(19) United States
(12) Patent Application Publication
(10) Pub. No.: US 2025/0348192 A1
(43) Pub. Date: Nov. 13, 2025

(54) Devices, Methods, and Graphical User Interfaces for Interacting with User Interface Objects Corresponding to Applications

(71) Applicant: Apple Inc., Cupertino, CA (US)

(72) Inventor: William M. Tyler, San Francisco, CA (US)

(21) Appl. No.: 19/182,465

(22) Filed: Apr. 17, 2025

Related U.S. Application Data
(60) Provisional application No. 63/647,056, filed on May 13, 2024.
(60) Provisional application No. 63/657,911, filed on Jun. 9, 2024.

(51) Int. Cl. G06F 3/0484; G06F 3/04817; G06F 3/0482

(52) U.S. Cl. CPC G06F 3/0484; G06F 3/04817; G06F 3/0482

(57) ABSTRACT

A computer system, while displaying a home screen user interface which includes user interface objects corresponding to different applications, detects an input directed to a user interface object, and in response, if the input meets first criteria where the input meets a first input threshold with less than a threshold amount of movement, the computer system concurrently displays the user interface object and configuration options. The configuration options include a first configuration option and a second configuration option, where the first configuration option causes first change in configuration of the user interface object, and the second configuration option causes a second change in configuration of the user interface object. If the input meets second criteria, where the first input does not meet with the first input threshold with less than the threshold amount of movement, the computer system performs an operation.

### RELATED APPLICATIONS

This application claims priority to U.S. Provisional Patent Application 63/657,911, filed Jun. 9, 2024, and U.S. Provisional Patent Application 63/647,056, filed May 13, 2024, each of which is incorporated by reference in its entirety.

### TECHNICAL FIELD

This relates generally to electronic devices with input devices, such as touch-sensitive surfaces, cameras, and/or other sensors for detecting user inputs and contextual conditions, and/or output devices, such as display generation components and audio output devices, including but not limited to electronic devices in communication with touch-sensitive surfaces, displays, and/or audio output devices.

### BACKGROUND

Mobile devices such as smartphones, head-mounted displays, vehicle head units, and smartwatches are used by users throughout the day. Such devices often include many applications, each application providing various functionality of the device.

Current methods for quickly accessing applications and content from applications are inefficient. For example, user interface objects corresponding to applications are presented to the user in a home screen user interface in a disorganized and unintuitive manner. Manual organization is tedious and time consuming. This may further result in wasted time, increased cognitive burden on the user, and unneeded power consumption of the device (e.g., performing operations that can be avoided with more efficient and effective content delivery).

### SUMMARY

Accordingly, there is a need for electronic devices with faster, more efficient methods and interfaces for organizing user interface objects corresponding to applications (e.g., application icons, widgets, complications, and/or other types of user interface objects corresponding to applications), provide improved customizability without burdening the user with complicated customization steps, and automatically provide suggested application objects and content based on context and based on user's preferences. There is an additional need for presenting the user interface objects corresponding to applications in a manner that improves visual clarity of the user interface objects and/or reduce visual distractions, thereby reducing mistakes when interacting with the user interface objects corresponding to applications. Such methods and interfaces optionally complement or replace conventional methods for displaying and interacting with user interface objects corresponding to applications on the electronic devices. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or, optionally, more generally, computer systems) are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the device is a head-mounted display device that provides three-dimensional virtual and/or augmented reality experiences. In some embodiments, the device has a touchpad. In some embodiments, the device has a touch-sensitive display (also known as a “touch screen” or “touch-screen display”). In some embodiments, the device has one or more cameras that detect air gestures performed using a user's hand, and, optionally, the gaze of the user. In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with one or more display devices and one or more input devices. The method includes, displaying, via the one or more display devices, a home screen user interface, wherein the home screen user interface includes a plurality of user interface objects corresponding to a plurality of different applications. The method further includes, detecting, via the one or more input devices, a first input directed to a first user interface object of the plurality of user interface objects. The method further includes, in response to detecting the first input directed to the first user interface object of the plurality of user interface objects and in accordance with a determination that the first input meets first criteria, wherein the first criteria require that the first input meets a first input threshold with less than a threshold amount of movement in order for the first input to meet the first criteria, displaying, concurrently with the first user interface object, two or more configuration options corresponding to the first user interface object, including a first configuration option that, when selected, causes a first change in configuration of the first user interface object in the home screen user interface, and a second selectable option that, when selected, causes a second change in configuration of the first user interface object in the home screen user interface, wherein the second change in configuration is different from the first change in configuration. The method further includes, in response to detecting the first input directed to the first user interface object of the plurality of user interface objects and in accordance with a determination that the first input meets second criteria, wherein the second criteria require that the first input does not meet with the first input threshold with less than the threshold amount of movement, in order for the first input to meet the second criteria, performing a first operation associated with the first user interface object.

In accordance with some embodiments, a method is performed at a computer system that is in communication with one or more display devices and one or more input devices. The method includes, displaying, via the one or more display devices, a first user interface including a plurality of user interface objects of a first object type, wherein the first user interface has a plurality of placement locations that are respectively available to accommodate a corresponding user interface object of the first object type. The plurality of user interface objects are placed into at least a subset of the plurality of placement locations in accordance with a first arrangement of the plurality of user interface objects relative to the plurality of placement locations. The method further includes, while displaying, via the one or more display devices, the first user interface with the plurality of user interface objects of the first object type in the first arrangement, detecting, via the one or more input devices, a first input directed to a first user interface object of the plurality of user interface object that is placed at a first placement location of the plurality of placement locations. The method further includes, in response to detecting the first input that is directed to the first user interface object at the first placement location, removing the first user interface object from the first placement location. The method further includes, in response to detecting the first input that is directed to the first user interface object at the first placement location and in accordance with a determination that the first user interface object and one or more second user interface objects of the plurality of user interface objects form a first automatically-arranged group in accordance with first grouping criteria, wherein the first grouping criteria include one or more conditions based on a spatial distribution of the plurality of user interface objects the first user interface, rearranging the one or more second user interface objects in the first user interface, including moving one of the one or more second user interface objects to the first placement location. The method further includes, in response to detecting the first input that is directed to the first user interface object at the first placement location and in accordance with a determination that the first user interface object and one or more third user interface objects of the plurality of user interface objects do not form a respective automatically-arranged group in accordance with the first grouping criteria, forgoing rearranging the one or more third user interface objects in the first user interface.

In accordance with some embodiments, a method is performed at a computer system that is in communication with one or more display devices and one or more input devices. The method includes, detecting a first event. The method further includes, in response to detecting the first event, displaying, via the one or more display devices, a first page of a home screen user interface, including: displaying, via the one or more display devices, a first plurality of application icons in accordance with a first arrangement that was established in the first page of the home screen user interface; and displaying, via the one or more display devices, at least a respective set of application icons in a first region in the first page of the home screen user interface, wherein the respective set of application icons included in the first region are automatically selected by the computer system in accordance with a respective category associated with the first region. Further, displaying the respective set of application icons in the first region includes: in accordance with a determination that the first region is associated with a first category, displaying, via the one or more display devices, a first set of application icons associated with the first category in the first region; and in accordance with a determination that the first region is associated with a second category different from the first category, displaying, via the one or more display devices, a second set of application icons associated with the second category in the first region, wherein the second set of application icons are different from the first set of application icons.

In accordance with some embodiments, a method is performed at a computer system that is in communication with one or more display devices and one or more input devices. The method includes, displaying, via the one or more display devices, an application library user interface, including respective representations of a plurality of system-generated groupings for a plurality of applications associated with the computer system. Further, displaying the respective representations of the plurality of system-generated groupings for the plurality of applications includes concurrently displaying: a first representation of a first system-generated grouping for a first subset of the plurality of applications that includes two or more application icons that are associated with a first category, and a second representation of a second system-generated grouping for a second subset of the plurality of applications that includes two or more application icons that are associated with a second category different from the first category. The method further includes, while displaying the application library user interface including concurrently displaying the first representation of the first system-generated grouping and the second representation of the second system-generated grouping, detecting, via the one or more input devices, a first input directed to a respective application icon in the application library user interface. The method further includes, in response to detecting the first input and in accordance with a determination that the first input meets first criteria, and that the respective application icon is included in the first representation of the first system-generated grouping, displaying, via the one or more display devices, a first selectable option for recategorizing a respective application that is associated with the respective application icon to a category other than the first category. The method further includes, in response to detecting the first input and in accordance with a determination that the first input meets the first criteria, and that the respective application icon is included in the second representation of the first system-generated grouping, displaying, via the one or more display devices, a second selectable option for recategorizing the respective application that is associated with the respective application icon to a category other than the second category.

In some embodiments, a method is performed at a computer system that is in communication with one or more display devices and one or more input devices. The method includes, while the computer system is operating in a first state, displaying, a home screen user interface, wherein the home screen user interface includes a first plurality of user interface objects corresponding to a first plurality of applications, wherein a respective user interface object of the first plurality of user interface objects, when selected by a selection input of a first input type, causes the computer system to display a respective application corresponding to the respective user interface object. The method further includes, displaying the home screen user interface while the computer system is operating in the first state, including: in accordance with a determination that a first appearance property is selected for the first plurality of user interface objects, displaying the first plurality of user interface objects in the home screen user interface, with a first flexible set of colors for different user interface objects of the first plurality of user interface objects; and in accordance with a determination that a second appearance property is selected for the first plurality of user interface objects, displaying the first plurality of user interface objects in the home screen user interface with a first constrained set of colors, wherein the first constrained set of colors includes fewer colors than the first flexible set of colors. The method further includes, after displaying the home screen user interface while the computer system was operating in the first state, while the computer system is operating in a second state different from the first state, displaying, via the one or more display devices, the home screen user interface, including: in accordance with a determination that the first appearance property is selected for the first plurality of user interface objects, displaying the first plurality of user interface objects with a second flexible set of colors for different user interface objects of the first plurality of user interface objects, wherein the second flexible set of colors is different from the first flexible set of colors; and in accordance with a determination that the second appearance property is selected for the first plurality of user interface objects, displaying the first plurality of user interface objects in the home screen user interface with a second constrained set of colors, wherein the second constrained set of colors includes fewer colors than the second flexible set of colors.

In accordance with some embodiments, an electronic device (or, optionally, computer system more generally) includes a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device that includes a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), cause the device to perform or cause performance of the operations of any of the methods described herein. In accordance with some embodiments, a graphical user interface on an electronic device with a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators); and means for performing or causing performance of the operations of any of the methods described herein. In accordance with some embodiments, an information processing apparatus, for use in an electronic device with a display generation component (e.g., a display, a touch-screen display, or a head-mounted display), an input device (e.g., a touch-sensitive surface, a touch screen display, optionally one or more sensors to detect intensities of contacts with the touch-sensitive surface or touch-screen display, one or more cameras, and/or one or more controllers), and one or more output devices (e.g., audio output devices, and optionally, one or more tactile output generators), includes means for performing or causing performance of the operations of any of the methods described herein.

Thus, electronic devices and other computer systems with display generation components (e.g., displays, touch-screen displays, and/or head-mounted displays), input device (e.g., touch-sensitive surfaces, touch screen displays, optionally one or more sensors to detect intensities of contacts with the touch-sensitive surface or touch-screen display, one or more cameras, and/or one or more controllers), and one or more output devices (e.g., audio output devices, and optionally, one or more tactile output generators) are provided with improved methods and interfaces for interacting with user interface objects corresponding to applications, thereby increasing the effectiveness, efficiency, and user satisfaction with such devices. Such methods and interfaces may complement or replace conventional methods for interacting with user interface objects corresponding to applications.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5AT illustrate example user interfaces and interactions for transforming an application object from one type to another without navigating away from a currently displayed user interface (e.g., directly from a home screen user interface in which the application object is currently displayed) and user interfaces and interactions for reconfiguring a home screen user interface, in accordance with some embodiments.

FIGS. 6A-6AX illustrate example user interfaces and interactions for automatic grouping and re-arrangement of application objects in a home screen user interface, in accordance with some embodiments.

FIGS. 7A-7V illustrate example user interfaces and interactions for automatically displaying application icons by category in a home screen user interface using an application category widget and configuring an application category widget, in accordance with some embodiments.

FIGS. 8A-8Q illustrate example user interfaces and interactions for modifying system-generated categorization of applications into groups and arranging the groups in an application library user interface, in accordance with some embodiments.

FIGS. 9A-9AB illustrate example techniques for changing an appearance of a home screen interface, in accordance with some embodiments.

FIGS. 10A-10J are a flow diagram of methods of transforming an application object from one type to another without navigating away from a currently displayed user interface (e.g., directly from a home screen user interface) and reconfiguring the home screen user interface, in accordance with various embodiments.

FIGS. 11A-11H are a flow diagram of methods of automatic grouping and re-arrangement of application objects in a home screen user interface, in accordance with various embodiments.

FIGS. 12A-12H are a flow diagram of methods of automatically displaying application icons by category in a home screen user interface using an application category widget and configuring an application category widget, in accordance with various embodiments.

FIGS. 13A-13F are a flow diagram of methods of modifying system-generated categorization of applications into groups and arranging the groups in an application library user interface, in accordance with various embodiments.

FIGS. 14A-14H are a flow diagram of methods of changing an appearance of a home screen user interface, in accordance with various embodiments.

### DESCRIPTION OF EMBODIMENTS

Some methods of adding and configuring application objects corresponding to different applications (e.g., application icons and/or application widgets) in a home screen user interface, require that the user navigates away from the home screen user interface through various other user interfaces and/or menu options, thereby losing visibility of content in the home screen user interface and potentially resulting in multiple application objects corresponding to the same application being added to the home screen user interface. Typically, to add an application widget on a home screen page, the user accesses a widget library, find a target application, and then search for a desired widget type and size through various options and interfaces. Such techniques can become cumbersome, time consuming, and may result in multiple widgets of the same application being added to the home screen page. In some embodiments, instead of navigating through various user interfaces and/or menu options, an application object of a first type (e.g., an application widget) is added to the home screen user interface by transforming an application object of a second type (e.g., an application icon or a different type of application widget) that is associated with the respective application and has already been placed in the home screen user interface. An input directed to an application object causes a device to display an in-line editing user interface (e.g., a quick action or contextual menu) in association with the application object. The in-line editing user interface includes various options that, when selected, transform or replace the application object without navigating away from the home screen user interface. The application object is transformed (i) from an application icon into an application widget of a select type and/or size corresponding to the same application; (ii) from an application widget of one type and/or size to an application widget of a different type and/or size corresponding to the same application; and (iii) from an application widget to an application icon corresponding to the same application. Transforming or replacing an application object of a first type into an application object of a second type by selecting an option in an in-line editing user interface associated with the application object that is being transformed or replaced, reduces the number of inputs and/or the time needed to reconfigure a home screen user interface (e.g., by adding different application objects corresponding to an application to the home screen user interface).

Some methods for rearranging application objects on a home screen page allow for free placement of application objects anywhere in the home screen. These techniques, while presenting some advantages, often lead to a disorganized home screen page with scattered application objects that are difficult and time consuming to locate, or require the user to laboriously move application objects to arrive at a more organized arrangement. Other methods for rearranging application objects automatically reflow application objects upon moving, adding, or removing an application object in the arrangement. These techniques, while presenting some advantages with respect to produce a more organized “look” on a home screen page, sometimes do not provide enough flexibility for placing application objects at desired locations on the home screen page to actually improve the organization and efficiency of the home screen page (e.g., by eliminating the user's ability to cluster and separate application objects into groups on the same home screen page). The methods and systems described herein provide an improved technique for organizing and re-arranging a home screen user interface that combines the advantageous of flexible placing with the advantages of automated reflow of application objects. Upon detecting re-arrangement on a page of the home screen user interface (e.g., re-arrangement in response to a user input or requested by the computer system), some application icons reflow while others remain displayed at their respective locations (e.g., current locations that are optionally user-specified). In particular, application icons in a respective automatically-arranged group reflow, e.g., to make room for icons added to the respective automatically-arranged group or to refill vacant placement locations in the respective automatically-arranged group, while other applications icons on the same page located outside the respective automatically-arranged group maintain (e.g., icons that are not part of the respective group and/or are included in other automatically-arranged groups) respective locations. Accordingly, a user can specify groups of application icons where changes in one group do not affect changes in other groups. The technique combines the efficiency of automatically re-arranging a page of the home screen user interface with the flexibility of persisting user-specified locations for some application icons on the page. Reflowing some application icons upon re-arrangement without reflowing other application icons reduces the number of inputs and/or time needed to re-arrange a page of the home screen user interface while providing additional control to a user for arranging the page of the home screen user interface.

Some methods of displaying and interacting with user interface objects corresponding to different applications, in particular, for displaying and interacting with application icons corresponding to different applications, often require multiple separate inputs for the user to manually arrange the application icons into meaningful categories or folders on a home screen page. The user has to look for the correct application icon among many other applications on multiple pages of the home screen user interface in order to locate the application icon for a desired application in order to activate the application icon and launch the desired application. Overtime, it becomes increasingly difficult for the user to keep track of the applications installed on the device and increasingly difficult for the user to manually categorized and arrange the application icons in the home screen user interface to allow for efficient and easy access to the application icons. The methods and systems described herein provide an improved technique for organizing application icons by category in a home screen user interface. Instead of manually creating folders or arranging application icons of the same application category in regions on a page, an application category widget automatically displays multiple application icons of the same category (and optionally, automatically switches between displaying different subsets of the applications icons of the same category) in the page of the home screen user interface, optionally at a location chosen by the user. The category assigned to the application category widget can be changed by a user. An assigned category is optionally modifiable in response to a first input directed to the application category widget and optionally a second input directed to a selectable option that is displayed (e.g., a in a contextual or quick action menu) in response to the first input. Further, the computer system dynamically selects respective application icons included in an application category widget, e.g., based on contextual information, usage patterns, and/or events occurring in the computer system or respective applications. Multiple application category widgets are optionally placed on a page of the home screen user interface, and respective application category widgets optionally can be assigned different or the same application category. Adding application category widgets in the home screen user interface, reduces the number of inputs and/or time needed to arrange application icons per application category on a page of the home screen user interface while also providing additional control to a user for specifying location, number, and/or category of application category widget; and/or reduces the number of inputs and/or time needed to locate an application icon in the home screen user interface.

Some methods automatically group applications into system-generated application categories represented as respective group icons in an application library user interface. For example, the computer system may automatically assign application categories to application icons for the purposes of automatically grouping the application icons. Such methods, while presenting advantages with respect to organizing applications by category, sometimes do not provide enough flexibility for customizing the system-assigned categorization of the applications. The methods and system herein provide an improved for organizing application object per category a home screen user interface. An assigned category (e.g., system-assigned, or user-assigned) for an application icon is changed directly from the application library in response to a user's request (e.g., without navigating away from the application library). In particular, a user input directed to an application icon displayed in a group representation (e.g., a group icon or pod) causes the computer system to display one or more options for recategorizing the application icon that, when selected, cause the computer system to change the assigned category of the application icon and to optionally move the application icon from one group representation into another group representation in the application library in accordance with the changed category. The method combines the efficiency of automatic grouping of application icons by category with the flexibility of customizing said grouping and categorization, thereby reducing the number input and/or time needed to find an application icon in the home screen user interface (e.g., by placing icons into system or user assigned groups) and/or reducing the number input and/or time needed to customize an application library.

In some embodiments, in accordance with a determination that a change in a state of a computer system is detected (e.g., from light mode to dark mode or vice versa), depending on a selected visual appearance property (e.g., “colorful” or “tinted” icon configuration), the computer system either changes an appearance of application icons or maintains a tinted appearance of the application icons on the home screen user interface, optionally, in conjunction with making changes to a background the home screen user interface in accordance with the change in the state of the computer system. Automatically changing appearance of the home screen interface based on a state the computer system is in and a selected visual appearance property, reduces the number and/or complexity of inputs needed to locate icons on the home screen and change the appearance of the home screen, and provides visual feedback that the computer system is in a specific state.

The methods, devices, and GUIs described make it easier to for users to quickly locate, view, and/or interact with user interface object corresponding to applications on a system user interface (e.g., application icons, widgets, complications, and/or other types of user interface objects corresponding to applications, on a home screen user interface, an application library user interface, and other system user interfaces), by providing in-line editing user interfaces, combining automatic reflow and grouping of icons with manual repositioning of icons, automatically categorizing and grouping of applications, automatically suggesting applications based on a chosen categories one or more application category widgets, allowing a user to adjust automatic categories in an in-line editing user interface, and allowing customization and automatically changing appearances of the application objects in a home screen user interface based on a state change in the computer system.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

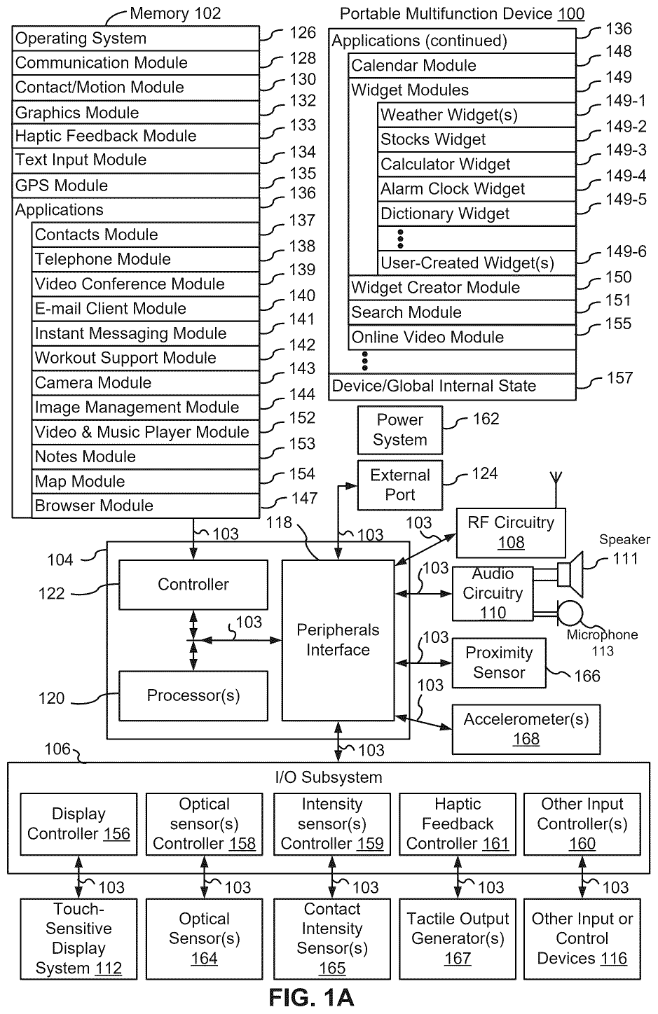

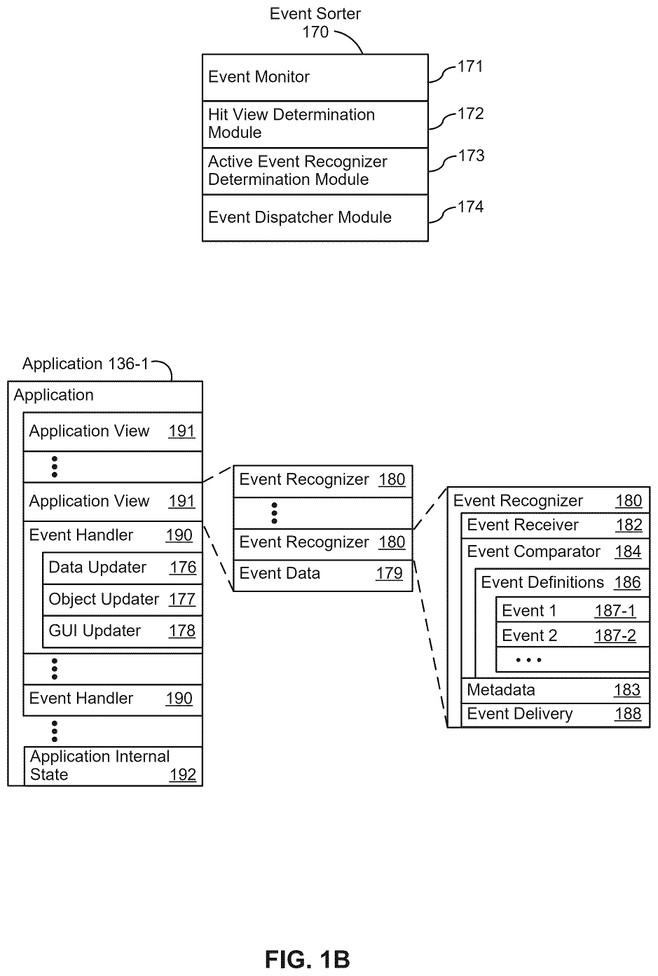

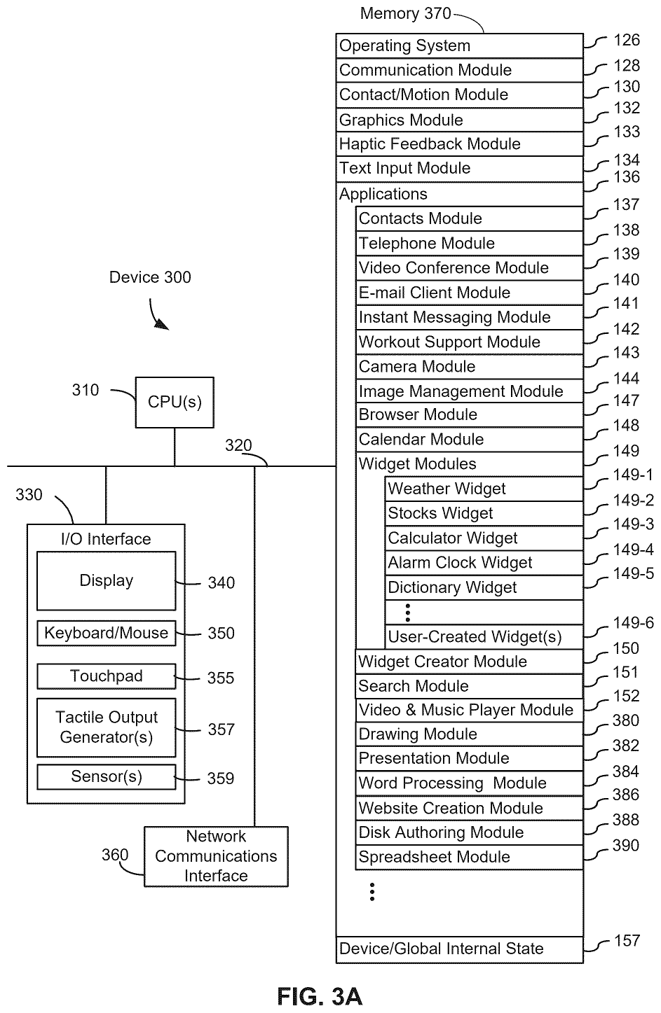

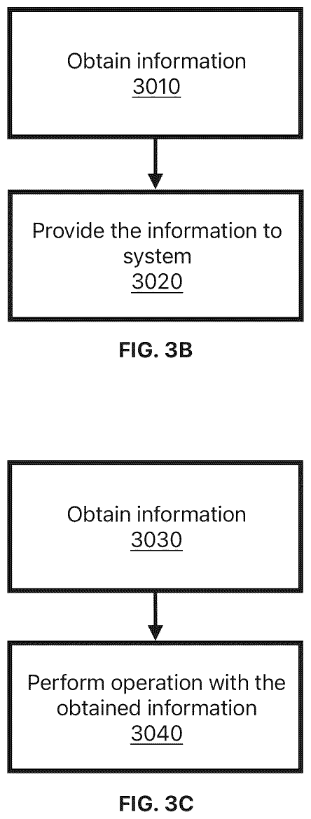

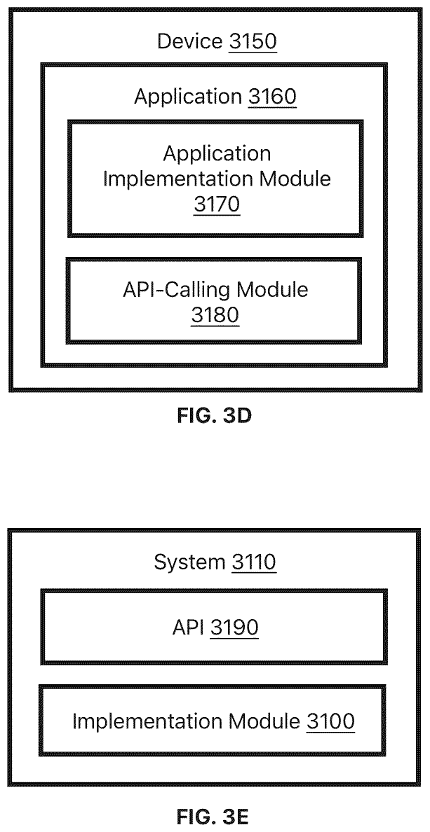

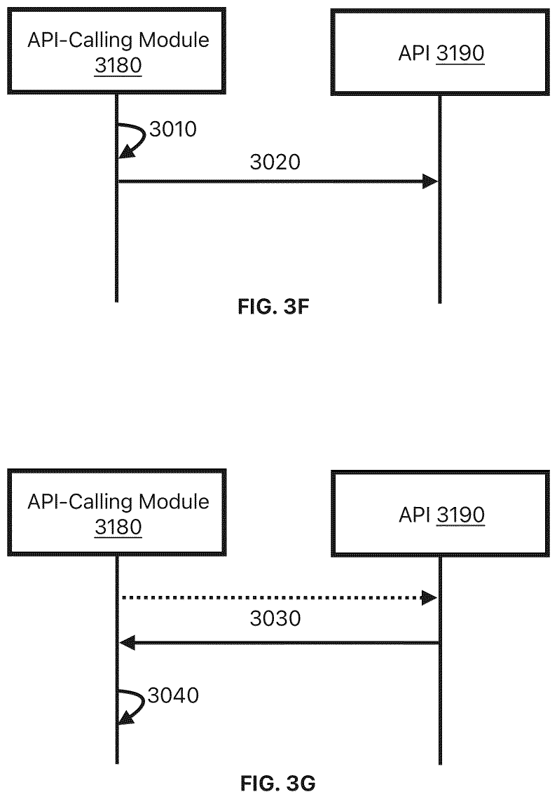

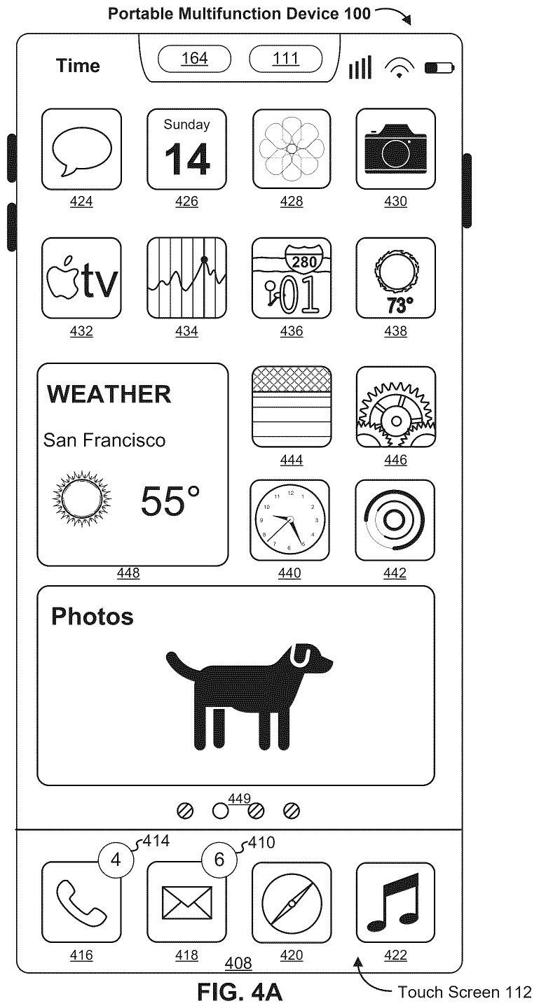

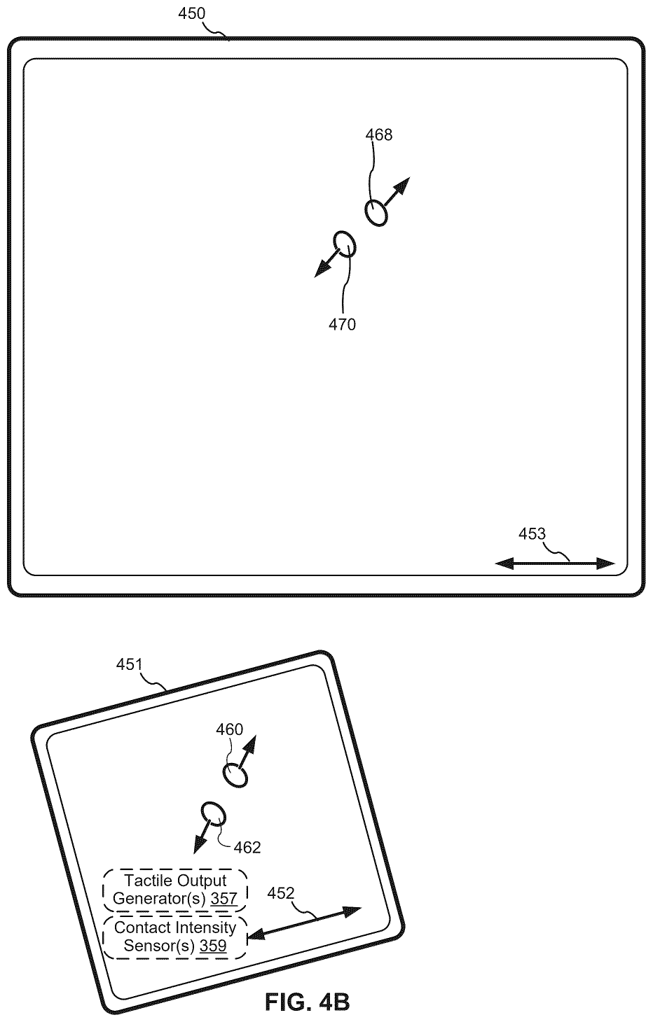

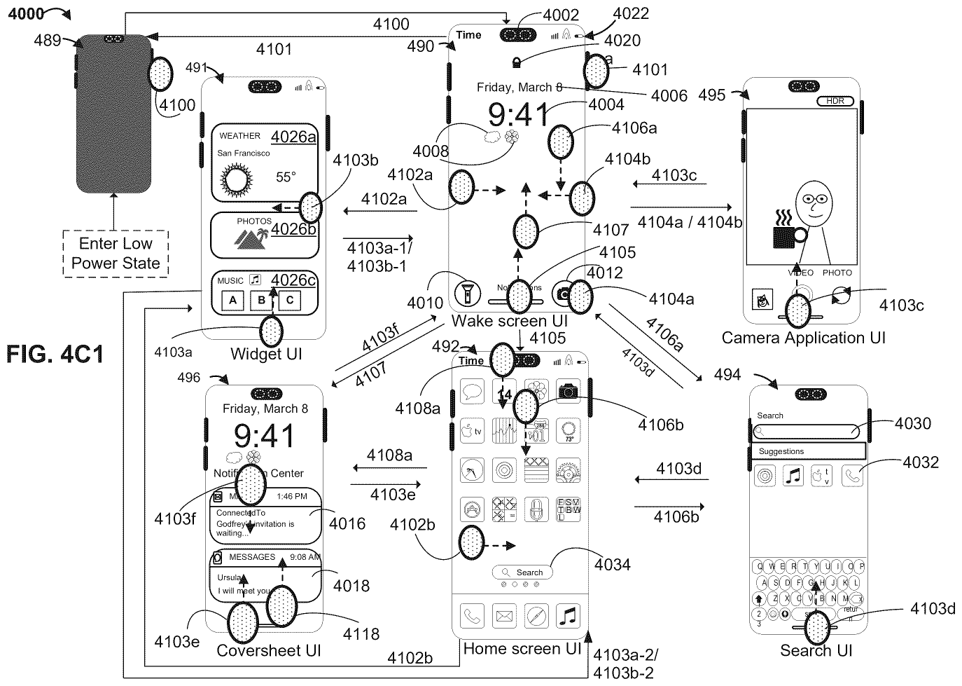

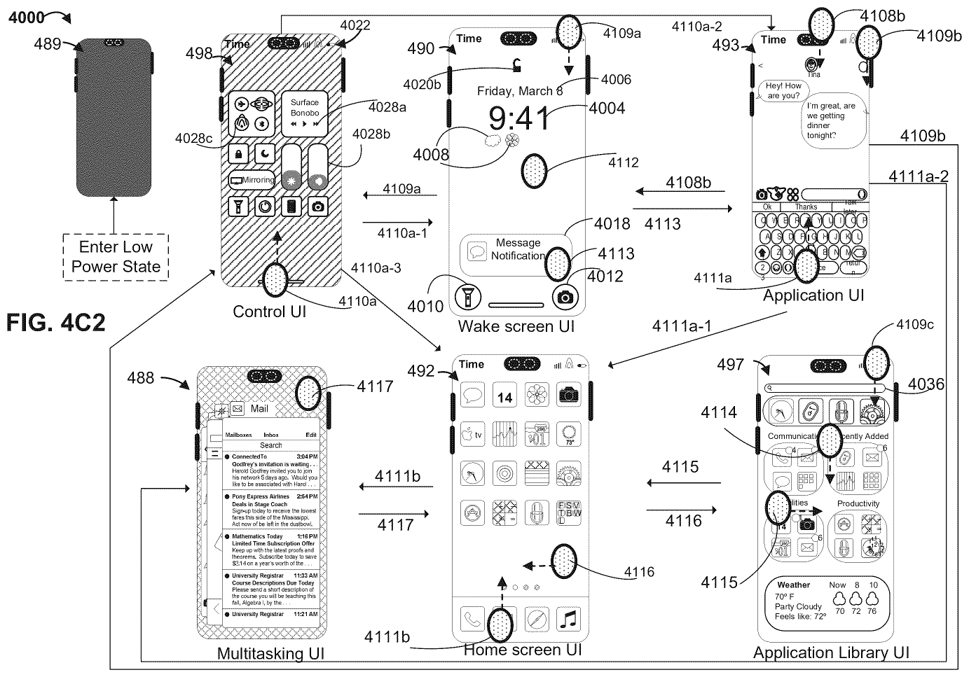

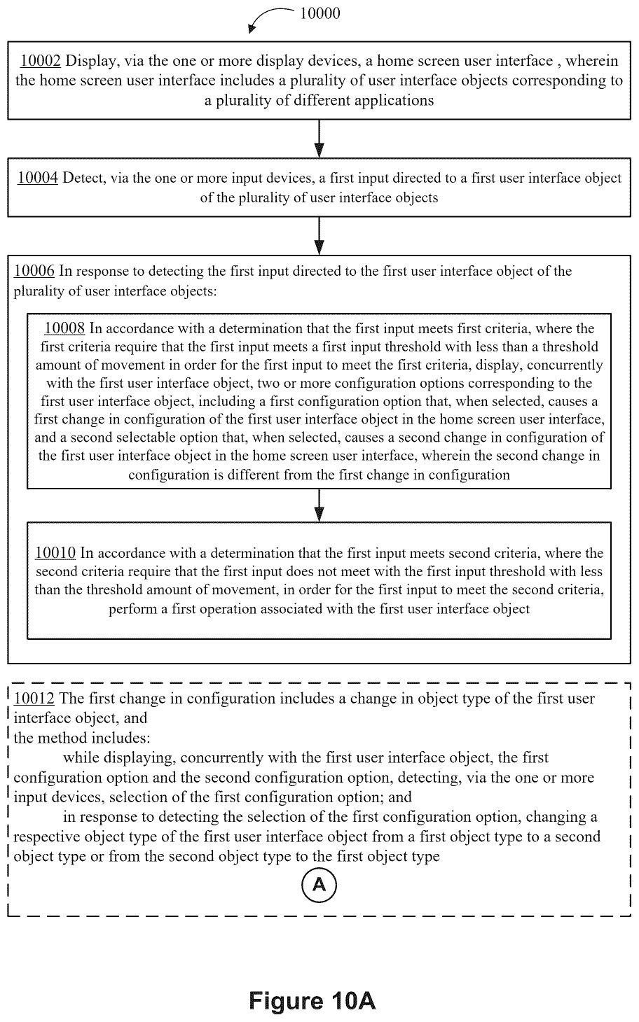

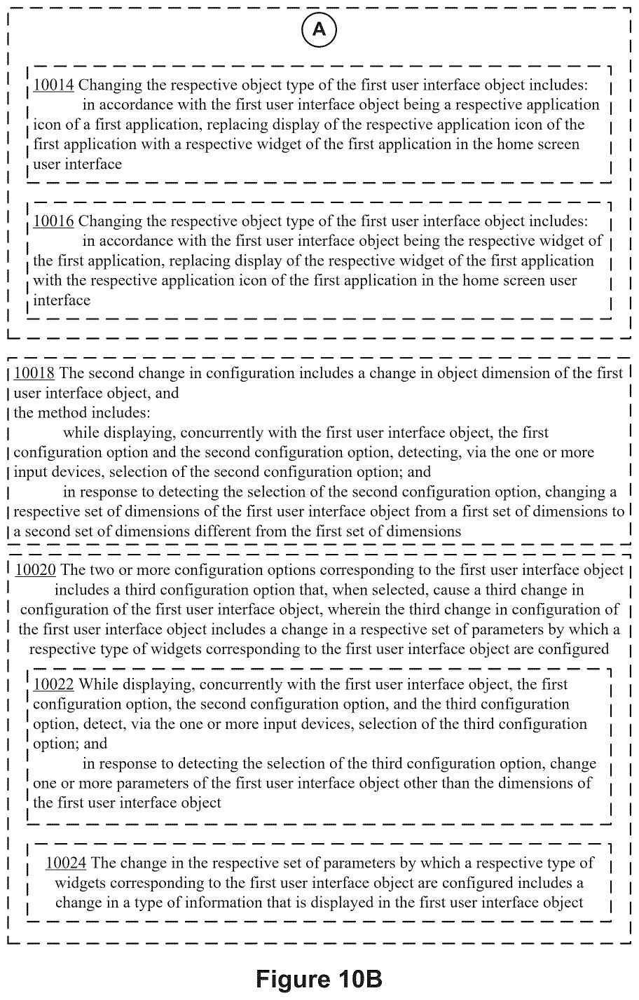

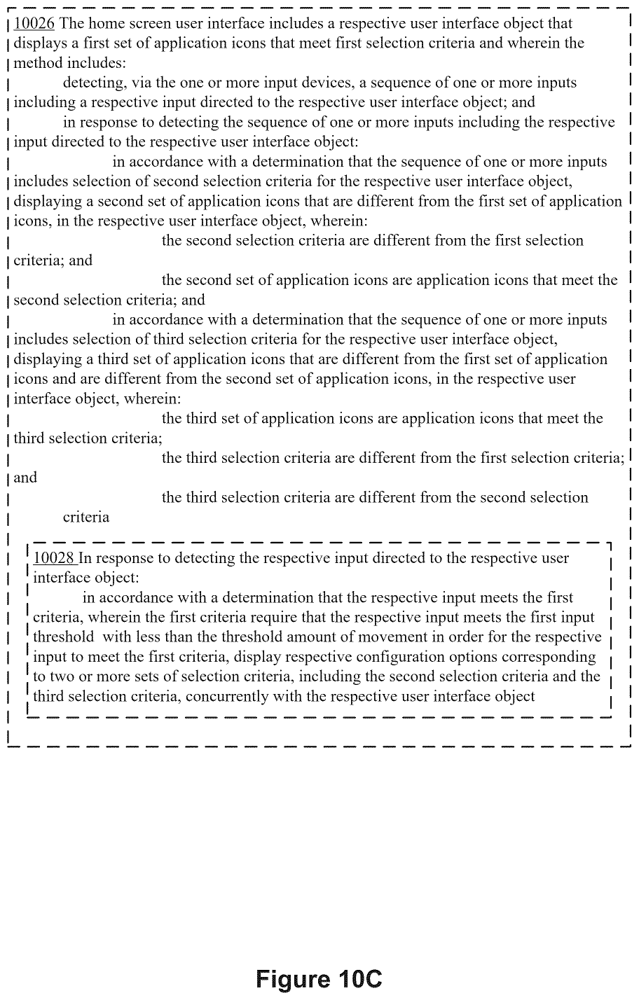

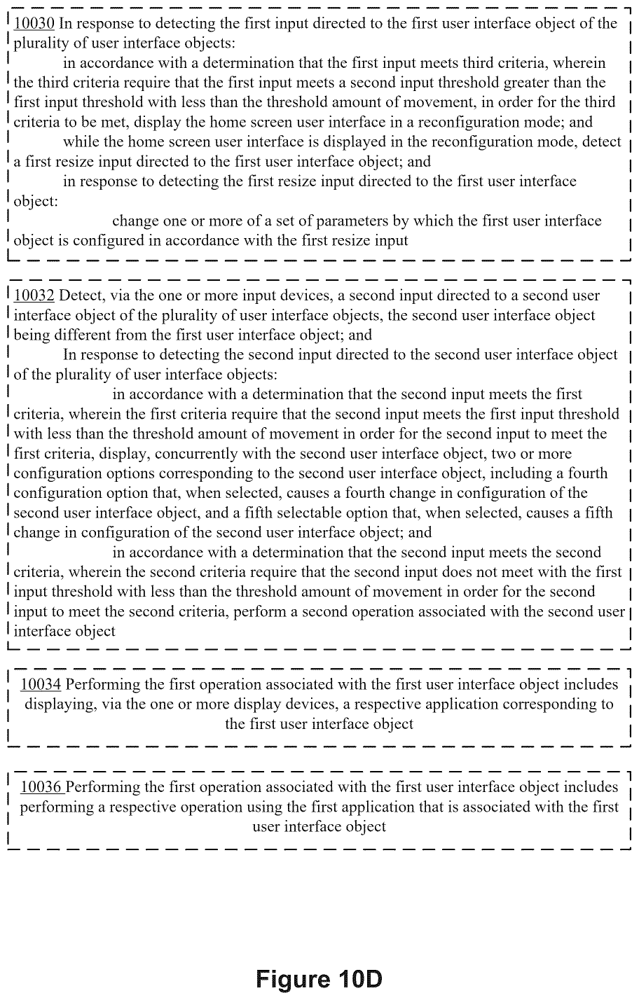

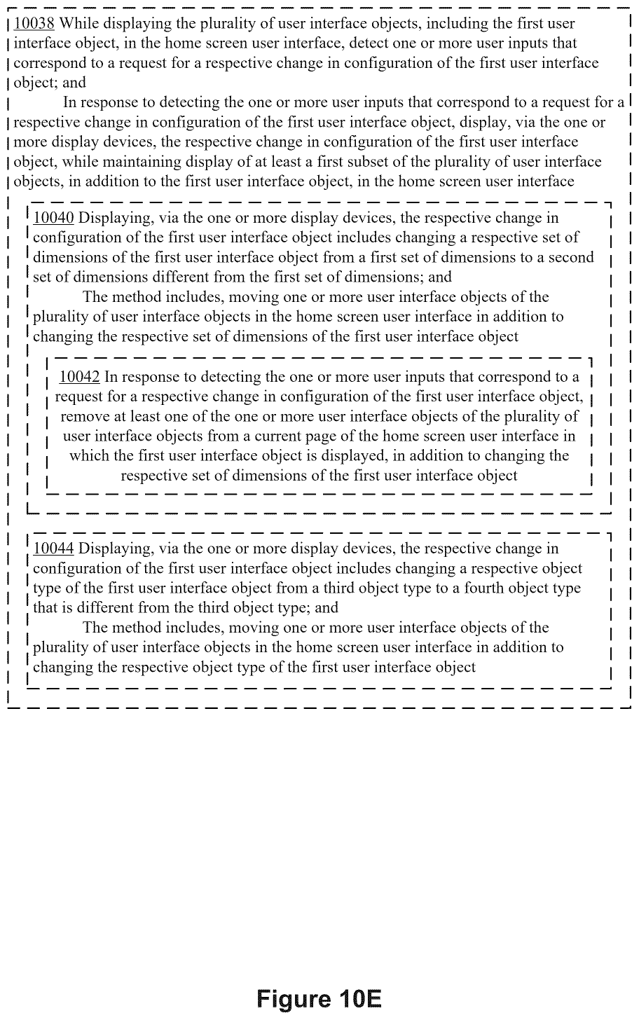

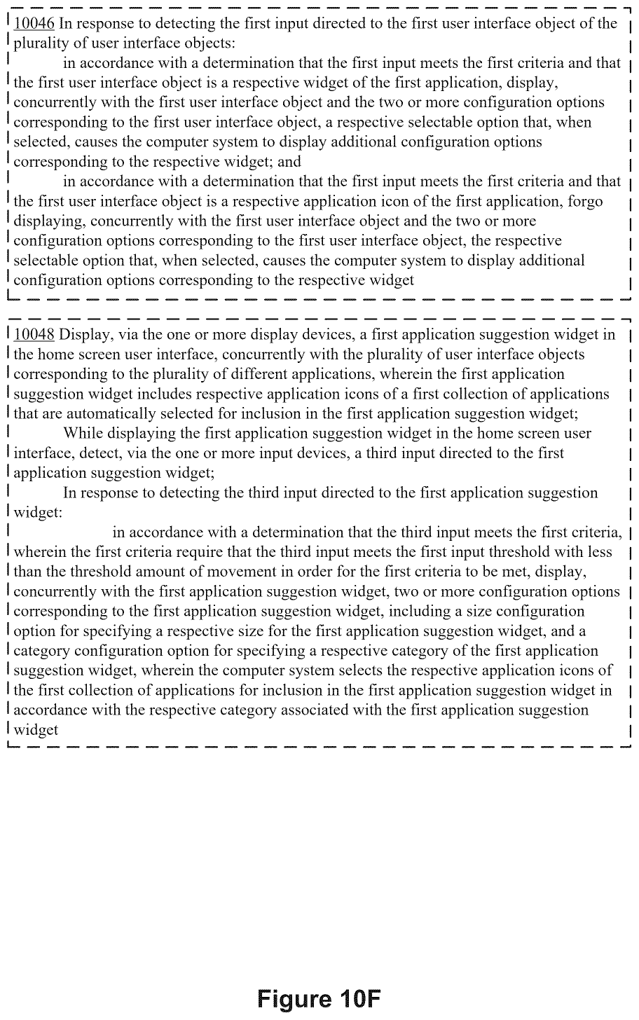

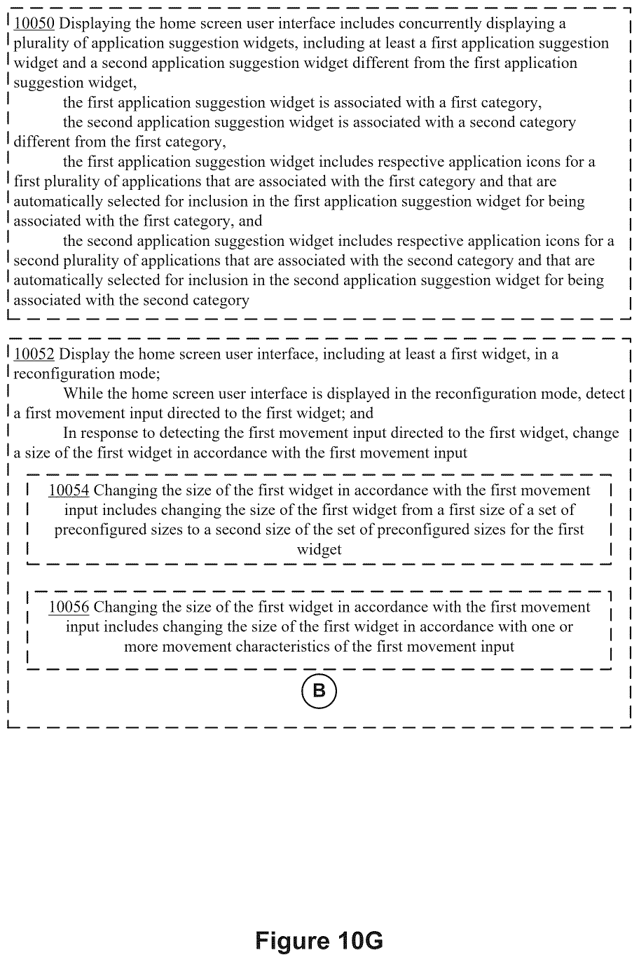

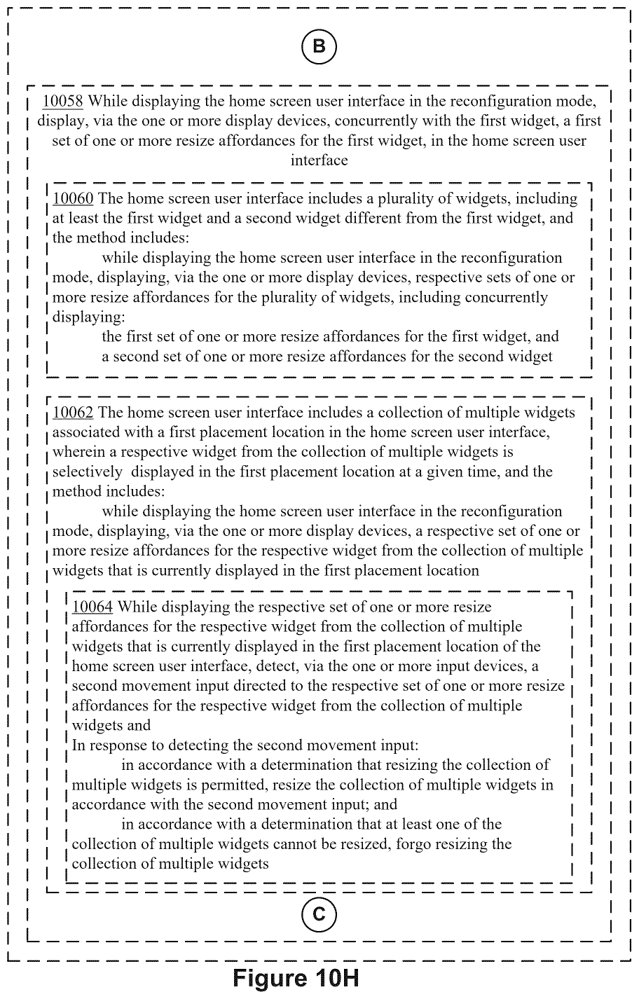

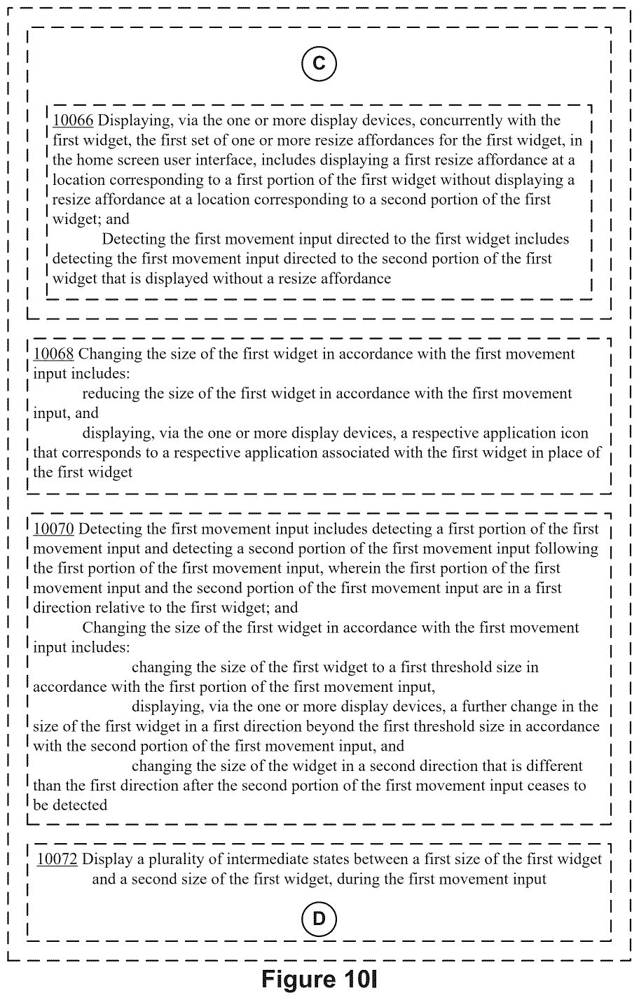

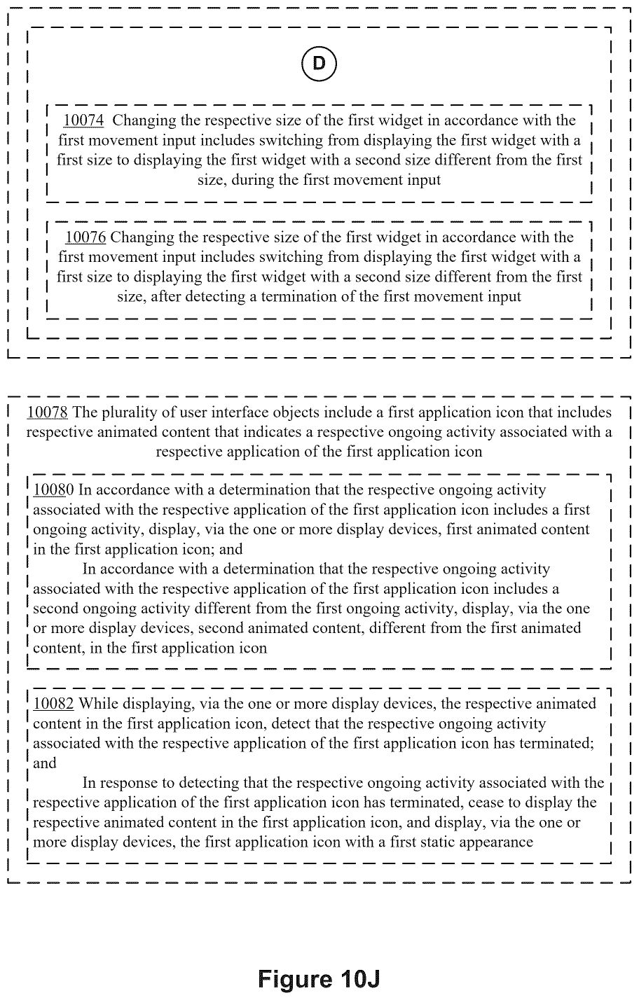

Below, FIGS. 1A-1B, 2, and 3A provide a description of example devices. FIGS. 3B-3G describe the use of Application Programming Interfaces (APIs) to perform operations. FIGS. 4A-4C2, 5A-5AT, 6A-6AX, 7A-7V, 8A-8Q, and 9A-9AB illustrate example user interfaces for interacting with a home screen user interface in accordance with some embodiments. The user interfaces in these figures are used to illustrate the processes described below, including the processes in FIGS. 10A-10J, 11A-11H, 12A-12H, 13A-12F, and 14A-14H. In addition, unless otherwise stated unambiguously in this disclosure, the various features described with respect to one set of Figures are applicable to the same or analogous features described and/or illustrated in another set of Figures, and the descriptions are not repeated in the interest of brevity.

For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) while a location or object is targeted, such as when the location of the hand(s) and/or finger(s) are on or near the object or the location or while a focus selector is on the location or object.

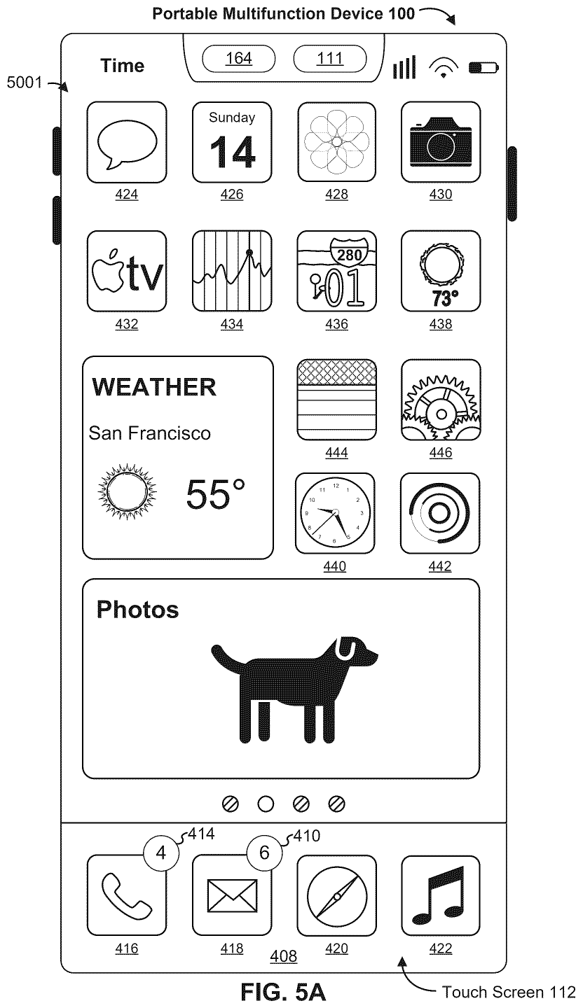

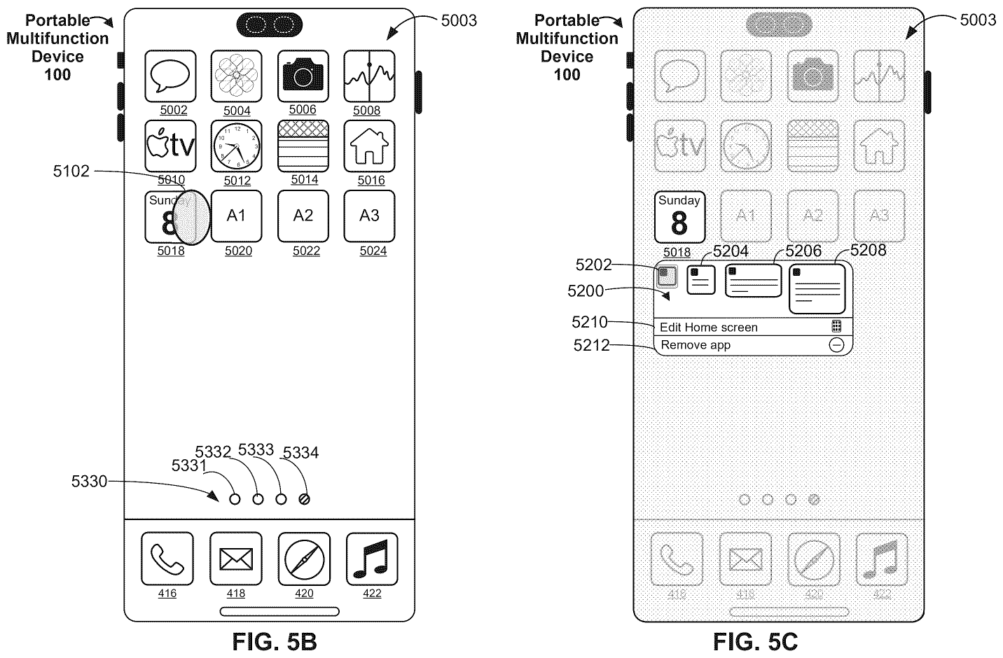

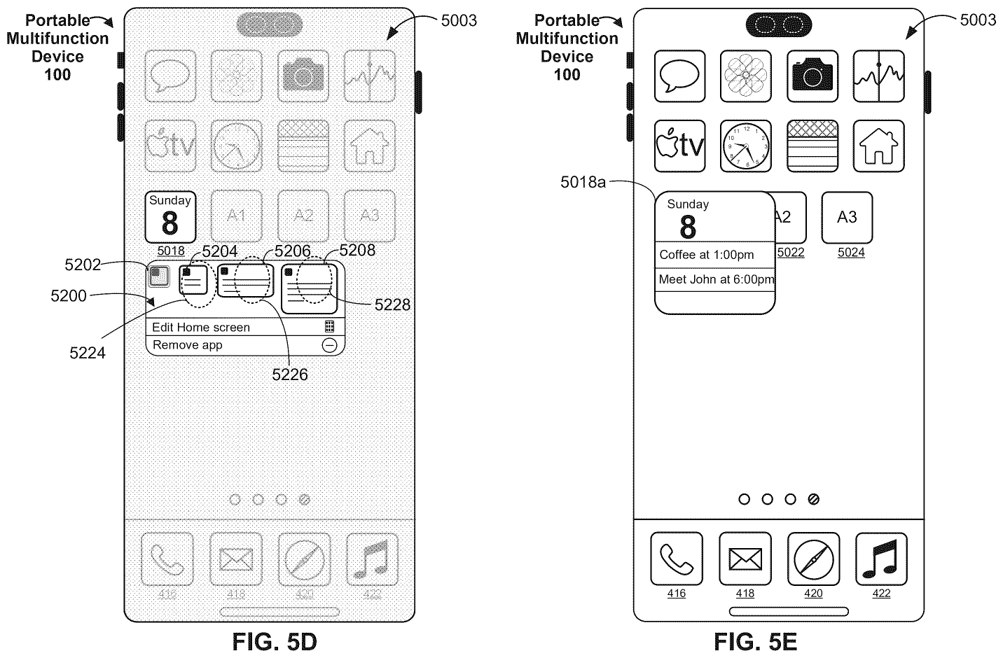

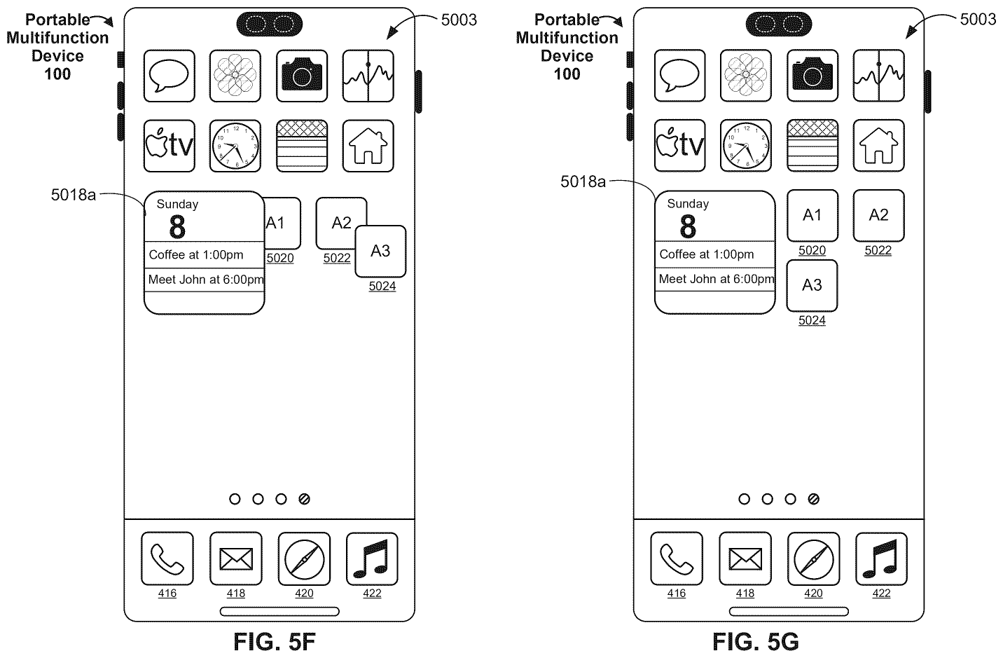

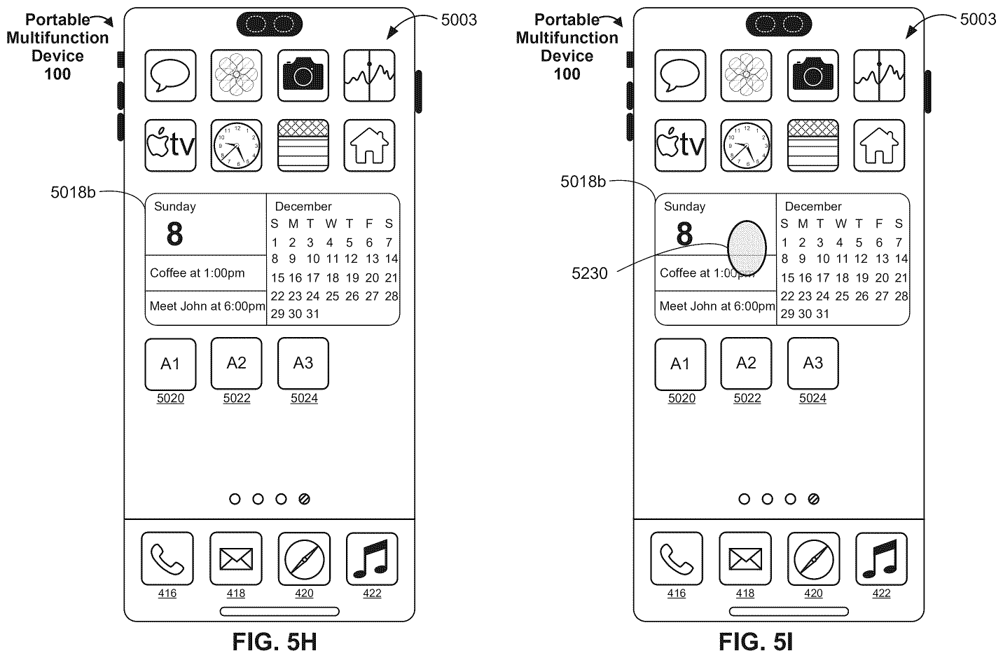

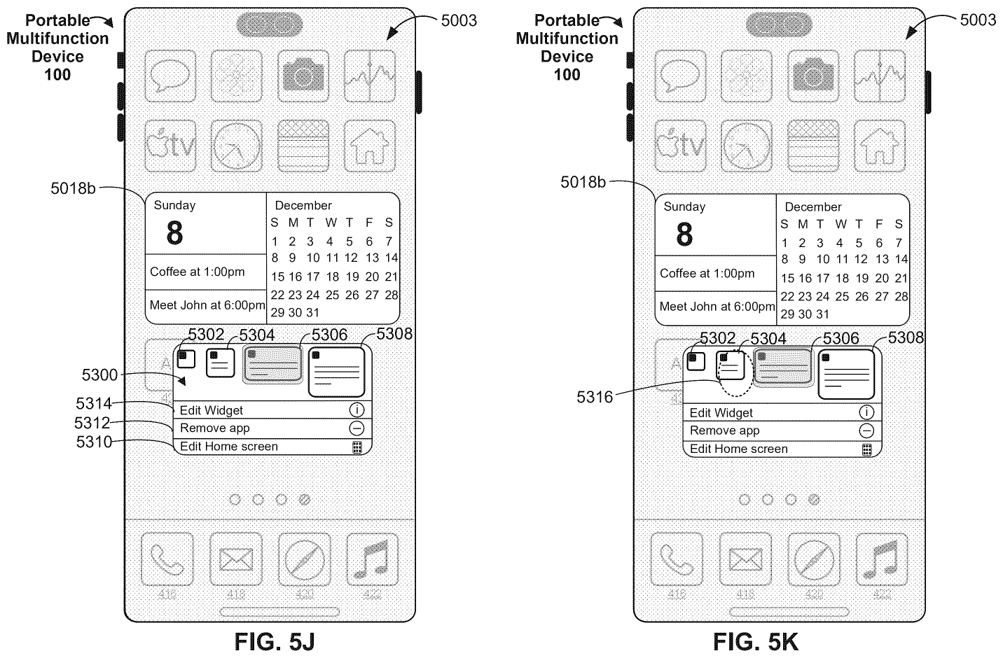

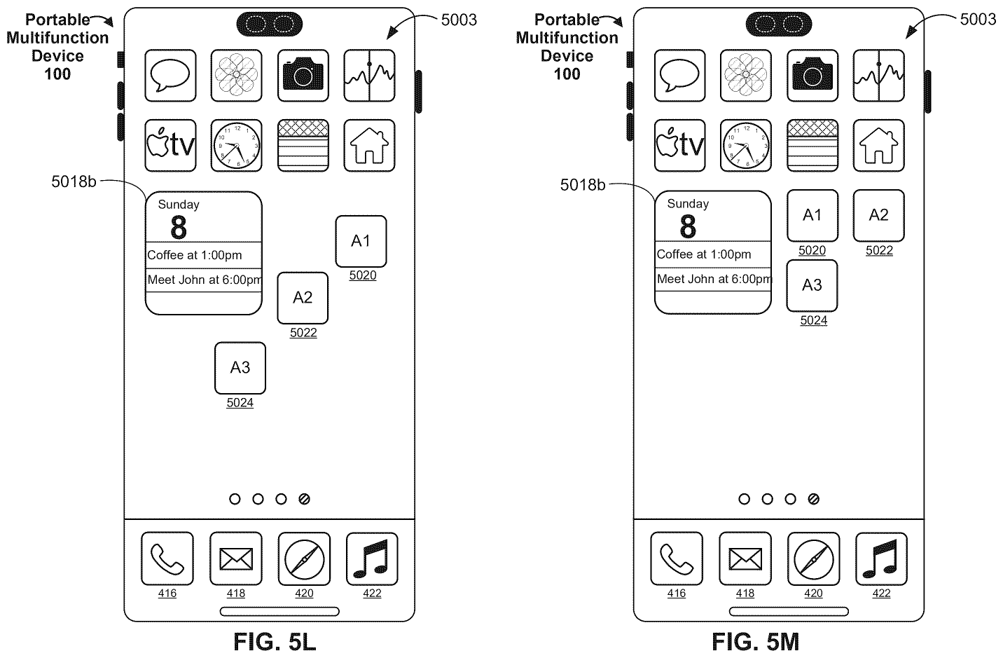

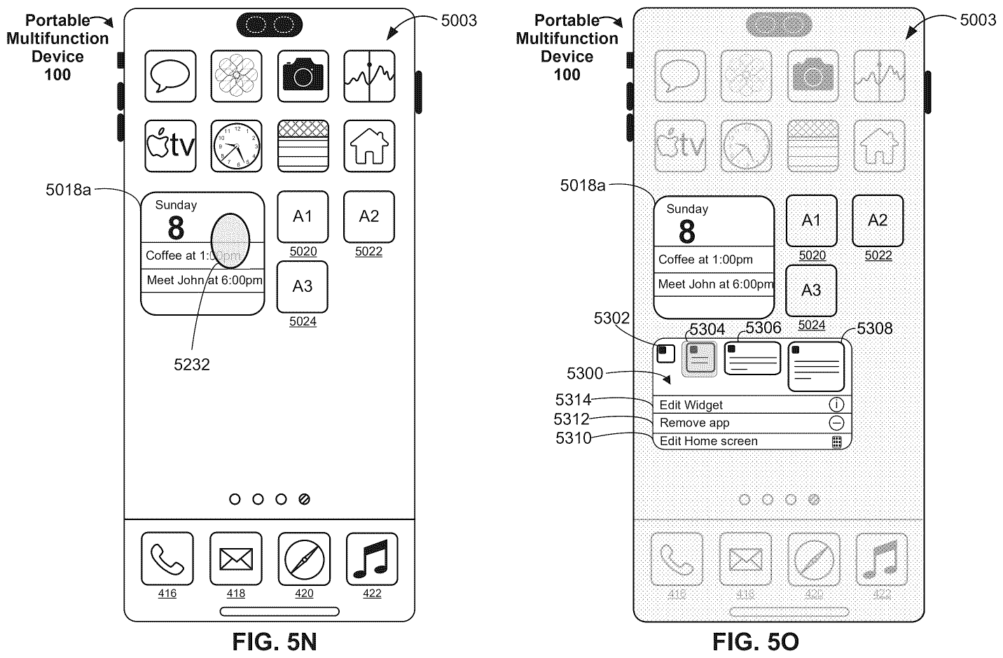

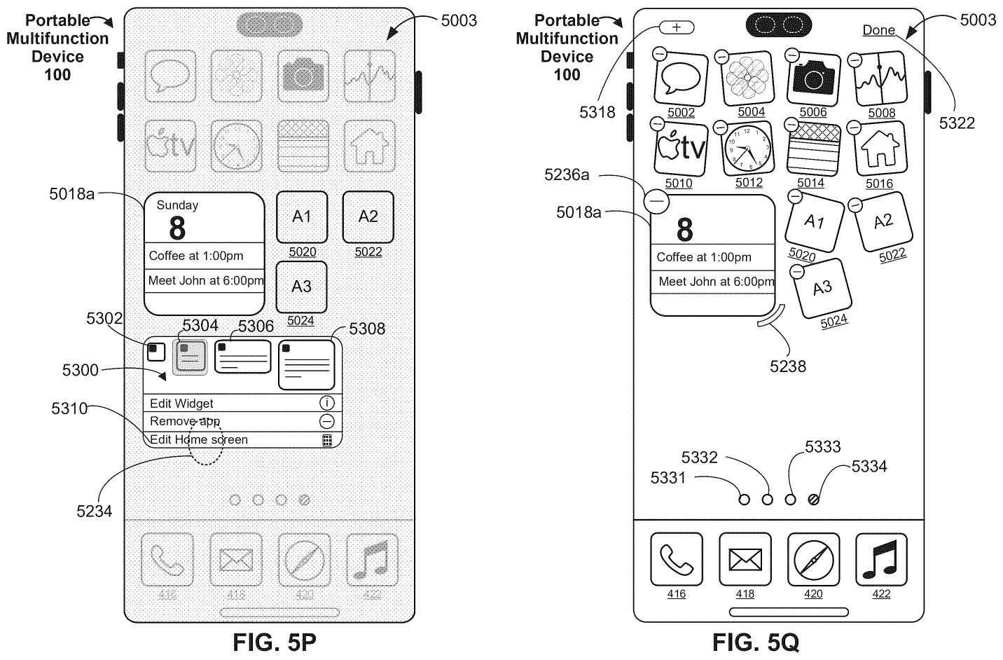

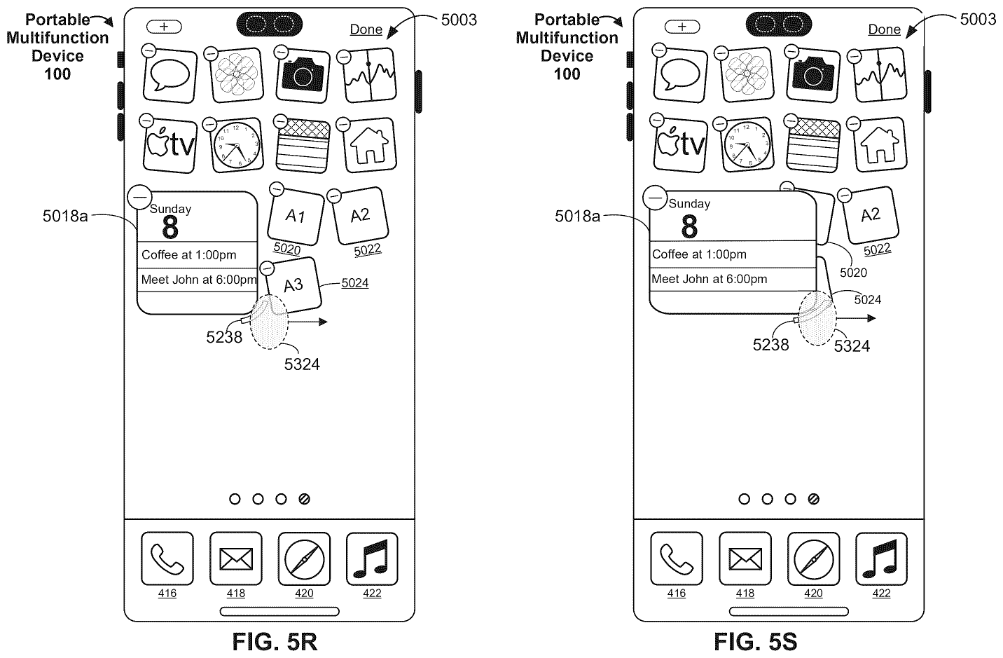

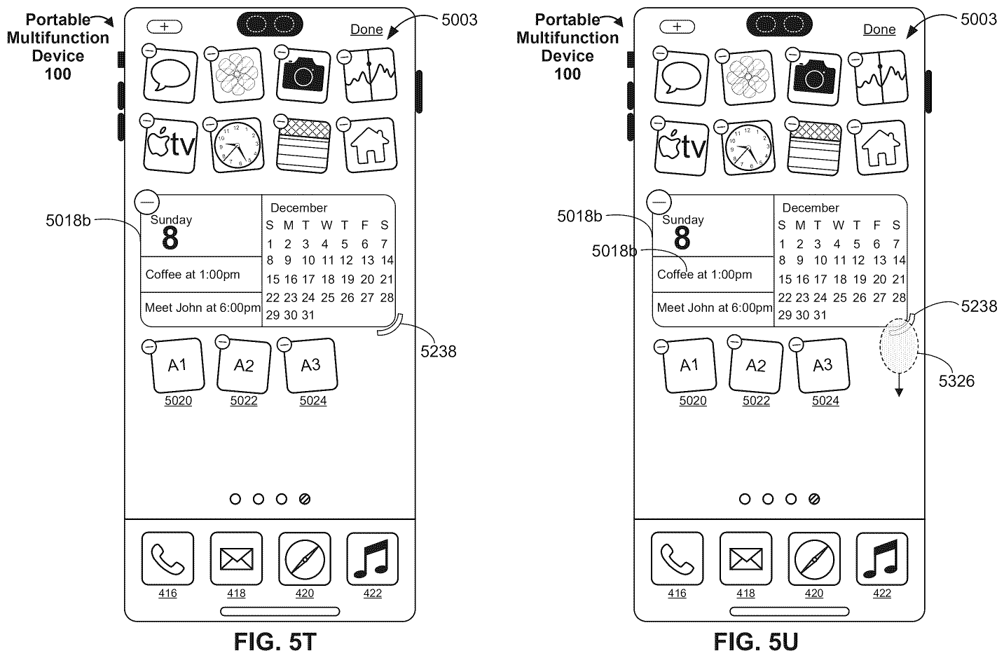

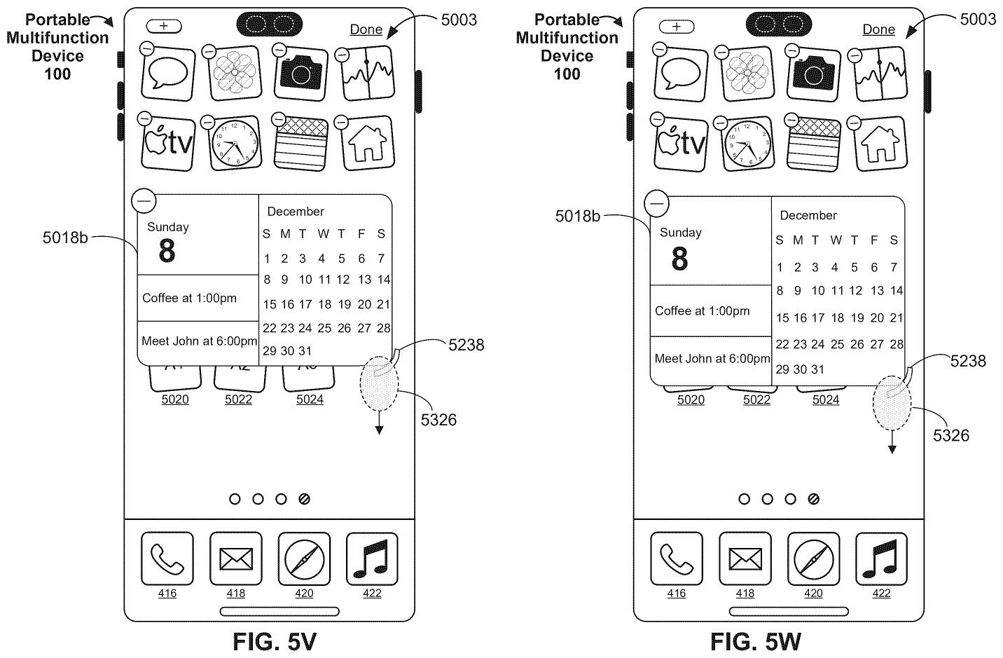

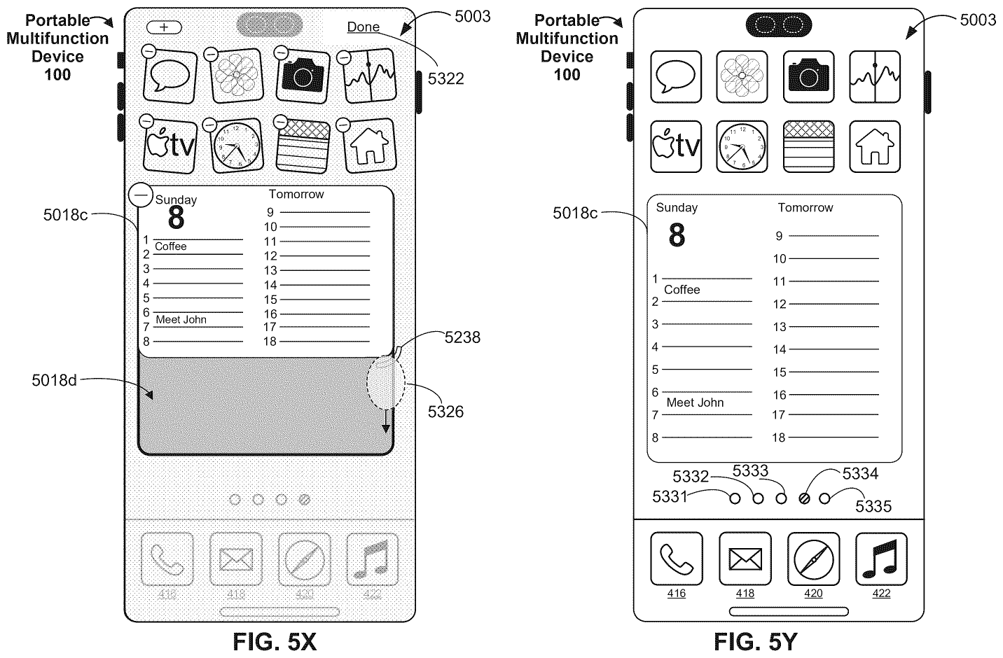

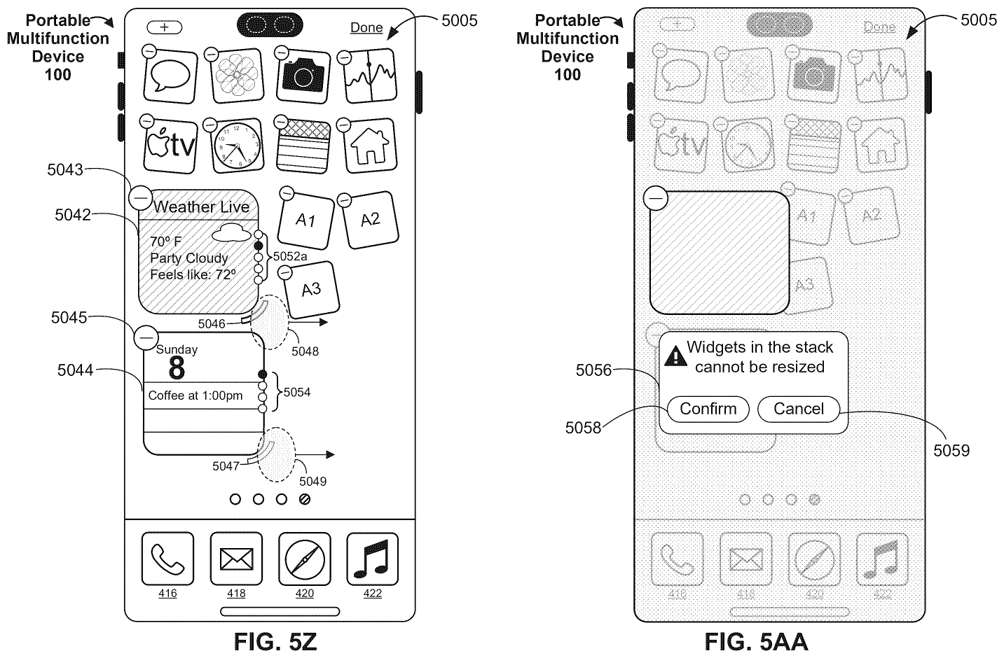

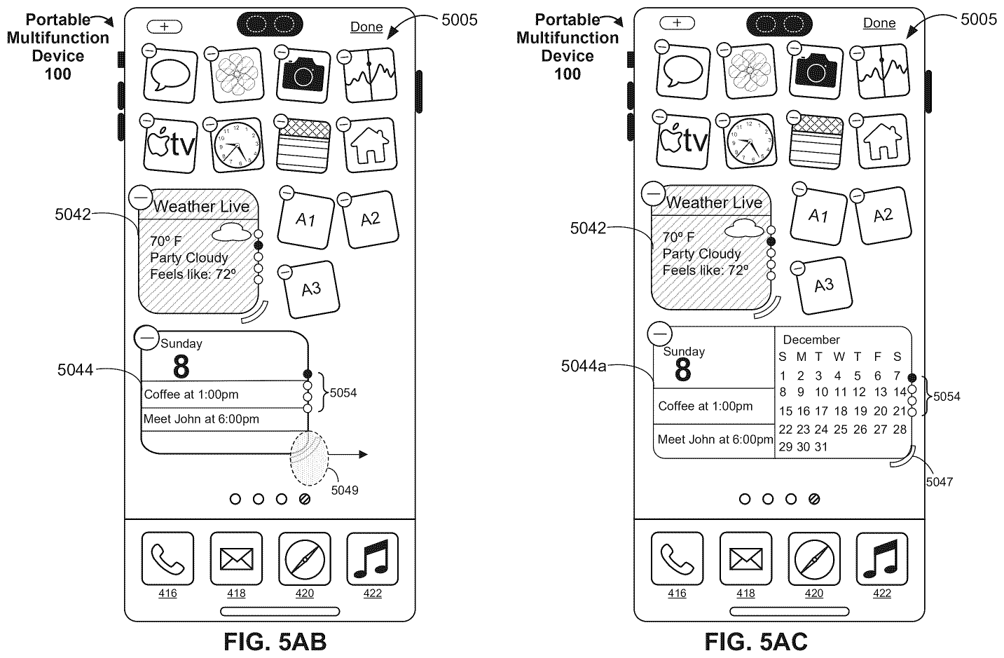

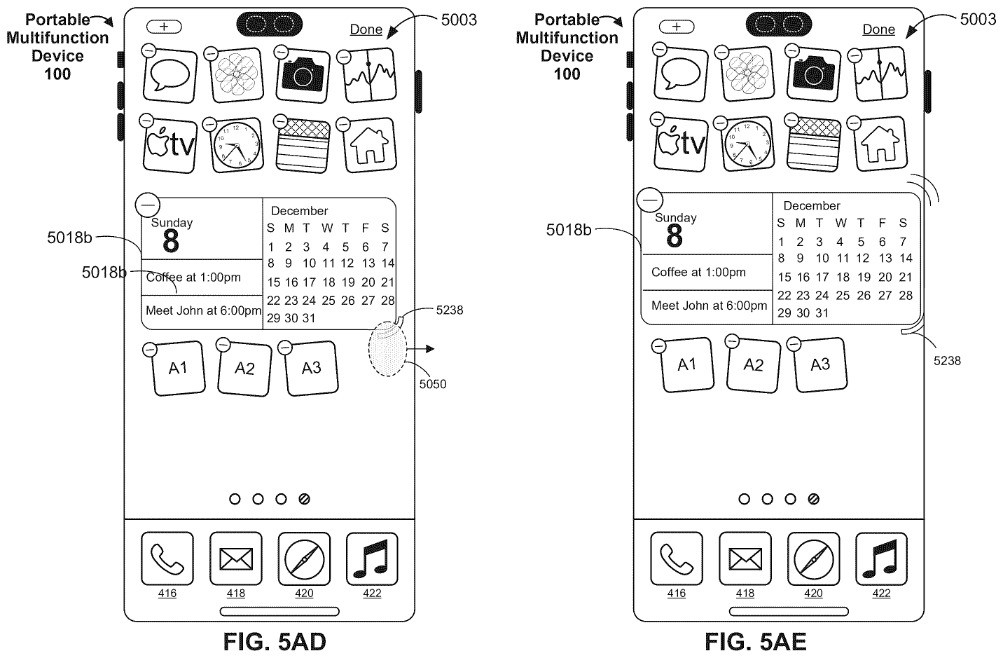

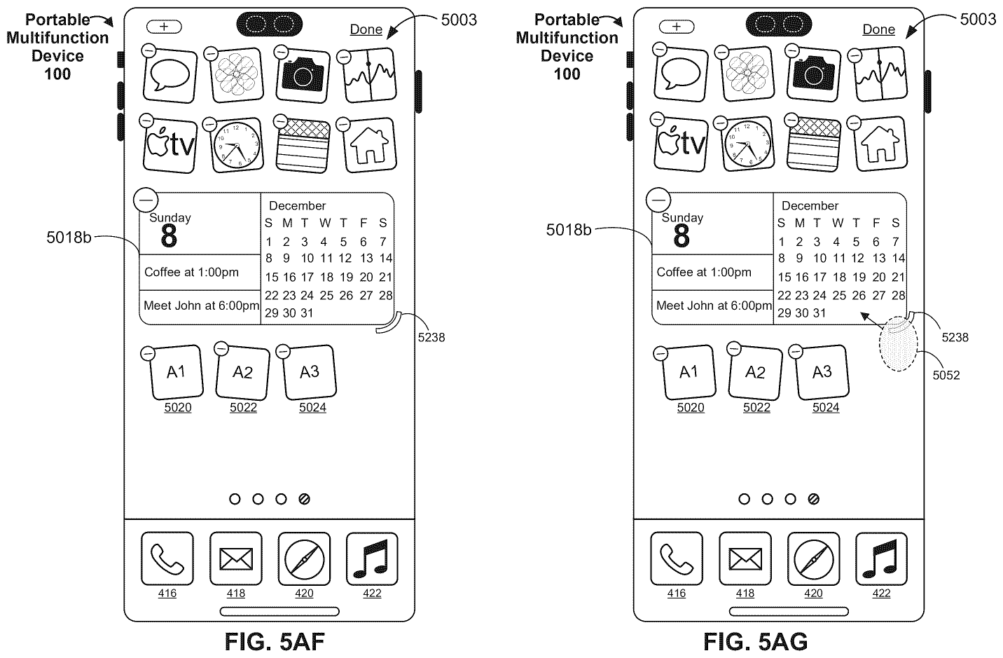

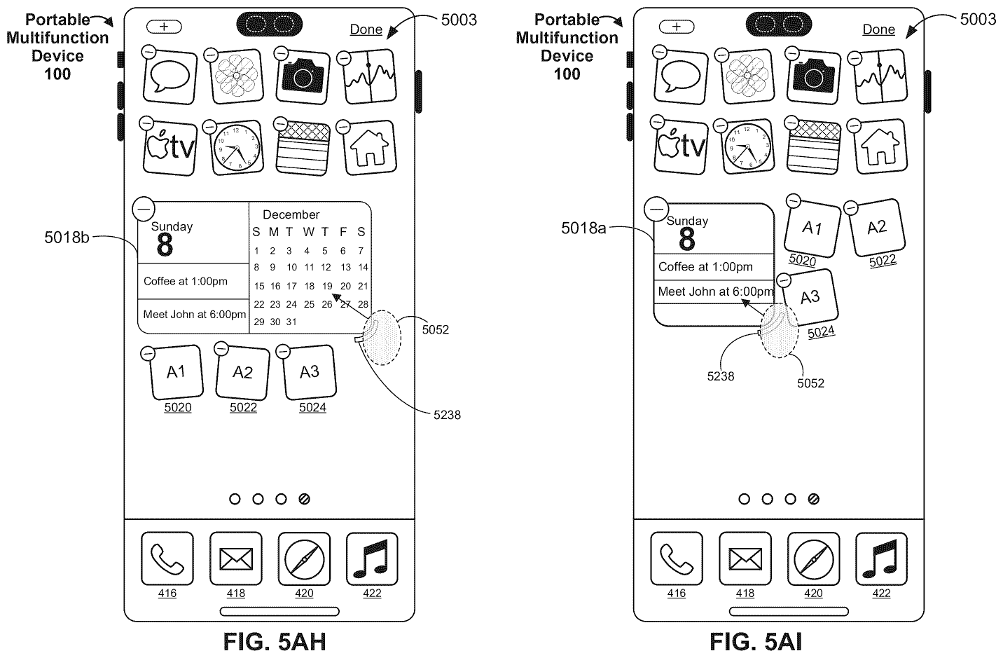

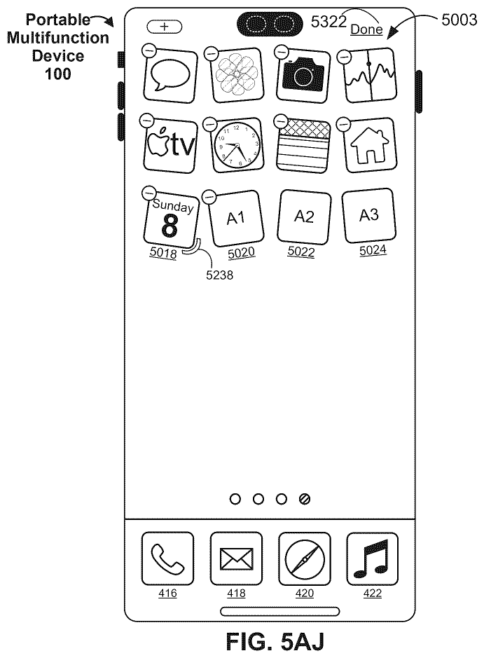

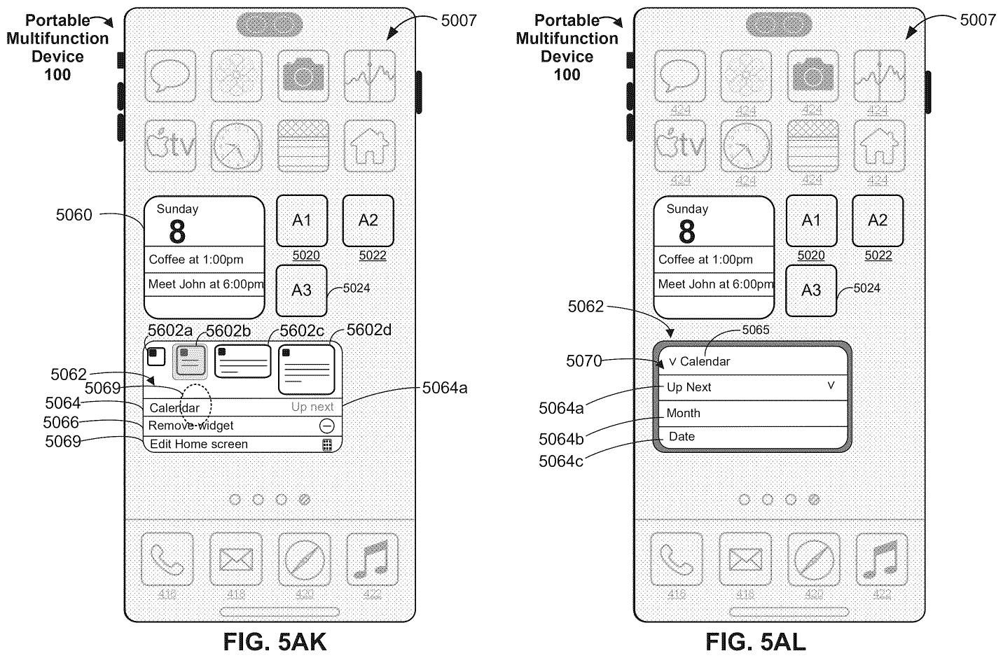

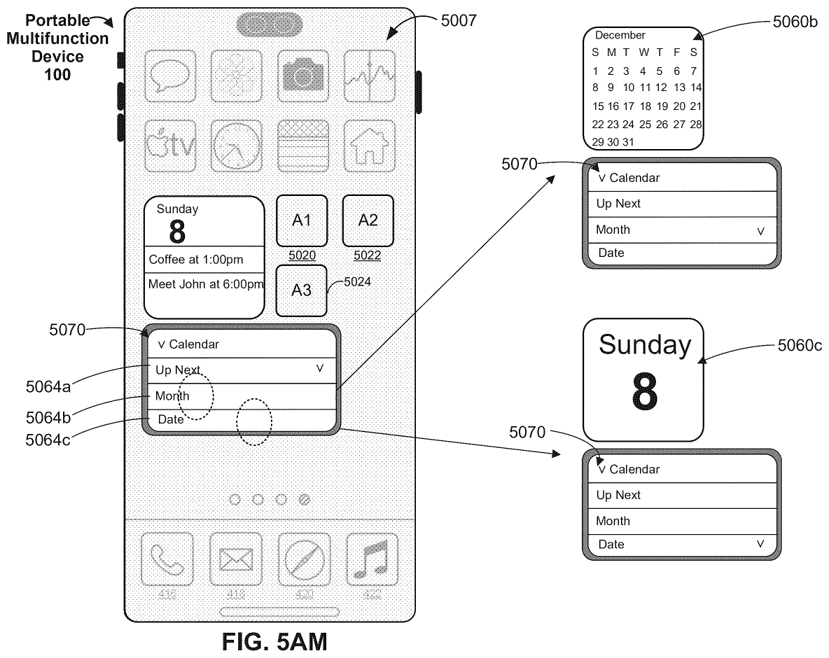

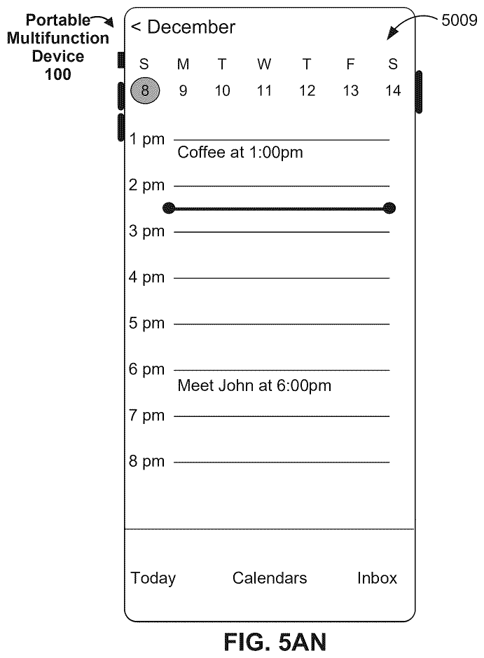

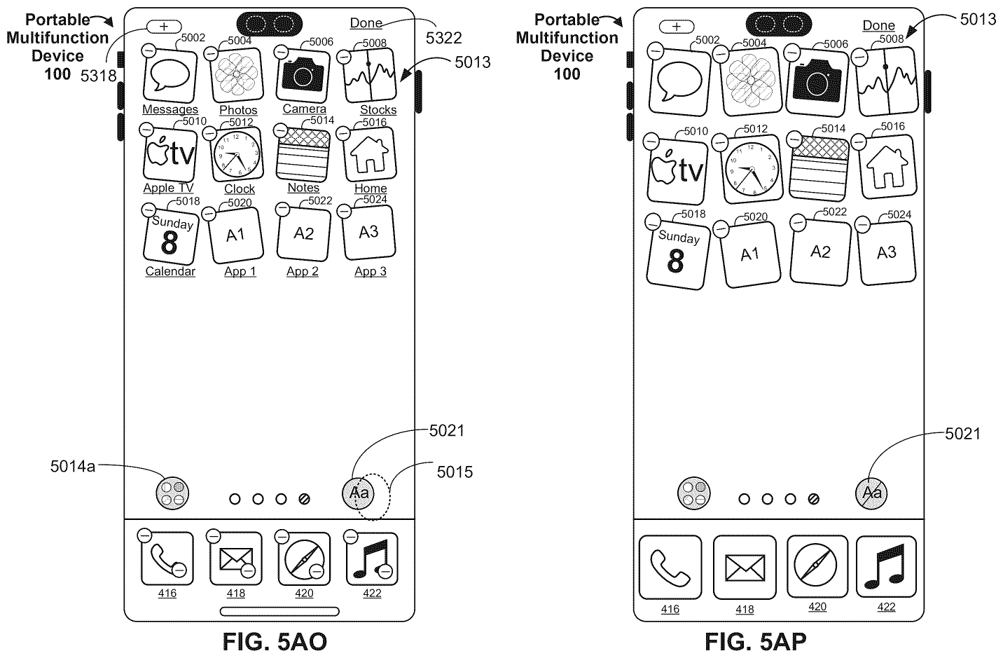

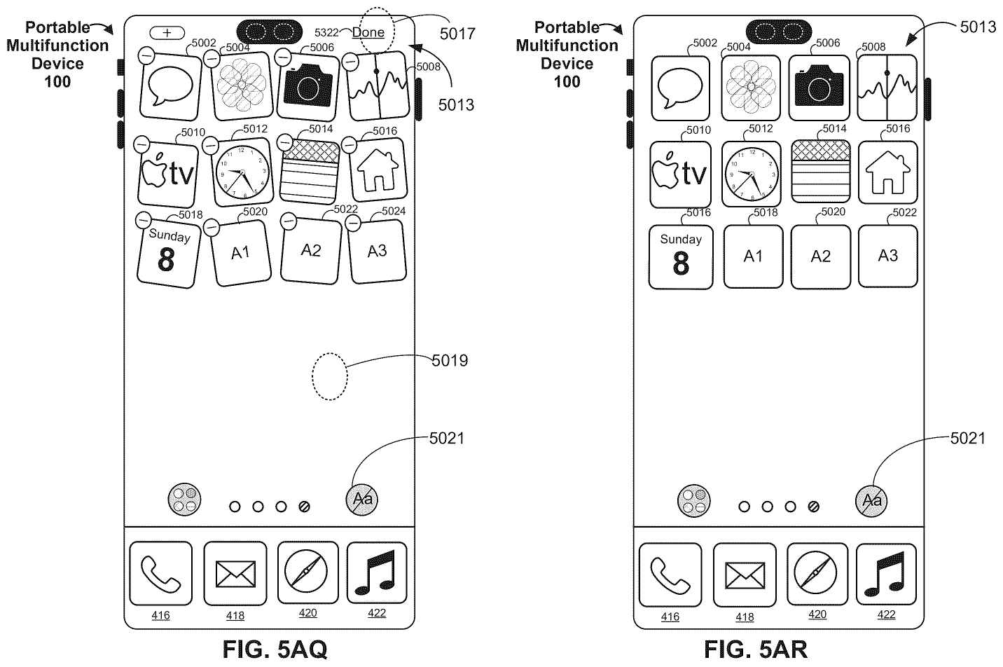

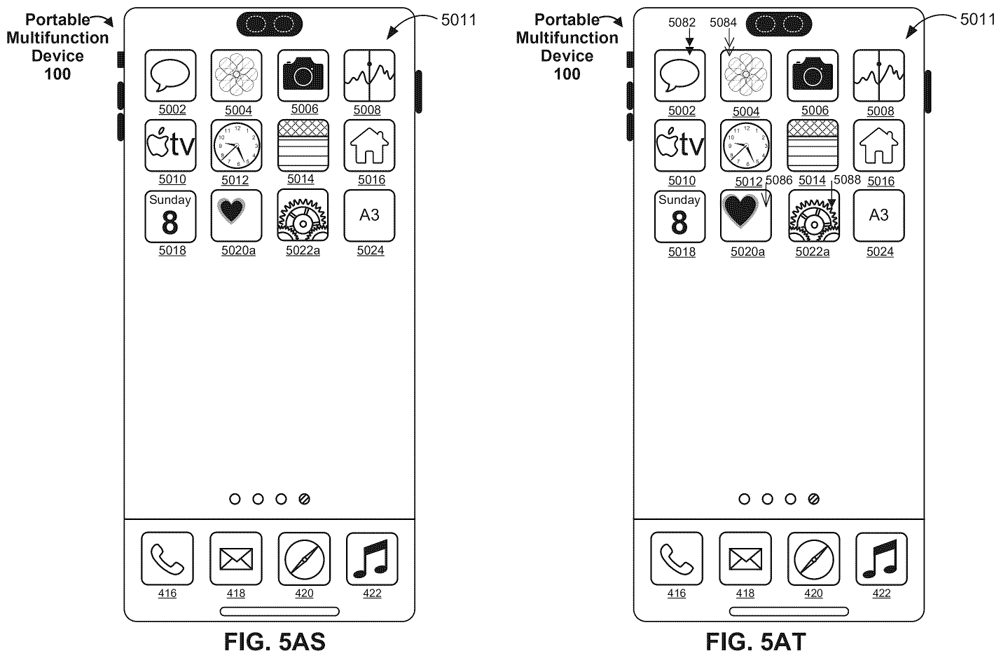

Although FIGS. 5A-5AT, 6A-6AX, 7A-7V, 8A-8Q, and 9A-9AB focus on different aspects of user interfaces and/or interactions with the home screen user interface, it is to be understood that the descriptions of features and elements (e.g., application objects, application icons, application widgets, configuration options, deletion affordances, resize affordances, configuration modes, and other objects and user interface elements) shown in some of FIGS. 5A-5AT, 6A-6AX, 7A-7V, 8A-8Q, and 9A-9AB, unless otherwise stated, are also applicable to similar or identical features and elements shown in and/or discussed with respect to another figure in FIGS. 5A-5AT, 6A-6AX, 7A-7V, 8A-8Q, and 9A-9AB, and features described in different parts of FIGS. 5A-5AT, 6A-6AX, 7A-7V, 8A-8Q, and 9A-9AB and/or descriptions can be combined or separately implemented in one or more embodiments without limitation. For illustrative purposes, the inputs described with respect to FIGS. 5A-5AT, 6A-6AX, 7A-7V, 8A-8Q, and 9A-9AB are shown as touch inputs performed by one or more contacts on a touch-screen display that specifies a target of the inputs based on the touch-location(s) of the contacts. It is to be understood that, in various embodiments, other types of inputs may be used to replace the touch inputs described with respect to FIGS. 5A-5AT, 6A-6AX, 7A-7V, 8A-8Q, and 9A-9AB. For example, for a tap input performed by a contact at a location of a target object or region, an equivalent input may include an air tap gesture that is detected at a location corresponding to the target object or region in a three-dimensional environment, an air pinch gesture that is detected while a gaze is directed to the target object or region, a click input that is detected when a focus selector such as a mouse pointer is located on the target object or region, and/or an activation input on a control device detected while the target object or region has input focus. Similarly, for a swipe gesture performed by a contact moving in a respective direction, with a respective speed, and/or by a respective distance, an equivalent input may include an air swipe gesture performed by a finger or a pair of pinched fingers, a click-hold and drag input performed by a pointing device, such as a mouse. A light press input or long press input that is performed by a contact may be replaced by another type of input that meets an input threshold (e.g., a time threshold and/or intensity threshold) with less than a threshold amount of movement, such as an air pinch gesture that is maintained with less than a threshold amount of movement for at least a threshold amount of time, a down-click input that is held for more than a threshold amount of time with less than a threshold amount of movement before an up-click is detected.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and, optionally, computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (e.g., average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

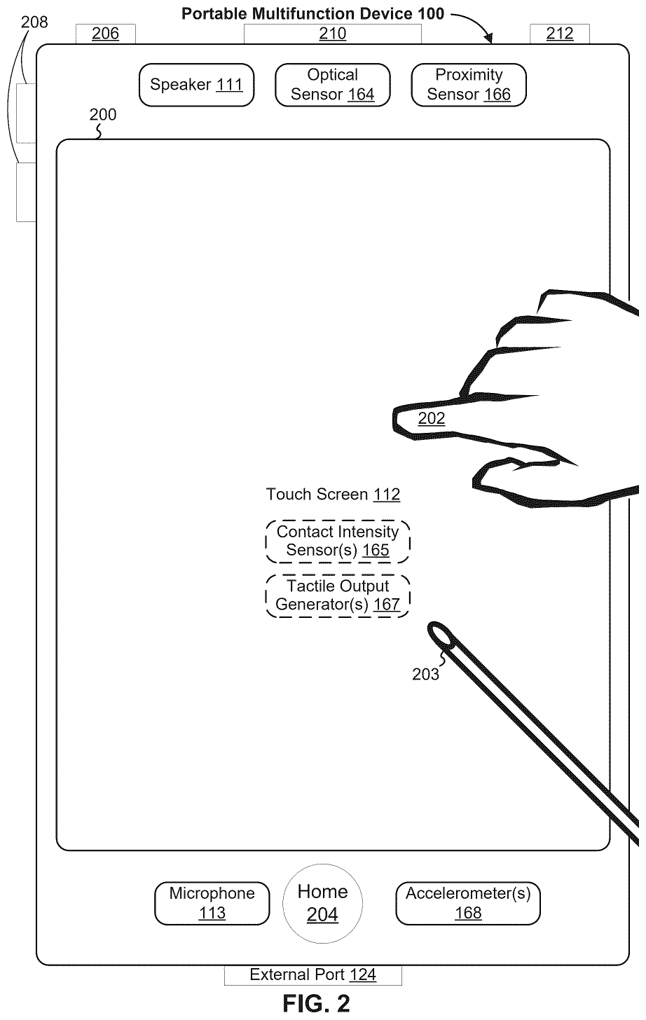

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or, optionally, none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or, optionally, pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (e.g., magnitude), velocity (e.g., magnitude and direction), and/or an acceleration (e.g., a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (e.g., lift off) event at the same position (or, optionally, substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (e.g., lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (e.g., greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

In some embodiments, a gesture includes an air gesture. An air gesture is a gesture that is detected without the user touching (or, optionally, independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or, optionally, independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap Input, a reversal of direction of movement of the finger or hand, and/or a reversal of a direction of acceleration of movement of the finger or hand).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast, or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (e.g., in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (e.g., in FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (e.g., from left to right, right to left, upward and/or downward) and/or a rolling of a finger (e.g., from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (e.g., in FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (e.g., in FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

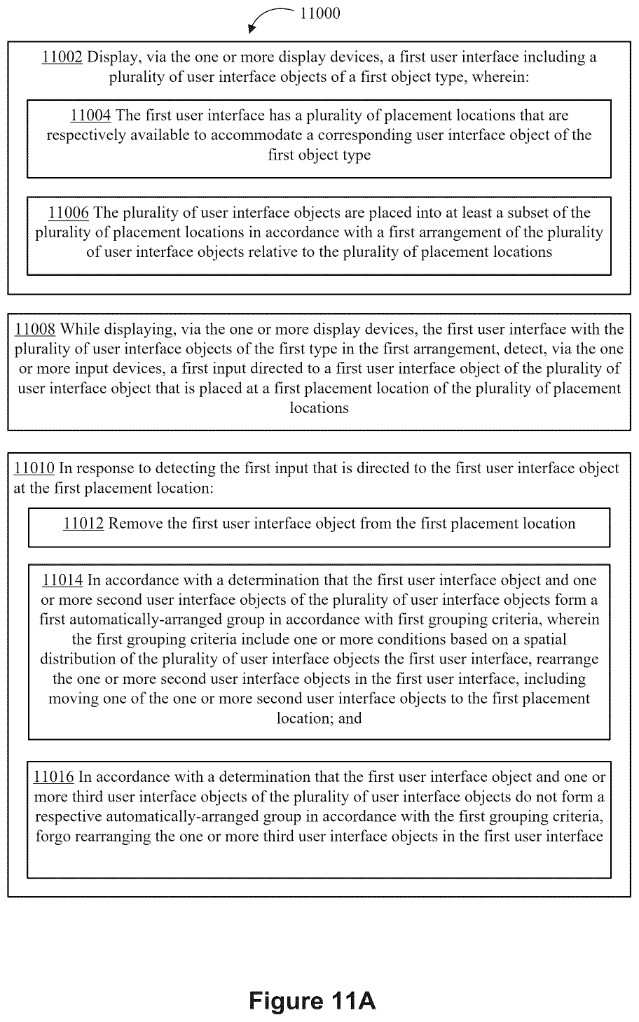

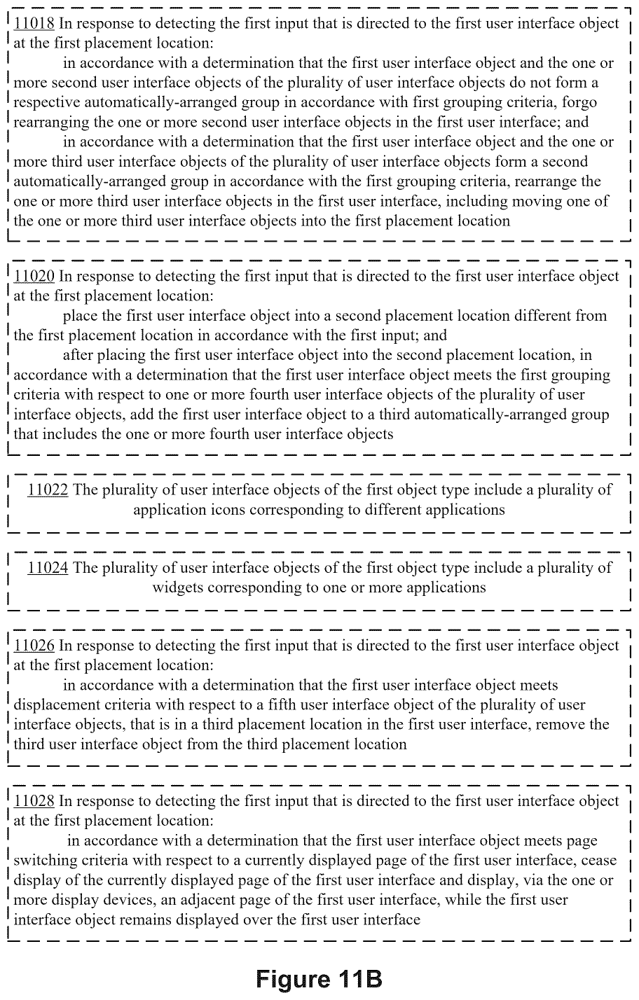

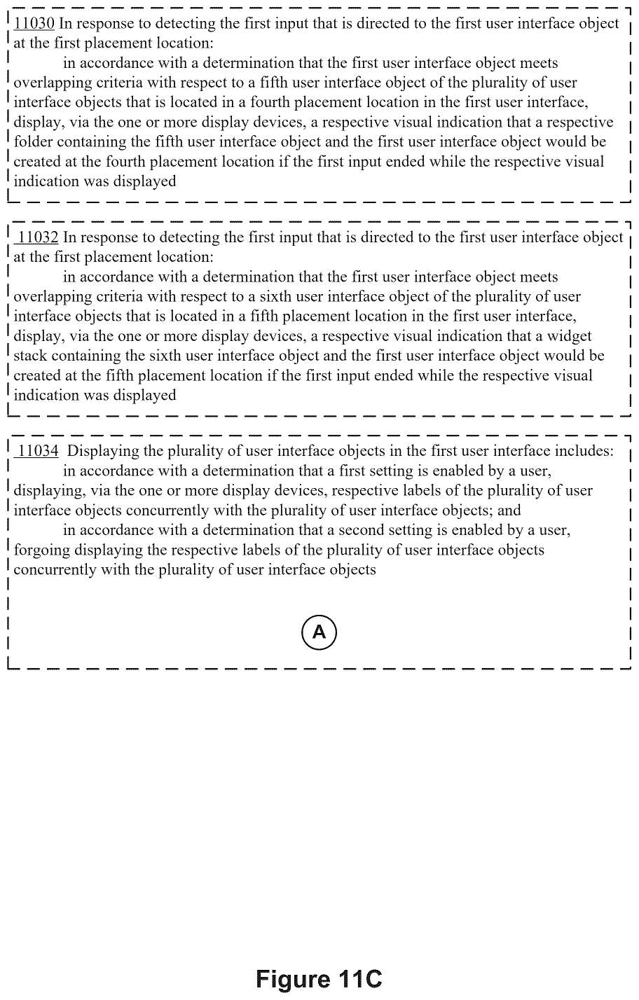

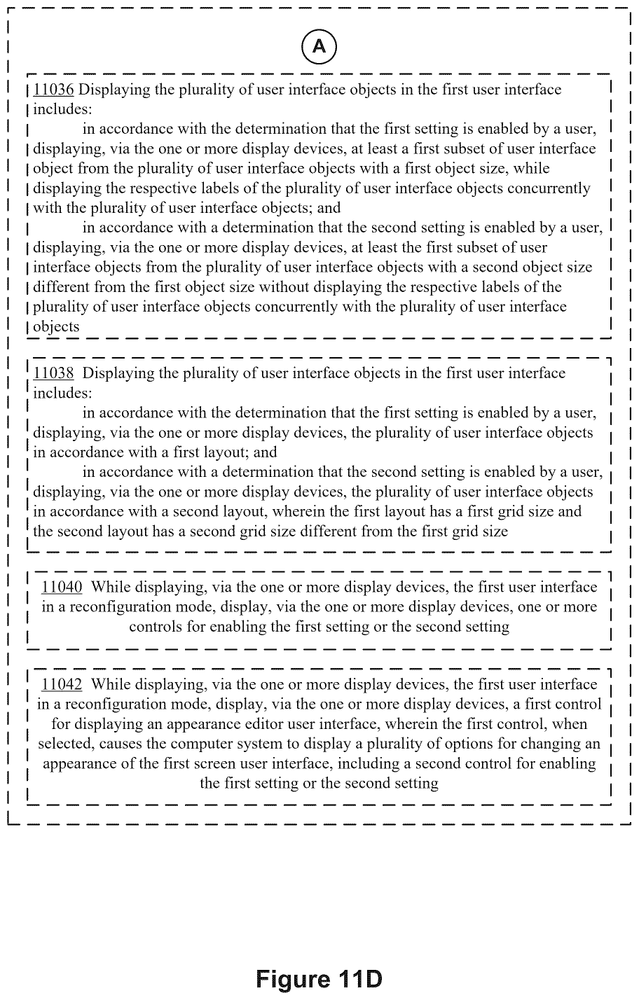

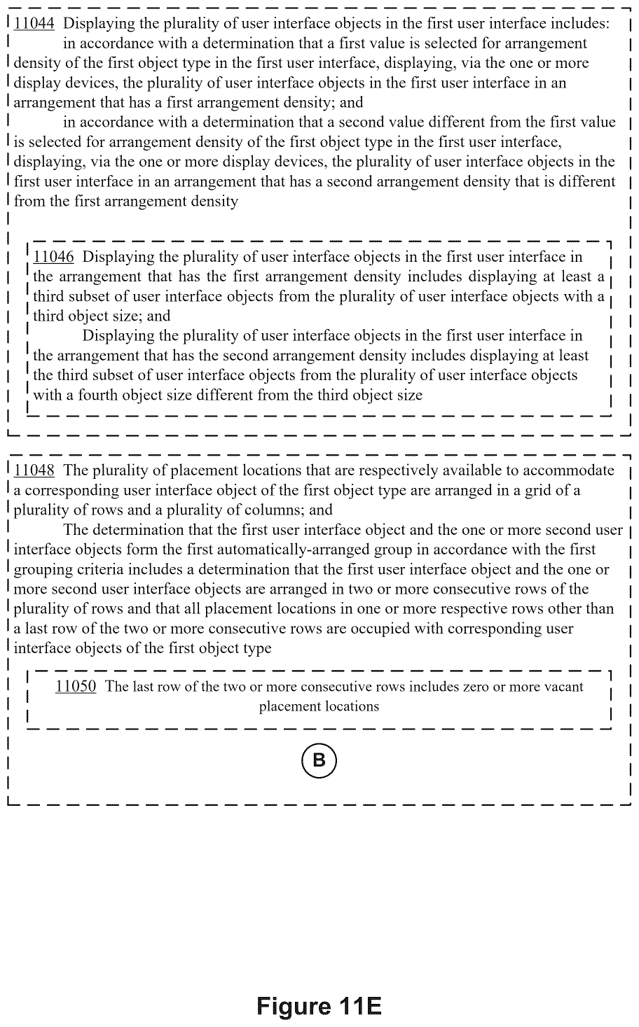

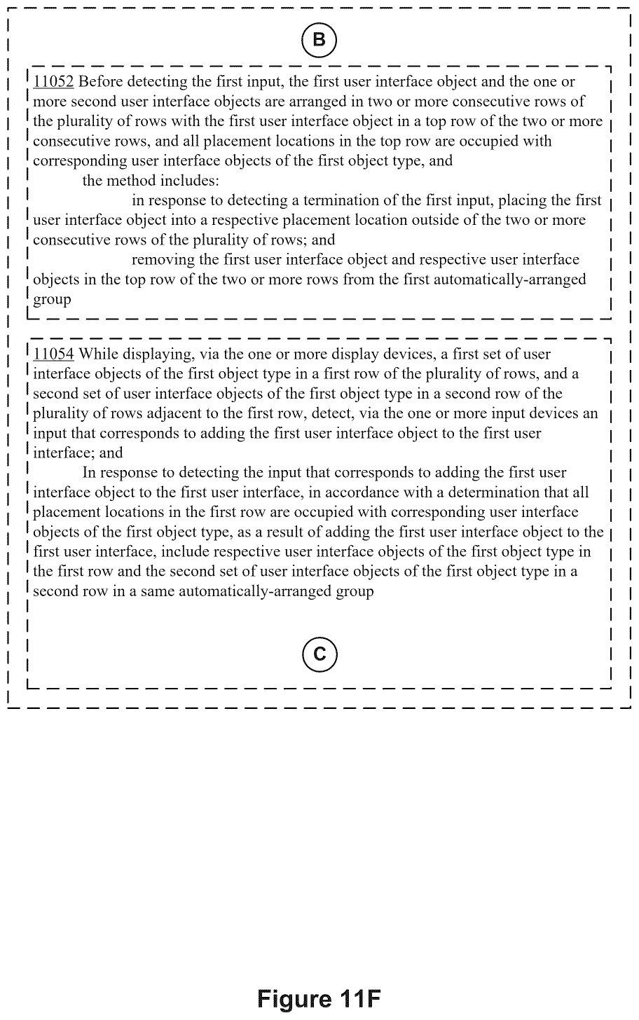

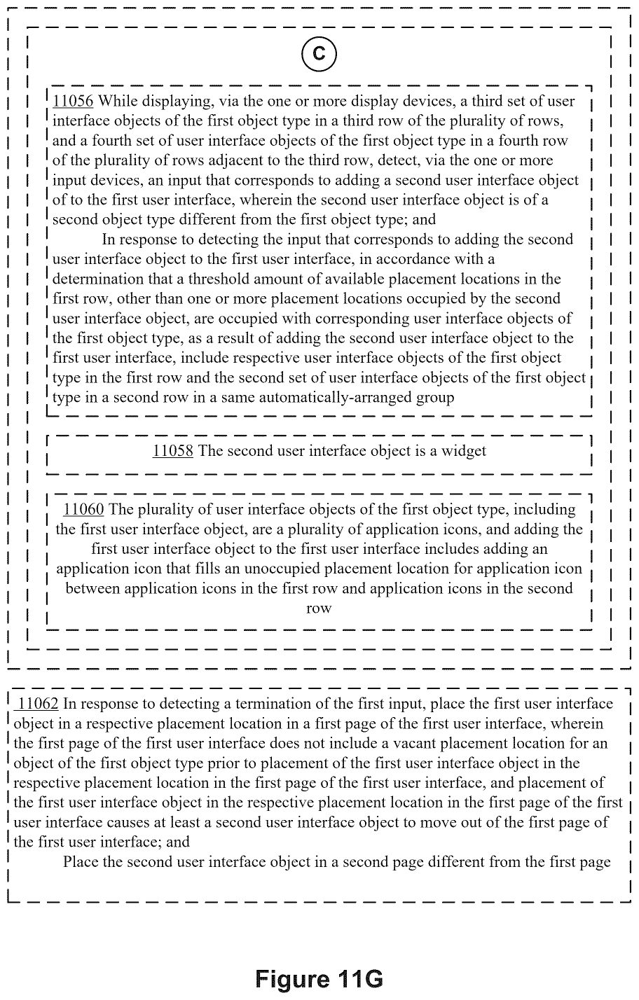

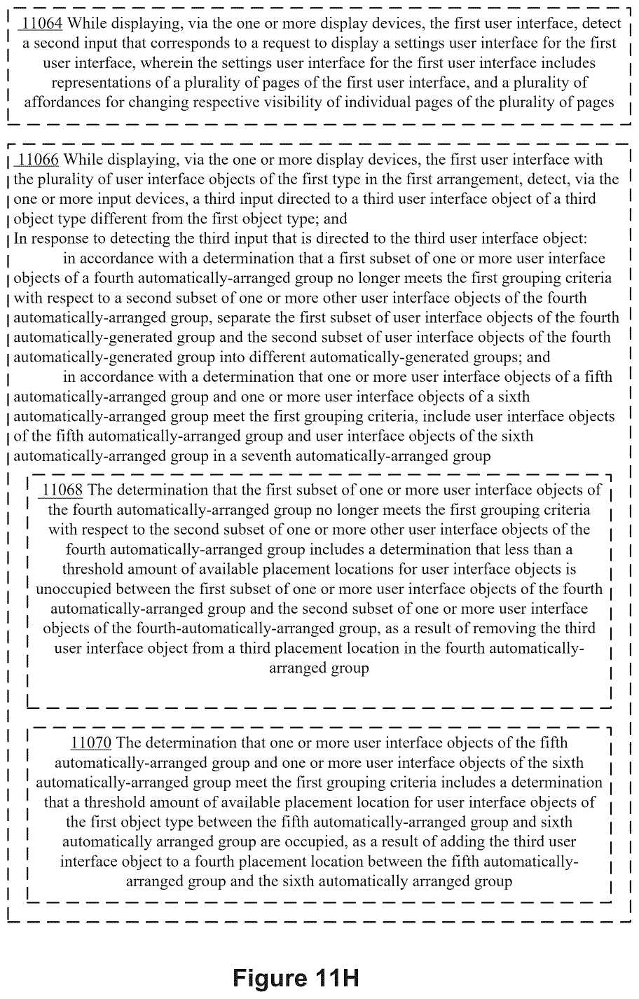

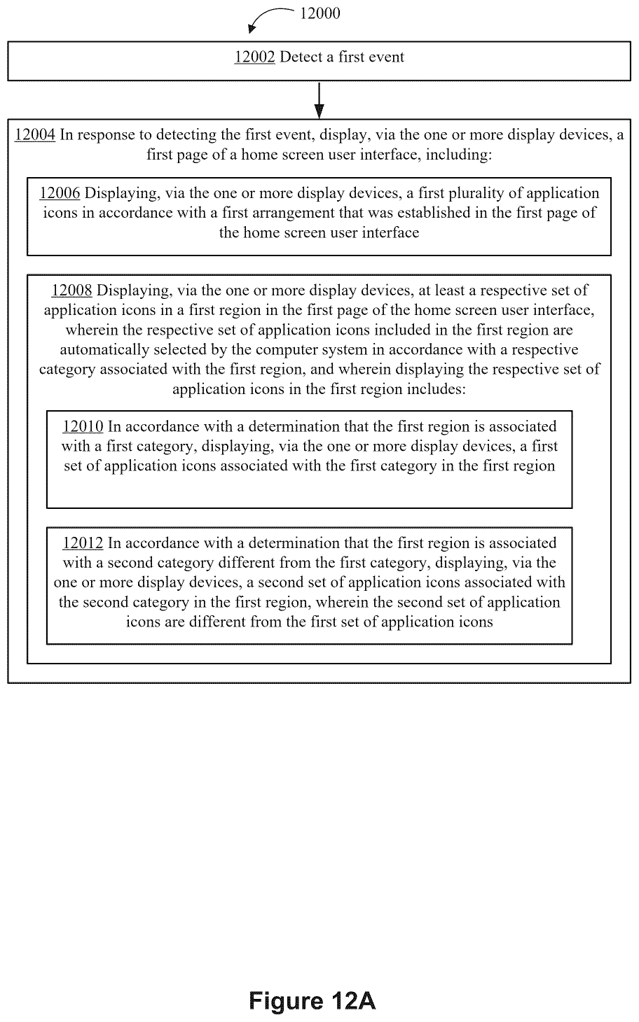

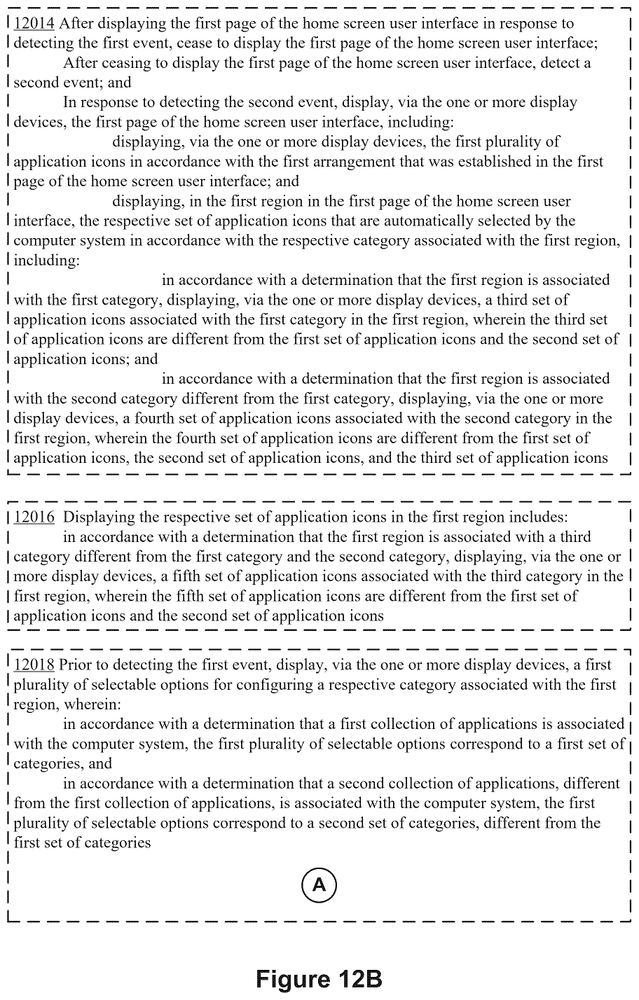

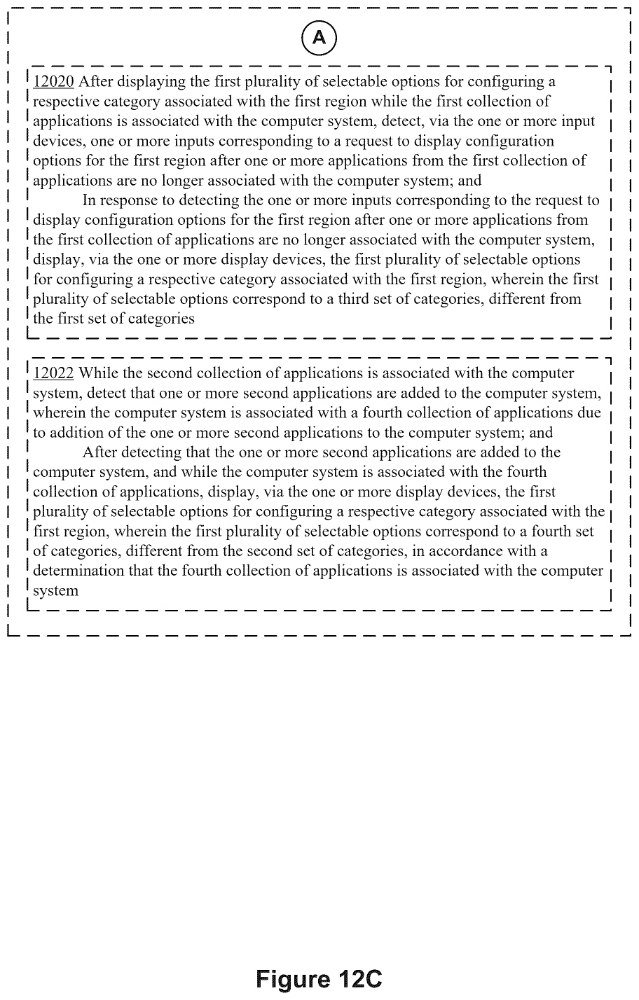

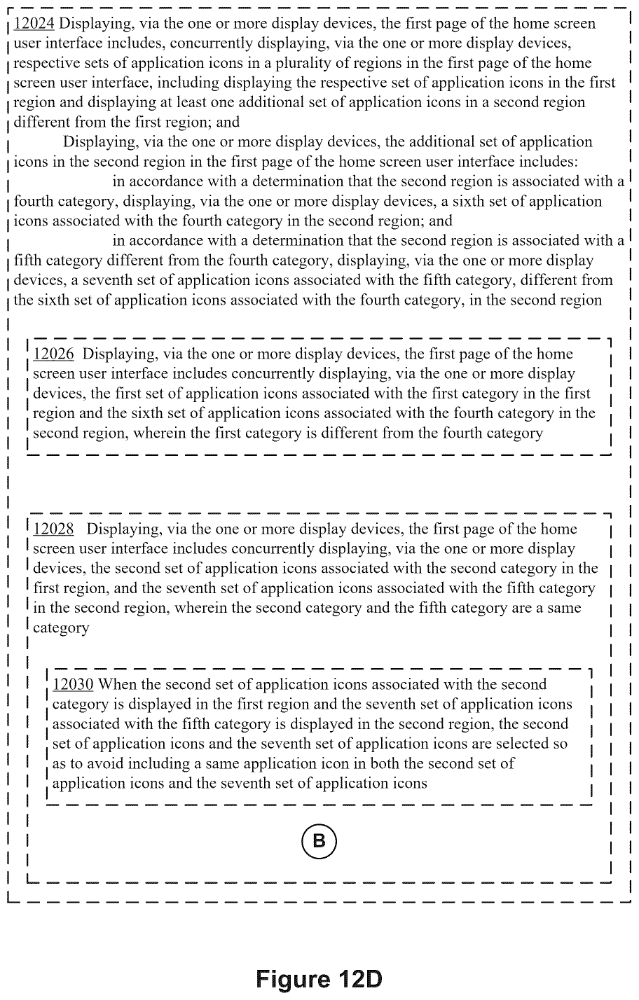

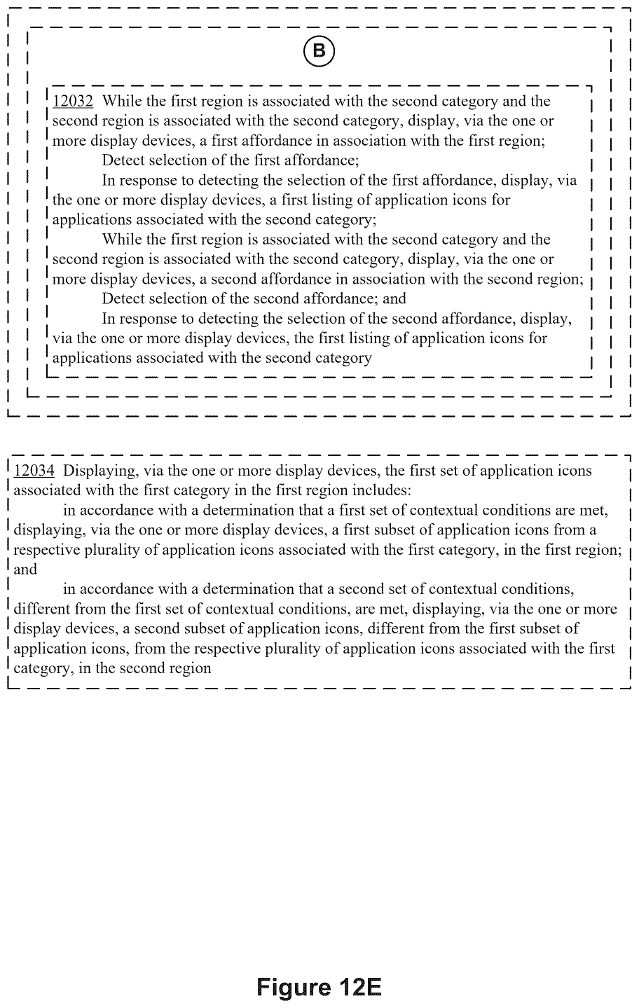

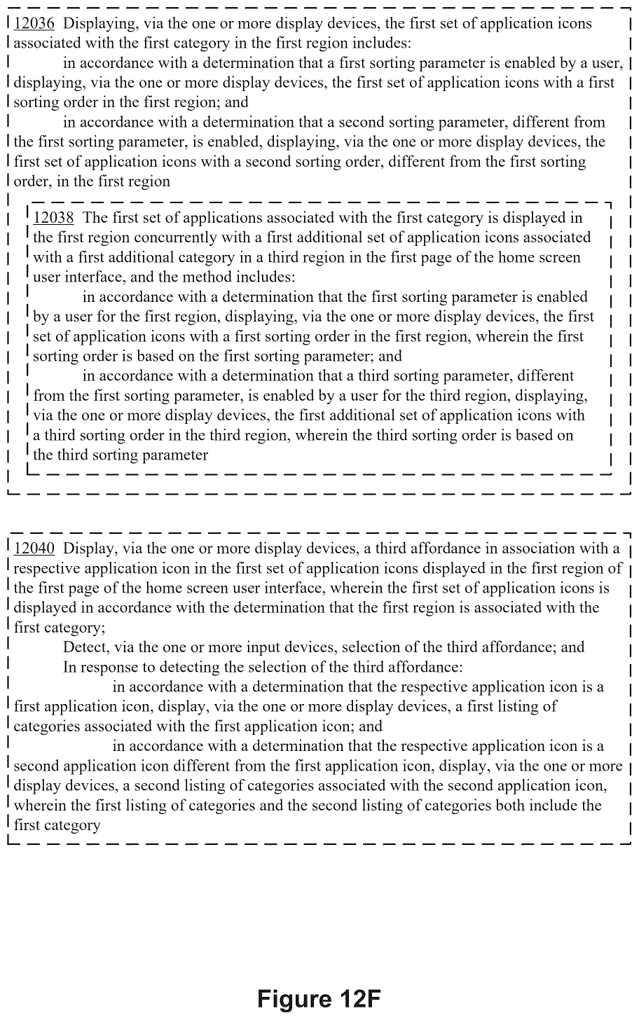

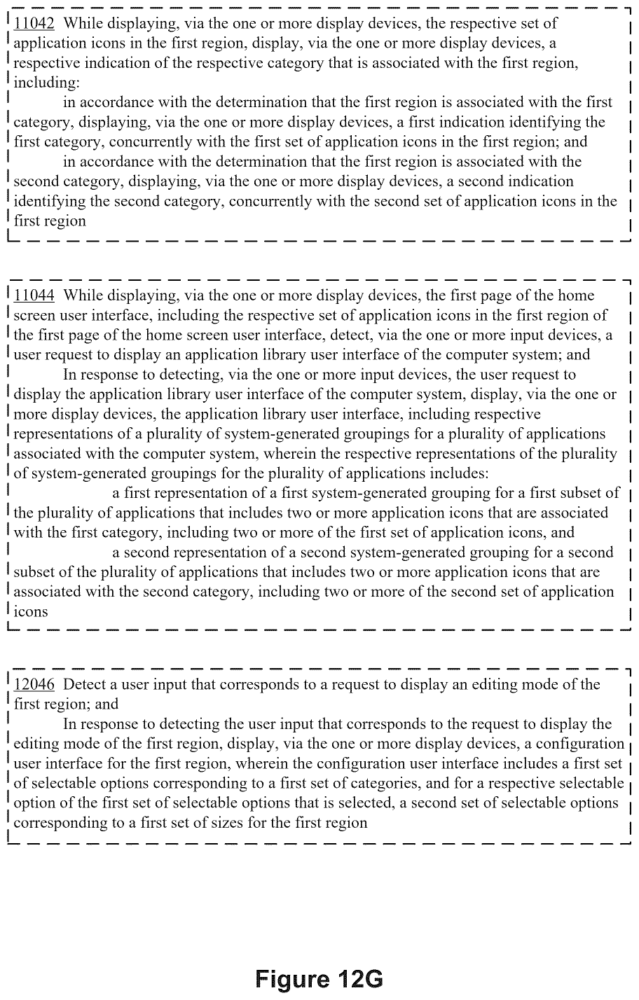

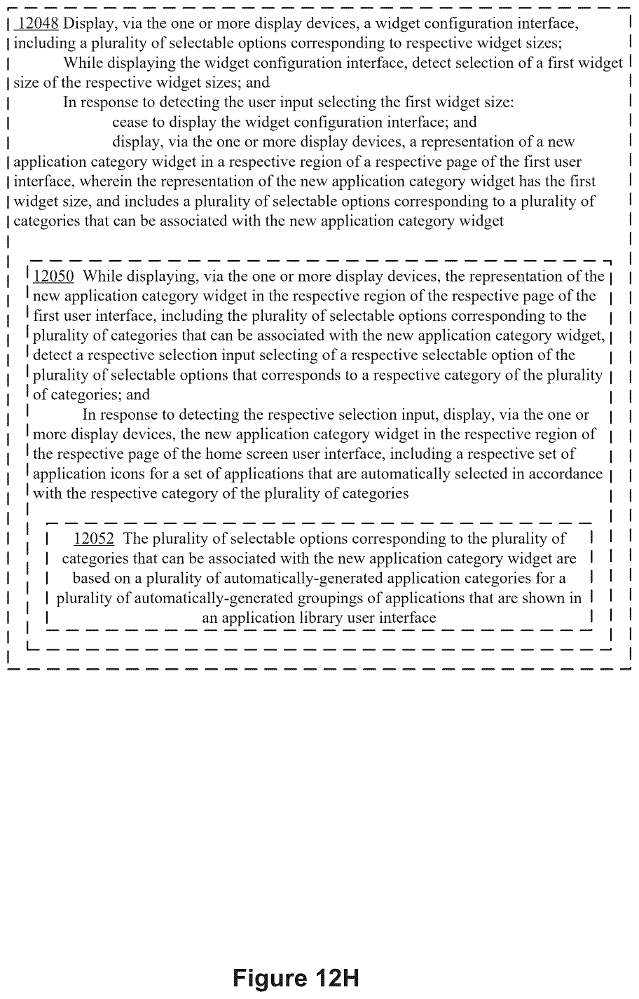

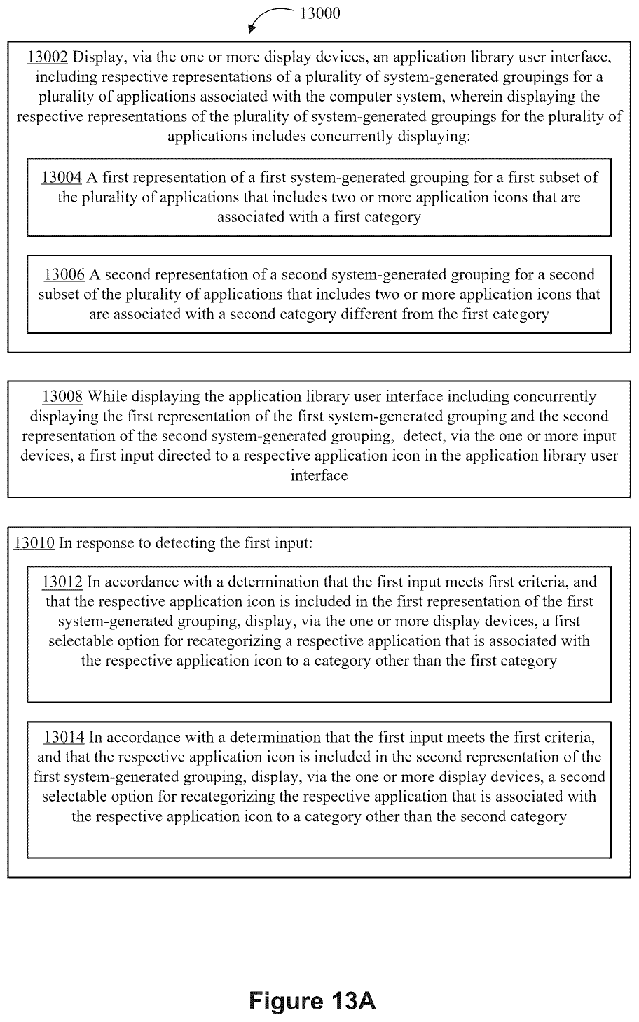

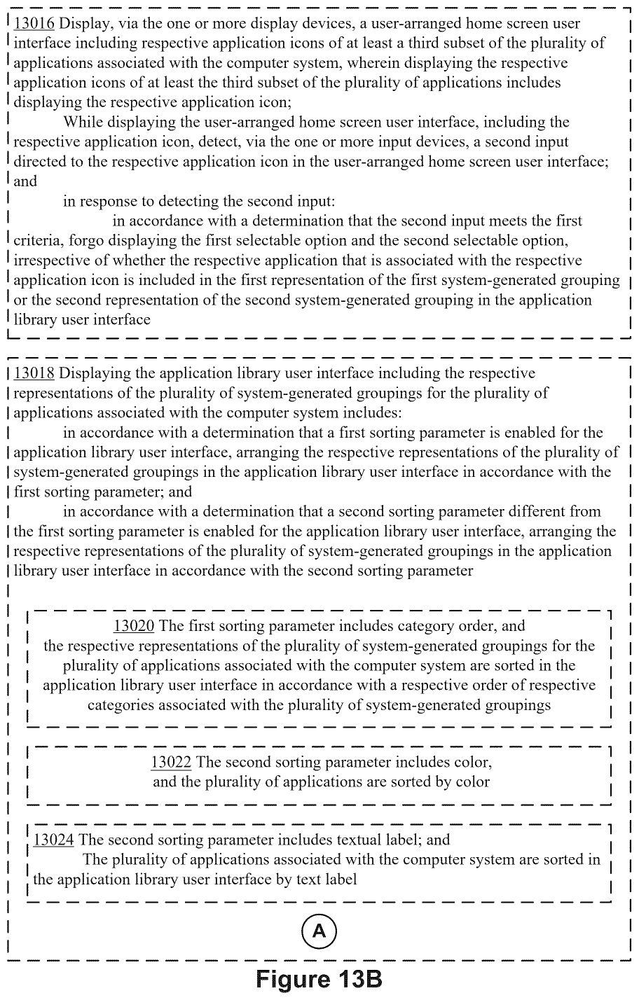

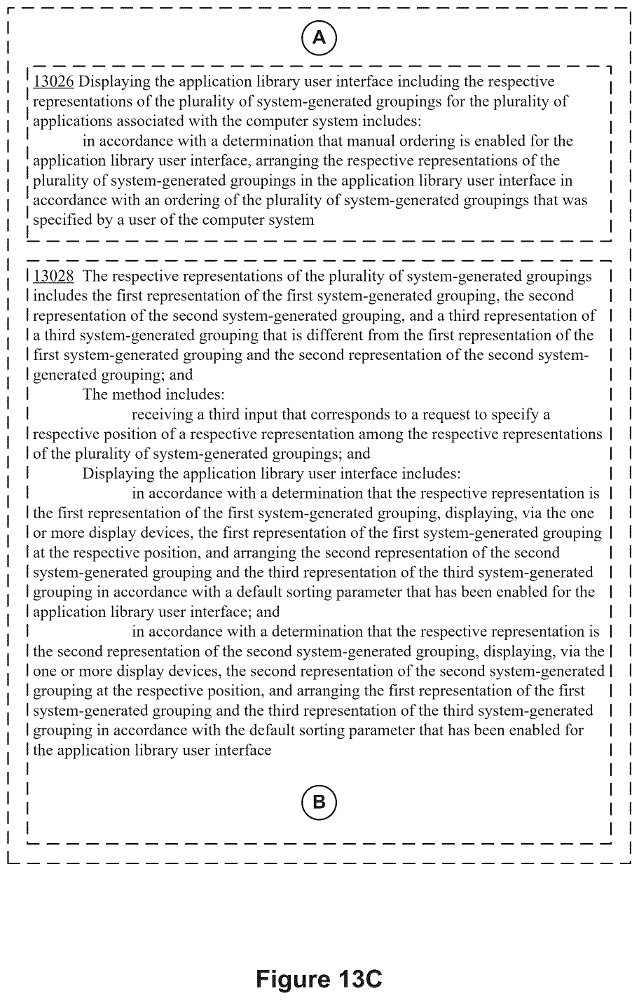

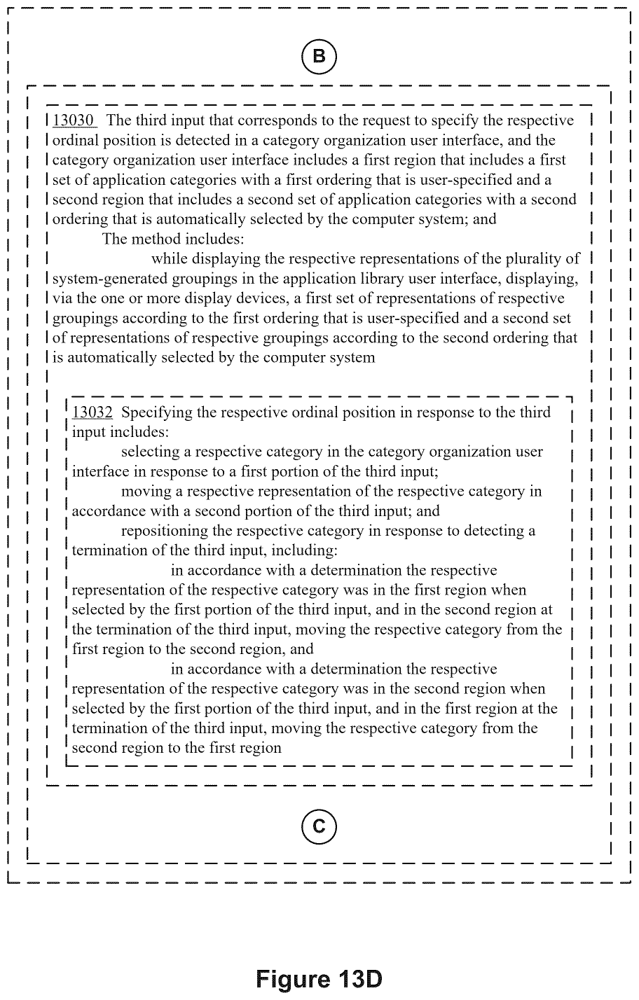

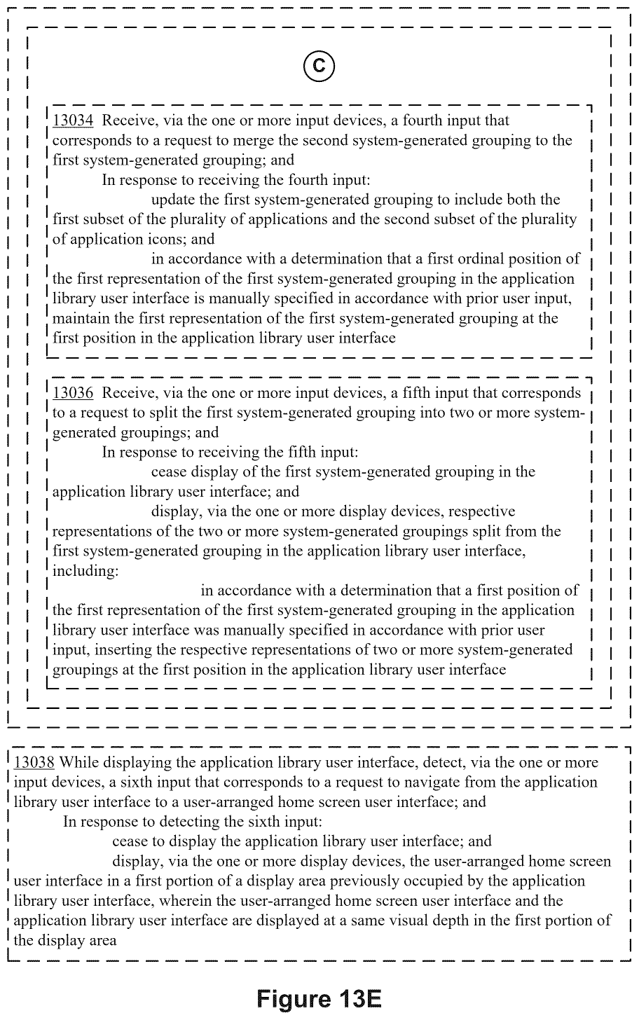

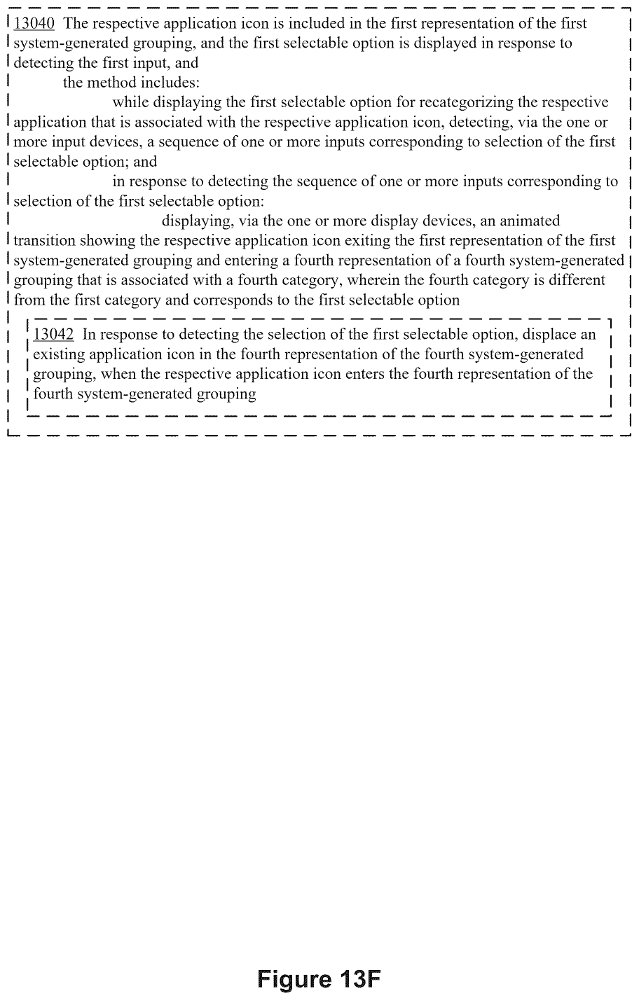

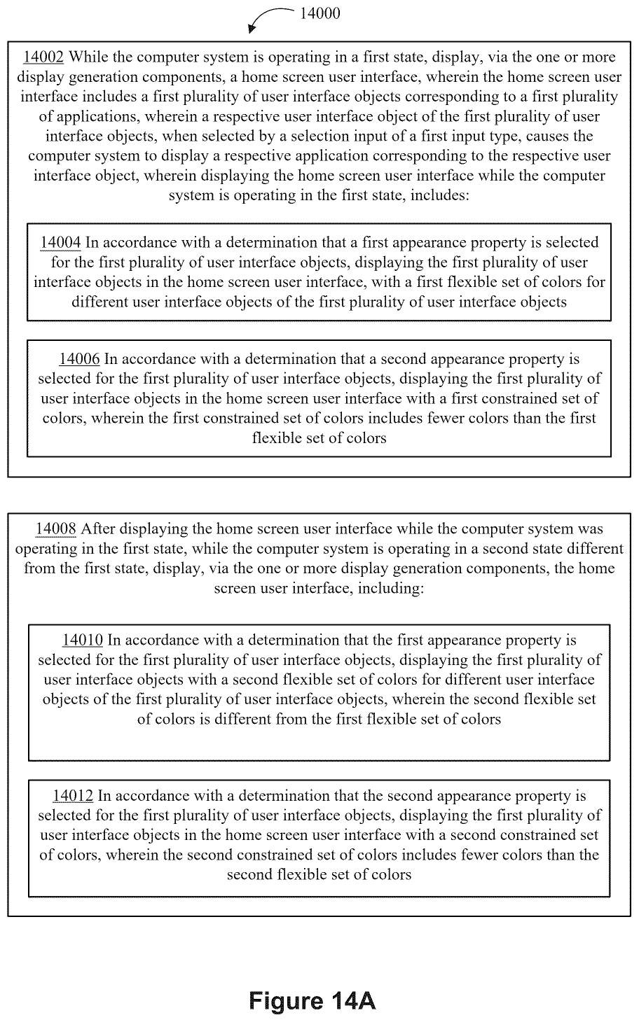

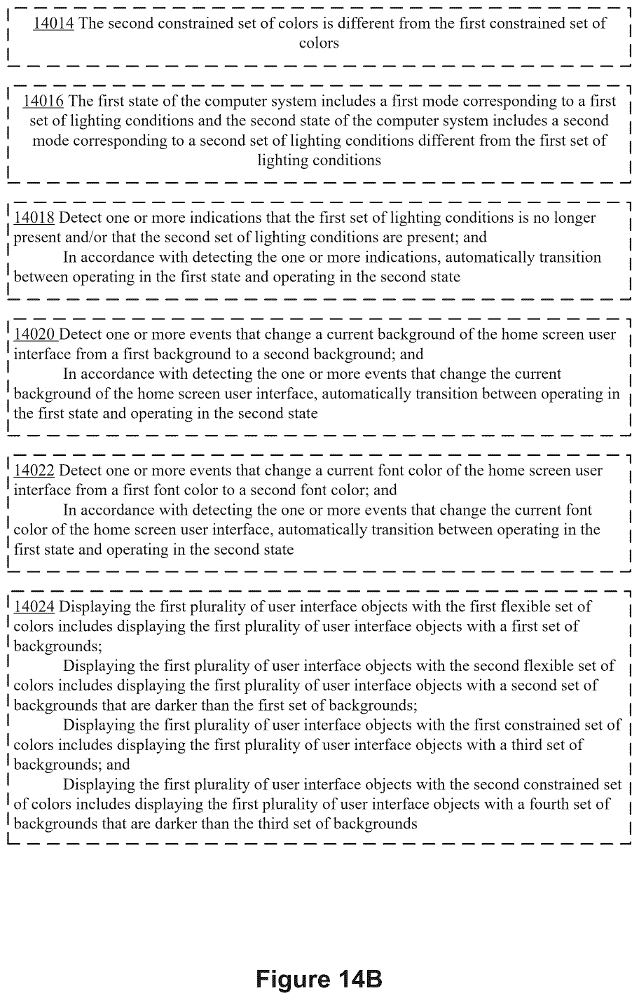

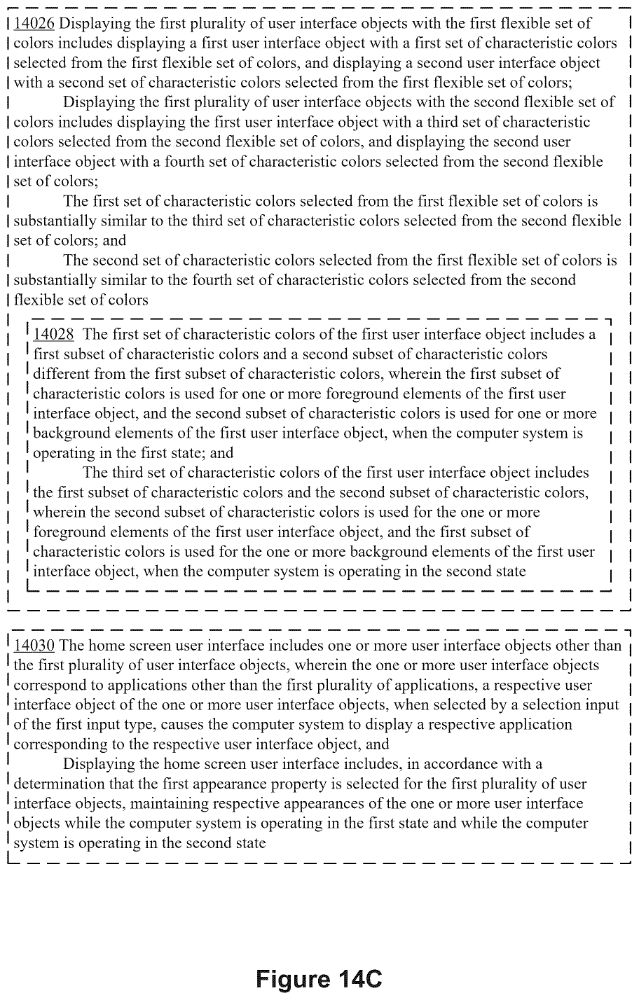

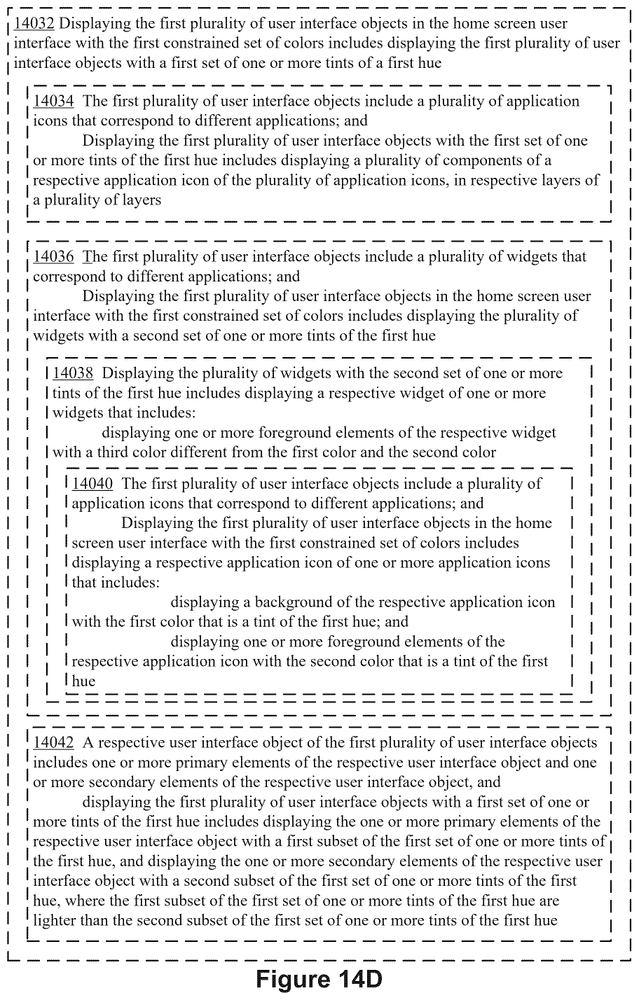

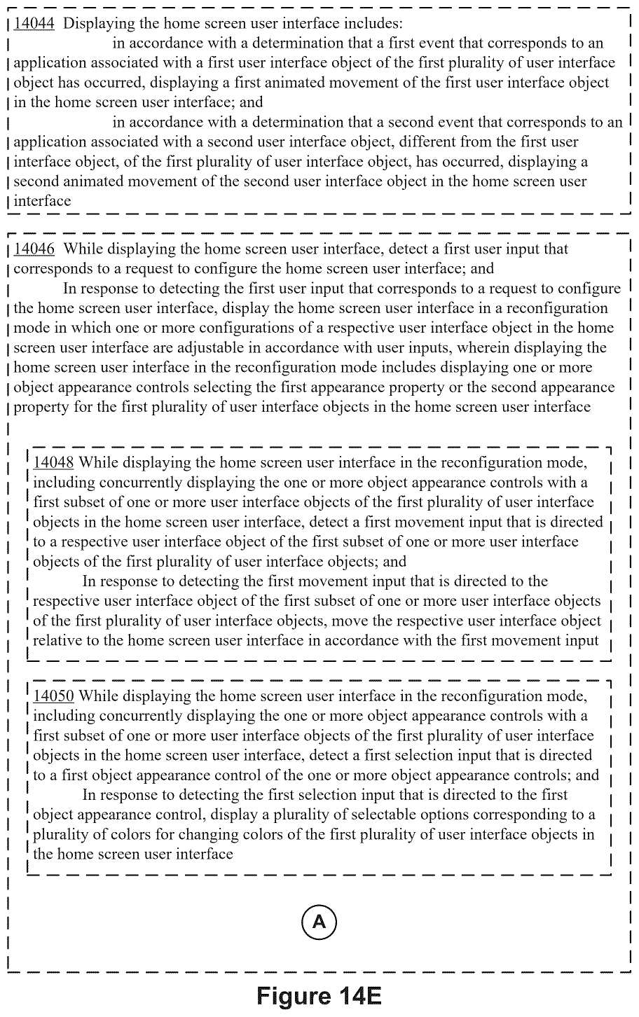

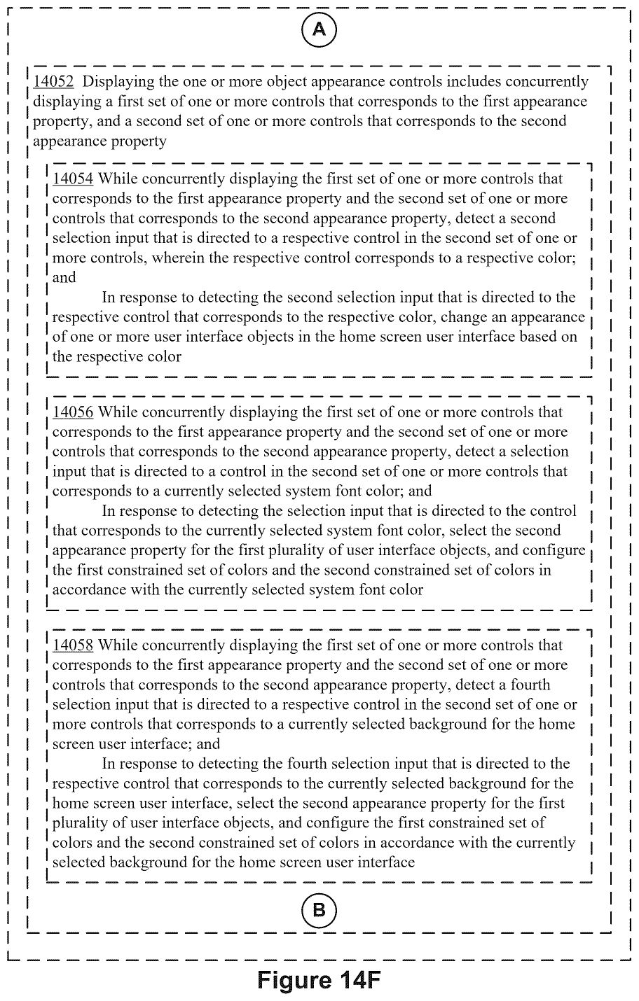

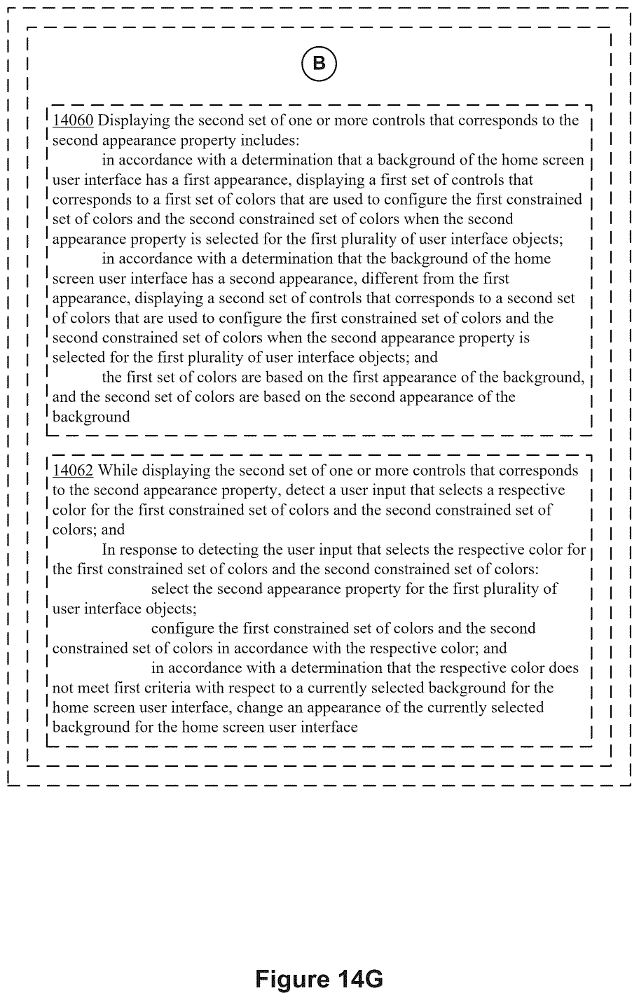

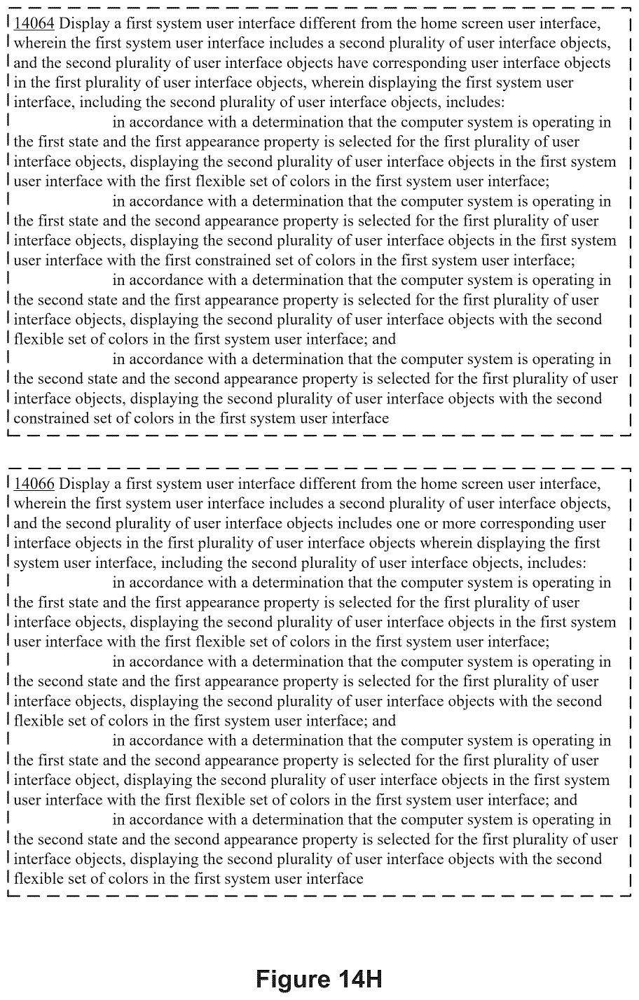

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 10000 (FIGS. 10A-10J), method 11000 (FIGS. 11A-11H), method 12000 (FIGS. 12A-12H), method 13000 (FIGS. 13A-13F) and/or method 14000 (FIGS. 14A-14H) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”;
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136; and
Widgets that include content from respective applications that is updated from time to time without user intervention, such as:
   Widget 448 associated with a weather application; and
   Widget 449 associated with a photos application.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties. In some embodiments, input intensity threshold are replaced by or used in conjunction with other types of input thresholds, such as time thresholds that an input and/or a characteristic of the input is maintained, speed thresholds, and/or distance thresholds for characteristics of a movement of the user input, to determine whether an input meets various criteria for triggering various operations and/or feedback.

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device operates in a standby mode that provides a simplified set of user interfaces and functions, when a set of conditions is met (e.g., device is charging, placed on a docking station, and/or is oriented in a landscape orientation). FIGS. 4C1-4C2 illustrate the navigation states in the normal, non-standby mode. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 for displaying alerts, status updates, and/or current states for various subscribed and/or ongoing events, and/or for various application activities, in real-time or substantially real-time. In some embodiments, the display includes a static status region 4022 for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (e.g., in FIG. 4A) of the multifunction device 100), the multifunction device displays (4100) the wake screen user interface 490 that is the initially displayed system user interface of the multifunction device 100 when the multifunction device transitions from a power off state to a power on state.

In some embodiments, while the wake screen user interface 490 is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state, while the multifunction device 100 is in the low power state. For example, in the low power state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 in the normal, undimmed state. In some embodiments, the multifunction device automatically returns to the low power mode after a short period of time after displaying the alert, notification, and/or the status update.

In some embodiments, the wake screen user interface 490 displayed in the dimmed always-on state includes the same or substantially the same set of user interface elements as the wake screen user interface 490 displayed in the normal operating state (e.g., as opposed to the dark screen shown in FIGS. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)) In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained). In some embodiments, the notifications displayed in the wake screen user interface may, at various times, include un-summarized notifications where the notification content of an un-summarized notification includes application content corresponding to a respective event that triggered the notification, without including a summary of the application content, and/or summaries of notifications, where the summary content of a summary for a single event includes automatically generated summary of application content corresponding to a respective event that triggered the notification, and the summary of multiple related events includes automatically generated summary of application content corresponding to multiple related events that triggered multiple notifications.

In some embodiments, the wake screen user interface 490 may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced and/or alternative selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced and/or alternative selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data).

In some embodiments, the upward swipe gesture 4105 is a representative example of a home gesture or dismissal gesture (e.g., other examples include upward swipe gestures 4103a, 4103c, 4103d, 4103e, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492).

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or, optionally, another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or, optionally, another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application. In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion (and/or the left portion) of the top edge of the wake screen user interface (e.g., as illustrated in FIG. 4C2) causes (4109a) the multifunction device to display the control user interface 498 overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (WiFi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or, optionally, another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498). Additional features and details regarding the control user interface 498 and user interactions related to the control user interface 498 are disclosed in other parts of this specification.

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492, and another upward swipe gesture that starts from the bottom edge of the home screen user interface 492 does not cause the multifunction device to dismiss the home screen user interface 492 and return to the wake screen user interface 490. In other words, once the navigation from the wake screen user interface 490 to the home screen user interface 492 is completed, the multifunction device is no longer in the restricted state, and access to the application icons displayed on the home screen user interface 492 and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface (e.g., irrespective of whether the home screen user interface was the last displayed user interface prior to displaying the currently displayed user interface).

As shown in FIG. 4C2, once the multifunction device navigates away from the wake screen user interface 490 and displays the home screen user interface 492, the user can access the functions and applications of the multifunction device without restriction. For example, in some embodiments, the home screen user interface 492 includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon. More details regarding customization, reorganization, and other aspects of the organization, appearance, customization and/or interactions with the home screen user interface and objects included in the home screen user interface are provided below.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or, optionally, another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode. More details regarding the reconfiguration of the home screen user interface are provided below.

In some embodiments, while displaying the home screen user interface 492, a downward swipe gesture 4108a that starts from the top edge of the home screen user interface 492 causes (4108a) the multifunction device to cover the home screen user interface 492 with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or, optionally, displaying application user interfaces of multiple applications in a concurrent-display configuration), a downward swipe gesture 4108b that starts from the top edge of the application user interface(s) causes (4108b) the multifunction device to display the coversheet user interface 496 (e.g., in FIG. 4C1) (or, optionally, the wake screen user interface 490 in FIG. 4C2) over the application user interface(s). The multifunction device dismisses the coversheet user interface 496 (or, optionally, the wake screen user interface 490) and redisplays the application user interface(s) in response to an upward swipe gesture that starts from the bottom edge of the coversheet user interface (or, optionally, another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or, optionally, another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

In some embodiments, when the device is placed on a docking station or is connected wirelessly or through a contact-based connection (e.g., via electronic connection, or magnetic connection) to a charging source, rotation of the display when the wake screen user interface is displayed and/or when the device is in the low power state, cause the device to enter a standby mode, where a different set of navigation states are made available. In some embodiments, swiping in the vertical direction causes the device to navigate between different versions of a functional “face” (e.g., a user interface that provides a primary function, such as a “clock” face, a “weather” face, a “calendar” face, a “stock” face, a “photos” face, a “widget” face, or user interface that provides another function), while swiping in the horizontal direction cause the device to navigate between different functional faces. In some embodiments, swiping downward from the upper right corner of the display causes the device to display a “control” face that includes controls for various control functions of the device. Swiping upward from the bottom edge of the display when the “control” face is displayed causes the device to dismiss the “control” face and redisplay the last displayed functional face.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

### User Interfaces and Associated Processes

Attention is now directed towards embodiments of user interfaces (“UI”) and associated processes that may be implemented on an electronic device (or, optionally, computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AT illustrate example user interfaces and interactions for transforming an application object from one type to another without navigating away from a currently displayed user interface (e.g., directly from a home screen user interface in which the application object is displayed) and user interfaces and interactions for reconfiguring the home screen user interface. FIGS. 10A-10J are a flow diagram of an exemplary method 10000 for transforming an application object from one type to another without navigating away from a currently displayed user interface (e.g., directly from a home screen user interface in which the application object is displayed) and reconfiguring the home screen user interface, in accordance with some embodiments. The user interfaces in FIGS. 5A-5AT are used to illustrate the methods described below, including the methods in FIGS. 10A-10J.

FIGS. 5A-5AT illustrate example user interfaces and interactions for displaying and transforming user interface objects corresponding to different applications (also referred to as “application objects”) from one type to another on a multipage home screen user interface (e.g., including two or more user-arranged home screen pages and optionally a system-arranged home screen page (also referred to as an “application library user interface”)), in accordance with some embodiments. The user interface objects corresponding to different applications include application icons and/or application widgets (e.g., also referred to as “widgets” which include user interface objects including application content from respective applications that are updated over time as the application content change in the respective applications). In some embodiments, both the application icons and application widgets are configured to launch their corresponding applications when activated by a first type of input (e.g., a tap input at a location of the application icon or the application widget, an air pinch gesture that is detected while a user attention is directed to the application icon or application widget, a click input that is detected while a focus selector is on the application icon or application widget, and/or another type of selection input that targets the application icon or application widget). In some embodiments, application widgets are updated (e.g., by the operating system and/or by the applications) according to content and/or instructions provided their corresponding applications, while the applications remain dormant or operating in the background.

In some embodiments, an application widget (also referred to as a “widget”) refers to an application object that provides access to a subset of content and functionality of an application without launching, opening, and/or displaying the application. In some embodiments, an application widget is displayed in one or more user interfaces other than a user interface of the application that provides the content of the widget (e.g., one or more home screen user interfaces, a wake screen, a lock screen, a standby mode screen, or other user-arranged or system-generated user interfaces). For example, application widgets can be placed on different user interfaces to provide quick access and preview of respective application content and/or functionality without the need to open the respective application to view or access the respective application content and/or functionality from within the application user interface. In some embodiments, when an application widget is included in a user interface other than a user interface of the application that is associated with the widget, the content of the application widget is updated by the operating system from time to time based on updates to the application content (e.g., updates received from the application associated with the application widget, updates received from another application that communicates with the operating system regarding the application), even though the application is not currently displayed with the widget (e.g., the application may be running in a background process, or not running at all). In some embodiments, a widget includes user interface objects that, when selected, perform a respective subset of operations and provide a respective subset of functions of the application, without launching and/or displaying the application itself. In some embodiments, an application that has associated widgets can have different widgets (e.g., different types of widgets) that include different subset of content and/or provide different subsets of functionality of the application, and widgets of different sizes and/or dimensionality (e.g., a size that is based on a size of a placement location that can also accommodate a number of rows and columns of application icons). In some embodiments, application widgets display controls for performing actions in the associated application. For example, a weather widget may display a control for editing a temperature scale from Celsius to Fahrenheit (e.g., or vice versa) directly from the home screen user interface (e.g., without launching the weather application) or a control for changing the location for which the weather is displayed. In another example, a calendar widget may display a control for adding a meeting. In some embodiments, the controls are frequently used operations in the respective applications, thereby providing quick access (e.g., without the need to launch the respective applications) for invoking the frequently used functions.

In some embodiments, an application icon (also referred to as an application launch icon) refers to an application object for launching software applications installed on a device and for identifying such applications (e.g., amongst other installed applications). While both application widgets and application icons are associated with a respective application, content, functionality of, and/or interaction with, application widgets differ from that of application icons. For example, content of an application icon typically corresponds to an application logo, symbol, or other graphic that represents a respective application associated with the application icon. The content of an application icon is typically static compared to the content of an application widget. For example, application icon's content does not update or refresh automatically based on external factors such as time, user actions, server update, and/or other data changes. In some embodiments, application widgets can display different dynamic content (e.g., dynamically changing based on events occurring in the respective application, updates received from a server of the respective application, user input, database updates, real-time data feeds, or system events) including, but not limited to, changing weather information, stock market information, news headlines, social media feeds, and/or other dynamically updated content. Application icons visually represent software applications installed on a device and are used for launching respective applications, while application widgets provide dynamic content or functionality directly on the device's home screen or other screen (e.g., without the need to open the respective application). For example, application widgets offer quick access to information or actions without the need to open the application. While both application widgets and application icons can be selected (e.g., tapped on or clicked on) to launch respective applications, application widgets optionally provide further interactive elements that allow users to perform actions or view content of the respective application directly from a screen on which the widgets are displayed (e.g., directly from a home screen without the need to open the respective application). For example, content in an application widget can be scrolled and/or controls for performing functions with respect to the associated application can also be provided (e.g., media playback controls, toggling settings, or other frequently used application functionality).

In some embodiments, specific types of widgets are associated with multiple applications (e.g., as opposed to a single application). For example, an application suggestion widget, an application category widget, and a widget stack are examples of widgets that are associated with multiple applications. In some embodiments, an application suggestion widget provides (e.g., displays) dynamically generated recommendations for applications based on various factors including, but not limited to, a time of day, location, previous or current application usage patterns, events occurring in applications (e.g., ongoing sessions and/or notifications), and/or other contextual information. In some embodiments, the application suggestion widget displays or includes multiple application icons corresponding to different application that are recommended by the system. In some embodiments, an application suggestion widget provides shortcut to frequently used applications or applications that are determined by the system to be relevant for a current context. In some embodiments, the application suggestion widget provides quick access to applications that are likely to be useful at a given moment (e.g., depending on the context). Multiple application suggestion widgets can be placed on a page of the home screen user interface. In some embodiments, the computer system reduces or eliminates duplication of application icons displayed in the multiple application suggestion widgets on the same page. In some embodiments, an application category widget provides (e.g., displays) dynamically generated recommendations for applications of the same application category. For example, the application category widget displays multiple application icons of the same application category, e.g., in a preset region on a page (e.g., the preset region corresponds to a location whether the application category widget is placed). An application category widget is assigned a respective application category that can be changed by a user. Respective application icons, corresponding to different applications of the same application category, that are included in an application category widget are dynamically selected (e.g., changed over time) or updated by the computer system based on contextual information, usage patterns, and/or events occurring in the computer system or respective applications. Multiple application category widgets can be placed on a page of the home screen user interface, and respective widgets optionally can be assigned a different application category. In some embodiments, the computer system reduces or eliminates duplication of application icons displayed in the multiple application category widgets on the same page.

In some embodiments, the application icons displayed in a home screen user interface have the same size (e.g., a first size, or a second size). In some embodiments, the application widgets displayed in a home screen use interface have different sizes, and a placement location for a respective application widget has a widget and/or height that are integer multiples of the width and/or height for a placement location for a respective application icon. In some embodiments, application widgets that are configured to be displayed on different system user interfaces (e.g., wake screen, widget screen, or home screen user interfaces) can have different form factors and/or shapes.

FIG. 5A illustrates a user-arranged home screen page 5001 of a multi-page home screen user interface, in accordance with some embodiments. The user-arranged home screen page 5001 includes application icons 416, 418, 420, 422, 424, 426, 428, 430, 432, 434, 436, 438, 444, 446, 440, and 442 corresponding to different applications (e.g., installed on device 100). For example, application icon 424 corresponds to a messages application, application icon 426 corresponds to a calendar application, application icon 428 corresponds to a photos application, application icon 430 corresponds to a camera application, application icon 432 corresponds to a TV application, application icon 434 corresponds to a stocks application, application icon 436 corresponds to a maps application, application icon 438 corresponds to a weather application, application icon 440 corresponds to a clock application, application icon 442 corresponds to a fitness application, application icon 444 corresponds to a notes application, application icon 446 corresponds to a settings application, application icon 416 corresponds to a telephony application, application icon 418 corresponds to an e-mail application, application icon 420 corresponds to a browser application, and application icon 422 corresponds to a media player application. In some embodiments, a set of application icons, such as application icons 416, 418, 420, and 422, is included in dock 408 located at a bottom portion of the user-arrangement home screen page 5001. In some embodiments, user-arranged home screen page 5001 includes one or more folder icons corresponds to one or more folders including application icons of other applications. In some embodiments, the user-arranged home screen page 5001 includes one or more application widgets, such as a widget of the weather application and a widget of the photos application. In some embodiments, the “weather” widget and the “photos” widget have different sizes (e.g., two-row-by-two-column vs. two-row-by-four-column) and are updated as the content represented I the widgets change in their corresponding applications.

In some embodiments, corresponding applications are launched or opened in response to a selection input directed to a respective application icon of application icons in the user-arranged home screen page 5001. For example, in response to a tap input selecting application icon 424, the messages application is opened or launched, such that a user interface of the messages application is displayed on the display of device 100. In another example, in response to a tap input selecting application icon 426, the calendar application is opened or launched, such that a user interface of the calendar application is displayed on the display of device 100. In some embodiments, names of the respective applications are displayed near respective application icons. For example, a label “Messages” is displayed near application icon 424, and a label “Calendar” is displayed near application icon 426.

In some embodiments, user-arranged home screen page 5001 is reconfigurable in accordance with methods and techniques described herein.

FIGS. 5B-5G illustrate an example technique and user interfaces for transforming an application icon into an application widget via an in-line editing user interface displayed in a home screen user interface (e.g., a currently displayed user interface in which the application icon is displayed and in which the application widget will be displayed), according to some embodiments.

FIG. 5B illustrates user-arranged home screen page 5003 of a multi-page home screen user interface, in accordance with some embodiments. The user-arranged home screen page 5003 includes application icons 5002-5024 corresponding to different applications (e.g., installed on device 100). Some application icons of applications icons 5002-5024 correspond to the same applications as application icons 424-442 on user-arranged home screen page 5001 and some applications icons 5002-5024 are different from application icons 424-442. FIG. 5B further illustrates a page indicator user interface element 5330. Page indicator user interface element 5330 includes a corresponding page indicator for each page that is included in the multi-page home screen user interface (e.g., including all of the user-arranged pages that are currently included (e.g., pages that are not hidden) in the home screen user interface, and optionally the system-arranged home screen page). For example, in FIG. 5B, there are four page indicators 5331, 5332, 5333, and 5334, each corresponding to a respective page in the multi-page home screen user interface. Page indicator 5334 is highlighted relative to page indicators 5331, 5332, and 5333 to indicate that the currently displayed page is the last page (e.g. fourth) in the sequence of pages. For example, home screen page 5003 is the fourth page (e.g., last page) in a sequence of four pages of the multi-page home screen user interface.

In FIG. 5B, device 100 detects input 5102 (e.g., selection input) directed to application icon 5018. Application icon 5018 corresponds to a calendar application. For example, the calendars application is launched or opened in response to detecting input 5102 in accordance with a determination that input 5102 includes a tap input directed to application icon 5018.

FIG. 5C illustrates a transition from FIG. 5B in response to detecting input 5102, in accordance with some embodiments. In some embodiments, input 5102 is a long press input (e.g., a tap input remaining substantially stationary at the location of application icon 5018 (e.g., with less than a threshold amount of movement) for more than a threshold amount of time). In response to detecting input 5102 directed to application icon 5018 and in accordance with a determination that input 5102 includes a long press input directed to application icon 5018, device 100 displays an in-line editing user interface 5200. The in-line editing user interface 5200 is a contextual or quick-access menu associated with application icon 5018, in some embodiments. The in-line editing user interface 5200 includes selectable configuration options 5202, 5204, 5206, and 5208 for transforming a selected application icon (or, optionally, another selected application object) into a different type of application object (e.g., an application icon into an application widget, an application widget into an application icon, one type of widget into another type of widget, or from a widget of one size to a widget of another size). Configuration option 5202, when selected, causes the computer system to transform a currently selected object (e.g., an application widget) into an application icon. Configuration option 5204, when selected, causes the computer system to transform a currently selected object (e.g., an application widget or an application icon) into a “small” application widget. Configuration option 5206, when selected, causes the computer system to transform a currently selected object (e.g., an application widget or an application icon) into a “medium” application widget. Configuration option 5208, when selected, causes the computer system to transform a currently selected object (e.g., an application widget or an application icon) into a “large” application widget. Accordingly, configuration option 5204, 5206, and 5208 are used to change or transform a selected application object to an application widget of different dimensions, e.g., “small”, “medium”, or “large,” respectively. The in-line editing user interface 5200 is displayed overlaying the home screen user interface. In some embodiments, the configuration options available in the in-line editing user interface 5200 vary depending on the currently selected application object (e.g., depending on the corresponding application of the application object, the type of application object, and/or available content types and/or sizes for the application object).

Configuration option 5202 is highlighted in in-line editing user interface 5300, as shown in FIG. 5C. Highlighting of configuration option 5202 illustrates or provides visual feedback to a user that the currently selected application object (e.g., application icon 5018) is an application icon. For example, the highlighted configuration option in in-line editing user interface 5200 is the configuration that is currently selected for the respective application object. In some embodiments, the in-line editing user interface 5200 includes additional control options. For example, the in-line editing user interface 5200 includes a control option 5210 “Edit Home Screen” for activating a reconfiguration mode of the multi-page home screen user interface (e.g., an icon reconfiguration mode or “jiggle mode” in which application icons and/or widgets can be added, deleted, or rearranged by a user in the multi-page home screen user interface). The in-line editing user interface 5200 optionally further includes a control option 5212 “Remove app” for removing the currently selected application object (e.g., application icon 5018).

In some embodiments, an application icon (e.g., application icon 5018) can be transformed into application widgets of different types or sizes (e.g., “small,” “medium,” “large,” or another size) directly from a home screen user interface using an in-line editing user interface (e.g., displayed overlaying a home screen user interface), such as in-line editing user interface 5200. In some embodiments, an application icon (e.g., application icon 5018) is transformed into or replaced by an application widget without navigating away from the home screen user interface (e.g., home screen page 5003) to another user interface, such as a settings user interface or a configuration user interface (e.g., for reconfiguring the application icon). The application widget into which the application icon is being transformed (or, optionally, by which the application icon is being replaced) corresponds to (or, optionally, is associated with) the same application associated with the application icon that is being transformed (or, optionally, replaced). For example, FIGS. 5G, 5H, and 5Y illustrate that application icon 5018 corresponding to the calendar application has been transformed or replaced by an application widget, also corresponding to the calendar application, via the in-line editing user interface 5200.

In some embodiments, FIG. 5D illustrates different inputs 5224, 5226, and 5228 directed to configuration options 5204, 5206, and 5208, respectively, in the in-line editing user interface 5200. In some embodiments, inputs 5224, 5226, and 5228 are selection inputs, such as tap inputs directed to configuration options 5204, 5206, and 5208, respectively. FIGS. 5E-5G illustrate an animated transition transforming selected application icon 5018 into small widget 5018a in response to input 5224 selecting configuration options 5204, as described in further detail below. FIG. 5H illustrates an example transformation of selected application icon 5018 into medium widget 5018b in response to input 5226 selecting configuration options 5206. In some embodiments, FIG. 5Y illustrates an example transformation of selected application icon 5018 into large size widget 5018c in response to input 5228 selecting configuration options 5208.

FIGS. 5E-5G illustrate transforming application icon 5018, corresponding to the calendar application, into small widget 5018a, also corresponding to the calendar application, via the in-line editing user interface 5200 without navigating away from home screen page 5003, in accordance with some embodiments. FIGS. 5E-5G illustrate intermediate states of home screen page 5003 while application icon 5018 is transformed into small widget 5018a the calendar application, in response to input 5224 selecting configuration option 5204 for transforming selected application icon 5018 to a small widget. The calendar application can be launched or opened from both application icon 5018 and small widget 5018a (e.g., in response to a tap input or other selection input). In some embodiments, transforming application icon 5018 into an application widget of small size includes enlarging application icon 5018 to the size of the small widget 5018a, displaying additional content, and optionally reflowing application icons 5020, 5022, and 5024 to make room for small widget 5018a (e.g., small widget 5018a is larger than application icon 5018, occupying a placement location that is equivalent to two rows by two columns of placement locations for application icons). In some embodiments, small widget 5018a is four times the size of application icon 5018 (e.g., four application icons arranged in 2×2 grid—e.g., two rows and two columns). FIG. 5F illustrates a transition from FIG. 5E while application icon 5018 is transformed into small widget 5018a. FIG. 5G illustrates a final state of home screen page 5003 after application icons 5020, 5022, and 5024 are reflowed and application icon 5018 is transformed into small widget 5018a. For example, positions of application icons 5020-5024 in FIG. 5G shifted to make room for small widget 5018a (e.g., compared to positions of application icons 5020-5024 in FIGS. 5C-5D before transformation of application icon 5018) and positions of application icons 5002-5016 remains the same. For example, application icons 5020-5024 reflow in a top-down, left-to-right snaking pattern (also referred to as a “reflow path”). While the user interfaces described herein are described with reference to a particular reflowing pattern, it should be understood that many other different reflowing patterns could be used where icons reflow vertically, horizontally, radially, or in another reflow pattern that is set by the computer system or selected by a user of the computer system. In some embodiments, reflowing of application icons 5020-5024 is animated. In some embodiments, enlarging application icon 5018 to small widget 5018a is optionally animated. Small widget 5018a displays additional content relative to content displayed in application icon 5018. For example, while application icon 5018 displays a current date, small widget 5018a displays additional information about events or meetings scheduled for the current day (e.g., one event for “Coffee at 1 pm”, and a second event “Meet John at 6:00 pm”).

FIG. 5H illustrates a transition from FIG. 5D in response to input 5226 selecting configuration option 5206 in the in-line editing user interface 5200. FIG. 5H illustrates state of home screen page 5003 after selected application icon 5018 is transformed into or replaced by medium widget 5018b in response to input 5226 selecting configuration option 5206. Application icon 5018 and medium widget 5018b both correspond to the same calendar application, and the calendar application can be launched or opened from both application icon 5018 and medium widget 5018b (e.g., in response to a tap input or other selection input). Medium widget 5018b is larger than small widget 5018a (and application icon 5018) and displays additional content (e.g., relative to both small widget 5018a and application icon 5018). For example, in addition to displaying events or meetings scheduled for the current day (e.g., also included in small widget 5018a), medium widget 5018b displays all days in the current month (e.g., for comparison, all days in the current month are not displayed in small widget 5018a). Both small widget 5018a and medium widget 5018b display the current day like application icon 5018. In some embodiments, medium widget 5018b is two times (2×) the size of small widget 5018a or eight times (8×) the size of application icon 5018 (e.g., the size of eight application icons arranged in 2×4 grid—e.g., two rows and four columns). Application icons 5020-5024 in FIG. 5H shifted positions compared to original position in FIGS. 5C-5D to make room for medium widget 5018b (e.g., application icons 5020-5024 are displayed two rows down compared to original position in FIGS. 5C-5D).

In some embodiments, an application widget (e.g., application widget 5018b) can be transformed into an application widget of different size or type (e.g., from “small” to “medium” or “large”; from “medium” to “small” or “large”; from “large” to “medium” or “small”; and/or other transformation in content type and/or size) directly from a home screen user interface using an in-line editing user interface (e.g., displayed overlaying a home screen page 5003), such as in-line editing user interface 5200. In some embodiments, an application widget of a first type or size (e.g., application widget 5018b) is transformed or replaced by an application widget of a different type or size (e.g., application widget 5018a) without navigating away from the home screen user interface (e.g., home screen page 5003) to another user interface, such as a settings user interface or a configuration user interface (e.g., for configuring and adding widgets in a home screen user interface).

FIGS. 5I-5M illustrate transforming medium widget 5018b, corresponding to the calendar application, into small widget 5018a, also corresponding to the calendar application, via the in-line editing user interface 5200 without navigating away from home screen page 5003, as described in further detail below. In FIG. 5I, device 100 detects input 5230 directed to medium widget 5018b (e.g., same widget 5018b illustrated in FIG. 5H). Input 5230 corresponds to a long press input for bringing up or displaying an in-line editing user interface.

FIG. 5J illustrates a transition from FIG. 5I in response to input 5230, in accordance with some embodiments. In response to detecting input 5230 and in accordance with a determination that input 5230 includes a long press input directed to medium widget 5018b (e.g., to a portion of medium widget 5018b that is not occupied by a selectable affordance that responds to a long press input), device 100 displays an in-line editing user interface 5300. In some embodiments, an in-line editing user interface associated with an application widget includes additional widget-specific configuration options that are not included in an in-line editing user interface associated with an application icon. In other words, a long press input on an application widget causes display of an in-line editing user interface that includes widget-specific configuration options that are not displayed in response to a long press input on an application icon. For example, the in-line editing user interface 5300 is the same as in-line editing user interface 5200, except that in-line editing user interface 5300 includes an additional configuration option 5314 “Edit Widget” for editing a currently selected application widget (e.g., selected in response to the long press input). Configuration option 5314 for editing a selected application widget, when selected by another selection input, causes the computer system to display a user interface (e.g., an in-line editing user interface or another editing user interface) for changing a respective widget type of the currently selected widget, as described in further detail below with reference to FIGS. 5AK-5AM.

In some embodiments, in-line editing user interface 5300 is a contextual or quick-access menu associated with application widget 5018b. The in-line editing user interface 5300 includes configuration options 5302 (e.g., analogous to configuration option 5202), 5304 (e.g., analogous to configuration option 5204), 5306 (e.g., analogous to configuration option 5206), and 5308 (e.g., analogous to configuration option 5208) for transforming a selected application widget (or, optionally, other currently selected application object) into a different type of application object, as described above with reference to in-line editing user interface 5200.

Configuration option 5306 is highlighted in in-line editing user interface 5300, as shown in FIG. 5J. Highlighting of configuration option 5306 illustrates or provides visual feedback that the currently selected application object (e.g., application widget 5018b) is a medium size widget (e.g., as configuration option 5306 is for transforming or replacing a selected application object to a medium size widget). The highlighted configuration option in in-line editing user interface 5300 is the configuration that is currently used for the respective application object.

FIG. 5K illustrates a selection input 5316 directed to configuration option 5304 for transforming a selected application object (e.g., medium widget 5018b) to a small size widget. In response to input 5316 and in accordance with a determination that the input 5316 is a tap input directed to configuration option 5304, medium widget 5018b is transformed back to small widget 5018a, as illustrated in FIGS. 5L-5M.

FIGS. 5L-5M illustrate intermediate states of home screen page 5003 while medium widget 5018b is transformed back to small widget 5018a of the calendar application, in response to input 5316 selecting configuration option 5304 via in-line editing user interface 5300. In some embodiments, transforming medium widget 5018b into a small widget 5018a includes reducing size of medium widget 5018b to the size of a small size widget, displaying less application content and/or different application content, and optionally reflowing application icons 5020, 5022, and 5024 to fill up placement locations that become available as a result of reducing the size of the widget from “medium” to “small” (e.g., small widget 5018a is smaller than medium widget 5018b). In some embodiments, small widget 5018a (e.g., occupying a placement location the size of four application icons arranged in 2×2 grid—e.g., two rows and two columns) is half the size of medium widget 5018b (e.g., occupying a placement location the size of eight application icons arranged in 2×4 grid—e.g., two rows and four columns).

FIG. 5L illustrates a transition from FIG. 5K while medium widget 5018b is transformed into small widget 5018a. FIG. 5L illustrates that application icons 5020, 5022, and 5024 are flowing in a bottom-up, right-to-left snaking pattern (also referred to as a “reflow path”) to fill up the newly available placement locations on home screen page 5003. While the user interfaces described herein are described with reference to a particular reflowing pattern, it should be understood that many other different reflowing patterns could be used where icons reflow vertically, horizontally, radially, or in another reflow pattern that is set by the computer system or selected by a user of the computer system.

FIG. 5M illustrates that application widget 5018b is transformed or replaced by application widget 5018a via the in-line editing user interface 5300, in accordance with some embodiments. FIG. 5M is a transition from FIG. 5K, and FIG. 5M illustrates a state of home screen page 5003 after application icons 5020, 5022, and 5024 reflowed and medium widget 5018b is transformed into or replaced by small widget 5018a. For example, positions of application icons 5020-5024 in FIG. 5M shifted to fill up spots on home screen page 5003 that are vacated (e.g., compared to positions of application icons 5020-5024 in FIGS. 5H-5I before transformation of medium widget 5018b) while positions of application icons 5002-5016 remain the same. For example, application icons 5020-5024 reflow in a bottom-up-down, right-to-left snaking pattern. While the user interfaces described herein are described with reference to a particular reflowing pattern, it should be understood that many other different reflowing patterns could be used where icons reflow vertically, horizontally, radially, or in another reflow pattern that is set by the computer system or selected by a user of the computer system. In some embodiments, reflowing of application icons 5020-5024 is animated. In some embodiments, reducing the size of medium widget 5018b to small widget 5018a is optionally animated. Small widget 5018a displays less content relative to content displayed in medium widget 5018b, in some embodiments.

In some embodiments, a size, dimensions, and/or a type of an application object (e.g., application widget 5018a, application widget 5018b, or application icon 5018) can be changed directly from a home screen user interface (e.g., without the need to navigate away from the home screen user interface or to select a configuration option in a menu) in response to a drag input directed to the application object or, optionally, a drag input directed to a resize handle of the application object. For example, FIGS. 5N-5T illustrate changing the size of a small size widget (e.g., small widget 5018a) to a medium size widget (e.g., medium widget 5018b) directly from home screen page 5003 in response to a drag input directed to a resize handle of the small size widget, in accordance with some embodiments. In another example, FIGS. 5U-5Y illustrate changing the size of a medium size widget (e.g., medium widget 5018b) to a large size widget (e.g., large widget 5018c) directly from home screen page 5003 in response to a drag input directed to a resize handle of the medium size widget, in accordance with some embodiments. In another example, FIGS. 5AG-5AJ illustrate transforming an application widget (e.g., medium widget 5018b) to an application icon (e.g., application icon 5018) by resizing down the application widget directly from home screen page 5003 in response to a drag input directed to a resize handle of the application widget.

FIG. 5N illustrates a long press input 5232 directed to small widget 5018a to request display of an in-line editing user interface for editing small widget 5018a. FIG. 5O illustrates a transition from FIG. 5N in response to the long press input 5232. FIG. 5O illustrates that the device 100 displays in-line editing user interface 5300 in response to the long press input 5232 directed to the small widget 5018a. As described above, in addition to configuration options 5302-5308 for transforming an application object to another type of application object, in-line editing user interface 5300 includes a control option 5310 “Edit Home Screen” for activating a reconfiguration mode of the multi-page home screen user interface. FIG. 5P illustrates a tap input 5234 selecting control option 5310 for activating the reconfiguration mode.

FIG. 5Q illustrates a transition from the user interface shown in FIG. 5P that occurs in response to tap input 5234 selecting control option 5310 for activating the reconfiguration mode. FIG. 5Q illustrates that the device 100 activates the reconfiguration mode in response to tap input 5234 selecting control option 5310. In the reconfiguration mode, locations of application icons and/or widgets can be adjusted (e.g., application objects can be repositioned on the same page or a different page), and application icons and/or widgets can be added or deleted in response to additional user inputs. For example, device 100 displays home screen page 5003 in the reconfiguration mode in response to tap input 5234 selecting control option 5310. In FIG. 5Q, application icons 5002-5024 are displayed with respective delete affordances (e.g., in the top left corner of each respective application icon) for deleting the respective application icons while home screen page 5003 is in the reconfiguration mode. In the reconfiguration mode, home screen page 5003 displays affordance 5318 for adding application objects (e.g., widgets) and affordance 5322 for confirming and saving any changes made to the home screen user interface while in the reconfiguration mode (e.g., deletion, addition, or relocation of application objects).

Further, as shown in FIG. 5Q, small widget 2018a is also displayed with a delete affordance 5236a for deleting small widget 2018a while home screen page 5003 is in the reconfiguration mode. In addition, while home screen page 5003 is in the reconfiguration mode, small widget 2018a is displayed with one or more resize affordances for resizing small widget 2018a (e.g., resize handle 5238 displayed at or near the bottom right corner of small widget 2018a). FIG. 5R illustrates a drag input 5324 directed at resize handle 5238 of small widget 2018a displayed on home screen page 5003 (e.g., movement of a contact that is detected on the resize handle 5238, and/or, optionally, a corner or edge of small widget 2018a displayed without a resize handle; or another type of drag input, such as a click and drag input or an air pinch and drag input, directed to the resize handle or a corner or edge of the small widget 2018a).

FIG. 5S illustrates a transition from FIG. 5R in response to the detection of drag input 5324 in a rightward direction. In FIG. 5S, small widget 2018a is in an intermediate state in which the size of small widget 2018a has increased but has not yet reached the next preset or target size (e.g., the medium size). For example, small widget 2018a is stretched while drag input 5324 is moving in the rightward direction to enlarge the small widget 2018a to a larger widget. Further, small widget 2018a is displayed overlaying application icons 5020-5024, which are about to be shifted and moved out of the way, upon detection that small widget 2018a in being resized to the medium size widget. In some embodiments, in the intermediate state (e.g., prior to transformation of the small widget 2018a into a medium widget), the content in the small widget 2018a in FIG. 5S is the same or consistent with the content of the small widget 2018a in FIG. 5Q (e.g., prior to detection of drag input 5324) to indicate that the small widget 2018a has not yet been transformed into a medium size widget. In some embodiments, while small widget 2018a is being resized, device 100 switches from displaying the small widget 2018a to displaying a medium size widget (e.g., including changing content displayed in the small widget 2018a that is being resized) during the movement portion of drag input 5324.

FIG. 5T illustrates a transition from FIG. 5S after the small widget 2018a is switched or transformed into medium widget 5018b in response to the drag input 5324 in the rightward direction detected by device 100 in FIG. 5R. For example, after small widget 2018a is switched to medium widget 5018b and the end of drag input 5324 is detected (e.g., lift-off of a contact performing the drag input 5324, an up-click in a click-hold and drag input, release of the air pinch posture in an air pinch and drag gesture, or termination of another type of drag input). In FIG. 5T, application icons 5020-5024 have shifted (e.g., in a top-down, left-to-right snaking pattern) from their original positions in FIG. 5R to make room for medium widget 5018b. While the user interfaces described herein are described with reference to a particular reflowing pattern, it should be understood that many other different reflowing patterns could be used where icons reflow vertically, horizontally, radially, or in another reflow pattern that is set by the computer system or selected by a user of the computer system. In some embodiments, changing the size or dimensions of an application object (e.g., widget 5018a) in response to a drag input directed at a resize handle of the application object causes corresponding changes in content, functionality, and/or type of information provided by the application object that is being resized. For example, medium widget 5018b displays additional content (e.g., calendar information for the whole month) that is not displayed in small widget 2018a.

FIGS. 5U-5Y illustrate changing the size of medium widget 5018b to a large size widget directly from home screen user interface screen 5002 in response to a drag input directed to resize handle 5238 of the medium size widget, in accordance with some embodiments.

FIG. 5U illustrates detection of drag input 5326 directed to resize handle 5238 of medium widget 2018b displayed on home screen page 5003. In some embodiments, drag input 5326 is a continuation of drag input 5324 detected on small widget 5018a. In some embodiments, drag input 5326 is a new drag input detected after the drag input 5324 detected on small widget 5018a has ended. For example, medium widget 2018b is enlarged by dragging resize handle 5238 downward to increase the vertical dimension of the media widget 2018b. FIGS. 5V-5X illustrate intermediate states of medium widget 2018b while the medium widget 2018b is being resized in response to drag input 5326. In some embodiments, while medium widget 2018b is being resized, the device 100 switches from the medium widget 2018b to a large size widget (e.g., switching the size or type of widget includes changing content displayed in the widget 2018b that is being resized) during a movement portion of drag input 5326.

FIG. 5V illustrates a transition from FIG. 5U in response to the detection of drag input 5326 in a downward direction. In FIG. 5V, medium widget 2018b is in an intermediate state in which the size of the medium widget 2018b has increased but has not yet reached the next preset or target size (e.g., the “large” size). For example, medium widget 2018b is stretched while drag input 5326 is moving in the downward direction to enlarge the medium widget 2018b to a large size widget. Further, medium widget 2018b is displayed partially overlaying application icons 5020-5024, which are about to be shifted and moved out of the way, upon detection that medium widget 2018b is being resized to a large size widget. In some embodiments, in the intermediate state (e.g., prior to transformation of the medium widget 2018b into a large size widget), the content in the medium widget 2018b in FIG. 5V is the same or consistent with the content of the medium widget 2018b in FIG. 5U (e.g., prior to detection of drag input 5326) to indicate that the medium widget 2018b has not yet been transformed into a large size widget. In FIG. 5W, the medium widget 5018b is still in an intermediate state while a movement portion of drag input 5326 is being detected but before the medium widget 5018b is switched to a large size widget. For example, content in the medium widget 5018b is further stretched and medium widget 5018b has covered or overlayed greater portion of application icons 5020-5024.

As explained above with respect to FIGS. 5R-5T, an application widget switches from one type to another as the application widget is being resized (e.g., while a movement portion of a drag input is being detected), in accordance with some embodiments. In some embodiments, a widget switches from one type to another while the widget is being resized in accordance with a determination that the drag input moved more than a threshold amount of distance in a respective direction (e.g., sideways, and/or up and down directions), or in accordance with a determination that the drag input is less than threshold amount of distance away from an edge of the display of device 100. In some embodiments, reflow of application icons is initiated when the threshold for switching object types is met (e.g., the drag input moved more than the threshold amount of distance, or is within a threshold amount of distance from another size of the application object). In some embodiments, the content of the application object is updated when the threshold for switching object types is met (e.g., the drag input moved more than the threshold amount of distance, or is within a threshold amount of distance from another size of the application object), and the object type is changed upon termination of the drag input. In some embodiments, before the termination of the drag input is detected, the visual feedback (e.g., reflow of application icons, and updating of content in the application object) is dynamically updated and reversible based on the current location of the drag input.

FIG. 5X is a transition from FIG. 5W in response to continued detection of drag input 5326 in the downward direction. FIG. 5X shows an intermediate state in which the medium widget 2018b has switched to large size widget 5018c while drag input 5326 in the downward direction continues to be detected. In some embodiments, a size of a widget (e.g., medium widget 2018b) that is being resized is determined based on an amount of movement of the resizing input (e.g., drag input 5326). In some embodiments, a size of a widget (e.g., medium widget 2018b) that is being resized is selected from among a predetermined target sizes (e.g., small, medium, large, extra-large, and/or other discrete size options) based on the amount and/or direction of movement of the resizing input (e.g. drag input 5326).

In some embodiments, device 100 guides and provides visual feedback to a user during resizing of an application widget. For example, medium widget 2018b switches to a preview of large size widget 5018c while device 100 continues to detect drag input 5236 in the downward direction (e.g., before a persistent switch to large size widget 5018c has be completed). For example, content in the preview of large size widget 5018c differs from content in medium widget 2018b. Large size widget 5018c and its preview display additional content that previously was not displayed in medium widget 2018b, such as hours of the day in the calendar application (e.g., as opposed to displaying only scheduled meetings). Further, a platter 5018d with the target size of large size widget 5018c is displayed to indicate the size of large size widget 5018c once device 100 persistently switches from displaying medium widget 2018b to displaying large size widget 5018c. In some embodiments, if device 100 detects termination of drag input 5236 in FIG. 5X, device 100 will switch back to displaying medium widget 5018b that was displayed in FIG. 5U. For example, the preview of large size widget 5018c is an intermediate state that is transient and will be reverted if the resizing input ends before the preview of large size widget 5018c reaches a predetermined target size, e.g., such as the size illustrated by the platter 5018d in FIG. 5X or another target size. If the device detects a lift off of drag input 5326 after the preview of large size widget 5018c has reached the target size, as illustrated in FIG. 5Y, the switching to large size widget 5018c is completed and large size widget 5018c remain displayed (e.g., at the target size illustrated by platter 5108d or a size greater than the target size illustrated by platter 5018d) as illustrated in FIG. 5Y. In some embodiments, the size of the platter 5018d indicates the threshold boundaries the drag input needs to reach in order to complete switching to large size widget 5018c. In some embodiments, the size of the platter 5018d indicates the size of the large size widget 5018c. In some embodiments, the bottom edge of platter 5328 continues to move downward during the downward drag input 5326, to indicate to the user that the drag input 5326 needs to continue downward in order to meet the threshold for switching to the large size widget until the drag input meets the distance threshold for completing the switching to the large size widget.

FIG. 5Y illustrates the home screen page 5003 after the medium widget 2018b is persistently switched or transformed into large size widget 5018c in response to the drag input 5326 in the downward direction, and the device has exited the reconfiguration mode in response to the user selecting the “Done” button 5322. After the preview of large size widget 5018c reaches the target size indicated by platter 5018d during the drag input 5326, large size widget 5018c is persistently displayed after termination of the drag input 5326 (e.g., in the reconfiguration mode, until the user selects the “Done” button 5322 the reconfiguration mode). FIG. 5Y illustrates home screen page 5003 in the normal mode (e.g., after an input selects affordance 5322 to confirm the changes made to the home screen user interface), as opposed to the reconfiguration mode. In some embodiments, due to the increased size of large size widget 5018c, application icons 5020-5024 that were previously obscured while medium widget 2018b was being resized by the drag input 5326, are pushed to another page of the multi-page home screen user interface. In some embodiments, the device 100 automatically generates a new page of the multi-page home screen user interface, and adds the application icons 5020-5024 to the new page. FIG. 5Y illustrates the addition of the new page by adding page indicator 5335 that is added to the page indicator user interface element 5330. In some embodiments, if the current page is not the last and there is space on the next (e.g., adjacent) page, then application icons 5020-5024 are added to the next page instead of to a new page. In some embodiments, device 100 automatically generates a new page and adds the application icons 5020-5024 to the new page regardless of whether there is a subsequent page with available space for application icons 5020-5024.

In some embodiments, the device 100 transforms application icon 5018, corresponding to the calendar application, into large size widget 5018c, also corresponding to the calendar application, in response to input 5228 selecting configuration option 5208 displayed in in-line editing user interface 5200 in FIG. 5D (e.g., without navigating away from home screen page 5003). For example, instead of resizing application icon 5018 using a drag input, a user can select a respective configuration option in in-line editing user interface 5200.

In some embodiments, techniques described herein in relation to FIGS. 5B-5Y for transforming application icon 5018 into application widgets of different types can be applied to another application icon of application icons 5002-5024 displayed on home screen page 5003. In some embodiments, more than one application object on the same home screen page can be transformed into a different type of application object directly from the home screen page using an in-line editing user interface or resize inputs (e.g., drag inputs). For example, two small widgets on the home screen page can be transformed into two medium size widget, respectively; three icons can be transformed into three application widgets, respectively; and/or two medium size widgets can be transformed to small size widgets, in accordance with two or more resize and/or reconfiguration inputs.

In some embodiments, a widget stack is another type of user interface object that can be transformed into a different type of widget stack or a different size directly from a home screen user interface (e.g., home screen page 5003). For example, a size, dimensions, and/or a type of a widget stack can be changed without navigating away from the home screen user interface, using an in-line editing user interface (e.g., in-line editing user interface 5200 or 5300), or in response to a drag input directed to an edge and/or corner of the widget stack or, optionally, a drag input directed to a resize handle of the widget stack. In some embodiments, a widget stack includes multiple application widgets corresponding to different applications that are stacked (e.g., displayed one at a time at the same placement location) and can be flipped through (e.g., or navigated through one by one) in response to flick or swipe gestures directed to the widget stack (e.g., the currently displayed widget from the widget stack). In some embodiments, the applications associated with respective application widgets in the stack of widgets do not change as a result of resizing or transforming the stack of widgets into a different type or size.

In some embodiments, when resizing a stack of widgets, a determination is made regarding whether one or more application widgets included in the stack of widgets can be resized to a requested target size (e.g., whether such a widget size is available for the application). For example, some applications installed on device 100, do not have application widgets of the full range of available sizes (e.g., widget sizes that are available for other applications). FIGS. 5Z-5AA illustrate resizing a stack of widgets in which at least one application widget cannot be resized to a requested target size (e.g., because the target size is not available as a configuration option for the respective widget), as further described below.

FIG. 5Z illustrates home screen page 5005 that includes the same application icons 5002-5024 as home screen page 5003, and further includes stack of widgets 5042 and stack of widgets 5044. Stack of widgets 5042 and stack of widgets 5044 are both displayed in “small” size (e.g., as opposed to “medium” or “large” sizes). Home screen page 5005 is displayed in the reconfiguration mode. In the reconfiguration mode, the delete affordances of application icons 5002-5024 are displayed at the top left corners of application icons 5002-5024, the delete affordance 5043 of stack of widgets 5042 and delete affordance 5045 of stack of widgets 5044 are also displayed, and resize handles 5046 and 5047 of stack of widgets 5042 and 5044, respectively, are also displayed in reconfiguration mode. In some embodiments, a stack of widgets is differentiated from a single application widget using a user interface element, such as user interface element 5052a that indicates a number of application widgets (e.g., five as indicated by the five dots in user interface element 5052a) that are included in the stack of widgets 5042, and user interface element 5054 indicates a number of application widgets (e.g., four as indicated by the four dots in user interface element 5054) that are included in the stack of widgets 5044. In some embodiments, user interface elements 5052a and 5054 indicate that the application object is a stack of widgets as opposed to a single application widget, without indicating the actual number of application widgets included in the stack of widgets.

In some embodiments, FIG. 5Z illustrates different inputs 5048 and 5049 directed to respective resize handles 5046 and 5047 of stack of widgets 5042 and stack of widgets 5044. In some embodiments, inputs 5048 and 5049 are resizing inputs, such as drag inputs that started at locations of the stack of widgets 5042 and stack of widgets 5044, respectively. FIG. 5AA illustrates the response of device 100 to input 5048 requesting to resize stack of widgets 5042, as described in further detail below. FIGS. 5AB-5AC illustrates the response of device 100 to input 5049 requesting to resize stack of widgets 5044, as described in further detail below.

In FIG. 5Z, drag input 5048 directed at resize handle 5046 of stack of widgets 5042 is detected. Drag input 5048 moves in a rightward direction as indicated by an arrow (e.g., towards right edge of device 100). Drag input 5048 corresponds to a request that the respective size of stack of widgets 5042 be increased from “small” to “medium.” In response to detecting the drag input 5048 and in accordance with the determination that a respective application widget in the stack of widgets 5042 cannot be resized as requested (e.g., because the target size is not available as a configuration option for the respective widget), the device 100 generates warning prompt 5056 indicating that a respective application widget in the stack of widgets 5042 cannot be resized, as illustrated in FIG. 5AA. Warning prompt 5056 provides an option 5059 to cancel the resizing operation and option 5058 to confirm that device 100 is to proceed with the resizing operation of stack of widgets 5042. In some embodiments, proceeding with resizing the stack of widgets 5042 even though a respective application widget in the stack of widgets 5042 cannot be resized, causes the device 100 to remove the respective application widget from the stack of widgets 5042 and complete the resize operation of the stack of widgets after removing the respective application widget from the stack of widgets. In some embodiments, if there are two or more widgets in the stack of widgets that cannot be resized as requested, the device 100 remove the two or more widgets from the stack before resizing the stack. In some embodiments, if after the removal of the widgets that cannot be resized from the stack of widget, only a single widget remains in the stack, the stack is resized as a single widget.

FIGS. 5AB-5AC illustrate resizing a stack of widgets in which all included application widgets can be resized to a requested target size (e.g., because the target size is available as a configuration option for all application widgets in the stack), as further described below.

FIG. 5AB is a transition from FIG. 5Z in response to detecting drag input 4045 in the rightward direction as indicated by an arrow (e.g., towards right edge of device 100). Drag input 5049 requests that the respective size of stack of widgets 5044 be increased from “small” to “medium.” In response to the drag input 5049 and in accordance with the determination that the stack of widgets 5044, including the respective application widgets in the stack of widgets, can be resized (e.g., because the target size is available as a configuration option for the respective application widgets in the stack of widgets 5042), the device 100 resizes stack of widgets 5044. FIG. 5AB illustrates an intermediate state of stack of widgets 5044 in which the size of the stack of widgets 5044 has increased but has not yet reached next preset or target size (e.g., medium size). For example, stack of widgets 5044 is stretched while drag input 5049 is moving in the rightward direction to enlarge the stack of widgets 5044 to the next available size, e.g., the medium size.

FIG. 5AC is a transition from FIG. 5AB after the stack of widgets 5044 have been transformed from a small size to a medium size (e.g., into stack of widgets 5044a) in response to drag input 5049 (e.g., after the termination of the drag input 5049). For example, content displayed in the application widget at the top of stack of widgets 5044a has changed relative to the content of displayed in the application widget at the top of stack of widgets 5044 (e.g., additional content of the calendar application is displayed). In some embodiments, the applications associated with the application widgets included in the stack of widgets 5044 do not change due to the resizing the stack of widgets 5044 to stack of widgets 5044a.

In some embodiments, device 100 provides a rubberband or a bounce back effect in accordance with a determination that a resize input requests that an application object be resized beyond a maximum available or allowable size. For example, FIGS. 5AD-5AF illustrate that the size of medium widget 5018b bounces back to its maximum allowable size in response to a drag input that stretched the medium widget 5018b beyond its maximum allowable size once the drag input is released (e.g., as shown in FIGS. 5AE and 5AF).

FIG. 5AD illustrates the same home screen page 5003 that is illustrated in FIG. 5T. For example, the same application objects and medium widget 5018b included in home screen page 5003 in FIG. 5AD are also included home screen page 5003 in FIG. 5T. In FIG. 5AD, home screen page 5003 is in the reconfiguration mode and resize handle 5238 of medium widget 5018b is displayed. Medium widget 5018b cannot be resized in a leftward or rightward direction as there is no space available on home screen page 5003 to accommodate a wider widget. In some embodiments, medium widget 5018b can be resized in an upward or downward direction (e.g., by pushing some application icons to another page of the multi-page home screen user interface). In some embodiments, if medium widget 5018b was displayed in a device with a larger screen than device 100 (e.g., a tablet as opposed to a smartphone), medium widget 5018b is optionally resizable to a larger size.

In FIG. 5AD, the device 100 detects drag input 5050 directed to resize handle 5238 of media widget 5018b. Drag input 5050 moves in the rightward direction towards the right edge of device 100 (e.g., in contrast to FIG. 5U in which drag input 5326 moves in a downward direction). Drag input 5050 requests to resize medium widget 5018b beyond the maximum size that is available in the rightward direction.

FIG. 5AE illustrate a transition from FIG. 5AD in response to drag input 5050 requesting that medium widget 5018b is resized beyond the maximum size that is available in the rightward direction. FIG. 5AE illustrates that medium widget 5018b has reached the limit at the right edge of device 100. In some embodiments, content in the medium widget 5018b is shown as slightly stretched to provide visual feedback to a user that device 100 is responding to the drag input 5050. Further, in FIG. 5AE, a termination of the drag input 5050 is detected (e.g., lift-off of a contact performing the drag input 5050, or termination of another type of drag input). FIG. 5AF illustrates a transition from FIG. 5AE in response to detecting an end of drag input 5050. In FIG. 5AF, medium widget 5018b has bounced back from its overstretched size shown in FIG. 5AE and reverted to the regular size the medium widget 5018b was in before detection of drag input 5050. For example, in FIG. 5AF, medium widget 5018b has reverted to the state it was in before the drag input 5050, as shown in FIG. 5AD. In some embodiments, the visual effect that is provided corresponds to a rubberband effect in which the medium widget 5018b behaves as if the left side of medium widget 5018b is anchored, the medium widget 5018b is elastic, the drag input 5050 is pulling the elastic medium widget 5018b in the rightward direction, and medium widget 5018b bounces back in a leftward direction when the end of drag input 5050 is detected.

In some embodiments, an application widget can be transformed into an application icon directly on a home screen user interface (e.g., without the need to navigate away from the home screen user interface or to select a configuration option in a menu) by resizing down the application widget (e.g., in response to a drag input directed to the application widget or, optionally, a drag input directed to a resize handle of the application widget). FIGS. 5AG-5AJ illustrate transforming an application widget (e.g., medium widget 5018b) to an application icon (e.g., application icon 5018) by resizing down the application widget directly on home screen page 5003 in response to a drag input directed to a resize handle of the application widget, as described in further detail below.

FIG. 5AG illustrates home screen page 5003. FIG. 5AG illustrates the same home screen page 5003 that is illustrated in FIGS. 5T and 5AD. For example, the same application objects and medium widget 5018b included in home screen page 5003 in FIGS. 5T and 5AD are also included home screen page 5003 in FIG. 5AG. In FIG. 5AG, home screen page 5003 is in the reconfiguration mode and resize handle 5238 of medium widget 5018b is displayed. In FIG. 5AG, the device 100 detects drag input 5052 directed at resize handle 5239 of medium widget 5018b. The drag input 5052 moves in a direction toward the center and/or the upper left corner of medium widget 5018b (e.g., as opposed to in the rightward direction, away from the center of medium widget 5018b, as illustrated in FIG. 5AD and in the downward direction, away from the center of medium widget 5018b, as illustrated in FIG. 5T).

FIG. 5AH illustrates a transition from the user interface shown in FIG. 5AG in response to detecting further movement of drag input 5052 in the direction toward the center and/or the upper left corner of medium widget 5018b. In FIG. 5AH, the size of medium widget 5018b is reduced in accordance with the direction and amount of movement of drag input 5052. In FIG. 5AH, medium widget 5018b is displayed in an intermediate state in which medium widget 5018b has not yet switched to a small size widget, e.g., content in medium widget 5018b in FIG. 5AH is the same as content in medium widget 5018b in FIG. 5AF before the drag input 5052 was detected.

FIG. 5AI is a transition from FIG. 5AH in response to detecting further movement of drag input 5052 in the direction toward the center and/or the upper left corner of medium widget 5018b. In FIG. 5AI, the size of medium widget 5018b is reduced in accordance with the direction and amount of movement of drag input 5052. Further, in FIG. 5AI, medium widget 5018b has switched to small widget 5018a. For example, in addition to changing the size from “medium” to “small,” content in small widget 5018a in FIG. 5AI changed relative to content in medium widget 5018b in FIG. 5AH. Further, application icons 5020-5024 reflowed to fill up placement locations that became available as a result of reducing the medium widget 5018b to small widget 5018a. In some embodiments, application icons 5020, 5022, and 5024 reflowed or shifted in a bottom-up, right-to-left snaking pattern to fill up the placement locations that have become available in home screen page 5003. For example, positions of application icons 5020-5024 in FIG. 5AI changed relative to positions of application icons 5020-5024 in FIG. 5AH. Medium widget 5018b would remain displayed in the configuration shown in FIG. 5AI, if termination of the drag input 5052 were detected at the location shown in FIG. 5AI. While the user interfaces described herein are described with reference to a particular reflowing pattern, it should be understood that many other different reflowing patterns could be used where icons reflow vertically, horizontally, radially, or in another reflow pattern that is set by the computer system or selected by a user of the computer system.

FIG. 5AJ is a transition from FIG. 5AI in response to detecting further movement of drag input 5052 in the direction toward the center and/or the upper left corner of small widget 5018a. In FIG. 5AJ, the size of small widget 5018a is reduced down to the size of an application icon in accordance with the direction and amount of movement of drag input 5052. For example, FIG. 5AJ illustrates that small widget 5018a is transformed into application icon 5018, corresponding to the same calendar application, in response to further movement of drag input 5052. Accordingly, medium widget 5018b is resized down to application icon 5018 in response to drag input 5052. Further, FIG. 5AJ illustrates that application icons 5020-5024 reflowed (e.g., optionally in a bottom-up, right-to-left snaking pattern) to fill up placement locations that became available as a result of reducing small widget 5018a into application icon 5018. In some embodiments, once small widget 5018a is switched to application icon 5018, lift off or end of drag input 5052 would not cause the application icon 5018 to be reverted back to small widget 5018a. In some embodiments, selection of affordance 5322 (e.g., the “Done” button) causes the changes made to home screen page 5003, including the changing medium widget 5018b to application icon 5018, to persist after exiting the reconfiguration mode. In some embodiments, a tap input directed to home screen page 5003 in the reconfiguration mode (e.g., on an application icon, or an unoccupied region of home screen page 5003), causes device 100 to exit the reconfiguration mode and cancel any changes made to home screen page 5003 during the reconfiguration mode.

In some embodiments, FIGS. 5N-5T, 5U-5Y, and 5AG-5AJ illustrate a technique for resizing an application widget and/or stack of widgets that uses a resize handle to change the size of the application widget or stack of widgets. In some embodiments, an application widget can be resized using a drag input directed to any corner or edge of the application widget (e.g., without the need to use and/or display a resize handle). For example, resizing techniques described in relation to FIGS. 5N-5T, 5U-5Y, and 5AG-5AJ can be performed using a resize input (e.g., a drag input) that is directed to corners and/or edges of respective application widgets as opposed to resize handles (e.g., even if resize handles are displayed, or if no resize handles are displayed).

In some embodiments, a type of an application object (e.g., an application widget) can be changed directly on a home screen user interface (e.g., without the need to navigate away from the home screen user interface or to select a configuration option in a settings user interface for the home screen or the application) using an in-line editing user interface (e.g., optionally displayed overlaying a home screen user interface). FIGS. 5AK-5AM illustrate changing a respective type of calendar widget 5060 using a configuration displayed via in-line editing user interface 5062, as described in further detail below.

FIG. 5AK illustrates a home screen page 5007. Home screen page 5007 includes the same icons 5002-5016 and 5020-5024 that are included in home screen page 5003 illustrated in FIG. 5G. Further, home screen page 5007 includes a calendar widget 5060 corresponding to the calendar application (e.g., calendar widget 5060 is the same as small widget 5018a displayed in FIG. 5G). Further, the device 100 displays in-line editing user interface 5062 for reconfiguring calendar widget 5060 (e.g., for changing size and/or type of calendar widget 5060). In some embodiments, in-line editing user interface 5062 for reconfiguring calendar widget 5060 is similar to in-line editing user interface 5200 for reconfiguring application icon 5018 in FIG. 5C, but in-line editing user interface 5062 includes an additional configuration option 5064 for changing a respective type of calendar widget 5060, described in further detail below with respect to FIGS. 5AL-5AM.

In some embodiments, in-line editing user interface 5062 is displayed in response to a long press directed to calendar widget 5060 while the home screen page 5007 is displayed in the normal mode. In some embodiments, continuing the long press input performed by a contact with a movement of the contact (e.g., before lift-off of the contact) while the in-line editing user interface 5062 is displayed, causes the device 100 to display home screen page 5007 in the reconfiguration mode and cease to display the in-line editing user interface 5062. Configuration options 5062a, 5062b, 5062c, and 5062d displayed in in-line editing user interface 5062 correspond to configuration options 5202, 5204, 5206, and 5208 displayed in in-line editing user interface 5200. For example, configuration option 5062a, when selected, causes device 100 to transform a selected application object into an application icon (e.g., for transforming calendar widget 5060 into application icon 5018 corresponding to the calendar application); configuration option 5062b, when selected, causes device 100 to transform a selected application object into small widget (e.g., configuration option 5062b is highlighted in FIG. 5AK as it is the currently selected configuration for calendar widget 5060); configuration option 5062c, when selected, causes device 100 to transform a selected application object into medium size widget (e.g., for transforming calendar widget 5060 into medium widget 5018b corresponding to the calendar application, as described in more detail in relation to FIGS. 5D-5G); and configuration option 5062d, when selected, causes device 100 to transform a selected application object into large size widget (e.g., for transforming calendar widget 5060 into large size widget 5018c corresponding to the calendar application, as described in more detail in relation to FIGS. 5D and 5Y). Further, in-line editing user interface 5062 displays control option 5068 “Edit Home Screen” for activating a reconfiguration mode of the multi-page home screen user interface (e.g., control option 5068 in FIG. 5AK corresponds to control option 5210 described in relation to FIG. 5C) and control option 5066 “Remove widget” for removing the currently selected application object (e.g., calendar widget 5060) from home screen page 5007. In addition, as mentioned above, in-line editing user interface 5062 includes configuration option 5064 for changing a respective type of calendar widget 5060. Further, configuration option 5064 indicated the widget type 6064a (e.g., “Up Next”) currently selected for calendar widget 5060. In FIG. 5AK, the device 100 detects input 5069 selecting widget type 6064a.

FIG. 5AL is a transition from FIG. 5AK in response to detection of input 5069 selecting widget type 6064a. In response to input 5069 selecting widget type 6064a, the device 100 displays an in-line editing user interface 5070 for reconfiguring a widget type for calendar widget 5060. In some embodiments, the in-line editing user interface 5070 is displayed overlaying in-line editing user interface 5062 (e.g., optionally obscuring content of in-line editing user interface 5062) without dismissing in-line editing user interface 5062. The in-line editing user interface 5070 displays configuration options 5064a, 5064b, and 5064c for changing the respective type of the currently selected widget into different widget types. For example, configuration option 5064a, when selected, causes the device 100 to set the type of calendar widget to a widget type “Up Next”. According to widget type “Up Next,” the calendar widget 5060 displays upcoming meetings (e.g., one or more meetings that are up next for the day, if any) in calendar widget 5060. In the example in FIG. 5AK-5AL, configuration option 5064a is already selected for calendar widget 5060, e.g., as indicated by the symbol “v” near configuration option 5064a in in-line editing user interface 5070. The content displayed in calendar widget 5060 also reflects that configuration 5064a is the currently selected type for calendar widget 5060 (e.g., calendar widget 5060 displays two upcoming meetings for the day—(1) “Coffee at 1:00 pm” and (2) “Meet John at 6:00 pm”). Configuration option 5064b, when selected, causes the device 100 to change the type of calendar widget 5060 to a widget type “Month,” and configuration option 5064c, when selected, causes the device 100 to change the type of calendar widget 5060 to a widget type “Date,” as explained and illustrated in FIG. 5AM.

In some embodiments, the application associated with a respective widget can be changed using an in-line editing user interface for reconfiguring a widget type (e.g., in-line editing user interface 5070) without the need to navigate away from home screen page 5007. For example, configuration option 5065 in in-line editing user interface 5070 in FIG. 5AL, when selected, causes device 100 to display a list of selectable application for changing the calendar application to a different application that is installed on device 100. In some embodiments, configuration option 5065 indicates the application that is associated with the currently selected application widget (e.g., the calendar application for the calendar widget 5060). In some embodiments, once another application is selected from the list of available applications installed on device 100, the configuration option 5065 would indicate the newly selected application, the selectable options 5064a-5064c will be replaced by the widget types associated with the newly selected application, and the application widget 5060 will be replaced by another small size widget corresponding to the newly selected application.

FIG. 5AM illustrates input 5071 selecting configuration option 5064b for changing the widget type to “Month” and, alternatively, input 5073 selecting configuration option 5064c for changing the widget type to “Date.” In some embodiments, device 100 displays calendar widget 5060b of widget type “Month” on home screen page 5007 (e.g., updating the content of small widget 5060 or replacing small widget 5060) in response to detecting input 5071 selecting configuration option 5064b (e.g., optionally, in conjunction with dismissing in-line editing user interfaces 5062 and 5070). In some embodiments, device 100 displays calendar widget 5060c of widget type “Date” on home screen page 5007 (e.g., updating the content of small widget 5060 or replacing small widget 5060) in response to detecting input 5073 selecting configuration option 5064c (e.g., optionally, in conjunction with dismissing in-line editing user interfaces 5062 and 5070). Accordingly, a type, a size, and an application associated with an application object can be reconfigured without navigating away from a home screen user interface (e.g., via one or more in-line editing user interface, and/or by a drag input that changes the size of the application object and, optionally, causing changes in the type of the application object).

In some embodiments, a selection input directed to an application object (e.g., an application icon or an application widget, or a stack of widgets) is disambiguated to either display an in-line editing user interface or to perform an operation with respect to the application object based on one or more input criteria (e.g., one or more input thresholds, such as intensity, duration, and/or other thresholds). For example, in FIG. 5B, selection input 5102 directed to application icon 5018 corresponding to the calendar application causes device 100 to either display an in-line editing user interface 5200, as described in further detail in relation to FIG. 5C, or to open the calendar application and display user interface 5009 of the calendar application, as illustrated in FIG. 5AN. In some embodiments, selection input 5102 is disambiguated based on a duration criterion, e.g., based on whether the input includes less than a threshold amount of movement in a threshold amount of time (e.g., is kept substantially stationary at the location corresponding to the application icon 5018) and is maintained for at least a first threshold amount of time (e.g., meeting a first time threshold) before termination of the input. For example, in accordance with a determination that selection input 5102 ended (e.g., a lift off or end of selection input 5102 is detected) before a threshold amount of time has passed, device 100 opens the calendar application and display user interface 5009 of the calendar application, as illustrated in FIG. 5AN. In accordance with a determination that the selection input 5102 has not ended (e.g., a lift off of selection input 5102 is not detected) before the threshold amount of time has passed, device 100 displays the in-line editing user interface 5200, as illustrated in further FIG. 5C. In some embodiments, other types of input thresholds can be used to disambiguate the input, e.g., an intensity threshold that distinguishes between a tap input and a light press input, or between a light press input and a hard press input. In some embodiments, other input types that can be disambiguated using input thresholds can replace the touch gestures used in the examples, e.g., an air pinch and release gesture and an air pinch and hold gesture, a click and release input and a click and hold input performed by a mouse, a left button click and a right button click on a mouse, a double click and a single click, and/or other pairs of inputs of input types other than touch gestures.

In some embodiments, labels (e.g., text identifying the names of applications) of application icons in a home screen user interface can be hidden or unhidden using a control setting. FIGS. 5AO-5AR illustrate hiding labels of application icons displayed in a home screen user interface in response to enabling a setting directly in the home screen user interface, as described in further detail below.

FIG. 5AO illustrates a home screen page 5013 in the reconfiguration mode, in accordance with some embodiments. FIG. 5AO displays the same application icons 5002-5024 that are displayed on home screen page 5003 in FIG. 5B. In FIG. 5AO, each application icons of application icons 5002-5024 is displayed concurrently a corresponding label identifying a respective application of the application icons. For example, a label “Messages” is displayed concurrently with application icon 5002 to indicate that application icon 5002 corresponds to a messages application; a label “Photos” is displayed concurrently with application icon 5004 to indicate that application icon 5004 corresponds to a photos application; a label “Camera” is displayed concurrently with application icon 5006 to indicate that application icon 5006 corresponds to a camera application; a label “Stocks” is displayed concurrently with application icon 5008 to indicate that application icon 5008 corresponds to a stocks application; a label “TV” is displayed concurrently with application icon 5010 to indicate that application icon 5010 corresponds to a TV application; a label “Clock” is displayed concurrently with application icon 5012 to indicate that application icon 5012 corresponds to a clock application; a label “Notes” is displayed concurrently with application icon 5014 to indicate that application icon 5014 corresponds to a notes application; a label “Home” is displayed concurrently with application icon 5016 to indicate that application icon 5016 corresponds to a notes application; a label “Calendar” is displayed concurrently with application icon 5018 to indicate that application icon 5018 corresponds to a calendar application; a label “App 1” is displayed concurrently with application icon 5020 to indicate that application icon 5020 corresponds to a first application; a label “App 2” is displayed concurrently with application icon 5022 to indicate that application icon 5022 corresponds to a second application; and a label “App 3” is displayed concurrently with application icon 5024 to indicate that application icon 5024 corresponds to a third application.

In some embodiments, as described above, a number of controls (e.g., delete affordances, resize handles, affordance for adding new application objects, and/or other controls) for editing the home screen user interface are displayed when the reconfiguration mode is active, as described in further detail in relation to FIG. 5Q. Further, when the reconfiguration mode is active, application objects move side to side or jiggle to indicate that the reconfiguration mode is active. Additionally, control setting 5021 is displayed on home screen page 5013 optionally when the reconfiguration mode is active, when the normal mode is active, or both. Optionally, control setting 5021 is displayed on each page of the multi-page home screen user interface (e.g., optionally when the multipage home screen user interface is in the reconfiguration mode, in the normal mode, or both). Optionally, control setting 5014a for changing color palette of application objects in the home screen is also displayed on home screen page 5013 (e.g., optionally when the home screen page 5013 is in the reconfiguration mode, in the normal mode or both). Optionally, control settings 5012 and 5014a are displayed concurrently.

In FIG. 5AO, device 100 detects an input 5015 selecting control setting 5021 for hiding and unhiding applications icons labels in a home screen user interface. In response to the detection of input 5015 selecting control setting 5021 for hiding and unhiding applications icons labels, the device 100 removes the currently displayed labels of application icons 5002-5024, as illustrated in FIG. 5AP, as described in further detail below.

FIG. 5AP is a transition from FIG. 5AO in response to the detection of input 5015 selecting control setting 5021 for hiding and unhiding applications icons labels. As illustrated, labels of application icons 5002-5024 are removed. In some embodiments, in conjunction with removing the labels of application icons 5002-5024, the device 100 automatically enlarges respective sizes of application icons 5002-5024 in according with a determination that a setting for hiding the labels is enabled (e.g., while maintain equal relative sizes of application icons 5002-5024). In some embodiments, in response to enabling the setting for hiding the labels caused by the selection of control setting 5021, device 100 changes the appearance of control setting 5021 to indicate that the setting for hiding the labels is enabled (e.g., appearance of control setting 5021 in FIG. 5AO indicates that the setting for hiding the labels is not enabled compared to the appearance of control setting 5021 in FIG. 5AP indicating that the setting for hiding the labels is enabled). In some embodiments, an input selecting control setting 5021 in FIG. 5AP, causes the device 100 to redisplay the labels in the home screen page 5013 as illustrated in FIG. 5AO (e.g., before enabling that the setting for hiding the labels). Accordingly, control setting 5021 functions as an on and off toggle for enabling and disabling the setting for hiding the labels, in some embodiments. In some embodiments, the changes made to the home screen user interface that correspond to enabling or disabling the setting for hiding the labels, are maintained when device 100 exits the reconfiguration mode. FIGS. 5AQ-5AR illustrate the home screen page 5013 in the normal mode when the setting for hiding the labels is enabled (e.g., without the labels of the application icons 5002-5024 and with enlarged application icons 5002-5024).

FIG. 5AQ illustrates an input 5017 selecting affordance 5322 “Done” for confirming and saving changes made to the home screen user interface 5010 and, alternatively, input 5019 directed to the home screen user interface 5010 for exiting the reconfiguration mode (e.g., without explicitly confirming any changes made to the home screen user interface). In some embodiments, when the setting for hiding the labels is enabled, application icons are displayed without labels regardless of how the device 100 exits the reconfiguration mode (e.g., with or without confirming explicitly the changes via selection affordance of 5322 “Done”). In some embodiments, unless the changes made in the reconfiguration mode are confirmed via selection of affordance 5322 “Done”), the device 100 reverts the enablement or disablement of the setting for hiding the labels made during the reconfiguration mode.

FIG. 5AR is a transition from FIG. 5AQ in response to either input 5017 selecting affordance 5322 “Done” or input 5019 directed to the home screen user interface 5010 for exiting the reconfiguration mode. In FIG. 5AR, the home screen user interface 5010 is displayed in the normal mode, without the labels for application icons 5002-5024 (e.g., in accordance with a determination that setting for hiding the labels is enabled), and with application icons 5002-5024 enlarged (e.g., relative to application icons 5002-5024 in FIG. 5AQ). In some embodiments, automatically enlarging the application icons in conjunction with hiding the respective labels of the application icons, improves utilization of space in the home screen user interface. In some embodiments, a foreground graphical portion of an application icon is animated or moving to indicate an ongoing activity associated with the application corresponding to the application icon (e.g., ongoing call, recording, software update, downloading, uploading, sharing, or workout). FIG. 5AS illustrates application icons without animation (e.g., because there is no ongoing activity) and FIG. 5AT illustrates the same application icons as displayed in FIG. 5AS, however, some of the application icons are displayed with animation (e.g., because there is ongoing activity).

FIG. 5AS illustrates home screen user interface 5011 in the normal mode. Home screen user interface 5011 includes the same application icons 5002-5018 and 5024 that are displayed on home screen page 5003 in FIG. 5B. In addition, application icon 5020a corresponding to a fitness application is added (e.g., and application icon 5020 is removed relative to FIG. 5B) and application icon 5022a corresponding to a settings application is added (e.g., and application icon 5022 removed relative to FIG. 5B), to facilitate description of this example. In FIG. 5AS, none of the associated applications of application icons 5002-5018, 5020a, 5022a, and 5024 have ongoing activity (e.g., an event that is occulting in the respective application) at this time. Accordingly, no animation is displayed in the application icons in FIG. 5AS.

FIG. 5AT is a transition from FIG. 5AS in accordance with a determination that the messages application (e.g., corresponding to application icon 5002), the photos application (e.g., corresponding to application icon 5004), the fitness application (e.g., corresponding to application icon 5020a), and the settings application (e.g., corresponding to the application icon 5022a) have respective ongoing activities occurring. Accordingly, respective foreground graphical portions of application icons 5002, 5004, 5020a, and 5022a are animated, while other application icons in home screen user interface 5011 are displayed without animation. In some embodiments, the activity associated with the messages application corresponds to receiving or sending messages within a threshold time window of the current time (e.g., if the sending and/or receiving is occurring now and/or occurred within a minute or 30 seconds of the current time). The animation in application icon 5002 corresponding to the messages application is illustrated with arrow 5082 (e.g., the animation involves animated movement of one or more graphical elements displayed within application icon 5002 and/or the application icon 5002 as a whole, and arrow 5082 is used for descriptive purposes). In some embodiments, the activity associated with the photos application may correspond to sharing (e.g., via Bluetooth, or other ad hoc or persistent connections) or downloading shared pictures or videos within a threshold time window of the current time (e.g., if the sharing and/or downloading is occurring now and/or occurred within a minute or 30 seconds of the current time). The animation in application icon 5004 corresponding to the photos application is illustrated with arrow 5084 (e.g., the animation involves animated movement of one or more graphical elements displayed within application icon 5004 and/or the application icon 5004 as a whole, and arrow 5084 is used for descriptive purposes). The animation in application icon 5020a corresponding to the fitness application is illustrated with arrow 5086 (e.g., the animation involves movement of a graphical element displayed within application icon 5004, such as a beating heart (e.g., pulsating and/or changing colors) and arrow 5086 is used for descriptive purposes). The animation in application icon 5022a corresponding to the settings application is illustrated with arrow 5088 (e.g., the animation involves movement of a graphical element displayed within application icon 5022a, such as moving gears (e.g., rotating gears and/or moving progress bars), and arrow 5088 is used for descriptive purposes). In some embodiments, the animated movements of the application icons that have ongoing activities and/or recent activities are indicative of the status of the ongoing activities, such as progress (e.g., 50% complete, paused, and/or waiting), activity type (e.g., sending, receiving, downloading, measuring, or sharing), and values of one or more parameters of the activities (e.g., number for heart rate, colors for abnormal readings or errors). In some embodiments, different sets of one or more applications may have ongoing activities at different times, and the animated movements of the components of the application icons that have ongoing activities draws attention of the user regarding these transient activities, without being overly distracting. In some embodiments, the animated portions of the application icons are different from a badge that displays the number of missed notifications or messages that is updated as new notifications and/or messages arrive.

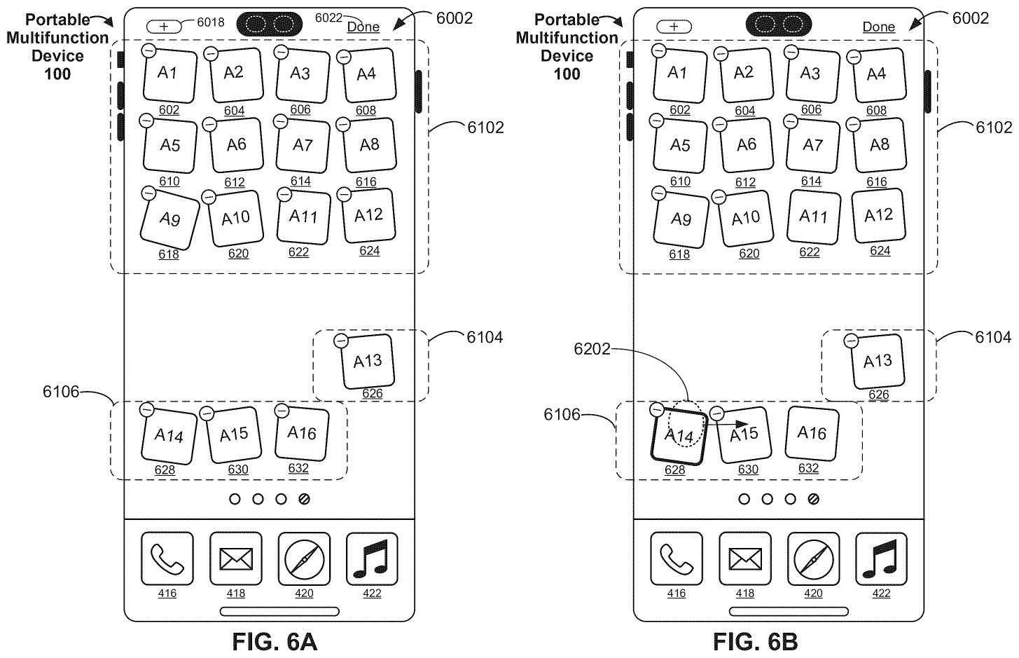

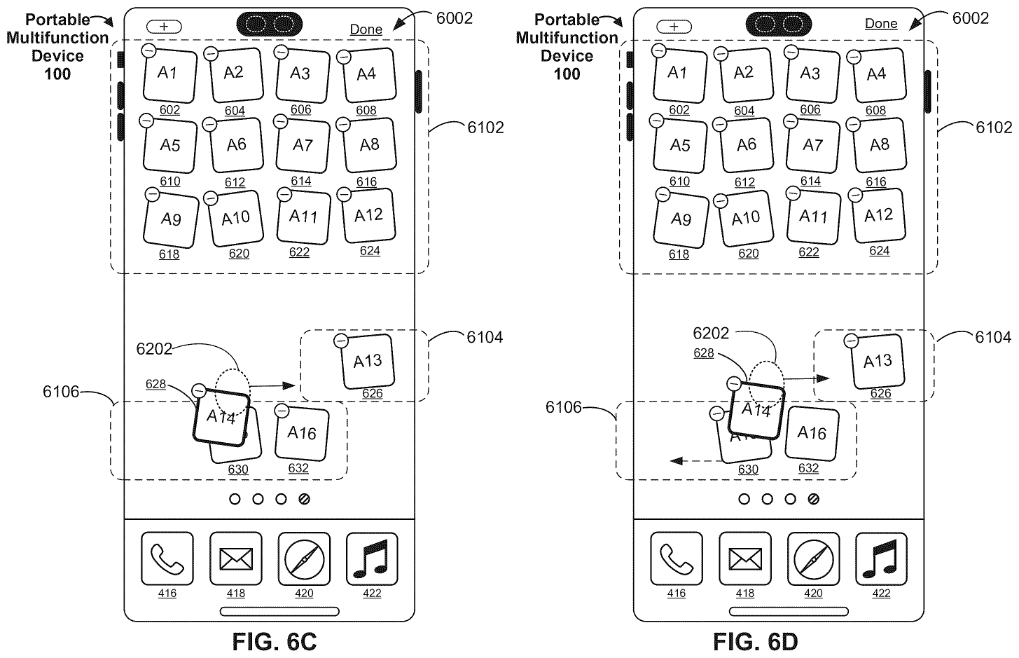

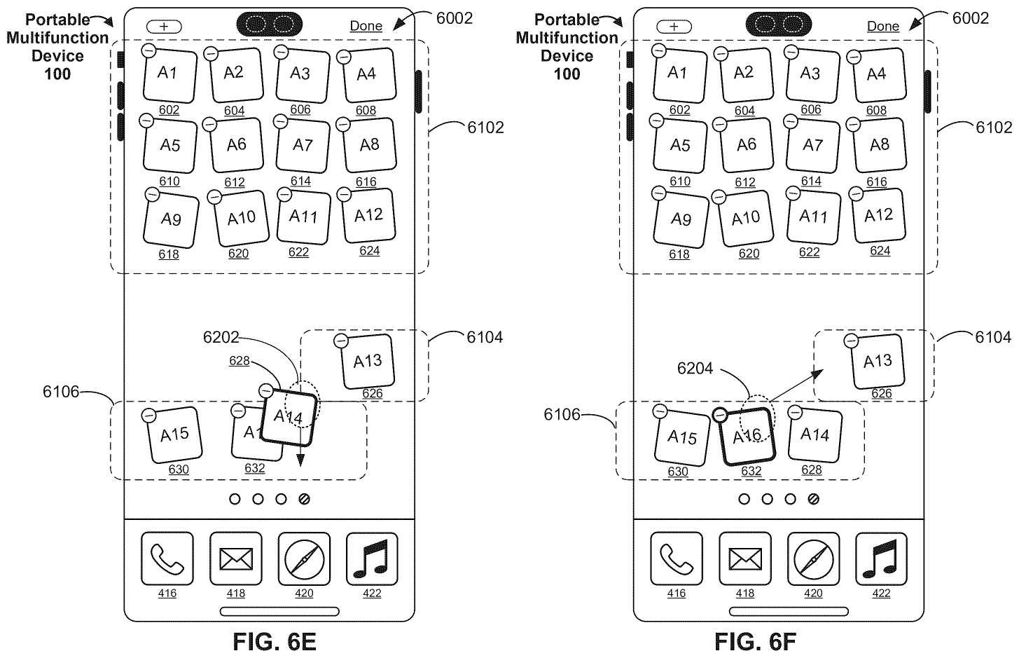

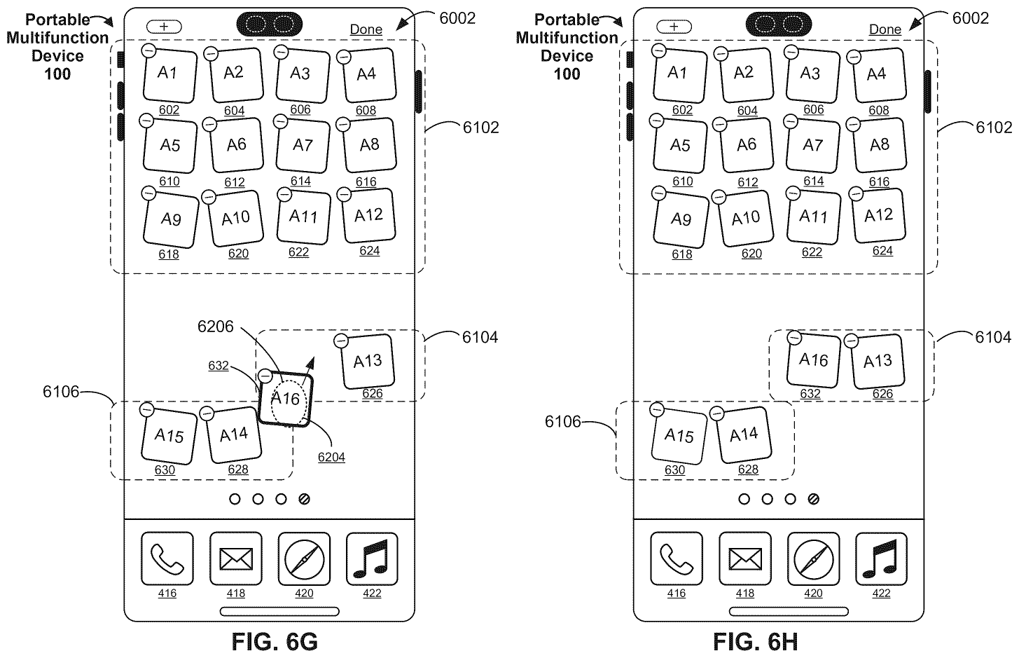

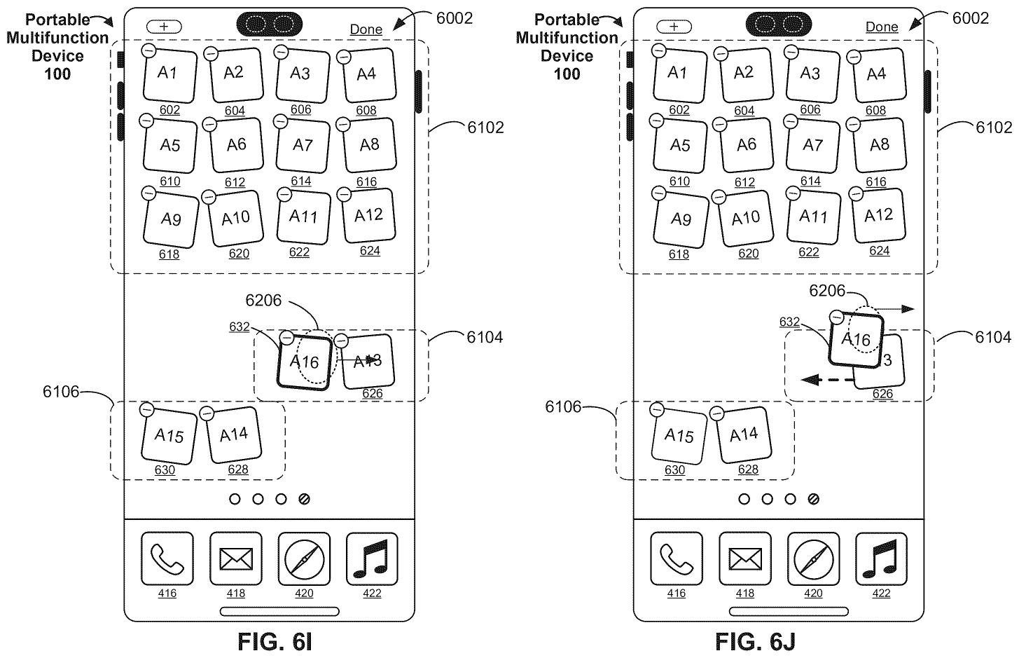

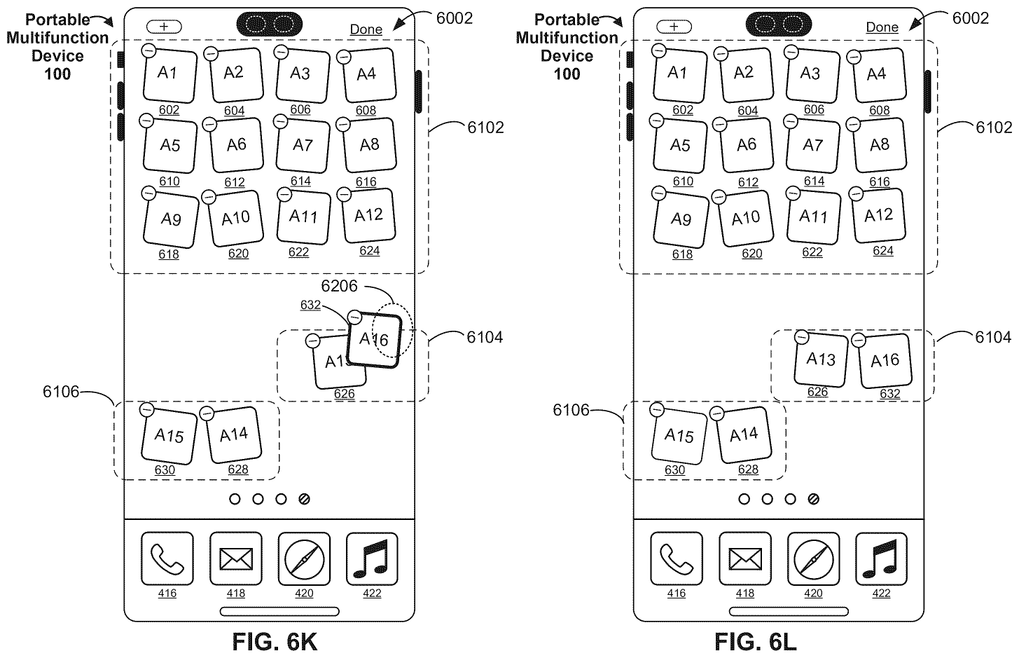

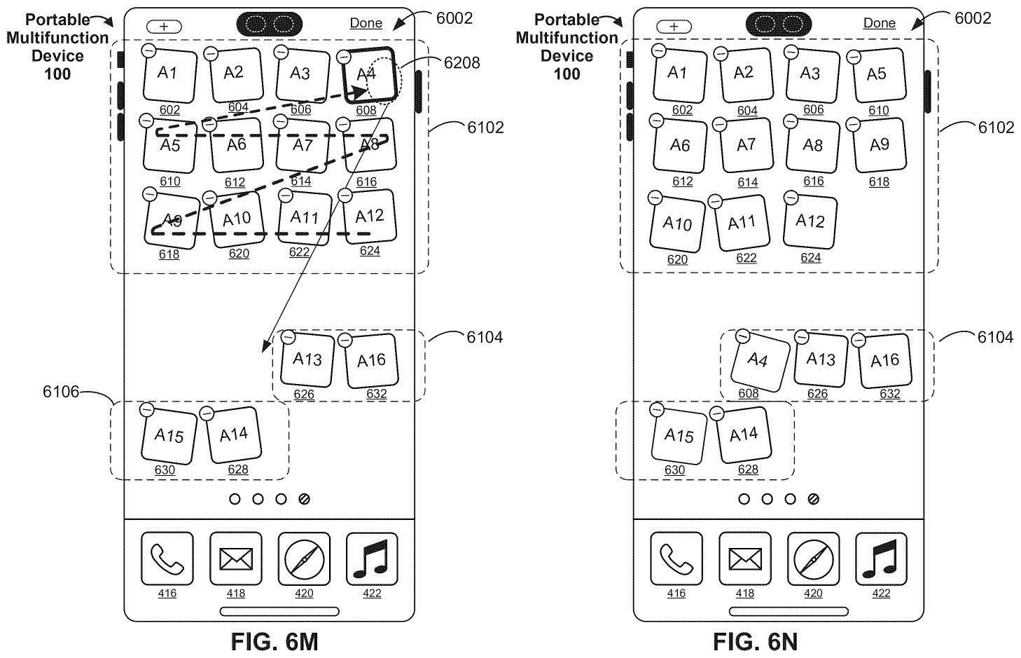

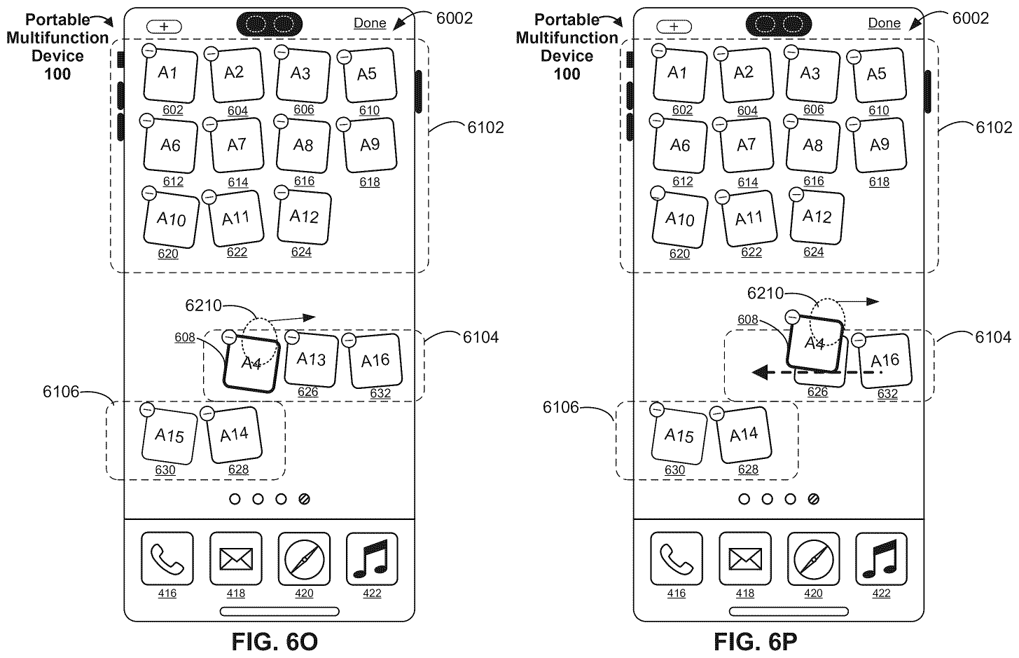

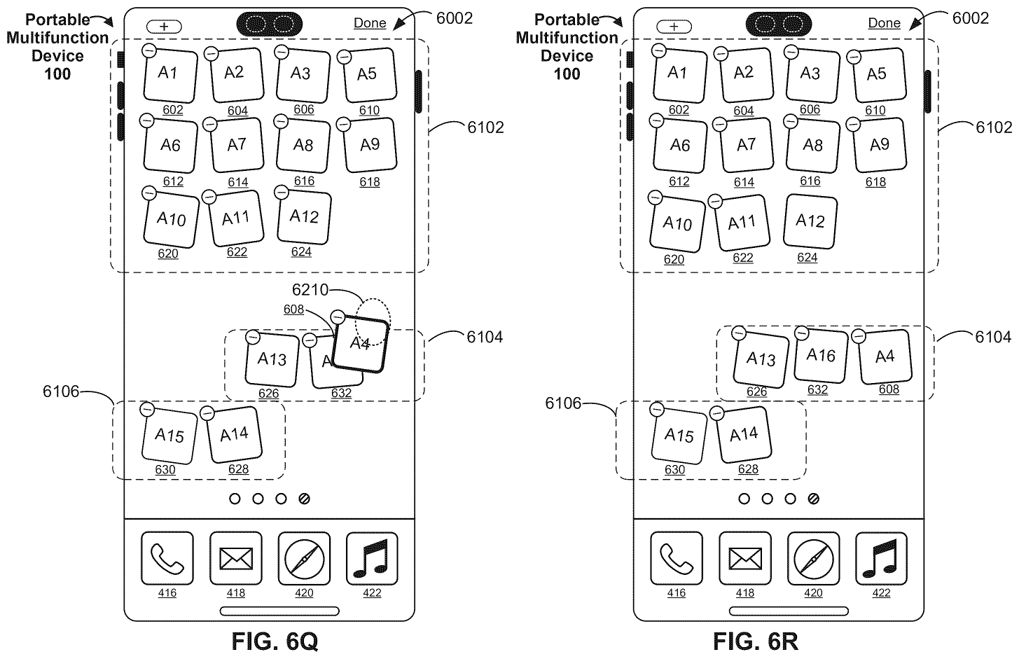

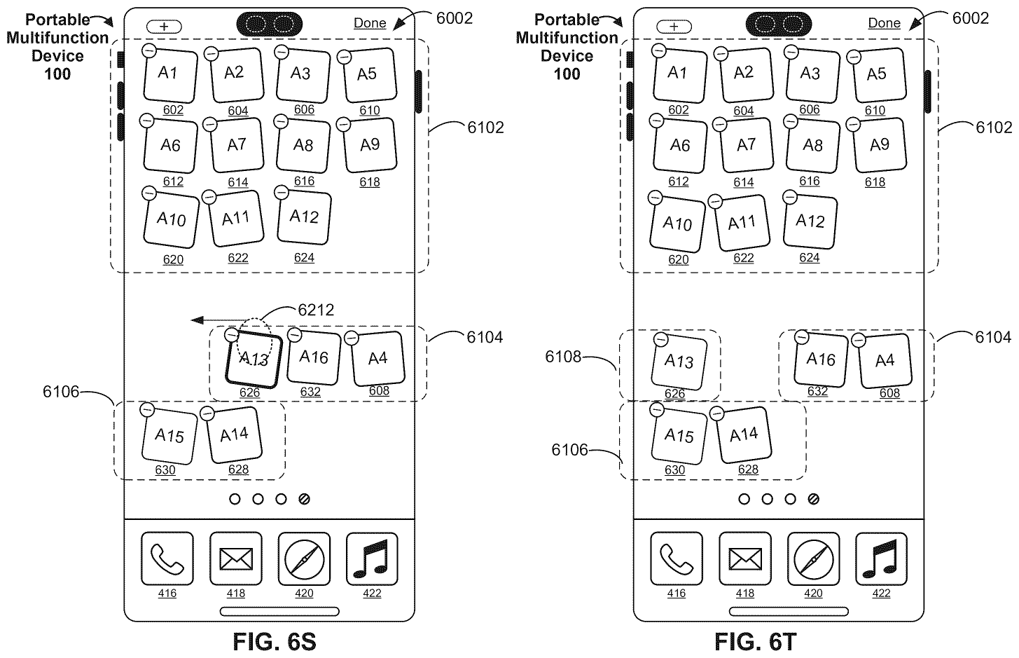

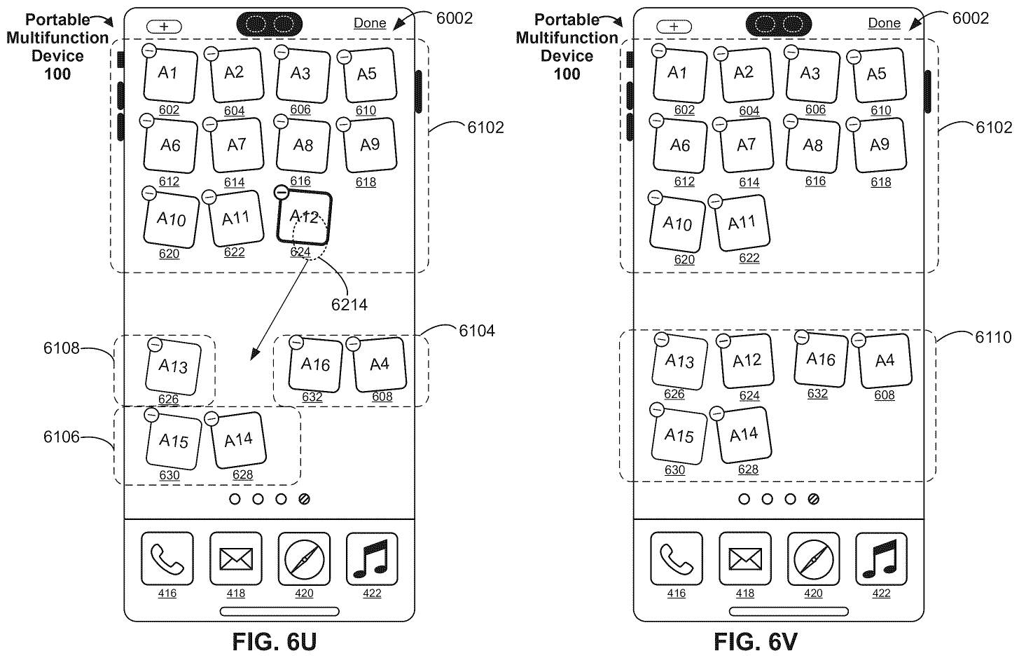

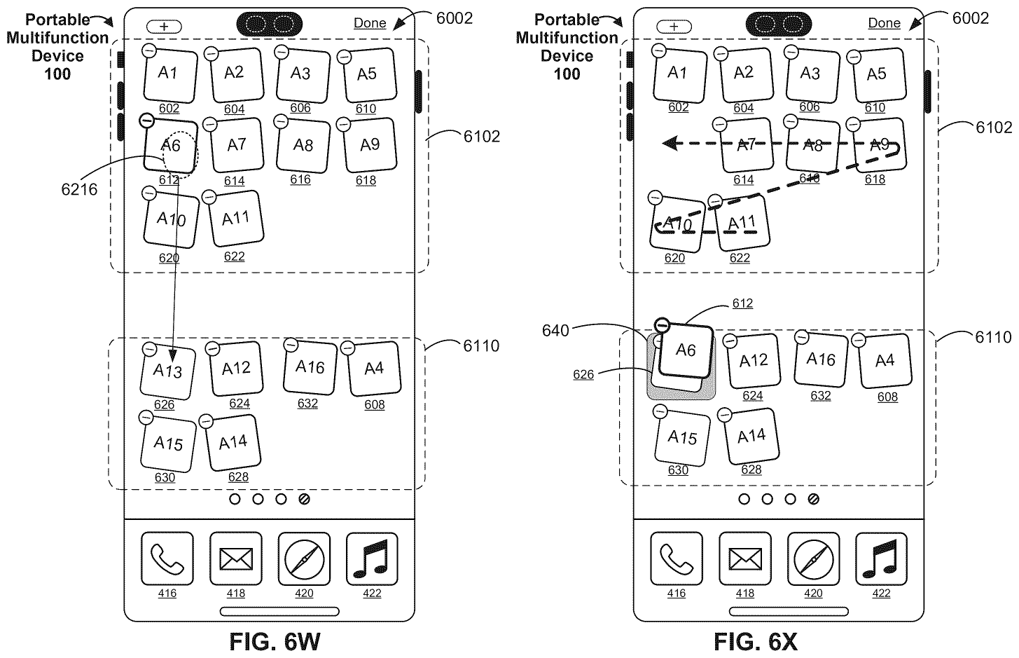

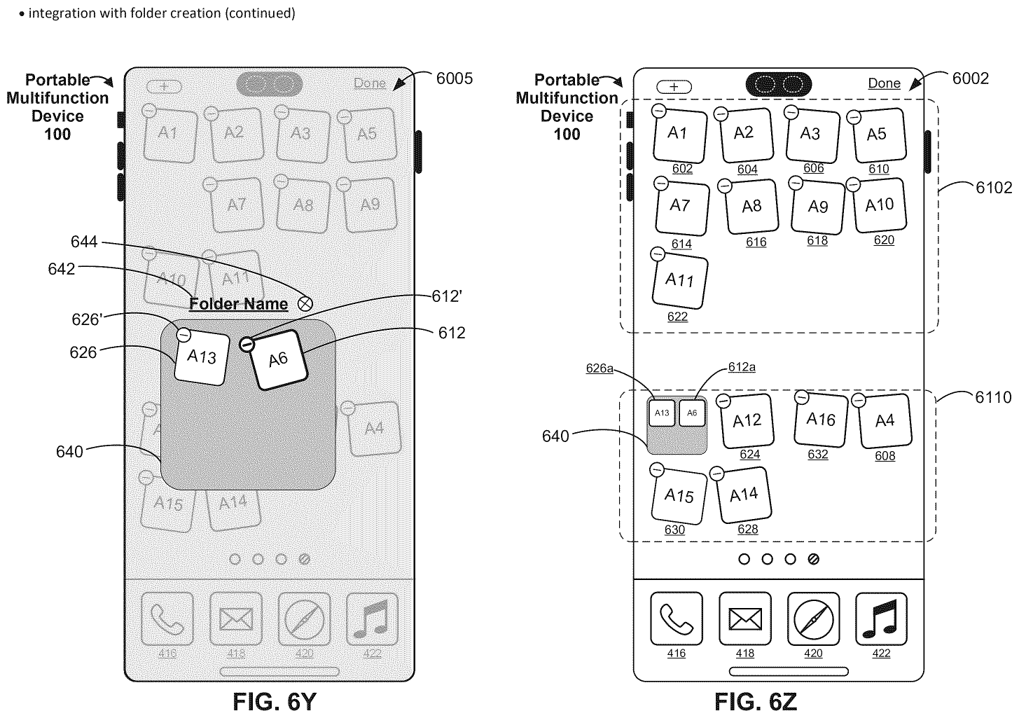

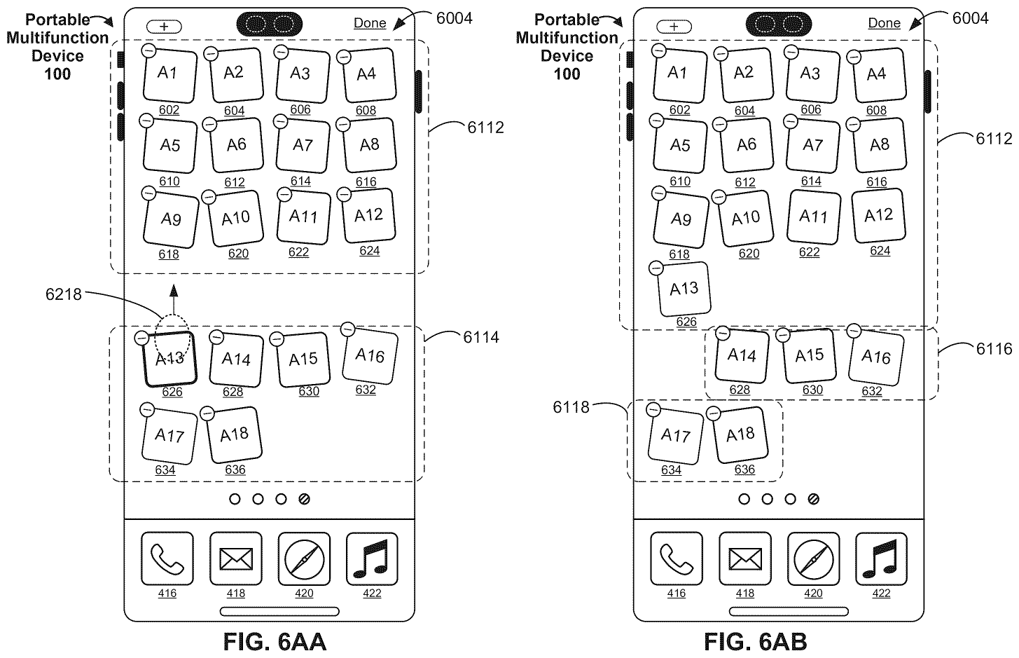

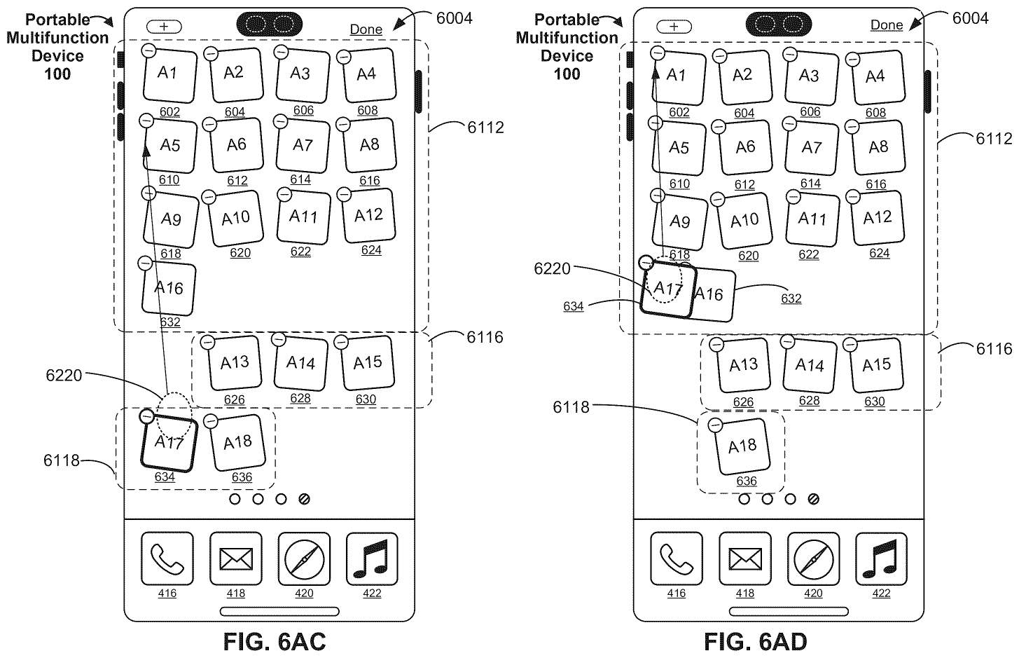

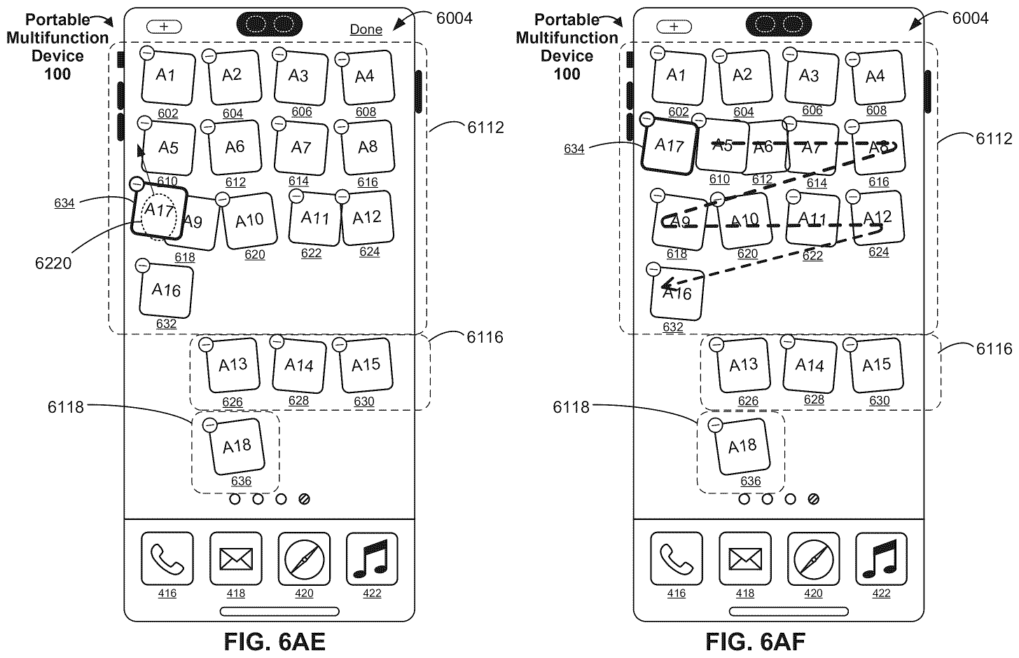

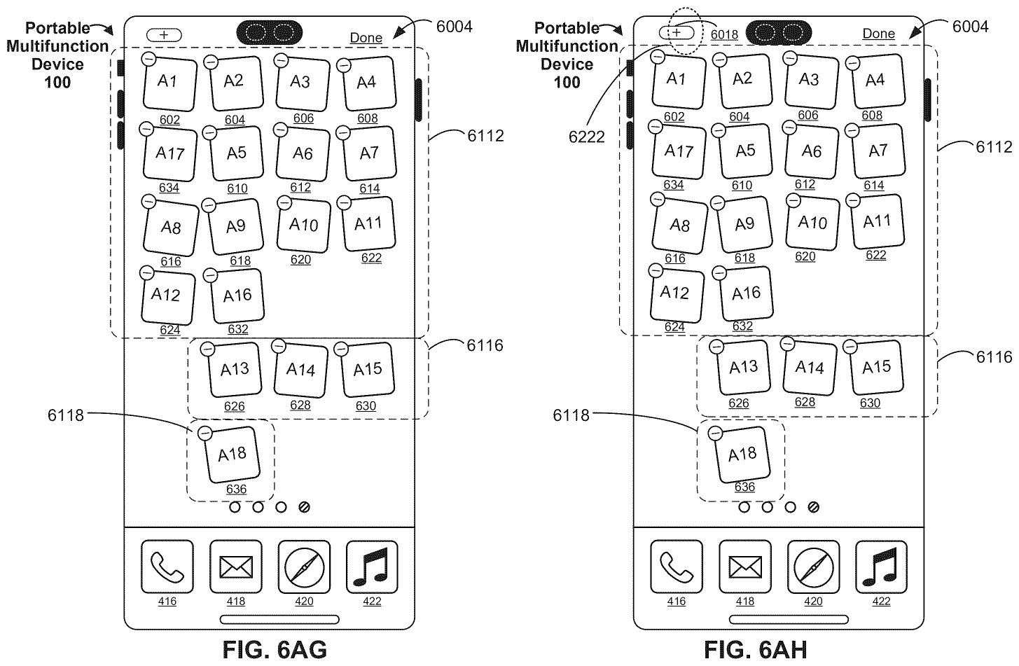

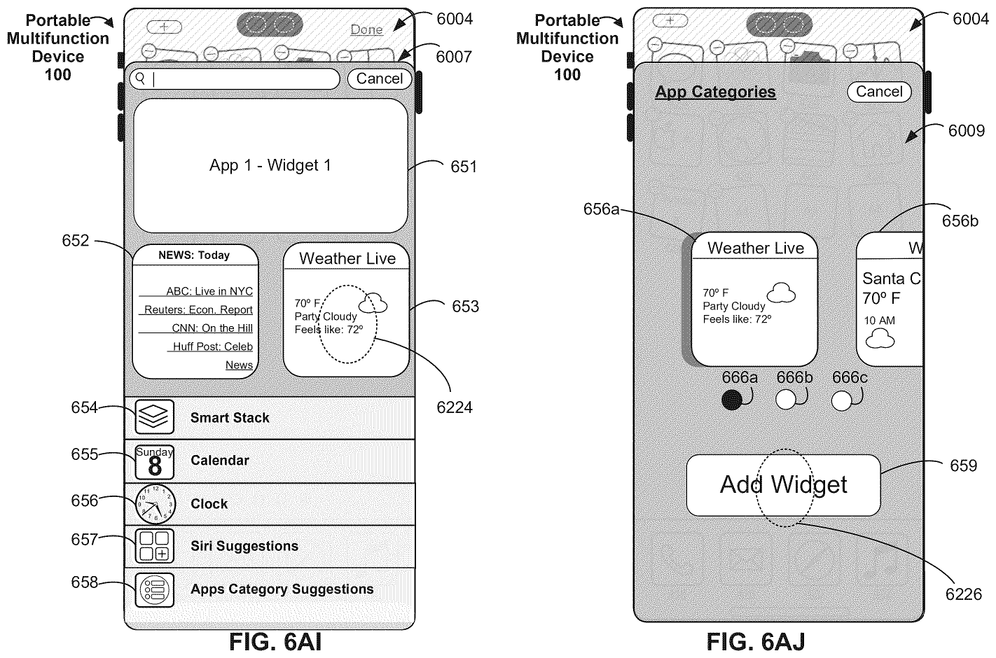

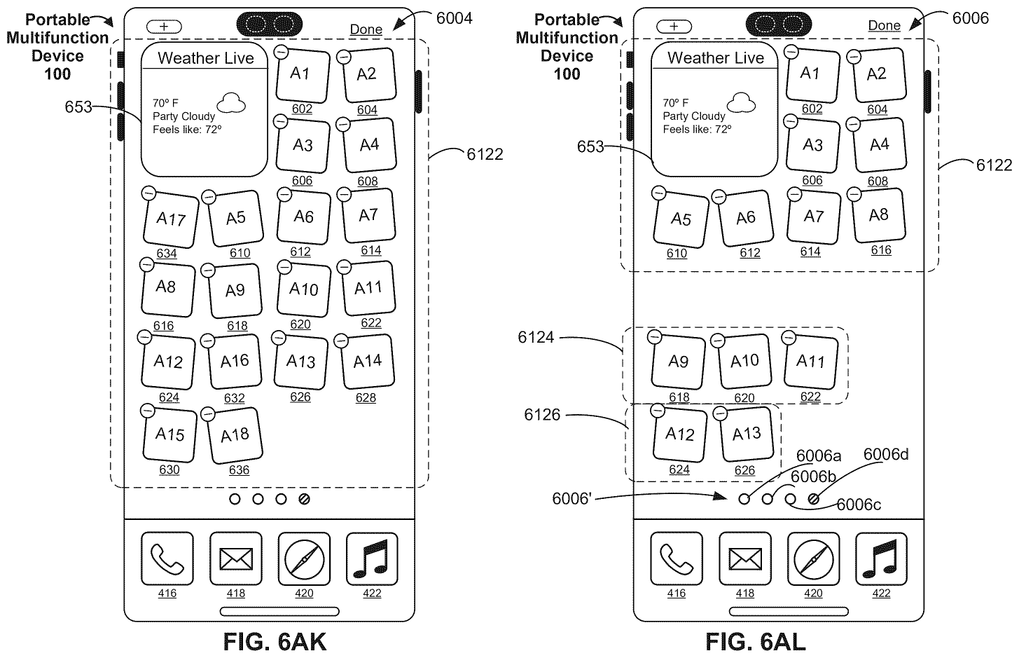

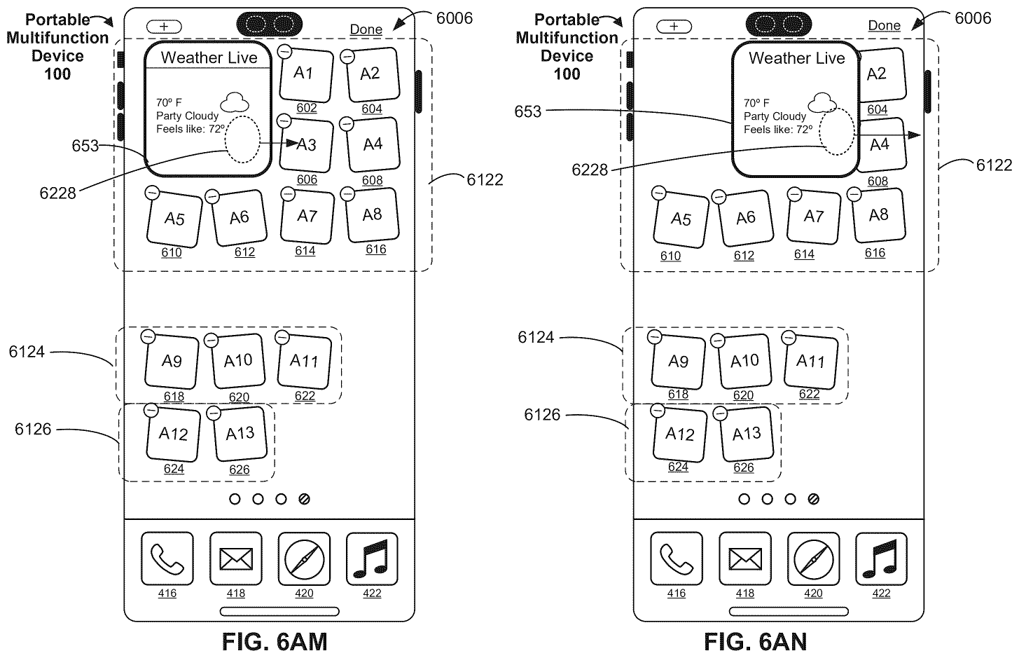

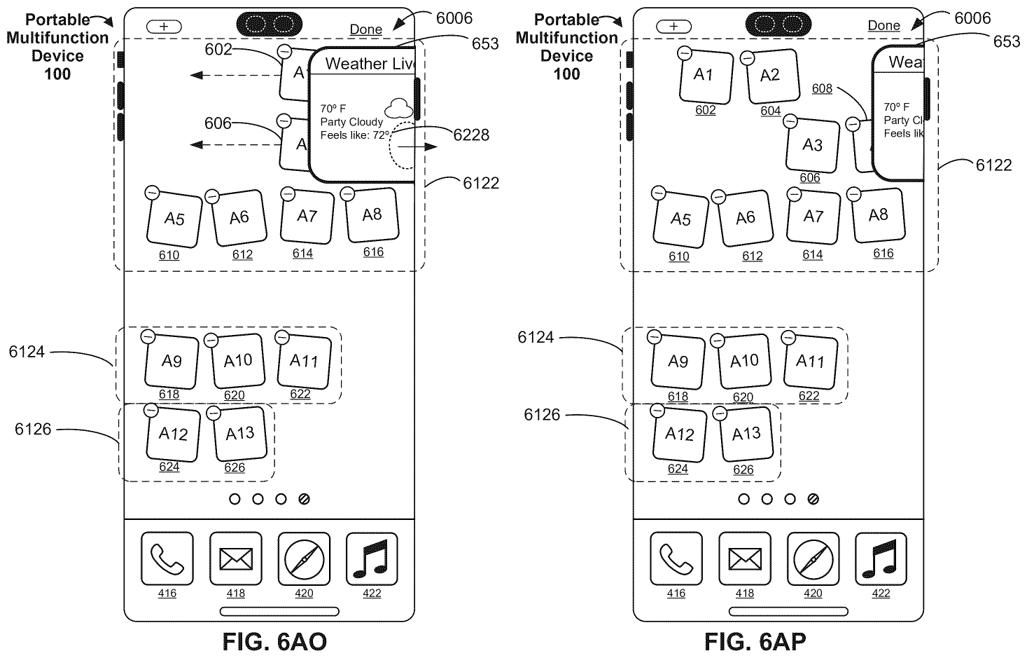

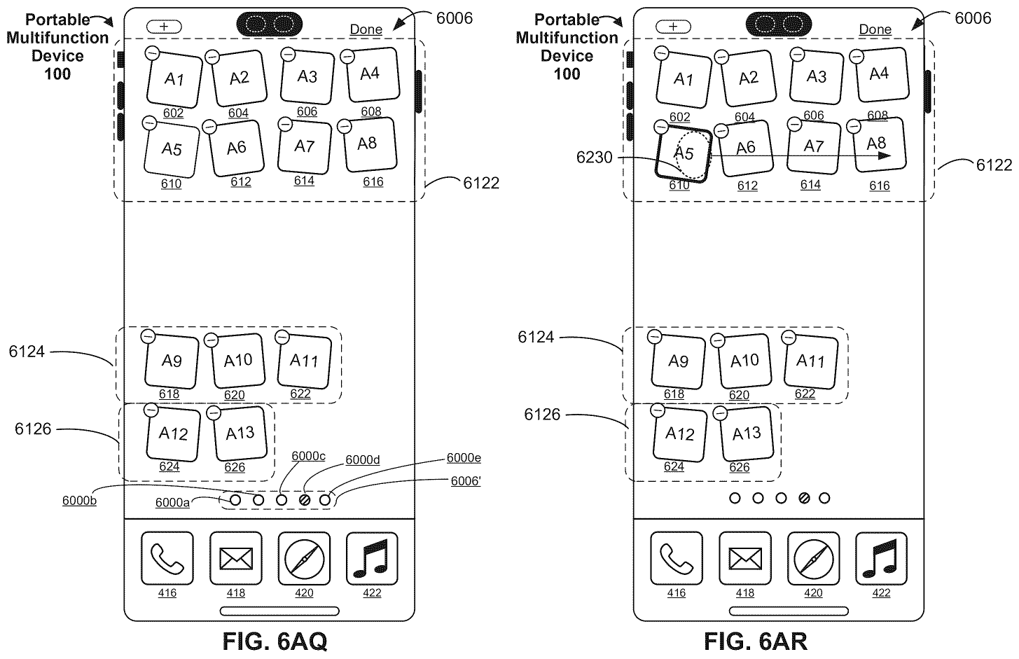

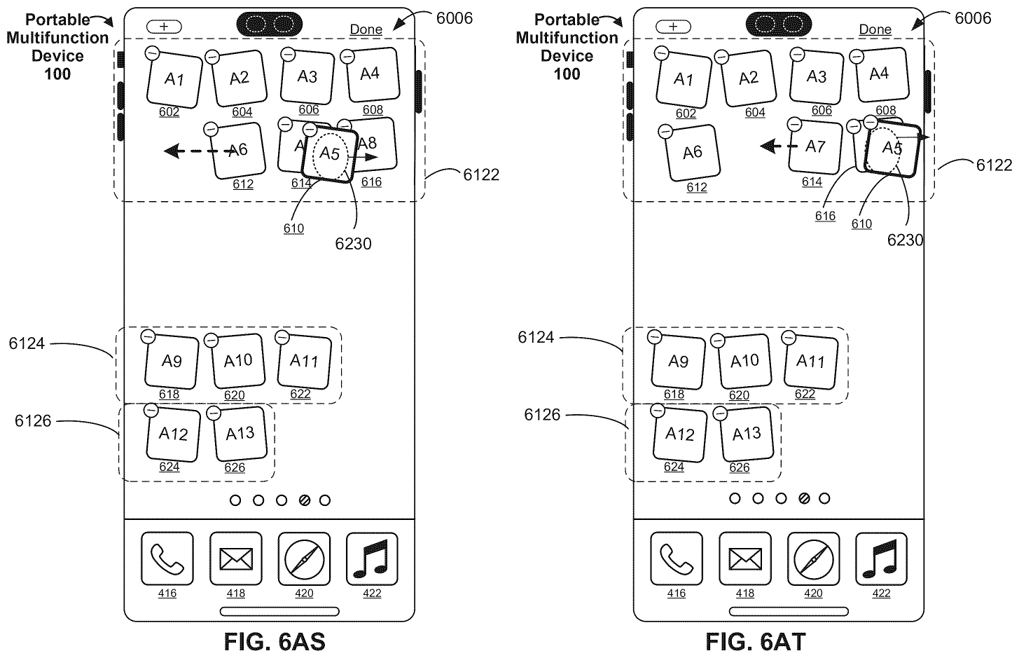

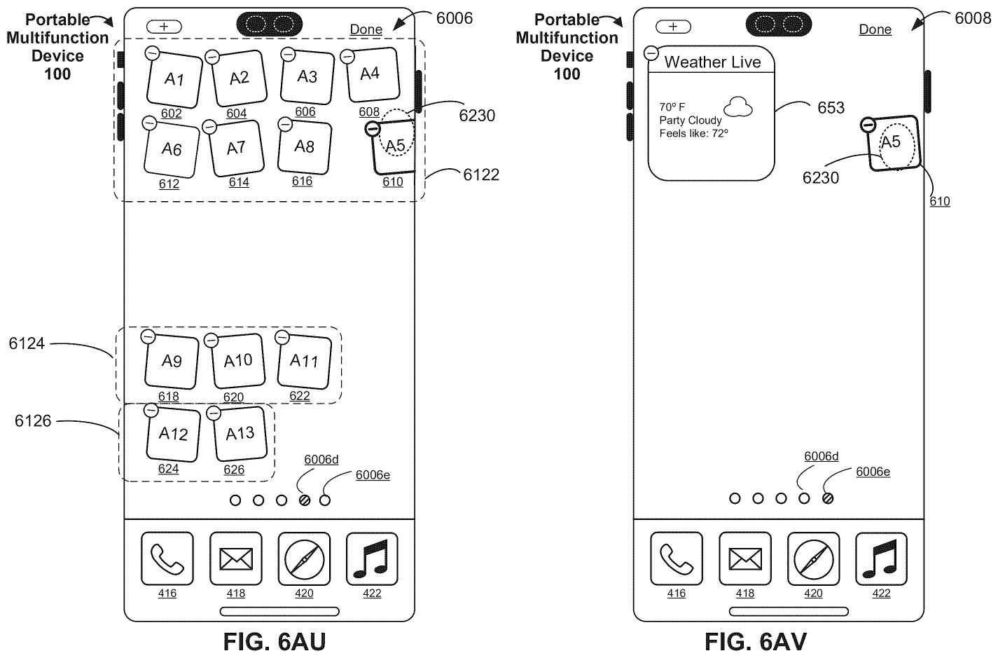

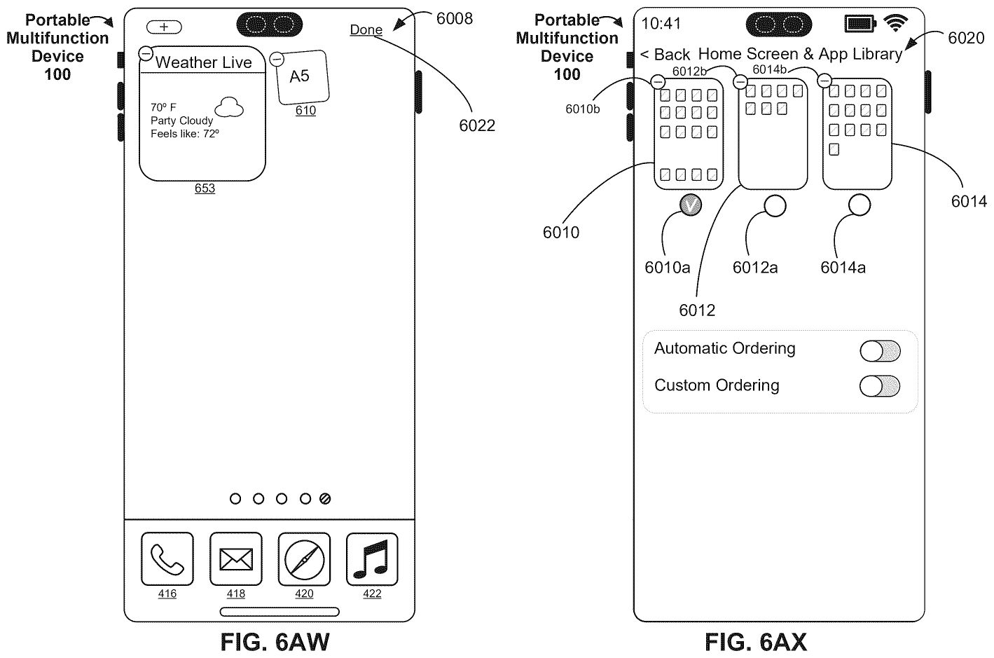

FIGS. 6A-6AX illustrate example user interfaces and interactions for automatic grouping and organizing of application objects in a home screen user interface, in accordance with some embodiments. FIGS. 11A-11H are a flow diagram of an exemplary method 11000 for automatic grouping and organizing of application objects in a home screen user interface, in accordance with some embodiments. The user interfaces in FIGS. 6A-6AX are used to illustrate the processes described below, including the processes described with respect to FIGS. 11A-11H.

FIG. 6A-6AX illustrate example user interfaces and techniques for automatic grouping and organizing of application objects (e.g., application icons) on a home screen page based on group association criteria, and techniques for automatic generation of system-arranged groups of application objects based on criteria including spatial proximity of application objects (e.g., objects of the same object type) to one another, in accordance with some embodiments.

In some embodiments, a home screen page (e.g., home screen page 6002) of a multi-page home screen user interface has a grid of placement locations for organizing application objects (e.g., application icons, application widgets, and/or folders with application icons) on the home screen page. In some embodiments, the grid of placement locations has a grid size and/or a total number of available placement locations for displaying application icons. For example, a 1×4 grid (e.g., one row and four columns of placement locations for application icons), a 2×4 grid (e.g., two rows and four columns of placement locations for application icons), a 4×4 grid (e.g., four rows and four columns of placement locations for application icons), a 5×4 grid (e.g., five rows and four columns of placement locations for application icons), a 5×5 grid (e.g., five rows and five columns of placement locations for application icons), a 2×6 grid (e.g., two rows and six columns of placement locations for application icons), a 4×6 grid (e.g., four rows and six columns of placement locations for application icons), a 6×6 grid (e.g., six rows and six columns of placement locations for application icons), a 2×8 grid (e.g., two rows and eight columns of placement locations for application icons), a 4×8 grid (e.g., four rows and eight columns of placement locations for application icons), a 6×8 grid (e.g., sic rows and eight columns of placement locations for application icons), an 8×8 grid (e.g., eight rows and eight columns of placement locations for application icons), and/or other type of grids). In some embodiments, the grid is not necessarily a rectangular grid with rectangular shaped cells for placement locations. In some embodiments, the cells of the grid are off set from each other in adjacent rows or columns, creating a honeycomb structure or other lattice shapes for the grid. In some embodiments, the size of the grid (e.g., the number of rows and number of columns in the grid) can be modified or configured by a user (e.g., in response to user inputs). For example, a user can change the size or grid configuration from a grid configuration of 4×6 rectangular grid to a grid configuration of 3×5 rectangular grid. In some embodiments, removing labels of application icons can cause the device 100 to enlarge the application icons in conjunction with changing the size of the grid, as described in further detail with reference to FIGS. 5AO-5AR. In some embodiments, a size of one unit of a placement location in the grid corresponds to a size of a single application icon (e.g., an application icon is the smallest placement unit). For example, a slot in the grid corresponds to the size of an application icon. In some embodiments, multiple units of placement locations in the grid (e.g., two rows and two columns, four rows and two columns, four rows and four columns, or three rows and five columns) can form one placement location for a larger application object, such as an application widget.

In some embodiments, the computer system (e.g., device 100) generates or forms system-arranged groupings of application objects based on a number of criteria related to positions of application objects on the grid of the home screen page, and positions and/or proximity of application objects in relation to another (e.g. including based on whether application objects are placed in contiguous placement locations and/or contiguous rows), as described in further detail in relation to FIGS. 6A-6AX. In some embodiments, the home screen page, and optionally other pages of the multi-page home screen user interface, are user configurable. For example, application objects on the home screen page can be repositioned, added, removed, transformed from one type or size to another type or size, and/or changed based on other edits that are performed in response to user input(s). In some embodiments, when a user makes changes to a home screen page, including adding, removing, repositioning, and/or resizing an application object, the computer system automatically modifies (or, optionally, re-arranges) the system-arrange groupings in a number of possible ways, including, but not limited to, forming new system-arranged groupings of application objects, merging existing system-arranged groupings of application objects, condensing existing system-arranged groupings of application objects to fill up vacant spots (e.g., reflowing application icons within a group), adding application objects to existing system-arranged groupings of application objects, removing application objects from existing system-arranged groupings of application objects and/or other re-arrangements or modifications of the groupings on the home screen page. Accordingly, while the computer system automatically forms the system-arranged groups, user-specified configuration (e.g., user inputs re-arranging the home screen page) at least partially dictates or drives the formation of the groupings of application objects.

In some embodiments, application objects (e.g., application icons, or another plurality of application objects, such as widgets, that are of the same size) within a group (e.g., system-arranged group) reflow or shift automatically when an application object from the group is repositioned (e.g., deleted and/or moved in response to a user input) without causing application objects in other groups (e.g., system-arranged groups) on the same home screen page to reflow. FIGS. 6A-6F illustrate reflowing application icons in one group of application icons (e.g., group 6102 of application icons 602-624) without causing application icons in other groups on the same home screen page to reflow (e.g., group 6104 of one application icon 626 and group 6106 of application icons 628-632), in accordance with some embodiments. More details are provided below.

FIG. 6A illustrates home screen page 6002 of a multi-page home screen user interface, in accordance with some embodiments. Home screen page 6002 is user configurable (e.g., application objects on the home screen page can be repositioned, added, and/or removed), as described in further details below in relation to FIGS. 6A-6AX. In FIG. 6A, home screen page 6002 is in the reconfiguration mode in which the home screen page 6002 can be configured in response to user input(s). In the reconfiguration mode, home screen page 6002 displays application objects (e.g., application icons and/or widgets) on the home screen page 6002 and affordance 6022 for confirming and saving any changes that are made to the home screen page 6002 while in the reconfiguration mode (e.g., deletion, addition, and/or relocation of application objects). Home screen page 6002 displays application icons 602-632 placed at various placement locations for application icons on a 6×4 grid (e.g., six rows and four columns of placement locations for application icons). For example, in FIG. 6A, the first row of home screen page 6002's grid (6×4) of placement locations for application icons includes application icons 602, 604, 606, and 608; the second row of placement locations for application icons in the grid includes application icons 610, 612, 614, and 616; the third row of placement locations for application icons in the grid includes application icons 618, 620, 622, and 624; the fourth row is empty (e.g., fourth empty placement locations for application icons); the fifth row of placement locations includes application icon 626 at the fourth (e.g., the last placement location) placement location for application icon in the row; and the sixth row of placement locations includes application icons 628, 630, and 632 at the first, second, and third placement locations for application icons in the row, respectively. In the reconfiguration mode, application icons 602-632 are optionally moving side to side (e.g., jiggling) to indicate that a user can reposition the application icons 602-632 (e.g., provide visual feedback that the reconfiguration mode is active). In some embodiments, when an application icon is added to a user-configurable home screen page of the multipage home screen user interface, the user can choose the placement location for the application icon, rather than having the operating system choose a default placement location for the application icon (e.g., the highest or lowest available placement location in an ordered sequence of the vacant placement locations in the home screen page). As a result, the application icons on a home screen page may include fully filled rows, unoccupied placement locations in a row, and/or clusters of application icons distributed in placement locations in two or more consecutive rows, at a given time. Allowing the user to freely choose the placement locations of application icons or other application objects in a user-configurable home screen page provides the user with more customization capabilities and control over how the home screen page is organized, resulting in improvement of efficiency of the home screen page when the user accesses the application icons on the home screen page. However, automatic grouping and rearrangement of application icons that are performed by the device, and triggered by the manual placement of a respective application icon or widget, enables more organization on the home screen page, and improves the efficiency of home screen configuring process.

In some embodiments, different rules, based on positions of application icons on the grid of placement locations of a home user page, dictate or determine how are system-arranged groups formed. For example, the device 100 forms a respective system-arranged group of applications icons from (i) a single complete row of application icons or single incomplete row of application icons that are placed in contiguous placement locations, (ii) multiple complete rows of application icons, and/or (iii) multiple complete rows of application icons followed by a single incomplete row of application icons in contiguous placement locations in the incomplete row. In some embodiments, the placement locations for application icons on a home screen page are ordered sequentially in a top down and left to right manner (e.g., left to right in a first row, followed by left to right in a second row below the first row, followed by left to right in a third row below the second row, and so on).

In FIG. 6A, home screen page 6002 includes three system-arranged groups of application icons: (1) group 6102 that includes application icons 602-624; (2) group 6104 that includes a single application icon 626; and (3) group 6106 that includes application icons 628-632. Group 6102 is formed of three full rows of application icons 602-624. In some embodiments, a complete or full row in the grid of placement location refers to a row of application icons in the grid that has no vacant positions (e.g., if the grid has four columns, there are four applications icons in a complete row). Application icon 626 forms a separate group 6104 because there are no others adjacent icons in the same row as application icon 626. Further, in some embodiments, for two consecutive rows to form a group, it is a necessary condition that the upper row is fully occupied (e.g., no vacant placement locations). Accordingly, application icon 626 cannot form a group with application icons 628-632 from the row below, because in the example in FIG. 6A, the upper row in which application icon 626 is placed is incomplete (e.g., has vacant placement locations). Application icons 628-632 form another group 6106 (e.g., even though the row is incomplete) because application icons 628-632 are contiguously placed (e.g., adjacent to one another with no vacant placement location(s) in between). In some embodiments, contiguously placed application icons in a row are application icons that are not separated by an empty placement location on the grid of placement locations. In some embodiments, contiguously placement application icons in two adjacent rows include a fully filled upper row and a lower row that is filled in one or more placement locations starting from the leftmost placement location with no vacant placement locations in between. For example, in the case of group 6106, application icon 628 is adjacent to application icon 630; application icon 630 is adjacent to both application icons 627 and 632; and application icons 632 is adjacent to application 630. In other words, there is no vacant placement locations on the grid between application icons 628-632 (e.g., in contrast to application icons 626, 632, and 608 in FIG. 6T that are placed on the same row but form two separate groups: (1) a group 6108 of application icon 626 and (2) a group 6104 of application icons 632 and 608 because there is a vacant spot in the row that separates the two groups 6108 and 6104, as described in further detail below with reference to FIG. 6T).

In some embodiments, dashed lines in FIGS. 6A-6AX are used for illustrative purposes to indicate how the application icons 602-623 are automatically grouped on a home screen page. The dashed lines are not displayed or visible to a user. In some embodiments, visual indications of grouping of application icons, such as dished lines or platters underlying or around the automatically-generated groupings, are displayed temporarily, while the user drags and/or repositions an application object on the home screen page, to help provide visual feedback to the user regarding the rationale for reflowing some application icons while maintaining the positions of other application icons on the home screen page.

In FIG. 6B, device 100 detects input 6202 directed to application icon 628, which is included in group 6106. Input 6202 is a drag input (e.g., selection input followed by a movement input while selection of application icon 628 is maintained) in a rightward direction, e.g., toward the location of application icon 632 displayed in the same row and in the same group 6106. In some embodiments, user input 6202 moves application icon 628 from the first position in the group 6106 to the third position in the group 6106.

FIGS. 6C-6F illustrate that application icons 630-632 reflow when application icon 628 of the same group 6106 is repositioned within the group 6106 (e.g., to condense the space occupied by group 6106 and automatically fill up vacated spots in the group 6106).

FIG. 6C is a transition from FIG. 6B in response to detection of further movement of input 6202 dragging application icon 628 towards the placement location of application icon 632. In FIG. 6C, application icon 628 is displayed overlaying application icon 630 while application icon 628 is being moved toward application icon 632. In some embodiments, application icon 630 (e.g., which is being overlaid) maintains its respective location (e.g., second placement location in the row from left to right) until application icon 628 moves past the midline of application icon 630. For example, in accordance with a determination that application icon 628 (or, optionally, the midline of application icon 628) has moved across a midline of application icon 630, the device 100 causes application icon 630 to move out of the way of application icon 628 (e.g., which is being dragged by user input 6202) and reflow towards the vacated (e.g., first placement location in the row that was vacated by application icon 630. For example, in FIG. 6D, application icon 628 (or, optionally, the midline of application icon 628) has just crossed the midline of application icon 630 and application icon 630 is about to move in a leftward direction toward the spot vacated by application icon 628, as illustrated in FIG. 6E.

FIG. 6E is a transition from FIG. 6D in response to further movement of input 6202 dragging application icon 628 towards the third placement location in the row (e.g., original location of application icon 632 in FIG. 6A). In some embodiments, in accordance with a determination that application icon 628 (or, optionally, the midline of application icon 628) has moved across a midline of application icon 630 (e.g., as shown in FIG. 6D), the device 100 caused application icon 630 to move out of the way of application icon 628 and reflow towards the vacated placement location in group 6106 (e.g., first spot in the row that was vacated by application icon 628, as illustrated in FIG. 6E). Further, in accordance with a determination that that application icon 628 (or, optionally, the midline of application icon 628) has moved passed the second placement location in the row (e.g., previously occupied by application icon 630) towards the third placement location in the row, the device 100 causes application icon 632 to move out of the way of application icon 628 (e.g., which is being dragged by user input 6202) and reflow towards the vacated second placement location in group 6106 (e.g., second placement location in the row vacated by application icon 630), as illustrated in FIGS. 6E-6F.

FIG. 6F is a transition from FIG. 6E in response to placing application icon 628 in the third placement location in group 6106 (e.g., third placement location in the row that was vacated automatically by application icon 632). In FIG. 6F, application icons 630-632 have reflowed and moved out of the way in response to input 6202, in accordance with a determination that application icon 628 of the same group 6106 is repositioned within the group 6106 at third placement location in the row. Accordingly, application icons 630-632 reflow when application icon 628 of the same group 6106 is repositioned within the group 6106 (e.g., while application icon 628 is being dragged in response to input 6202), whereas application icons 602-624 in group 6102 and application icon 626 in group 6104 do not reflow and maintain respective (e.g., user selected) locations in the home screen page 6002.

In some embodiments, the computer system (e.g., device 100) automatically merges groups of application objects into a single group in some situations when application objects are added, deleted, reflowed, and/or relocated. For example, application icons in two or more consecutive rows can be merged into one group in some situations when application objects are added, deleted, reflowed, and/or relocated. In some embodiments, two consecutive rows of application objects (e.g., application objects of the same size, and/or object type) do not form a group unless the upper row is complete (e.g., there are no available vacant placement locations for the application object in the upper row (e.g., the upper row can have two, three, four, five, six, or other number of available placement locations for the application objects (e.g., due to the size of the row and/or, optionally, presence of other application objects of other sizes and/or types taking up some space in the upper row) and they all have to be filled up)). For example, in FIG. 6F, application icons 626 and 628-632 do not form a single group even though the application icons 626 and 628-632 are placed in two consecutive rows, because there is at least one empty or vacant placement location in the top row where application icon 626 is placed (e.g., three empty spots in the top row and the fourth one is filled by application icon 626 that forms a separated group 6104).

In some embodiments, in accordance with a determination that a respective application object is moved to a placement location that is contiguous to an existing group of application objects, the computer system (e.g., device 100) automatically adds the respective application object to the existing group of application objects, thereby automatically expanding the existing group of application objects. For example, in FIGS. 6G-6H, when application icon 632 is moved to a placement location adjacent to the application icon 626 in the row of application icon 626, the device 100 expands group 6104 that previously included on application icon 626 to include both application icons 626 and 632, as described in further detail below.

In FIG. 6F, the device 100 detects input 6204 directed to application icon 632 (e.g., selecting and optionally holding application icon 632, located in the second placement location of the last row of the grid of placement locations). Input 6204 is a drag input that moves application icon 632 from the last (e.g., sixth) row of the grid of placement location of home screen page 6002 next to application icon 626 in the row above, as illustrated in FIG. 6G.

FIG. 6G is a transition from FIG. 6F in response to detecting movement of input 6204 dragging application icon 632 towards the vacant placement location next to application icon 626 (e.g., towards the third placement location in the fifth row of the grid of placement location of home screen page 6002). In accordance with a determination that application icon 632 (or, optionally, the midline of application icon 632) has moved across a midline of application icon 628, the device 100 causes application icon 628 to move out of the way of application icon 632 and reflow towards the vacated (e.g., second) placement location in group 6106 (e.g., second spot in the last row), as illustrated in FIG. 6G. Moving application icon 628 to the spot vacated by application icon 632 condenses the space occupied by group 6106 (e.g., to the first two placement locations in the last row in the grid).

FIG. 6H is a transition from FIG. 6G after application icon 632 is placed next to application icon 626 in response to input 6204 dragging application icon 632 to the row of application icon 626. In response to termination of input 6204 placing application icon 632 next to application icon 626 in the row of application icon 626, the device 100 adds application icon 632 to group 6104 of application icon 626, thereby automatically expanding group 6104. In contrast, if application icon 632 was placed in the first or second placement location in the fifth row, the device 100 would forgo adding application icon 632 to group 6104, in accordance with a determination that application icon 632 and 626 would not have been in contiguous placement locations (e.g., separated by one or more empty placement locations in the fifth row). Further, in conjunction with expanding group 6104 to include application icon 632, the device 100 removes application icon 632 from group 6106 and condenses group 6106 by reflowing application icon 628 to the placement location vacated by application icon 632. Accordingly, after moving application icon 632, group 6104 includes application icons 632 and 626, and group 6106 includes application icons 630 and 628. Groups 6104 and 6106 do not merge in FIG. 6H because there are vacant spots in the upper row where application icons 632 and 626 in group 6104 are located. Further, locations of application icons 602-624 are maintained (e.g., the same as before input 6204 was detected) because application icons 602-624 are separated from group 6104 by an empty row in the grid of placement locations.

In some embodiments, as mentioned above, application objects in the same group of application objects reflow within the group (e.g., to make room for an additional application object or to fill up a vacated placement location in the group) without causing application objects in other groups to reflow. For example, FIGS. 6I-6L illustrate that application icon 626 in group 6104 automatically moves out of the way of application icon 632, which is being dragged by user input 6206, and takes up a placement location in group 6104 that was vacated by application icon 632. In another example, FIGS. 6O-6R illustrate that application icons 626 and 632 shift in a leftward direction (e.g., move in a reflow path from right to left) to take up the placement location in group 6104 that is vacated by application icon 608). More details are provided below.

In FIG. 6I, the device 100 detects input 6206 directed to application icon 632 (e.g., selecting and optionally holding application icon 632), which is located in the first placement location in group 6104 (e.g., corresponding to the third placement location in the fifth row). Input 6206 continues as a drag input that moves application icon 632 towards the second placement location in group 6104 currently occupied by application icon 626.

FIG. 6J is a transition from FIG. 6I in response to detecting movement of input 6206 in a rightward direction towards the placement location in the same group 6104 occupied by application icon 626. FIG. 6J illustrates home screen page 6002 in a transitional state before application icon 632 has crossed respective midline of application icon 626. The dashed arrow illustrates that application icon 626 is about to shift towards the placement location vacated by 632 if further movement of input 6206 causes application icon 632 to cross the respective midline of application icon 626, as illustrated in FIG. 6K.

FIG. 6K is a transition from FIG. 6J in response to detecting further movement of input 6206 in the rightward direction towards the second placement location in group 6104 that was occupied by application icon 626. In some embodiments, in accordance with a determination that application icon 632 (or, optionally, the midline of application icon 632) has moved pass or crossed a midline of application icon 626 (or, optionally, midline of the second placement location in group 6104 corresponding to the fourth spot in the fifth row), the device 100 causes application icon 626 to move out of the way and reflow towards the vacated first placement location in group 6104 (e.g., corresponding to third spot in the fifth row in grid that was previously occupied by application icon 632). FIG. 6K illustrates home screen page 6002 in a transitional state while movement of input 6206 in the rightward direction continues to be detected and while device 100 automatically shifts application icon 626 towards the vacated first placement location in group 6104 (e.g., in accordance with a determination that movement of input 6206 has caused application icon 632 to cross the respective midline of application 626).

FIG. 6L is a transition from FIG. 6K after application icon 632 is placed in the second placement location of group 6104 (e.g., corresponding to the fourth placement location in the fifth row) that was previously occupied by application icon 626, upon termination of drag input 6206 at the location shown in FIG. 6K. For example, in response to detecting a lift off (or, optionally, other end event) of input 6206 in FIG. 6K, application icon 632 is placed in the second placement spot in group 6104 and application icon 626 shifts to the first placement spot in group 6104 (e.g., because application icons 626 belongs to the same group 6104). FIG. 6L illustrates that while application icon 626 was shifted to fill up the placement location vacated in the same group 6104, application icons 630-628 in group 6106 and application icons 602-624 in group 6102 maintain their respective locations in home screen page 6002.

In some embodiments, as mentioned above, application objects in the same group of application objects reflow or shift within the group (e.g., to make room for an additional application object or to fill up a vacated placement location in the group) without causing application objects in other groups to reflow. Optionally, application objects reflow in a snaking pattern. For example, if a placement location in a group is vacated, all application objects (e.g., optionally of the same type and/or size) that follow or are placed after the vacated placement location (e.g., where the order of placement locations in the grid is determined from left to right and top to bottom in the grid) shift one placement location at a time from right to left and from bottom to top of the grid to fill up the vacated placement location and condense the group of application objects (e.g., in the case that reflow is in the backward direction of the grid (e.g., right to left and bottom to top) along the snaking pattern in the home screen page). For example, FIGS. 6M-6N illustrate that application icons 610-624 in group 6102 shift in a snaking pattern (e.g., from right to left and from bottom to top) to fill up a placement location in group 6102 that is vacated by application icon 608, thereby condensing the space occupied by group 6102. More details are provided below. In another example, if an application object is moved into a respective placement location that is already occupied by another application object in a group, the application object placed in the respective placement location and all application objects (e.g., optionally of the same type) that follow or are placed after the respective placement location (e.g., where the order of placement locations is determined from left to right top bottom in the grid) shift with one placement location from left to right and from top to bottom of the grid to make room for the application object that is being added. For example, FIGS. 6AC-6AG illustrate that application icons 610-624 and 632 in group 6112 shift in a snaking pattern (e.g., from left to right and from top to bottom) to make room for application icon 634 that is being added to group 6112 and placed in the fifth placement location in the grid (e.g., corresponding to the first spot in the second row of the grid) that was previously occupied by application icon 610, thereby expanding group 6112 to include the added application icon 634 (e.g., in the case that reflow is in the forward direction of the grid (e.g., left to right and top to bottom) along the snaking pattern in the home screen page). While the user interfaces described herein are described with reference to a particular reflowing pattern, it should be understood that many other different reflowing patterns could be used where icons reflow vertically, horizontally, radially, or in another reflow pattern that is set by the computer system or selected by a user of the computer system. More details are provided below.

In FIG. 6M, device 100 detects input 6208 directed to application icon 608 (e.g., selecting and optionally holding application icon 608 that is located in the fourth placement location in the grid corresponding to the fourth placement location in the first row). Input 6208 includes a drag input that moves application icon 608 from group 6102 and places application icon 608 next to application icon 626 in group 6104, where the arrow shows the movement path of input 6208. In some embodiments, in response to application icon 608 vacating the fourth placement location in the grid, the device 100 causes application icons 610-624, located in placement locations subsequent to the fourth placement location in the grid, to shift by one placement location in a snaking pattern (e.g., from right to left and from bottom to top) to fill up the fourth placement location in the grid vacated by application icon 608. The snaking pattern or the reflow path of application icons 610-624 is illustrated by a dashed line that ends with an arrowhead at the fourth placement location in the grid.

FIG. 6N is a transition from FIG. 6M after application icon 608 is moved out of the fourth placement location in group 6102 and placed next to application icon 626 in group 6104. FIG. 6N illustrates that application icons 610-624 shifted by one spot in a snaking pattern (e.g., from right to left and from bottom to top) to take up the fourth placement location in grid vacated by application icon 608, thereby condensing the space occupied by group 6102. As a result of moving application icon 608 next to application icon 626 in another group 6104, the device 100 automatically removes application icon 608 from group 6102 and adds application icon 608 to group 6104 (e.g., as a result, group 6104 includes application icons 608, 626, and 632). Further, FIG. 6N illustrates that while application icons 610-624 shifted to take up a placement location vacated in the same group 6102, application icons 626-632 in group 6104 and application icons 630 and 628 in group 6106 maintain their respective locations (e.g., groups 6104 and 6106 are not condensed because the removed application icon 608 belonged to a different group 6102).

In some embodiments, as mentioned above, application objects in the same group of application objects reflow within the group (e.g., to make room for an additional application object or to fill up a vacated placement location in the group) without causing application objects in other groups (e.g., groups that are not taking in a new application object to losing an existing application object) to reflow. For example, FIGS. 6O-6R illustrate that application icons 626 and 632 in group 6104 shift when application icon 608 is moved to a placement location in group 6104 previously occupied by application icon 632, without causing application icons 602-606, 610, 612-624 in group 6102 and application icons 630 and 628 in group 6106 to reflow.

FIG. 6O illustrates the same home screen page 6002 illustrated in FIG. 6N. In FIG. 6O, group 6102 includes application icons 602-606, 610, 612-624 (e.g., application icon 608 is no longer included in group 6102 as a result of input 6208 detected in FIG. 6M); group 6104 includes application icon 608, 626, and 632 (e.g., application icon 608 is removed from group 6102 and added to group 6104 in response to input 6208); and group 6106 includes application icons 630 and 628. In FIG. 6O, the device 100 detects input 6210 directed to application icon 608 (e.g., selecting and optionally holding application icon 608), which is located in the first placement location in group 6104 (e.g., corresponding to the second placement location on the fifth row). Input 6210 includes a drag input that moves application icon 608 in a rightward direction towards the last (e.g., third) placement location in group 6104 occupied by application icon 632, as illustrated by the arrow connected to input 6210.

FIG. 6P is a transition from FIG. 6O in response to detecting movement of input 6210 in the rightward direction towards the last (e.g., third) placement location in the same group 6104 occupied by application icon 632. FIG. 6P illustrates home screen page 6002 in a transitional state before application icon 608 has crossed a respective midline of application icon 626, placed before application icon 632 in the sequence placement locations in home screen page 6002. The dashed arrow illustrates that the snaking pattern or reflow path of application icons 626 and 632 that are about to shift towards the placement location vacated by 608 if further movement of input 6206 causes application icon 632 to cross the respective midline of application icon 626 and then cross the midline of application icon 632, as illustrated in FIG. 6Q.

FIG. 6Q is a transition from FIG. 6P in response to detecting further movement of input 6210 in the rightward direction towards the last placement location in group 6104 that was occupied by application icon 632. FIG. 6Q illustrates that, in accordance with a determination that application icon 608 (or, optionally, the midline of application icon 608) has moved past or crossed respective midlines of application icons 626 and 632, the device 100 causes application icons 626 and 632 to move out of the way and shift towards the vacated first placement location in group 6104 (e.g., corresponding to the second spot in the fifth row that was previously occupied by application icon 608 in FIG. 6O). FIG. 6Q illustrates home screen page 6002 in a transitional state while movement of input 6210 in the rightward direction continues to be detected.

FIG. 6R is a transition from FIG. 6Q after application icon 608 is placed in the third placement location in group 6104 (e.g., corresponding to the fourth spot in the fifth row that was previously occupied by application icon 632), upon termination of input 6210. For example, in response to detecting lift off of input 6210 in FIG. 6Q, application icon 608 is placed in the third placement location in group 6104 and application icons 626 and 632 shift to the first and second placement locations in group 6104, corresponding to the second and third placement locations in the fifth row, (e.g., because application icons 626 and 632 belong to the same group 6104). FIG. 6R illustrates that while application icons 626 and 632 were shifted to fill up the placement location vacated in the same group 6104, application icons in other groups, such as application icons 630-628 in group 6106 and application icons 602-606, 610-624 in group 6102, maintain in their respective locations in home screen page 6002. Accordingly, even though application icon 608 was relocated by input 6210 and application icons 626 and 632 automatically shifted due to relocation of application icon 608, the device 100 maintains grouping of application icons 608, 626, and 632 (e.g., as application icons 608, 626, and 632 are in contiguous spots on the same row), reflows application icons 626, and 632 within the group 6104, and maintains locations of other application icons on home screen page 6002 outside group 6104.

In some embodiments, the computer system (e.g., device 100) automatically breaks up a group of application objects into two or more groups when a respective application object from the group is removed and optionally moved to a non-contiguous placement location on the grid relative to the remaining application objects in the original group (e.g., placement location that is not adjacent to other application objects in the original group). For example, FIGS. 6S-6T illustrate that the device 100 breaks up group 6104 of application icon 626, 632 and 608 into two groups (e.g., group 6104 with application icons 632 and 608, and group 6108 of application icon 626), in accordance with a determination that application icon 626 is separated from application icons 632 and 608 in group 6104 and move to non-contiguous location (e.g., in the same row but separated by a vacant placement location from application icons 632 and 608). More details are provided below. In another example, in FIG. 6V, if application icon 626 is moved from the first spot in the fifth row to the first spot in the row above (e.g., corresponding to the fourth row), the device 100 automatically breaks group 6110 into three separate groups (e.g., because the fourth and fifth row are incomplete), where the first group would include only application icon 626 in the fourth row, the second group would include application icons 624, 632, and 608 in the fifth row, and the third group would include application icons 630 and 628). More details are provided below.

FIG. 6S illustrates the same home screen page 6002 illustrated in FIG. 6R. In FIG. 6S, group 6102 includes application icons 602-606, 610, and 612-624; group 6104 includes application icons 626, 632, and 608; and group 6106 includes application icons 630 and 628. As explained above, application icons 626, 632, and 608 in the upper row do not merge with application icons 630 and 628 in the row below because the upper row is incomplete (e.g., the first spot in the row is vacant).

In FIG. 6S, the device 100 detects input 6212 directed to application icon 626 (e.g., selecting and optionally holding application icon 626), which is located in the first placement location in group 6104 (e.g., corresponding to the second placement location on the fifth row). Input 6212 includes a drag input that moves application icon 626 in a leftward direction towards the first spot in the fifth row in the grid (e.g., a vacant placement location outside group 6104), as illustrated by the arrow connected to input 6212.

FIG. 6T is a transition from FIG. 6S in response to input 6212 moving application icon 626 to a vacant placement location in the same row corresponding to the first spot in the fifth row in the grid. In accordance with a determination that application icon 626 is moved to a non-contiguous placement location in relation to group 6104 (e.g., application icons 626 is not adjacent to application icons 632 and 608 in group 6104), the device 100 automatically removes application icon 626 from the group 6104. And, in accordance with a determination that application icon 626 is moved to a non-contiguous placement location in relation to other groups (e.g., group 6102 or group 6106), the device 100 automatically breaks group 6104 into two groups. For example, in conjunction with removing application icon 626 from group 6104, the device 100 automatically arranges or generates a new group 6108 that includes a single application icon 626.

In some embodiments, the computer system automatically merges two or more groups of application icons when a respective application icon is placed in a vacant placement location that optionally corresponds to the only vacant placement location in a row or between two adjacent rows (e.g., a gap between application objects in the same row is filled when the respective application icon is placed in the vacant placement location, when the last vacant spot in an upper row is filled by the respective application icon and the first spot in the lower row is already filled, or when the upper row is already filled and the respective application icon fills the gap between the upper row and one or more application icons in the lower row). For example, FIGS. 6U-6V illustrate that device 100 automatically merges three groups (e.g., group 6104, group 6106, and group 6108 in FIG. 6U) into one group 6110 (e.g., newly arranged by the device 100) in accordance with a determination that application icon 622 is moved into the only vacant placement location in the fifth row, thereby closing a gap between application object 626 in group 6108, application icons 632 and 608 in group 6104, and application objects 630 and 628 in group 6106.

FIG. 6U illustrates the same home screen page 6002 illustrated in FIG. 6T. In FIG. 6U, group 6102 includes application icons 602-606, 610, and 612-624; group 6104 includes application icons 632 and 608; group 6108 includes application icon 626; and group 6106 includes application icons 630 and 628. As explained above, the device 100 does not merge application icon 626 with application icons 632 and 608 in the same group because application icon is in a non-contiguous placement location relative to application icons 632 and 608 that are included in a separate group 6104; and application icons 626, 632, and 608 in the upper row do not merge with application icons 630 and 628 in the row below because the upper row is incomplete (e.g., the second spot in the row is vacant).

In FIG. 6U, the device 100 detects input 6214 directed to application icon 624 (e.g., selecting and optionally holding application icon 624), which is located in the last placement location in group 6102 (e.g., corresponding to the third placement location in the third row of the grid). Input 6214 includes a drag input that moves application icon 624 towards the vacant placement location in the fifth row (e.g., corresponding to the second spot in the fifth row), as illustrated by the arrow connected to input 6214.

FIG. 6V is a transition from FIG. 6U in response to detecting input 6214 moving and placing application icon 624 in the vacant placement location in the fifth row (e.g., corresponding to the second spot in the fifth row) upon termination of input 6214. In response to detecting input 6214 placing application icon 624 in the vacant placement location in the fifth row and in accordance with a determination that application icon 624 occupies what was the only remaining vacant placement location in the fifth row (e.g., corresponding to the second spot in the fifth row), the device 100 automatically merges application icons in groups 6104 (e.g., of application icon 632 and 608), 6106 (e.g., of application icons 630 and 628), and 6108 (e.g., of application icon 626) into one group 6110 and adds application icon 622, thereby merging three groups into one group 6110 including application icons 626, 624, 632, 608, 630, and 628. The device 100 merges group 6108 with group 6104 because application icon 626 is no longer separated from application icons 632 and 608 by an empty placement location (e.g., application icons 626, 624, 632, and 608 are placed in contiguous locations in the fifth row, which is now completed as a result of the addition of application icon 624). Further, device 100 merges application icons 626, 624, 632, and 608 in the fifth row with application icons 630 and 628 in the sixth row, because the upper row (e.g., the fifth row) is complete and application icons 630 and 628 in the lower row are placed in contiguous placement location relative to the application icons in the upper row. In some embodiments, if the first spot in the sixth row was empty, application icons 630 and 628 in the sixth would not have been placed in contiguous placement locations in relation to application icons 626, 624, 632, and 608 in the fifth row, and the device 100 would not have merged the application icons in the fifth and sixth row in the same group.

In some embodiments, one or more application objects form a system-arranged group with one or more user interface objects of a different type. In some embodiments, application icons form a group with other interface objects of the same size that are placeable in a home screen user interface. For example, the computer system (e.g., device) automatically generates or arranges a group that includes application icons and a folder with application icons, in accordance with a determination that the folder is placed in a placement location contiguous to the placement locations of the application icons. For example, FIGS. 6W-6Z illustrate that device 100 automatically adds folder 640 to group 6110 that includes application icons 624, 632, 608, 630, and 628. More details are provided below.

FIG. 6W illustrates the same home screen page 6002 illustrated in FIG. 6V. In FIG. 6W, group 6102 includes application icons 602-606, 610, and 612-622 and group 6110 includes application icons 626, 624, 632, 608, 630, and 628 (e.g., after groups 6104, 6106, and 6108 are merged into group 6110 as a result of completing a row and filling a gap by adding application icon 624 to the vacant placement location in the fifth row, as described in relation to FIGS. 6U-6V).

In FIG. 6W, the device 100 detects input 6216 directed to application icon 612 (e.g., selecting and optionally holding application icon 612), which is located in the fifth placement location in group 6102 (e.g., corresponding to the first placement location on the second row in the grid). Input 6216 includes a drag input that moves application icon 612 in a downward direction towards application icon 626 that is located in the first spot on the fifth row in the grid (e.g., corresponding to the first placement location in group 6110), as illustrated by the arrow connected to input 6216.

FIG. 6X is a transition from FIG. 6W in response to input 6216. In some embodiments, in accordance with a determination that input 6216 holds application icon 612 over application icon 626 for more than a threshold amount of time, the device 100 automatically initiates a folder creation process. FIG. 6X illustrates a transient state of home screen page 6002 in which generation of folder 640 (e.g., to include application icons 612 and 626) is initiated but not yet completed. In some embodiments, if input 6216 moves application icon 612 away from application icon 626 before the threshold amount of time has passed, the folder creation process would be terminated and application icon 626 remains at its placement location as a standalone application icon. In some embodiments, in accordance with a determination that input 6216 holds application icon 612 over application icon 626 for more than the threshold amount of time before releasing application icon 612 at the location of application icon 626, folder 640 is created at the placement location of application icon 626 upon termination of the input 6216. In some embodiments, in accordance with a determination that, after input 6216 holds application icon 612 over application icon 626 for more than the threshold amount of time and input 6216 continues to hold application icon 612 for an additional period of time, the device 100 displays folder creation user interface 6005, as illustrated in FIG. 6Y, for configuring the newly created folder (e.g., providing folder name, rearranging icons in the folder, adding, and/or removing icons in the folder, and/or deleting the folder). In some embodiments, in accordance with a determination that input 6216 drops application icon 612 over application icon 626 (e.g., lift off of input 6216 is detected) after the threshold period has passed, the device 100 automatically creates folder 640, as illustrated in FIG. 6Z. In some embodiments, in accordance with a determination that input 6216 drops application icon 612 in folder 640 in FIG. 6Y (e.g., lift off of input 6216 is detected) after the additional threshold period of time has passed, and dismisses the folder creation user interface 6005 (e.g., by a tap input outside of the folder 640), the device 100 creases to display the folder creation user interface 6005 and displays folder 640 in the placement location previously occupied by application icon 626, as illustrated in FIG. 6Z.

Further, in accordance with a determination that folder 640 is created and the fifth placement location in group 6102 (e.g., corresponding to the first spot in the second row of group 6102) previously occupied by application icon 612 is vacated, the device 100 automatically shifts application icons 614-622 (e.g., which are placed in placement locations subsequent to the vacated placement location) by one placement location following a snaking pattern. The reflow path, following the snaking pattern, of application icons 614-622 is illustrated in FIG. 6X by the dashed arrow that finishes at the vacated placement location (e.g., from right to left and from the bottom to the top).

FIG. 6Y illustrates a transition from FIG. 6X in response to input 6216 that holds application icon 612 over application icon 626 for more than the threshold period and continues to hold application icon 612 for an additional period of time, in accordance with some embodiments. In accordance with a determination that input 6216 holds application icon 612 over application icon 626 for more than the threshold period and input 6216 continues to hold application icon 612 for an additional period of time, the device 100 displays folder creation user interface 6005 for configuring the newly created folder 640. FIG. 6Y illustrates that the device 100 automatically includes application icons 612 and 626 in folder 640, after the folder creation user interface 6005 is dismissed.

In some embodiments, the name of the folder can be created or edited in entry field 642 in folder creation user interface 6005 in response to user inputs. In some embodiments, the name of the folder can be removed, or alternatively, the folder, including its content, can be deleted, in response to user input selecting delete affordance 644. Further, application icon 626 can be removed from folder 640 and home screen page 6002 in response to an input selecting delete affordance 626′, and application icon 612 can be removed from folder 640 and home screen page 6002 in response to an input selecting delete affordance 612′. Application icons 626 and 612 can be repositioned (e.g., application icon 626 can switch places with application icons 612 in folder 640, or optionally, occupying non-continuous placement locations inside folder 640). In some embodiments, the device 100 automatically places any application icons in a folder at the first available placement location (e.g., there are no gaps between application icons in a folder). In some embodiments, application icons 626 or 612 can be removed from folder 640 in response to a drag input that drags respective application icon 626 or 612 outside folder 640, placing the dragged application icon at another placement location on home screen page 6002. In some embodiments, a tap input outside folder 640 in folder creation user interface 6005 causes the device 100 to exit (e.g., cease to display) the folder creation user interface 6005 and display the home screen page 6002 (e.g., as illustrated in FIG. 6Z). In some embodiments, FIG. 6Z is a transition from FIG. 6Y. For example, the device 100 displays home screen page 6002 in FIG. 6Z in response an input that causes device 100 to exit the folder creation user interface 6005.

In some embodiments, displaying folder creation user interface 6005 is optional, and the device 100 creates folder 640, as illustrated in FIG. 6Z, without first displaying folder creation user interface 6005. For example, FIG. 6Z is a transition from FIG. 6X after folder 640 is created. In some embodiments, the device 100 detects a lift off of input 6216 in FIG. 6X while application icon 612 is displayed over application icon 626 and after the folder creation process is initiated (e.g., after the folder 640 appears, as illustrated in FIG. 6X). In response to the detection of lift off of input 6216, the device 100 completes the folder creation process and generates folder 640 that includes application icons 626 and 612, as illustrated in FIG. 6Z. Further, FIG. 6Z illustrates that, in accordance with a determination that folder 640 is created and the fifth placement location in group 6102 (e.g., corresponding to the first spot in the second row) previously occupied by application icon 612 is vacated, the device 100 automatically shifted application icons 614-622 by one placement location according to the snaking pattern illustrated in FIG. 6X. In some embodiments, the icon for folder 640 displays a scaled down representation 626a of application icon 626 and a scaled down representation 612a of application icon 612, as illustrated in FIG. 6Z.

In some embodiments, automatic re-arrangement and grouping techniques described in relation to FIGS. 6A-6V with respect to application icons also apply to icons for folders of application icons (e.g., in addition to application icons). For example, an icon for a folder of one or more application icons is grouped with other application icons, and the icon of the folder is automatically shifted within a group in the same way an application icon is automatically shifted by the device 100 (e.g., in response to adding or removing an application icon or a folder from the group). For example, FIG. 6Z illustrates that device 100 automatically adds the icon for folder 640 including application icons 626 and 612 to group 6110 including application icons 624, 632, 608, 630, and 628. If folder 640 is moved from the first placement location in group 6110 (e.g., first spot in the fifth row), device 100 automatically shifts application icons 624, 632, 608, 630, and 628 by one placement location to fill up the vacated placement location corresponding to the first spot in the fifth row. For example, if folder 640 is moved from the first placement location in the fifth row to the second placement location in the sixth row, application icons 624, 632, 608, 630, and 628 shift in a snaking pattern (e.g., from bottom to top and from right to left) to fill in the first placement location in the fifth. In some embodiments, moving folder 640 from first placement location in the fifth row to the third placement location in the sixth row, causes device 100 to split group 6110 into two groups-one group including application icons 623, 632, and 608 from the upper row, and another group including application icons 630, 628, and folder 640 from the bottom row (e.g., because the upper row, fifth, becomes incomplete as a result of removing folder 640 and placing it the third placement location in the sixth row). In some embodiments, moving folder 640 from first placement location in the fifth row to the third placement location in the sixth row, causes device 100 to maintain group 6110 and shift application icons 624, 632, 608, 630, and 628 in a snaking pattern to fill the vacated placement location in the fifth row, and place folder 650 in a new group that is separated from group 6110 by one placement location.

In some embodiments, when an application object located in an upper row of a group of two rows of application objects is removed from the upper row, thereby vacating a placement location in the upper row in the group of two rows, the device 100 automatically breaks the group of two rows into two separate groups, such that remaining application icons in the upper row are included in one system-arranged group and application icons in the lower row are included in another system-arranged group. For example, FIGS. 6AA-6AB illustrate that group 6114, which includes application icons 626, 628, 620, and 632 in the upper row and application icons 634 and 636 in the lower row, breaks into two separate groups: group 6116 with application icons 628-632 from the upper row and group 6118 with application icons 634 and 636 from the lower row, in accordance with a determination that application icon 626 is removed from the upper row and the upper row is no longer complete. More details are provided below.

FIG. 6AA illustrates a home screen page 6004 that includes groups 6112 and group 6114 illustrated by dashed lines. Home screen page 6004 is similar to home screen page 6002 but with a different arrangement of application icons. Group 6112 includes application icons 602, 604, 606, 608, 610, 612, 614, 616, 618, 620, 622, and 624 and group 6114 includes application icons 626, 629, 630, 632, 634, and 636. Home screen page 6004 is in the reconfiguration mode and application icons 602-636 are moving side to side (e.g., jiggling) to indicate that home screen page 6004 is configurable.

In FIG. 6AA, the device 100 detects input 6218 directed to application icon 626 (e.g., selecting and optionally holding application icon 626), which is located in the first placement location in group 6114 (e.g., corresponding to the first placement location on the fifth row). Input 6218 includes a drag input that removes application icon 626 from the fifth row and drags it toward the first placement location in the row above, as illustrated by the arrow connected to input 6218.

FIG. 6AB is a transition from FIG. 6AA in response to detection of input 6218 moving application icon 626 from the fifth row to the fourth row. For example, after application icon 626 is moved from the first placement location in the fifth row to the first placement location in the fourth row, the device 100 detects an end (e.g., a lift off) of input 6218 causing the device 100 to place application icon 626 in the first placement location in the fourth row. As a result of removing application icon 626 from the fifth row, the fifth row becomes incomplete (e.g., whereas the fifth row was complete before detection of input 6218) and the device 100 automatically breaks group 6114 into two separate groups: group 6116 and group 6118. Accordingly, the device 100 automatically creates two groups from two consecutive rows, in accordance with a determination that the upper row is no longer complete. For example, group 6116 includes application icons 628, 630, and 632 from the upper row and group 6118 includes application icons 634 and 636 from the lower row.

Further, in conjunction with breaking up group 6114, the device 100 automatically adds application icon 626 to group 6112, in accordance with a determination that application icon 626 is placed into a contiguous location relative to other application icons in group 6112 and in accordance with a determination that the row above application icon 626 is complete (e.g., the third row above the fourth row, where application icon 626 is placed, is complete). Accordingly, application icons in a partial row (e.g., even a row including a single application icon) can be added to the same group as the row above, in accordance with a determination that the row above is complete (and/or if the placement locations of application icons in the partial row are in contiguous placement locations relative to the upper row). In some embodiments, a contiguous placement location relative to application icons in a complete row corresponds to the first available placement location in the row below (e.g., corresponding to the first placement location in the row below).

In some embodiments, in FIG. 6AB, if application icon 626 was placed in the second placement location in the fourth row instead of the first placement location in the fourth row, the device 100 would not add application icon 626 to group 6112 as application icon 626 would be placed in a non-contiguous location relative to the application icons in the upper row corresponding to the third row in the grid (e.g., thus non-contiguous to group 6112), even though the row above (e.g., the third row) is complete.

In some embodiments, as mentioned above, application objects in the same group of application objects reflow or shift within the group (e.g., to make room for an application object that is being added to the group or being repositioned within the group) without causing application objects in other groups to reflow. Optionally, application objects reflow in a snaking pattern. For example, if an application object is moved into a respective placement location that is already occupied by another application object in a group, the application object placed in the respective placement location and all application objects that are placed in subsequent locations in the same group (e.g., where the order in grid is determined from left to right, top bottom) shift by one placement location from left to right and from top to bottom of the grid (e.g., in a snaking pattern) to make room for the application object that is being added. FIGS. 6AC-6AG illustrate that application icons 610-624 and 632 in group 6112 shift in a snaking pattern (e.g., from left to right and from top to bottom) to make room for an additional application icon 634, without causing application icons 626-630 in group 6116 to reflow. More details are provided below.

In FIGS. 6AC-6AF, the device 100 detects input 6220 requesting to insert application icon 634 into the first placement location in the second row (e.g., corresponding to the fifth placement location in the grid). In some embodiments, as described above in relation to FIGS. 6A-6F, 6I-6L, and 6O-6R, the computer system (e.g., device 100) automatically moves out of the way application objects that are placed along the movement path of an application object that is being dragged (e.g., move to the side or slides underneath). FIGS. 6AD-6AE illustrate that device 100 temporarily pushes application icons 632 and 618 (e.g., slightly to the side), in accordance with a determination that application object 634 moves over application icons 632 and 618, respectively, while application object 632 is being dragged in response to detection of movement of input 6220.

FIG. 6AD is a transition from FIG. 6AC in response to input 6220 moving application icon 634 from the last row toward the second row. In response to input 6220 and in accordance with a determination that application icon 634 passes through a respective placement location of application icon 632 (e.g., as opposed to remaining at the respective placement location for more than a threshold period of time), the device 100 pushes application icon 632 sideways (e.g., in a rightward direction). In accordance with a determination that application icon 634 continues to move past application icon 632 (e.g., in response to further movement of input 6220) before expiry of the threshold period of time, the device 100 restores application icon 632 back to its respective placement location (e.g., corresponding to the first placement location in the fourth row), as illustrated in FIG. 6AE. In some embodiments, moving application icons out of the way of another application icon that is being dragged by a user input, provides visual feedback to a user that the computer system is successfully responding to the detected input. Further, FIG. 6AD illustrates that application icon 634 is removed from group 6118 and that application icon 636 is the only remaining application icon in group 6118 (e.g., located in the last row of the grid).

FIG. 6AE is a transition from FIG. 6AD in response to detection of further movement of input 6220. In response to detecting further movement of input 6220 and in accordance with a determination that application icon 634 passes through a respective placement location of application icon 618 (e.g., as opposed to remaining at the respective placement location for more than a threshold period), the device 100 pushes application icon 618 sideways (e.g., in a rightward direction). In accordance with a determination that application icon 634 continues to move past the placement location of application icon 618 (e.g., in response to further movement of input 6220) before expiry of the threshold period of time, the device 100 restores application icon 618 back to its placement location (e.g., corresponding to the first placement location in the third row), as illustrated in FIG. 6AF.

FIG. 6AF is a transition from FIG. 6AE in response to detecting further movement of input 6220 dragging application icon 634 to the first placement location in the second row in the grid. In some embodiments, in accordance with a determination that application icon is held at a respective placement location of application icon 610 (e.g., corresponding to the first placement location of the second row in grid), the device 100 pushes application icon 610 sideways (e.g., in a rightward direction). Further, the device 100 detects a lift off of input 6220 while application icon 634 is located at the first placement location in the second row and the application icon 610 is moved out of the first placement location in the second row. In response to detecting lift off of input 6220, the device 100 inserts application icon into the fifth placement location in group 6112 and automatically shifts application icons 610-624 and 632 by one placement location along a reflow path illustrated with a dashed arrow in FIG. 6AF (e.g., along a snaking pattern that moves application icons 610-624 and 632 from top to bottom and from left to right).

FIG. 6AG illustrates is a transition from FIG. 6AF after application icon 634 is inserted in the fifth placement location in group 6112 (e.g., corresponding to the fifth placement location in the grid and the first spot in the second row), in response to input 6220 inserting application icon 634 in the fifth placement location in group 6112. FIG. 6AG illustrates that the device 100 automatically shifts application icons in placement locations after the first placement location in group 6112 to make room for the inserted application icon 634. For example, application icons 610-624 and 632 have each shifted by one placement location (e.g., along the reflow path illustrated in FIG. 6AF with a dashed arrow). Further, FIG. 6AG illustrates that application icon 634 is added to group 6112 and removed from group 6118.

Further, FIG. 6AG illustrates that the device 100 does not merge application icons 626-630 in group 6116 with application icons in group 6112 (e.g., because the row above application icons 626-630 in group 6112 is incomplete). Also, FIG. 6AG illustrates that the device 100 does not merge application icons 626-630 in group 6116 with application icon 636 in group 6118 (e.g., because the row of application icons 626-630 in group 6112 above the row of application icon 636 is incomplete, and application icon 636 is not in a contiguous placement location relative to the application icons in group 6116).

In some embodiments, when adding, removing, or repositioning an application widget relative to a respective group of application objects (e.g., icons and folders) in a home screen user interface, the device 100 automatically reflows the application objects within the respective group to make room for the added application widget or to fill up a placement location vacated by the application widget, respectively. In some embodiments, as a result of automatically reflowing the application objects within the respective group, if conditions for merging groups are met, the device 100 merges the application objects in the respective group with application objects in another group. For example, FIGS. 6AH-6AK illustrate that the device 100 automatically merges groups 6112, 6116, and 6118 as a result of inserting application widget 653 on home screen page at placement locations occupied by application icons in group 6112, as described in further detail below.

FIG. 6AH illustrates the same home screen page 6004 illustrated in FIG. 6AG. Home screen page 6004 in FIG. 6AH includes group 6112 that includes application icons 602-608, 634, 610-624, and 632; group 6116 that includes application icons 626, 628, and 630; and group 6118 that includes application icon 636. In FIG. 6AH, the device 100 detects input 6222 selecting affordance 6018 for adding application objects (e.g., application widgets) to the home screen user interface.

FIG. 6AI is a transition from FIG. 6AH in response to the detection of input 6222 selecting affordance 6018. In response to input 6222 selecting affordance 6018, the device 100 displays a widget library user interface 6007, as illustrated in FIG. 6AH. In some embodiments, the widget library user interface 6007 overlays home screen page 6004. In some embodiments, home screen page 6004 is partially visible underneath the widget library user interface 6007. For example, a respective widget in the widget library user interface 6007 can be added on the home screen page 6004 when the respective widget is selected and dragged to a portion of home screen page 6004 that is visible, and dropped onto the home screen page 6004. In some embodiments, once the dragging of the respective widget is started, device 100 ceases to display widget library user interface 6007 and restores display of home screen page 6004. The widget library user interface 6007 displays various selectable application widgets (e.g., some corresponding to different applications) that, when selected, can be added to the home screen page 6004. For example, widget library user interface 6007 includes application widget 651 corresponding to a first application; application widget 652 corresponding to a news application (e.g., different from the first application); application widget 653 corresponding to a weather application (e.g., different from the first application and the news applications); widget stack option 654 that corresponds to multiple application widgets that are stacked at the same placement location (e.g., selection of the application widgets in the widget stack 654 is optionally user-configurable, or automatically configured by the operating system based on context); application widget option 655 corresponding to a calendar application; application widget option 656 corresponding to a clock application; widget option 657 corresponding to an application suggestion widget (e.g., described in further detail above); and widget option 658 corresponding to an application category widget (e.g., described in further detail above).

In FIG. 6AI, the device 100 detects input 6224 selecting widget 653 corresponding to the weather application (also referred to as the weather widget 653). In some embodiments, input 6224 is a tap input directed to widget 653 displayed in widget library user interface 6007. In some embodiments, in response to selecting a selectable widget in the widget library user interface 6007, the device 100 displays a widget configuration user interface for configuring the type and/or size of the selected widget. For example, in response to selecting the weather widget 653, the device 100 displays widget configuration user interface 6009, as illustrated in FIG. 6AJ. In some embodiments, in response to selecting a selectable widget in the widget library user interface 6007, the device 100 directly adds the selected widget to the home screen page 6004 (e.g., without first displaying widget configuration user interface 6009). In some embodiments, the selected widget is added to a first available placement location for the selected widget in the home screen page 6004 or a new page if home screen page 6004 does not have an available placement location for the selected widget. In some embodiments, selection of the widget that meets first criteria (e.g., by a tap input, or another input type that does not meet an input threshold) causes placement of the selected widget into the home screen page, and selection of the widget that meets second criteria (e.g., by a tap and hold input, or another input type that meets the input threshold) causes display of the widget configuration user interface for the selected widget.

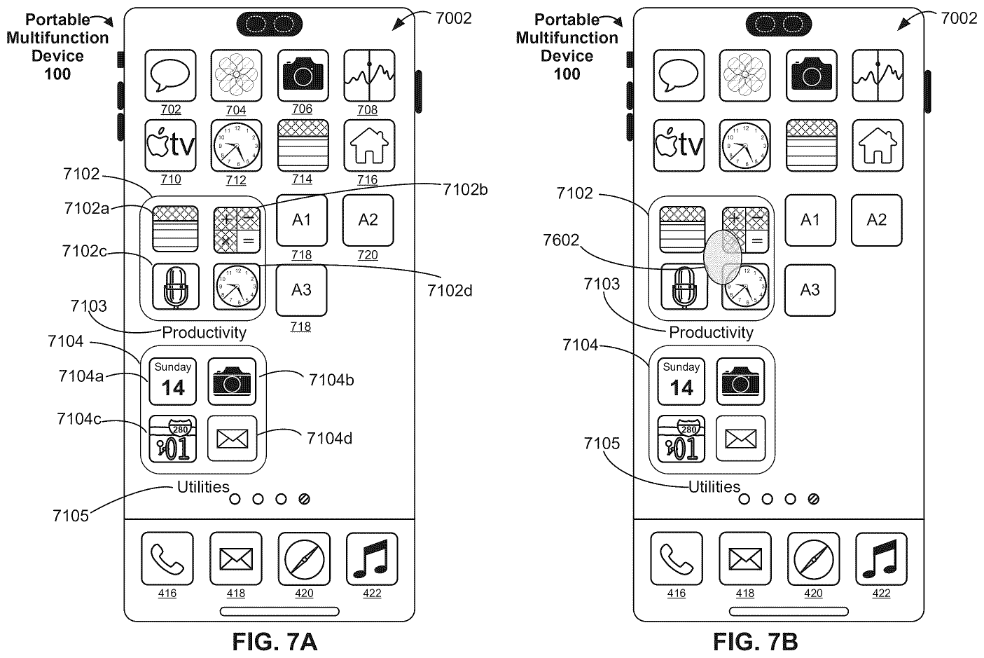

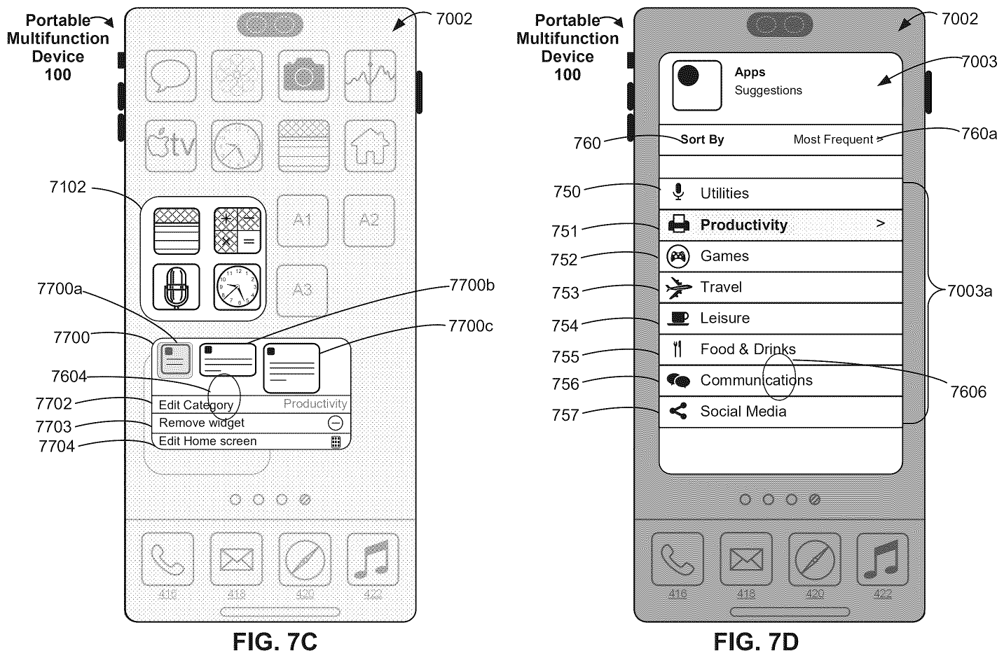

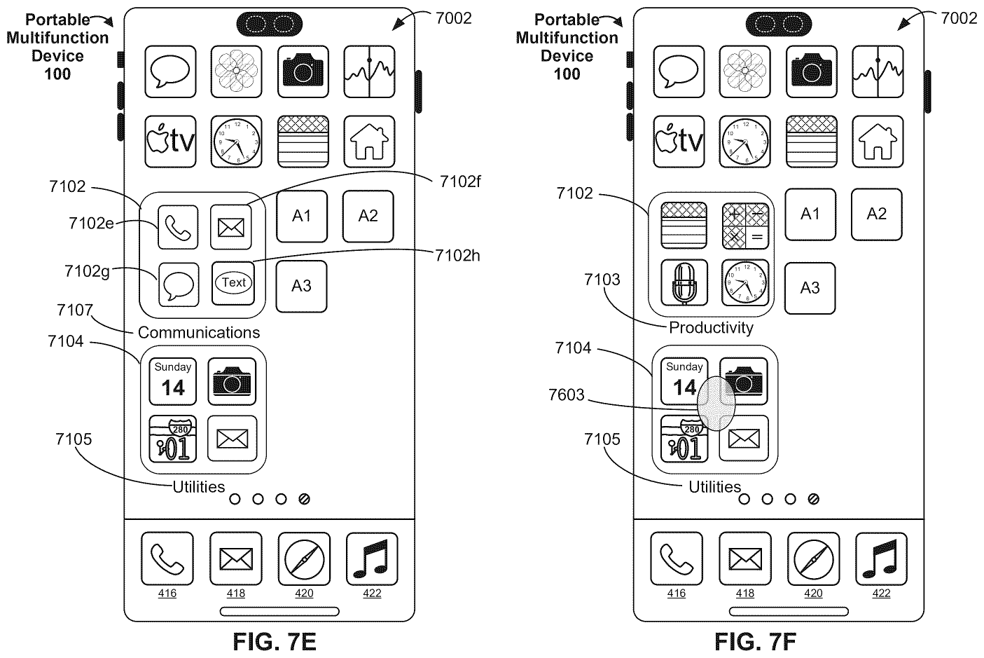

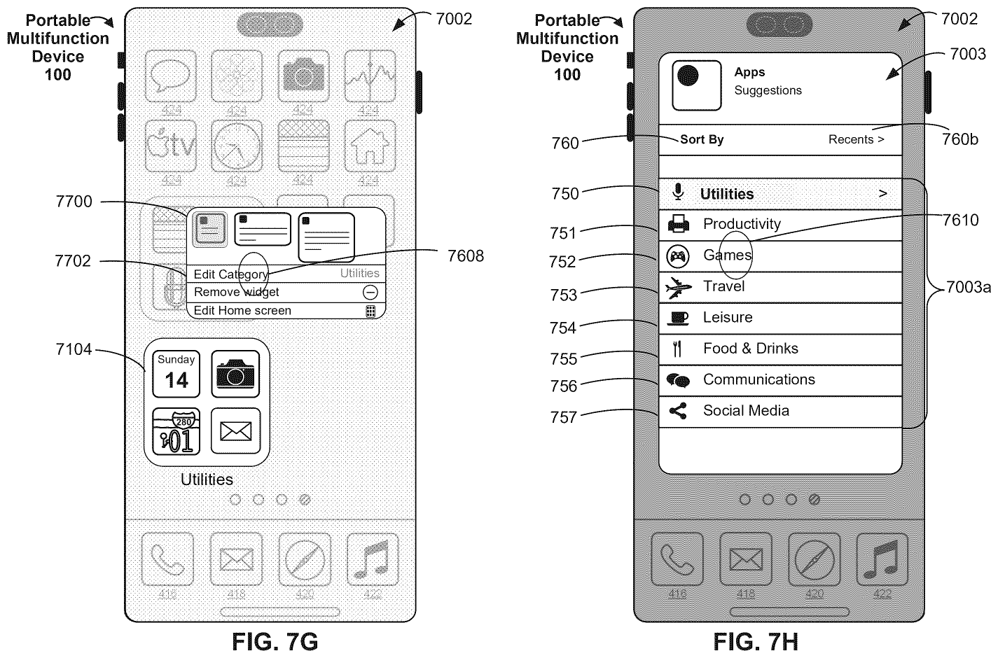

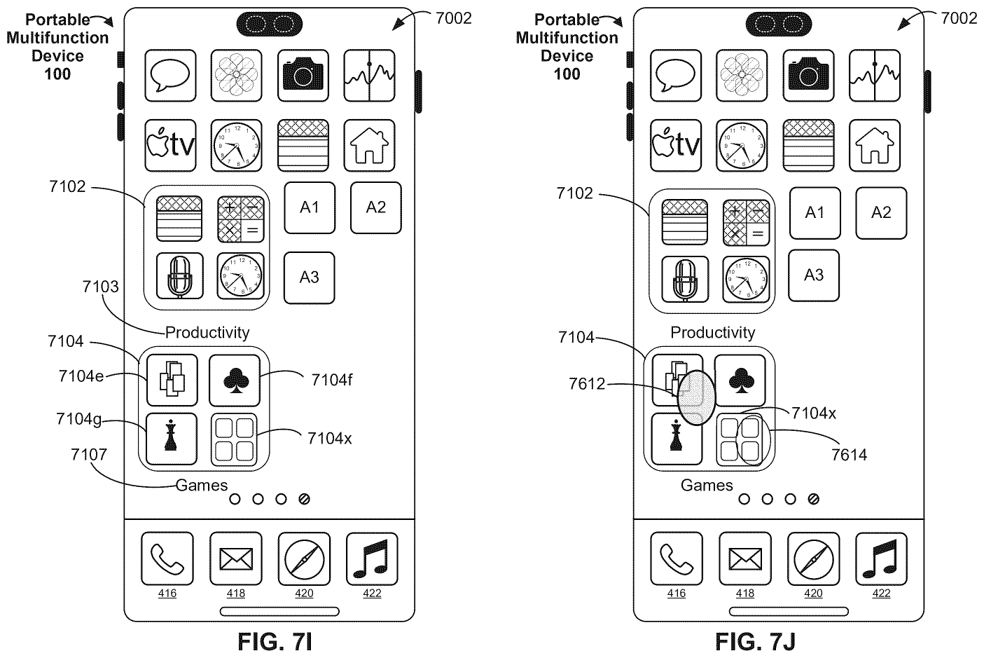

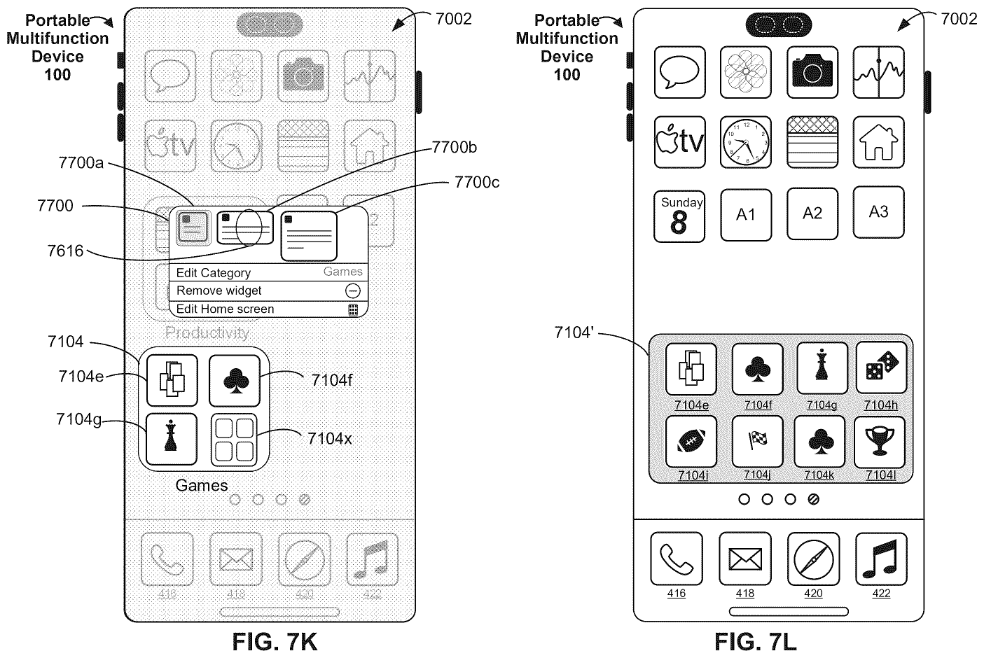

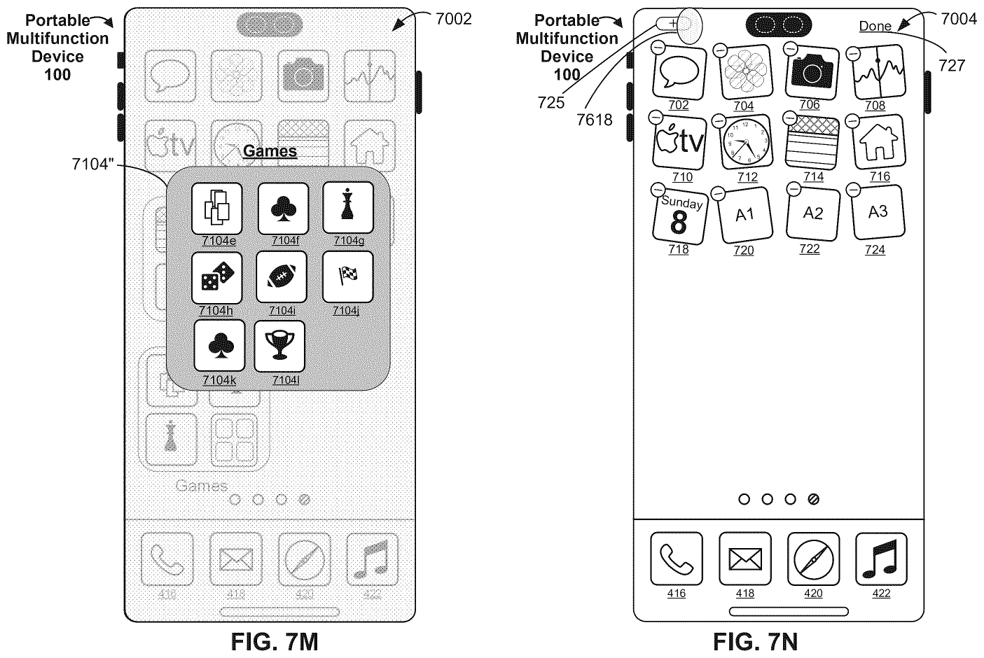

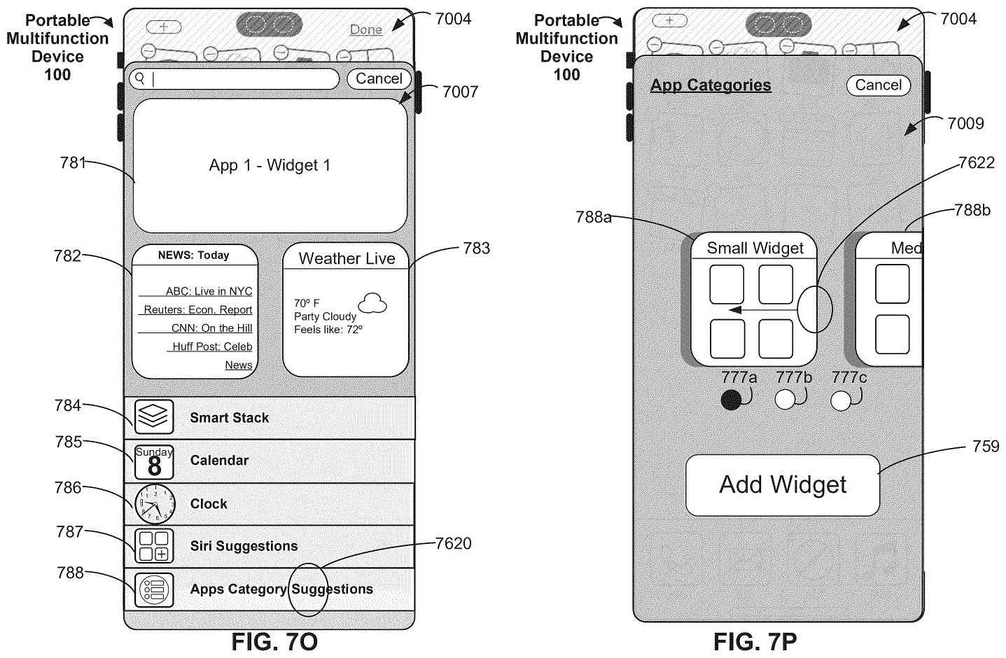

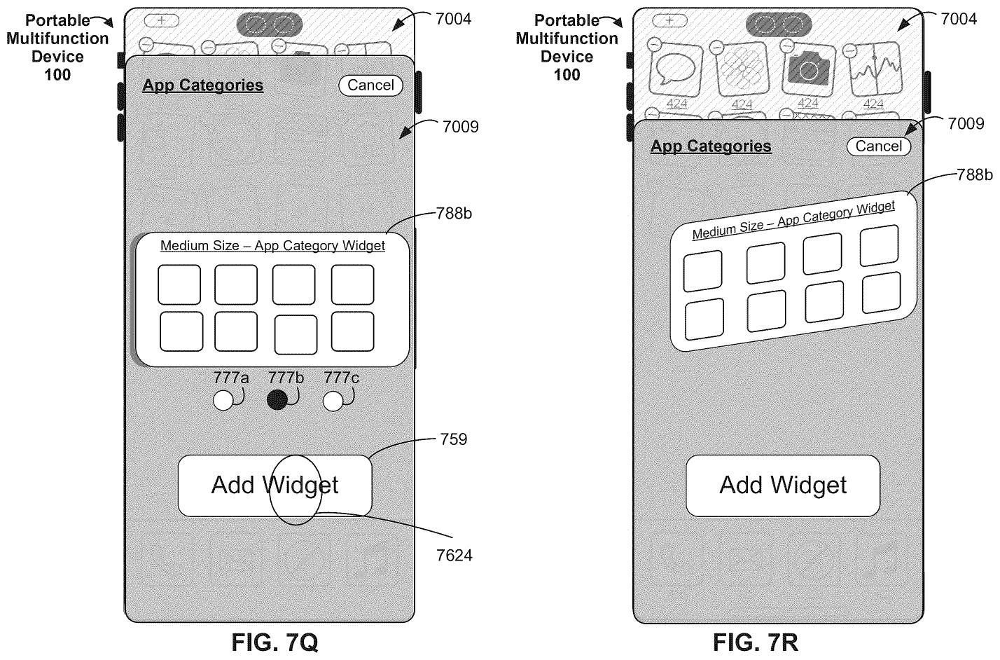

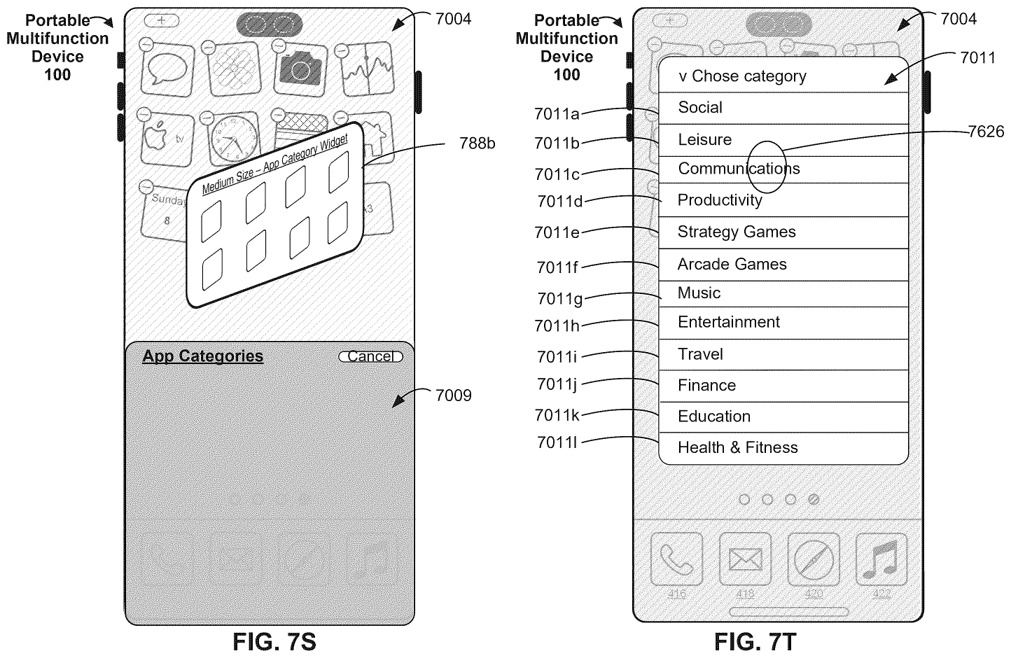

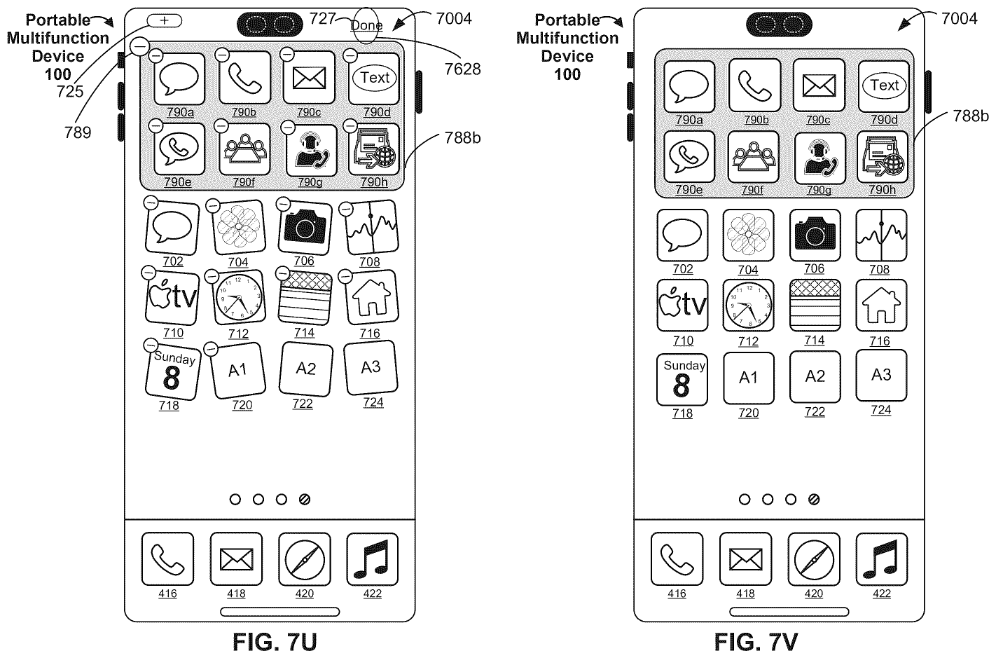

FIG. 6AJ is a transition from FIG. 6AI in response to input 6224 selecting weather widget 653 in the widget library user interface 6007. In response to selecting the weather widget 653 (and optionally, in accordance with a determination that the input 6224 meets the second criteria), the device 100 displays widget configuration user interface 6009 for the weather widget 653. In some embodiments, widget configuration user interface 6009 overlays home screen page 6004. In some embodiments, home screen page 6004 is partially visible underneath the widget configuration user interface 6009. Widget configuration user interface 6009 includes three selectable configuration options for weather widget 653. In some embodiments, the three selectable configuration options (e.g., indicated by user interface elements 666a, 666b, and 666c) correspond to different types and/or sizes of the weather widget 653. In FIG. 6AJ, widget configuration user interface 6009 includes configuration option 656a (e.g., completely visible in the widget configuration user interface 6009), configuration option 656b (e.g., only partially visible in the widget configuration user interface 6009) and a third configuration option that is not visible in the widget configuration user interface 6009 but can be displayed in response to navigation input (e.g., scrolling or swiping input) that navigates through the configuration options in the widget configuration user interface 6009 (e.g., as described in further detail in relation to FIGS. 7H-7L that illustrate configuring and adding an application category widget on a home screen page). In some embodiments, configuration option 656a can be selected in response to an input selecting user interface element 666a corresponding to configuration option 656a; configuration options 656b can be selected in response to an input selecting user interface element 666b corresponding to configuration option 656b; and the third configuration option can be selected in response to an input selecting user interface element 666c corresponding to the third configuration option. In some embodiments, configuration options 656a, 656b, and the third configuration option, respectively show a preview of the weather widget with the content, sizes, and/or types corresponding to the configuration options.

In FIG. 6AJ, the device 100 detects input 6226 selecting affordance 659 for adding a selected widget. Configuration option 656a for weather widget 653 is the selected configuration option when device 100 detects input 6226. In response to input 6226 selecting affordance 659 and in accordance with a determination that configuration option 656a for weather widget 653 is the currently selected configuration option when input 6226 is detected, the device 100 inserts or adds weather widget 653, configured according to the selected configuration option 656a, to the home screen page 6004. In some embodiments, configuration option 656a corresponds to a “small” size for weather widget 653.

FIG. 6AK is a transition from FIG. 6AJ in response to input 6226 selecting affordance 659 detected while configuration option 656a is selected. In response to input 6226, the device 100 inserts weather widget 653 to home screen page 6004 optionally in the first placement location for small widget on home screen page 6004. In some embodiments, a placement location for the weather widget 653, which is small size according to the selected configuration option 656a, corresponds to four placement locations for application icons (e.g., two rows and two columns of placement locations for application icons). Inserting weather widget 653 in the first widget placement location in the grid causes the device 100 to automatically reflow or shift application icons 602-608, 634, 610-624, and 632 in group 6112 and application icons 626-630 in group 6116 to make room for application widget 653, thereby moving application icons 602-608, 634, 610-624, and 632 to contiguous locations relative to group 6116 and moving application icons 626-630 to contiguous locations relative to group 6118. Accordingly, FIG. 6AK illustrates that device 100 automatically merges groups 6112, 6116, and 6118 into a single group 6120 as a result of inserting application widget 653 on home screen page 6004. For example, group 6120 includes application icons 602-636.

In some embodiments, application widgets are part of groups of application icons and/or folders. In some embodiments, application widgets are not grouped with application icons and/or folders. In some embodiments, application widgets are grouped with application icons and/or folders but do not automatically reflow to make room or fill in gaps. For example, the device 100 forgoes reflowing widgets displayed on a home screen page (e.g., in contrast to automatically reflowing application icons within groups) upon detection re-arrangement of application objects on the home screen page. In some embodiments, application widgets remain stationary while application icons and/or folders reflow to make room for other application objects or to fill in gaps vacated by other application objects. In some embodiments, application icons in a respective group (e.g., system-arranged group) that includes a respective application widget or that are adjacent a respective application widget (e.g., application widget 653) automatically reflow to fill in placement locations vacated by removing or moving the respective application widget. For example, FIGS. 6AL-6AQ illustrate that application icons in group 6122 on home screen page 6006 automatically reflow in accordance with a determination that application widget 653 is removed from group 6122 (e.g., by repositing the application widget to a next page) without automatically reflowing application icons in groups 6124 and 6126 on the same home screen page 6006, as described in further detail below with reference to FIGS. 6AL-6AQ below. Group 6122 in FIG. 6AL differs from Group 6122 in FIG. 6AK, and represents a result for inserting widget 653 from a different state than that show in FIG. 6AH (e.g., inserting widget 653 when the application icons 602-616 occupied the top two rows, and application icons 618-626 were located as shown in FIG. 6AL). More details are provided below.

FIG. 6AL illustrates a home screen page 6006 that includes group 6122, group 6124 and group 6126 illustrated by dashed lines. Home screen page 6006 is similar to home screen page 6004 but with a different arrangement of application icons. For example, group 6122 includes weather widget 653 and application icons 602, 604, 606, 608, 610, 612, 614, and 616 (e.g., application icons 602-616); group 6124 includes application icon 618, 620, and 622; and group 6126 includes application icons 624 and 626. Home screen page 6006 is in the reconfiguration mode and application icons 602-626 and weather widget 653 are moving side to side (e.g., jiggling) to indicate that home screen page 6006 is configurable.

Further, FIG. 6AL illustrates that a page indicator user interface element 6006′ is displayed on home screen page 6006. Page indicator user interface element 6006′ includes a corresponding page indicator for each page (e.g., pages that are not currently hidden) that is included in the multi-page home screen user interface. In the example of FIG. 6AL, the multi-page home screen user interface includes four home screen page and four corresponding page indicators 6006a, 6006b, 6006c, and 6006d, each corresponding to a respective page in the multi-page home screen user interface. Page indicator 6006d is highlighted relative to page indicators 6006a, 6006b, and 6006c, to indicate that the currently displayed page is the last page (e.g. fourth page) in the sequence of pages. For example, home screen page 6006 is the fourth page (e.g., last page) in a sequence of four user-arranged pages of the multi-page home screen user interface.

In FIG. 6AM, device 100 detects input 6228 dragging weather widget 653 in a rightward direction towards the right edge of device 100 (e.g., or right edge of home screen page 6006). Home screen page 6006 in FIG. 6AM is the same as home screen page 6006 in FIG. 6AL except that weather widget 653 appears to be lifted off and dragged slightly in the rightward direction in response to input 6228.

FIG. 6AN is a transition from FIG. 6AM in response to further movement of input 6228 dragging weather widget 653 toward the right edge of device 100. In FIG. 6AN, weather widget 653 is overlaying application icons 602, 604, 606, and 608, where application icons 602 and 606 are completely obscured and application icons 604 and 608 are partially obscured by weather widget 653. In some embodiments, as weather widget 653 moves further towards the right edge of device 100, application icons 602 and 606 shift in a leftward direction to fill in the placement locations in grid vacated by the weather widget 653, as illustrated in FIG. 6AO with dashed arrows (e.g., indicating the movement direction) and in FIG. 6AP (e.g., corresponding to intermediate state illustrating that application icons 602, 604, 606, and 608 are reflowing). In some embodiments, the application icons 602, 604, 606, and 608 are moved as a unit (e.g., as a two row by two column unit) that has an aggregated placement location size (e.g., two rows by two columns) corresponding to the placement location size of the weather widget 653 that is being dragged by input 6228, and maintain their relative positions in the unit. In some embodiments, application icons 602, 604, 606, and 608 reflow as individual icons, e.g., in the sequential order of their original placement locations (e.g., application icons 602, 604, 606, and 608 are flowed one by one into the slots in the first row of the grid), as shown in FIG. 6AP.

FIG. 6AO is a transition from FIG. 6AN in response to further movement of input 6228 dragging weather widget 653 toward the right edge of device 100. In FIG. 6AO, weather widget 653 has passed through midlines of application icons 602 and 606, and application icons 602 and 606 are about to shift in a leftward direction to fill in the placement locations vacated by weather widget 653, as illustrated by the dashed arrows. Further, weather widget 653 partially slides off from home screen page 6006 as weather widget 653 is dragged pass the right edge of home screen page 6006, as illustrated in FIG. 6AO.

FIG. 6AP is a transition from FIG. 6AO in response to further movement of input 6228 dragging weather widget 653 toward the right edge of device 100. In FIG. 6AP, in accordance with a determination that weather widget 653 has passed through midlines of application icons 602, 604, 606, and 608, the device 100 automatically causes application icons 602, 604, 606, and 608 to reflow (e.g., in a snaking pattern) and fill in the placement locations vacated by weather widget 653. Furthermore, application icons 610-616 reflow to fill the second row that is now vacated completely. In some embodiments, input 6228 drags weather widget 653 to a next page on the multi-page home screen user interface. In some embodiments, if there is no additional page beyond the currently displayed page in the direction in which the weather widget 653 is being dragged, the device 100 automatically generates a new home screen page, as illustrated in FIG. 6AQ (e.g., new page indicator 6006e is added corresponding to home screen page 6008 illustrated in FIGS. 6AV-6AW) and FIGS. 6AV-6AW. Further, FIG. 6AP illustrates that while application icons in group 6122 reflow (e.g., as a result of weather widget vacating placement locations in group 6122 in response to input 6228), the device 100 maintains locations of application icons 618-622 in group 6124 and application icons 624-626 in group 6126.

FIG. 6AQ is a transition from FIG. 6AP after weather widget 653 is dragged on to the next page. In some embodiments, device 100 generates a new page in response to input 6228 moving weather widget 653 beyond the right edge of home screen page 6006. For example, FIG. 6AQ illustrates that an additional page indicator 6006d is added to page indicator user interface element 6006′. In accordance with a determination that weather widget 653 vacates four placement locations in group 6124 (e.g., as a result of being relocated to an adjacent page), the device 100 automatically shifts application icons 602-616 by four placement locations to fill in the vacated placement locations. In some embodiments, application icons 602-616 reflow sequentially in a snaking pattern (e.g., from right to left and from bottom to top). Further, FIG. 6AQ illustrates that while application icons 602-616 in group 6122 reflow due to removal of weather widget 653 from group 6124, while the device 100 maintains locations of application icons 618-622 in group 6124 and application icons 624-626 in group 6126. As illustrated in FIG. 6AQ, locations of application icons 618-622 in group 6124 and application icons 624-626 in group 6126 are the same as locations of application icons 618-622 in group 6124 and application icons 624-626 in group 6126 in FIG. 6AL before the input 6228 was detected.

In some embodiments, when moving an application object (e.g., an application icon, a widget, or a folder including application objects) from a respective group to a different page of the multipage home screen user interface (e.g., in response to a drag input), the device 100 automatically reflows the application objects within the respective group to fill up respective placement location(s) vacated by the removed application object while maintain locations of application objects in other groups on the home screen page. FIGS. 6AR-6AW illustrate that application icons 602-616 in group 6122 on home screen page 6006 automatically reflow in accordance with a determination that application icon 610 is dragged to the next page in the multipage home screen user interface without automatically reflowing application icons in groups 6124 and 6126 on the same home screen page 6006, as described in further detail below with reference to FIGS. 6AR-6AW.

FIG. 6AR illustrates the same home screen page 6006 illustrated in FIG. 6AQ. Home screen page 6006 in FIG. 6AQ corresponds to the fourth page in a sequence of five pages of the multipage home screen user interface, as indicated by highlighted page indicator 6006d relative to other page indicators 6006a, 6006b, 6006c, and 6006e. Home screen page 6006 includes three separate groups of application icons: group 6122 that includes application icons 602-616; group 6124 that includes application icons 618-622; and group 6126 that includes application icons 624-626.

In FIG. 6AR, the device 100 detects input 6230 dragging application icon 610 in a rightward direction towards the right edge of device 100 (e.g., or right edge of home screen page 6006), as indicated by the arrow connected to input 6230. Home screen page 6006 in FIG. 6AM is the same as home screen page 6006 in FIG. 6AQ except that application icon 610 has been visually emphasized to indicate that application icon 610 is being dragged in response to input 6230.

FIG. 6AS is a transition from FIG. 6AR in response to further movement of input 6230 dragging application icon 610 toward the right edge of device 100. In FIG. 6AS, application icon 610 has vacated the first placement location in the second row in the grid and has moved passed application icon 612 and is partially overlaying application icons 614 and 616. The device 100 is about to automatically shift application icon 612 in a leftward direction to fill in the first placement location in the second row in the grid (e.g. as illustrated by the dashed arrow), in accordance with a determination that application icon 610 has moved at least past the midline of application icon 612. FIG. 6AS illustrates that application icons 602-608 in group 6122 maintain location because application icons 602-608 are located before the placement location vacated by application icon 610.

FIG. 6AT is a transition from FIG. 6AS in response to further movement of input 6230 dragging application icon 610 toward the right edge of device 100. In FIG. 6AS, application icon 610 has moved past application icon 614 (e.g., located in the third placement location in the second row) and is partially overlaying application icon 616. In accordance with a determination that application icon 610 has moved at least past the midline of application icon 614, the device 100 automatically shifts application icon 614 in a leftward direction (e.g., moves application icon 614 next to application icon 612, as illustrated by the dashed arrow) to fill in the second placement location in the second row vacated by application icon 612 that has shifted by one placement location to the first placement location in the second row. FIG. 6AS illustrates that application icons 618-622 in group 6124 and application icons 624-626 in group 6126 maintain location as application icons 618-622 and application icons 624-626 are included in separate groups from the application icons in group 6122.

FIG. 6AU is a transition from FIG. 6AT in response to further movement of input 6230 dragging application icon 610 toward the right edge of device 100. In FIG. 6AU, application icon 610 has moved past application icon 616 (e.g., previously located in the fourth placement location in the second row) and is only partially displayed as it is being moved from home screen page 6006 to home screen page 6008 (e.g., as illustrated in FIG. 6AV). In accordance with a determination that application icon 610 has moved at least past the midline of application icon 616, the device 100 automatically shifts application icon 616 in a leftward direction (e.g., moves application icon 616 next to application icon 614, as illustrated in FIG. 6AU) to fill in the third placement location in the second row vacated by application icon 614 that has shifted by one placement location to the second placement location in the second row. FIG. 6AU illustrates that application icons 618-622 in group 6124 and application icons 624-626 in group 6126 maintain location as application icons 618-622 and 624-626 are included in separate groups from the application icons in group 6122.

FIG. 6AV is a transition from FIG. 6AU in response to input 6230 holding application icon 610 at the right edge of device 100 for more than a threshold period of time (e.g., holding at the right edge as illustrated in FIG. 6AU). In response to input 6230 holding application icon 610 at the right edge of device 100 for more than the threshold period of time in FIG. 6AU, the device 100 automatically switches from displaying home screen page 6006 to displaying home screen page 6008. As device 100 switched from displaying home screen page 6006 to displaying home screen page 6008, page indictor 6006e corresponding to home screen page 6008 is highlighted relative to the other page indicators 6006a-6006d (e.g., and page indictor 6006d corresponding to home screen page 6006 is no longer highlighted).

FIG. 6AW is a transition from FIG. 6AV in response to detecting an end of input 6230 dropping application icon 610 on home screen page 6008. In some embodiments, the device 100 automatically places application icon 610 in the first available placement location in the grid (e.g., next to weather widget 653). In some embodiments, the changes made to the home screen user interface, including creating new page 6008 and reflowing of application icons in group 6122, can be saved and maintain in response to user input selecting affordance 6022.

In some embodiments, one or more configuration options for pages of a multi-page home screen user interface (e.g., home screen pages 6002, 6004, 6006, and 6008) can be customized in a settings user interface (e.g., in a system settings application). For example, in a user interface of a system settings application, pages of the home screen user interface can be reordered, deleted, and/or hidden or un-hidden (e.g., when navigating through the multi-page home screen user interface). FIG. 6AX illustrates a settings user interface 6020 for reconfiguring pages of a multipage home screen user interface, as described in further detail below.

FIG. 6AX illustrates a settings user interface 6020 for reconfiguring pages of a multipage home screen user interface. Settings user interface 6020 displays thumbnail images 6010, 6012, and 6014 with checkmark affordances 6010a, 6012a, and 6014a below the respective thumbnail images. The thumbnail images are reduced scale representations of respective home screen pages of the multipage home screen user interface. For example, settings user interface 6020 includes thumbnail image 6010 corresponding to a reduced scale representation of a first home screen page; thumbnail image 6012 corresponding to a reduced scale representation of a second home screen page; and thumbnail image 6014 corresponding to a reduced scale representation of a third home screen page. In some embodiments, the order in which thumbnail images 6010-6014 are displayed determines the order in which the home screen pages are displayed. For example, when a user navigates though the home screen pages of the multipage home screen (e.g., in response to swipe inputs or other navigation inputs), the pages of the multipage home screen are displayed according to the order of thumbnail images 6010-6014 specified or configured in settings user interface 6020. In some embodiments, the order in which the home screen pages are displayed can be changed via settings user interface 6020. In some embodiments, a user can select a thumbnail image of thumbnail images 6010-6014 and move the selected representation to a different location to change respective order in which the respective pages of the multipage home screen user interface are displayed. For example, to change the order, a user can tap and hold on a respective thumbnail image of thumbnail images 6010-6014 and drag it to a new position relative to other thumbnail images of thumbnail images 6010-6014.

In some embodiments, pages of the multipage home screen user interface can be deleted in response to selection of respective delete affordances. For example, the device 100 deletes the first page of the multipage home screen user interface in response to detecting a selection input directed at delete affordance 6010b associated with representation 6010 of the first page. In another example, the device 100 deletes the second page of the multipage home screen user interface in response to detecting a selection input directed at delete affordance 6012b associated with representation 6012 of the second page. In yet another example, the device 100 deletes the third page of the multipage home screen user interface in response to detecting a selection input directed at delete affordance 6014b associated with representation 6014 of the third page. In some embodiments, deletion of a respective page also deletes the applications corresponding to the application icons included in the respective page. In some embodiments, deletion of a respective page does not delete the applications corresponding to the application icons included in the respective page, and those applications are still accessible in the application library user interface of the device 100.

In some embodiments, pages of the multipage home screen user interface can be hidden or unhidden in response to selection of respective checkmark affordances. In some embodiments, the device 100 hides the first page of the multipage home screen user interface in response to detecting a selection input that causes device 100 to uncheck the checkmark affordance 6010a associated with thumbnail image 6010 of the first page. For example, tap input on checkmark affordance 6010a to remove the checkmark hides the first page. In another example, tap input on checkmark affordance 6012a to remove the checkmark hides the second page. In yet another example, tap input on checkmark affordance 6014a to remove the checkmark hides the third page. A selection input (e.g., tap input) on a respective checkmark affordance of checkmark affordances 6010a, 6012a, and 6014a to add a checkmark causes device 100 to show respective hidden page (e.g., unhide the page). For example, tap input on checkmark affordance 6010a to add the checkmark unhides the first page. In another example, tap input on checkmark affordance 6012a to add the checkmark unhides the second page. In yet another example, tap input on checkmark affordance 6014a to add the checkmark unhides the third page. In the example of FIG. 6AX, the checkmark in checkmark affordance 6010a indicates that the first page of the multipage home screen user interface is visible in response to input navigating through the multipage home screen user interface, while the unchecked affordance 6012a and 6014a indicate that the second and third pages, respectively, are hidden (e.g., not visible) in response to input navigating through the multipage home screen user interface (e.g., in contrast to being deleted if affordances 6012b or 6014b are selected).

In some embodiments, thumbnail images 6010-6014 correspond to one or more of home screen pages 6002, 6004, 6006, and 6008 described in relation to FIGS. 6A-6AW. In some embodiments, if there are additional home screen pages in the multipage home screen page that are not displayed in the settings user interface 6020, the device 100 displays respective thumbnail images of the additional pages in response to a scroll input (e.g., a movement input directed to the area where thumbnail images 6010-6014 are displayed, or selection of a scroll affordance in the settings user interface 6020).

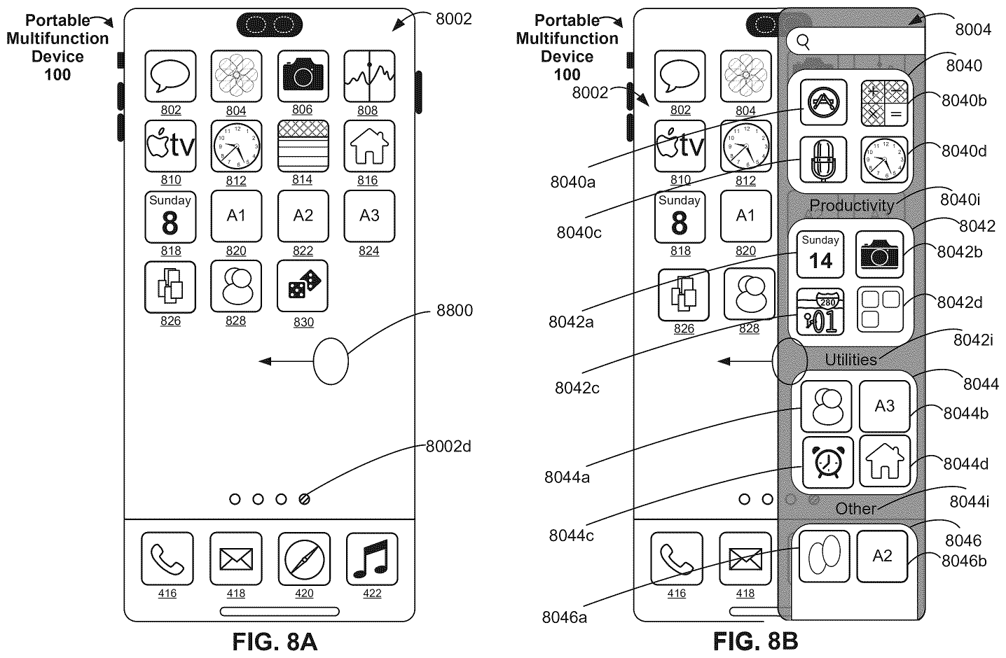

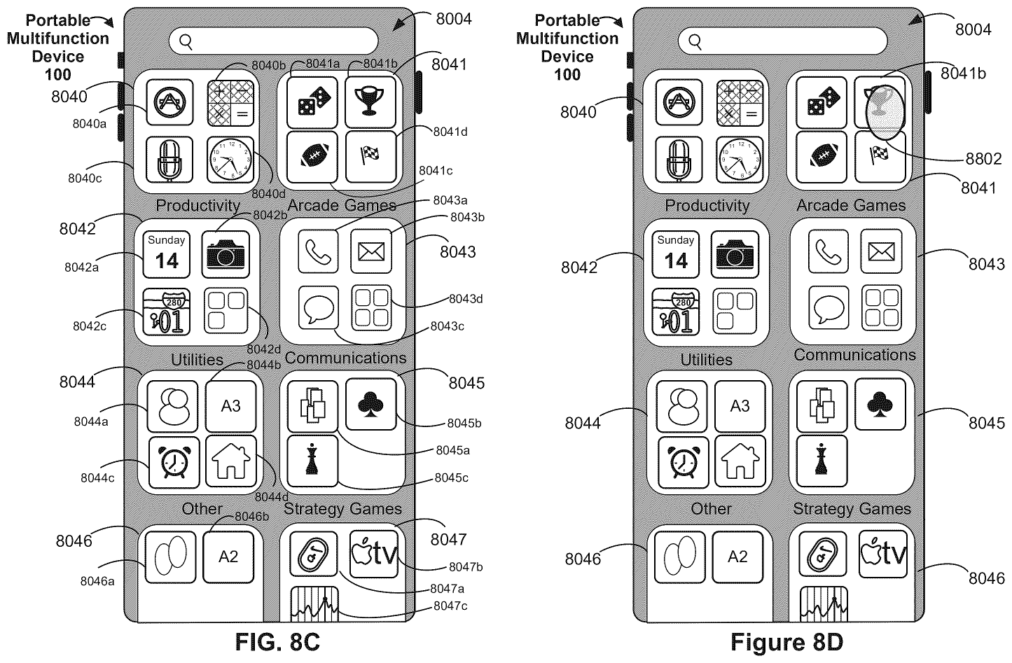

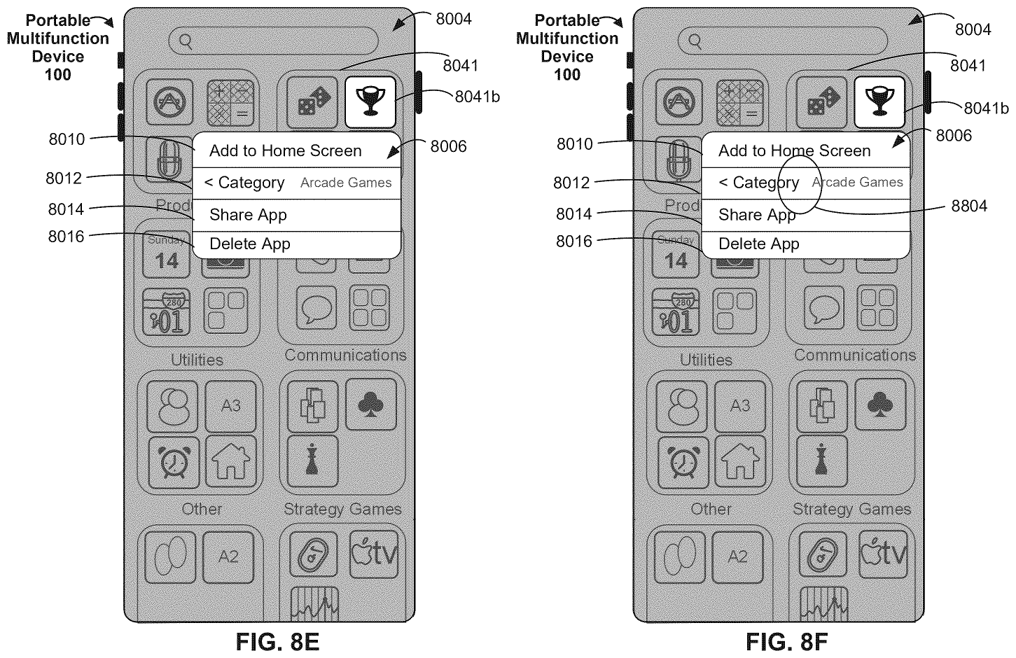

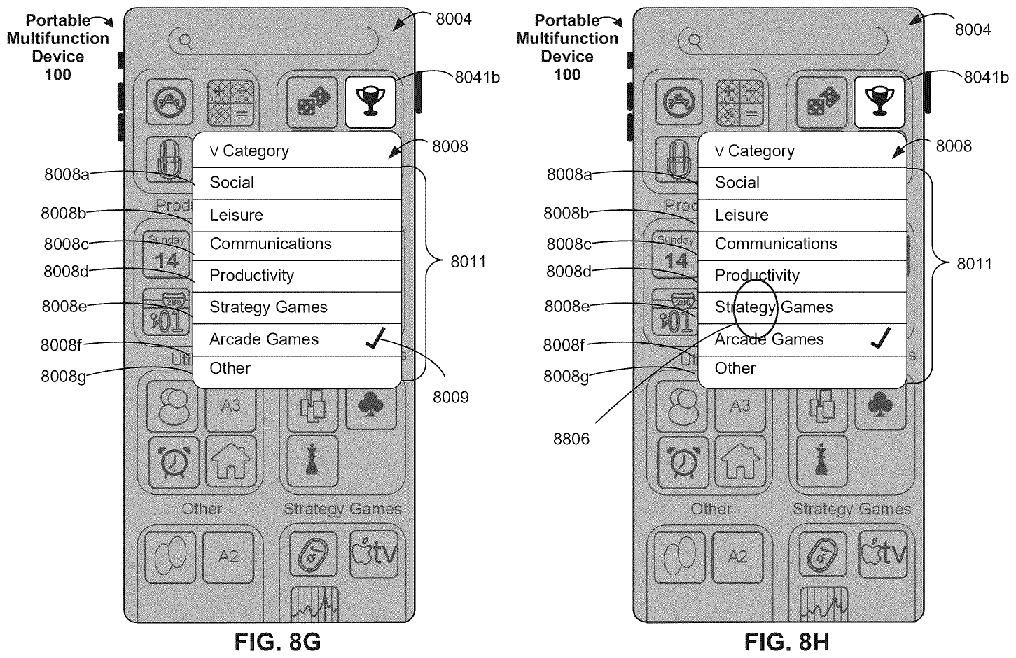

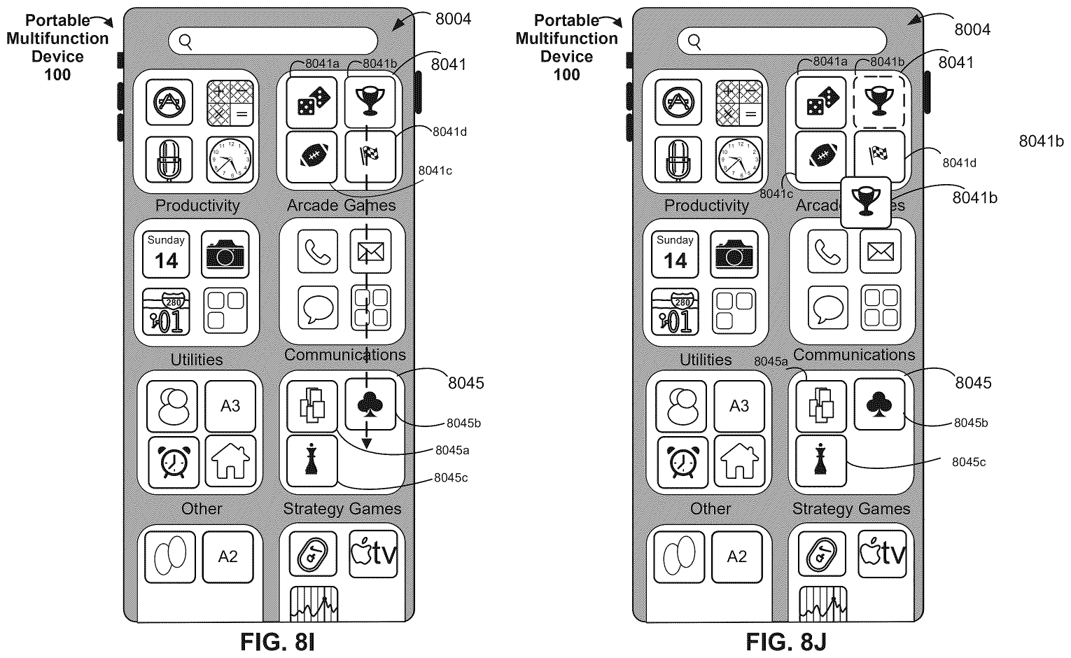

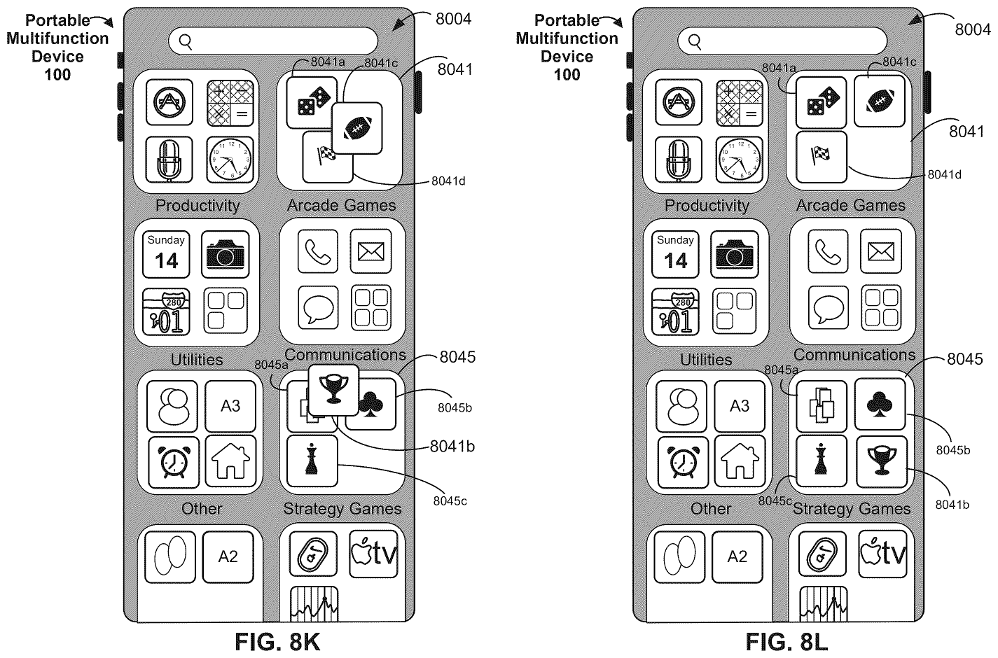

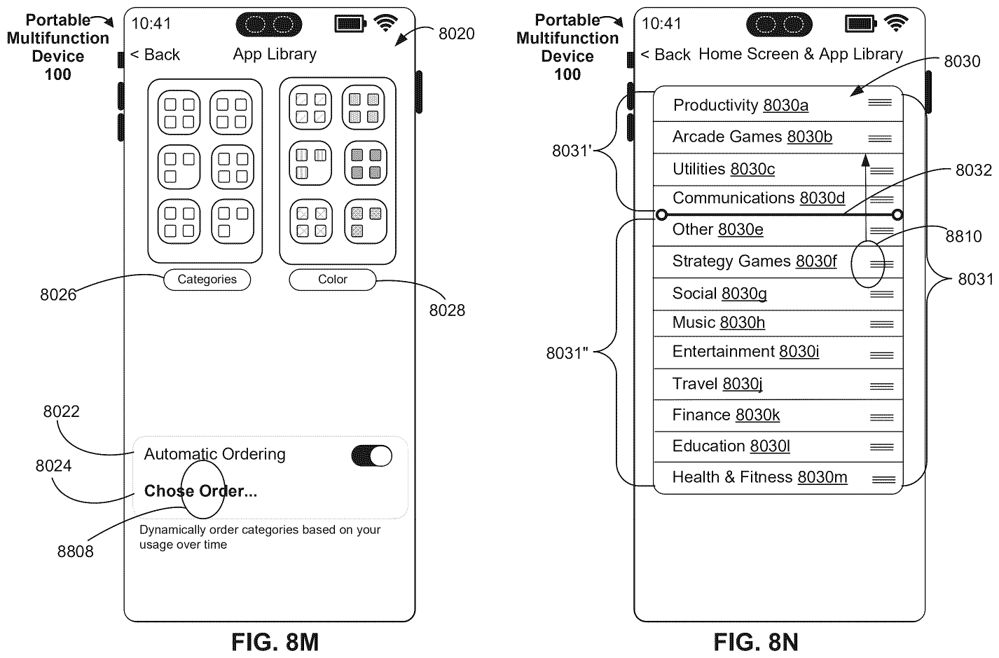

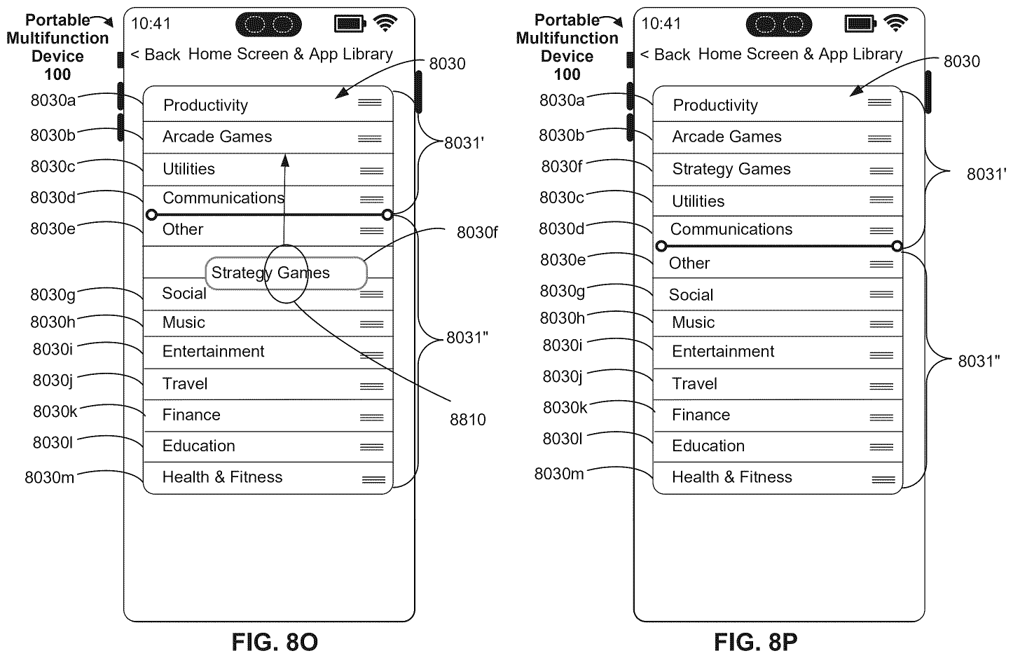

Optionally, settings user interface 6020 provides additional options for reconfiguring ordering of application library user interface. For example, the order of the respective groups of applications displayed in the application library interface can be configured settings user interface 6020 (or, optionally, another setting user interface as described in further detail in FIGS. 8M-8P below). In some embodiments, other configuration options, such as grid size, show/hide application labels, light/dark mode, colorful/tinted icons, background, and/or other configuration options for the pages of the home screen user interface are also available in the settings user interface 6020.

FIGS. 7A-7V illustrate example user interfaces and interactions for automatically organizing application icons by category in a home screen user interface and configuring an application category widget. FIGS. 12A-12H are a flow diagram of an exemplary method 1100 for automatically organizing application icons by category in a home screen user interface and configuring an application category widget, in accordance with some embodiments. The user interfaces in FIGS. 7A-7V are used to illustrate the processes described below, including the processes in FIGS. 12A-12H.

Manually organizing application icons on a multipage home screen user interface can be tedious and time consuming. In some embodiments, the computer system automatically displays application icons of the same application category in an application category widget. In some embodiments, application icons of different applications are organized by application category and displayed in different application category widgets. For example, FIG. 7A illustrates an application category widget 7102 assigned a productivity application category and an application category widget 7104 assigned a utilities application category displayed on a home screen page of a multipage home screen user interface, as described in further detail below.

FIG. 7A illustrates a home screen page 7002 of a multipage home screen user interface. Home screen page 7002 includes application icons 702, 704, 706, 708, 710, 712, 714, 716, 718, 720, and 722. In some embodiments, application icon 702 corresponds to a messages application, application icon 704 corresponds to a photos application, application icon 706 corresponds to a camera application, application icon 708 corresponds to a stocks application, application icon 710 corresponds to a TV application, application icon 712 corresponds to a clock application, application icon 716 corresponds to an application for managing home devices, and application icons 718-720 correspond to different applications. Further, home screen page 7002 displays two different application category widgets 7102 and 7104 assigned different application categories. For example, application category widget 7102 assigned the productivity application category and an application category widget 7104 assigned the utilities application category are concurrently displayed on home screen page 7002 with a respective label below the respective application category widgets. For example, label 7103 indicates that application category widget 7102 is assigned the productivity application category, and label 7105 indicates that application category widget 7104 is assigned the utilities application category. In some embodiments, the available application categories are automatically generated by the operating system without user inputs. In some embodiments, a user can customize the content of an application category or create a customized application category, as described in more details below.

In some embodiments, some or all of the application icons corresponding to applications in the productivity application category (e.g., applications that are installed on device 100 and that are assigned automatically to the productivity category by the system or optionally manually by a user) are included in the application category widget 7102. For example, application category widget 7102 displays application icon 7102a corresponding to a notes application; application icon 7102b corresponding to a calculator application; application icon 7102c corresponding to a recording application; and application icon 7102d corresponding to a clock application, where the notes, calculator, recording, and clock applications are assigned to the productivity application category. In some embodiments, the device 100 automatically groups applications assigned to the productivity category that are installed on device 100 (e.g., all applications, some applications, a preset number of applications (e.g., optionally determined based on respective size of the application category widget 7102) in the application category widget 7102, displayed on home screen page 7002. In some embodiments, some or all of application icons corresponding to applications in the utilities application category are included in the application category widget 7104. For example, application category widget 7104 displays application icon 7104a corresponding to a calendar application; application icon 7104b corresponding to a camera application; application icon 7104c corresponding to a maps application; and application icon 7104d corresponding to an email application, where the calendar, camera, maps, and email applications are assigned to the utilities application category. In some embodiments, the device 100 automatically groups applications assigned to the utilities category that are installed on device 100 (e.g., all applications, some applications, a preset number of applications (e.g., optionally determined based on respective size of the application category widget 7104) in the application category widget 7104, displayed on home screen page 7002. Accordingly, application icons are grouped by application category in application category widgets displayed on a home screen page. In some embodiments, multiple instances of the same application category widget can be placed on different home screen pages at the same time. In some embodiments, multiple instances of the same application category widget can be placed on the same home screen page, and the device 100 optionally deduplicates application icons included in different instances of the same application category widget displayed on the same home screen page.

In some embodiments, application icons in the application category widgets (e.g., application category widgets 7102 and/or 7104) are automatically selected by the computer system (e.g., device 100) in response detecting a change of context in relation to the computer system and/or applications that are installed on the computer system (e.g., time, place, location, incoming communication, active focus mode, new notifications, ongoing activity on the computer system, and/or other contextual change). For example, application icons 7102a-7102d included application category widget 7102 and/or application icons 7104a-7104d included application category widget 71024 are updated by device 100 dynamically over time based on a change of context. Changes that occur in the computer system that can cause the computer system to automatically update the set of application icons currently displayed in the application category widgets include, but are not limited to, detection of an event in one or more applications of the respective application category assigned to a respective application category widget; detection of a change in usage of applications installed on the computer system (e.g., user activity), including applications assigned to the respective application category; enabling or disabling a mode of operation of the computer system (e.g., a focus mode); detection of installation of one or more new applications on the computer system or deletion (and/or uninstallation) of installed applications from the computer system, and/or other changes associated with the computer system and/or applications installed on the computer system.

In some embodiments, an application category assigned to an application category widget can be modified (e.g., in response to one or more user inputs). For example, an application category assigned to an application category widget (e.g., application category widgets 7102 and 7104) can be changed (e.g., a different application category can be selected) directly from a home screen user interface using an in-line editing user interface (e.g., displayed overlaying home screen page 7002). FIGS. 7B-7E illustrate techniques from changing the application category assigned to application category widget 7102 from the productivity application category to a communications application category, and FIGS. 7F-7I illustrate techniques from changing the application category assigned to application category widget 7104 from the utilities application category to a games application category, as described in further detail below.

FIG. 7B illustrates detection of input 7602 directed to application category widget 7102 displayed on home screen page 7002. In some embodiments, input 7602 corresponds to a request to display an in-line editing user interface in association with application category widget 7102. For example, input 7602 is a long press input directed to application category widget 7102, in some embodiments. In some embodiments, input 7602 includes other types of inputs that meets an input threshold (e.g., an long air pinch gesture that is detected while a gaze is directed to application category widget 7102, and that is kept substantially stationary for at least a threshold amount of time; or a click and hold input by a mouse while a focus selector is at the location of the application category widget 7102, or another input that targets the application category widget 7102 and that meets an input threshold).

FIG. 7C is a transition from FIG. 7B in response to the detection of input 7602, in accordance with some embodiments. In response to detecting input 7602, the device 100 displays in-line editing user interface 7700. In-line editing user interface 7700 is displayed in association with application category widget 7102 (e.g., for reconfiguring application category widget 7102). The in-line editing user interface 7700 is a contextual or quick-access menu associated with application category widget 7102. In some embodiments, in-line editing user interface 7700 has characteristics and interactions that are analogous to those described with respect to in-line editing user interfaces 5200, 5300, 5602 and 5070 in FIGS. 5A-5AT. The in-line editing user interface 7700 includes configuration options 7700a, 7700b, and 7700c for transforming the application category widget into a different size. For example, configuration option 7700a, when selected, causes device 100 to set the size of the application category widget to a “small” size. Configuration option 7700b, when selected, causes the device 100 to set the size of the application category widget to a “medium” size. Configuration option 7700c, when selected, causes device 100 set the size of the application category widget to a “large” size. The in-line editing user interface 7700 is displayed overlaying the home screen page 7002. Accordingly, configuration option 7700a, 7700b, and 7700c are used to change or transform the dimensions of a selected application category widget directly from the home screen page 7002 (e.g., without navigating away from home screen page 7002). Configuration option 7700a is highlighted relative to configuration options 7700b and 7700c to indicate that application category widget 7102 is configurated according to configuration option 7700a corresponding to a small size widget. Further, in-line editing user interface 7700 displays a control option 7704 “Edit Home Screen” for activating a reconfiguration mode of the multi-page home screen user interface (e.g., control option 7704 in FIG. 7C corresponds to control option 5210 described in relation to FIG. 5C) and a control option 7703 “Remove widget” for removing the currently selected application widget (e.g., for removing application category widget 7102 from home screen page 7002).

In addition, as mentioned above, in-line editing user interface 7700 includes configuration option 7702 for changing a respective application category assigned to the currently selected application category widget 7102. In FIG. 7C, configuration option 7702 indicates that the currently selected application category is “Productivity.” In FIG. 7C, device 100 detects input 7604 selecting configuration option 7702 for changing the respective application category assigned to application category widget 7102.

In response to detecting user input 7604 selecting configuration option 7702, device 100 displays configuration user interface 7003, optionally overlaying home screen page 7002 and/or in-line editing user interface 7700. In some embodiments, configuration user interface 7003 includes a listing 7003a of selectable options 750-757 corresponding to available categories that can be associated with the currently selected application category widget 7102. For example, selectable option 750 corresponds to the utilities application category; selectable option 751 corresponds to the productivity application category; selectable option 752 corresponds to the games application category; selectable option 753 corresponds to a travel application category; selectable option 754 corresponds to a leisure application category; selectable option 755 corresponds to a foods and drinks application category; selectable option 756 corresponds to the communications application category; and selectable option 757 corresponds to a social media application category. The symbol “>” near selectable option 751 corresponding to the productivity application category indicates that the currently selected application category corresponds to the productivity application category (e.g., also optionally indicated by visually emphasizing selectable option 751 relative to other selectable options 750 and 752-757 in the listing 7003a of selectable options).

In some embodiments, device 100 automatically (e.g., and, optionally, dynamically) changes application categories displayed in the listing 7003a, e.g., based on new applications being installed or other applications being uninstalled from the device 100 (or, optionally, otherwise removed or respectively added to device 100). In some embodiments, changing application categories over time includes merging two or more application categories into one application category (e.g., as a result of removing applications from the device 100) and splitting an application category into two or more application categories (e.g., as a result of installing additional applications of the application category that is being split).

In some embodiments, a user can select (e.g., from a predetermined set of ordering options) an order by which application icons are displayed in the application category widget. For example, configuration user interface 7003 includes configuration option 760 for selecting a sorting order according to which application icons (e.g., application icons 7010a-7010-d) are displayed in the application category widget (e.g., application category widget 7102). Sorting order criteria for application icons in application category widgets include, but is not limited to, sorting based on application name (e.g., alphabetically, or reverse alphabetically), sorting according to recency of usage, sorting according to frequency of usage, and/or other sorting parameters. In FIG. 7D, sorting order 760a corresponding to decreasing usage frequency (e.g., most frequently used applications are included and/or shown first) is selected for configuration option 760.

In FIG. 7D, device 100 detects input 7606 selecting configuration option 756 corresponding to the communications application category. In response to input 7606 selecting configuration option 756, device 100 changes the application category assigned to application category widget 7102 from the productivity application category to the communications application category, as described in further detail below in relation to FIG. 7E.

FIG. 7E is a transition from FIG. 7E in response to input 7606 selecting configuration option 756 in the listing 7003a of selectable options displayed in configuration user interface 7003. In response to input 7606 selecting configuration option 756, the device 100 changes the application category assigned to application category widget 7102 from the productivity application category to the communications application category, as illustrated in FIG. 7E. Home screen page 7002 in FIG. 7E is the same as home screen page 7002 in FIG. 7D, except that application icons and application category associated with application category widget are changed in response to input 7606. For example, FIG. 7E illustrates that the label indicating the respective application category of application category widget 7102 has changed from label 7103 “Productivity” to label 7107 “Communications.” Further, application icons 7102a-7102d in application category widget 7102 are replaced with application icons 7102e, 7102f, 7102g, 7102h corresponding to different communication applications. For example, application icon 7102e corresponds to a phone application, application icons 7102g and 7102h correspond to two different messaging application, and application icon 7102f corresponds to an email application. Accordingly, FIG. 7B-7E illustrate that an application category assigned to application category widget 7102 is changed directly from the home screen user page 7002 using an in-line editing user interface 7700.

In some embodiments, an application category assigned to different application category widgets can be modified using in-line editing user interface 7700 and configuration user interface 7003. In some embodiments, the same listing of application categories is displayed in association with different application category widgets on the multipage home screen user interface. For example, listing 7003a of selectable options displayed in association with application category widget 7102 is the same as listing 7003a displayed in association with application category widget 7104, as described in further detail below.

FIG. 7F illustrates the same home screen page 7002 displayed in FIG. 7B. In FIG. 7B, input 7603 is directed to application category widget 7104 (e.g., in contrast to input 7602 detected in FIG. 7B that is directed to application category widget 7102). In some embodiments, input 7603 corresponds to a request to display an in-line editing user interface 7700 in association with application category widget 7104 (e.g., as opposed to in associated with application category widget 7102 as in FIGS. 7B-7C). For example, input 7603 is a long press directed to application category widget 7104.

FIG. 7G is a transition from FIG. 7F in response to the detection of input 7603, in accordance with some embodiments. In response to detecting input 7603, the device 100 displays in-line editing user interface 7700. In-line editing user interface 7700 is displayed in association with application category widget 7104 (e.g., for reconfiguring application category widget 7104). In-line editing user interface 7700 displayed in association with application category widget 7104 in FIG. 7G is the same as in-line editing user interface 7700 displayed in association with application category widget 7102 in FIG. 7C, except that configuration option 7702 in FIG. 7G indicates that the selected application category is “Utilities” for application category widget 7104, whereas configuration option 7702 in FIG. 7C indicates that the selected application category is “Productivity” for application category widget 7102. In FIG. 7G, device 100 detects input 7608 selecting configuration option 7702 for changing the respective application category assigned to application category widget 7104.

FIG. 7H is a transition from FIG. 7G in response to input 7608 selecting configuration option 7702 in in-line editing user interface 7700 displayed in FIG. 7G. In response to input 7604 selecting configuration option 7702, device 100 displays configuration user interface 7003 for changing the application category assigned to the application category widget 7104. Configuration user interface 7003 displayed in association with application category widget 7104 in FIG. 7H is the same as configuration user interface 7003 displayed in association with application category widget 7102 in FIG. 7D, except that sorting order 760b corresponding to recency of usage is selected for configuration option 760 (e.g., whereas sorting order 760a corresponding to frequency of usage is selected for configuration option 760 in FIG. 7D) and that the currently selected application category corresponds to the productivity utilities category (e.g., as indicated by symbol “>” near selectable option 750 in contrast to selectable option 751 in FIG. 7D). Listing 7003a of selectable options corresponding to different application categories is the same in configuration user interface 7003 displayed in association with both application category widgets 7102 and 7104.

In FIG. 7H, device 100 detects input 7610 selecting configuration option 752 corresponding to the games application category. In response to input 7610 selecting configuration option 752, the device 100 changes the application category assigned to application category widget 7104 from utilities to games, as described in further detail below in relation to FIG. 7I.

FIG. 7I is a transition from FIG. 7H in response to input 7610 selecting configuration option 752 in the listing 7003a of selectable options displayed in configuration user interface 7003. In response to input 7610 selecting configuration option 752, the device 100 changes the application category assigned to application category widget 7102 from the utilities application category to the games application category, as illustrated in FIG. 7I. For example, application icons 7104a-7104d are replaced with application icons 7104e, 7104f, 7104g, and affordance 7104x, and label 7105 “Utilities” is replaced with label 7107 “Games.” Application icons 7104e, 7104f, 7104g correspond to different applications assigned the games category.

In some embodiments, if applications installed on the device corresponding to a respective application category exceed a threshold number for a respective size of an application category widget, such that there is no room to display all application icons in the application category widget, the device 100 displays an expand category affordance in the application category widget, as illustrated in FIGS. 7I-7J and further described in relation to FIGS. 7J and 7M. In some embodiments, applications installed on device 100 that correspond to the games category exceed a threshold number of four that can be displayed in a small size widget, such as application category widget 7104. Accordingly, application category widget 7104 displays expand category affordance 7104x for expanding the application category widget 7104 to reveal undisplayed application icons corresponding to the games application category.

In some embodiments, the size of an application category widget (e.g., application category widgets 7102 and 7104) can be configured directly from the home screen user interface in accordance with techniques described in relation to FIGS. 5A-5AT. The size (e.g., from small size to medium size, from medium size to large size, from small to large size, and/or other size modification) of an application category widget can be modified by selecting different configuration options displayed in an in-line editing user interface (e.g., in-line editing user interfaces 5200, 5300, 5602 and 5070 in FIGS. 5A-5AT and in-line editing user interface 7700 in FIG. 7C), as described in further detail in FIGS. 7J-7L.

FIG. 7J illustrates two different inputs 7612 and 7614. Input 7612 corresponds to a request to display in-line editing user interface 7700 in association with application category widget 7104 and input 7614 corresponds to a request to expand the application category widget 7104 to reveal undisplayed application icons corresponding to the games application category. In some embodiments, input 7612 is a long press input directed at application category widget 7104 and input 7614 is a tap input directed at affordance 7104x displayed in application category widget 7104. In some embodiments, input 7612 meets an input threshold (e.g., intensity threshold, time threshold, or other types of thresholds) before termination, while input 7614 does not meet the input threshold before termination, where input 7612 and input 7614 are performed using the same type of input mechanism (e.g., touch, air gesture, air gesture with gaze, mouse click, or other input mechanisms).

FIG. 7K is a transition from FIG. 7J in response to the detection of input 7612, in accordance with some embodiments. In response to detecting input 7612, the device 100 displays in-line editing user interface 7700 in association with application category widget 7104 (e.g., for reconfiguring application category widget 7104). The in-line editing user interface 7700 displayed in association with application category widget 7104 in FIG. 7K is the same as in-line editing user interface 7700 displayed in association with application category widget 7102 in FIG. 7C, except that configuration option 7702 in FIG. 7K indicates that the currently selected application category is “Games,” whereas configuration option 7702 in FIG. 7C indicates that the currently selected application category is “Productivity.” Configuration option 7700a is highlighted relative to configuration options 7700b and 7700c to indicate that application category widget 7104 is a small size widget that is configurated according to configuration option 7700a. Further, FIG. 7K illustrates an input 7616 directed at configuration option 7700b corresponding to medium size widget that, when selected, causes device 100 to transform application category widget 7104 from small size to medium size, as illustrated in FIG. 7L.

FIG. 7L is a transition from FIG. 7K in response to input 7617 selecting configuration option 7700b corresponding to the medium size widget. In response to input 7617 selecting configuration option 7700b displayed in in-line editing user interface 7700, the device 100 changes application category widget 7104 from a small size widget to a medium size widget. For example, application category widget 7104 is replaced with application category widget 7104′ that assigned the same games application category but is larger (e.g., changed from a two-row-by-two-column size to a two-row-by-four-column size) and include additional application icons previously undisplayed in application category widget 7104. For example, application category widget 7104′ includes application icons 7104h, 7104i, 7104j, 7104k, and 71041, in addition to application icons 7104e, 7104f, and 7104g displayed in application category widget 7104 in FIG. 7K (e.g., before input 7616 was detected). In some embodiments, if there are more than a threshold number of eight applications in the games application category, application category widget 7104′ will display seven application icons and a category expansion affordance 7104x to indicate that there are additional undisplayed application icons in the games application category.

In some embodiments, instead of changing the size of an application category widget (e.g., using in-line editing user interface 7700), the application category widget can be temporarily expanded to reveal previously undisplayed application icons in the associated category. In some embodiments, applications installed on device 100 that correspond to the games category exceed a threshold number of four that can be displayed in a small size widget, such as application category widget 7104. Accordingly, application category widget 7104 displays category expansion affordance 7104x for expanding the application category widget 7104 to reveal undisplayed application icons corresponding to the games application category.

FIG. 7M is a transition from FIG. 7J in response to detecting input 7614 selecting affordance 7104x. In some embodiments, in response to detecting input 7614 selecting affordance 7104x, device 100 expands application category widget 7104 and displays application icons 7104e-71041 in container 7104″ corresponding to all applications that are assigned to the games application category (e.g., including application icons 7104h-71041 that were not displayed before expanding the application category widget 7104). In some embodiments, home screen page 7002 is blurred while container 7104″ is displayed (e.g., optionally overlaying home screen page 7002). In some embodiments, a tap input outside container 7104″ causes device 100 to display container 7104″ and redisplay home screen page 7002 in 7J and application category widget 7104 (e.g., at the small size it was displayed before expansion).

In some embodiments, an application category, and/or size can be assigned to an application category widget before the application category widget is placed on a home screen page, thereby reducing the number of inputs necessary to add and configure an application category widget. For example, FIGS. 7N-7V illustrate selecting a size and an application category of a respective application category widget before the respective application category is added to home screen page 7004.

FIG. 7N displays home screen page 7004 of a multipage home screen user interface. Home screen page 7004 in FIG. 7N is similar to home screen page 7002 in FIG. 7A, except that application category widgets 7102 and 7104 are not displayed on home screen page 7004. For example, home screen page 7004 in FIG. 7N displays the same application icons 702-722 that are displayed on home screen page 7002 in FIG. 7A. Home screen page 7004 is displayed in the reconfiguration mode (e.g., as opposed home screen page 7002 that is displayed in the normal mode). In the reconfiguration mode, home screen page 7004 displays affordance 725 for adding application objects (e.g., widgets) and affordance 727 for confirming and saving any changes made to the home screen user interface while in the reconfiguration mode (e.g., deletion, addition, or relocation of application objects). In FIG. 7N, the device 100 detects input 7618 selecting affordance 725 for adding application objects.

FIG. 7O is a transition from FIG. 7N in response to input 7618 selecting affordance 725 for adding application objects. In response to input 7618 selecting affordance 725, the device 100 displays a widget library user interface 7007, as illustrated in FIG. 7O. In some embodiments, the widget library user interface 7007 overlays home screen page 7004. In some embodiments, home screen page 7004 is partially visible underneath the widget library user interface 7007. For example, a respective widget in the widget library user interface 7007 can be added on the home screen page 7004 when the respective widget is selected and dragged to a portion of home screen page 7004 that is visible. In some embodiments, in accordance with a determination that the respective widget has been dragged to the portion of home screen page 7004 that is visible, device 100 automatically pushes widget library user interface 7007 downwards to reveal larger portion of the home screen page 7004. The widget library user interface 7007 displays various selectable application widgets (e.g., some corresponding to different applications) that, when selected, can be added to the home screen page 7004. For example, widget library user interface 7007 includes application widget 781 corresponding to a first application; application widget 782 corresponding to a news application (e.g., different from the first application); application widget 783 corresponding to a weather application (e.g., different from the first application and the news applications); widget stack 784 that corresponds to multiple application widgets that stacked at the same placement location (e.g., selection of the application widgets in the widget stack 784 is automatic based on context, or is user-configurable); application widget 785 corresponding to a calendar application; application widget 786 corresponding to a clock application; widget 787 corresponding to an application suggestion widget (e.g., described in further detail above); and widget 788 corresponding to an application category widget (e.g., described in further detail above).

In FIG. 7O, the device 100 detects input 7620 selecting application category widget option 788. In some embodiments, input 7620 is a tap input directed at application category widget option 788 displayed in widget library user interface 7007. In some embodiments, in response to selecting application category widget option 788 in the widget library user interface 7007, the device 100 displays a widget configuration user interface for configuring the type and/or size of the application category widget. For example, in response to selecting application category widget option 788, the device 100 displays widget configuration user interface 7009, as illustrated in FIG. 7P. In some embodiments, in response to selecting a selectable widget (e.g., widget 781, 782, or 783) in the widget library user interface 7007, the device 100 directly adds the selected widget to the home screen page 6004 (e.g., without first displaying widget configuration user interface 7009).

FIG. 7P is a transition from FIG. 7O in response to input 7620 selecting application category widget option 788 in the widget library user interface 7007. In response to selecting the application category widget option 788, the device 100 displays widget configuration user interface 7009. In some embodiments, widget configuration user interface 7009 overlays home screen page 7004. In some embodiments, home screen page 7004 is partially visible underneath the widget configuration user interface 7009. Widget configuration user interface 7009 includes different (e.g., three, or more) selectable configuration options for an application category widget. In some embodiments, the selectable configuration options are indicated by user interface elements 777a, 777b, and 777c and correspond to different types and/or sizes of application category widget. In FIG. 7P, widget configuration user interface 7009 includes configuration option 788a (e.g., completely visible in the widget configuration user interface 7009), configuration option 788b (e.g., only partially visible in the widget configuration user interface 7009) and a third configuration option that is not visible in the widget configuration user interface 7009 but can be displayed in response to navigation input (e.g., scrolling or swiping input) that navigates through the configuration options in the widget configuration user interface 7009. In FIG. 7P, user interface element 777a is highlighted relative to user interface elements 777b and 777c to indicate that the currently selected option is 788a.

In some embodiments, configuration option 788a can be selected in response to an input selecting user interface element 777a corresponding to configuration option 788a; configuration options 788b can be selected in response to an input selecting user interface element 777b corresponding to configuration option 788b; and the third configuration option can be selected in response to an input selecting user interface element 777c corresponding to the third configuration option. In some embodiments, configuration option 788a corresponds to a small size widget, configuration option 788b corresponds to a medium size widget, and the third configuration option indicated by user interface element 777c corresponds to a large size widget. In some embodiments, a user can flip through the configuration options in the widget configuration user interface 7009 in response to swipe inputs. For example, in FIG. 7P, the device 100 detects navigation input 7622 that causes device to navigate through configuration options indicated by user interface elements 777a, 777b, and 777c, as described in further detail below in relation to FIG. 7Q.

FIG. 7Q is a transition from FIG. 7P in response to navigation input 7622. In response to navigation input 7622, the device 100 navigates through configuration options in widget configuration user interface 7009. For example, in response to input 7622, the device switches from configuration option 788a to configuration option 788b in widget configuration user interface 7009, indicated by highlighting user interface element 777b (e.g., in contrast to FIG. 7P in which user interface element 777a is highlighted). Configuration option 788b corresponds to medium size widget. While configuration option 788b is selected, the device 100 detects an input 7624 directed at affordance 759 for adding a widget (e.g., a selected widget according to the selected configuration option for size and/or type). In response to input 7622 selecting affordance 759, the device 100 initiates a process for inserting or adding an application category widget, configured according to the selected configuration option 788b, to the home screen page 7004. For example, the device 100 displays an animation corresponding to flipping application category widget 788b and displaying application category configuration user interface 7011 (e.g., optionally on the back of the flipped application category widget 788b) for assigning an application category to application category widget 788 before application category widget 788b is added on the home screen page, as described in further detail below with references to FIGS. 7R-7U.

FIG. 7R is a transition from FIG. 7Q in response to input 7624 directed at affordance 759 for adding a widget. In response to input 7624 selecting affordance 759, the device 100 initiates a process for inserting or adding application category widget 788b to home screen page 7004. FIG. 7R is a transition state of widget configuration user interface 7009 while application category widget 788b is being flipped. For example, in FIG. 7R, widget configuration user interface 7009 is pushed downwards to reveal more of home screen page 7004 and application category widget 788b is tilted in the process of flipping over.

FIG. 7S is a transition from FIG. 7R further illustrating that the animation of flipping over application category widget 788b has progressed. While application category widget 788 is being added on the home screen page 7004, the device 100 continuously animates the flipping over of application category widget 788b. For example, in FIG. 7R, widget configuration user interface 7009 is further pushed downwards to reveal even more of home screen page 7004 (e.g., relative to FIG. 7R) and application category widget 788b is tilted even more in the process of flipping over (e.g., relative to FIG. 7R).

FIG. 7T is a transition from FIG. 7S and corresponds to a transitional state while application category widget 788b is being added to home screen page 7004. In some embodiments, after application category widget 788b is flipped over (e.g., but before application category widget 788b is added to the home screen page 7004) application category configuration user interface 7011 is displayed overlaying home screen page 7004. In some embodiments, home screen page 7004 is optionally blurred while application category configuration user interface 7011 is displayed. In some embodiments, application category configuration user interface 7011 appears to be displayed on the back of application category widget 788. Application category configuration user interface 7011 includes a list of selectable options corresponding to different application categories. For example, application category configuration user interface 7011 includes option 7011a corresponding to social applications category; option 7011b corresponding to leisure applications category; option 7011c corresponding to communications applications category; option 7011d corresponding to productivity applications category; option 7011e corresponding to strategy games category; option 7011f corresponding to music applications category; option 7011h corresponding to entertainment applications category; option 7011i corresponding to travel applications category; option 7011j corresponding to finance applications category; option 7011k corresponding to education applications category; and option 70111 corresponding to health and fitness applications category. In some embodiments, a user can select an application category, from the list of application categories displayed in application category configuration user interface 7011, to assign to application category widget 788b before application category widget 788b is added to home screen page 7004. For example, in FIG. 7T, device 100 detects input 7626 selecting the communications application category 7011c.

FIG. 7U is a transition from FIG. 7T in response to the detection of input 7626 selecting the communications application category 7011c in the list of selectable application categories displayed in application category configuration user interface 7011. In response to input 7626 selecting the communications application category 7011c, the device 100 assigns the communications application category 7011c to application category widget 788b and places application category widget 788b on home screen page 7004, configured according to configuration option 788b that corresponds to medium size widget, as illustrated in FIG. 7U. For example, device 100 adds application category widget 788 of medium size to the top of home screen page 7004 (e.g., shifting application icons 702-722 to make room for application category widget 788). Application category widget 788 displays a threshold number of application icons (e.g., the number is optionally determined according to the size of the widget) corresponding to applications of the communications application category. For example, application category widget 788 displays application icon 790a corresponding to a messaging application, application icon 790b corresponding to a phone application; application icon 790c corresponding to an email application; application icons 790d and 790e corresponding to different messaging applications; application icon 790f corresponding to a conferencing application; application icon 790g corresponding to a call assistant application; and application icon 790a corresponding to an email application. In some embodiments, application icons 790a-790h in application category widget 788 are dynamically updated (e.g., by adding, removing and/or replacing application icons from the communications category in accordance with contextual changes with respect to device 100 or the application installed on device 100). In some embodiments, even if there are more than a threshold number of applications in the application category associated with the application category widget 788b, the device does not display a category expansion affordance in the application category widget 788b. In some embodiments, tapping on a region of the application category widget 788b that is not occupied by an application icon causes the device to display the application icons in the associated application category including those that are not currently displayed in the application category widget 788b.

In some embodiments, a user can add additional application objects, including additional application category widgets of different sizes and/or different application categories to the home screen page 7004 in response to user input selecting affordance 725 according to the techniques described in relation to FIGS. 7N-7U. In some embodiments, a user can delete the added application category widget 788b in response to selecting deletion affordance 789. In some embodiments, a user can delete the any application icon 790a-790h displayed in application category widget 788b by selecting the respective deletion affordance of the respective application icon. In some embodiments, a user can confirm the changes made to home screen page 7004 by selecting affordance 727. For example, in FIG. 7U, device 100 detects input 7628 selecting affordance 727. In response to selecting affordance 727, device 100 saves the changes made to the home screen page 7004 while in the reconfiguration mode and exits the reconfiguration mode, as illustrated in FIG. 7V. In some embodiments, the computer system (e.g., device 100) selects different subsets of application icons from the communications category to display in the application category widget 788b over time, e.g., when the home screen page 7004 is dismissed and redisplayed at a later time, when the device is locked and unlocked at a later time, when new communication sessions is being requested or have occurred, and/or when other context changes have occurred.

FIGS. 8A-8Q illustrate example user interfaces and interactions for modifying system-generated categorization of applications into groups and sorting of the groups in an application library user interface. FIGS. 13A-13F are a flow diagram of an exemplary method 1200 for modifying system-generated categorization of applications into groups and sorting the groups in an application library user interface, in accordance with some embodiments. The user interfaces in FIGS. 8A-8Q are used to illustrate the processes described below, including the processes in FIGS. 13A-13F.

In some embodiments, the computer system (e.g., device 100) automatically assigns applications to different groups that are system-generated based on various characteristics of the applications (e.g., assigned application category, function of the application, when an application is installed, how frequently or how recently is an application accessed optionally relative to other installed applications, the number of other applications in the same category or in a related category, and/or other criteria). In some embodiments, group folder icons represent the system-generated groups in an application library user interface (e.g., application library user interface 8004 in FIGS. 8C-8D). A respective group folder icon includes application icons corresponding to applications assigned a respective group represented by the respective group folder icon. In some embodiments, the automatically assigned categorization can be modified directly from the application library user interface (e.g., without navigating away from the application library user interface) optionally using an in-line editing user interface. For example, FIGS. 8A-8L illustrate changing, via an in-line editing user interface 8006, an application category that is assigned to an application, thereby also changing a respective group that is assigned to the application based on the assigned application category. More details are provided below.

FIG. 8A illustrates a home screen page 8002 of a multipage home screen user interface. Home screen page 8002 includes application icons 802, 804, 806, 808, 810, 812, 814, 816, 818, 820, 822, 824, 826, 826, and 830. In some embodiments, some of application icons on home screen page 8002 represent the same applications that are represented on home screen page 5001 in FIG. 5A, and some application are different. In some embodiments, application icon 802 corresponds to a messages application, application icon 804 corresponds to a photos application, application icon 806 corresponds to a camera application, application icon 808 corresponds to a stocks application, application icon 810 corresponds to a TV application, application icon 812 corresponds to a clock application, application icon 816 corresponds to an application for managing home devices, application icons 818-820 correspond to different applications, and application icons 826-830 corresponds to different games. In some embodiments, when an application is installed on device 100, the device 100 automatically identifies an application category assigned to the application (e.g., specified in metadata of application, such as an app store category), and includes the application in a system-arranged group that corresponds to the application category. For example, application icon 802 corresponds to the messages application and is assigned to communications application category or to social application category, and application icons 826-830 corresponds to different games and are assigned the games application category. In some embodiments, at least some of application icons 802-830 are included in respective group folder icons in application library user interface 8004 based on the assigned application category, as described in further detail below with reference to FIGS. 8B-8D.

Further, in FIG. 8A, the device 100 detects navigation input 8800 requesting to display next page of the multi-page homes screen user interface. In response to navigation input 8800, the device at least partially reveals application library user interface 8004, as described in further detail below with reference to FIGS. 8B-8C.

FIG. 8B is a transition from FIG. 8A in response to navigation input 8800. In some embodiments, navigation input 8800 is a swipe gesture in a leftward direction. In some embodiments, the navigation input 8800 is a gesture used to navigate between user-arranged pages of the home screen user interface (e.g., home screen pages 5002, 6002, 7002, and 8002). For example, the device 100 switches from one home screen page to another in response to a swipe gesture. In some embodiments, in response to navigation input 8800 and in accordance with a determination that home screen page 8002 is the last user-arranged page in a sequence of home screen pages of the multipage home screen user interface (e.g., as indicated by page indicator 8002d indicating respective ordinal position of the home screen page 8002 in the sequence of home screen pages), the device 100 reveals and at least partially displays application library user interface 8004, as illustrated in FIG. 8B. In some embodiments, in response to navigation input 8800 and in accordance with a determination that home screen page 8002 is not the last user-arranged page in a sequence of home screen pages of the multipage home screen user interface, the device 100 switches to the next available page in the sequence of home screen pages (e.g., as opposed to causing device 100 to display the application library user interface 8004). In some embodiments, depending on the currently displayed home screen page, a user will swipe left past all user-arranged home screen pages to get access to and display the application library user interface 8004.

FIG. 8B illustrates an intermediate state before the device 100 has switched from displaying the home screen page 8002 to displaying application library user interface 8004. For example, in FIG. 8B, application library user interface 8004 is displayed partially overlaying home screen page 8002. In some embodiments, in FIG. 8B, application library user interface 8004 is partially revealed (e.g., further movement of navigation input 8800 causes device 100 to fully display application library user interface 8004 as illustrated in FIG. 8C) in response to navigation input 8800. The revealed portion of application library user interface 8004 includes group folder icons 8040, 8042, 8044, and 8046, each representing a system-generated group of applications (e.g., optionally grouped by application category). In some embodiments, a group folder icon of group folder icons 8040-8046 corresponds to a representation of a respective system-generated group. For example, group folder icon 8040 represents a group of applications that are assigned to the productivity application category as indicated by label 8040i “Productivity” displayed under group folder icon 8040; group folder icon 8042 represents a group of applications that are assigned to the utilities application category as indicated by label 8042i “Utilities” displayed under group folder icon 8042; group folder icon 8044 represents a group of applications that are unassigned or correspond to application that are assigned a mixture of different application categories as indicated by label 8044i “Others” displayed under group folder icon 8044; and group folder icon 8046 represents yet another group of applications. In some embodiments, an application is only assigned a single category. In some embodiments, an application can be assigned one or more categories, and be included in the groups of multiple categories.

In some embodiments, a group folder icon (e.g., corresponding to a representation of a respective system-generated group) optionally includes miniature versions (e.g., scaled down versions) of application icons corresponding to at least a subset of the applications included in the group and, in some embodiments, an expand folder icon. For example, group folder icon 8040 represents applications assigned the productivity application category and displays application icons 8040a, 8040b, 8040c, and 8040d corresponding to applications included in the group of productivity applications; group folder icon 8042 represents applications assigned the utilities application category and displays application icons 8042a, 8042b, and 8042c corresponding to applications included in the group of utilities applications and expand folder icon 8042d that, when selected, causes device 100 to expand group folder icon 8042 and display the application icons included in the utilities application category (e.g., including application icons that were previously undisplayed); group folder icon 8044 represents applications that are not assigned a specific application category or are assigned various application categories and group folder icon 8044 displays application icons 8044a, 8044b, 8044c, and 8044d corresponding to applications included in the group of other applications; and group folder icon 8046 represents applications assigned a different application category and displays application icons 8046a, and 8046b corresponding to applications included in the respective group of applications represented by group folder icon 8046.

In some embodiments, when a respective miniature application icon is activated by a user input (e.g., by a tap input, a double tap input, an air pinch gesture, or another type of selection input that does not exceed an input threshold (e.g., a time threshold or intensity threshold)), the computer system (e.g., device 100) launches the corresponding application of the respective miniature application icon. For example, in response to detection of a selection input directed to application icon 8040b corresponding to the calculator application, the device 100 opens the calculator application and displays a user interface corresponding to the calculator application. The expand folder icon, when activated (e.g., by a tap input, a double tap input, or other type of input), displays the folder content, including the application icons corresponding to the applications in the respective grouping associated with the group folder icon. For example, expand folder icon 8042d, when selected, causes device 100 to expand group folder icon 8042 and display the application icons included in the application group that is associated with group folder icon 8042.

In some embodiments, the application library user interface 8004 corresponds to a system-generated or system-arranged home screen user interface. The group folder icons are generated automatically (e.g., without user input placing application icons in respective group folder icons) according to predetermine criteria that include criteria based on application category. The group folder icons (e.g., group folder icons 8040, 8042, 8044, and 8046) and respective positions or ordering of the group folder icons optionally update dynamically over time based on usage patterns, contextual changes, changes occurring in the respective applications and/or events occurring with respective to device 100. In some embodiments, application library user interface 8004 is presented as a page of the multipage home screen user interface with a corresponding page indicator icon indicating its ordinal position in a sequence of pages of the multipage home screen user interface (e.g., similar to page indicator 8002d). In such scenario, the pages of the multipage homes screen user interface are optionally displayed at the same simulated depth (e.g., as opposed to displaying application library user interface 8004 at a different simulated depth and sliding over the last page of the home screen user interface). In some embodiments, the application library user interface 8004 is presented as a user interface overlay or a separate user interface (e.g., as opposed to a page of the multipage homes screen) that does not have a corresponding page indicator icon displayed alongside the page indicator icons of the user-arranged pages of the multipage-home screen user interface. In such scenario, the application library user interface 8004 is optionally displayed at a simulated depth that is different from the depth at which home screen pages, such as home screen page 8002, are displayed. For example, as illustrated in FIG. 8B, when switching from displaying home screen page 8002 to displaying application library user interface 8004, the device 100 displays home screen page 8002 at a greater simulated depth than the depth at which application library user interface 8004 is displayed. In some embodiments, irrespective of its appearance, the system-arranged page of the home screen user interface is accessed and displayed in response to the same type of page navigation inputs (e.g., navigation input 8800) that are used to navigate between user-arranged pages of the multipage home screen user interface.

Further, in FIG. 8B, the device 100 detects further movement of navigation input 8800 in a leftward direction requesting to display application library user interface 8004. In response to navigation input 8800, the device 100 switches from displaying the home screen page 8002 (e.g., ceases to display home screen page 8002) to displaying application library user interface 8004, as described in further detail below with reference to FIG. 8C.

FIG. 8C is a transition from FIG. 8B in response to the detection of further movement of navigation input 8800. In response to navigation input 8800, the device 100 completes the switch from displaying the home screen page 8002 to displaying application library user interface 8004. As illustrated in FIG. 8C, application library user interface 8004 displays group folder icons 8041, 8043, 8045, 8047 in addition to group folder icons 8040, 8042, 8044, and 8046 described in further detail in relation to FIG. 8B. Group folder icon 8041 represents a group of applications that are assigned to an arcade games application category, as indicated by label 8041i “Arcade Games” displayed under group folder icon 8041, and group folder icon 8041 displays application icons 8041a, 8041b, 8041c, and 8041d corresponding to applications included in the group of arcade games applications; group folder icon 8043 represents a group of applications that are assigned to the communications application category, as indicated by label 8043i “Communications” displayed under group folder icon 8043 and group folder icon 8043 displays application icon 8043a, 8043b, 8043c, and 8043d corresponding to applications included in the group of communications applications; group folder icon 8045 represents a group of applications that are assigned to a strategy games application category, as indicated by label 8045i “Strategy Games” displayed under group folder icon 8045; and group folder icon 8047 represents yet another group of applications represented by application icons 8047a, 8047b, and 8047c.

In some embodiments, application library user interface 8004 shows applications (e.g., installed on the device 100) organized into categories (e.g., categories such as Social, Entertainment, Productivity, Games, and Finance). In some embodiments, the application categories that are used most frequently are displayed near the top of application library user interface 8004 and application icons for applications that are most frequently are displayed at the top level of respective group folder icon corresponding to their categories, such that a user can easily locate and open the applications. In some embodiments, application library user interface 8004 is scrollable. For example, the device 100 displays additional group folder icons in application library user interface 8004 in response to a navigation input (e.g., a swipe gesture that, when detected, causes device 100 to scroll group folder icons in application library user interface 8004 and reveal group folder icons that were not initially displayed in application library user interface 8004).

Further, in FIG. 8D, the device 100 detects a selection input 8802 directed to application icon 8041b displayed in group folder icon 8041 corresponding to applications categorized as arcade games. In some embodiments, selection input 8802 is a long press input (or, optionally, another type of input that meets an input threshold, such as an intensity threshold or a time threshold) that causes device 100 to display an in-line editing user interface in relation to application icon 8041b (e.g., in contrast to a different selection input that does not meet the input threshold, such as a tap input, air pinch gesture, or a click and release input, that causes device 100 open the arcade game application that corresponds to application icon 8041b), as described in further detail below with reference to FIGS. 8E-8F.

FIG. 8E is a transition from FIG. 8D in response to selection input 8802 directed to application icon 8041b. Application icon 8041b represents a respective arcade game application. In response to selection input 8802 directed to application icon 8041b, the device 100 selects application icon 8041b and displays in-line editing user interface 8006 in association with the selected application icon 8041b. In some embodiments, in-line editing user interface 8006 is a contextual menu for performing various operations with respect to the respective arcade game application in association with which the in-line editing user interface 8006 is displayed. For example, in-line editing user interface 8006 includes control option 8010 for adding an application icon corresponding to the respective arcade game application (e.g., another instance or duplicate of application icon 8041b) to a user-arranged home screen page of the multipage home screen user interface. Further, in-line editing user interface 8006 includes control option 8014 for sharing the respective arcade game application with another contact (e.g., for sending a link via message to a contact via a communications application or social application). Further, in-line editing user interface 8006 includes control option 8016 for deleting the respective arcade game application from the group corresponding to arcade games and, thus, from group folder icon 8041. In some embodiments, deleting an application from a group and thus removing corresponding application icon from a respective group folder icon does not cause the device 100 to uninstall the application and/or delete corresponding application icon from the one or more home screen pages. In some embodiments, in-line editing user interface 8006 displays configuration control 8012 for recategorizing a selected application (e.g., corresponding to a selected application icon, respectively, such as the selected application icon 8041b). FIG. 8E illustrates that the currently assigned category to the application represented by application icon 8041b is “Arcade Games.” In some embodiments, configuration control 8012, when selected, causes device 100 to display a category configuration user interface, as described in further detail below with reference to FIGS. 8F-8G.

FIG. 8F illustrates a selection input 8804 directed at configuration control 8012. In some embodiments, selection input 8804 is a tap, double tap, and/or other selection input that does not meet an input threshold (e.g., a tap input, an air pinch gesture, or a click and release input). In response to the detection of selection input 8804, the device 100 displays category configuration user interface 8008, as shown in FIG. 8G. In some embodiments, category configuration user interface 8008 is displayed overlaying application library user interface 8004 and optionally selected application icon 8041b is visually emphasized relative to other application icons and group icons in application library user interface 8004. Category configuration user interface 8008 is displayed in association with application icon 8041b and respective arcade game application represented by application icon 8041b. Category configuration user interface 8008 displays a list 8011 of selectable options corresponding to different application categories. For example, the list 8011 of selectable options includes option 8008a corresponding to social applications category; option 8008b corresponding to leisure applications category; option 8008c corresponding to communications applications category; option 8008d corresponding to productivity applications category; option 8008e corresponding to strategy games category; option 8008f corresponding to arcade games category; and option 8008g corresponding to other applications category. In some embodiments, the list 8011 of selectable options displayed in association with an application icon displayed in application library user interface 8004 in FIG. 8G is the same as the list of selectable options displayed in configuration user interface 7011 in association with an application category widget in FIG. 7T. In FIG. 8G, checkmark 8009 in category configuration user interface 8008 indicates that the currently selected application category, assigned to application icon 8041b and corresponding application, is “Arcade Games.”

In some embodiments, the list of selectable application categories is automatically selected by the computer system. In some embodiments, the list of selectable application categories (e.g., list 8011 in FIG. 8G or the list in FIG. 7T) change dynamically in accordance with detecting a change in context of the computer system (e.g., time, place, location, incoming communication, active focus mode, notifications, ongoing activity on the computer system, and/or other contextual changes); in response detecting an event in an application of the same group, same or related category; in response to detecting a change in usage of applications installed on the computer system (e.g., user activity); in response to detecting that one or more new applications are installed (e.g., and/or downloaded) on the computer system or removed (e.g., and/or uninstalled) from the computer system, and/or other changes associated with the computer system and/or applications installed on the computer system.

In FIG. 8H, the device 100 detects selection input 8806 directed at selectable option 8008e corresponding to strategy games application category. Accordingly, selection input 8806 requests to change the assigned application category from the arcade games application category to the strategy games application category. In response to detecting selection input 8806 directed at selectable option 8008e, the device 100 changes the assigned application category from arcade games application category to strategy games application category and initiates an animated recategorization process that includes relocating application icon 8041b from group folder icon 8041 corresponding to the arcade games to group folder icon 8045 corresponding to the strategy games, as illustrated and described in further detail below with reference to FIGS. 8I-8L.

FIG. 8I illustrates the movement path of application icon 8041b that is being recategorized from group folder icon 8041 corresponding to the arcade games to group folder icon 8045 corresponding to the strategy games (e.g., illustrated with a dashed arrow beginning from placement location of application icon 8041b in group folder icon 8041 and ending in group folder icon 8045). FIG. 8J is a transition from FIG. 8I in response to the detection of selection input 8806 directed at selectable option 8008e that causes device 100 to recategorize application icon 8041b from an arcade game to a strategy game. FIG. 8K further illustrates movement of application icon from group folder icon 8041 corresponding to the arcade games to group folder icon 8045 corresponding to the strategy games. In conjunction with relocating application icon 8041b, the device 100 automatically shifts application icons in group folder icon 8041 to fill up the placement location 8041b′ vacated by application icon 8041b. For example, application icons 8041c and 8041d (e.g., placed after the vacated placement location 8041b′ in group folder icon 8041) shift by one placement location in a snaking pattern (e.g., left to right and bottom to top), as illustrated in FIG. 8K. Further, in FIG. 8K, the application icon 8041b is displayed over group folder icon 8045 but it is not yet placed in group folder icon 8045. FIG. 8L illustrates a state of application library user interface 8004 after application icon 8041b and its corresponding application are recategorized from being an arcade game to being a strategy game, and application icon 8041b has been placed in group folder icon 8045 corresponding to the strategy games (and, optionally, removed from group folder icon 8041 corresponding to the arcade games).

In some embodiments, the automatically assigned categorization of an application can be modified directly from the application library user interface 8004 by relocating a respective application icon representing the application from one group folder icon to another (e.g., in response to a drag and drop input). For example, instead of using in-line editing user interfaces 8006 and 8008, a use can optionally select application icon 8041b and drag application icon 8041b from group folder icon 8041 to group folder icon 8045, thereby causing device 100 to recategorize application icon 8041b and its corresponding application from being an arcade game to being a strategy game. Optionally, in accordance with a determination that an application icon is moved from a first group icon to a second group icon (e.g., different from the first group icon), the computer system (e.g., device 100) displays a user interface that prompts a user to confirm the recategorization of the application icon (e.g., that also optionally provides warning) that the relocation of the application icon would also cause recategorization of the application icon and the corresponding application).

In some embodiments, the computer system (e.g., device 100) automatically sorts the group folder icons representing the system-generated groups of application icons in the application library user interface. For example, the computer system displays the group folder icons in the application library user interface in a system-assigned ordering determined based on various criteria (e.g., according to recency and/or frequency of using applications in the respective group, according to recency and/or frequency of accessing the respective group folder icon, according to recent changes or events occurring in the application in the respective group, based on usage over a period of time, based on current context in relation to the computer system; and/or other criteria). In some embodiments, the order in which some (e.g., or optionally all) of the system-generated groups are displayed in the application library user interface is selected by a user while the order for a remainder of the system-generated groups is dynamically determined by the computer system (e.g., while the order selected by a user is maintained, the order of the remaining groups adapt dynamically based on various contextual and usage criteria). For example, FIGS. 8M-8P illustrate a user fixing the sorting order in which some groups are displayed in the application library user interface while enabling a system-determined sorting order for other groups.

FIG. 8M illustrates a setting user interface 8020 for configuring an application library user interface (e.g., an application library user interface 8004, or another system-arranged user interface that includes group folder icons corresponding to application categories). In some embodiments, different sorting parameters can be used to sort group folder icons in application library user interface 8004. For example, group folder icons can be sorted by application category, by color, alphabetically, and/or other sorting parameter. In some embodiments, setting user interface 8020 for configuring the application library user interface displays configuration option 8026 corresponding to a sorting parameter based on application category and configuration option 8028 corresponding to a sorting parameter based on color. Further, the setting user interface 8020 displays a configuration option 8022 for enabling or disabling automatic ordering of groups (e.g., corresponding to ordering of respective group folder icons). For example, configuration option 8022, when enabled, causes device 100 to dynamically change the sorting order of group folder icons based on usage of applications over time, contextual changes, changes occurring in the respective applications, installing and/or uninstalling applications, and/or events occurring with respective to device 100. In some embodiments, configuration option 8022, when enabled, causes device 100 to dynamically change the sorting order in accordance with selected sorting parameter (e.g., application categories, color, or alphabetical). In some embodiments, even if automatic ordering is enabled, a user can explicitly specify (e.g., “pin”) the sort order for a selected number of system-arranged groups of applications. For example, the order in which “pinned” system-arranged groups are displayed is maintained (e.g., not changed by device 100) while the device 100 may automatically change the order of the unpinned system-arranged groups of applications over time. In some embodiments, configuration option 8024, when selected, causes device 100 to display configuration user interface 8030 for providing custom ordering of the system-arranged groups of applications, as described in further detail below with reference to FIGS. 8N-8Q. FIG. 8M further illustrates that device 100 detects selection input 8808 selecting configuration option 8024 for providing custom ordering of the system-arranged groups of applications.

FIG. 8N is a transition from FIG. 8M in response to the detection of selection input 8808 selecting configuration option 8024. In response to the detection of selection input 8808 selecting configuration option 8024, the device 100 displays configuration user interface 8030 for providing custom ordering that includes a list 8031 of selectable and movable user interface objects corresponding to different application categories. For example, list 8031 includes selectable option 8030a corresponding to the productivity application category; selectable option 8030b corresponding to the arcade games application category; selectable option 8030bc corresponding to the utilities application category; selectable option 8030d corresponding to the communications application category; selectable option 8030e corresponding to the “other” applications category; selectable option 8030f corresponding to the strategy games application category; selectable option 8030g corresponding to a social application category; selectable option 8030h corresponding to a music application category; selectable option 8030i corresponding to an entertainment application category; selectable option 8030j corresponding to a travel application category; selectable option 8030k corresponding to a finance application category; selectable option 8030l corresponding to an education application category; and selectable option 8030m corresponding to a health and fitness application category.

In some embodiments, the list 8031 of selectable and movable user interface objects corresponding to different application categories is divided in two parts by divider affordance 8032 (e.g., a user interface element that corresponds to a line or border that divides the list 8031, as illustrated in FIG. 8N). For example, a list 8031′ of selectable options 8030a-8030d above divider affordance 8032 correspond to pinned system-arranged groups of applications, whereas a list 8021″ of selectable options 8030e-8030m below divider affordance 8032 correspond to unpinned system-arranged groups of applications. In some embodiments, group folder icons corresponding to the pinned system-arranged groups of applications (e.g., represented by list 8031′ of selectable 8030a-8030d in configuration user interface 8030) are displayed in the application library user interface 8004 according to the order specified in the list 8031′ of selectable options 8030a-8030d, irrespective of whether automatic ordering is enabled and even if the unpinned system-arranged groups of applications represented by list 8031″ of selectable options 8030a-8030d in configuration user interface 8030 are reordered by the device. For example, according to the order in list 8031′ of selectable options 8030a-8030d, the device 100 displays, at the first ordinal position, group folder icon 8040 corresponding to selectable option 8030a placed at the top of list 8031′ and representing system-arranged group of applications that are categorized as productivity applications. Further, the device 100 displays, at the second ordinal position, group folder icon 8041 corresponding to selectable option 8030b placed at second position in list 8031′ and representing system-arranged group of applications that are categorized as arcade games. Further, the device 100 displays, at the third ordinal position, group folder icon 8042 corresponding to selectable option 8030c placed at third position in list 8031′ and representing system-arranged group of applications that are categorized as utilities applications. Further, the device 100 displays, at the fourth ordinal position, group folder icon 8043 corresponding to selectable option 8030d at fourth position in list 8031′ and representing system-arranged group of applications that are categorized as communications applications. In some embodiments, the group folder icons corresponding to selectable options in list 8031″ below the divider affordance 8032 are displayed in application library user interface 8004 in an order that is automatically and dynamically determined by the device 100.

In some embodiments, the pinned system-arranged groups of applications can be changed in response to a user input reordering the selectable options in the list 8031′ above divider affordance 8032, relocating one or more selectable options from the list 8031″ below divider affordance 8032 to the list 8031′ above the divider affordance 8032, and/or relocating one or more selectable options from the list 8031′ above divider affordance 8032 to the list 8031″ below the divider affordance 8031. For example, FIGS. 8O-8P illustrate a user selecting selectable option 8030f and dragging the selected selectable option 8030f from list 8031″ below the divider affordance 8032 to list 8031′ above the divider affordance 8031, thereby causing device 100 to pin a system-arranged group (e.g., the group corresponding to the strategy games category) that was previously unpinned.

In FIG. 8N, the device 100 detects input 8810 selecting selectable option 8030f representing system-arranged group of applications that are categorized as strategy games. In some embodiments, input 8810 corresponds to a drag and drop input requesting to relocate selectable option 8030f from list 8031″ below the divider affordance 8032 to list 8031′ above the divider affordance 8032.

FIG. 8O is a transition from FIG. 8N in response to detecting movement of input 8810 while selectable option 8030f is selected (e.g., while maintain selection of selectable option 8030f). FIG. 8O illustrates an intermediate state in which selectable option 8030f is in the process of being relocated in response to the movement of input 8810 while selection of selectable option 8030f is maintained. In FIG. 8O, selectable option 8030f is lifted off of its original position and the arrow connected to input 8810 illustrates the movement path of selectable option 8030f in response to movement of input 8810.

FIG. 8P is a transition from FIG. 8O after the selectable option 8030f has been relocated from list 8031″ below the divider affordance 8032 to the third ordinal position of in list 8031′ above the divider affordance 8032. FIG. 8P illustrates an updated list 8031′ that displays, at the third ordinal position in the list 8031′, an additional selectable option 8030f corresponding to group of applications categorized as strategy games, and an updated list 8031″ without selectable option 8030f. In some embodiments, the device 100 displays, in the application library user interface 8004, group folder icons corresponding to selectable options 8030a, 8030b, 8030f, 8030c, and 8030d in accordance with the order of selectable options 8030a, 8030b, 8030f, 8030c, and 8030d in list 8031′ in FIG. 8P, while automatically determining and optionally dynamically updating the order in which group folder icons corresponding to selectable options 8030e, and 8030g-8030m are displayed in in the application library user interface 8004.

FIG. 8Q illustrates application library user interface 8004 in accordance with the customized sorting order specified in list 8031 of selectable options 8030a-8030m in FIG. 8P. In some embodiments, the order in which group folder icons corresponding to selectable options 8030a-8030m is pinned or persistent (e.g., not changed dynamically by device 100). For example, the first pinned group folder icon is group folder icon 8040, corresponding to a system-arranged group of applications categorized as productivity applications, and is displayed at the first ordinal position in application library user interface 8004 (e.g., from top to bottom and from left to right) in accordance with the first ordinal position of selectable option 8030a corresponding to productivity application category. Next, group folder icon 8041, corresponding to a system-arranged group of applications categorized as arcade games, is displayed at the second ordinal position in application library user interface 8004 (e.g., from top to bottom and from left to right) in accordance with the second ordinal position of the pinned selectable option 8030b corresponding to arcade games application category. Next, group folder icon 8045, corresponding to a system-arranged group of applications categorized as strategy games, is displayed at the third ordinal position in application library user interface 8004 (e.g., previously displayed at the sixth ordinal position before pinning the strategy games group) in accordance with the third ordinal position of pinned selectable option 8030f corresponding to strategy games application category. Next, group folder icon 8042, corresponding to a system-arranged group of applications categorized as utilities applications, is displayed at the fourth ordinal position in application library user interface 8004 (e.g., from top to bottom and from left to right) in accordance with the fourth ordinal position of the pinned selectable option 8030c corresponding to utilities application category. Finally, the last pinned group folder icon is group folder icon 8044, corresponding to a system-arranged group of applications categorized as communications applications, and is displayed at the fourth ordinal position in application library user interface 8004 (e.g., from top to bottom and from left to right) in accordance with the fifth and last ordinal position of the pinned selectable option 8030c corresponding to communications application category. In some embodiments, the order in which the remainder of group folder icons displayed in application library user interface 8004 may change dynamically and is determined by device 100, as opposed to manually selected in accordance with pinned selectable options in list 8031′.

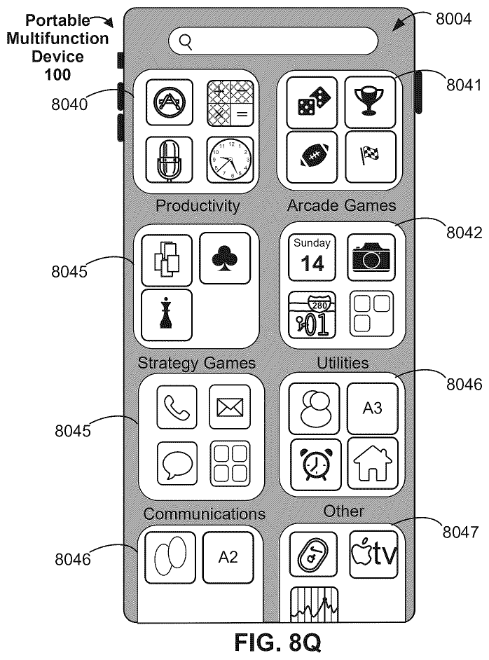

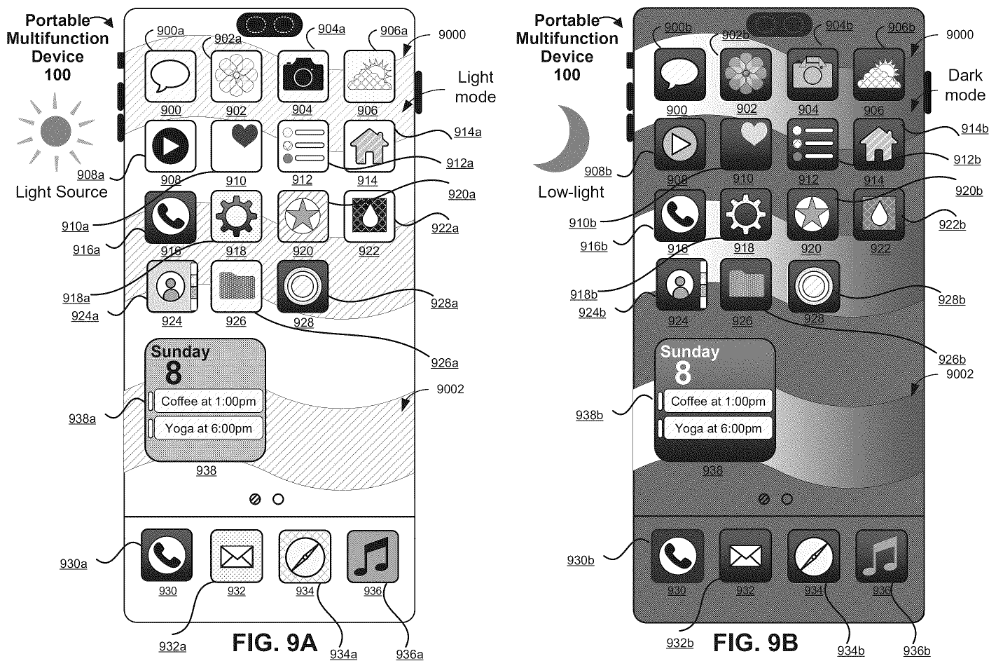

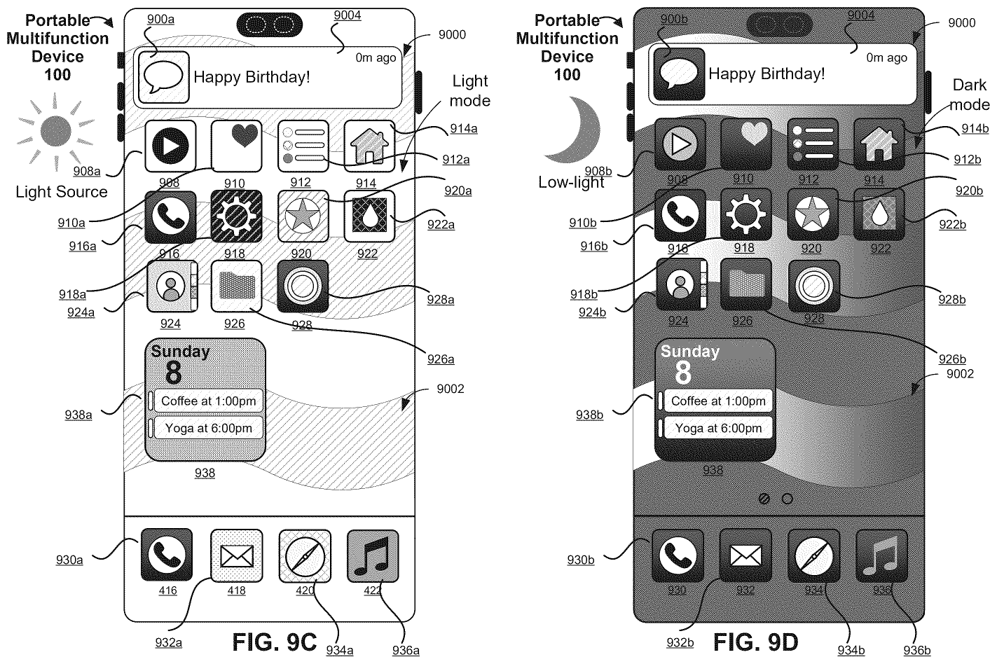

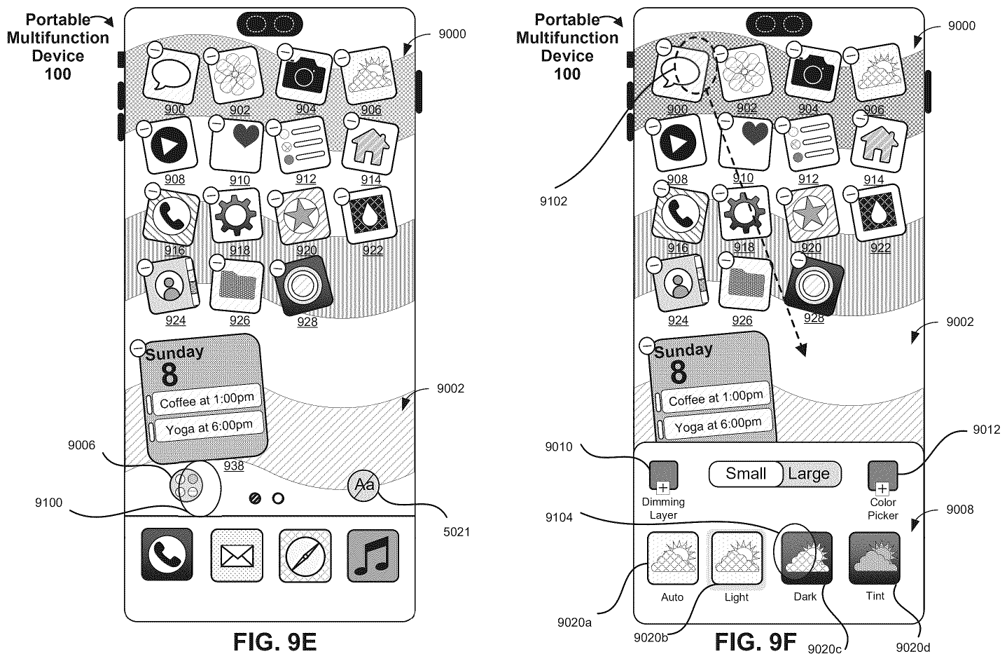

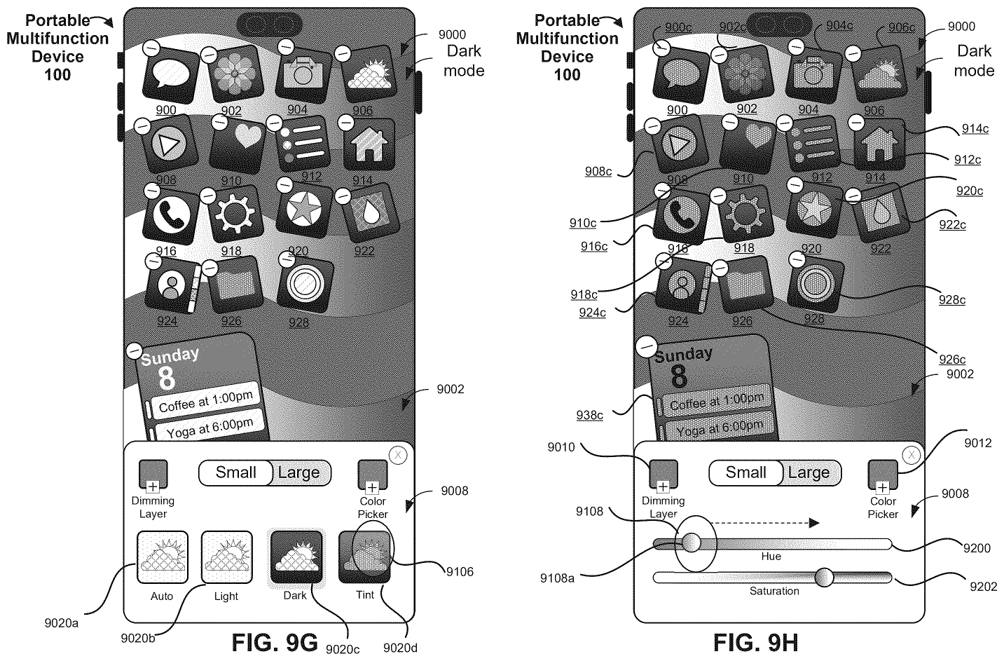

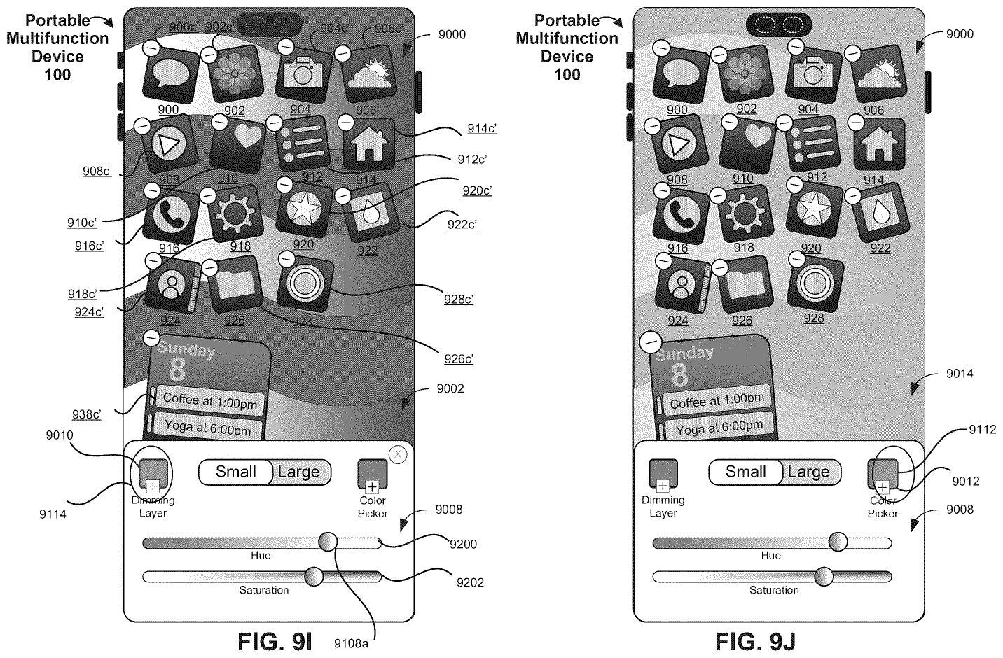

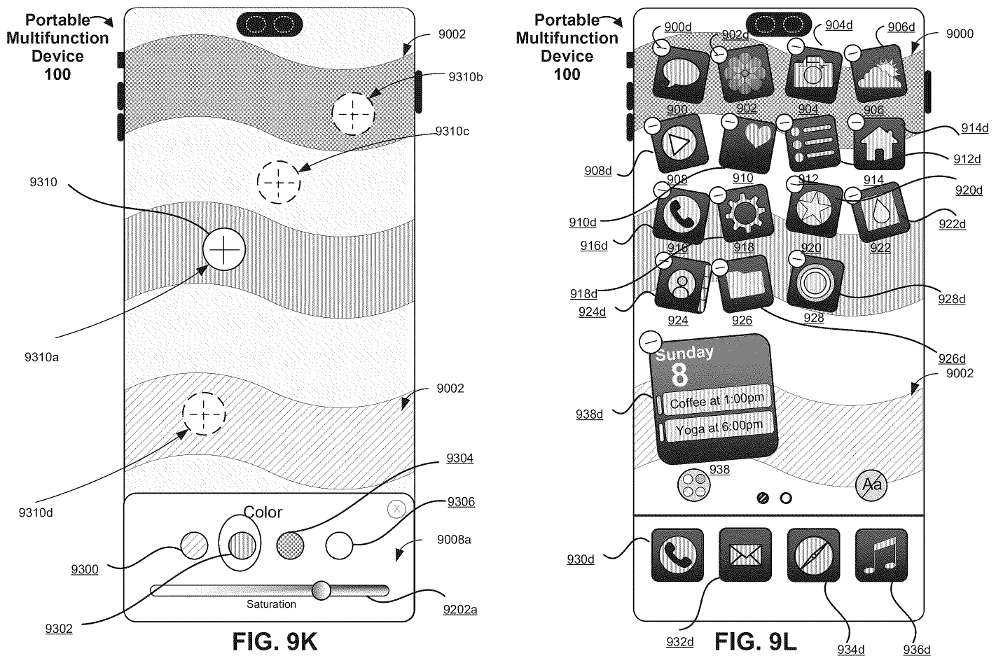

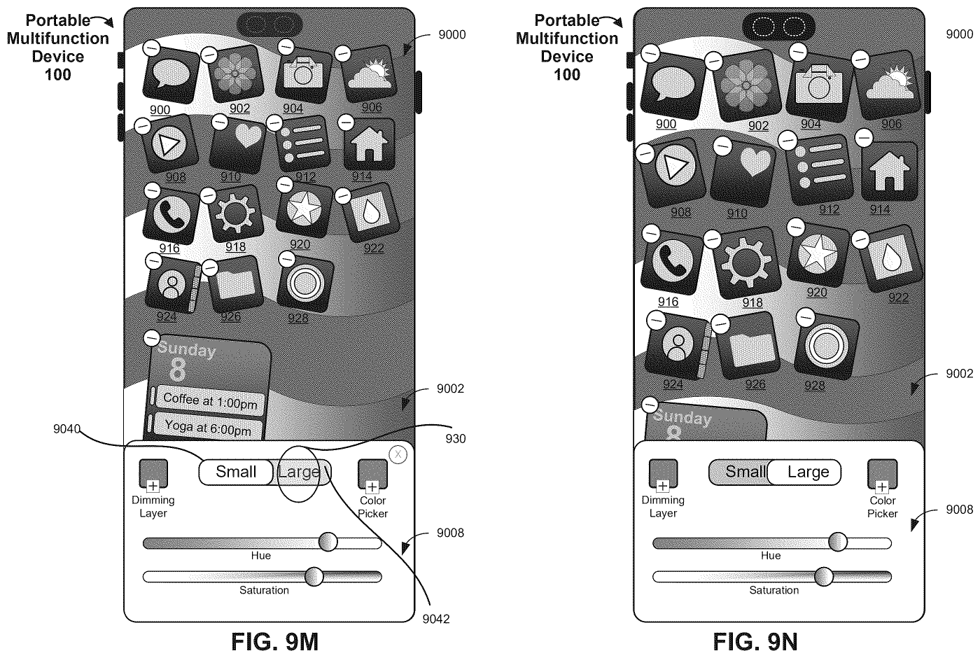

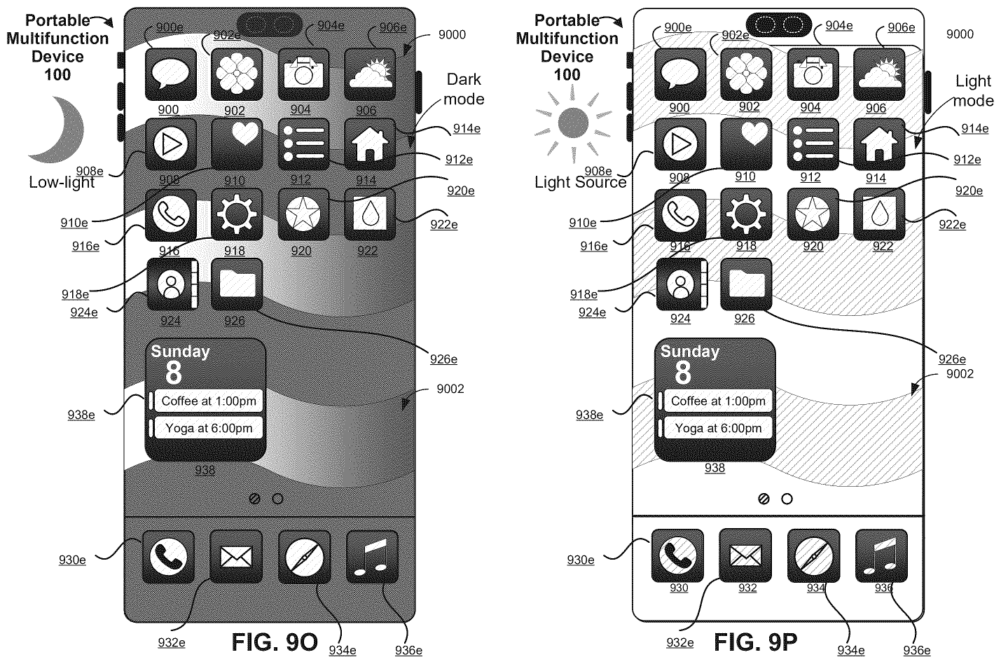

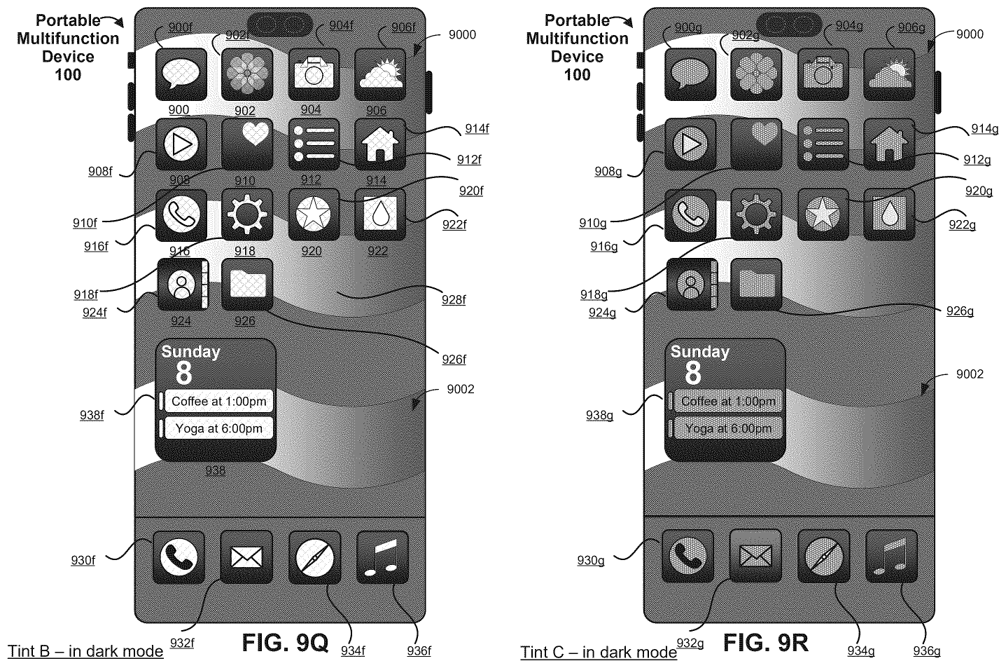

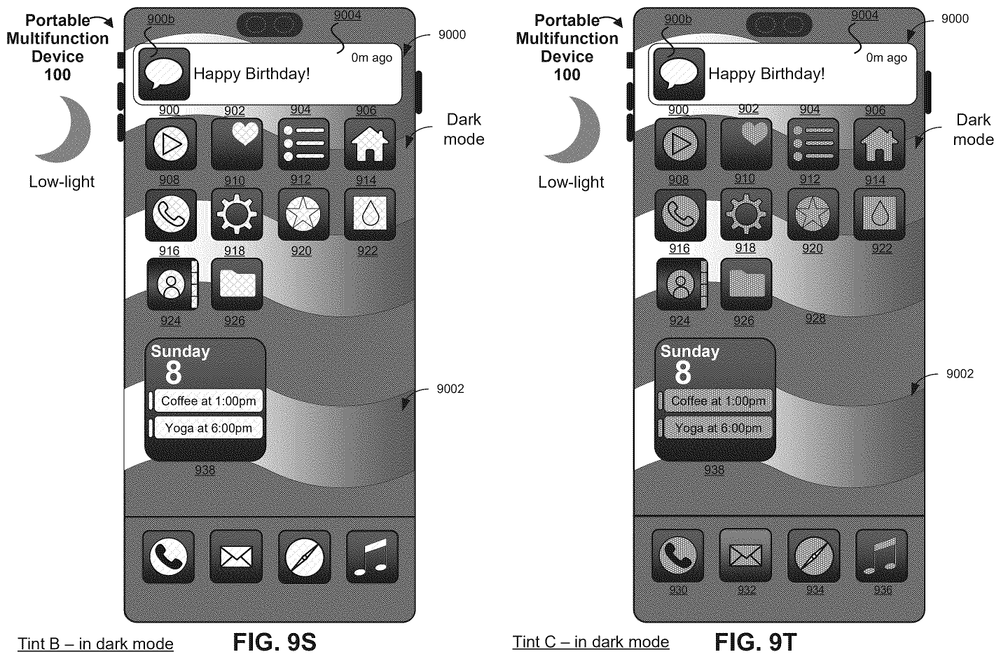

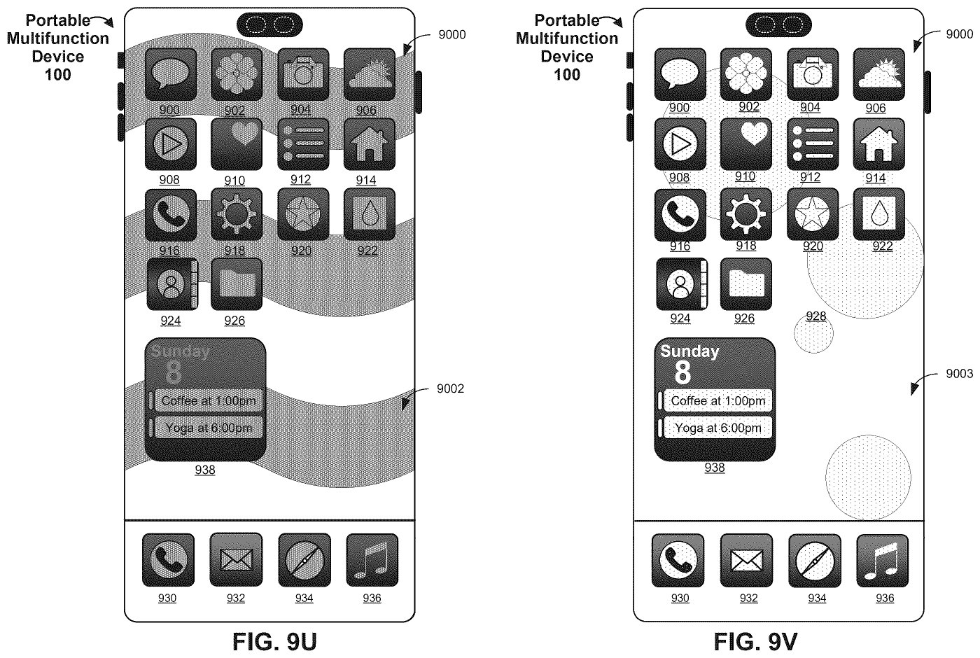

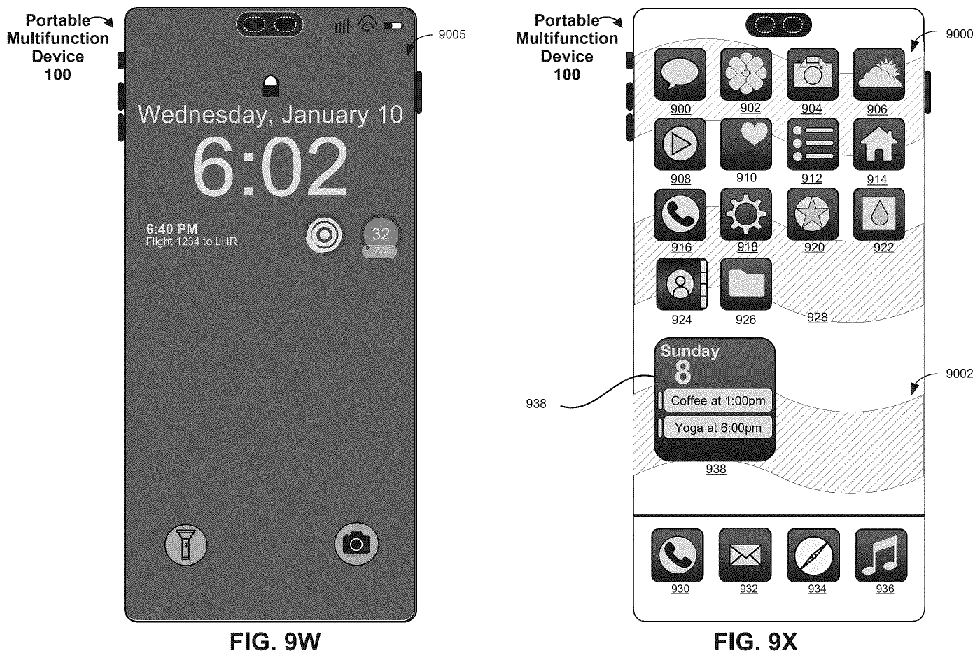

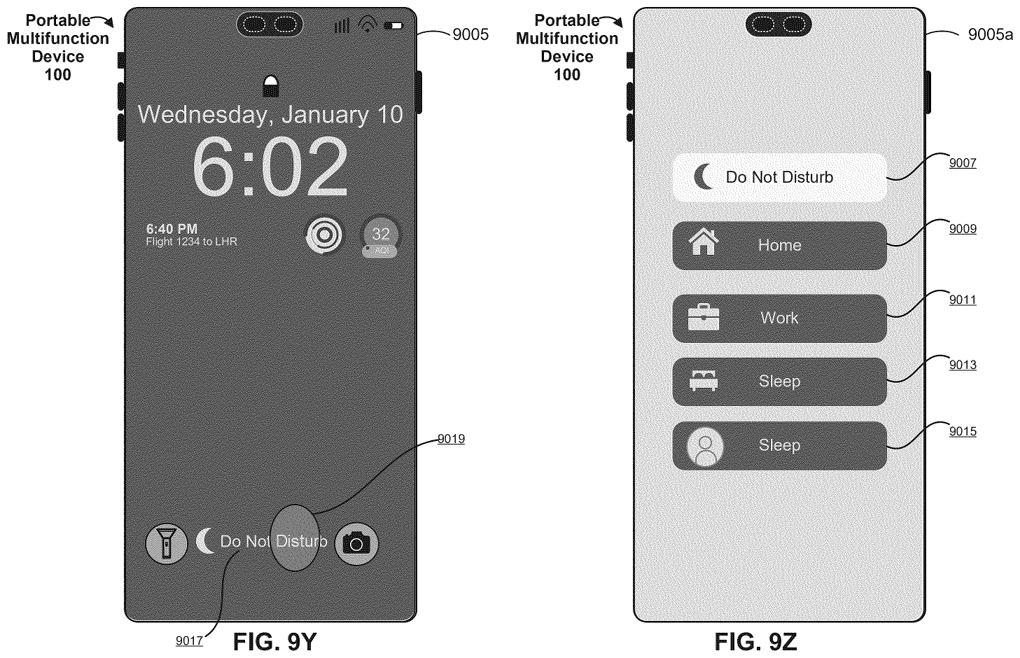

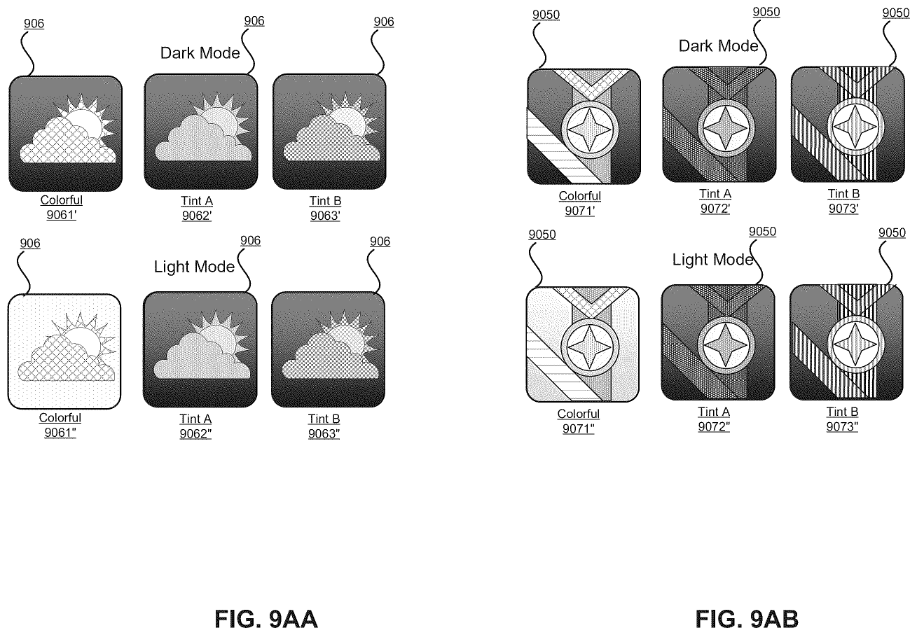

FIGS. 9A-9AB illustrate example techniques for changing an appearance of a home screen user interface, in accordance with some embodiments. FIGS. 14A-14H are a flow diagram of methods of changing an appearance of a home screen user interface, in accordance with various embodiments. The user interfaces in FIGS. 9A-9AB are used to illustrate the processes described below, including the processes in FIGS. 14A-14H.

In some embodiments, the computer system maintains a selected colorful or tint appearance for foreground elements of application user interface objects (e.g., application icons and/or widgets) on a home screen user interface while changing a background of the home screen user interface, in accordance with a change of the state of the device from a light mode to a dark mode or vice versa.

FIGS. 9A-9B illustrate a home screen user interface 9000 with a selected visual property corresponding to a colorful appearance (e.g., optionally also referred to as “colorful” icon configuration). When the colorful appearance is selected, application user interface objects (e.g., application icons, widgets, complications, and/or other types of user interface objects corresponding to applications) are displayed with a varied set of colors (e.g., for foreground elements of the application user interface objects and, optionally, the respective background of the user interface objects) that are designed by the developers of the applications and are not configurable by a user. In FIG. 9A, device 100 is operating in a light mode and FIG. 9B the device 100 is operating in a dark mode. In some embodiments, in the “light mode,” the device 100 displays user interfaces with appearance properties that are suitable for daytime viewing, and/or in well-lit conditions, or another set of conditions based on time, environment, and/or physical settings. In some embodiments, in the “dark mode,” the device 100 displays user interfaces with appearance properties that are suitable for nighttime viewing, and/or in dim-lit conditions, or another set of conditions based on time, environment, and/or physical settings. In some embodiments, the operating system of device 100 determines the conditions for switching between the light mode and the dark mode, and automatically switches between the light mode and the dark mode when the device is in use. In some embodiments, device 100 switches between operating in the light mode or the dark mode in response to user requests.

In FIG. 9A, the home screen user interface 9000 is displayed with an appearance selected according to the colorful appearance and in accordance with the light mode of device 100. For example, application icons 900, 902, 904, 906, 908, 910, 912, 914, 916, 918, 920, 922, 924, 926, 928, 930, 932, 934, and 936 (e.g., collectively referred to as application icons 900-936), and application widget 938 (e.g., collectively referred to as application user interface objects 900-938) are displayed with respective appearances 900a-938a (e.g., also referred to as light mode appearances) that have varied colors for foreground elements and varied colors for the background, as designed by the developers of the application (e.g., specified in metadata or configuration for the application user interface objects 900-938) and by designer(s) of the background 9002 of home screen user interface 9000. In some embodiments, the foreground elements include graphics, shapes, layers, and/or text of an application icon or a widget other than the background over which the foreground elements are displayed. In some embodiments, the applications corresponding to the application user interface objects 900-938 are designed and provided by various sources, and therefore, are not coordinated in terms of colors or palettes with respect to one another. For example, the background of the messages application represented by application icon 900, the background of the photos application represented by application icon 902, the background of the fitness application represented by application icon 928, and the background of the weather application represented by application icon 906 have different color, patterns, and/or color palettes. Similarly, the foreground elements of application icon 900 (e.g., the messages bubble), the foreground elements of application icon 902 (e.g., the colorful flower), the foreground elements of application icon 928 (e.g., colorful rings), and the foreground elements of application icon 906 (e.g., the cloud and the sun behind the cloud) have different color, patterns, and/or color palettes.

In some embodiments, if the background 9002 of home screen user interface 9000 is a picture, the picture is displayed without any automatic changes in color by the device 100, in accordance with a determination that the device 100 is in the light mode and the colorful appearance is selected. In some embodiments, background 9002 corresponds to a selected wallpaper (e.g., selected from a gallery of wallpapers of pictures).

FIG. 9B is a transition from FIG. 9A in accordance with a change of the state of the device 100 from light mode to dark mode that has occurred (e.g., automatically triggered, or manually triggered; and/or, before home screen user interface is displayed, or while the home screen user interface is displayed). In some embodiments, the change of state of the device is requested by a user. In some embodiments, the change of state of the device occurs automatically, in accordance with the detection of a change of state of various conditions, such as a change in time, location, ambient lighting conditions, and/or active focus mode. For example, the change in state from the light mode in FIG. 9A to dark mode in FIG. 9B occurs due to change in ambient lighting conditions, in accordance with some embodiments.

In response to the detection of a change of the state of the device 100 from light mode to dark mode, the device 100 changes background 9002 from a lighter appearance in FIG. 9A to a darker appearance illustrated in FIG. 9B. For example, while the patterns, shapes, and graphics of background 9002 are maintained, the colors are changed to a darker and restricted color palette, more appropriate for a dark mode of operation of device 100. Further, application user interface objects 900-938 are displayed with respective appearances 900b-938b (e.g., also referred to as dark mode appearances) that maintain the respective varied colors for the foreground elements (e.g., as selected by the application designers) of application user interface objects 900-938, but replace the background with a uniform dark color (e.g., optionally, selected from the same or similar darker and restricted palette as background 9002 of the home screen 9000). Accordingly, when the “colorful” icon configuration is selected, the color palette for the foreground element(s) of application user interface objects 900-938 is maintained even though the device switches from light mode in FIG. 9A to dark mode in FIG. 9B. Further, in the dark mode, appearances 900b-938b of application user interface objects 900-938 in FIG. 9B have a dark background (e.g., relative to appearances 900a-938a of application user interface objects 900-938 in the light mode in FIG. 9A).

In some embodiments, some application user interface objects have a color palette for the foreground elements that is dark (e.g., without the system applying any dark filters as in the dark mode). Applying a dark background color in the dark mode to such application user interface objects would cause the foreground element of the respective application user interface objects to become hard to distinguish (e.g., colors of the background and foreground may become too similar). Accordingly, in some embodiments, the device 100 uses the background color of such respective application user interface object in the light mode and applies it to the foreground element(s) of the respective application user interface object in the dark mode. Application icon 900 corresponding to the messages application, application icon 918 corresponding to a settings application, an application icon 908 for a music application are examples of such icons in which the background color in the light mode becomes the foreground color for the foreground elements in the dark mode. For example, the color of the messages bubble in the dark appearance 900b of application icon 900 (e.g., in FIG. 9B) has the same color as the background in the light appearance 900a of application icon 900 (e.g., in FIG. 9A).

In some embodiments, some application user interface objects, already have a dark color palette used for the background and a distinctive colorful palette for the foreground elements (e.g., without the system applying any dark filters as in the dark mode). In such scenarios, the color palette used for the background and the foreground elements remain the same even though the device switches from the light mode to dark mode. For example, color palette and appearances of application icon 916 corresponding to the phone application and application icon 928 corresponding to the fitness application remain unchanged even though the device switches from the light mode in FIG. 9A to the dark mode in FIG. 9B (e.g., appearances 916a and 916b of application icon 916 are the same in FIGS. 9A-9B, and appearances 928a and 928b of application icon 928 also remain the same in FIG. 9A-9B).

As illustrated in FIGS. 9A-9B, the same or analogous changes that are applied to application icons 900-936 are also applied to application widget 938, including change of the background while maintaining the colors for the foreground elements. Similarly, optionally, the same and/or analogous changes that are applied to application icons 900-928 in the user-arranged portion of home screen user interface 9000 (e.g., main portion of the home screen page) are also applied to the applications 930-936 in the dock area (e.g., for opening frequently accessed applications, and/or automatically suggested applications).

In some embodiments, while the colorful appearance is selected for the home screen user interface, the appearance of a respective user interface object is the same across different user interfaces (e.g., home screen user interface, notifications user interface, share sheet user interface, and/or settings user interface) on which the respective user interface object is displayed. For example, the respective user interface object will have the same “colorful” dark mode appearance or the same “colorful” light mode appearance across multiple user interfaces that the respective user interface object may be displayed, whereas, optionally, the device 100 does not replicate a tinted appearance for the respective user interface object across user interfaces other than the home screen user interface, when the tinted configuration is selected for the home screen user interface. FIGS. 9C-9D illustrate dark mode and light mode appearance of the same icon in a notifications banner, as described below.

FIG. 9C illustrates that the light mode appearance 900a of application icon 900 (e.g., corresponding to the messages application) that is displayed in home screen user interface 9002 in the light mode (e.g., shown in FIG. 9A) is also used for application icon 900 in a notification banner 9004 for the messages application, in accordance with a determination that the device is in the light mode of operation when the notification is displayed. Further, FIG. 9D illustrates that the dark mode appearance 900b of the same icon 900 that is displayed in home screen user interface 9002 in the dark mode (e.g., shown in FIG. 9B) is also used in a notification banner 9004 for the messages application, in accordance with a determination that the device 100 is in the dark mode of operation when the notification is displayed. However, a tinted appearance of icon 900, such as one displayed on home screen user interface 9000 with respect to FIGS. 9Q-9R (e.g., appearances 900f and 900g), would not appear in the notification banner 9004 in accordance with a determination that the tinted icon configuration is selected, as described in further detail below with reference to FIGS. 9S-9T.

In some embodiments, while a home screen user interface is in the reconfiguration mode (e.g., also referred to as an icon reconfiguration mode or “jiggle mode” in which application icons and/or widgets can be added, deleted, or rearranged by a user in the multi-page home screen user interface), the device 100 displays a control for initiating color reconfiguration process. FIGS. 9E-9N illustrate a color configuration process with respect to home screen user interface 9000 that is displayed in the reconfiguration mode.

FIG. 9E illustrates the home screen user interface 9000 in the reconfiguration mode, as visually illustrated by the tilted icons 900-928 and displayed delete affordances on or adjacent the icons 900-928 (e.g., for deleting the respective icons 900-928). In the reconfiguration mode, the device 100 displays control 9006 for activating a color editing user interface and, optionally, a control setting 5021 for hiding and unhiding applications icons labels (and, optionally, widget labels as well) (e.g., described in further detail with reference to FIGS. 5AO-5AP). FIG. 9E illustrates a tap input 9100 (e.g., performed by a contact, by an air gesture, or another type of selection input provided via another type of input interface) directed to control 9006 for activating a color editing user interface.

FIG. 9F is a transition from FIG. 9E in response to the detection of tap input 9100 directed to control 9006 for activating a color editing user interface. In response to the detection of tap input 9100, the device 100 displays color editing user interface 9008. In some embodiments, the color editing user interface 9008 is displayed concurrently with home screen user interface 9000. For example, the color editing user interface 9008 is partially overlaying home screen user interface 9000, such that a portion of home screen user interface 9000 and, at least some, of application user interface objects 900-928 and 938 are visible while color editing user interface 9008 is displayed. Displaying color editing user interface 9008 while also maintaining visibility of home screen user interface 9000, allows a user to preview any changes made to the appearance of home screen user interface via inputs directed to controls of the color editing user interface 9008 (e.g., thereby reducing the number of inputs and/or time needed to modify the appearance of home screen user interface 9000). In some embodiments, the same control 9006 is displayed in various system user interfaces, providing additional control to the user to modify the appearance of the home screen user interface from different user interfaces (e.g., lock screen, settings user interface, a control center, and/or other user interfaces other than the home screen user interface).

Concurrently with the color editing user interface 9008, the home screen user interface 9000 continues to be displayed in the icon reconfiguration mode. In some embodiments, application objects can be deleted or rearranged in home screen user interface 9000 while the device 100 maintains display of the color editing user interface 9008. For example, in FIG. 9F, while the color editing user interface 9008 is concurrently displayed with home screen user interface 9000 in the reconfiguration mode, a movement input 9102 that selects and drags application icon 9030 downward across the home screen user interface 9000, causes the device 100 to relocate application icon 9030 from the top row to a placement location indicated by an end of the arrow in FIG. 9E (e.g., the arrow illustrating a relocation path in accordance with movement input 9102). In some embodiments, an application widget can also be repositioned in response to a selection input followed by a drag input (e.g., a tap-hold and drag gesture, or an air pinch-hold and drag gesture, or another type of selection and drag input).

In FIG. 9F, color editing user interface 9008 includes various controls for editing the appearance of home screen user interface 9000. For example, color editing user interface 9008 includes a control 9020a for activating a system-selected appearance, a control 9020b for activating a light mode appearance, a control 9020c for activating a dark mode appearance, and control 9020d for selecting a tinted appearance. Control 9020a for activating a system-selected appearance, when selected, causes the device 100 to automatically change the color setting based on whether the device 100 is currently operating in light mode or in dark mode. For example, control 9020a, when selected, causes the device 100 to automatically switch between the light mode appearance or the dark mode appearance (e.g., dynamically switching between light mode appearances 900a-938a and dark mode appearances 900b-938b) in accordance with the currently active mode. In contrast, control 9020b for activating a light mode appearance, when selected, causes device 100 to apply the light mode appearance (e.g., appearances 900a-938a) to application user interface objects 900-938, regardless whether the device 100 is in the light mode or dark mode, and control 9020c for activating a dark mode appearance when selected, causes device 100 to apply the dark mode appearance (e.g., appearances 900b-938b) to application user interface objects 900-938, regardless whether the device 100 is in the light mode or dark mode. In FIG. 9F, control 9020b for activating a light mode appearance is highlighted relative to controls 9020a, 9020c, and 9020d to indicate the currently selected color setting of the home screen user interface is the light mode appearance.

FIG. 9G is a transition from FIG. 9F in response to the detection of input 9104 selecting control 9020c for activating a dark mode appearance. In response to the detection of input 9104 selecting control 9020c for activating the dark mode appearance, the device 100 displays the home screen user interface 9000 in the dark mode appearance (e.g., same as home screen user interface 9000 in the dark mode appearance in FIG. 9B). For example, in FIG. 9G, application user interface objects 900-9038 are displayed with dark mode appearances 900b-938b against the background 9002 with dark mode appearance. FIG. 9G illustrates that control 9020c for activating the dark mode appearance is highlighted relative to controls 9020a, 9020b, and 9020d to indicate that the currently selected color setting of the home screen user interface is the dark mode appearance.

FIG. 9H is a transition from FIG. 9G in response to the detection of input 9106 selecting control 9020d for activating a tinted mode appearance. In response to the detection of input 9106 selecting control 9020d for activating the tinted mode appearance, the device 100 displays application user interface objects 900-938 on home screen user interface 9000 with a tinted appearance 900c-938c, respectively. In some embodiments, the tinted appearance can be displayed in a dark mode and in a light mode, in accordance with determination that device 100 is in the light mode or the dark mode, respectively.

In FIG. 9H, the device 100 is in the dark mode state when the input 9106 selecting control 9020d for activating the tinted mode appearance was detected. Accordingly, tinted appearances 900c-983c are displayed against a dark background (e.g., same as in FIG. 9G). The color palette for the tinted appearances 900c-938c used for the foreground elements of the application user interface objects 900-938 is initially pre-selected by device 100 (e.g., based on colors in the background of home screen 9000, colors used in fonts on the lock screen, and/or based on previous user configuration). In addition to displaying application user interface objects 900-938 with the tinted appearance 900c-938c, respectively, in response to the detection of input 9106 selecting control 9020d for activating the tinted mode appearance, the device 100 displays slider control 9200 for changing the hue level of the currently selected tint color and slider control 9202 for changing the saturation level of the currently selected tint color. In some embodiments, a user can change the hue and saturation levels of the currently selected tint color in response to slide inputs directed at the slider controls 9200 and 9202, respectively.

For example, FIG. 9I is a transition from FIG. 9H in response to detecting a slide input 9108 directed to slider control 9200 for changing the hue level of the selected tint color. In response to the detection of slide input 9108 directed to slider control 9200 for changing the hue level of the selected tint color, the device 100 changes the hue of the tint color in application user interface objects 9030-938. For example, application user interface objects 9030-938 are displayed with tinted appearances 900c′-938c′ that corresponds to a lighter version of the same tint color used in the tinted appearances 900c-938c. Further, position of indicator of indicator 9108a for indicating the currently selected hue for the currently selected tint color (e.g., from blue to turquoise, from orange to peachy orange, or from one variation of a dominant or tertiary color to another variation of the same dominant or tertiary color) has changed in response to slide input 9108 (e.g., indicator 9108a is moved along the slider in response to slide input 9108), as illustrated in FIG. 9I relative to FIG. 9H. In some embodiments, in addition to changing the hue or saturation of a selected tint color, a user can change the tint color itself. For example, FIGS. 9J-9K illustrate customizing and changing the tint color (e.g., as opposed to the hue or saturation of the selected tint color) from one tint color to another.

In some embodiments, while previewing a color to be selected for the appearances of user interface objects, a dimming layer (e.g., a monochromatic unobstructive color) can be added below the application user interface objects 900-938 to make the selected color(s) in the application user interface objects 900-938 stand out, thereby assisting a user in the selection of a color for the application user interface objects 900-938, as illustrated with reference to FIG. 9J below.

FIG. 9J is a transition from FIG. 9I in response to the detection of input 9114 selecting control 9010 for adding a dimming layer. In response to the detection of input 9114 selecting control 9010 for adding a dimming layer, the device 100 displays a dimming layer 9014 on top of background 9002, substantially (e.g., but optionally not completely) obscuring background 9002 of home screen user interface 9000, as shown in FIG. 9J. In FIG. 9J, application user interface objects 900-938 are displayed with the same tinted appearances 900c′-938c′ with dimming layer 9014 underlying application user interface objects 900-938. In some embodiments, dimming layer 9014 is at least to some degree translucent and revealing some visual characteristics of the background 9002 underlying the dimming layer 9014. In some embodiments, while application user interface objects 900-938 are displayed against a background of the dimming layer 914, the color editing user interface 9008 remains displayed, and a user can preview other colors with various hues and/or saturations (e.g., selected via controls in the color editing user interface 9008) against the dimming layer 914 without navigating away from the color editing user interface 9008. Further, in FIG. 9J, the device 100 detects an input 9112 selecting control 9012 for picking a tint color.

FIG. 9K is a transition from FIG. 9J in response to the detection of input 9112 selecting control 9012 for picking a tint color. In response to the detection of input 9112 selecting control 9012 for picking a tint color, the device 100 ceases the display of home screen user interface 9000 and displays background 9002 of home screen user interface (e.g., in the light mode displayed in FIG. 9A). In some embodiments, a user can pick a tint color from the colors or color palette used in the background 9002 by moving or directing a color picker 9310 over respective portions in the background 9002. FIG. 9K illustrates various locations 9310a, 9310b, 9310c, and 9310d in the background 9002 at which the color picker 9310 can be directed to. In some embodiments, in response to detecting a selection input while color picker 9310 is directed at a respective location in the background 9002, the device changes the tint color in accordance with the color of the background 9002 in the target location, as described further below with reference to FIG. 9L.

In some embodiments, in conjunction with displaying background 9002 of home screen user interface and color picker 9310, in response to the detection of input 9112 selecting control 9012 for picking a tint color, the device 100 optionally displays color editing user interface 9008a with color pots 9300, 9302, 9304, and 9306 representing different tint colors that can be selected. In some embodiments, displaying such color editing user interface 9008a is optional. In some embodiments, color pots 9300, 9302, 9304, and 9306 represent various preconfigured tint colors that can be selected. In some embodiments, color editing user interface 9008a can be scrolled to reveal additional color pots previously undisplayed in color editing user interface 9008a. In some embodiments, color pots 9300, 9302, 9304, and 9306 correspond to colors selected from the background 9002 of the home screen user interface. For example, color pot 9300 corresponds to a color selected from the color of background 9002 in location 9310d; color pot 9302 corresponds to a color selected from the color of background 9002 in location 9310a; color pot 9304 corresponds to a color selected from the color of background 9002 in location 9310b; and color pot 9306 corresponds to a color selected from the color of background 9002 in location 9310. In some embodiments, a user can pick a color from the background in response to selecting one of the color pots 9300, 9302, 9304, and 9306 that corresponds to tint colors selected from the background 9002. In some embodiments, the saturation of a selected tint color can be adjusted using slider control 9202a (e.g., same as slider control 9202 in FIG. 9I).

FIG. 9L is a transition from FIG. 9K in response to detecting a selection input (e.g., a tap input, a tap and hold, a press input, a double tap input, and/or other selection input) while color picker 9310 is directed at location 9310a in the background 9002. In response to the detection of the selection input while color picker 9310 is directed at location 9310a in the background 9002, the device changes the tint color applied to the foreground elements of application user interface objects 900-938 from using a tint color used in tinted appearances 900c′-9038c′ in FIG. 9J (e.g., before the detection of input 9112 selecting control 9012 for picking a tint color) to using a different tint color in tinted appearances 900d-938d. The same tint color is applied to application user interface objects 900-938, resulting in an overall tinted “monochromatic” look of application user interface objects 900-938 on the home screen user interface.

In some embodiments, a selection input 9116 directed at color pot 9302 corresponding to a color selected from the color of background 9002 in location 9310a also would cause the device to change the tint color applied to the foreground elements of application user interface objects 900-938 to the tint color in tinted appearances 900d-938d (e.g., in addition to, or as an alternative to, using the selection input while color picker 9310 is directed at location 9310a in the background 9002).

In some embodiments, in addition to changing the appearances of user interface objects with respect to the color configuration (e.g., tinted configuration, light mode configuration, dark mode configuration, and/or customized tint colors with various hues and saturations) in response to inputs directed at the color editing user interface 9008, the size of the application user interface objects 930-938 can be modified using size controls 9040 (e.g., as shown in FIG. 9M) for changing the size of application user interface objects to a small size and 9042 (e.g., as shown in FIG. 9M) for changing the size of respective application user interface objects to a large size, as illustrated with respect to FIGS. 9M-9N and described in more details below.

FIG. 9M illustrates application user interface objects 900-928 displayed with the same appearance and size as displayed in FIG. 9I. Color editing user interface 9008 further displays controls 9040 for changing the size of application user interface objects to a small size and 9042 for changing the size of respective application user interface objects to a large size. In home screen user interface 9000 in FIG. 9M, the currently selected size of application user interface objects 930-938 corresponds to the small size, as indicated by the highlighted appearance of control 9040 relative to control 9042. Application icons 900-928 all have the same size (e.g., corresponding to a placement unit size), as described in more detail with reference to FIGS. 6A-6AX. In FIG. 9M, a selection input 930 directed at size control 9042 for changing the size of respective application user interface objects to a large size.

FIG. 9N is a transition from FIG. 9M in response to the detection of selection input 930 directed at size control 9042 for changing the size of respective application user interface objects to a large size. In response to input 930, the device 100 enlarges, uniformly, application icons 900-928. Optionally, the device 100 also enlarges application widget 938. In some embodiments, the application icons 900-928 are similarly enlarged as application icons 5002-5024 in FIGS. 5AP-5AO in response to and/or in accordance with a determination that a setting for hiding the labels is enabled.

As described above, a uniform tint configuration for multiple user interface objects on the home screen is applied in response to selecting “tinted” icon configuration, irrespective of whether the device is in the light mode or dark mode. For example, FIGS. 9O-9P display application user interface objects 900-938 with the same tinted appearance 900e-938e (e.g., tinted foreground elements and darkened background of the application user interface objects 900-938) even though in FIG. 9O, the device 100 is in the dark mode and in FIG. 9P the device 100 is in the light mode. One difference in home screen user interface 9000 between FIGS. 90 and 9P is the darkened background 9002 of home screen user interface 9000 in FIG. 9O in accordance with a determination that the device 100 is in the dark mode. Optionally, in the dark mode, the device applies the same tint color as the one applied to the application user interface objects 900-938 to the background as well (e.g., in addition to darkening the background 9002). Another difference between FIG. 9O displaying home screen user interface 9000 in the dark mode and FIG. 9P displaying home screen user interface 9000 in the light mode, is that even though the tint color applied to the foreground elements of application user interface objects 900-938, the hue, brightness, and/or saturation of the selected tint color configuration is darker in FIG. 9O relative to FIG. 9P.

While application widgets are applied the same tint color as application icons in accordance with a determination that the “tinted” icon configuration is selected, some foreground elements of application widgets can be displayed with an additional color that is different from the tint color applied to the application icons (e.g., because widgets have more elements and content relative to application icons), as described in more detail below with reference to FIGS. 9Q-9R.

FIG. 9Q illustrates home screen user interface 9000 that displays application user interface objects 900-938 with a first tint color applied uniformly to application user interface objects 900-938 (e.g., applied to the foreground elements of application user interface objects 900-938), in accordance with a selected tint configuration. For example, application user interface objects 900-936 in FIG. 9Q have the tinted appearance 900f-936f. Application widget 938 is also applied the same first tint color to some of the foreground elements, however, the foreground element corresponding to the date (e.g., “Sunday 8”) is displayed with an additional color, different from the first color. Similarly, FIG. 9R illustrates application user interface objects 900-936 with a second tint color applied uniformly to application user interface objects 900-930 corresponding to tinted appearance 900g-936g (e.g., applied to the foreground elements of application user interface objects 900-936), in accordance with a selected tint configuration, however, the foreground element corresponding to the date (e.g., “Sunday 8”) is displayed with an additional color, different from the second color. Accordingly, FIGS. 9Q-9R illustrate two different tint color configurations applied to the same application user interface objects 900-936 and displayed on home screen user interface 9000 while the device 100 is in the dark mode. In some embodiments, because of the dark mode configuration, background 9002 is displayed darkened in FIGS. 9Q-9R (e.g., same as in FIG. 9B), and optionally the selected first or second tint color applied to the application user interface objects 900-936 is also applied to the background 9002 in the dark mode (e.g., but would not be applied to the background 9002 in the light mode).

In some embodiments, while application icons 900-936 in home screen user interface 9000 in FIG. 9R have the same tint color (e.g., the second tint color) for the foreground elements, some foreground elements may have a different brightness, hue, or translucency relative to other foreground elements. For example, icons 906, 908, 916, 920, and 922 have foreground elements with the same tint color as other icons on the home screen 9000, but in addition, some foreground elements are brighter. For example, the sun in icon 906, the triangle in icon 908, the phone in icon 916, the star in icon 920, and the drop in icon 922, are different in terms brightness, hue, and/or translucency, as compared to other internal foreground elements and the foreground elements of other icons.

As described above, a dark mode appearance or a light mode appearance of a user interface objects is displayed on user interfaces other than the home screen user interface (e.g., as illustrated in FIGS. 9C-9D), whereas the device 100 does not display a tinted appearance that is selected in accordance with a tinted configuration across user interfaces other than the home screen user interface, as described below with reference to FIGS. 9S-9T.

FIG. 9S displays application user interface objects 900-938 in the home screen user interface 9000 with the same first tinted appearance as illustrated in FIG. 9Q, and FIG. 9T displays application user interface objects 900-938 in the home screen user interface 9000 with the same second tinted appearance as illustrated in FIG. 9R. FIGS. 9S-9T illustrate that the same dark mode appearance 900b for icon 900 is displayed in notification banner 9004, in accordance with a determination that the device 100 is in the dark mode of operation when the notification is displayed, even though the first tinted configuration is applied to application user interface objects 900-938 in FIG. 9S (e.g., appearances 900f-938f) and even though the second tinted configuration is applied to application user interface objects 900-930 in FIG. 9T (e.g., appearances 900g-938g).

In some embodiments, control 9020a for activating a system-selected appearance (e.g., displayed in color editing user interface 9008 in FIG. 9F), optionally, when selected, causes the device 100 to apply, uniformly to user interface objects on the home screen user interface, a system-selected color (e.g., or color palette) that is based on, and changes dynamically, according to a color scheme of a system background or wallpaper of the homes screen user interface.

FIGS. 9U-9V illustrate that, in accordance with a determination that control 9020a for activating a system-selected appearance is selected (e.g., selected in FIG. 9F, or elsewhere) and in accordance with a determination that the background 9002 changes to background 9003 (e.g., different graphics and/or color palette), the device 100 automatically changes the tinted appearance of application user interface objects 900-938 in accordance with or based on a color scheme or palette used in background 9003.

In some embodiments, a selected tint color configuration for application user interface objects 900-938 can change dynamically and automatically, in accordance with a determination that, a change in configuration of appearance for other elements (e.g., a color choice for a system font, such as a color choice of text selected for a wake screen date/time) has occurred. For example, if a tint color configuration is selected for application user interface objects 900-938, and a font color for user interface elements on the lock screen or wake screen user interface is changed (e.g., manually in response to user inputs, or automatically in response to other conditions being met), the device 100 automatically applies the color of the font used for user interface elements on the lock screen or wake screen as a tint color for application user interface objects 900-938 on the home screen user interface 9000.

FIG. 9W illustrates a lock screen 9005 or wake screen user interface, with a selected font color for the date and time and other user interface elements on the lock screen or wake screen user interface, in accordance with some embodiments.

In some embodiments, when displaying the home screen user interface 9000 in FIG. 9X in response to a user request, and/or while the home screen user interface 9000 is currently displayed, the computer system determines whether the computer system is operating in the light mode or the dark mode (optionally, making a transition between the light mode and the dark mode, if conditions for transitioning between the light mode and the dark mode are met), and chooses the appearance of the icons on the home screen user interface according to whether the computer system is operating in the light mode or the dark mode and whether the “colorful” icon configuration or the “tinted” icon configuration is selected for the home screen icons (e.g., application icons and/or widgets). Further, optionally, in accordance with a determination that the “tinted” icon configuration is selected and that a change of font has occurred, the device displays the color of the font used for user interface elements on the lock screen as a tint color for application user interface objects 900-938. For example, FIG. 9X illustrates that the font color selected for the user interface elements on the lock screen is applied as a tint color to application user interface objects 900-938 on home screen user interface 9000, in accordance with a determination that the computer system is operating in the light mode and that the “tinted” icon configuration mode is selected.

In some embodiments, in addition to the light and dark mode, other modes of operation of device 100 can cause changes to the appearance of application user interface objects 900-938 on home screen user interface 9000 to change. Different operation modes may be customized to display user interface objects with dark or light appearances. Example of such different modes are illustrated in system user interface 9005a for selecting a mode of operation of the device 100, as described in FIGS. 9Y-9Z.

FIG. 9Y illustrates a lock screen or wake screen user interface 9005, with a currently selected mode of operation (e.g., a focus mode that affects notification delivery, lock and unlocking restrictions, and/or other aspects of the device operation) corresponding to the “Do Not Disturb” mode of operation, as illustrated with user interface element 9017.

FIG. 9Z is a transition from FIG. 9Y in response to a selection input 9019 directed to user interface element 9017 displayed on lock screen or wake screen user interface 9005 in FIG. 9Y. In response to selection input 9019 directed to user interface element 9017, the device 100 displays system user interface 9005a for selecting a mode of operation of the device 100 (e.g., selecting a focus mode from a plurality of available focus modes, and/or adding and customizing a new focus mode). System user interface 9005a includes different modes of operation, including mode 9007 corresponding to the currently selected “Do Not Disturb” mode of operation, mode 9009 corresponding to “Home” mode of operation, mode 9011 corresponding to “Work” mode of operation, and mode 9013 corresponding to “Sleep” mode of operation. The illustrated modes 9007, 9009, 9011, 9013, and 9015 are examples and other modes can be configured and added, or some modes can be deleted. In some embodiments, in accordance with selecting a mode from modes 9007, 9009, 9011, 9013, and 9015, the device 100 transitions to the selected mode and, optionally, changes the appearances of application user interfaces objects 900-938, according to the mode in which the device is operating and whether the “colorful” icon configuration or the “tinted” icon configuration is selected for the home screen icons (e.g., application icons and/or widgets). In some embodiments, the change in appearance of the application user interface objects 900-938 is based on the wallpaper, system fonts, color scheme, time and date, and/or other aspects of the selected mode of operation.

In some embodiments, some foreground elements of application user interfaces objects are primary elements while others are secondary elements. In some embodiments, the primary elements of the respective user interface objects are elements in the top layer and/or higher layers of the respective user interface object, and the secondary elements of the respective user interface objects are elements in the bottom layer and/or lower layers of the respective user interface object. In some embodiments, the primary elements of the respective user interface objects are elements in the central region of the respective user interface object, and the secondary elements of the respective user interface objects are elements in the peripheral region of the respective user interface object. In some embodiments, the device 100 displays the primary elements with a hue that is brighter than the hue for the secondary elements.

FIG. 9AA illustrates application icon 906 corresponding to the weather application in the “colorful” icon configuration in with dark mode appearance 9061′ and light mode appearance 9061″. Further, application icon 906 is displayed in a first “tinted” icon configuration with a dark mode appearance 9062′ and light mode appearance 9062″, and application icon 906 is displayed in a second “tinted” icon configuration with a dark mode appearance 9063′ and light mode appearance 9063″. For example, top row displays application icon 906 with a “colorful” icon configuration and two different “tinted” icon configurations while the device 100 is operating in the dark mode, and bottom row displays application icon 906 with the same “colorful” icon configuration and the two different “tinted” icon configurations while the device 100 is operating in the light mode. As illustrated, the foreground element of icon 906 corresponding to the sun is lighter or brighter than the rest of the foreground elements regardless of whether a “colorful” icon configuration and a “tinted” icon configuration is selected, and regardless of whether the device 100 is operating in the light mode vs dark mode.

FIG. 9AB illustrates application icon 9050 with a “colorful” icon configuration (e.g., appearance 9071′) and two different “tint” icon configurations (e.g., appearances 9072′ and 9073′) while the device 100 is operating in the dark mode; and bottom row displays application icon 9050 with the same “colorful” icon configuration (e.g., appearance 9071″) and the same two “tint” icon configurations but while the device 100 is operating in the light mode. For example, appearance 9072″ corresponds to appearance 9072′ and appearance 9073″ corresponds to appearance 9073′ (e.g., because, optionally, the tinted appearances of the icons are maintained when the device changes mode of operation from the light mode to the dark mode). Similar to FIG. 9AA, the foreground element of icon 9050 corresponding to the circle that encapsulates the start is a primary element that is lighter or brighter relative to the rest of the foreground elements regardless of whether a “colorful” icon configuration and a “tint” icon configuration is selected, and regardless of whether the device 100 is operating in the light mode vs dark mode.

FIGS. 10A-10J are flow diagrams of an exemplary method 10000 for transforming an application object from one type to another without navigating away from a currently displayed user interface (e.g., directly from a home screen user interface) and reconfiguring the home screen user interface. In some embodiments, the method 10000 is performed at a computer system that is in communication one or more display devices and one or more input devices (e.g., including one or more sensors for detecting user inputs). In some embodiments, the method 10000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 10000 are, optionally, combined and/or the order of some operations is, optionally, changed.

As described herein, the method 10000 provides an improved input mechanism for reconfiguring a home screen user interface by adding different types of application objects of a respective application to a home user interface. Instead of navigating through various user interfaces and/or menu options, an application object of a first type (e.g., a widget) is added to the home screen user interface by transforming an application object of a second type (e.g., an application icon or a different type of widget) that has already been placed on the home user interface and is associated with the respective application. For example, an input directed to an application icon causes display of a contextual menu (e.g., a quick action menu) that includes options that, when selected, transform, replace, or convert the application icon into a widget of a select type. In another example, a widget can be transformed into an application icon by selecting an option in a contextual menu associated with the widget (e.g., similar to the contextual menu associated with the application icon but optionally including option(s) that are specific to widgets). Transforming or replacing an application object of a first type into an application object of a second type by selecting an option in a contextual menu associated with the application object that is being transformed or replaced, reduces the number of inputs and time needed to reconfigure a home user interface (e.g., add to a home user interface different types of application objects for a respective application.

In the method 10000, the computer system displays (10002), via the one or more display devices, a home screen user interface (e.g., a page of a multipage home screen user interface, or a single page home screen user interface, and/or a user-configured home screen user interface), wherein the home screen user interface includes a plurality of user interface objects (e.g., application icons and/or widgets) corresponding to a plurality of different applications. In some embodiments, a widget refers to a mini application object that provides access to a subset of content and user interface objects of an application, without launching, opening, and/or displaying the application. In some embodiments, a widget is displayed in one or more user interfaces other than a user interface of the application that provides the content of the widget. In some embodiments, when a widget is included in a user interface other than a user interface of the application that is associated with the widget, the content of a widget is updated by the operating system from time to time based on updates to the application content (e.g., updates received from the application, updates received from another application that communicates with the operating system regarding the application), even though the application is not currently displayed with the widget (e.g., the application may be running in a background process, or not running at all). In some embodiments, a widget includes user interface objects that, when selected, perform a subset of operations and provide a subset of functions of the application, without launching and/or displaying the application itself. In some embodiments, an application that has associated widgets can have different widgets that include different subset of content and/or provide different subsets of functionality of the application, and widgets of different sizes and/or dimensionality (e.g., a size that is based on a size of a placement location that can also accommodate a number of rows and columns of application icons).

In the method 10000, the computer system detects (10004), via the one or more input devices, a first input directed to a first user interface object of the plurality of user interface objects (e.g., a touch input at a location that corresponds to the location of the first user interface object, a pointing gesture that is pointed toward the location of the first user interface object, an air gesture at a location of the first user interface object, or another type of input that is directed to a location of the first user interface object).

In response to detecting the first input directed to the first user interface object of the plurality of user interface objects (10006), in accordance with a determination that the first input meets first criteria, wherein the first criteria require that the first input meets a first input threshold (e.g., a duration threshold and/or an intensity threshold) with less than a threshold amount of movement (e.g., the first input is substantially stationary (e.g., includes less than a threshold amount of movement) before or until meeting the first input threshold) in order for the first input to meet the first criteria, the computer system displays (10008), concurrently with the first user interface object (e.g., while the home screen user interface remains displayed unchanged or deemphasized in the background of the first user interface object, and/or without navigating away from the home screen user interface to a settings or configuration user interface corresponding to the first user interface object), two or more configuration options corresponding to the first user interface object, including a first configuration option that, when selected (e.g., selected by a tap input by a contact at a location corresponding to the first configuration option, an air tap gesture at a location corresponding to the first configuration option, an air pinch gesture detected in conjunction with a gaze input directed to the first configuration option, or another type of selection input that targets the first user interface object, and/or an input that does not meet the first input threshold), causes a first change in configuration of the first user interface object in the home screen user interface, and a second selectable option that, when selected (e.g., selected by a tap input by a contact at a location corresponding to the second configuration option, an air tap gesture at a location corresponding to the second configuration option, an air pinch gesture detected in conjunction with a gaze input directed to the second configuration option, or another type of selection input that targets the second configuration option, and/or an input that does not meet the first input threshold), causes a second change in configuration of the first user interface object in the home screen user interface, wherein the second change in configuration is different from the first change in configuration. FIGS. 5B-5G illustrate an example technique and user interfaces for transforming an application icon 5018 into an application widget 5018a via an in-line editing user interface 5200 displayed in a home screen user interface (e.g., a currently displayed user interface in which the application icon is displayed and in which the application widget will be displayed). In some embodiments, the two or more configuration options are displayed in a menu (e.g., a contextual menu or a quick-action menu) associated with the first user interface object. In some embodiments, while the menu including the first selectable option and the second selectable option is displayed, other user interface objects on the home screen user interface, including the first user interface object, are visible (e.g., optionally visually deemphasized). In some embodiments, in addition to the first selectable option and the second selectable option, the menu includes one or more selectable options that are associated with the application of the first user interface object, including an option that corresponds to a frequently performed operation of the application (e.g., the frequently performed operation can be performed without opening the application when the option is selected), an option for sharing the application via one or more communication applications, and/or an option for rearranging the home screen user interface (e.g., an option to edit the home screen user interface). In some embodiments, the menu is dismissed in response to a tap or other gesture directed to a location outside of the menu. In some embodiments, the first user interface object is an application icon of a first application (e.g., for launching, opening, starting, or otherwise bringing a user interface of the application to a foreground), and the two or more configuration options include one or more selectable options for replacing the application icon with (and/or transforming the application icon into) a widget of the same first application, including for example, a first selectable option that, when selected, causes the application icon to be replaced with and/or converted into a widget of a first size and/or including first widget content of the first application; and a second selectable option that, when selected, causes the application icon to be replaced with and/or converted into a widget of a second size and/or include second widget content of the first application. In some embodiments, the first user interface object is a widget of a first application, and the two or more configuration options include at least one selectable option for replacing the widget with (and/or transforming the widget into) another widget of the same first application, including for example, a third selectable option that, when selected, causes the widget to be replaced with another widget of a different size and/or including different widget content of the first application. In some embodiments, the first user interface object is a widget of a first application, and the two or more configuration options include a selectable option for replacing the widget with (and/or transforming the widget into) an application icon of the same first application, including for example, a fourth selectable option that, when selected, causes the widget to be replaced with and/or converted into an application icon that is smaller in size and includes less content from the first application. In response to detecting the first input directed to the first user interface object of the plurality of user interface objects (10006), in accordance with a determination that the first input meets second criteria (e.g., and does not meet the first criteria), wherein the second criteria require that the first input does not meet with the first input threshold with less than the threshold amount of movement (e.g., at the time that the termination of the first input is detected, the first input included more than a threshold amount of movement and/or the first input did not meet the first input threshold before termination of the first input), in order for the first input to meet the second criteria (e.g., the first input is a tap input directed to the first user interface object, the first input is a pinch and release input directed to the first user interface object, an air gesture at the location of the first user interface object, or the first input is another selection input that is directed to the first user interface object), the computer system performs (10010) a first operation associated with the first user interface object (e.g., expanding the first user interface object to display more information, activating or toggling a control associated with the first user interface object, navigating away from the home screen user interface and displaying an application user interface corresponding to the application of the first user interface object, or performing another operation that is triggered by the selection of the first user interface object). In some embodiments, an input that meets the second criteria launches or opens a user interface of a respective application when the input that meets the second criteria is directed to a widget associated with the respective application and when the input is directed to an application icon associated with the respective application. For example, a tap input on both an application icon and a widget associated with the same application causes the computer system to open the application and display a respective user interface of the application.

In some embodiments, the first change in configuration includes (10012) a change in object type of the first user interface object (e.g., from application icon to widget, or vice versa). The method 10000 includes: while displaying, concurrently with the first user interface object, the first configuration option and the second configuration option the computer system detects, via the one or more input devices, selection of the first configuration option (without detecting selection of the second configuration option and/or other configuration options); and in response to the detecting the selection of the first configuration option, the computer system changes a respective object type of the first user interface object from a first object type to a second object type (e.g., from widget to application icon) or from the second object type to the first object type (e.g., from application icon to widget). For example, in FIG. 5D, the in-line editing user interface 5200 includes selectable configuration options 5202, 5204, 5206, and 5208 for transforming a selected application icon (or another selected application object) into a different type of application object (e.g., an application icon into an application widget, an application widget into an application icon, one type of widget into another type of widget, or from a widget of one size to a widget of another size). Configuration option 5202, when selected, causes the computer system to transform a currently selected object (e.g., an application widget) into an application icon. Configuration option 5204, when selected, causes the computer system to transform a currently selected object (e.g., an application widget or an application icon) into a “small” application widget. Configuration option 5206, when selected, causes the computer system to transform a currently selected object (e.g., an application widget or an application icon) into a “medium” application widget. Configuration option 5208, when selected, causes the computer system to transform a currently selected object (e.g., an application widget or an application icon) into a “large” application widget. In some embodiments, a respective object type, such as the widget type, includes widget of different sets of dimensions, widgets of different types of content from the application associated with the widget, and/or widget with different content configured in accordance with different sets of configuration parameters (e.g., location, update schedule, subject matter, and/or other configurable parameters for the widget). In some embodiments, changing the respective object type of the first user interface object from the first object type to the second object type or from the second object type to the first object type includes replacing the representation of the first user interface object with a different representation (e.g., ceasing display of a current representation of the first user interface object, and displaying another representation of the first user interface object at the same location, such as ceasing display of an application icon representation and displaying a widget representation at the same location, or vice versa) or transforming the appearance of the first user interface object from one representation to another representation (e.g., from an application icon representation to a widget representation, or vice versa) in response to detecting the selection of the first configuration option. Transforming or replacing an application icon into an application widget, an application widget into an application, or one type of widget into another type of widget by selecting an option in a contextual menu associated with the application object that is being transformed or replaced, reduces the number of inputs and the time needed to reconfigure to a home user interface with application objects of different types.

In some embodiments, changing the respective object type of the first user interface object includes (10014), in accordance with the first user interface object being a respective application icon of a first application (e.g., the first configuration option shows a representation of the respective widget of the first application, such as a widget of a first size, or another size, and/or a widget containing first application content or second application content from the first application), replacing display of the respective application icon of the first application with a respective widget of the first application in the home screen user interface (e.g., ceasing display of the respective application icon and displaying the respective widget at the same location, or transforming the respective application icon into the respective widget). For example, FIGS. 5E-5G illustrate transforming application icon 5018, corresponding to the calendar application, into small widget 5018a, also corresponding to the calendar application, via the in-line editing user interface 5200 without navigating away from home screen page 5003. In some embodiments, a respective application icon and a respective widget of the same application differ in one or more aspects, such as size, the amount and/or type of content included in the respective application icon and the respective widget, response to a respective type of user input, functionality, and/or appearance. In some embodiments, application icons have a fixed size that is a minimum size of a representation of an application on the home screen user interface and that is uniform across the application icons of different applications on the home screen user interface, while a widget can have a number of different sizes that are all larger than the size of an application icon. In some embodiments, the size of a widget can be measured in multiple rows and columns of the size of an application icon. For example, a widget can be a two-by-two widget, which means it occupies a placement location on the home screen user interface that can also accommodate a group of two row by two column of application icons. In another example, a widget can be a one by four widget, with a size that can displace a single row of four application icons on the home screen user interface. In yet another example, a four-by-four widget has a size that is equivalent to a total size of a four row by four column arrangement or array of application icons on the home screen user interface. In some embodiments, the size of a widget is defined by a size of a placement location for the widget, and the size of the placement location is specified by a width and a height that are integer numbers of placement locations used to accommodate individual application icons. In some embodiments, the size of a widget is freely defined by the application and are not necessarily based on grid size of the home screen, e.g., when the placement of widgets and application icons are not restricted to a fixed grid with fixed spacings. In some embodiments, the content represented in an application icon of an application is limited and relatively static, while the content of a widget of the same application is richer and more dynamic. For example, in some embodiments, the application icon for a weather application includes a static image to identify the weather application relative to other applications represented on the home screen user interface, and the static image remains substantially unchanged over time so that it is recognizable by a user trying to locate the application icon and launch the weather application. In contrast, a widget of the weather application includes graphics (e.g., rainy, cloudy, sunny, snowy, and/or windy, night, day, and/or other weather graphics) and text (e.g., temperature, pressure, wind speed, location name, and/or other weather data) that change dynamically from time to time (e.g., automatically, without requiring user input to request the updated information) based on actual weather information of the real world that is automatically retrieved from the weather application (e.g., including weather information retrieved by the weather application from a server of weather information). In some embodiments, although the application icon may include some animated graphics that convey some limited information about the status of a corresponding application (e.g., an animated progress indicator to show updating and/or downloading of the application software, an animated clock for a clock application, or other canned or fixed animation that does not rely on dynamic updates from the application), as described herein with respect to FIGS. 5AS-5AT, the content of the widget includes changes that are based on real-time updates, and changes that are not fixed or known until the information become available in the application (e.g., fitness data from actual movement of the user, weather information, sports score, news, stock market data, and/or other real-time updates from applications). In some embodiments, an application is associated with a single application icon, but multiple widgets of different sizes and different types of content can be associated with the application. In some embodiments, an application icon of an application does not have internal user interface objects that trigger different operations, while a widget of an application may have internal user interface objects, such as buttons, slider controls, and/or other controls, that respond to user inputs individually, and cause the computer system to perform different operations of the application. In some embodiments, an application icon of an application cannot be further configured as an application icon (e.g., the application icon is substantially fixed in appearance and function) on the home screen user interface, while a widget of the application can be configured as a widget to include different content and/or change its update triggers and update frequencies on the home screen user interface. In some embodiments, application icons are used for launching or opening the associated application; while widgets are used to display or provide content and/or specific functionality that is otherwise available in the associated application, without the need to open and display a user interface of the associated application. Accordingly, widgets reduce the need for opening an application, thereby reducing the number of interactions with application icons. In some embodiments, a user interface of a respective application can be opened in the same manner in response to a selection input directed to either an application icon or a widget. Transforming an application icon into a widget in the home user interface by selecting an option in a contextual menu associated with the application icon, reduces the number of inputs and time needed to reconfigure and customize the home user interface (e.g., add an application widget and/or remove an application icon for a respective application).

In some embodiments, changing the respective object type of the first user interface object includes (10016), in accordance with the first user interface object being the respective widget of the first application (e.g., the first configuration option shows a representation of the respective application icon of the first application), replacing display of the respective widget of the first application with the respective application icon of the first application in the home screen user interface (e.g., ceasing display of the respective widget and displaying the respective application icon at the same location, or transforming the respective widget into the respective application icon). For example, in FIG. 5D, configuration option 5202, when selected, causes the computer system to transform a currently selected object (e.g., an application widget) into an application icon. Transforming an application widget into an application icon in the home user interface by selecting an option in a contextual menu associated with the application widget, reduces the number of inputs and time needed to reconfigure and customize the home user interface (e.g., add an application icon and/or remove a widget for a respective application).

In some embodiments, the second change in configuration includes (10018) a change in object dimension of the first user interface object (e.g., from a first set of dimensions to a second set of dimensions, a third set of dimensions, or vice versa). In the method 10000, while displaying, concurrently with the first user interface object, the first configuration option and the second configuration option, the computer system detects, via the one or more input devices, selection of the second configuration option (without detecting selection of the first configuration option and/or other configuration options); and in response to detecting the selection of the second configuration option, the computer system changes (e.g., without navigating away from the currently displayed user interface) a respective set of dimensions of the first user interface object from a first set of dimensions to a second set of dimensions different from the first set of dimensions (e.g., from a 1×2 widget to a 2×2 widget, from a 2×2 widget to a 2×4 widget, from a 2×2 widget to a 4×4 widget, from 1×2 widget to a 2×4 widget, from a 1×2 widget to a 4×4 widget, or vice versa). For example, in FIG. 5D, the in-line editing user interface 5200 includes configuration option 5204, when selected, causes the computer system to transform a currently selected object (e.g., an application widget or an application icon) into a “small” application widget. Configuration option 5206, when selected, causes the computer system to transform a currently selected object (e.g., an application widget or an application icon) into a “medium” application widget. Configuration option 5208, when selected, causes the computer system to transform a currently selected object (e.g., an application widget or an application icon) into a “large” application widget. In some embodiments, the size of a widget is specified in terms of the size of a placement location used to accommodate the widget of that size, and the size of a placement location is specified in terms of the grid size of the home screen user interface (e.g., the home user interface has a grid of placement slots, where a size of a respective placement slot can accommodate a single application icon, and a placement location for a widget is specified by a number of rows and columns of the placement slots in the grid). In some embodiments, the grid size of the home screen user interface is the size of the placement location for a single application icon. As such, the size of a single application icon is one-by-one, indicating that it is accommodated by a region of one row by one column in the grid of the home screen user interface. Similarly, a widget with a one-by-two size is accommodated by a placement location that is one row by two columns in the grid of the home screen user interface. A widget of two-by-two size is accommodated by a placement location that is two rows by two columns in the grid of the home screen user interface. A widget of two-by-four size is accommodated by a placement location that is two rows by four columns in the grid of the home screen user interface. In some embodiments, the change in object dimension from “1×1” to another set of dimensions (e.g., 1×2, 2×2, or other sets of dimensions) is equivalent to a change in object type from “application icon” to “widget” of a respective size, and share the same selectable configuration option in the user interface. Similarly, in some embodiments, the change in object dimension from a set of larger dimensions (e.g., 1×2, 2×2, or other sets of dimensions) to “1×1” is equivalent to a change in object type from “widget” of a respective size to “application icon” and share the same selectable configuration option in the user interface. In some embodiments, transforming or replacing an application object of a first type into an application object of a second type includes changing size and/or dimensions of the application object that is being transformed or replaced. Changing size and/or dimensions of an application object on a home user interface by selecting an option in a contextual menu associated with the application object that is being transformed, reduces the number of inputs and time needed to reconfigure and customize the home user interface.

In some embodiments, the two or more configuration options corresponding to the first user interface object includes (10020) a third configuration option that, when selected, causes a third change in configuration of the first user interface object (e.g., a change in widget content, and/or other types of changes other than the dimensions of the widget), wherein the third change in configuration of the first user interface object includes a change in a respective set of parameters (e.g., location, update schedule, update triggers, update frequencies, update method, content, and/or other parameters) by which a respective type of widgets corresponding to the first user interface object are configured. For example, in FIG. 5K, transforming medium widget 5018b into a small widget 5018a (e.g., a selection input 5316 directed to configuration option 5304 for transforming a selected application object (e.g., medium widget 5018b) to a small size widget) includes reducing size of medium widget 5018b to the size of a small size widget, displaying less application content and/or different application content. In some embodiments, transforming or replacing an application object of a first type into an application object of a second type includes changing content and/or functionality displayed in the application object that is being transformed. In some embodiments, transforming an application object from one type to another includes concurrently changing both content and/or dimensions of the application object. Changing content and/or functionality provided by an application object on a home user interface by selecting an option in a contextual menu associated with the application object that is being transformed, reduces the number of inputs and time needed to reconfigure and customize the home user interface.

In some embodiments, while displaying, concurrently with the first user interface object, the first configuration option, the second configuration option, and the third configuration option, the computer system detects (10022), via the one or more input devices, selection of the third configuration option (without detecting selection of the first and second configuration options and/or other configuration options); and in response to detecting the selection of the third configuration option, the computer system changes one or more parameters of the first user interface object other than the dimensions of the first user interface object (e.g., changing the location of a weather widget, changing the set of stocks in the stock widget, changing the view of the calendar widget, changing the update schedule of the widget, and other changes in appearance of the widget that is not a mere change in dimensions). In some embodiments, a change in dimensions of a widget causes changes in one or more aspects of the content of the widget, and the change in dimensions is equivalent to the changes in the one or more aspects of the widget content, and can share the same selectable configuration option in the user interface. In some embodiments, transforming an application object from one type to another includes concurrently changing both content and/or dimensions of the application object. For example, changing the size of a calendar widget from a 2×2 size to 2×4 size changes the widget content from displaying the current date alone, to displaying an “up next” calendar entries; and changing the size of the calendar widget from 2×4 to 4×4 changes the widget content from displaying the “up next” calendar entries to displaying the “today” view of the calendar. In some embodiments, the first user interface object is a suggestions widget that dynamically select and display application icons and/or widgets of a plurality of applications, and the one or more parameters of the first user interface object specify a type of applications and/or information that are targeted by the first user interface object. In one example, FIGS. 5U-5Y illustrate changing the size of a medium size widget (e.g., medium widget 5018b) to a large size widget (e.g., large widget 5018c) directly from home screen page 5003 in response to a drag input directed to a resize handle of the medium size widget, in accordance with some embodiments. In another example, FIGS. 5AG-5AJ illustrate transforming an application widget (e.g., medium widget 5018b) to an application icon (e.g., application icon 5018) by resizing down the application widget directly from home screen page 5003 in response to a drag input directed to a resize handle of the application widget. In both examples, changing the size of the widgets also changes content and/or functionality provided by the widgets. Changing content and/or functionality provided by an application object on a home user interface by selecting an option in a contextual menu associated with the application object that is being transformed, reduces the number of inputs and time needed to reconfigure and customize the home user interface.

In some embodiments, the change in the respective set of parameters by which a respective type of widgets corresponding to the first user interface object are configured includes (10024) a change in a type of information that is displayed in the first user interface object. For example, in some embodiments, the type of information that is displayed in a widget of the calendar information may include the event that is coming up next (e.g., in an “Up Next” widget, or a listing of scheduled events for a current day (e.g., in a “Today” widget)). For example, in FIG. 5AL, configuration option 5064a, when selected, causes the device 100 to set the type of calendar widget to a widget type “Up Next”. In another example, the type of information that is displayed in a widget of the stock application may include the stock information of a single stock (e.g., a single stock widget for a single company), or the stock information for a stock index (e.g., an index widget for a plurality of stocks). Changing type of content provided by an application object on a home user interface by selecting an option in a contextual menu associated with the application object that is being transformed, reduces the number of inputs and time needed to reconfigure and customize the home user interface.

In some embodiments, the home screen user interface includes (10026) a respective user interface object (e.g., an application suggestion widget, an application category widget, or another type of widget that selectively displays application icons based on the current context and/or user preferences) that displays a first set of application icons that meet first selection criteria. In some embodiments, the first set of application icons that meet the first selection criteria are updated (e.g., automatically, and/or based on changing context) over time to include different sets of application icons that meet the first selection criteria (e.g., different sets of application icons that are associated with the application category specified by the first selection criteria). In the method 10000, the computer system detects, via the one or more input devices, a sequence of one or more inputs including a respective input directed to the respective user interface object (e.g., a long press touch input, a light press input that meets an intensity threshold, an air pinch and hold input, another type of input that meets an input threshold with less than a threshold amount of movement, and/or an input that meets menu display criteria). In the method 10000, in response to detecting the sequence of one or more inputs including the respective input directed to the respective user interface object: in accordance with a determination that the sequence of one or more inputs includes selection of second selection criteria for the respective user interface object (e.g., selecting a configuration option that corresponds to the second selection criteria from among configuration options corresponding to multiple sets of selection criteria), the computer system displays a second set of application icons that are different from the first set of application icons, in the respective user interface object, wherein: the second selection criteria are different from the first selection criteria; and the second set of application icons are application icons that meet the second selection criteria. In some embodiments, the second set of application icons that meet the second selection criteria are updated (e.g., automatically, and/or based on changing context) over time to include different sets of application icons that meet the second selection criteria (e.g., different sets of application icons that are associated with the application category specified by the second selection criteria). In the method 10000, in response to detecting the sequence of one or more inputs including the respective input directed to the respective user interface object, in accordance with a determination that the sequence of one or more inputs includes selection of third selection criteria for the respective user interface object (e.g., selecting a configuration option that corresponds to the third selection criteria from among configuration options corresponding to multiple sets of selection criteria), the computer system displays a third set of application icons that are different from the first set of application icons and are different from the second set of application icons, in the respective user interface object, wherein: the third set of application icons are application icons that meet the third selection criteria; and the third selection criteria are different from the first selection criteria; and the third selection criteria are different from the second selection criteria. In some embodiments, the third set of application icons that meet the third selection criteria are updated (e.g., automatically, and/or based on changing context) over time to include different sets of application icons that meet the third selection criteria (e.g., different sets of application icons that are associated with the application category specified by the third selection criteria). For example, in FIG. 7C, configuration option 7702 indicates that the currently selected application category is “Productivity.” Changing the set of application icons provided by a respective user interface object on a home user interface by selecting different sets of selection criteria associated with the respective user interface object, reduces the number of inputs and time needed to reconfigure and customize the home user interface.

In some embodiments, in response to detecting the respective input directed to the respective user interface object (10028): in accordance with a determination that the respective input meets the first criteria, wherein the first criteria require that the respective input meets the first input threshold (e.g., a duration threshold and/or an intensity threshold) with less than the threshold amount of movement (e.g., the respective input is substantially stationary before or until meeting the first input threshold) in order for the respective input to meet the first criteria, the computer system displays respective configuration options corresponding to two or more sets of selection criteria, including the second selection criteria and the third selection criteria (e.g., a second application category and a third application criteria), concurrently with the respective user interface object. In some embodiments, a respective configuration option for changing a respective category associated with the respective user interface object (e.g., choosing a single category or two or more categories from a listing of categories, such as sports, entertainment, tools, social media, media, gaming, and/or other user-defined categories, and/or other automatically-generated categories such as those available in the application library user interface), when selected, causes the computer system to select (e.g., automatically, from time to time) the set of applications based on the respective category associated with the respective user interface object. In some embodiments, in response to detecting the respective input directed to the respective user interface object, in accordance with the determination that the respective input meets the first criteria, the computer system displays concurrent with the respective user interface object another selectable option that, when selected, causes a change in configuration of the respective user interface object other than the change in the category associated with the respective user interface object, such as a change in size and/or dimensionality of the respective user interface object, a update schedule, an update trigger, and/or other changes in configuration of the respective user interface object. For example, in FIGS. 5B-5C, in response to detecting input 5102 directed to application icon 5018 and in accordance with a determination that input 5102 includes a long press input directed to application icon 5018, device 100 displays an in-line editing user interface 5200. In some embodiments, the respective user interface object corresponds to an application category widget, the change in the respective category associated with the respective user interface object causes a change in the category of applications that are being dynamically selected by the computer system and displayed in the application category widget. In some embodiments, in response to detecting the respective input directed to the respective user interface object, in accordance with a determination that the respective input meets the second criteria, wherein the second criteria require that the respective input does not meet the first input threshold with less than the threshold amount of movement, in order for the respective input to meet the second criteria (e.g., the respective input is a tap input directed to the respective user interface object, the respective input is a pinch and release input directed to the respective user interface object, an air gesture at the location of the respective user interface object, or the respective input is another selection input that is directed to the respective user interface object), the computer system performs a respective operation associated with the respective user interface object (e.g., navigating away from the home screen user interface and displaying an application user interface corresponding to a respective application that is selected by the respective input, based on the location of the respective input and the location of the application icon of the respective application in the respective user interface object). More details regarding the respective user interface object and categories of applications are provided with respect to FIGS. 7A-7V and accompanying descriptions. Changing the category of applications provided by a respective user interface object on a home user interface by selecting an option in a contextual menu associated with the respective user interface object, reduces the number of inputs and time needed to reconfigure and customize the home user interface.

In some embodiments, in response to detecting the first input directed to the first user interface object of the plurality of user interface objects (10030): in accordance with a determination that the first input meets third criteria, wherein the third criteria require that the first input meets a second input threshold (e.g., duration threshold or intensity threshold) greater than the first input threshold (e.g., duration threshold or intensity threshold) with less than the threshold amount of movement, in order for the third criteria to be met, the computer system displays the home screen user interface in a reconfiguration mode (e.g., in the reconfiguration mode, the computer system deletes and repositions application objects (e.g., application icons and/or widgets) in the home screen user interface in response to additional user inputs directed to the application icons and/or widgets). In some embodiments, the reconfiguration mode can also be triggered by an input that meets the first criteria followed by movement of the input by more than the threshold amount of movement after the first criteria are met. In some embodiments, a selectable option for entering the reconfiguration mode is displayed in response to the first input meeting the first criteria, the reconfiguration mode can also be triggered by an input selecting the selectable option for entering the reconfiguration mode. In the method 10000, while the home screen user interface is displayed in the reconfiguration mode, the computer system detects a first resize input directed to the first user interface object (e.g., the resize input is a drag input that is directed to a resize affordance of the first user interface object displayed in the reconfiguration mode, the resize input is optionally a continuation of the first input (e.g., a movement after the second criteria are met) before the termination of the first input, the resize input is optionally a new input detected after the termination of the first input); and in response to detecting the first resize input directed to the first user interface object, the computer system changes one or more of a set of parameters by which the first user interface object is configured in accordance with the first resize input (e.g., changing object dimensions, and correspondingly changing object type, widget content, and/or other configuration options associated with the first user interface object) (optionally, in accordance with direction, and/or magnitude of the movement input). In some embodiments, in response to detecting that the first input meets the third criteria, the computer system displays the home screen user interface in a reconfiguration mode in which, location of application icons and/or widgets can be adjusted, and application icons and/or widgets can be deleted in response to user inputs. In some embodiments, changing the size or dimensions of an application in response to the first resize input causes corresponding changes in content, functionality, and type of information provided by the application object that is being resized. For example, FIGS. 5U-5Y illustrate changing the size of medium widget 5018b to a large size widget directly from home screen user interface screen 5002 in response to a drag input directed to resize handle 5238 of the medium size widget. Changing size and/or dimensions of an application object on a home user interface in response to a drag input directed to the application object (optionally, directed to a resize affordance associated with the application object), reduces the number, complexity of inputs, and time needed to reconfigure the home user interface with application objects of different sizes.

In some embodiments, the computer system detects (10032), via the one or more input devices, a second input directed to a second user interface object of the plurality of user interface objects, the second user interface object being different from the first user interface object (e.g., corresponds to a different application, having a different object type, having a different set of dimensions, and/or having different set of configuration parameters, from the first user interface object). In the method 10000, in response to detecting the second input directed to the second user interface object of the plurality of user interface objects: in accordance with a determination that the second input meets the first criteria, wherein the first criteria require that the second input meets the first input threshold (e.g., duration threshold or intensity threshold) with less than the threshold amount of movement in order for the second input to meet the first criteria, the computer system displays, concurrently with the second user interface object (e.g., while the home screen user interface remains displayed unchanged or deemphasized in the background of the second user interface object, and/or without navigating away from the home screen user interface to a settings or configuration user interface corresponding to the second user interface object), two or more configuration options corresponding to the second user interface object, including a fourth configuration option that, when selected (e.g., selected by a tap input, a pinch gesture, or another type of selection input, and/or an input that does not meet the first input threshold), causes a fourth change in configuration of the second user interface object, and a fifth selectable option that, when selected (e.g., selected by a tap input, a pinch gesture, or another type of selection input, and/or an input that does not meet the first input threshold), causes a fifth change in configuration of the second user interface object. In some embodiments, the two or more configuration options are displayed in a menu (e.g., a contextual menu or a quick-action menu) associated with the second user interface object. In some embodiments, in addition to the fourth and fifth selectable options, the menu includes one or more selectable options that are associated with the application of the second user interface object, including an option that corresponds to a frequently performed operation of the application (e.g., the frequently performed operation can be performed without opening the application when the option is selected), an option for sharing the application via one or more communication applications, and/or an option for rearranging the home screen user interface (e.g., an option to edit the home screen user interface). For example, FIGS. 5U-5Y illustrate changing the size of medium widget 5018b to a large size widget directly from home screen user interface screen 5002 in response to a drag input directed to resize handle 5238 of the medium size widget. In another example, FIGS. 5R-5T illustrate changing the size of small widget 5018a to a medium size widget directly from home screen user interface screen 5002 in response to a drag input 5324 directed to resize handle 5238 of the small size widget 50198a. In some embodiments, the menu is dismissed in response to a tap or other gesture directed to a location outside of the menu. In some embodiments, the second user interface object is an application icon of a second application, and the two or more configuration options include one or more selectable options for replacing the application icon with (and/or transforming the application icon into) a widget of the same second application, including for example, a fourth selectable option that, when selected, causes the application icon to be replaced with and/or converted into a widget of a fourth size and/or including fourth widget content of the second application; and a fifth selectable option that, when selected, causes the application icon to be replaced with and/or converted into a widget of a fifth size and/or include fifth widget content of the second application. In some embodiments, the second user interface object is a widget of a second application, and the two or more configuration options include at least one selectable option for replacing the widget with (and/or transforming the widget into) another widget of the same second application, including for example, a sixth selectable option that, when selected, causes the widget to be replaced with another widget of a different size and/or including different widget content of the second application. In some embodiments, the second user interface object is a widget of a second application, and the two or more configuration options include a selectable option for replacing the widget with (and/or transforming the widget into) an application icon of the same second application, including for example, a seventh selectable option that, when selected, causes the widget to be replaced with and/or converted into an application icon that is smaller in size and includes less content from the second application. In the method 10000, in response to detecting the second input directed to the second user interface object of the plurality of user interface objects: in accordance with a determination that the second input meets the second criteria (e.g., and does not meet the first criteria), wherein the second criteria require that the second input does not meet with the first input threshold (e.g., duration threshold or intensity threshold) with less than the threshold amount of movement in order for the second input to meet the second criteria (e.g., the second input is a tap input directed to the second user interface object, the second input is a pinch and release input directed to the second user interface object, the second input is an air gesture at the location of the second user interface object, or the second input is another selection input that is directed to the second user interface object), the computer system performs a second operation associated with the second user interface object (e.g., expanding the second user interface object to display more information, activating or toggling a control associated with the second user interface object, navigating away from the home screen user interface and displaying an application user interface corresponding to the application of the second user interface object, or performing another operation that is triggered by the selection of the second user interface object). The interaction with the second user interface object has characteristics as described above with respect to the first user interface object, when input is directed to the second user interface object, in accordance with some embodiments. Transforming or replacing an application object of a first type into an application object of a second type by selecting an option in a contextual menu associated with the application object that is being transformed or replaced, reduces the number of inputs and time needed to add to a home user interface different types of application objects for a respective application.

In some embodiments, performing the first operation associated with the first user interface object includes (10034) displaying, via the one or more display devices, a respective application corresponding to the first user interface object (e.g., including displaying a user interface of the respective application and ceasing display of the home screen user interface on which the first user interface object was displayed). In some embodiments, the computer system either displays configuration options associated with the first user interface object or displays the respective application corresponding to the first user interface depending on whether the first input (e.g., optionally a substantially stationary input) directed to the first user interface object meets a duration criterion. For example, in FIG. 5B, selection input 5102 directed to application icon 5018 corresponding to the calendar application causes device 100 to either display an in-line editing user interface 5200, as described in further detail in relation to FIG. 5C, or to open the calendar application and display user interface 5009 of the calendar application, as illustrated in FIG. 5AN. Disambiguating a user input directed to an application object using a duration threshold to determines user's intent to display an application or to display configuration options associated with the application, reduces the number and extent of inputs necessary to reconfigure a home user interface and interact with applications.

In some embodiments, performing the first operation associated with the first user interface object includes (10036) performing a respective operation using (e.g., with or through) the first application that is associated with the first user interface object (e.g., performing an operation of the first application using the first application by interacting with the widget of the first application, such as composing a message and/or sending a message using messaging application by providing the content of the message and clicking on the send button in the widget of the messaging application, adding a calendar event and/or deleting a calendar event using the calendar application by selecting a deletion button or creation button in a calendar widget, start and/or stopping a recording using a voice memo application by selecting the start and/or stop button in the voice memo widget, starting/stopping media playback using a media player application by selecting the play/pause control in the media player widget). In some embodiments, the computer system either displays configuration options associated with the first user interface object or performs application-specific operation in the first application depending on whether the first input (e.g., optionally a substantially stationary input) directed to the first user interface object meets a duration criterion. For example, in FIG. 5B, selection input 5102 directed to application icon 5018 corresponding to the calendar application can causes device 100 to either display an in-line editing user interface 5200, as described in further detail in relation to FIG. 5C, or to perform an operation with respect to the calendar application (e.g., add an event, delete an event, and/or other quick action). Disambiguating a user input directed to an application object using a duration threshold to determine user's intent to performs application-specific operation in the application associated with the application object or to display configuration options associated with the application, reduces the number and extent of inputs necessary to reconfigure a home user interface and interact with applications.

In some embodiments, while displaying the plurality of user interface objects, including the first user interface object, in the home screen user interface, the computer system detects (10038) one or more user inputs that correspond to a request for a respective change in configuration of the first user interface object (e.g., one or more user inputs that correspond to a request to change a dimension, content, and/or object type of the first user interface object, optionally in a reconfiguration mode of the home screen user interface, and/or through selection of a selectable option such as the first selectable option, the second selectable option, or the third selectable option, that is displayed with the first user interface object in response to an input that met the first criteria). In response to detecting the one or more user inputs that correspond to a request for a respective change in configuration of the first user interface object, the computer system displays, via the one or more display devices, the respective change in configuration of the first user interface object, while maintaining display of at least a first subset of the plurality of user interface objects, in addition to the first user interface object, in the home screen user interface (e.g., the change in configuration is executed in the home screen user interface, without navigating away from the home screen user interface). In some embodiments, the first subset of the plurality of user interface object may not include all of the user interface objects, such as application icons and widgets, displayed on the home screen user interface before the one or more user inputs are detected, and some of the application icons and widgets that were concurrently displayed with the first user interface object may be pushed to another page of the home screen user interface (and therefore no longer concurrently displayed with the first subset of the plurality of user interface objects and the first user interface object) as a result of the respective change in configuration of the first user interface object. In some embodiments, instead of navigating away from the home user interface to a different configuration user interface for reconfiguring, an application object (e.g., an application icon or a widget) is transformed or reconfigured in the home user interface (e.g., while display of other objects on the home user interface is maintained). For example, FIGS. 5G, 5H, and 5Y illustrate that application icon 5018 corresponding to the calendar application has been transformed or replaced by an application widget, also corresponding to the calendar application, via the in-line editing user interface 5200, without navigating away from the home user interface 5003 and while continuing to display other objects on the home user interface 5003. Transforming or replacing an application object of a first type into an application object of a second type via a contextual menu without navigating away from the home user interface, reduces the number of inputs and time needed to reconfigure an application object on the home user interface (e.g., by reducing the need to switch between the home user interface and another user interface for reconfiguring the application object).

In some embodiments, displaying, via the one or more display devices, the respective change in configuration of the first user interface object includes (10040) changing (e.g., without navigating away from the currently displayed user interface) a respective set of dimensions of the first user interface object from a first set of dimensions to a second set of dimensions different from the first set of dimensions (e.g., from a 1×2 widget to a 2×2 widget, from a 2×2 widget to a 2×4 widget, from a 2×2 widget to a 4×4 widget, from 1×2 widget to a 2×4 widget, from a 1×2 widget to a 4×4 widget, or vice versa). In the method 10000, the computer system moves (e.g., reflowing, and/or shifting, in accordance with a reflow path or prioritization order in the home screen) one or more user interface objects of the plurality of user interface objects in the home screen user interface in addition to changing the respective set of dimensions of the first user interface object (e.g., while maintaining the spatial relationship between the first user interface object with a first subset of objects of the plurality of user interface objects, and changing the spatial relationship between the first user interface object with a second subset of objects of the plurality of user interface objects). In some embodiments, the change in object dimension from “1×1” to another set of dimensions (e.g., 1×2, 2×2, or other sets of dimensions) is equivalent to a change in object type from “application icon” to “widget” of a respective size, and share the same selectable configuration option in the user interface. Similarly, in some embodiments, the change in object dimension from a set of larger dimensions (e.g., 1×2, 2×2, or other sets of dimensions) to “1×1” is equivalent to a change in object type from “widget” of a respective size to “application icon” and share the same selectable configuration option in the user interface. In some embodiments, changing the dimensions of a widget further causes changes in the content type and/or content displayed within the widget. In some embodiments, while an application object (e.g., an application icon or a widget) on a home user interface is transformed from one size to another, the computer system automatically reflows or shifts other user interface objects displayed on the same page of the home screen user interface, including providing visual feedback or animation of the reflowing of the other user interface objects. For example, when the home user interface is being reconfigured, such as when the size of an application object on the home screen user interface is changed, one or more other application objects on the same page automatically reflow in a snake pattern (e.g., along a left-to-right top-to-bottom snake pattern or along a right-to-left bottom-to-top snake pattern). For example, in FIGS. 5E-5G, transforming application icon 5018 into an application widget of small size includes enlarging application icon 5018 to the size of the small widget 5018a, displaying additional content, and optionally reflowing application icons 5020, 5022, and 5024 to make room for small widget 5018a (e.g., small widget 5018a is larger than application icon 5018, occupying a placement location that is equivalent to two rows by two columns of placement locations for application icons). Automatically reflowing user interface objects on a home screen user interface while an application object on the same page of the home screen user interface is being resized, reduces the number of inputs and time needed to reconfigure the home user interface.

In some embodiments, in response to detecting the one or more user inputs that correspond to a request for a respective change in configuration of the first user interface object, the computer system removes (10042) (e.g., after reflowing, and/or shifting, in accordance with a reflow path or prioritization order in the home screen) at least one of the one or more user interface objects of the plurality of user interface objects from a current page of the home screen user interface in which the first user interface object is displayed, in addition to changing the respective set of dimensions of the first user interface object (e.g., at least one of the user interface objects that was in the same page of the home screen user interface is pushed out of the current page onto the next page, when the size of the first user interface object is expanded). In some embodiments, while an application object (e.g., an application icon or a widget) is being transformed from one size to another, the computer system automatically removes one or more other user interface objects displayed on the same page of the home screen user interface (e.g., to make space for the application object that is being enlarged). In some embodiments, when the home user interface is being reconfigured (e.g., when the size of an application object on the home screen user interface is changed), one or more other application objects on the same page automatically reflow in a snake pattern (e.g., along a left-to-right top-to-bottom snake pattern or along a right-to-left bottom-to-top snake pattern) and as a result some applications object on the same page of the home screen user interface are pushed to another page of the home screen user interface (e.g., a new page automatically created to provide space for the pushed application objects, or an already existing adjacent page of the home screen user interface). For example, in FIGS. 5X-5Y, due to the increased size of large size widget 5018c, application icons 5020-5024 that were previously obscured while medium widget 2018b was being resized by the drag input 5326, are pushed to another page of the multi-page home screen user interface. Automatically removing user interface objects on a home screen user interface while an application object on the same page of the home screen user interface is being resized, reduces the number of inputs and time needed to reconfigure the home user interface (e.g., to make space on the page of the home screen for the application object).

In some embodiments, displaying, via the one or more display devices, the respective change in configuration of the first user interface object includes (10044) changing (e.g., without navigating away from the currently displayed user interface) a respective object type of the first user interface object from a third object type to a fourth object type that is different from the third object type (e.g., from application icon to widget or from widget to application icon). In the method 10000, the computer system moves (e.g., reflowing, and/or shifting, in accordance with a reflow path or prioritization order in the home screen) one or more user interface objects of the plurality of user interface objects in the home screen user interface in addition to changing the respective object type of the first user interface object (e.g., while maintaining the spatial relationship between the first user interface object with a first subset of objects of the plurality of user interface objects, and changing the spatial relationship between the first user interface object with a second subset of objects of the plurality of user interface objects). For example, FIG. 5L illustrates a transition from FIG. 5K while medium widget 5018b is transformed into small widget 5018a. FIG. 5L illustrates that application icons 5020, 5022, and 5024 are flowing in a bottom-up, right-to-left snaking pattern (also referred to as a “reflow path”) to fill up the newly available placement locations on home screen page 5003. In some embodiments, changing the respective object type of the first user interface object is accompanied by changing the dimensions of the first user interface object which results in the reflow of the other application icons and/or widgets on the same page of the home screen user interface. In some embodiments, while an application object (e.g., an application icon or a widget) on a home user interface is transformed from one type to another (e.g., an application icon is converted into or replaced by a widget, a widget is converted into or replaced by an application icon, and/or a widget of a first type is converted into or replaced by a widget of a second type), the computer system automatically reflows or shifts other user interface objects displayed on the same page of the home screen user interface (optionally providing visual feedback or animation of the reflowing visualizing or displaying the movement of the application objects). For example, when an application object on a home user interface is transformed from one type to another, one or more other application objects on the same page of the home user interface automatically reflow in a snake pattern (e.g., along a left-to-right top-to-bottom snake pattern or along a right-to-left bottom-to-top snake pattern). Automatically reflowing user interface objects on a home screen user interface while an application object on the same page of the home screen user interface is being reconfigured (e.g., transformed from one type to another), reduces the number of inputs and time needed to reconfigure the home user interface.

In some embodiments, in response to detecting the first input directed to the first user interface object of the plurality of user interface objects (10046): in accordance with a determination that the first input meets the first criteria and that the first user interface object is a respective widget of the first application (e.g., a single widget or a widget that is part of a stack of widgets displayed at the same placement location), the computer system displays, concurrently with the first user interface object and the two or more configuration options corresponding to the first user interface object, a respective selectable option that, when selected (e.g., selected by a tap input, a pinch gesture, or another type of selection input, and/or an input that does not meet the first input threshold), causes the computer system to display additional configuration options corresponding to the respective widget (e.g. an option for editing the widget, such as changing the type of content and/or functionally that is provided by the widget of the respective associated application; and/or an option for editing the widget stack, such as removing and/or adding widgets to the widget stack); and in accordance with a determination that the first input meets the first criteria and that the first user interface object is a respective application icon of the first application, the computer forgoes displaying, concurrently with the first user interface object and the two or more configuration options corresponding to the first user interface object, the respective selectable option that, when selected (e.g., selected by a tap input, a pinch gesture, or another type of selection input, and/or an input that does not meet the first input threshold), causes the computer system to display additional configuration options corresponding to the respective widget. In some embodiments, the same user input that meets the first criteria causes the computer system to display (e.g., in a contextual menu) different configuration options depending on whether the user input is directed to a widget (e.g., a single widget or a widget in a widget stack) or to an application icon. For example, the in-line editing user interface 5300 displayed in association with a widget includes an additional configuration option 5314 “Edit Widget” for editing a currently selected application widget (e.g., selected in response to the long press input) while in-line editing user interface 5200 displayed in association with application icon does not show the same configuration option. Displaying different configuration options in response to the same user input (e.g., input that meets the first criteria) depending on whether the application object at which the user input is directed to is a widget or an application icon, reduces the complexity of inputs and the time need to reconfigure application objects on the home screen user interface.

In some embodiments, the computer system displays (10048), via the one or more display devices, a first application suggestion widget in the home screen user interface, concurrently with the plurality of user interface objects corresponding to the plurality of different applications, wherein the first application suggestion widget includes respective application icons of a first collection of applications that are automatically selected for inclusion in the first application suggestion widget. In some embodiments, an application suggestion widget automatically suggests, or includes in the home screen user interface, application icons for a set of applications based on usage patterns and/or contextual information. In some embodiments, the application suggestion widget includes a platter than underlies the application icons for the set of automatically selected applications. In some embodiments, the application suggestion widget does not have a visible platter indicating the grouping of the set of automatically selected applications until the computer system detects a respective input that is directed to the location of the application suggestion widget. While displaying the first application suggestion widget in the home screen user interface, the computer system detects, via the one or more input devices, a third input directed to the first application suggestion widget (e.g., a touch input at a location that corresponds to the location of the first application suggestion widget, a pointing gesture that is pointed toward the location of the first application suggestion widget, or another type of input that is directed to a location of the first application suggestion widget). In response to detecting the third input directed to the first application suggestion widget: in accordance with a determination that the third input meets the first criteria, wherein the first criteria require that the third input meets the first input threshold (e.g., a duration threshold and/or an intensity threshold) with less than the threshold amount of movement (e.g., the third input is substantially stationary before meeting the first input threshold) in order for the first criteria to be met, the computer system displays, concurrently with the first application suggestion widget (e.g., while the home screen user interface remains displayed unchanged or deemphasized in the background of the first application suggestion widget, and/or without navigating away from the home screen user interface to a settings or configuration user interface corresponding to the first application suggestion widget), two or more configuration options corresponding to the first application suggestion widget, including a size configuration option for specifying a respective size for the first application suggestion widget (e.g., displaying a respective selectable option for each of a plurality of sizes (e.g., rows and columns of application icons to be included in the widget), or displaying a respective selectable option that, when selected, causes display of the respective selectable options for a plurality of sizes), and a category configuration option for specifying a respective category of the first application suggestion widget (e.g., displaying a respective selectable option for each of a plurality of categories, or displaying a respective selectable option that, when selected, causes display of the respective selectable options for a plurality of categories), wherein the computer system selects the respective application icons of the first collection of applications for inclusion in the first application suggestion widget in accordance with the respective category associated with the first application suggestion widget (and the respective categories associated with the applications associated with the computer system). In some embodiments, in response to a user input specifying a different category to be associated with the first application suggestion widget using the category configuration option, the computer system updates the respective application icons included in the first application suggestion widget to those of a new collection of applications associated with the newly specified category for the first application suggestion widget. For example, in FIGS. 7C-7E, selecting configuration options 7702 and then 756 causes the device to change the application displayed in the application category widget from productivity to communications. In some embodiments, application icons in the application suggestion widget are automatically selected by the computer system in response detecting a change of context of the computer system (e.g., time, place, location, incoming communication, ongoing activity on the computer system, and/or other contextual change); in response detecting an event in an application of the same application category as the applications in the application suggestion widget; in response to detecting a change in usage of applications installed on the computer system (e.g., user activity); in accordance with determination that a respective mode, such as a focus mode, is enabled or disabled; in response to detecting that one or more new applications are installed (and/or downloaded) on the computer system or removed (and/or uninstalled) from the computer system, and/or other changes associated with the computer system and/or applications installed on the computer system. Displaying different configuration options, including a category configuration option, in response to the same user input (e.g., input that meets the first criteria) depending on whether the application object at which the user input is directed to an application suggestion widget or other type of application object, reduces the complexity of inputs and the time need to reconfigure application objects on the home screen user interface.

In some embodiments, displaying the home screen user interface includes (10050) concurrently displaying a plurality of application suggestion widgets, including at least a first application suggestion widget and a second application suggestion widget different from the first application suggestion widget (e.g., concurrently displayed at two different placement locations in the home screen user interface). The first application suggestion widget is associated with a first category, the second application suggestion widget is associated with a second category different from the first category, the first application suggestion widget includes respective application icons for a first plurality of applications that are associated with the first category and that are automatically selected for inclusion in the first application suggestion widget for being associated with the first category, and the second application suggestion widget includes respective application icons for a second plurality of applications that are associated with the second category and that are automatically selected for inclusion in the second application suggestion widget for being associated with the second category. In some embodiments, multiple application suggestions widgets associated with different respective application categories can be displayed on the same or different pages of the home screen user interface. In some embodiments, the first plurality of application icons are updated (e.g., automatically, and/or based on changing context (recency of usage, frequency of usage, current location, current time of day, and/or other contextual conditions)) over time to include different sets of application icons from the first category, and/or the second plurality of application icons are updated (e.g., automatically, and/or based on changing context (e.g., recency of usage, frequency of usage, current location, current time of day, and/or other contextual conditions)) over time to include different sets of application icons from the second category. For example, in FIG. 7A, home screen page 7002 displays two different application category widgets 7102 and 7104 assigned different application categories. For example, application category widget 7102 assigned the productivity application category and an application category widget 7104 assigned the utilities application category are concurrently displayed on home screen page 7002 with a respective label below the respective application category widgets. Displaying multiple application suggestions widgets associated with different respective application categories, reduces the number of inputs and time needed to organize application objects on the home screen user interface and/or to locate application icons on the home screen user interface.

In some embodiments, the computer system displays (10052) the home screen user interface, including at least a first widget (and optionally, a plurality of application icons and/or widgets), in a reconfiguration mode (e.g., in the reconfiguration mode, the computer system deletes and repositions individual application icons and/or widgets in the home screen user interface in response to additional user inputs directed to the application icons and/or widgets). In some embodiments, the reconfiguration mode can be triggered by an input that meets the first criteria followed by movement of the input by more than the threshold amount of movement after the first criteria are met. In some embodiments, a selectable option for entering the reconfiguration mode is displayed in response to the first input meeting the first criteria, the reconfiguration mode can also be triggered by an input selecting the selectable option for entering the reconfiguration mode. In some embodiments, the reconfiguration mode can also be triggered by an input that meets third criteria that require the input to meet a second input threshold greater than the first input threshold, with less than the threshold amount of movement. In the method 10000, while the home screen user interface is displayed in the reconfiguration mode, the computer system detects a first movement input directed to the first widget (e.g., the first movement input is a drag input that is directed to a resize affordance of the first widget displayed in the reconfiguration mode). In response to detecting the first movement input directed to the first widget, the computer system changes a size of the first widget in accordance with the first movement input (e.g., changing object dimensions, and correspondingly changing object type, widget content, and/or other configuration options associated with the first widget) (optionally, in accordance with direction, and/or magnitude of the first movement input). For example, while home screen user interface 5003 is in the reconfiguration mode, drag input 5052 at resize handle 5238 causes the device to change the size of the weather widget from medium size widget 5018b to small size widget 5018a. Changing size and/or dimensions of a widget on a home user interface in response to a movement input (e.g., a drag input directed to the widget or optionally directed to a resize affordance associated with the widget), reduces the number, complexity of inputs, and/or time needed to reconfigure the home user interface with widgets of different sizes (e.g., there is no need to remove the widget from the home user interface, open a configuration user interface, and/or select a new widget of different size from a widget gallery).

In some embodiments, changing the size of the first widget in accordance with the first movement input includes (10054) changing the size of the first widget from a first size of a set of preconfigured sizes to a second size of the set of preconfigured sizes for the first widget. For example, in some embodiments, only a finite number of sizes are available for the first widget (e.g., a 2×2 size, a 2×4 size, and a 4×4 size), and the computer system switches between several discrete sizes based on the magnitude and/or direction of the first movement input. For example, the weather widget in FIGS. 5H-5Y is changed between target sizes small, medium, and large. Automatically switching between sizes selected from a limited number of discrete widget sizes based on characteristics of the movement input, reduces the number of inputs and time needed to resize a widget (e.g., there is no need to remove the widget from the home user interface, open a configuration user interface, and/or select a new widget of different size from a widget gallery).

In some embodiments, changing the size of the first widget in accordance with the first movement input includes (10056) changing the size of the first widget in accordance with one or more movement characteristics (e.g., direction, and/or magnitude of movement) of the first movement input. In some embodiments, in accordance with a determination that the first movement input includes movement in a first direction, the computer system increases a size of the first widget; and in accordance with a determination that the first movement input includes movement in a second direction different from the first direction, the computer system decreases a size of the first widget. In some embodiments, in accordance with a determination that the first movement input includes a first amount of movement, the computer system changes a size of the first widget by a first magnitude; and in accordance with a determination that the first movement input includes a second amount of movement, the computer system changes a size of the first widget by a second magnitude that is different from the first magnitude. For example, whether the weather widget in FIGS. 5W-5Y is changed from medium to large is based on the amount and/or direction of the movement of drag input 5326. Changing the size of the widget in accordance with a movement characteristic of a movement input provides additional control or input mechanism for changing the size of a widget, thereby the number of inputs and time needed to resize a widget while increasing control of the user over the resizing process (e.g., there is no need to remove the widget from the home user interface, open a configuration user interface, and/or select a new widget of different size from a widget gallery).

In some embodiments, while displaying the home screen user interface in the reconfiguration mode (e.g., in response to detecting one or more of the criteria that trigger display of the reconfiguration mode), the computer system displays (10058), via the one or more display devices, concurrently with the first widget, a first set of one or more resize affordances for the first widget (e.g., displayed at one or more of the corners and/or on one or more of the edges of the first widget), in the home screen user interface. In some embodiments, while the home screen user interface is in a reconfiguration mode, a resize affordance is displayed at or near widget(s), widget stack(s), and/or optionally application icons. For example, a resize affordance is displayed at one or more corners of the widget or widget stacks. A widget or a widget stack are resizable in response to resize inputs (e.g., drag inputs) and in response to resize inputs that are not directed to a resize affordance. For example, the computer system can resize the widget in response to a drag input directed to a corner, border, or a resize affordance of the widget or widget stack. In some embodiments, application icons are optionally resizable in response to movement inputs directed to one or more resize affordances associated with the application icons. In some embodiments, one or more edges and/or corners of the widget (or another type of resizable object on the home screen user interface) are displayed with corresponding resize affordances while other edges and/or corners of the widget are displayed without corresponding resize affordances. The system resizes the widget in response to detecting a movement input directed to a resize affordance or an edge or corner without a resize affordance, in similar manners. For example, in FIG. 5Q, while home screen page 5003 is in the reconfiguration mode, small widget 2018a is displayed with one or more resize affordances for resizing small widget 2018a (e.g., resize handle 5238 displayed at or near the bottom right corner of small widget 2018a). Displaying a resize affordance (e.g., a resize handle) for changing a size of a respective widget in the home user interface while the home user interface is in reconfiguration mode, provides visual feedback to the user that the size of the widget can be reconfigured and/or reduces the number of inputs and time needed to resize a widget on the home screen user interface (e.g., there is no need to remove the widget from the home user interface, open a configuration user interface, and/or select a new widget of different size from a widget gallery).

In some embodiments, the home screen user interface includes (10060) a plurality of widgets, including at least the first widget and a second widget different from the first widget. While displaying the home screen user interface in the reconfiguration mode (e.g., in response to detecting one or more of the criteria that trigger display of the reconfiguration mode), the computer system displays, via the one or more display devices, respective sets of one or more resize affordances (e.g., resize handles displayed optionally at one, some, or all corners of a respective widget) for the plurality of widgets, including concurrently displaying: the first set of one or more resize affordances for the first widget, and a second set of one or more resize affordances for the second widget. For example, in the reconfiguration mode of home user interface 5005 in FIG. 5Z, resize handles 5046 and 5047 of stack of widgets 5042 and 5044, respectively, are displayed. Displaying multiple resize affordance (e.g., resize handles) for changing a size of respective widgets in the home user interface while the home user interface is in reconfiguration mode, provides visual feedback to the user that the size of the respective widgets can be reconfigured and/or reduces the number of inputs and time needed to resize a widget on the home screen user interface.

In some embodiments, the home screen user interface includes (10062) a collection of multiple widgets (e.g., a stack of widgets) associated with a first placement location in the home screen user interface, wherein a respective widget from the collection of multiple widgets is selectively (e.g., by user input or by the computer system in accordance with contextual conditions and/or other widget switching schedule) displayed in the first placement location at a given time. In the method 10000, while displaying the home screen user interface in the reconfiguration mode (e.g., in response to detecting one or more of the criteria that trigger display of the reconfiguration mode), the computer system displays, via the one or more display devices, a respective set of one or more resize affordances (e.g., resize handle(s)) for the respective widget (or for the collection of multiple widgets as a whole) from the collection of multiple widgets that is currently displayed in the first placement location. For example, a resize affordance is displayed at one or more corners of a stack of widgets. In some embodiments, resizing the stack of widgets causes some or all widgets in the stack to be resized. In some embodiments, the currently display widget at the first placement location and/or the collection of multiple widgets associated with the first placement location are automatically selected by the computer system in response detecting a change of context of the computer system (e.g., time, place, location, incoming communication, ongoing activity on the computer system, and/or other contextual change). In some embodiments, the currently display widget at the first placement location and/or the collection of multiple widgets associated with the first placement location are automatically selected by the computer system in response detecting an event in an application of the same application category as the applications associated with a currently displayed widget or widgets in the collection of multiple widgets. In some embodiments, the currently display widget at the first placement location and/or the collection of multiple widgets associated with the first placement location are automatically selected by the computer system in response to detecting a change in usage of applications installed on the computer system (e.g., user activity). In some embodiments, the currently display widget at the first placement location and/or the collection of multiple widgets associated with the first placement location are automatically selected by the computer system in accordance with determination that a respective mode, such as a focus mode, is enabled or disabled. In some embodiments, the currently display widget at the first placement location and/or the collection of multiple widgets associated with the first placement location are automatically selected by the computer system in response to detecting that one or more new applications are installed (and/or downloaded) on the computer system or removed (and/or uninstalled) from the computer system, and/or other changes associated with the computer system and/or applications installed on the computer system. For example, in the reconfiguration mode of home user interface 5005 in FIG. 5Z, resize handles 5046 and 5047 of stack of widgets 5042 and 5044, respectively, are displayed Displaying a resize affordance (e.g., a resize handle) for changing a size of a stack of widgets in the home user interface while the home user interface is in reconfiguration mode, provides visual feedback to the user that the stack of widgets can be reconfigured and/or reduces the number of inputs and time needed to resize stack of widgets on the home screen user interface.

In some embodiments, while displaying the respective set of one or more resize affordances for the respective widget from the collection of multiple widgets (e.g., a stack of widgets) that is currently displayed in the first placement location of the home screen user interface, the computer system detects (10064), via the one or more input devices, a second movement input directed to the respective set of one or more resize affordances for the respective widget from the collection of multiple widgets (e.g., a drag input directed to a resize handle for the stack of widgets). In response to detecting the second movement input, in accordance with a determination that resizing the collection of multiple widgets is permitted, the computer system resizes the collection of multiple widgets in accordance with the second movement input. In some embodiments, after the collection of multiple widgets are resized in accordance with the second movement input, the current displayed widget in the collection of multiple widgets is displayed with a new size, and as another widget from the collection of multiple widget is displayed, that widget is also displayed with the new size. In response to detecting the second movement input, in accordance with a determination that at least one of the collection of multiple widgets cannot be resized, the computer system forgoes resizing the collection of multiple widgets. In some embodiments, in accordance with the determination that a respective widget of the collection of multiple widget cannot be resized (e.g., because the target size is not available as a configuration option for the respective widget), the computer system generates a warning or prompt indicating that the respective widget from the collection of multiple widgets cannot be resized, and optionally, provides an option to cancel the resizing operation for the collection of multiple widgets, or proceed with the resizing operation for the collection of multiple widgets after removing the respective widget from the collection of multiple widgets. For example, on response to detecting the drag input 5048 and in accordance with the determination that a respective application widget in the stack of widgets 5042 cannot be resized as requested (e.g., because the target size is not available as a configuration option for the respective widget), the device 100 generates warning prompt 5056 indicating that a respective application widget in the stack of widgets 5042 cannot be resized, as illustrated in FIG. 5AA. Resizing respective widgets in the stack of widgets in response to the same movement input directed to the resize affordance of the stack of widgets or forgoing the resizing operation if one or more widgets in the stack cannot be resized, reduces the number of inputs and/or time needed to resize the stack of widgets.

In some embodiments, displaying, via the one or more display devices, concurrently with the first widget, the first set of one or more resize affordances for the first widget, in the home screen user interface, includes (10066) displaying a first resize affordance at a location corresponding to a first portion of the first widget without displaying a resize affordance at a location corresponding to a second portion of the first widget. Detecting the first movement input directed to the first widget includes detecting the first movement input directed to the second portion of the first widget that is displayed without a resize affordance. For example, in some embodiments, resize handles are displayed at one or more corners and/or edges of the first widget, but the user can drag any corner or edge of the first widget to resize the first widget, including the edge(s) and/or corners that are displayed with resize affordances and the edge(s) and/or corners that are displayed without resize affordances. For example, resizing techniques described in relation to FIGS. 5N-5T, 5U-5Y, and 5AG-5AJ can be performed using a resize input (e.g., a drag input) that is directed to corners and/or edges of respective application widgets as opposed to resize handles (e.g., even if resize handles are displayed, or if no resize handles are displayed). Resizing a respective widget in response to a movement input directed to a portion of the widget that is not displayed with a resize affordance in a manner similar to a resize affordance reduces visual clutter and reduces input mistakes when resizing the respective widget.

In some embodiments, changing the size of the first widget in accordance with the first movement input includes (10068): reducing the size of the first widget (e.g., to a size of an application icon or toward a size of the application icon) in accordance with the first movement input, and displaying, via the one or more display devices, a respective application icon that corresponds to a respective application associated with the first widget in place of the first widget. In some embodiments, a widget is transformed or replaced by an application icon in the home screen user interface by resizing the widget down to an application icon using a movement input directed to a resize affordance. For example, FIGS. 5AG-5AJ illustrate transforming an application widget (e.g., medium widget 5018b) to an application icon (e.g., application icon 5018) by resizing down the application widget directly from home screen page 5003 in response to a drag input directed to a resize handle of the application widget. Resizing down an application widget into an application icon in the home user interface using a drag input directed to a resize affordance, reduces the number of inputs and time needed to reconfigure and customize the home user interface (e.g., add an application icon and/or remove a widget for a respective application).

In some embodiments, detecting the first movement input includes (10070) detecting a first portion of the first movement input and detecting a second portion of the first movement input following the first portion of the first movement input, wherein the first portion of the first movement input and the second portion of the first movement input are in a first direction relative to the first widget. Changing the size of the first widget in accordance with the first movement input includes: changing the size of the first widget to a first threshold size in accordance with the first portion of the first movement input; displaying, via the one or more display devices, a further change in the size of the first widget in a first direction beyond (e.g., above or below) the first threshold size in accordance with the second portion of the first movement input; and changing the size of the widget in a second direction that is different than the first direction after the second portion of the first movement input ceases to be detected (e.g., returning the respective size of the first widget to the first threshold size if the first movement input ends after the second portion of the first movement input, or changing the respective size to a smaller size in accordance with subsequent portion of the first movement input in a reverse direction of the first direction). For example, as the widget is being resized in response to a drag input, a bounce back effect is displayed in which the widget bounces back from a transient size that exceeds the predefined widget size back to the predefined widget size. Accordingly, the computer system continuously provides visual feedback to the user (e.g., in response to user's continued movement input) with respect to an internal state of the computer system while the movement input is being detected. For example, visual feedback is provided while the computer system is responding to the resize movement input and a bounce back effect is provided when the maximum threshold widget size has been reached. For example, FIG. 5AD-5AF illustrate that the size of medium widget 5018b bounces back to its maximum allowable size in response to a drag input that stretched the medium widget 5018b beyond its maximum allowable size once the drag input is released (e.g., as shown in FIGS. 5AE and 5AF). Providing a bounce back effect when allowable maximum widget size has been reached, provides a visual feedback to the user regarding whether the computer system is responding to a user input resizing the widget, thereby reducing the number of inputs and/or time needed to resize a widget (e.g., reducing the number of attempts to resize the widget to a size that is not allowable or available).

In some embodiments, the computer system displays (10072) a plurality of intermediate states between a first size of the first widget and a second size of the first widget, during the first movement input. In some embodiments, a respective intermediate state includes a respective background platter that has a respective intermediate size between the first size and the second size according to the current value of the first movement input, and a scaled version of the content of the first widget with the intermediate size. In some embodiments, the scaled version of the content of the first widget is visually obscured, e.g., blurred, darkened, and/or skewed, during the first movement input. In some embodiments, while the movement input corresponding to a command to resize the widget is detected, different intermediate or transient states (e.g., sizes and/or content) are displayed. For example, during drag input 5326 large target size illustrated by platter 5108d in FIG. 5X. Displaying intermediate or transient states of the widget while the widget is being resized in response to a movement input, provides continuous or uninterrupted visual feedback to the user that the computer system is responding to the detected movement input, thereby reducing the number of inputs and/or time needed to resize a widget.

In some embodiments, changing the respective size of the first widget in accordance with the first movement input includes (10074) switching from displaying the first widget with a first size to displaying the first widget with a second size different from the first size, during the first movement input. In some embodiments, displaying intermediate or transient states of the widget while the widget is being resized includes switching between different types of the widget (e.g., different sizes and/or content of the widget) during the movement input. For example, a platter 5018d with the target size of large size widget 5018c is displayed to indicate the size of large size widget 5018c once device 100 persistently switches from displaying medium widget 2018b to displaying large size widget 5018c. Switching between different types of the widget while the widget is being resized in response to a movement input corresponding to a resize command, provides continuous or uninterrupted visual feedback to the user that the computer system is responding to the detected movement input.

In some embodiments, changing the respective size of the first widget in accordance with the first movement input includes (10076) switching from displaying the first widget with a first size to displaying the first widget with a second size different from the first size, after detecting a termination of the first movement input (e.g., after liftoff of a touch input and/or release of a pinch gesture). In some embodiments, after the end of the movement input corresponding to a resize command, the widget is transformed into or replaced by a widget of a different type. For example, if the device detects a lift off of drag input 5326 after the preview of large size widget 5018c has reached the target size, as illustrated in FIG. 5Y, the switching to large size widget 5018c is completed and large size widget 5018c remain displayed (e.g., at the target size illustrated by platter 5108d or a size greater than the target size illustrated by platter 5018d) as illustrated in FIG. 5Y. Displaying intermediates states for the widget, including switching between different types of widget, while the widget is being resized in response to a movement input, and switching the type of widget that is displayed permanently after end of the movement input, provides continuous or uninterrupted visual feedback to the user that the computer system is responding to the movement input and has successfully completed the resize command.

In some embodiments, the plurality of user interface objects includes (10078) a first application icon that includes respective animated content (e.g., animated voice signals showing that a media recording process is ongoing, updates to the appearance of a delivery company logo indicates the progress of an ongoing delivery job, or updates to the temperature value show in a home control app icon shows heating progress for a room) that indicates a respective ongoing activity associated with a respective application of the first application icon. For example, a foreground graphical portion of an application icon is animated or moving to indicate an ongoing activity (e.g., ongoing call, recording, software update, downloading, uploading, sharing, workout), and the type of animation displayed is based on the foreground graphical portion of the application icon for the respective application and, optionally, the current state of the ongoing activity as the current state changes over time. For example, FIG. 5AS illustrates application icons without animation (e.g., because there is no ongoing activity) and FIG. 5AT illustrates the same application icons as displayed in FIG. 5AS, however, some of the application icons are displayed with animation (e.g., because there is ongoing activity). Displaying an animation in an application icon indicating an ongoing activity occurring in a respective application corresponding to the application icon, provides visual feedback to the user that changes are occurring in the respective application without the need to clutter the user interface with notifications and/or without the need to open the respective application.

In some embodiments, in accordance with a determination that the respective ongoing activity associated with the respective application of the first application icon includes a first ongoing activity, the computer system displays (10078), via the one or more display devices, first animated content in the first application icon; and in accordance with a determination that the respective ongoing activity associated with the respective application of the first application icon includes a second ongoing activity different from the first ongoing activity, the computer system displays, via the one or more display devices, second animated content, different from the first animated content, in the first application icon. For example, in some embodiments, the application icon of a home control application includes a temperature value that is updated as the temperature of a room changes during a heating or cooling cycle of the thermostat for the room. In addition, the application icon of the home control application includes a background color that changes as ambient lighting changes and as lights are turned on by the home control application. In another example, in the case of a settings application, animation in a respective application icon corresponding to the settings application can be displayed to indicate that a software update is in progress (e.g., gears in the application icon can be shifting while the software update is in progress and cease to be move after the software update is completed). In another example, in the case of a photos application, an animation in a respective application icon corresponding to the photos application can be displayed to indicate that a sharing process (e.g., sharing of a photo, and/or a file transfer process) is ongoing. In another example, in the case of a fitness application, an animation (e.g., a beating heart) in a respective application icon corresponding to the fitness application can be displayed to indicate that an activity or a workout is in progress. For example, in FIG. 5AT, the animations illustrated with arrows 5082, 5084, 5086, and 5088 correspond to different animations in accordance with the ongoing activity associated with the respective icons 5002, 5004, 5020a, and 5022a. Displaying different animations in respective application icons indicating different ongoing activity occurring in respective applications corresponding to the respective application icons, provides visual feedback to the user that changes are occurring in the respective applications without the need to clutter the user interface with notifications and/or without the need to open the respective applications.

In some embodiments, while displaying, via the one or more display devices, the respective animated content in the first application icon, the computer system detects (10082) that the respective ongoing activity associated with the respective application of the first application icon has terminated. In response to detecting that the respective ongoing activity associated with the respective application of the first application icon has terminated, the computer system ceases to display the respective animated content in the first application icon, and the computer system displays, via the one or more display devices, the first application icon with a first static appearance. In some embodiments, while displaying the respective animated content in the second application icon, the computer system detects that the respective ongoing activity associated with the respective application of the second application icon has terminated; and in response to detecting that the respective ongoing activity associated with the respective application of the second application icon has terminated, the computer system ceases to display the respective animated content in the second application icon, and displays the second application icon with a second static appearance. In some embodiments, while displaying the first application icon with the first static appearance, the computer system detects that the respective ongoing activity associated with the respective application of the first application icon has started; and in response to detecting that the respective ongoing activity associated with the respective application of the first application icon has started, the computer system displays the respective animated content in the first application icon. In some embodiments, while displaying the second application icon with the second static appearance, the computer system detects that the respective ongoing activity associated with the respective application of the second application icon has started; and in response to detecting that the respective ongoing activity associated with the respective application of the second application icon has started, the computer system displays the respective animated content in the second application icon. For example, in some embodiments, the presence of animated content for a respective application icon of an application indicates that a process of the application is ongoing, and the absence of animated content for the respective application icon indicates that the ongoing process has been terminated and/or the application does not have an ongoing process at the present time. In some embodiments, displaying an animation in an application icon indicates an ongoing activity occurring in the respective application corresponding to the application icon, and absence of an animation in the application icon indicates absence or termination of an ongoing activity occurring in the respective application. For example, in FIG. 5AT, the animations illustrated with arrows 5082, 5084, 5086, and 5088 with respect to icons 5002, 5004, 5020a, and 5022a indicate ongoing activities, whereas the absence of such animations in the rest of the icons on the home screen 5011 illustrates that there is no ongoing activity. Displaying an animation in an application icon indicating an ongoing activity occurring in a respective application corresponding to the application icon, provides visual feedback to the user that changes are occurring in the respective application without the need to clutter the user interface with notifications and/or without the need to open the respective application.

It should be understood that the particular order in which the operations in FIGS. 10A-10J have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 11000, 12000, 13000, and 14000) are also applicable in an analogous manner to method 14000 described above with respect to FIGS. 10A-10J. For example, the controls, user interfaces, and user inputs described above with reference to method 10000 optionally have one or more of the characteristics of the controls, user interfaces, and user inputs described herein with reference to other methods described herein (e.g., methods 11000, 12000, 13000, and 14000). For brevity, these details are not repeated here.

FIGS. 11A-11H are flow diagrams of an exemplary method 11000 for automatic grouping and re-arrangement of application objects in a home screen user interface. In some embodiments, method 11000 is performed at a computer system that is in communication one or more display devices and one or more input devices (e.g., including one or more sensors for detecting user inputs). In some embodiments, the method 11000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 11000 are, optionally, combined and/or the order of some operations is, optionally, changed.

In the method 11000, the computer system displays (11022), via the one or more display devices, a first user interface (e.g., a home screen user interface, a user-arranged page of a multipage home screen user interface, and/or another user interface that includes an arrangement of user interface objects, such as application icons, widgets, and/or other types of objects) including a plurality of user interface objects of a first object type (e.g., application icons, widgets of a first set of dimensions, or widgets of any of one or more sets of dimensions). In the method 11000, the first user interface has (11004) a plurality of placement locations that are respectively available to accommodate a corresponding user interface object of the first object type (e.g., placement locations that are of a first size that is configured to accommodate an application icon, placement locations that are of a second size that is configured to accommodate a 2×2 widget, or placement locations that are of another size that is configured to accommodate an object of a different set of dimensions). In the method 11000, the plurality of user interface objects are (11006) placed into at least a subset of the plurality of placement locations in accordance with a first arrangement of the plurality of user interface objects relative to the plurality of placement locations. In the method 11000, while the computer system displays, via the one or more display devices, the first user interface with the plurality of user interface objects of the first type in the first arrangement, the computer system detects, via the one or more input devices, a first input directed to a first user interface object of the plurality of user interface object that is placed at a first placement location of the plurality of placement locations. In the method 11000, in response to detecting the first input that is directed to the first user interface object at the first placement location (e.g., a drag input that moves the first user interface object from the first placement location to a second placement location on the same page or a different page of the first user interface, or a user input deleting the first user interface object from the first user interface) (11010): the computer system removes (11012) the first user interface object from the first placement location; in accordance with a determination that the first user interface object and one or more second user interface objects of the plurality of user interface objects form a first automatically-arranged group (e.g., the first automatically-arranged group is formed by the computer system prior detecting the first input) in accordance with first grouping criteria, wherein the first grouping criteria include one or more conditions based on a spatial distribution (e.g., spatial proximity and/or spatial location) of the plurality of user interface objects (e.g., criteria for automatically grouping the first user interface object and the one or more second user interface objects based on spatial proximity and/or locations of the user interface objects) in the first user interface (e.g., the automatically-arranged group is formed based on spatial proximity and locations of the user interface objects of the same type in the first arrangement), the computer system rearranges (11014) the one or more second user interface objects in the first user interface, including moving one of the one or more second user interface objects to the first placement location (e.g., consolidating spatial distribution of the objects in the automatically-arranged group); and in accordance with a determination that the first user interface object and one or more third user interface objects of the plurality of user interface objects (e.g., the one or more second user interface objects, or one or more user interface objects that are different from and/or are concurrently displayed with the one or more second user interface objects) do not form a respective automatically-arranged group in accordance with the first grouping criteria, the computer system forgoes rearranging (11016) the one or more third user interface objects in the first user interface (e.g., leaving the one or more third user interface objects at their currently locations, leaving the first placement location vacated, and/or move another user interface objects from the same group as the first user interface object into the first placement location). FIG. 6A-6F illustrate reflowing application icons in one group of application icons (e.g., group 6102 of application icons 602-624) without causing application icons in other groups on the same home screen page to reflow (e.g., group 6104 of one application icon 626 and group 6106 of application icons 628-632), in accordance with some embodiments. In some embodiments, the home user interface has a grid of placement locations (e.g., also referred to as slots), where a size of a respective placement location can accommodate a single application icon. In some embodiments, the grid of placement locations has a preset size and/or number of available placement locations for displaying application icons. For example, a 1×4 grid, a 2×4 grid, a 4×4 grid, a 5×4 grid, a 5×5 grid, a 2×6 grid, a 4×6 grid, a 6×6 grid, a 2×8 grid, a 4×8 grid, a 6×8 grid, an 8×8 grid, and/or other type of fixed grid). In some embodiments, a number of rules are applied to determine formation of a respective automatically-arranged group based on positions of application icons in the available placement locations on the home user interface. For example, a respective automatically-arranged group is formed by a single complete row of application icons or single incomplete row of application icons that are placed in contiguous placement locations, multiple complete rows of application icons, and/or multiple complete rows of application icons followed by a single incomplete row of application icons in contiguous placement locations in the incomplete row. In some embodiments, the plurality of user interface objects of the first type (e.g., application icons) are displayed at the same hierarchy level on the home screen user interface. For example, the plurality of user interface objects are displayed in the user-arranged page directly (e.g., as opposed to in folders or otherwise nested). For example, each of the first subset of application icons can be accessed directly from the user-arranged page. In some embodiments, if the multipage home screen user interface is a structure for organizing user interface objects at a different hierarchy levels, the user-arranged page is a first level of that structure, where the application icons displayed on the user-arranged page are on the same level, and application icons included in folders on the user-arranged page are displayed at a second level of the user-arranged page. In some embodiments, the first user interface is in a reconfiguration mode when the first input that is directed to the first user interface object is detected. In some embodiments, the first user interface is a user-arranged page of a multipage home screen user interface that can be modified or rearranged in response to additional user inputs in the reconfiguration mode. For example, application icons and/or widgets can be added, deleted, moved, or otherwise rearranged in accordance with additional user inputs. As described herein, the method 11000 provides an improved technique for organizing and re-arranging a home screen user interface. Upon detecting re-arrangement on a page of the home screen user interface (e.g., re-arrangement in response to a user input or requested by the computer system), some application icons reflow while others remain displayed at their respective locations (e.g., current locations that are optionally user-specified). For example, application icons in a respective automatically-arranged group reflow, e.g., to make room for icons added to the respective automatically-arranged group or to refill vacant placement locations in the respective automatically-arranged group, while other applications icons on the same page located outside the respective automatically-arranged group maintain (e.g., icons that are not part of the respective group and/or are included in other automatically-arranged groups) respective locations. Accordingly, a user can specify groups of application icons where changes in one group do not affect changes in other groups. The technique combines the efficiency of automatically re-arranging a page of the home user interface with the flexibility of persisting user-specified locations for some application icons on the page. Reflowing some application icons upon re-arrangement without reflowing other application icons reduces the number of inputs and/or time needed to re-arrange a page of the home screen user interface while providing additional control to a user for arranging the page of the home user interface.

In some embodiments, in response to detecting the first input that is directed to the first user interface object at the first placement location (11018) (e.g., a drag input that moves the first user interface object from the first placement location to a second placement location on the same page or a different page of the first user interface, or a user input deleting the first user interface object from the first user interface): in accordance with a determination that the first user interface object and the one or more second user interface objects of the plurality of user interface objects do not form a respective automatically-arranged group in accordance with first grouping criteria, the computer system forgoes rearranging the one or more second user interface objects in the first user interface (e.g., leaving the one or more second user interface objects at their currently locations, leaving the first placement location vacated, and/or move another user interface objects from the same group as the first user interface object into the first placement location); and in accordance with a determination that the first user interface object and the one or more third user interface objects of the plurality of user interface objects form a second automatically-arranged group in accordance with the first grouping criteria, the computer system rearranges the one or more third user interface objects in the first user interface, including moving one of the one or more third user interface objects into the first placement location (e.g., consolidating spatial distribution of the objects in the automatically-arranged group)). For example, FIGS. 6M-6N illustrate that application icons 610-624 in group 6102 shift in a snaking pattern (e.g., from right to left and from bottom to top) to fill up a placement location in group 6102 that is vacated by application icon 608, thereby condensing the space occupied by group 6102 without causing application icons in groups 6104 and 6106 to move. Reflowing application icons within a group upon re-arrangement of a page of the home screen user interface without reflowing application icons in other groups on the home screen user interface, reduces the number of inputs and/or time needed to re-arrange a page of the home screen user interface while providing additional control to a user for arranging the page of the home user interface.

In some embodiments, in response to detecting the first input that is directed to the first user interface object at the first placement location (e.g., a drag input that moves the first user interface object from the first placement location to a second placement location on the same page or a different page of the first user interface, or a user input deleting the first user interface object from the first user interface): the computer system places (11020) the first user interface object into a second placement location different from the first placement location in accordance with the first input (e.g., the first input is terminated and released the first user interface object into the second placement location in the home screen user interface, e.g., on the same page or different page from the page containing the first placement location); and after placing the first user interface object into the second placement location, in accordance with a determination that the first user interface object meets the first grouping criteria with respect to one or more fourth user interface objects of the plurality of user interface objects, the computer system adds the first user interface object to a third automatically-arranged group (e.g., a newly created group or an existing group) that includes the one or more fourth user interface objects (e.g., such that, when the first user interface object is later moved to vacate the second placement location, the one or more fourth user interface objects are rearranged in response to refill the second placement location). In some embodiments, in accordance with a determination that an application icon is moved from a location in the first automatically-arranged group to a location within or adjacent to the third automatically-arranged group, the computer system automatically includes or adds the application icon to the third automatically-arranged group. For example, in FIGS. 6AA-6AB, the device 100 automatically adds application icon 626 to group 6112, in accordance with a determination that application icon 626 is placed into a contiguous location relative to other application icons in group 6112 and in accordance with a determination that the row above application icon 626 is complete (e.g., the third row above the fourth row, where application icon 626 is placed, is complete). Automatically adding application icons to a respective group upon detecting that the application icons are placed within or adjacent to the respective group, reduces the number of inputs and/or time needed to re-arrange a page of the home screen user interface.

In some embodiments, the plurality of user interface objects of the first object type include (11022) a plurality of application icons corresponding to different applications (e.g., without including any widgets). For example, FIG. 6A-6F illustrate reflowing application icons in one group of application icons (e.g., group 6102 of application icons 602-624) without causing application icons in other groups on the same home screen page to reflow (e.g., group 6104 of one application icon 626 and group 6106 of application icons 628-632), The first placement location is a placement location of a size that accommodates a single application icon, in accordance with some embodiments. Reflowing application icons within a group upon re-arrangement of a page of the home screen user interface without reflowing application icons in other groups on the home screen user interface, reduces the number of inputs and/or time needed to re-arrange a page of the home screen user interface while providing additional control to a user for arranging the page of the home user interface.

In some embodiments the plurality of user interface objects of the first object type include (11024) a plurality of widgets corresponding to one or more applications (e.g., without including any application icons). The first placement location is a placement location of a size that accommodates a widget, and is greater than (e.g., is multiple rows and columns of) the size that accommodates a single application icon, in accordance with some embodiments. In some embodiments, the home user interface includes user interface objects of a second type (e.g., widgets). In some embodiments, re-arrangement of a page of the home screen is caused by adding, removing, and/or locating a widget in the page of the home screen user interface. For example, FIGS. 6AH-6AK illustrate that the device 100 automatically merges groups 6112, 6116, and 6118 as a result of inserting application widget 653 on home screen page at placement locations occupied by application icons in group 6112. In some embodiments, reflowing of application icons within a group without reflowing application icons in other groups on the page is caused by re-arrangement of the page with respect to a widget. Reflowing application icons within a group upon re-arrangement of a page of the home screen user interface with respect to a widget, without reflowing application icons in other groups on the home screen user interface, reduces the number of inputs and/or time needed to re-arrange a page of the home screen user interface while providing additional control to a user for arranging the page of the home user interface.

In some embodiments, in response to detecting the first input that is directed to the first user interface object at the first placement location (e.g., a drag input that moves the first user interface object from the first placement location to a second placement location on the same page or a different page of the first user interface, or a user input deleting the first user interface object from the first user interface): (prior to placing the first user interface object into a respective placement location different from the first placement location in accordance with the first input (e.g., before the first input is terminated and before the first user interface object is released into a new placement location in the home screen user interface, e.g., on the same page or different page from the page containing the first placement location)) in accordance with a determination that the first user interface object meets displacement criteria with respect to a fifth user interface object of the plurality of user interface objects, that is in a third placement location in the first user interface, the computer system removes (11026) the third user interface object from the third placement location. For example, in some embodiments, when the first user interface object is dragged close to another user interface object of the same type (e.g., the first user interface object is close enough to the third placement location of the third user interface object to meet a threshold distance of the proximity criteria), but not directly over the other user interface object of the same type, the computer system moves the third user interface object out of the third placement location (e.g., optionally, into an adjacent placement location of the third placement location), to allow the first user interface object to be placed into the third placement location if the first input is terminated at the current location (e.g., within the threshold distance of the third placement location). In some embodiments, while the first user interface object is being relocated in response to detecting a movement input, other user interface objects displayed along a respective movement path of the first user interface object are temporarily displaced (e.g., moved out of the way). For example, in accordance with a determination that application icon 628 (or the midline of application icon 628) has moved across a midline of application icon 630 (as shown in FIG. 6D), the device 100 caused application icon 630 to move out of the way of application icon 628 and reflow towards the vacated placement location in group 6106 (e.g., first spot in the row that was vacated by application icon 628, as illustrated in FIG. 6E). Accordingly, the computer system provides visual feedback to continuous or uninterrupted visual feedback to the user that the computer system is responding to the detected movement input, thereby reducing the number of inputs and/or time necessary to re-arrange a page of the home screen user interface.

In some embodiments, in response to detecting the first input that is directed to the first user interface object at the first placement location (e.g., a drag input that moves the first user interface object from the first placement location to a second placement location on the same page or a different page of the first user interface, or a user input deleting the first user interface object from the first user interface): (prior to placing the first user interface object into a respective placement location different from the first placement location in accordance with the first input (e.g., before the first input is terminated and before the first user interface object is released into a new placement location in the home screen user interface, e.g., on the same page or different page from the page containing the first placement location)) in accordance with a determination that the first user interface object meets page switching criteria with respect to a currently displayed page of the first user interface (e.g., the first user interface object is held within a threshold distance of a first edge of the currently displayed page for at least a threshold amount of time, and the first edge corresponds to a navigation direction for reaching an adjacent page (e.g., a previous page or a next page) of the home screen user interface), the computer system ceases (11028) display of the currently displayed page of the first user interface and the computer system, and displays, via the one or more display devices, an adjacent page of the first user interface, while the first user interface object remains displayed over the first user interface (e.g., sliding out the currently displayed page and sliding in the next page of the home screen user interface underneath the first user interface object as the first user interface object is held). For example, in some embodiments, when the first user interface object is dragged close to the side edge of the home screen user interface and held near the side edge for at least a threshold amount of time, the computer system navigates to an adjacent page of the home screen near that side edge, to allow the user to find a placement location for the first user interface object in the adjacent page. Further, FIG. 6AP illustrates that while application icons in group 6122 reflow (e.g., as a result of weather widget vacating placement locations in group 6122 in response to input 6228), the device 100 maintains locations of application icons 618-622 in group 6124 and application icons 624-626 in group 6126. Automatically switches pages when a user interface object is dragged in a multi-page home screen user interface, reduces the number of inputs and/or time needed to re-arrange a page of the home screen user interface while providing additional control to a user for arranging the multi-page home user interface.

In some embodiments, in response to detecting the first input that is directed to the first user interface object at the first placement location (11030) (e.g., a drag input that moves the first user interface object from the first placement location to a second placement location on the same page or a different page of the first user interface, or a user input deleting the first user interface object from the first user interface): (prior to placing the first user interface object into a respective placement location different from the first placement location in accordance with the first input (e.g., before the first input is terminated and before the first user interface object is released into a new placement location in the home screen user interface, e.g., on the same page or different page from the page containing the first placement location)) in accordance with a determination that the first user interface object meets overlapping criteria (e.g., including a folder creation criteria) with respect to a fifth user interface object of the plurality of user interface objects that is located in a fourth placement location in the first user interface (e.g., the first user interface object is held over the fifth user interface object, with at least a threshold amount of overlap with the fifth user interface object, and for at least a threshold amount of time) (and that the plurality of user interface objects are application icons), the computer system displays, via the one or more display devices, a respective visual indication that a respective folder containing the fifth user interface object and the first user interface object would be created at the fourth placement location if the first input ended while the respective visual indication was displayed. For example, FIGS. 6W-6Z illustrate that device 100 automatically adds folder 640 to group 6110 that includes application icons 624, 632, 608, 630, and 628, and further, in accordance with a determination that folder 640 is created and the fifth placement location in group 6102 (e.g., corresponding to the first spot in the second row of group 6102) previously occupied by application icon 612 is vacated, the device 100 automatically shifts application icons 614-622 (e.g., which are placed in placement locations subsequent to the vacated placement location) by one placement location following a snaking pattern (FIG. 6X). For example, in some embodiments, when the first user interface object is dragged and hovered over a user interface object of the same type, and the computer system displays a visual indication that a folder will be created at this location if the first user interface object is dropped into this placement location, and the folder will include both the object at the current placement location and the first user interface object. In some embodiments, the computer system distinguishes the user's intent to displace a user interface object from a placement location or to create a folder at the placement location based on whether the dragged object is hovered near the peripheral region of the existing object or directly over the existing object. In some embodiments, the computer system requires movement toward the existing object with at least a threshold speed, in order to displace the existing object from its placement location. Reflowing application icons within a respective automatically-arranged group upon moving a user interface object included in the respective automatically-arranged group and creating a folder with the first user interface object that is being moved and another user interface object of the first type, without reflowing application icons in other groups on the home screen user interface, reduces the number of inputs and/or time needed to re-arrange a page of the home screen user interface while providing additional control to a user for arranging the multi-page home user interface.

In some embodiments, in response to detecting the first input that is directed to the first user interface object at the first placement location (e.g., a drag input that moves the first user interface object from the first placement location to a second placement location on the same page or a different page of the first user interface, or a user input deleting the first user interface object from the first user interface): (prior to placing the first user interface object into a respective placement location different from the first placement location in accordance with the first input (e.g., before the first input is terminated and before the first user interface object is released into a new placement location in the home screen user interface, e.g., on the same page or different page from the page containing the first placement location)) in accordance with a determination that the first user interface object meets overlapping criteria (e.g., widget stacking criteria) with respect to a sixth user interface object of the plurality of user interface objects that is located in a fifth placement location in the first user interface (e.g., the first user interface object is held over the sixth user interface object, with at least a threshold amount of overlap with the sixth user interface object, and for at least a threshold amount of time) (and that the plurality of user interface objects are widgets and not application icons), the computer system displays (11032), via the one or more display devices, a respective visual indication that a widget stack containing the sixth user interface object and the first user interface object would be created at the fifth placement location if the first input ended while the respective visual indication was displayed. For example, in some embodiments, when a widget is dragged and hovered over another widget of the same dimensions, and the computer system displays a visual indication that a widget stack will be created at this location if the dragged widget is dropped into this placement location, and the widget stack will include both the existing widget at the current placement location and the dragged widget. For example, in FIG. 6X-6Z, if one widget was hovered over another widget (e.g., instead of application icon 612 over application icon 626), and the hover meets a widget stack creation criteria, the device 100 reflows application icons in the same group in which the widget that was moved was, to fill up placement locations vacated by the moved application widget. In some embodiments, the computer system distinguishes the user's intent to displace a widget from a placement location or to create a widget stack at the placement location based on whether the dragged widget is hovered near the peripheral region of the existing widget or directly over the existing widget. In some embodiments, the computer system requires movement toward the existing widget with at least a threshold speed, in order to displace the existing widget from its placement location. In some embodiments, the re-arrangement that causes some application icons in a respective automatically-arranged group to reflow without reflowing other application icons (e.g., located outside the respective automatically-arranged group), includes automatically creating a widget stack by dragging one widget on top of another widget. Reflowing application icons in a respective automatically-arranged group upon creating a widget stack by dragging one widget on top of another widget, without reflowing application icons in other groups on the home screen user interface, reduces the number of inputs and/or time needed to re-arrange a page of the home screen user interface while providing additional control to a user for arranging the multi-page home user interface.

In some embodiments, displaying the plurality of user interface objects in the first user interface includes (11034): (optionally, in accordance with a determination that the plurality of user interface objects are a plurality of application icons corresponding to a plurality of applications) in accordance with a determination that a first setting is enabled (and a second setting is not enabled) by a user, displaying, via the one or more display devices, respective labels of the plurality of user interface objects concurrently with the plurality of user interface objects; and in accordance with a determination that a second setting is enabled (and the first setting is not enabled) by a user, forgoing displaying the respective labels of the plurality of user interface objects concurrently with the plurality of user interface objects. For example, FIG. 5AP is a transition from FIG. 5AO in response to the detection of input 5015 selecting control setting 5021 for hiding and unhiding applications icons labels. As illustrated, labels of application icons 5002-5024 are removed. In some embodiments, when the respective labels of the plurality of user interface objects are not displayed with the plurality of user interface objects in accordance with the determination that the second setting is enabled (and the first setting is not enabled), the computer system expands the sizes of the plurality of application icons. In some embodiments, when the first user interface is displayed in a reconfiguration mode, the respective labels for the plurality of user interface objects are displayed, irrespectively of whether the first setting and/or the second setting are enabled. In response to a user request to hide labels associated with application user interface objects on the home screen user interface, the labels are removed across multiple pages of the home screen user interface. In some embodiments, the first setting and the second setting are available to be enabled respectively in a settings user interface for the home screen user interface and/or the application library user interface, and the computer system determines which setting is enabled based on configuration inputs previously received in the settings user interface. In some embodiments, the first setting and/or the second setting are displayed in the reconfiguration mode of the home screen user interface, and the computer system ceases to display the respective labels in response to selection of the second setting in the reconfiguration mode and displays the respective labels in response to selection of the first setting in the reconfiguration mode. Providing an option or a setting to hide or display labels of application icons in the home user interface, provides an additional control over arrangement of the home user interface.

In some embodiments wherein displaying the plurality of user interface objects in the first user interface includes (11036): in accordance with the determination that the first setting is enabled (and the second setting is not enabled) by a user, displaying, via the one or more display devices, at least a first subset of user interface object from the plurality of user interface objects with a first object size (e.g., a set of application icons are respectively displayed with a first icon size, a set of two-by-two widgets are respectively displayed with a first two-by two widget size, or a set of two-by-four widgets are respectively displayed with a first two-by-four widget size), while displaying the respective labels of the plurality of user interface objects concurrently with the plurality of user interface objects; and in accordance with a determination that the second setting is enabled (and the first setting is not enabled) by a user, displaying, via the one or more display devices, at least the first subset of user interface objects from the plurality of user interface objects with a second object size (e.g., the set of application icons are respectively displayed with a second icon size, the set of two-by-two widgets are respectively displayed with a second two-by two widget size, or the set of two-by-four widgets are respectively displayed with a second two-by-four widget size) different from the first object size (e.g., larger than the first object size, wider than the first object size, and/or taller than the first object size), without displaying the respective labels of the plurality of user interface objects concurrently with the plurality of user interface objects. For example, in FIG. 5AP, in conjunction with removing the labels of application icons 5002-5024, the device 100 automatically enlarges respective sizes of application icons 5002-5024 in according with a determination that a setting for hiding the labels is enabled (e.g., while maintain equal relative sizes of application icons 5002-5024). In some embodiments, displaying the plurality of user interface objects in the first user interface includes: in accordance with the determination that the first setting is enabled (and the second setting is not enabled) by a user, displaying, via the one or more display devices, at least a second subset of user interface object from the plurality of user interface objects with a third object size, while displaying the respective labels of the plurality of user interface objects concurrently with the plurality of user interface objects; and in accordance with a determination that the second setting is enabled (and the first setting is not enabled) by a user, displaying, via the one or more display devices, at least the second subset of user interface objects from the plurality of user interface objects with a fourth object size different from the third size (e.g., larger than the third object size, wider than the third object size, and/or taller than the third object size), without displaying the respective labels of the plurality of user interface objects concurrently with the plurality of user interface objects. In some embodiments, the first subset of user interface objects and the second subset of user interface objects correspond to a first object type and a second object type (e.g., application icons vs. two-by-two widgets; application icons vs. two-by-four widgets, or two-by-two widgets vs. two-by-four widgets), respectively, and the first object type and the second object type have different object sizes when displayed without labels, and have different object sizes when displayed with labels. In some embodiments, in response to a user request to hide labels associated with the application user interface objects on the home screen user interface, in conjunction with hiding the labels, the computer system automatically (e.g., without addition user input) enlarges the first subset of user interface objects and the second subset of user interface objects (e.g., application icons, and/or widgets of different widget sizes) on the home screen user interface. In some embodiments, the setting for enabling or disabling the display of labels is available in a settings user interface for the home screen user interface and/or the application library user interface, and the computer system determines which setting is enabled based on configuration inputs previously received in the settings user interface. In some embodiments, the setting for enabling or disabling the display of labels is available in the reconfiguration mode of the home screen user interface, and the computer system ceases to display the respective labels and increases the sizes of the user interface objects (e.g., application icons and widgets of various sizes) in response to selection of the second setting in the reconfiguration mode, and displays the respective labels and reduces the sizes of the user interface objects in response to selection of the first setting in the reconfiguration mode. For example, in FIGS. 5AP-5AO, in conjunction with removing the labels of application icons 5002-5024, the device 100 automatically enlarges respective sizes of application icons 5002-5024 in accordance with a determination that a setting for hiding the labels is enabled (e.g., while maintain equal relative sizes of application icons 5002-5024). Automatically enlarging application user interface objects in conjunction with hiding labels of application icons in response to a user request to hide the labels, automatically improves utilization of space on the home screen user interface, thereby reducing the number of inputs and/or time needed to customize the home screen user interface.

In some embodiments, displaying the plurality of user interface objects in the first user interface includes (11038): in accordance with the determination that the first setting is enabled (and the second setting is not enabled) by a user, displaying, via the one or more display devices, the plurality of user interface objects in accordance with a first layout; and in accordance with a determination that the second setting is enabled (and the first setting is not enabled) by a user, displaying, via the one or more display devices, the plurality of user interface objects in accordance with a second layout, wherein the first layout has a first grid size and the second layout has a second grid size different from the first grid size. For example, in FIGS. 5AP-5AO, in conjunction with removing the labels of application icons 5002-5024 and automatically enlarging respective sizes of application icons 5002-5024 in accordance with a determination that a setting for hiding the labels is enabled (e.g., while maintain equal relative sizes of application icons 5002-5024), the size of a unit of placement location in the grid is enlarged (e.g., the grid size changes from 6×4 to 5×3 or to 4×2). In some embodiments, the grid size is a size of a placement location for a respective application icon and/or a respective user interface object of the first object type. In some embodiments, the grid size includes the size of the user interface object and some spacing around the user interface object when the user interface object is placed within a placement location. In some embodiments, in response to a user request to hide labels associated with the application user interface objects on the home screen user interface, in conjunction with hiding the labels, the computer system automatically (e.g., without addition user input) enlarges respective placement locations available for application icons on the home screen user interface. For example, if a single placement location has a first size that can host a single application icon, the computer system changes the first size to a second larger size in conjunction with hiding the labels in response to the user request to hide labels. In some embodiments, the first setting and the second setting are available to be enabled respectively in a settings user interface for the home screen user interface and/or the application library user interface, and the computer system determines which setting is enabled based on configuration inputs previously received in the settings user interface. In some embodiments, the first setting and/or the second setting are displayed in the reconfiguration mode of the home screen user interface, and the computer system ceases to display the respective labels in response to selection of the second setting and enlarges the grid size in the reconfiguration mode, and displays the respective labels and reduces the grid size in response to selection of the first setting in the reconfiguration mode. Automatically enlarging application user interface objects in conjunction with hiding labels of application icons in response to a user request to hide the labels, automatically improves utilization of space on the home screen user interface, thereby reducing the number of inputs and/or time needed to customize the home screen user interface.

In some embodiments, while displaying, via the one or more display devices, the first user interface in a reconfiguration mode (e.g., a mode for re-arranging icons and/or widgets on pages of the home screen user interface), the computer device displays (11040), via the one or more display devices, one or more controls for enabling the first setting or the second setting (e.g., a toggle for changing between enabling the first setting or the second setting, a toggle for enabling label display or hiding labels, and/or another type of control (e.g., slider control, or multi-states control) that changes grid size, object size(s), and/or label sizes (e.g., from zero to a finite size)). For example, control setting 5021 for hiding and unhiding applications icons labels in FIG. 5AO is optionally displayed on each page of the multi-page home screen user interface (e.g., optionally when the multipage home screen user interface is in the reconfiguration mode, in the normal mode, or both). In some embodiments, the first user interface is home screen user interface (e.g., a user-arranged page of the home screen use interface), and the reconfiguration mode is a mode in which the application objects can be dragged and positions, reflowed, grouped into folders, and/or merged into stacks, in accordance with user inputs. Providing a control for enabling settings for displaying or hiding labels for application icons in a reconfiguration mode provides additional functionality for configuring the first user interface, thereby improves utilization of space on the first user interface and reduces input mistakes and improves efficiency of the first user interface.

In some embodiments, while displaying, via the one or more display devices, the first user interface in a reconfiguration mode (e.g., a mode for re-arranging icons and/or widgets on pages of the home screen user interface), the computer device displays (11042), via the one or more display devices, a first control for displaying an appearance editor user interface, wherein the first control (e.g., control 9006 for activating a color editing user interface in FIG. 9E), when selected, causes the computer system to display a plurality of options for changing an appearance of the first screen user interface, including a second control for enabling the first setting or the second setting (e.g., a toggle for changing between enabling the first setting or the second setting, a toggle for enabling label display or hiding labels). For example, in FIGS. 9E-9F, in response to the detection of tap input 9100 directed to control 9006 for activating a color editing user interface, the device 100 displays color editing user interface 9008 that includes size control 9040 for changing the size of application user interface objects on the home screen to a small size and size control 9042 for changing the size of respective application user interface objects to a large size. In some embodiments, the first user interface is home screen user interface (e.g., a user-arranged page of the home screen use interface), and the reconfiguration mode is a mode in which the application objects can be dragged and positions, reflowed, grouped into folders, and/or merged into stacks, in accordance with user inputs. Providing a control for enabling settings for displaying or hiding labels for application icons in a reconfiguration mode provides additional functionality for configuring the first user interface, thereby improves utilization of space on the first user interface and reduces input mistakes and improves efficiency of the first user interface.

In some embodiments, displaying the plurality of user interface objects in the first user interface includes (11044): in accordance with a determination that a first value is selected for arrangement density of the first object type in the first user interface, displaying, via the one or more display devices, the plurality of user interface objects in the first user interface in an arrangement that has a first arrangement density; and in accordance with a determination that a second value different from the first value is selected for arrangement density of the first object type in the first user interface, displaying, via the one or more display devices, the plurality of user interface objects in the first user interface in an arrangement that has a second arrangement density that is different from the first arrangement density. In some embodiments, arrangement density corresponds to the number of application objects of the same type (e.g., application icons) that can fit within a row and/or column in the grid of placement location of the home user interface. In some embodiments, the arrangement density determines the number of application objects that can fit within one page of the home screen user interface. For example, if the arrangement density is high, the number of placement locations on the home screen user interface is also high, such as a grid of size 6×4 placement locations; if the arrangement density is medium, the number of placement locations on the home screen user interface is also medium, such as a grid of 5×3 placement locations; and if the arrangement density is low, the number of placement locations on the home screen user interface is also low, such as a grid of 4×2 placement locations. For example, in FIGS. 5AP-5AO, in conjunction with removing the labels of application icons 5002-5024 and automatically enlarging respective sizes of application icons 5002-5024 in accordance with a determination that a setting for hiding the labels is enabled (e.g., while maintain equal relative sizes of application icons 5002-5024) or in accordance with a determination that control 9042 for changing the size of respective application user interface objects to a large size is selected (e.g., FIG. 9M), the size of a unit of placement location in the grid is enlarged (e.g., the grid size changes from 6×4 to 5×3 or to 4×2). Providing a control option or a setting to change the arrangement density in the home user interface, provides an additional control over customization of the home user interface.

In some embodiments, displaying the plurality of user interface objects in the first user interface in the arrangement that has the first arrangement density includes (11046) displaying at least a third subset user interface objects (e.g., a set of application icons, a set of two-by-two widgets, or a set of two-by-four widgets) from the plurality of user interface objects with a third object size (e.g., the set of application icons are respectively displayed with a third icon size, the set of two-by-two widgets are respectively displayed with a third two-by two widget size, or the respective set of two-by-four widgets are respectively displayed with a third two-by-four widget size); and displaying the plurality of user interface objects in the first user interface in the arrangement that has the second arrangement density includes displaying at least the third subset user interface objects (e.g., the set of application icons, the set of two-by-two widgets, or the set of two-by-four widgets) from the plurality of user interface objects with a fourth object size different from (e.g., larger size for smaller arrangement density, and smaller size for larger arrangement density) the third object size (e.g., the set of application icons are respectively displayed with a fourth icon size different from the third icon size, the set of two-by-two widgets are respectively displayed with a fourth two-by two widget size different from the third two-by-two widget size, or the set of two-by-four widgets are respectively displayed with a fourth two-by-four widget size different from the third two-by-four widget size). For example, in FIGS. 5AP-5AO, in conjunction with removing the labels of application icons 5002-5024 and automatically enlarging respective sizes of application icons 5002-5024 in accordance with a determination that a setting for hiding the labels is enabled (e.g., while maintain equal relative sizes of application icons 5002-5024) or in accordance with a determination that control 9042 for changing the size of respective application user interface objects to a large size is selected (FIG. 9M), the size of a unit of placement location in the grid is enlarged and density in the grid changes (e.g., from 6×4 to 5×3 or to 4×2). In some embodiments, displaying the plurality of user interface objects in the first user interface in the arrangement that has the first arrangement density includes displaying at least a fifth subset user interface objects from the plurality of user interface objects with a fifth object size; and displaying the plurality of user interface objects in the first user interface in the arrangement that has the second arrangement density includes displaying at least the fifth subset of the plurality of user interface objects with a sixth object size different from the fifth object size. In some embodiments, by specifying the arrangement density of the user interface objects of the first object type, the user also changes the object size of the user interface objects of the first object type in the first user interface (e.g., a larger arrangement density results in a smaller object size, and vice versa). For example, in response to a user request to respective arrangement density of the home user interface, in conjunction with changing the arrangement density according to the user request, the computer system changes sizes of the application objects displayed on the home user interface (and/or size of respective placement locations on the home user interface). Automatically changing respective sizes of application user interface objects in conjunction with changing object density of the hone user interface in response to a user request, automatically improves utilization of space on the home screen user interface, thereby reducing the number of inputs and/or time needed to customize the home screen user interface.

In some embodiments, the plurality of placement locations that are respectively available to accommodate a corresponding user interface object of the first object type are arranged (11048) in a grid of a plurality of rows and a plurality of columns; and the determination that the first user interface object and the one or more second user interface objects form (e.g., are part of or included in) the first automatically-arranged group in accordance with the first grouping criteria includes a determination that the first user interface object and the one or more second user interface objects are arranged in two or more consecutive rows of the plurality of rows and that all placement locations in one or more respective rows other than a last row of the two or more consecutive rows (e.g., the top row in two consecutive rows, the top two rows in three consecutive rows, and/or the top three rows in four consecutive rows) are occupied with corresponding user interface objects of the first object type (e.g., objects from the first user interface object and the one or more second user interface objects). For example, application icons 626, 632, and 608 in the upper row do not merge with application icons 630 and 628 in the row below because the upper row is incomplete (e.g., the first spot in the row is vacant). In some embodiments, the computer system automatically merges groups of application objects into a single group. In some embodiments, two consecutive rows of application objects do not form a group unless the top row is complete and there are no available vacant positions at the top row. For example, if the row has 4 placement locations, all 4 placement locations need to be occupied with a respective user interface object for the row to be complete; if the row has 3 placement locations, all 3 placement locations need to be occupied with a respective user interface object for the row to be complete; and/or if the row has 2 placement locations, all 2 placement locations need to be occupied with a respective user interface object for the row to be complete. In some embodiments, widgets can be used to fill spaces and/or complete rows, but widgets do not form a group with application icons. For example, if application icons included in a group are automatically reflowing upon detecting re-arrangement of a page on the home screen user interface, widgets remain at their respective positions. In some embodiments, the one or more respective rows may include unoccupied placement locations for objects that are smaller than the objects of the first object type. For example, if the objects of the first object type are widgets of 2×2 size, the top rows of 2×2 placement locations may include vacant 1×1 placement locations for application icons, but no vacant 2×2 placement locations for the widgets of 2×2 size. Automatically merging a group of application objects (e.g., application icons) in a complete row (e.g., rows that have no vacant placement locations) with application objects of the same type located in contiguous row below, reduces the number of inputs and/or time needed to rearrange the home screen user interface.

In some embodiments, the last row of the two or more consecutive rows includes (11050) zero or more vacant placement locations (e.g., the vacant placement locations are the last zero or more placement locations in the last row of the two or more consecutive rows). In some embodiments, the computer system automatically forms a group of application objects (e.g., application icons) located in an incomplete row (e.g., a row that has unoccupied placement locations) with applications icons located in a preceding one or more complete rows (e.g., rows that have no vacant placement locations). For example, in FIG. 6AB, in accordance with a determination that application icon 626 is placed into a contiguous location relative to other application icons in group 6112 and in accordance with a determination that the row above application icon 626 is complete (e.g., the third row above the fourth row, where application icon 626 is placed, is complete), the device 100 automatically adds application icon 626 to group 6112. Automatically merging a group of application objects (e.g., application icons) located in an incomplete row (e.g., row that has unoccupied placement locations) with applications icons located in a preceding one or more complete rows (e.g., rows that have no vacant placement locations), reduces the number of inputs and/or time needed to rearrange the home screen user interface.

In some embodiments, before detecting the first input, the first user interface object and the one or more second user interface objects are arranged (11052) in two or more consecutive rows of the plurality of rows with the first user interface object in a top row of the two or more consecutive rows (e.g., the first user interface object is the first object in the top row of the two or more consecutive rows), and all placement locations in the top row are occupied with corresponding user interface objects of the first object type. In the method 11000, in response to detecting a termination of the first input, the computer system places the first user interface object into a respective placement location outside of the two or more consecutive rows of the plurality of rows; and the computer system removes the first user interface object and respective user interface objects in the top row of the two or more rows from the first automatically-arranged group (while keeping other rows of the first automatically arranged group in the first automatically arranged group). For example, FIGS. 6S-6T illustrate that the device 100 breaks up group 6104 of application icon 626, 632 and 608 into two groups (e.g., group 6104 with application icons 632 and 608, and group 6108 of application icon 626), in accordance with a determination that application icon 626 is separated from application icons 632 and 608 in group 6104 and move to non-contiguous location (e.g., in the same row but separated by a vacant placement location from application icons 632 and 608). In some embodiments, when an application object (e.g., an application icon) is removed from a complete row of the two consecutive rows, and respective application objects in the complete row formed a group with respective application objects from a consecutive row before removal of the application object, the computer system automatically breaks the group (e.g., into two groups), such that remaining application objects in the two consecutive rows no longer form one group. Automatically breaking a group of application objects formed by two consecutive rows when an application object (e.g., an application icon) is removed from a complete row of the two consecutive rows with the top row being complete, reduces the number of inputs and/or time needed to rearrange the home screen user interface.

In some embodiments, while displaying, via the one or more display devices, a first set of user interface objects of the first object type in a first row of the plurality of rows, and a second set of user interface objects of the first object type in a second row of the plurality of rows adjacent to the first row, the computing device detects (11054), via the one or more input devices an input that corresponds to adding the first user interface object to the first user interface; and in response to detecting the input that corresponds to adding the first user interface object to the first user interface, in accordance with a determination that all placement locations in the first row are occupied with corresponding user interface objects of the first object type, as a result of adding the first user interface object to the first user interface, the computer system includes respective user interface objects of the first object type in the first row and the second set of user interface objects of the first object type in a second row in a same automatically-arranged group. In some embodiments, in accordance with a determination that an incomplete row is completed as a result of placing an application object in a vacant placement location of the incomplete row, the computer system automatically merges applications objects in the newly completed row with other application objects in one or more consecutive rows. For example, FIGS. 6U-6V illustrate that device 100 automatically merges three groups (e.g., group 6104, group 6106, and group 6108 in FIG. 6U) into one group 6110 (e.g., newly arranged by the device 100) in accordance with a determination that application icon 622 is moved into the only vacant placement location in the fifth row, thereby closing a gap between application object 626 in group 6108, application icons 632 and 608 in group 6104, and application objects 630 and 628 in group 6106. Automatically merging groups of application object as a result of adding objects to vacant placement locations (optionally thereby completing previously incomplete rows), reduces the number of inputs and/or time needed to rearrange the home screen user interface.

In some embodiments, while displaying, via the one or more display devices, a third set of user interface objects of the first object type in a third row of the plurality of rows, and a fourth set of user interface objects of the first object type in a fourth row of the plurality of rows adjacent to the third row, the computer system displays (11056), via the one or more input devices, an input that corresponds to adding a second user interface object of to the first user interface, wherein the second user interface object is of a second object type different from the first object type (e.g., the second user interface is a widget and the first user interface object is an application icon); and in response to detecting the input that corresponds to adding the second user interface object to the first user interface, in accordance with a determination that a threshold amount of available placement locations in the first row (e.g., all available placement locations in the first row or more than half of available placement locations in the first row), other than one or more placement locations occupied by the second user interface object, are occupied with corresponding user interface objects of the first object type, as a result of adding the second user interface object to the first user interface, the computer system includes respective user interface objects of the first object type in the first row and the second set of user interface objects of the first object type in a second row in a same automatically-arranged group. In some embodiments, in accordance with a determination that an incomplete row is completed as a result of placing an application object in a vacant placement location of the incomplete row, the computer system automatically merges applications objects in the newly completed row with other application objects in one or more consecutive rows. For example, FIGS. 6AH-6AK illustrate that the device 100 automatically merges groups 6112, 6116, and 6118 as a result of inserting application widget 653 on home screen page at placement locations occupied by application icons in group 6112, as described in further detail below. In another example, in FIG. 6W, group 6102 includes application icons 602-606, 610, and 612-622 and group 6110 includes application icons 626, 624, 632, 608, 630, and 628 (e.g., after groups 6104, 6106, and 6108 are merged into group 6110 as a result of completing a row and filling a gap by adding application icon 624 to the vacant placement location in the fifth row, as described in relation to FIGS. 6U-6V. Automatically merging groups of application object as a result of adding objects to vacant placement locations (optionally thereby completing previously incomplete rows), reduces the number of inputs and/or time needed to rearrange the home screen user interface.

In some embodiments, the second user interface object is (11058) a widget. In some embodiments, vacant placement locations in incomplete rows are filled up by reflowing application icons as a result of adding a widget (or relocating a widget). For example, FIGS. 6AH-6AK illustrate that the device 100 automatically merges groups 6112, 6116, and 6118 as a result of inserting application widget 653 on home screen page at placement locations occupied by application icons in group 6112, as described in further detail below. Automatically filling vacant placement locations and merging groups of application object as a result of adding or relocating a widget on the home screen user interface, reduces the number of inputs and/or time needed to rearrange the home screen user interface.

In some embodiments, the plurality of user interface objects of the first object type, including the first user interface object, are (11060) a plurality of application icons, and adding the first user interface object to the first user interface includes adding an application icon that fills an unoccupied placement location for application icon between application icons in the first row and application icons in the second row. For example, in accordance with a determination that all placement locations in the first row are occupied with application icons, as a result of adding an application icon to the first user interface (e.g., the added application icon fills the gap between application icons allocated to two consecutive rows of application icons), the computer system includes the application icons in the first row and the application icons in the second row in the same automatically-arranged group (e.g., including the newly added application icon and the application icons that existed in the two rows prior to the addition of the new application icon). For example, in FIG. 6W, group 6102 includes application icons 602-606, 610, and 612-622 and group 6110 includes application icons 626, 624, 632, 608, 630, and 628 (e.g., after groups 6104, 6106, and 6108 are merged into group 6110 as a result of completing a row and filling a gap by adding application icon 624 to the vacant placement location in the fifth row, as described in relation to FIGS. 6U-6V). In some embodiments, in accordance with a determination that an incomplete row is completed as a result of placing an application icon in a vacant placement location of the incomplete row, the computer system automatically merges applications icons in the newly completed row with other application icons in one or more consecutive rows. Automatically merging groups of application icons as a result of adding application icons to vacant placement locations (optionally thereby completing previously incomplete rows), reduces the number of inputs and/or time needed to rearrange the home screen user interface.

In some embodiments, in response to detecting a termination of the first input, the computer system places (11062) the first user interface object in a respective placement location in a first page of the first user interface, wherein the first page of the first user interface does not include a vacant placement location for an object of the first object type prior to placement of the first user interface object in the respective placement location in the first page of the first user interface, and placement of the first user interface object in the respective placement location in the first page of the first user interface causes at least a second user interface object to move out of the first page of the first user interface; and the computer system places the second user interface object in a second page different from the first page (e.g., in new page, or another user-arranged page of the first user interface). For example, input 6228 drags weather widget 653 to a next page on the multi-page home screen user interface. If there is no additional page beyond the currently displayed page in the direction in which the weather widget 653 is being dragged, the device 100 automatically generates a new home screen page, as illustrated in FIG. 6AQ and FIGS. 6AV-6AW (e.g., new page indicator 6006e is added corresponding to home screen page 6008 illustrated in FIGS. 6AV-6AW). In some embodiments, adding an application object on a first page of a multi-page home screen user interface that has no space to accommodate the application object causes the computer system to automatically move other application objects to other pages on the home screen (e.g., adjacent pages with room to accommodate the application objects that are being relocated, or new system-generated page). Automatically displacing or relocating application icons from a first page to a second page to accommodate the addition of an application object on the first page, reduces the number of inputs and/or time needed to rearrange the home screen user interface.

In some embodiments, while displaying, via the one or more display devices, the first user interface, the computer system detects (11064) a second input that corresponds to a request to display a settings user interface for the first user interface, wherein the settings user interface for the first user interface includes representations of a plurality of pages of the first user interface, and a plurality of affordances for changing respective visibility (e.g., hide and/or unhide) of individual pages of the plurality of pages (and, optionally, affordances for deleting individual pages of the plurality of pages, and an interaction mechanism for reordering the plurality of pages). For example, FIG. 6AX illustrates a settings user interface 6020 for reconfiguring pages of a multipage home screen user interface. In some embodiments, pages of the multi-page home screen user interface can be customized in a settings application. For example, in a user interface of a settings application, pages of the home screen user interface can be reordered (e.g., representations of the pages are reordered in a sequence in accordance with user inputs dragging the representations into different ordinal positions in the sequence), deleted (e.g., pages are deleted when deletion affordances corresponding to the different pages are selected by a tap input and air gesture, or other types of selection inputs), and/or select pages can be hidden or un-hidden (e.g., when navigating through the multi-page home screen user interface) (e.g., pages are hidden or unhidden in response to the states of the hide/unhide affordances corresponding to the different pages, and selection of the hide/unhide affordances changes the states of the hide/unhide affordances). Providing a dedicated user interface for customizing the multi-page home screen user interface, provides additional control to the user and/or reduces the time and/or number of inputs need to customize the multi-page home screen user interface.

In some embodiments, while displaying, via the one or more display devices, the first user interface with the plurality of user interface objects of the first type in the first arrangement, the computer system detects (11066), via the one or more input devices, a third input directed to a third user interface object of a third object type different from the first object type (e.g., user objects of the first object type are application icons and user interface objects of the third object type are widgets). In response to detecting the third input that is directed to the third user interface object (e.g., a drag input that moves the third user interface object on the same page or across different pages of the first user interface, or a user input deleting the third user interface object from the first user interface): in accordance with a determination that a first subset of one or more user interface objects of a fourth automatically-arranged group no longer meets the first grouping criteria with respect to a second subset of one or more other user interface objects of the fourth automatically-arranged group (e.g., the fourth automatically-arranged group is formed by the computer system prior detecting the third input) (e.g., the automatically-arranged group is formed based on spatial proximity and locations of the user interface objects of the same type, and the first subset of user interface objects and the second subset of user interface objects are separated by a gap when the third user interface object is moved away from between the first subset of user interface objects and the second subset of user interface objects), the computer system separates the first subset of user interface objects of the fourth automatically-generated group and the second subset of user interface objects of the fourth automatically-generated group into different automatically-generated groups (e.g., foregoing reflowing the user interface objects in the first subset and/or second subset of user interface objects to maintain them in a single group). In response to detecting the third input that is directed to the third user interface object (e.g., a drag input that moves the third user interface object on the same page or across different pages of the first user interface, or a user input deleting the third user interface object from the first user interface): in accordance with a determination that one or more user interface objects of a fifth automatically-arranged group and one or more user interface objects of a sixth automatically-arranged group meet the first grouping criteria (e.g., the fifth and sixth automatically-arranged groups were formed by the computer system prior detecting the third input) (e.g., the automatically-arranged group is formed based on spatial proximity and locations of the user interface objects of the same type, and the fifth and sixth automatically-arranged groups are merged when the third user interface object fill a gap between the two automatically-arranged groups), the computer system includes user interface objects of the fifth automatically-arranged group and user interface objects of the sixth automatically-arranged group in a seventh automatically-arranged group (e.g., merging the two separate groups in a single group when the third user interface object fills the gap between the two groups). For example, FIGS. 6AH-6AK illustrate that the device 100 automatically merges groups 6112, 6116, and 6118 as a result of inserting application widget 653 on home screen page at placement locations occupied by application icons in group 6112, as described in further detail below. Automatically merging or separating groups of application object as a result of moving objects to vacant placement locations and/or completing previously incomplete rows, reduces the number of inputs and/or time needed to rearrange the home screen user interface.

In some embodiments, the determination that the first subset of one or more user interface objects of the fourth automatically-arranged group no longer meets the first grouping criteria with respect to the second subset of one or more other user interface objects of the fourth automatically-arranged group includes (11068) a determination that less than a threshold amount of available placement locations for user interface objects (e.g., at least one placement location for user interface objects of the first object type) is unoccupied between the first subset of one or more user interface objects of the fourth automatically-arranged group and the second subset of one or more user interface objects of the fourth-automatically-arranged group, as a result of removing the third user interface object from a third placement location in the fourth automatically-arranged group (e.g., deleted or moved to a different placement location). FIGS. 6AL-6AQ illustrate that application icons in group 6122 on home screen page 6006 automatically reflow in accordance with a determination that application widget 653 is removed from group 6122 (e.g., by repositing the application widget to a next page) without automatically reflowing application icons in groups 6124 and 6126 on the same home screen page 6006, as described in further detail below with reference to FIGS. 6AL-6AQ. Automatically separating groups of application object as a result of moving objects to vacant placement locations reduces the number of inputs and/or time needed to rearrange the home screen user interface.

In some embodiments, the determination that one or more user interface objects of the fifth automatically-arranged group and one or more user interface objects of the sixth automatically-arranged group meet the first grouping criteria includes (11070) a determination that a threshold amount of available placement location for user interface objects of the first object type between the fifth automatically-arranged group and sixth automatically arranged group are occupied (e.g., all available placement locations between the fifth-automatically arranged group and the sixth automatically arranged group are occupied or more than half of available placement locations between the fifth-automatically arranged group and the sixth automatically arranged group are occupied), as a result of adding the third user interface object to a fourth placement location between the fifth automatically-arranged group and the sixth automatically arranged group. For example, FIGS. 6AH-6AK illustrate that the device 100 automatically merges groups 6112, 6116, and 6118 as a result of inserting application widget 653 and adds application widget 653 to group 6112, as described in further detail below. Automatically merging groups of application object as a result of completing previously incomplete rows, reduces the number of inputs and/or time needed to rearrange the home screen user interface.

It should be understood that the particular order in which the operations in FIGS. 11A-11H have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 12000, 13000, and 14000) are also applicable in an analogous manner to method 14000 described above with respect to FIGS. 11A-11H. For example, the controls, user interfaces, and user inputs described above with reference to method 11000 optionally have one or more of the characteristics of the controls, user interfaces, and user inputs described herein with reference to other methods described herein (e.g., methods 10000, 12000, 13000, and 14000). For brevity, these details are not repeated here.

FIGS. 12A-12H are flow diagrams of an exemplary method 12000 for modifying system-generated categorization of applications into groups and arranging the groups in an application library user interface, in accordance with some embodiments. In some embodiments, the method 12000 is performed at a computer system that is in communication one or more display devices and one or more input devices (e.g., including one or more sensors for detecting user inputs). In some embodiments, the method 12000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 12000 are, optionally, combined and/or the order of some operations is, optionally, changed.

In the method 12000, the computer system detects (12002) a first event (e.g., detecting an input that dismisses the wake screen and displays the home screen user interface, detecting an input that dismisses a currently displayed application user interface and displaying the home screen user interface, displaying an input that causes navigation from one page to another page of the home screen user interface, or other inputs and/or events that causes the display of the home screen user interface, or another system user interface (e.g., widget user interface, search user interface, or application library user interface) that displays the application suggestion widget). In response to detecting the first event, the computer system displays (12004), via the one or more display devices, a first page of a home screen user interface, including: displaying (12006), via the one or more display devices, a first plurality of application icons in accordance with a first arrangement that was established in the first page of the home screen user interface (e.g., in accordance with one or more previous user inputs adjusting respective placement locations of one or more of the first plurality of application icons) (e.g., the first arrangement was established in accordance with user inputs selecting and repositioning application icons and/or widgets in a reconfiguration mode of the home screen user interface) (e.g., the first page of the home screen user interface is a user-configured page of the home screen user interface, as opposed to a system-generated application library user interface that includes application icons automatically grouped and placed into respective placement locations in the application library user interface). In response to detecting the first event, displaying, via the one or more display devices, a first page of a home screen user interface, further includes (12008) displaying, via the one or more display devices, at least a respective set of application icons in a first region (e.g., the region corresponding to a first widget placement location for a first widget, such as an application category widget, or application suggestion widget) in the first page of the home screen user interface, wherein the respective set of application icons included in the first region are automatically selected by the computer system in accordance with a respective category associated with the first region (e.g., associated with the application category widget or application suggestion widget placed at the first widget placement location). Displaying the respective set of application icons in the first region includes: in accordance with a determination that the first region is associated with a first category (e.g., an applications category, such as games, social media, utilities, fitness and health, travel and leisure, and/or other category associated with applications optionally available on the computer system), displaying (12010), via the one or more display devices, a first set of application icons associated with the first category in the first region; and in accordance with a determination that the first region is associated with a second category different from the first category, displaying (12012), via the one or more display devices, a second set of application icons associated with the second category in the first region, wherein the second set of application icons are different from the first set of application icons. In some embodiments, the computer system assigns applications into different system-generated groupings of applications that are associated with different categories (e.g., entertainment, fitness, tools, social networking, photography, cooking, communication, messaging, puzzle games, online gaming, and/or other categories). For example, home screen page 7002 in FIG. 7A, displays two different application category widgets 7102 and 7104 assigned different application categories. For example, application category widget 7102 assigned the productivity application category and an application category widget 7104 assigned the utilities application category are concurrently displayed on home screen page 7002 with a respective label below the respective application category widgets. In some embodiments, the application icons of the different applications are arranged into representations of the different groupings in the application library user interface based on the categories of the applications. In some embodiments, the computer system displays an application suggestion widget or application category widget (e.g., a widget of two rows and four columns of application icons, a widget of two rows and two columns of application icons, or some other sizes) at a first placement location (e.g., a user-selected location, or a system-selected location) on the user-arranged home screen user interface (e.g., as opposed to the application library user interface). In some embodiments, the computer system also allows the user to assign or specify a preferred category for the application category widget or application suggestion widget for the first placement location, and in accordance with the user's preferred category for the first placement location, the computer system automatically selects, e.g., from among the applications in the grouping of the preferred category, the respective set of applications, and displays their application icons in the application category widget or application suggestion widget displayed at the first placement location.

As described herein, method 12000 provides an improved technique for organizing application icons per category on a home screen user interface. Instead of manually creating folders or arranging application icons of the same application category in regions on a page, an application category widget displays multiple application icons of the same category in the page of the home screen user interface. The category assigned to the application category widget can be changed by a user. For example, an assigned category is modifiable in response to a first input directed to the application category widget and optionally a second input directed to a selectable option that is displayed (e.g., a in a contextual or quick action menu) in response to the first input. Further, respective application icons included in an application category widget dynamically selected (e.g., change over time) by the computer system, e.g., based on contextual information, usage patterns, and/or events occurring in the computer system or respective applications. Multiple application category widgets can be placed on a page of the home screen user interface, and respective widgets optionally can be assigned a different application category. Adding application category widgets on the home screen user interface, reduces the number of inputs and/or time needed to arrange application icons per application category on a page of the home screen user interface while also providing additional control to a user for specifying location, number, and/or category of application category widget; and/or reduces the number of inputs and/or time needed to locate an application icon on the home screen user interface.

In some embodiments, after displaying the first page of the home screen user interface in response to detecting the first event, the computer system ceases to display (12014) the first page of the home screen user interface (e.g., due to user inputs for displaying other system user interfaces, other pages of the home screen user interface, applications, and/or conditions for entering a power saving mode). After ceasing to display the first page of the home screen user interface, the computer system detects a second event (e.g., detecting an input that dismisses the wake screen and displays the home screen user interface, detecting an input that dismisses a currently displayed application user interface and displaying the home screen user interface, displaying an input that causes navigation from one page to another page of the home screen user interface, or other inputs and/or events that causes the display of the home screen user interface, or another system user interface (e.g., widget user interface, search user interface, or application library user interface) that displays the application suggestion widget). In response to detecting the second event, the computer system displays, via the one or more display devices, the first page of the home screen user interface. Displaying the first page of the home screen user interface includes: displaying, via the one or more display devices, the first plurality of application icons in accordance with the first arrangement that was established in the first page of the home screen user interface (e.g., in accordance with the one or more previous user inputs adjusting the respective placement locations of the one or more of the first plurality of application icons) (e.g., the selection and placement locations of the first plurality of application icons remain unchanged since the previous display of the first page of the home screen user interface, if the home screen user interface has not been reconfigured by the user between the first event and the second event); and displaying, in the first region in the first page of the home screen user interface (e.g., at the same location as the previous time that the first region was displayed, if the first region has not been repositioned in the first page of the home screen user interface by the user between the first event and the second event), the respective set of application icons that are automatically selected by the computer system in accordance with the respective category associated with the first region. Displaying, in the first region in the first page of the home screen user interface, the respective set of application icons that are automatically selected by the computer system in accordance with the respective category associated with the first region includes: in accordance with a determination that the first region is associated with the first category, displaying, via the one or more display devices, a third set of application icons associated with the first category in the first region, wherein the third set of application icons are different from the first set of application icons and the second set of application icons (e.g., one or more application icons of the first category are removed from the first region and replaced with one or more application icons of the same first category); and in accordance with a determination that the first region is associated with the second category different from the first category, displaying, via the one or more display devices, a fourth set of application icons associated with the second category in the first region, wherein the fourth set of application icons are different from the first set of application icons, the second set of application icons, and the third set of application icons (e.g., one or more application icons of the second category are removed from the first region and replaced with one or more application icons of the same second category). For example, even though the category associated with the first region does not change, the respective set of application icons that are chosen from the category and displayed in the first region can be different at different times that the first page of the home screen user interface is displayed, in accordance with some embodiments. For example, in FIG. 7A, application icons 7102a-7102d included application category widget 7102 and/or application icons 7104a-7104d included application category widget 71024 are updated by device 100 dynamically over time based on a change of context. In some embodiments, application icons in the application category widget are dynamically and automatically selected by the computer system in response detecting a change of context of the computer system (e.g., time, place, location, incoming communication, ongoing activity on the computer system, and/or other contextual change), an event detected in an application of the same category, detecting a change in usage of applications installed on the computer system, detecting that one or more new applications of the same category are installed (downloaded) on the computer system or removed (uninstalled) from the computer system, and/or other changes associated with the computer system and/or applications installed on the computer system. In some embodiments, application icons in the application category widget can be deleted in response to a user input, and the compute system automatically replaces the deleted application icon with another application icon of the same application category that was previously not included in the application category widget. Dynamically selecting and updating application icons in the application category widget, reduces the number of inputs and/or time needed to arrange application icons of the same category on a page of the home screen user interface and/or reduces the number of inputs and/or time needed to locate an application icon on the home screen user interface.

In some embodiments, displaying the respective set of application icons in the first region (e.g., in response to detecting the first event, or the second event) includes (12016), in accordance with a determination that the first region (e.g., application category widget) is associated with a third category different from the first category and the second category, displaying, via the one or more display devices, a fifth set of application icons associated with the third category in the first region, wherein the fifth set of application icons are different from the first set of application icons and the second set of application icons (and, optionally, different from the third set and fourth set of application icons). In some embodiments, a respective application category widget can be assigned different application category selected from a number of application categories. FIGS. 7B-7E illustrate techniques from changing the application category assigned to application category widget 7102 from the productivity application category to a communications application category, and FIGS. 7F-7I illustrate techniques from changing the application category assigned to application category widget 7104 from the utilities application category to a games application category. Displaying application icons in an application category widget (e.g., a dedicated placement region for which application category can be specified) in accordance with assigned application category, reduces the number of inputs and/or time needed to arrange application icons per application category on a page of the home screen user interface while also providing additional control to a user for specifying location, number, and/or category of application category widget.

In some embodiments, prior to detecting the first event, the computer system displays (12018), via the one or more display devices, a first plurality of selectable options for configuring a respective category associated with the first region (e.g., in response to detecting a request to display configuration options for the first region), wherein: in accordance with a determination that a first collection of applications is associated with the computer system, the first plurality of selectable options corresponds to a first set of categories, and in accordance with a determination that a second collection of applications, different from the first collection of applications, is associated with the computer system, the first plurality of selectable options corresponds to a second set of categories, different from the first set of categories. For example, in some embodiments, depending on the collection of applications that are installed and/or downloaded onto the computer system, the computer system generates different sets of categories based on the collection of applications, and the set of categories are presented as options for selection by a user as the respective category for the first region (e.g., for the application suggestion widget to be displayed at the first placement location) differ depending on what categories were generated based on the collection of applications installed on the computer system. For example, in FIG. 7D, device 100 automatically (e.g., and, optionally, dynamically) changes application categories displayed in the listing 7003a, e.g., based on new applications being installed or other applications being uninstalled from the device 100 (or otherwise removed or respectively added to device 100). In some embodiments, selectable options for changing an application category associated with an application category widget are displayed in response to an input directed at the application category widget (e.g., in response to a long press, long touch, long pinch and/or other user input). In some embodiments, application categories that can be assigned to an application category widget change dynamically based on applications that are available on the computer system (e.g., application categories change over time based on new applications being installed or uninstalled from the computer system). Dynamically updating application categories that can be assigned to an application category widget based on applications that are available on the computer system, reduces the number of inputs and/or time needed to arrange application icons per application category on a page of the home screen user interface (e.g., by reducing the need to manually create application categories).

In some embodiments, after displaying the first plurality of selectable options for configuring a respective category associated with the first region while the first collection of applications is associated with the computer system, the computer system detects (12020), via the one or more input devices, one or more inputs corresponding to a request to display configuration options for the first region after one or more applications from the first collection of applications are no longer associated with the computer system (e.g., in response to user input deleting the one or more first applications from the computer system, or the one or more first applications becoming unusable on the computer system due to system update or lapse of licenses for the one or more first applications). In response to detecting the one or more inputs corresponding to the request to display configuration options for the first region after one or more applications from the first collection of applications are no longer associated with from the computer system, the computer system displays, via the one or more display devices, the first plurality of selectable options for configuring a respective category associated with the first region (e.g., in response to a request to display a set of configuration options for the first region), wherein the first plurality of selectable options corresponds to a third set of categories, different from the first set of categories (e.g., based on a current set of applications that are associated with the computer system) (e.g., the computer system is no longer associated with the first collection of applications after the removal of the one or more first applications from the computer system, and the computer system regenerated the categories for the computer system based on the remaining applications that are still associated with the computer system, such that some previous generated categories are merged and/or deleted). For example, in some embodiments, application categories change over time based on new applications being installed or other applications being uninstalled from the computer system (or otherwise removed or respectively added to the computer system). For example, in FIG. 7D, device 100 automatically (e.g., and, optionally, dynamically) changes application categories displayed in the listing 7003a, e.g., based on new applications being installed or other applications being uninstalled from the device 100 (or otherwise removed or respectively added to device 100. Changing application categories over time includes merging two or more application categories into one application category (e.g., as a result of removing applications from the computer system), in some embodiments. Dynamically updating application categories that can be assigned to an application category widget, including merging two or more application categories into one application category, reduces the number of inputs and/or time needed to arrange application icons per application category on a page of the home screen user interface (e.g., by reducing the need to manually create or remove application categories).

In some embodiments, while the second collection of applications is associated with the computer system, the computer system detects (12022) that one or more second applications are added to the computer system (e.g., in response to user input installing the one or more second applications onto the computer system, or the one or more second applications becoming available on the computer system due to activation of licenses for the one or more second applications), wherein the computer system is associated with a fourth collection of applications due to addition of the one or more second applications to the computer system (e.g., the fourth collection of applications includes applications in the second collection of applications and the one or more second applications that are added to the computer system). After the computer system detects that the one or more second applications are added to the computer system, and while the computer system is associated with the fourth collection of applications, the computing device displays, via the one or more display devices, the first plurality of selectable options for configuring a respective category associated with the first region (e.g., in response to a request to display a set of configuration options for the first region). In some embodiments, the first plurality of selectable options corresponds to a fourth set of categories, different from the second set of categories, in accordance with a determination that the fourth collection of applications is associated with the computer system (e.g., the computer system is no longer associated with the second collection of applications after the addition of the one or more second applications to the computer system, and the computer system regenerated the categories for the computer system based on the new collection of applications that are associated with the computer system, such that one or more new categories are created and/or one or more old categories are split into new categories). For example, in FIG. 7D, device 100 automatically (e.g., and, optionally, dynamically) changes application categories displayed in the listing 7003a, e.g., based on new applications being installed or other applications being uninstalled from the device 100 (or otherwise removed or respectively added to device 100. Changing application categories over time includes splitting an application category into two or more application categories (e.g., as a result of adding applications to the computer system and increasing the number of applications), in accordance with some embodiments. Dynamically updating application categories that can be assigned to an application category widget, including splitting an application category into two or more application categories, reduces the number of inputs and/or time needed to arrange application icons per application category on a page of the home screen user interface (e.g., by reducing the need to manually create or remove application categories).

In some embodiments, displaying, via the one or more display devices, the first page of the home screen user interface includes (12024), concurrently displaying, via the one or more display devices, respective sets of application icons in a plurality of regions (e.g., in a plurality of application category widgets) in the first page of the home screen user interface, including displaying the respective set of application icons in the first region (e.g., in a first category widget), and displaying at least one additional set of application icons in a second region (e.g., in a second category widget) different from the first region. Displaying, via the one or more display devices, the additional set of application icons in the second region in the first page of the home screen user interface includes: in accordance with a determination that the second region is associated with a fourth category, displaying, via the one or more display devices, a sixth set of application icons associated with the fourth category in the second region; and in accordance with a determination that the second region is associated with a fifth category different from the fourth category, displaying, via the one or more display devices, a seventh set of application icons associated with the fifth category, different from the sixth set of application icons associated with the fourth category, in the second region. For example, home screen page 7002 in FIG. 7A, displays two different application category widgets 7102 and 7104 assigned different application categories. For example, application category widget 7102 assigned the productivity application category and an application category widget 7104 assigned the utilities application category are concurrently displayed on home screen page 7002 with a respective label below the respective application category widgets. In some embodiments, multiple application category widgets are displayed on the same or different pages of the home screen user interface and optionally some of the multiple application category widgets are assigned different application categories and optionally others application category widgets are assigned the same application category. In some embodiments, application icons in respective application category widgets of the multiple application category widgets change over time dynamically. Displaying application icons in an application category widget (e.g., a dedicated placement region for which application category can be specified) in accordance with assigned application category, reduces the number of inputs and/or time needed to arrange application icons per application category on a page of the home screen user interface while also providing additional control to a user for specifying location, number, and/or category of application category widget.

In some embodiments, displaying, via the one or more display devices, the first page of the home screen user interface includes (12026) concurrently displaying, via the one or more display devices, the first set of application icons associated with the first category in the first region (e.g., in a first application category widget), the sixth set of application icons associated with the fourth category in the second region (e.g., in a second application category widget), and the first category is different from the fourth category. For example, in FIG. 7A, application category widget 7102 assigned the productivity application category and an application category widget 7104 assigned the utilities application category are concurrently displayed on home screen page 7002 with a respective label below the respective application category widgets. In some embodiments, multiple application category widgets that are displayed on the same page of the home screen user interface can be assigned different application categories, and each respective application category widget displays application icons of a respective application category assigned to the respective application category widget. Displaying multiple application category widgets assigned different categories on the same or different page of the home screen user interface, reduces the number of inputs and/or time needed to arrange application icons per application category on a page of the home screen user interface.

In some embodiments, displaying, via the one or more display devices, the first page of the home screen user interface includes (12028), concurrently displaying, via the one or more display devices, the second set of application icons associated with the second category in the first region, and the seventh set of application icons associated with the fifth category in the second region, wherein the second category and the fifth category are a same category. In some embodiments, multiple application category widgets that are displayed on the same page of the home screen user interface can be assigned or associated with the same application category, and a respective application category widget displays application icons of a respective application category assigned to the respective application category widget. For example, in FIG. 7A, application category widget 7102 assigned the productivity application category and displayed on home screen page 7002 concurrently with an application category widget 7104 assigned the utilities application category can also be modified to display application icons from the utilities category. Displaying multiple application category widgets assigned the same category on the same or different page of the home screen user interface, reduces the number of inputs and/or time needed to arrange application icons of the same application category on a page of the home screen user interface.

In some embodiments, when the second set of application icons associated with the second category is displayed in the first region and the seventh set of application icons associated with the fifth category is displayed in the second region, the second set of application icons and the seventh set of application icons are selected (12030) so as to avoid including a same application icon in both the second set of application icons and the seventh set of application icons (e.g., duplication of application icons in the first region and the second region is avoided even though the first region and the second region are associated with the same category of applications). For example, if one application icon is displayed in a first application widget, the same application icon is removed from display in a second application widget that is assigned the same application category as the first application widget. For example, if application category widget 7102 and application category widget 7104 in FIG. 7A are assigned the same application category, the device 100 automatically removes a duplicate application icon from one of the application category widgets 7102 and 7104. In some embodiments, two application category widgets that are assigned the same category display one or more duplicate application icons. Deduplicating or removing duplicate application icons displayed in different application widget of the same category, improves relevancy of the application icons in application category widgets, reduces the number of inputs and/or time needed to arrange application icons per application category on a page of the home screen user interface.

In some embodiments, while the first region (e.g., first application category widget) is associated with the second category and the second region (e.g., second application category widget) is associated with the second category (e.g., the fifth category is the same as the second category) the computer system displays (12032), via the one or more display devices, a first affordance in association with the first region; detecting selection of the first affordance. In response to detecting the selection of the first affordance, the computer system displays, via the one or more display devices, a first listing of application icons for applications associated with the second category. While the first region is associated with the second category and the second region is associated with the second category (e.g., the fifth category is the same as the second category), the computer system displays, via the one or more display devices, a second affordance in association with the second region. The computer system detects selection of the second affordance. In response to detecting the selection of the second affordance, the computer system displays, via the one or more display devices, the first listing of application icons for applications associated with the second category. For example, when a “show category” affordance is displayed in association with a respective application category widget placed at a respective placement location, the computer system displays the listing of applications for the category associated with that application category widget and/or the respective placement location. For example, listing 7003a of selectable options displayed in association with application category widget 7102 in FIG. 7D is the same as listing 7003a displayed in association with application category widget 7104 in FIG. 7H. When the “show category” affordance is displayed in association with another application category widget placed at a different placement location, the computer system displays the same listing of applications for the category associated with that application category widget and/or the placement location, if the two application category widgets and/or placement locations are associated with the same category. In some embodiments, the list of application includes selectable options for changing respective category associated with the first application category widget and the second application category widget. In some embodiments, the list of selectable options in accessible from a contextual menu associated with the first application category widget and the second application category widget. Displaying the same list of selectable options for changing a respective application category with respect to the first and second application category widgets that are assigned the same category, reduces the number of inputs and/or time needed to assign the same or different application category to two or more application category widgets on a page of the home screen user interface.

In some embodiments displaying, via the one or more display devices, the first set of application icons associated with the first category in the first region includes (12034): in accordance with a determination that a first set of contextual conditions (e.g., conditions based on time, time of day, day of the week, the currently active mode that modify notification delivery at the computer system, location of the computer system, recent user interaction with the computer system, usage pattern, and/or other contextual conditions) are met, displaying, via the one or more display devices, a first subset of application icons from a respective plurality of application icons associated with the first category, in the first region; and in accordance with a determination that a second set of contextual conditions (e.g., conditions based on time, time of day, day of the week, the currently active mode that modify notification delivery at the computer system, location of the computer system, recent user interaction with the computer system, usage pattern, and/or other contextual conditions), different from the first set of contextual conditions, are met, displaying, via the one or more display devices, a second subset of application icons, different from the first subset of application icons, from the respective plurality of application icons associated with the first category, in the second region. For example, in FIG. 7A, application icons 7102a, 7102b 7102c, and 7102d displayed in application widget 7102 can automatically change over time based on change of context, and application icons 7104a, 7104b 7104c, and 7104d in application widget 7104 can also automatically change over time based on the same or different event that changes the context. In some embodiments, application icons in the application category widget are automatically selected by the computer system in response detecting a change of context of the computer system (e.g., time, place, location, incoming communication, ongoing activity on the computer system, and/or other contextual change); in response detecting an event in an application of the same application category as the application category widget; in response to detecting a change in usage of applications installed on the computer system (e.g., user activity); in accordance with determination that a respective mode, such as a focus mode, is enabled or disabled; in response to detecting that one or more new applications are installed (downloaded) on the computer system or removed (uninstalled) from the computer system, and/or other changes associated with the computer system and/or applications installed on the computer system. In some embodiments, the above-mentioned examples of contextual conditions are also used as the contextual conditions for selecting application icons for displaying in an application suggestion widget (e.g., displayed on the wake screen, home screen, widget screen, search interface, or other system user interfaces), selecting widgets for inclusion in a dynamic widget stack that includes a collection of multiple automatically selected widgets for a respective placement location, and/or selecting the currently displayed widget from a collection of multiple widgets that is associated with the same placement location. In some embodiments, the above-mentioned examples of contextual conditions are also used as contextual conditions for other scenarios where visual feedback and/or responses to inputs are customized based on context surrounding the computer system at the time. Dynamically selecting and updating application icons in the application category widget based on context associated with the computer system and/or events occurring in applications installed on the computer system, improves relevance of application icons displayed in the application category widget and/or reduces the number of inputs and/or time needed to locate an application icon on the home screen user interface.

In some embodiments, displaying, via the one or more display devices, the first set of application icons associated with the first category in the first region includes (12036): in accordance with a determination that a first sorting parameter is enabled (e.g., for the first region, or for some or all regions that display application suggestion widgets) by a user (e.g., sorting based on application name, access recency, access frequency, and/or other sorting parameters), displaying, via the one or more display devices, the first set of application icons with a first sorting order (e.g., sorted according to increasing or decreasing values of the first sorting parameter for the first set of application icons) in the first region; and in accordance with a determination that a second sorting parameter, different from the first sorting parameter, is enabled (e.g., for the first region, or for some or all regions that display application suggestion widgets) by a user (e.g., sorting based on application name, access recency, access frequency, and/or other sorting parameters), displaying, via the one or more display devices, the first set of application icons with a second sorting order (e.g., sorted according to increasing or decreasing values of the second sorting parameter for the first set of application icons), different from the first sorting order, in the first region. In some embodiments, a user can specify sorting criteria for application icons displayed in an application category widget. For example, in FIG. 7D, configuration user interface 7003 includes configuration option 760 for selecting a sorting order according to which application icons (e.g., application icons 7010a-7010d) are displayed in the application category widget (e.g., application category widget 7102). Displaying application icons in an application category widget in accordance with user-selected order criteria, reduces the number of inputs and/or time needed to arrange application icons of the same application category on a page of the home screen user interface (e.g., by reducing the need to manually order application icons of the same application category).

In some embodiments, the first set of applications associated with the first category is displayed (12038) in the first region concurrently with a first additional set of application icons associated with a first additional category (e.g., a third set of applications associated with a third category, or another set of applications associated with another category) in a third region (e.g., the second region, or another region different from the first region and the second region) in the first page of the home screen user interface. In accordance with a determination that the first sorting parameter is enabled by a user (e.g., sorting based on application name, access recency, access frequency, and/or other sorting parameters) for the first region, the computer system displays, via the one or more display devices, the first set of application icons with a first sorting order (e.g., sorted according to increasing or decreasing values of the first sorting parameter for the first set of application icons) in the first region, wherein the first sorting order is based on the first sorting parameter. In accordance with a determination that a third sorting parameter, different from the first sorting parameter, is enabled by a user (e.g., sorting based on application name, access recency, access frequency, and/or other sorting parameters) for the third region, the computer system displays, via the one or more display devices, the first additional set of application icons with a third sorting order (e.g., sorted according to increasing or decreasing values of the third sorting parameter for the first additional set of application icons) in the third region, wherein the third sorting order is based on the third sorting parameter. In some embodiments, different or the same sorting criteria can be specified for different application category widgets. For example, sorting order 760b corresponding to recency of usage is selected in association with application widget 7104 (as described in relation to FIGS. 7G-7H), and sorting order 760a corresponding to frequency of usage is selected is selected in association with application widget 7102 (as described in relation to FIGS. 7C-7D). Displaying application icons in an application category widget in accordance with specified sorting order, reduces the number of inputs and/or time needed to arrange application icons of the same application category on a page of the home screen user interface (e.g., by reducing the need to manually order application icons of the same application category).

In some embodiments, the computer system displays (12040), via the one or more display devices, a third affordance (e.g., in response to a user input directed to a respective application icon in the first set of application icons displayed in the first region) in association with a respective application icon in the first set of application icons displayed in the first region of the first page of the home screen user interface, wherein the first set of application icons is displayed in accordance with the determination that the first region (e.g., application category widget) is associated with the first category (e.g., respective application category). The computer system detects, via the one or more input devices, selection of the third affordance (e.g., tap input on a “show category” affordance). In response to detecting the selection of the third affordance: in accordance with a determination that the respective application icon is a first application icon, the computer system displays, via the one or more display devices, a first listing of categories associated with the first application icon; and in accordance with a determination that the respective application icon is a second application icon different from the first application icon, the computer system displays, via the one or more display devices, a second listing of categories associated with the second application icon, wherein the first listing of categories and the second listing of categories both include the first category (and optionally, the first listing and the second listing include different sets of categories). In some embodiments, a contextual menu associated with an application icon displayed in a respective application category widget includes a selectable option (e.g., a “show category” affordance) that, when selected, causes the computer system to display a list of selectable options corresponding application categories associated the application icon. For example, configuration option 7702 displayed in in-line editing user interface 7700, when selected, causes device 100 to displays a listing 7003a of selectable options 750-757 corresponding to available categories that can be associated with the currently selected application category widget 7102 (e.g., as illustrated in FIGS. 7C-7D). In some embodiments, the category associated with the application icon can be changed in response to selecting a respective selectable option in the list of selectable options corresponding application categories. Viewing or changing one or more application categories associated with an application icon displayed in an application category widget reduces the number of inputs and/or time needed to arrange application icons per application category on a page of the home screen user interface.

In some embodiments, while displaying, via the one or more display devices, the respective set of application icons in the first region, the computer system displays (12042), via the one or more display devices, a respective indication of the respective category (e.g., a name or textual label of the application category that is assigned to the application category widget) that is associated with the first region (e.g., application category widget). Displaying the respective indication of the respective category that is associated with the first region includes: in accordance with the determination that the first region is associated with the first category, displaying, via the one or more display devices, a first indication identifying the first category, concurrently with the first set of application icons in the first region; and in accordance with the determination that the first region is associated with the second category, displaying, via the one or more display devices, a second indication identifying the second category, concurrently with the second set of application icons in the first region. For example, in FIG. 7A, label 7103 indicates that application category widget 7102 is assigned the productivity application category, and label 7105 indicates that application category widget 7104 is assigned the utilities application category. In some embodiments, concurrently with displayed application icons in an application category widgets, a label indicating respective application category of the application category widget is displayed. In some embodiments, the label is displayed in near (e.g., above or below) the application category widget. Displaying a label indicating respective application category of the application category widget concurrently with application icons displayed in the application category widget reduces the number of inputs and/or time needed to locate an application icon on the home screen user interface.

In some embodiments, while displaying, via the one or more display devices, the first page of the home screen user interface (e.g., user-arranged page), including the respective set of application icons in the first region of the first page of the home screen user interface, the computer system detects (12044), via the one or more input devices, a user request to display an application library user interface of the computer system (e.g., system arranged user interface that includes representations of groups of applications optionally arranged per application category or other type of criteria) (e.g., a system user interface that includes respective representations of a plurality of system-generated groupings for a plurality of applications associated with the computer system). In response to detecting, via the one or more input devices, the user request to display the application library user interface of the computer system, the computer device displays, via the one or more display devices, the application library user interface, including respective representations of a plurality of system-generated groupings for a plurality of applications associated with the computer system (e.g., respective group icons for different groupings of applications of the plurality of applications installed on the computer system). The respective representations of the plurality of system-generated groupings for the plurality of applications includes a first representation of a first system-generated grouping for a first subset of the plurality of applications that includes two or more application icons that are associated with the first category, including two or more of the first set of application icons (e.g., the first set of application icons are application icons included in an application category widget on a user-arranged page of the home screen, and the first representation of the first system-generated grouping includes a subset, all or fewer than all, of the application icons that are included in the application category widget directly in the first representation (e.g., directly selectable from the first representation of the first system-generated grouping to launch a corresponding application), where additional application icons in the first system-generated grouping are represented in a group expansion control and can be displayed and directly selected when the first representation is expanded by the selection of the group expansion control). The respective representations of the plurality of system-generated groupings for the plurality of applications further includes a second representation of a second system-generated grouping for a second subset of the plurality of applications that includes two or more application icons that are associated with the second category, including two or more of the second set of application icons (e.g., the second set of application icons are application icons included in an application category widget on a user-arranged page of the home screen, and the second representation of the first system-generated grouping includes a subset, all or fewer than all, of the application icons that are included in the application category widget directly in the second representation (e.g., directly selectable from the second representation of the second system-generated grouping to launch a corresponding application), where additional application icons in the second system-generated grouping are represented in a group expansion control and can be displayed and directly selected when the second representation is expanded by the selection of the group expansion control). For example, selectable options 750-757 in FIGS. 7G and 7D corresponding to available categories that can be assigned to an application category widget (e.g., application category widget 7102 and/or 7104) can also be represented as group folder icons in application library user interface 8004 in FIG. 8C. In some embodiments, the respective representations of the plurality of system-generated groupings of the plurality of applications also include the groupings for categories associated with the first plurality of application icons. In some embodiments, application category widgets can be assigned categories from the same list of application categories that the computer system assigned to representations of groups of applications in the application library user interface. In some embodiments, the size of the category module in the application library user interface is smaller than the size of the application category widgets in the user-arranged pages of the home screen. For example, a category module in the application library user interface is a size two-by-two module with two rows and two column to accommodate application icons, while an application category widget in a user-arranged page of the home screen can be a size two-by-four widget (e.g., for a four-column grid), a size two-by-five widget (e.g., for a five column grid), a size four-by-four widget (e.g., for a four-column grid), or a size five-by-five widget (e.g., for a five column grid), or another size bigger than the size of the category module. Displaying application icons per the same category in both application category widget on a user-arranged page of the home screen user interface and in a group representation in the application library user interface, reduces the number of inputs and/or time needed to locate an application icon on the home screen user interface.

In some embodiments, the computer system detects (12046) a user input that corresponds to a request to display an editing mode of the first region (e.g., while displaying the first page of the home screen user interface, with, or optionally, without, the respective set of application icons in the first region of the first page of the home screen user interface) (e.g. detecting a touch-hold input on the application suggestion widget displayed in the first placement location, detecting a press input on the first region, and/or detecting selection of an “add widget” affordance displayed in a reconfiguration mode of the home screen). In response to detecting the user input that corresponds to the request to display the editing mode of the first region, the computer system displays, via the one or more display devices, a configuration user interface for the first region (e.g., in the first page of the home screen user interface, in a separate settings or configuration user interface for the first region, in a settings or configuration user interface for the home screen user interface, or in a settings or configuration user interface of selecting and configuration widgets for the home screen user interface), wherein the configuration user interface includes a first set of selectable options corresponding to a first set of categories, and for a respective selectable option of the first set of selectable options that is selected, a second set of selectable options corresponding to a first set of sizes for the first region. For example, FIGS. 7N-7V illustrates selecting a size and an application category of a respective application category widget before the respective application category is added to home screen page 7004. In some embodiments, the first set of selectable options and the second set of selectable options are not necessarily displayed concurrently at the same time. In some embodiments, one or more selectable options from the first set of selectable options are displayed initially, and additional selectable options from the first set of selectable options are displayed in response to detecting user inputs (e.g., scrolling inputs, navigation inputs, and/or selection inputs directed to the currently displayed options or the region displaying the selectable options). Similarly, in some embodiments, one or more selectable options from the second set of selectable options are displayed initially, and additional selectable options from the second set of selectable options are displayed in response to detecting user inputs (e.g., scrolling inputs, navigation inputs, and/or selection inputs directed to the currently displayed options or the region displaying the selectable options). In some embodiments, the computer system chooses which options from the second set of selectable options to display, depending on the options that are displayed and/or selected from the first set of selectable options, or vice versa. In some embodiments, while the home user interface is displayed in a reconfiguration mode (e.g., icon and/or widget reconfiguration mode), the computer system changes a type and/or size of an application category widget in response to one or more user inputs directed to the application category widget (e.g., displays the first set of selectable options and the second set of selectable options in response to a first input directed to the application category widget, and changes the category and size of the application category widget in response to additional input selecting one or more of the selectable options). In some embodiments, the computer system displays a widget configuration user interface in response to selection of a control (e.g., an “add widget” affordance) that is displayed in the currently displayed page of the home screen user interface when the home screen user interface is displayed in a reconfiguration mode. In some embodiments, the widget configuration user interface includes a search input region for searching available widgets using one or more search keywords. In some embodiments, the widget configuration user interface includes one or more automatically recommended widgets, including an application category widget. In some embodiments, when the user selects the application category widget in the widget configuration user interface, the computer system displays a plurality of categories that can be associated with the application category widget, and in response to selection of a respective category for the application category widget, the compute system displays a plurality of sizes for the application category widget. In response to selection of a respective size of the application category widget, a new application category widget associated with the selected category in the selected size is added to the page of the home screen user interface from which the widget configuration user interface was invoked. In some embodiments, the widget configuration user interface also includes a plurality of sections for different widgets corresponding to different applications. For example, for a respective application, the widget configuration user interface includes a plurality of content types for the content that can be included in a widget of the respective application, and once a respective content type is selected, the widget configuration user interface displays a plurality of sizes that can be selected for a respective widget that corresponds to the selected content type. In some embodiments, the computer system allows the user to browse through the available sizes for a currently selected content type for the respective widget using one or more swipe inputs. In some embodiments, the computer system detects that a user selects a respective size for the selected content type and drags a representation of the widget with the selected content type and selected size away from its display position, and in response, the computer system cease to display the widget configuration user interface and redisplays the page of the home screen user interface from which the widget configuration user interface was invoked, and allows the user to drop the dragged representation of the widget into a placement location in the currently displayed page of the home screen user interface. Displaying options for categories and for a selected category, options for sizes, in a configuration user interface of the first region allow the user to configure multiple aspects of the first region without navigating away from the configuration user interface, which reduces the number of inputs required to accomplish a task and improves the efficiency of the user interface when configuring the first region.

In some embodiments, the computer system displays (12048), via the one or more display devices, a widget configuration interface, including a plurality of selectable options corresponding to respective widget sizes (e.g., and/or type). While displaying the widget configuration interface, the computer system detects selection of a first widget size (e.g., small, medium, or large size widget; and/or 2×2, 2×4, 4×4, or other sizes) of the respective widget sizes. In response to detecting the user input selecting the first widget size: the computer system ceases to display the widget configuration interface; and the computer system displays, via the one or more display devices, a representation of a new application category widget in a respective region of a respective page of the first user interface (e.g., the home screen page that was displayed when the first user interface entered into the widget configuration interface), wherein the representation of the new application category widget has the first widget size, and includes a plurality of selectable options corresponding to a plurality of categories that can be associated with the new application category widget. For example, FIGS. 7O-7S illustrates first selecting a size of an application category widget (e.g., configuration option 788b), and after the respective size is selected in configuration user interface 7009 and input 7624 directed at affordance 759 for adding a widget to the home screen is detected, the device 100 displays an animation corresponding to flipping application category widget 788b and displaying application category configuration user interface 7011 (e.g., optionally on the back of the flipped application category widget 788b) for assigning an application category to application category widget 788 before application category widget 788b is added on the home screen page, as described with references to FIGS. 7R-7U. In some embodiments, the computer system displays a widget configuration user interface in response to selection of a control (e.g., an “add widget” affordance) that is displayed in the currently displayed page of the home screen user interface when the home screen user interface is displayed in a reconfiguration mode. In some embodiments, the widget configuration user interface includes a search input region for searching available widgets using one or more search keywords. In some embodiments, the widget configuration user interface includes a search input region for searching available widgets using one or more search keywords. In some embodiments, the widget configuration user interface includes one or more automatically recommended widgets, including an application category widget. In some embodiments, the computer system displays a plurality of sizes for the application category widget (e.g., in response to selection of the application category widget in the widget configuration user interface), and in response to selection of a respective size for the application category widget, the compute system ceases to display the widget configuration user interface, and redisplays the page of the home screen user interface from which the widget configuration user interface was invoke. The computer system also displays a representation of the new application category widget in the page of the home screen user interface, where the representation of the new application category widget is displayed with a plurality of selectable categories that can be associated with the new application category widget. In some embodiments, the plurality of selectable categories are displayed on the backside of the representation of the application category widget (e.g., an animation showing the representation flipping over to display the category options is shown after the representation is placed into its placement location in the page of the home screen user interface). In some embodiments, the computer system detects that a user selects a respective category, and in response, the computer system displays the new application category widget in the page of the home screen user interface and populates the new application category widget with application icons of the applications selected in accordance with the selected category for the new application category widget. For example, the new application category widget can be added to the first region of the first page of the home screen user interface, and if the new application category widget is associated with a first category based on the selection done in the widget configuration user interface, the computer system displays the first set of application icons associated with the first category in the first region; and if the new application category widget is associated with a second category based on the selection done in the widget configuration user interface, the computer system displays the second set of application icons. Displaying options for categories to be associated with a new application category widget in the home screen user interface, after a size of an application category widget is selected in a configuration user interface allows the user to view the new application category widget in position when specifying its categories, which reduces the number of inputs required to place the application category widget and reduces input mistakes when selecting a category for the application category widget in the home screen user interface.

In some embodiments, while displaying, via the one or more display devices, the representation of the new application category widget in the respective region of the respective page of the first user interface (e.g., the page that was displayed when the first user interface entered into the widget configuration interface), including the plurality of selectable options corresponding to the plurality of categories that can be associated with the new application category widget, the computer system detects (12050) a respective selection input selecting of a respective selectable option of the plurality of selectable options that corresponds to a respective category of the plurality of categories. In response to detecting the respective selection input, the computer system displays, via the one or more display devices, the new application category widget in the respective region of the respective page of the home screen user interface, including a respective set of application icons for a set of applications that are automatically selected in accordance with the respective category of the plurality of categories. In some embodiments, displaying the new application category widget in the respective region includes flipping the representation of the new application category widget over in the respective region to show the application icons of the automatically selected applications (e.g., the representation of the new application category widget is the back of the new application category widget). In some embodiments, after a widget size is selected for the application category widget in the widget configuration user interface, the application category widget is added on the home screen user interface before an application category is assigned to the application category widget, and the application category widget automatically flips, thereby displaying a list of selectable application categories on the back of the application category widget. For example, in FIG. 7T, options 7011a-71001 are optionally displayed on the back of the flipped application category widget 788b (FIG. 7S), optionally before application category widget 788b is added on the home screen page, as described in further detail with references to FIGS. 7R-7U. Once a category of the application category widget is selected from the list, the application category widget flips to the front side again, and displays the application icons of the applications that are automatically selected based on the category selected for the application category widget. Displaying options for categories to be associated with a new application category widget in the home screen user interface, after a size of an application category widget is selected in a configuration user interface allows the user to view the new application category widget in position when specifying its categories, which reduces the number of inputs required to place the application category widget and reduces input mistakes when selecting a category for the application category widget in the home screen user interface.

In some embodiments, the plurality of selectable options corresponding to the plurality of categories that can be associated with the new application category widget are (12052) based on a plurality of automatically-generated application categories for a plurality of automatically-generated groupings of applications that are shown in an application library user interface (e.g., a system user interface that includes respective representations of a plurality of system-generated groupings for a plurality of applications associated with the computer system). For example, selectable options 7011a-71001 corresponding to application categories are optionally selected based on application groups displayed in application library user interface 8004 in FIGS. 8C-8D. Using automatically-generated application categories for a plurality of automatically-generated groupings of applications as options for available categories to be associated with an application category widget reduces the number of inputs to specify a category for an application category widget and provides consistency across different user interfaces of the computer system, thereby reduce input mistakes and improves the efficiency of the user interfaces.

It should be understood that the particular order in which the operations in FIGS. 12A-12H have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 13000, and 14000) are also applicable in an analogous manner to method 12000 described above with respect to FIGS. 12A-12H. For example, the controls, user interfaces, and user inputs described above with reference to method 12000 optionally have one or more of the characteristics of the controls, user interfaces, and user inputs described herein with reference to other methods described herein (e.g., methods 10000, 11000, 13000, and 14000). For brevity, these details are not repeated here.

FIGS. 13A-13F are flow diagrams of an exemplary method 13000 for modifying system-generated categorization of applications into groups and arranging the groups in an application library user interface. In some embodiments, the method 13000 is performed at a computer system that is in communication one or more display devices and one or more input devices (e.g., including one or more sensors for detecting user inputs). In some embodiments, the method 13000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 13000 are, optionally, combined and/or the order of some operations is, optionally, changed.

In the method 13000, the computer system display (13002), via the one or more display devices, an application library user interface, including respective representations of a plurality of system-generated groupings for a plurality of applications associated with the computer system (e.g., respective group icons for different groupings of applications of the plurality of applications installed on the computer system), wherein displaying the respective representations of the plurality of system-generated groupings for the plurality of applications includes concurrently displaying: (13004) a first representation of a first system-generated grouping for a first subset of the plurality of applications that includes two or more application icons that are associated with a first category (e.g., the first representation is a first group icon for a first grouping of applications that are associated with a first category, such as the entertainment category, the tools category, or another example of the first category), and (13006) a second representation of a second system-generated grouping for a second subset of the plurality of applications that includes two or more application icons that are associated with a second category different from the first category (e.g., the second representation is a second group icon for a second grouping of applications that are associated with a second category, such as the health category, the home control category, or another example of the second category). While displaying the application library user interface including concurrently displaying the first representation of the first system-generated grouping and the second representation of the second system-generated grouping (and, optionally respective representations of additional system-generated groupings for other subsets of applications of the plurality of applications associated with the computer system), the computer system detects (13008), via the one or more input devices, a first input directed to a respective application icon in the application library user interface. In response to detecting the first input (13010): in accordance with a determination that the first input meets first criteria (e.g., the first criteria are met by a touch-hold input on an application icon included in a group icon displayed in the application library user interface, or another input that corresponds to a request to configure the category of the application icon or group icon), and that the respective application icon is included in the first representation of the first system-generated grouping (e.g., the respective application icon is an application icon for an application in the first system-generated grouping of applications), the computer system displays (13012), via the one or more display devices, a first selectable option (e.g., in a menu associated with the respective application icon) for recategorizing a respective application that is associated with the respective application icon to a category other than the first category (e.g., the selectable option includes an option to recategorize, and/or a plurality of options corresponding to alternative categories to which the respective application can be assigned). In response to detecting the first input (13010), in accordance with a determination that the first input meets the first criteria, and that the respective application icon is included in the second representation of the first system-generated grouping, the computer system displays (13014), via the one or more display devices, a second selectable option for recategorizing the respective application that is associated with the respective application icon to a category other than the second category (e.g., the selectable option includes an option to recategorize, or a plurality of options corresponding to alternative categories to which the respective application can be assigned). In some embodiments, in response to detecting the first input, the computer system displays an indication of the respective category that the respective application is currently associated with, along with the selectable option(s) for alternative categories that the respective application can be assigned to. As described herein, method 13000 provides an improved technique for organizing a home screen user interface. Application icons are automatically grouped into system-generated application categories and displayed in respective group icons in an application library. The computer system automatically assigns respective application categories to application icons for the purposes of automatically grouping the application icons. In some embodiments, an assigned category (e.g., system-assigned, or user-assigned) for an application icon can be changed directly from the application library in response to a user's request. For example, a user input directed to an application icon displayed in a group representation (e.g., a group icon or pod) causes the computer system to display one or more options for recategorizing the application icon that, when selected, cause the computer system to change the assigned category of the application icon and to optionally move the application icon from one group representation into another group representation in the application library in accordance with the changed category. The method 13000 combines the efficiency of automatic grouping of application icons by category with the flexibility of customizing said grouping and categorization, thereby reducing the number input and/or time needed to find an application icon in the home screen user interface (e.g., by placing icons into system or user assigned groups) and/or reducing the number input and/or time needed to customize an application library.

In some embodiments, the computer system displays (13016), via the one or more display devices, (e.g., in response to a request to navigate from the application library user interface to a user-arranged home screen user interface) a user-arranged home screen user interface (e.g., a page of a home screen user interface in which the inclusion, positioning, and/or grouping of application icons are configurable by a user, e.g., in a reconfiguration mode of the home screen user interface), including respective application icons of at least a third subset of the plurality of applications associated with the computer system, wherein displaying the respective application icons of at least the third subset of the plurality of applications includes displaying the respective application icon (e.g., among other application icons and/or folder icons) (e.g., the respective icon may be associated with the first category or the second category in the application library user interface at this time, but the respective application icon is not included in a group icon in the user-arranged home screen user interface). While displaying the user-arranged home screen user interface, including the respective application icon, the computer system detects, via the one or more input devices, a second input directed to the respective application icon in the user-arranged home screen user interface. In response to detecting the second input, in accordance with a determination that the second input meets the first criteria (e.g., the first criteria are met by a touch-hold input on an application icon displayed in the user-arranged home screen user interface, or another input that corresponds to a request to display a plurality of operations associated with the application icon), the computer system forgoes displaying the first selectable option and the second selectable option, irrespective of whether the respective application that is associated with the respective application icon is included in the first representation of the first system-generated grouping or the second representation of the second system-generated grouping in the application library user interface. In some embodiments, in response to detecting the second input, in accordance with a determination that the second input meets the first criteria, the computer system displays one or more selectable options other than selectable options for changing a category of the respective application. In some embodiments, in response to detecting the second input, in accordance with a determination that the second input does not meet the first criteria, the computer system does not display the one or more selectable options. In some embodiments, application icons that are displayed or otherwise available on (e.g., user-arranged) pages of a muti-page home screen are also displayed (e.g., copy of the same application icon or another instance of the application icon) in respective groups in the application library. In some embodiments, a control option for recategorizing an application icon is displayed in the application library in response to a user input, but the same user input directed to the same application icon displayed in a user-arranged page of the home screen user interface does not cause the computer system to display the control option for recategorizing an application icon. For example, while configuration control 8012 for recategorizing a selected application is displayed in response to input 8802 directed to application icon 8041b in the application library user interface 8004 (e.g., FIGS. 8D-8E), the same option would not be displayed in response to the same input if the input was directed to the same application icon 8041b displayed not in the application library user interface 8004 but on the home screen page 8002. Determining whether to display a control option for recategorizing an application icon in response a user input directed to the application icon based on whether the application icon is displayed on a user-arranged page of the home screen user interface or in the application library, reduces clutter on page of the home user interface (e.g., by reducing the number of controls that are displayed) while at the same time proving flexibility of customizing system-assigned grouping and categorization of application icons.

In some embodiments, displaying the application library user interface including the respective representations of the plurality of system-generated groupings for the plurality of applications associated with the computer system includes (13018): in accordance with a determination that a first sorting parameter is enabled (e.g., by a user in a configuration user interface and/or configuration mode for the application library user interface) for the application library user interface, arranging the respective representations of the plurality of system-generated groupings in the application library user interface in accordance with the first sorting parameter (e.g., in accordance with an alphabetical order of the names of the categories associated with the plurality of system-generated groupings, in accordance with a chronological order of when the application icons in the groupings were last accessed, and/or in accordance with an order of the values of another example of the first sorting parameter for the different groupings); and in accordance with a determination that a second sorting parameter different from the first sorting parameter is enabled (e.g., by a user in a configuration user interface and/or configuration mode for the application library user interface) for the application library user interface, arranging the respective representations of the plurality of system-generated groupings in the application library user interface in accordance with the second sorting parameter (e.g., in accordance with an order of the colors assigned to the categories associated with the plurality of system-generated groupings, in accordance with an order of how frequently the application icons in the groupings were accessed by the user, and/or in accordance with an order of the values of another example of the second sorting parameter for the different groupings) (e.g., two or more representations from the respective representations of the plurality of system-generated groupings receive different sorting orders when the respective representations of the plurality of system-generated groupings are arranged in accordance with the first sorting parameter and when the respective representations of the plurality of system-generated groupings are arranged in accordance with the second sorting parameter). For example, configuration option 8024, when selected, causes device 100 to display configuration user interface 8030 for providing custom ordering of the system-arranged groups of applications, as described in further detail below with reference to FIGS. 8N-8Q. In some embodiments, after the computer system detects that the currently selected sorting parameter for the application library user interface has been changed in accordance with a user input, the computer system displays, in response to a request to display the application library user interface, the representations of the groupings in a new order that is sorted in accordance with the newly selected sorting parameter in the application library user interface. Displaying group representations according to selected criterion from different sorting criteria, reduces the number of inputs and/or time needed to reorganize group representations in the application library.

In some embodiments, the first sorting parameter includes (13020) category order (e.g., based on an order that depends on characteristics of a whole category), and the respective representations of the plurality of system-generated groupings for the plurality of applications associated with the computer system are sorted in the application library user interface in accordance with a respective order (e.g., access recency, access frequency, update recency, number of applications within the category, contextual importance, or other ordering methods for ordering categories of applications) of respective categories associated with the plurality of system-generated groupings. For example, in some embodiments, the representations of the system-generated groupings are sorted in accordance with a respective property (e.g., group size, access frequency, access recency, update recency, and/or other properties) of the categories associated with the system-generated groupings, wherein the value of the respective property is determined based on (e.g., by aggregating, averaging, taking maximum or minimum, and/or calculating other characteristic values of) events and properties associated with the applications and/or application icons within the different categories. For example, in FIG. 8M, setting user interface 8020 for configuring the application library user interface displays configuration option 8026 corresponding to a sorting parameter based on application category and configuration option 8028 corresponding to a sorting parameter based on color. In some embodiments, the application icons shown within a respective representation of a respective grouping are prioritized based on application name, access frequency, access recency, and/or other deterministic or contextual criteria. In some embodiments, the system-generated order or user-specified order are different from an alphabetical order of the names of the categories. Displaying group representations according to selected criterion from different sorting criteria, including criterion based on category, for group representations in the application library, reduces the number of inputs and/or time needed to reorganize group representations in the application library.

In some embodiments, the second sorting parameter includes (13022) color, and the plurality of applications are sorted by color (e.g., based on application icon color (e.g., application icons are grouped based on having same or similar color schemes into groupings for different colors and/or color schemes), or based on a color associated with groupings of applications (e.g., a background color for the representation of the grouping and/or a color of a label for the grouping that is selected by a user or the computer system)). For example, in some embodiments, the respective representations of the plurality of system-generated groupings are assigned different colors by the computer system or the user, and the respective representations of the plurality of system-generated groupings are sorted in the application library user interface in accordance with an order of the colors (e.g., from warm to cool, from light to dark, from red to violet, or other color ordering schemes). For example, in FIG. 8M, setting user interface 8020 for configuring the application library user interface displays configuration option 8026 corresponding to a sorting parameter based on application category and configuration option 8028 corresponding to a sorting parameter based on color. Displaying group representations according to selected criterion from different sorting criteria, including criterion based on color, for group representations in the application library, reduces the number of inputs and/or time needed to reorganize group representations in the application library.

In some embodiments the second sorting parameter includes (13024) textual label (e.g., name of applications and/or categories), and the plurality of applications associated with the computer system are sorted in the application library user interface by text label (e.g., text labels of the categories for the plurality of system-generated groupings (e.g., “entertainment,” “tools,” “gaming,” or “social media”), and/or groupings corresponding to alphabet (e.g., application icons are grouped into different groupings based on the starting letter in their text labels (e.g., grouping “A” for applications that have the letter “A” as the starting letter in their application names, and grouping “B” for applications that have the letter “B” as the starting letter in their application names))). For example, in some embodiments, the respective representations of the plurality of system-generated groupings have corresponding categories and different category names, and the respective representations of the plurality of system-generated groupings are sorted in the application library user interface in accordance with an alphabetical order of their category names. For example, in FIG. 8M, setting user interface 8020 for configuring the application library user interface displays configuration option 8026 corresponding to a sorting parameter based on application category and configuration option 8028 corresponding to a sorting parameter based on color, and additional configuration option corresponding to a sorting parameter based on alphabetical order can be displayed in the settings user interface 8020 (e.g., in response to a swipe input). Selecting different sorting criteria, including criterion based on category name, for group representations in the application library, reduces the number of inputs and/or time needed to reorganize group representations in the application library.

In some embodiments, displaying the application library user interface including the respective representations of the plurality of system-generated groupings for the plurality of applications associated with the computer system includes (13026): in accordance with a determination that manual ordering is enabled (e.g., by a user in a configuration user interface and/or configuration mode for the application library user interface) for the application library user interface, arranging the respective representations of the plurality of system-generated groupings in the application library user interface in accordance with an ordering of the plurality of system-generated groupings that was specified by a user of the computer system (e.g., the user has manually changed a default ordering of the plurality of system-generated grouping and saved it as the preferred manual ordering for the system-generated groupings in the application library user interface). For example, in FIG. 8M, the setting user interface 8020 displays a configuration option 8022 for enabling or disabling automatic ordering of groups (and respective group folder icons) and configuration option 8024 for providing custom ordering of the system-arranged groups of applications. In some embodiments, by enabling the manual ordering option in response to a user input, the computer system automatically disabling the automatic ordering based on an enabled sorting parameter (e.g., the first sorting parameter, the second sorting parameter, or another default sorting parameter), and allow the user to specify the manual ordering or use an existing manual ordering previously specified by the user. In some embodiments, by enabling one of the default sorting parameters in response to a user input, the computer system automatically disables the manual ordering and enables the automatic ordering based on the default sorting parameter that is enabled by the user. In some embodiments, while the plurality of system-generated grouping are arranged in the application library user interface in accordance with a first sorting parameter, the computer system detects one or more user inputs that correspond to a request to switch to automatic ordering based on a second sorting parameter, and in response, the computer system automatically rearranges the plurality of system-generated groupings (optionally, updating the groupings based on the second sorting parameter (e.g., grouping based on icon color, or based on application names, instead of the subject matter categories) based on the second sorting parameter. In some embodiments, while the plurality of system-generated groupings are arranged in the application library user interface in accordance with a respective sorting parameter, the computer system detects one or more user inputs that corresponds to a request to switch to manual ordering (e.g., the user selects the manual ordering option in a settings user interface for the application library, or triggers the reconfiguration mode from the application library user interface and drags the representation of a respective grouping away from its original position in the application library user interface), and in response, the computer system enables manual ordering and allows the user to rearrange the representations of the system-generated groupings in the application library user interface. In some embodiments, with manual reordering, the computer system displays the application library user interface in a mode in which the user can pick an order for the representations of the groupings (e.g., by dragging up and down in a list, or in the format of the application library user interface). Providing control options for enabling/disabling manual and/or automatic ordering of group representations in the application library, reduces the number of inputs and/or time needed to reorganize group representations in the application library while also providing additional control for customizing the order in which the group representations are displayed in the application library.

In some embodiments, the respective representations of the plurality of system-generated groupings includes (13028) the first representation of the first system-generated grouping, the second representation of the second system-generated grouping, and a third representation of a third system-generated grouping that is different from the first representation of the first system-generated grouping and the second representation of the second system-generated grouping. In the method 13000, the computer system receives a third input that corresponds to a request to specify a respective position (e.g., to pin at the current position, or to move to a fixed position) of a respective representation among the respective representations of the plurality of system-generated groupings. Displaying the application library user interface includes: in accordance with a determination that the respective representation is the first representation of the first system-generated grouping, displaying, via the one or more display devices, the first representation of the first system-generated grouping at the respective position, and arranging the second representation of the second system-generated grouping and the third representation of the third system-generated grouping in accordance with a default sorting parameter that has been enabled for the application library user interface. In some embodiments, displaying the application library user interface further includes: in accordance with a determination that the respective representation is the second representation of the second system-generated grouping, displaying, via the one or more display devices, the second representation of the second system-generated grouping at the respective position, and arranging the first representation of the first system-generated grouping and the third representation of the third system-generated grouping in accordance with the default sorting parameter that has been enabled for the application library user interface. In some embodiments, displaying the application library user interface includes: in accordance with a determination that the respective representation is the third representation of the third system-generated grouping, displaying, via the one or more display devices, the third representation of the third system-generated grouping at the respective position, and arranging the first representation of the first system-generated grouping and the second representation of the second system-generated grouping in accordance with the default sorting parameter that has been enabled for the application library user interface. In some embodiments, automatic ordering can be enabled for some group representations in the application library, and manual ordering can be enabled for other group representations in the application library. For example, while some group representations dynamically change order based on a selected sorting criteria, other group representations maintain respective order. For example, in FIG. 8M, configuration option 8022, when enabled, causes device 100 to dynamically change the sorting order in accordance with selected sorting parameter (e.g., application categories, color, or alphabetical). In some embodiments, even if automatic ordering is enabled, a user can explicitly specify (e.g., “pin”) the sort order for a selected number of system-arranged groups of applications, as described in with reference to FIGS. 8N-8Q. Enabling automatic ordering for some group representations in the application library while enabling manual ordering for other group representation in the application library, reduces the number input and/or time needed to customize the application library while providing additional control to the user for specifying the order in which the group representations are displayed.

In some embodiments, the third input that corresponds to the request to specify the respective ordinal position is detected (13030) in a category organization user interface, and the category organization user interface includes a first region that includes a first set of application categories with a first ordering that is user-specified and a second region that includes a second set of application categories with a second ordering that is automatically selected by the computer system. In the method 13000, while the computer system displays the respective representations of the plurality of system-generated groupings in the application library user interface, the computer system displays, via the one or more display devices, a first set of representations of respective groupings according to the first ordering that is user-specified and a second set of representations of respective groupings according to the second ordering that is automatically selected by the computer system. For example, in FIG. 8N, a list 8031′ of selectable options 8030a-8030d above divider affordance 8032 correspond to pinned system-arranged groups of applications, whereas a list 8021″ of selectable options 8030e-8030m below divider affordance 8032 correspond to unpinned system-arranged groups of applications. In some embodiments, the category organization user interface corresponds to a user interface for specifying the order in which group representation in the application library user interface would appear, wherein the order is determined per application category, and specifying the order includes specifying a respective order of different application categories in the category organization user interface. Providing a category organization user interface that displays a first set of application categories that are arranged in accordance with a user-specified ordering, and a second set of application categories that are arranged in accordance with an automatically generated ordering, provides user with control of how to order some categories, without requiring the user to specify the ordering of all of the application categories, thereby reduce the number of inputs required to accomplish a task (e.g., organizing the application library user interface) and improves the efficiencies of the configuration process.

In some embodiments, specifying the respective ordinal position in response to the third input includes (13032): selecting a respective category in the category organization user interface in response to a first portion of the third input; moving a respective representation of the respective category in accordance with a second portion (e.g., a drag input of the selected respective category) of the third input; and repositioning the respective category in response to detecting a termination of the third input, wherein repositioning the respective category in response to detecting the termination of the third input includes: in accordance with a determination the respective representation of the respective category was in the first region when selected by the first portion of the third input, and in the second region at the termination of the third input, moving the respective category from the first region (e.g., user-ordered region) to the second region (e.g., automatically sorted region); and in accordance with a determination the respective representation of the respective category was in the second region when selected by the first portion of the third input, and in the first region at the termination of the third input, moving the respective category from the second region (e.g., automatically sorted region) to the first region (e.g., user-ordered region). In some embodiments, when the respective category is moved from the first region to the second region, its order in the second region is automatically determined by the computer system (e.g., independent of the exact position in the second region at which the termination of the third input was detected). In some embodiments, when the respective category is moved from the second region to the first region, the order of the respective category in the first region is determined based on the position of the respective category specified by the termination of the third input. For example, input 8810 corresponds to a drag and drop input requesting to relocate selectable option 8030f from list 8031″ below the divider affordance 8032 to list 8031′ above the divider affordance 8032, thereby adding a group category “Strategy Games” to the groups with user-specified (e.g., pinned order). Allowing a user to drag a respective category between the user-specified region and the automatically ordered region of the category organization user interface provides the user with more control of how to organize the application library user interface and thereby improves the usability of the application library user interface.

In some embodiments, the computer system receives (13034), via the one or more input devices, a fourth input that corresponds to a request to merge the second system-generated grouping to the first system-generated grouping. In response to receiving the fourth input, the computer system updates the first system-generated grouping to include both the first subset of the plurality of applications and the second subset of the plurality of application icons (and, optionally, updating the first representation of the first system-generated grouping to show one or more application icons for applications in the second subset of the plurality of applications). In response to receiving the fourth input, in accordance with a determination that a first ordinal position of the first representation of the first system-generated grouping in the application library user interface is manually specified in accordance with prior user input (e.g., the first representation is pinned by the user, and/or the application library user interface is displayed with a manually specified order for the different categories), the computer system maintains the first representation of the first system-generated grouping at the first position (e.g., relative to the third representation of the third system-generated grouping, and representations of other system-generated groupings) in the application library user interface. For example, if the Communications group corresponding to selectable option 8030d in list 8031′ (e.g., for pinned groups) above the divider affordance 8032 in FIG. 8N is split into two groups (e.g., automatically by the computer system due to, e.g., increasing number of applications of the same category), the pinned order of the resulting two groups would be preserved, and if the Arcade Games corresponding to selectable option 8030b in list 8031′ is merged with Strategy Games corresponding to selectable option 8030f in list 8032″ (e.g., dynamic order groups), the ordinal position of the resulting merged group will correspond to the pinned second ordinal position of the Arcade Games corresponding to selectable option 8030b in list 8031′. In some embodiments, in response to receiving the fourth input, in accordance with a determination that the first ordinal position of the first representation of the first system-generated grouping in the application library user interface is not manually specified in accordance with prior user input, automatically arranging the first representation of the first system-generated grouping in the application library user interface in accordance with a default sorting parameter for the application library user interface. In some embodiments, application icons that are assigned different categories (e.g., optionally manually or by the system), and respectively grouped into different group representations in accordance with the assigned categories, can be merged into one category automatically by the computer system. For example, application icons in a first category are automatically merged with application icons in a second category in accordance with a determination that the first and second categories are sub-categories of the same third category and/or the total number of icons in the first category or the second category is below a threshold). In some embodiments, after merging, the computer system maintains user-specified (e.g., manual sorting order) for group representations in the application library. For example, the manual order set by a user is preserved (e.g., not affected) by merging of application icons in separate group representations. Automatically merging application icons from different group representations into one group representation in the application library in accordance with a determination that group-merging criteria is met while maintaining user-specified order of group representations in the application library, reduces the number of inputs and/or time needed to organize application icons and customize the application library.

In some embodiments, the computer system receives (13036), via the one or more input devices, a fifth input that corresponds to a request to split the first system-generated grouping (e.g., the first subset of the plurality of applications) into two or more system-generated groupings (e.g., corresponding to two or more sub-categories of the first category). In response to receiving the fifth input, the computer system ceases display of the first system-generated grouping in the application library user interface; and the computer system displays, via the one or more display devices, respective representations of the two or more system-generated groupings split from the first system-generated grouping in the application library user interface. Displaying the respective representations of the two or more system-generated groupings split from the first system-generated grouping in the application library user interface, includes: in accordance with a determination that a first position of the first representation of the first system-generated grouping in the application library user interface was manually specified in accordance with prior user input (e.g., the first representation is pinned by the user, and/or the application library user interface is displayed with a manually specified order for the different categories), inserting the respective representations of two or more system-generated groupings at the first position in the application library user interface. For example, if the Communications group corresponding to selectable option 8030d in list 8031′ (e.g., for pinned groups) above the divider affordance 8032 in FIG. 8N is split into two groups (e.g., automatically by the computer system due to, e.g., increasing number of applications of the same category), the pinned order of the resulting two groups would be preserved, and if the Arcade Games corresponding to selectable option 8030b in list 8031′ is merged with Strategy Games corresponding to selectable option 8030f in list 8032″ (e.g., dynamic order groups), the ordinal position of the resulting merged group will correspond to the pinned second ordinal position of the Arcade Games corresponding to selectable option 8030b in list 8031′. In some embodiments, in response to receiving the fifth input, in accordance with a determination that the first ordinal position of the first representation of the first system-generated grouping in the application library user interface is not manually specified in accordance with prior user input, automatically arranging the respective representations of the two or more system-generated grouping in the application library user interface in accordance with a default sorting parameter for the application library user interface. In some embodiments, application icons that are assigned to a single group (e.g., optionally manually or by the system), can be split into two groups automatically by the computer system. For example, application icons in a first group are automatically split into a second group and a third group in accordance with a determination that the application icons in the first group meet group-splitting criteria (e.g., the number of application icons in the first group exceed a respective threshold and/or there are suitable sub-categories among which the application icons can be split). For example, a grouping of icons that correspond to games (e.g., belong the games category) include a threshold number of icons that correspond to one or more sub-category, such as arcade games, puzzle games, and/or other types of games. In accordance with a determination, that the group-splitting criteria, the computer system splits icons from the grouping of icons are split into two or more other groupings that correspond to arcade games, puzzle games, and/or other types of games. In some embodiments, after splitting, the computer system maintains user-specified (e.g., manual) sorting order for respective group representations in the application library. For example, the manual order set by a user is preserved (e.g., not affected) by splitting of application icons from separate group representations into a single group representation. Automatically splitting application icons from one group representation into two group representations in the application library in accordance with a determination that group-splitting criteria is met while maintaining user-specified order of respective group representations in the application library, reduces the number of inputs and/or time needed to organize application icons and customize the application library.

In some embodiments, while displaying the application library user interface (e.g., a system user interface that displays respective representations of a plurality of system-generated groupings for a plurality of applications associated with the computer system), the computer system detects (13038), via the one or more input devices, a sixth input that corresponds to a request to navigate from the application library user interface to a user-arranged home screen user interface. In response to detecting the sixth input, the computer system ceases to display the application library user interface, and displays, via the one or more display devices, the user-arranged home screen user interface in a first portion of a display area previously occupied by the application library user interface, wherein the user-arranged home screen user interface and the application library user interface are displayed at a same visual depth (e.g., the application library user interface slides out and the user-arranged home screen slides in in the same plane) in the first portion of the display area. In some embodiments, while displaying the application library user interface, the computer system detects a seventh input that corresponds to a request to navigate from the user-arranged home screen user interface to the application library user interface; and in response to detecting the seventh input, the computer system ceases to display the user-arranged home screen user interface, and displays the application library user interface in the first portion of the display area previously occupied by the user-arranged home screen user interface, wherein the user-arranged home screen user interface and the application library user interface are displayed at the same visual depth (e.g., the application library user interface slides in and the user-arranged home screen slides out in the same plane) in the first portion of the display area. For example, in FIG. 8B, application library user interface 8004 is displayed partially overlaying home screen page 8002 at a different simulated depth, but optionally, application library user interface 8004 can be displayed at the simulated depth as home screen page 8002. Displaying the user-arranged home screen user interface and the application library user interface are displayed at the same (e.g., simulated) depth, provides visual feedback to the user that the system is responding to the user's input and/or that the application library user interface is part of the home screen user interface (e.g., as opposed to another system user interface that does not provide access to application user interface objects).

In some embodiments, the respective application icon (13040) is included in the first representation of the first system-generated grouping, and the first selectable option is displayed in response to detecting the first input. The method 13000 includes: while displaying the first selectable option for recategorizing the respective application that is associated with the respective application icon, detecting, via the one or more input devices, a sequence of one or more inputs corresponding to selection of the first selectable option; and in response to detecting the sequence of one or more inputs corresponding to selection of the first selectable option, displaying, via the one or more display devices, an animated transition showing the respective application icon exiting the first representation of the first system-generated grouping and entering a fourth representation of a fourth system-generated grouping that is associated with a fourth category, wherein the fourth category is different from the first category and corresponds to the first selectable option. For example, FIG. 8I illustrates the movement path of application icon 8041b that is being recategorized from group folder icon 8041 corresponding to the arcade games to group folder icon 8045 corresponding to the strategy games (e.g., illustrated with a dashed arrow beginning from placement location of application icon 8041b in group folder icon 8041 and ending in group folder icon 8045). In some embodiments, the respective application icon is included in the second representation of the second system-generated grouping, and the second selectable option is displayed in response to detecting the first input, and the method includes: while displaying the second selectable option for recategorizing the respective application that is associated with the respective application icon, detecting selection of the second selectable option; and in response to detecting the selection of the first selectable option, displaying an animated transition showing the respective application icon exiting the second representation of the second system-generated grouping and entering a fifth representation of a fifth system-generated grouping that is associated with a fifth category, wherein the fifth category is different from the second category and corresponds to the second selectable option. Displaying an animated transition of an application icon exiting one group representation associated with a first group and entering another group representation associated with a second group in response to a user input requesting to recategorizing the application icon from a first category associated with the first group representation to a second category associated with a second group representation in the application library, provides a user with visual feedback that the computer system is successfully responding to the recategorization request, thereby reducing the number of inputs and/or time needed to recategorize an application icon in the application library.

In some embodiments, in response to detecting the selection of the first selectable option, the computer system displaces (13042) an existing application icon in the fourth representation of the fourth system-generated grouping, when the respective application icon enters the fourth representation of the fourth system-generated grouping. In some embodiments, as a result of relocating the first application icon from the first group representation to the second group representation in the application library (e.g., in response to a request for recategorizing the application icon from the first category to the second category), the computer system displaces one or more application icons in the first group representations (e.g., one or more application icons in the first group representation move in a snake pattern to fill up a placement location in the first group representation vacated by the application icon that is being relocated, including optionally revealing previously undisplayed application icon that is included in the first group representation) and/or one or more application icons in the second group representation (e.g., one or more application icons in the second group representation move in a snake pattern to make space or room for the application icon that is being relocated, including optionally hiding a previously displayed application icon that was displayed in the second group representation). For example, in conjunction with relocating application icon 8041b, the device 100 automatically shifts application icons 8041c and 8041d (e.g., placed after the vacated placement location 8041b′ in group folder icon 8041) by one placement location in a snaking pattern (e.g., left to right and bottom to top), as illustrated in FIG. 8K. Alternatively, one or more application icons 8045a-854c can be displayed when application icon 8041b is moved into group folder icon 8045. Limiting the number of application icons concurrently visible in the representation of a respective grouping and displacing an existing application icon when the respective application icon is placed into the respective grouping through recategorizing the respective application icon, provides visual feedback to the effect of the user's input, and reduces user mistakes when recategorizing the respective application icon.

It should be understood that the particular order in which the operations in FIGS. 13A-13F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, and 14000) are also applicable in an analogous manner to method 13000 described above with respect to FIGS. 13A-13F. For example, the controls, user interfaces, and user inputs described above with reference to method 13000 optionally have one or more of the characteristics of the controls, user interfaces, and user inputs described herein with reference to other methods described herein (e.g., methods 10000, 11000, 12000, and 14000). For brevity, these details are not repeated here.

FIGS. 14A-14H are a flow diagram of a method 14000 of changing an appearance of a home screen user interface, in accordance with various embodiments.

Method 14000 is performed at an electronic device or computer system (e.g., device 300, FIG. 3A, or portable multifunction device 100, FIG. 1A) that is in communication with display devices (e.g., touch-screen displays, standalone displays, head-mounted displays, projectors, and/or other types of display devices), and one or more input devices (e.g., one or more sensors for detecting user inputs, such as cameras, touch-sensitive surfaces, touch-screen display, motion sensors, and/or other sensors and input devices). In some embodiments, the display generation component is a touch-screen display, and the touch-sensitive surface is on or integrated with the display. In some embodiments, the display is separate from the touch-sensitive surface. Some operations in method 14000 are, optionally, combined and/or the order of some operations is, optionally, changed. In some embodiments, the input devices include cameras, pointing devices, and other types of input devices. In some embodiments, the computer system is in communication with one or more output devices, such as displays, audio output devices, and/or tactile output devices.

As described herein, the method 14000 provides an improved technique for changing the appearance of a home screen interface. Depending on a selected visual appearance property (e.g., “colorful” or “tinted” icon configuration) and in accordance with a determination that a change in state of the computer system is detected (e.g., from light mode to dark mode), the computer system either changes appearance of application icons from a first flexible set of colors to a second flexible set of colors (e.g., “colorful” icon configuration for the foreground elements of the application icons is maintained while background of the application icons changes from light to dark in conjunction with background of the home user interface) or the computer system maintains tinted appearance of application icons (e.g., “tinted” icon configuration for the foreground elements is maintained and background of the application icons while background of the home user interface changes from light to dark according to the change of state). For example, displaying a home screen interface while the computer is operating in the first state (e.g., a light mode) includes displaying the first plurality of user interface objects in the home screen user interface, with either a first flexible set of colors (e.g., “colorful” icon configuration where individual icons have customized color configuration) for different user interface objects of the first plurality of user interface objects or with a first constrained set of colors (e.g., “tinted” icon configuration where individual icons have uniform tinted color configuration), in accordance with the determination that a first or second appearance property is selected for the first plurality of user interface objects, respectively. For example, while the computer system is operating in a second state (e.g., a dark mode) different from the first state, the home screen user interface displays the first plurality of user interface objects either with a second flexible set of colors (e.g., different from the first flexible set of colors) for different user interface objects of the first plurality of user interface objects or with a second constrained set of colors (e.g., the second constrained set is the same as the first set of constrained set colors or it has a different hue, e.g., the individual icons have uniform tinted color that is the same as in light mode or the tinted color configuration is maintained but shade or tint of the chosen hue changes, e.g., changes from light tint to a dark tint for the foreground elements), in accordance with the determination that the first or second appearance property is selected for the first plurality of user interface objects, respectively. Automatically changing the appearance of the home screen user interface based on the operation state and a selected visual appearance property (e.g., thereby maintain visibility and/or quick access to the user interface objects) reduces the number and/or complexity of inputs needed to locate icons, the color change of the icons and the home screen provide visual feedback that the system is in a specific operation state, thereby reducing the number of input and/or time needed to locate and interact with a selected object on the home screen and/or change the appearance of a home screen user interface.

In the method 14000, while the computer system is operating in a first state (e.g., the computer system is operating in a “light mode” in which the computer system displays user interfaces with appearance properties that are suitable for daytime viewing, and/or in well-lit conditions, or another set of conditions based on time, environment, and/or physical or social settings; and/or the computer system is operating in the first state in accordance with a determination that a first set of conditions (e.g., conditions based on time, location, lighting, environment, and/or other physical or social settings) are met), the computer system displays (14002), via the one or more display devices, a home screen user interface (e.g., a page of a multipage home screen user interface, or a single page home screen user interface, and/or a user-configured home screen user interface), wherein the home screen user interface includes a first plurality of user interface objects (e.g., application icons and/or widgets) corresponding to a first plurality of applications, wherein a respective user interface object of the first plurality of user interface objects, when selected by a selection input of a first input type (e.g., a tap input, an air pinch gesture detected in conjunction with a gaze input, a click input detected in conjunction with a location of a focus selector, or another type of selection input), causes the computer system to display a respective application corresponding to the respective user interface object. Displaying the home screen user interface while the computer system is operating in the first state, includes: (14004) in accordance with a determination that a first appearance property is selected for the first plurality of user interface objects (e.g., a configuration for “colorful” icons is selected), displaying the first plurality of user interface objects in the home screen user interface, with a first flexible set of colors (e.g., a varied set of colors that includes colors selected by individual applications) for different user interface objects of the first plurality of user interface objects (e.g., a first set of multiple colors for a first user interface object, a second set of multiple colors for a second user interface object, a third set of multiple colors for a third user interface object, and so on, where the first set of multiple colors, the second set of multiple colors, the third set of multiple colors, and so on, are different and/or independent from one another); and (14006) in accordance with a determination that a second appearance property is selected for the first plurality of user interface objects (e.g., a configuration of “tinted” icons is selected), displaying the first plurality of user interface objects in the home screen user interface with a first constrained (e.g., system-specified) set of colors (e.g., a set of related colors that optionally includes different tints of the same color), wherein the first constrained (e.g., system-specified) set of colors includes fewer colors than the first flexible set of colors (e.g., the first constrained set of colors has one color, two colors, or three colors, and the same color scheme is applied across multiple user interface objects, such as the first user interface object, the second user interface object, the third user interface object, and so on). In some embodiments, the first constrained set of colors has a single foreground color and a single background color, and optionally, a single accent color for some of the foreground elements, resulting in an overall “monochromatic” or “tinted” look of the home screen; while the first flexible set of colors includes colors that are varied (e.g., different combinations of foreground colors and background colors) and chosen by the designers of the different applications, resulting in an overall “colorful” look of the home screen. In some embodiments, the first constrained set of colors is at least partially configurable by a user (e.g., the user can choose a “tint” color for the foreground element, or have it match a background color of the home screen), and the first flexible set of colors is not individually configurable by a user (e.g., the “colorful” icons are designed by the application developers with specific designs and colors that are not configurable by a user). In some embodiments, the home screen user interface is displayed in response to detecting that a set of conditions for displaying the home screen user interface are met. In some embodiments, the home screen user interface is displayed in response to detecting a user input (e.g., activation of a hardware or software “home” affordance, an upward edge swipe gesture on a touch-screen, an air gesture for displaying the application launch user interface that is performed by one hand or two air gestures performed by two hands sequentially or simultaneously, or another input for navigating to the home screen) that corresponds to a request to dismiss a currently displayed user interface (e.g., a wake screen user interface, a system-configured application library user interface, an application user interface of an application, a control user interface, or another system or application user interface) and display the home screen user interface.

In some embodiments, the home screen user interface includes both application icons and widgets corresponding to different applications. In some embodiments, widgets of an application may be displayed in multiple user interfaces, such as the wake screen user interface, a widget user interface, a control user interface, and the home screen user interface. In some embodiments, widgets are also referred to as “mini-application objects” or “user interface object that includes application content,” and the widgets provide a limited subset of functions and/or information available from their corresponding applications without requiring the applications to be launched. In some embodiments, a widget that is displayed at a placement location (e.g., in the home screen user interface, or another user interface that includes widgets) is fixed and does not automatically switch to a different widget or widget for a different application. In some embodiments, a widget stack is implemented such that multiple widgets share the same placement location (e.g., in the home screen user interface, or another user interface that includes widgets) and are displayed at different times at the same placement location. In some embodiments, the home screen user interface includes both individual widgets and widget stacks at different placement locations in the home screen user interface. In some embodiments, the application content that is contained in a widget is user configurable and includes a specific type of informational content, and/or a specific application function without requiring the user to open the corresponding application. A widget is different from an application window which displays the user interface of an open application. In some embodiments, a limited set of application functions is provided in a widget, such as text input function or selection function, and the input received through the widget is provided to the corresponding application, so the application is updated according to the input without requiring the user to actually open the application. In some embodiments, the application content included in a widget is dynamically updated by the computer system when the same application content is updated in the corresponding application, even when the application is not currently open on the display generation component. In some embodiments, widgets do not include application icons, as application icons do not include application content that is automatically updated over time based on changes in application content that have occurred in the application. In some embodiments, the home screen user interface includes some application icons that include a limited amount of information from the application that is updated over time based on changes in application content within the application, and the distinction between such application icons and widgets is less clear, as such types of application icons can be considered a type of widget as well, even if they are referred to as “application icons” based on their appearances and other properties (e.g., size, form factor, styles, presence in the system-configured application library user interface, and/or behaviors).

In the method 14000, after displaying the home screen user interface while the computer system was operating in the first state (e.g., after a period of time has elapsed and/or physical lighting conditions have changed, and the conditions for operating in the first state are no longer met), while the computer system is operating in a second state different from the first state (e.g., the computer system is operating in a “dark mode” in which the computer system displays user interfaces with appearance properties that are suitable for nighttime viewing, and/or in dim-lit conditions, or another set of conditions based on time, environment, and/or physical or social settings; the computer system is operating in the second state in accordance with a determination that a second set of conditions (e.g., another set of conditions based on time, location, lighting, environment, and/or other physical or social settings, different from the first set of conditions) are met; and/or the computer system automatically transitions from the first state into the second state when the first set of conditions are no longer met and/or when the second set of conditions are met), the computer system displays (14008), via the one or more display devices, the home screen user interface (e.g., a page of a multipage home screen user interface, or a single page home screen user interface, and/or a user-configured home screen user interface). Displaying the home screen user interface includes: (14010) in accordance with a determination that the first appearance property is selected for the first plurality of user interface objects (e.g., the configuration of “colorful” icons is selected), displaying the first plurality of user interface objects with a second flexible set of colors (e.g., a varied set of colors that includes colors selected by individual applications) for different user interface objects of the first plurality of user interface objects (e.g., a first alternative set of multiple colors for the first user interface object, a second alternative set of multiple colors for the second user interface object, a third alternative set of multiple colors for the third user interface object, and so on, where the first alternative set of multiple colors, the second alternative set of multiple colors, the third alternative set of multiple colors, and so on, are different and/or independent from one another), wherein the second flexible set of colors is different from the first flexible set of colors. In some embodiments, the first flexible set of colors and the second flexible set of colors are both designed by the developers of the applications and are not configurable by a user. The second flexible set of colors for the first plurality of user interface objects maintains the “colorful” look of the home screen user interface, when the computer system transitions from the first state to the second state, in accordance with some embodiments. Displaying the home screen user interface further includes: (14012) in accordance with a determination that the second appearance property is selected for the first plurality of user interface objects (e.g., the configuration of “tinted” icons is selected), displaying the first plurality of user interface objects in the home screen user interface with a second constrained (e.g., system-specified) set of colors (e.g., a set of related colors that optionally includes different tints of the same color), wherein the second constrained (e.g., system-specified) set of colors includes fewer colors than the second flexible set of colors (e.g., the second constrained set of colors has one color, two colors, or three colors, and the same color scheme is applied across multiple user interface objects, such as the first user interface object, the second user interface object, the third user interface object, and so on). In some embodiments, the second constrained set of colors has a single foreground color and a single background color, and optionally, a single accent color for some of the foreground elements, resulting in an overall “monochromatic” or “tinted” look of the home screen; while the second flexible set of colors includes colors that are varied (e.g., different combinations of foreground colors and background colors) and chosen by the designers of the different applications, resulting in an overall “colorful” look of the home screen. In some embodiments, the second constrained set of colors is not directly configurable by a user, but rather is based on the first constrained set of colors (e.g., the user can choose a “tint” color for the foreground element for the light mode, or have it match a background color of the home screen for the light mode, and a system-generated variation of the “tint” is used for the dark mode).

In some embodiments, the home screen user interface is displayed in response to detecting that a set of conditions for displaying the home screen user interface are met. In some embodiments, the home screen user interface is displayed in response to detecting a user input (e.g., activation of a hardware or software “home” affordance, an upward edge swipe gesture on a touch-screen, an air gesture for displaying the application launch user interface that is performed by one hand or two air gestures performed by two hands sequentially or simultaneously, or another input for navigating to the home screen) that corresponds to a request to dismiss a currently displayed user interface (e.g., a wake screen user interface, a system-configured application library user interface, an application user interface of an application, a control user interface, or another system or application user interface) and display the home screen user interface. In some embodiments, the home screen user interface remains displayed when the transition from the first state to the second state occurs (e.g. automatically in accordance with a change in ambient lighting conditions and/or based on a change in time, location, active notification delivery modes, and/or other conditions; and/or in response to a user input that directly changes the state of the computer system). In some embodiments, the home screen user interface was not displayed when the conditions for changing the state of the computer system are met; and when the home screen user interface is displayed in response to a user input that corresponds to a request to display the home screen user interface, the computer system determines whether to display the home screen user interface in accordance with the first state or the second state, depending on what whether the first set of conditions corresponding to the first state or the second set of conditions corresponding to the second state is met.

As used herein a “flexible” set of colors refers to a color palette that is available to different applications for use in icon colors. Application icons for different applications coming from different sources and application designer typically do not coordinate in terms of colors and/or may present enhanced visual distinction with respect to one another based on their color choices. As a result the collection of colors that are used for the application icons on the home screen user interface are varied and independent of one another. Indeed, each application icon has an individualized color pallet that is independent of the color pallet of another application icon, resulting the overall “colorful” look of the home screen. Furthermore the color pallets for one application icon in the first state (e.g., the “light” mode) and the second state (e.g., the “dark” mode) are independent of the respective sets of color pallets for the first and second states for other application icons. Thus, the first “flexible” set of colors and the second “flexible” set of colors both include varied sets of colors, where the colors in each set are independently chosen and do not coordinate with one another as a whole on the home screen user interface. The computer system uses the application icons with the “flexible” sets of colors when a first appearance property (e.g., the configuration for “colorful” icons) is selected for the application icons (and, optionally, widgets). When a second appearance property (e.g., the configuration for “tinted” icons) is selected for the application icons (and optionally, widgets), the computer system uses the application icons with a first “constrained” set of colors and a second “constrained” set of colors. In some embodiments, the first “constrained” set of colors and the second “constrained” set of colors are chosen by the computer system, optionally based on a single “seed” color or baseline tint chosen by a user. The “constrained” sets of colors are chosen to create the “monochromatic” and/or “unified” color scheme of the home screen. As a result, the “constrained” set of colors has fewer colors than the “flexible” set of color, for a given state of the computer system, and optionally includes a single tint for both the background and the foreground elements of the application icons, or one tint for the foreground elements and another tint for the background elements of the application icons. In some embodiments, a small number of accent colors are permitted (e.g., available for use by some minute elements of an application icon that do not change the overall monochromatic and uniform look and feel of the application icon) for use in the application icons, when the second appearance property is selected, and the small number of accent colors are constrained by how much space it can occupy in the application icons.

In some embodiments, the second constrained set of colors is (14014) different from the first constrained set of colors (e.g., the second constrained set of colors includes a “darker” and/or “less saturated” versions of the first constrained set of colors). For example, even though the tinted color is applied to the foreground elements of application user interface objects 900-938 in FIG. 9O (e.g., displaying home user interface 9000 in the dark mode) and in FIG. 9P (e.g., displaying home user interface 9000 in the light mode), optionally, the hue, brightness, and/or saturation of the selected tint color is darker in FIG. 9O when the device 100 is in the dark mode relative to FIG. 9P when the device 100 is in the light mode. In some embodiments, the first constrained set of colors and the second constrained set of colors have the same baseline hue (e.g., red, yellow, blue, green, purple, black, white, or other primary and secondary colors), and the first constrained set of colors has a first set of tint and/or shades for the baseline hue and the second constrained set of colors has a second set of tints and/or shades for the baseline hue, that are different from the first set of tints and/or shades for the baseline hue. Given that, the first flexible set of colors and the second flexible set of colors are respectively used for the icons when the first appearance property is selected for the icons on the homes screen user interface and the computer system transitions between displaying the home screen in the first state and displaying the home screen in the second state, the first constrained set of colors and the second constrained set of colors are respectively used for the icons when the second appearance property is selected for the icons on the homes screen user interface and the computer system transitions between displaying the home screen in the first state and displaying the home screen in the second state, the home screen user interface goes through different types of visual changes (e.g., more drastic and colorful changes for the “colorful” icon configuration, and more subtle and muted changes for the “tinted” icon configuration), depending on the configuration option (e.g., “colorful” icons or “tinted” icons) that has been chosen at the time that the computer system transitions between the first state and the second state (e.g., the light mode and the dark mode) and/or when the home screen is displayed in the first state and the second state. Changing the hue, brightness, and/or saturation of a selected tint color configuration for user interface objects (e.g., application icons or widgets) on the home screen user interface in accordance with a determination that a change in state of the computer system is detected (e.g., from light mode to dark mode or vice versa), maintains a user-selected color configuration while also indicating a change of state of the computer system, thereby reducing the number and/or complexity of inputs needed configure appearance of a home user interface and provides visual feedback that the system is in a specific operation state.

In some embodiments, the first state of the computer system includes (14016) a first mode corresponding to (e.g., activated automatically without user inputs, and/or manually by a user input, based on) a first set of lighting conditions (e.g., a first level of actual ambient lighting, or a first presumed lighting level based on location, time, active notification delivery mode, or other factors) and the second state of the computer system includes a second mode corresponding to (e.g., activated automatically without user inputs, and/or manually by a user input, based on) a second set of lighting conditions (e.g., a second level of actual ambient lighting, or a second presumed lighting level based on location, time, active notification delivery mode, or other factors) different from the first set of lighting conditions. For example, the first mode is a light mode, and is activated when the actual ambient lighting is bright and above a threshold level of lighting, and/or when the location is outdoors, the time is during the daylight hours, when the active notification delivery mode is a daytime mode such as “work,” “study,” “morning” modes, and/or other conditions that indicate a bright ambient environment; and the second mode is a dark mode, and is activated when the actual ambient lighting is dim and below the threshold level of lighting, and/or when the location is indoors, the time is during the nighttime hours, when the active notification delivery mode is a nighttime mode such as “quiet” “sleep” “night” modes, and/or other conditions that indicate a dim ambient environment. For example, the change in state from the first mode to the second mode optionally corresponds to a change from the light mode in FIG. 9A to dark mode in FIG. 9B (e.g., optionally, occurring automatically due to change in ambient lighting conditions. In some embodiments, in accordance with a determination that a change of state of the computer system (e.g., from light to dark mode or from dark to light mode) is detected and in accordance with a determination a colorful configuration is selected (e.g., in which interface objects have uncoordinated color scheme for foreground elements), the computer system maintains the colorful (variable color selection) for the foreground elements of the user interface objects on the home screen while changing the background of the user interface objects in accordance with the state of the computer system (e.g., dark background for dark mode and light background for light mode). In accordance with a determination that the change of state of the computer system is detected and in accordance with a determination a tint configuration is selected (e.g., in which interface objects have coordinated or uniform color scheme for foreground and background elements), the computer system maintains the appearance of the user interface objects while changing the background of the home screen user interface (e.g., without changing the color of the background or foreground elements of the user interface objects). Maintaining selected colorful or tint appearance for foreground elements of the user interface objects while changing the background of the home screen user interface, in accordance with a change of the state of the device from light mode to dark mode or vice versa, preserves selected appearance for the user interface objects (e.g., by users or app developers) while also provides visual feedback for a current state or change of state of the computer system, thereby reducing the number and/or complexity of inputs needed configure appearance of a home user interface and provides visual feedback that the system is in a specific operation state.

In some embodiments, the computer system detects (14018) one or more indications (e.g., a change in time, location, ambient lighting conditions, and/or active focus mode) that the first set of lighting conditions is no longer present and/or that the second set of lighting conditions are present. In accordance with detecting the one or more indications (e.g., in response to detecting the one or more indications, or in accordance with one or more indications detected at an earlier time before the home screen user interface is displayed), the computer system automatically transitions between operating in the first state and operating in the second state (e.g., from the first state to the second state, or from the second state to the first state). For example, the change in state from the light mode in FIG. 9A to dark mode in FIG. 9B occurs due to change in ambient lighting conditions. In some embodiments, the automatic transition between the first state and the second state occurs while the home screen user interface is displayed, or while the home screen user interface is not displayed (e.g., while a wake screen user interface, a widget screen user interface, a control user interface, a notification user interface, and/or another system user interface that includes application icons and/or widgets is displayed). In some embodiments, when displaying the home screen user interface in response to a user request, and/or while the home screen user interface is currently displayed, the computer system determines whether the computer system is operating in the first state or the second state (optionally, making a transition between the first state and the second state, if conditions for transitioning between the first state and the second state are met), and chooses the appearance of the icons on the home screen user interface according to whether the computer system is operating in the first state or the second state and whether the “colorful” icon configuration or the “tinted” icon configuration is selected for the home screen icons (e.g., application icons and/or widgets). In some embodiments, in response to automatically transitioning between operating in the first state and operating in the second state, the computer system changes the appearance of the home screen user interface (e.g., while the home screen user interface is currently displayed, or the next time that the home screen user interface is displayed) by using the icons with an alternative flexible set of colors (e.g., if the first appearance property is selected for the icons) or the icons with an alternative constrained set of colors (e.g., if the second appearance property is selected for the icons). Maintaining selected colorful or tint appearance for foreground elements of the user interface objects while changing the background of the home screen user interface, in accordance with an automatic change of the state of the device from light mode to dark mode or vice versa, preserves selected appearance for the user interface objects (e.g., by users or app developers) while also provides visual feedback for a current state or change of state of the computer system, thereby reducing the number and/or complexity of inputs needed configure appearance of a home user interface and provides visual feedback that the system is in a specific operation state.

In some embodiments, the computer system detects (14020) one or more events (e.g., reconfiguration of the home screen user interface that changes its background and/or switching to a different version of the home screen user interface that has a different background, in accordance user inputs or automatically based on external conditions) that change a current background of the home screen user interface from a first background to a second background (e.g., from a first color scheme or a second color scheme, from a first image to a second image, from a first photograph to a second photograph). In some embodiments, the external conditions include the computer system automatically activating focus modes that have different home screen backgrounds, or other conditions that change the system background (e.g., time of day, ongoing astronomical events, local weather, automatic rotation of background images, and/or other external or system conditions). In accordance with detecting the one or more events that change the current background of the home screen user interface (e.g., in response to detecting the one or more events, or in accordance with one or more events detected at an earlier time before the home screen user interface is displayed), the computer system automatically transitions between operating in the first state and operating in the second state (e.g., from the first state to the second state, or from the second state to the first state. In some embodiments, the automatic transition between the first state and the second state occurs while the home screen user interface is displayed, or while the home screen user interface is not displayed (e.g., while a wake screen user interface, a widget screen user interface, a control user interface, a notification user interface, and/or another system user interface that includes application icons and/or widgets is displayed). For example, in FIG. 9U-9V, in accordance with a determination that control 9020a for activating a system-selected appearance is selected and in accordance with a determination that the background 9002 changes to background 9003, the device 100 automatically changes the tinted appearance of application user interface objects 900-938 in accordance with or based on a color scheme or palette used in background 9003. In some embodiments, when displaying the home screen user interface in response to a user request, and/or while the home screen user interface is currently displayed, the computer system determines whether the computer system is operating in the first state or the second state (optionally, making a transition between the first state and the second state, if conditions for transitioning between the first state and the second state are met), and chooses the appearance of the icons on the home screen user interface according to whether the computer system is operating in the first state or the second state and whether the “colorful” icon configuration or the “tinted” icon configuration is selected for the home screen icons (e.g., application icons and/or widgets). In some embodiments, in response to automatically transitioning between operating in the first state and operating in the second state, the computer system changes the appearance of the home screen user interface (e.g., while the home screen user interface is currently displayed, or the next time that the home screen user interface is displayed) by using the icons with an alternative flexible set of colors (e.g., if the first appearance property is selected for the icons) or the icons with an alternative constrained set of colors (e.g., if the second appearance property is selected for the icons). Automatically changing a selected color configuration of the user interface objects (e.g., a tint color configuration) based on or in accordance with a determination that a background of the home screen user interface has changed (e.g., from a first color scheme or a second color scheme, from a first image to a second image, from a first photograph to a second photograph), reduces the number and/or complexity of inputs needed configure appearance of a home user interface.

In some embodiments, the computer system detects (14022) one or more events (e.g., reconfiguration of the home screen user interface that changes the font color used in the home screen user interface, and/or switching to a different version of the home screen user interface that has a different font color, in accordance user inputs or automatically based on external conditions) that change a current font color of the home screen user interface from a first font color to a second font color. In some embodiments, the external conditions include the computer system automatically activating focus modes that have different system font colors, or other conditions that change the system font color (e.g., time of day, holidays, days of the week, and/or other external or system conditions). In some embodiments, the font color for the text (e.g., text for application names and system prompts) used in the home screen user interface is user-configurable and/or system configurable, and optionally depends on the configuration chosen for the wake screen user interface (e.g., for the time and date element on the wake screen user interface). In accordance with detecting the one or more events that change the current font color of the home screen user interface (e.g., in response to detecting the one or more events, or in accordance with one or more events detected at an earlier time before the home screen user interface is displayed), the computer system automatically transitions between operating in the first state and operating in the second state (e.g., from the first state to the second state, or from the second state to the first state. In some embodiments, the automatic transition between the first state and the second state occurs while the home screen user interface is displayed, or while the home screen user interface is not displayed (e.g., while a wake screen user interface, a widget screen user interface, a control user interface, a notification user interface, and/or another system user interface that includes application icons and/or widgets is displayed). In some embodiments, when displaying the home screen user interface in response to a user request, and/or while the home screen user interface is currently displayed, the computer system determines whether the computer system is operating in the first state or the second state (optionally, making a transition between the first state and the second state, if conditions for transitioning between the first state and the second state are met), and chooses the appearance of the icons on the home screen user interface according to whether the computer system is operating in the first state or the second state and whether the “colorful” icon configuration or the “tinted” icon configuration is selected for the home screen icons (e.g., application icons and/or widgets). In some embodiments, in response to automatically transitioning between operating in the first state and operating in the second state, the computer system changes the appearance of the home screen user interface (e.g., while the home screen user interface is currently displayed, or the next time that the home screen user interface is displayed) by using the icons with an alternative flexible set of colors (e.g., if the first appearance property is selected for the icons) or the icons with an alternative constrained set of colors (e.g., if the second appearance property is selected for the icons). Automatically changing a selected color configuration of the user interface objects (e.g., a tint color configuration) in accordance with a change in configuration of appearance for other elements (e.g., a color choice for a system font, such as a color choice of text selected for a wake screen date/time) has occurred, reduces the number and/or complexity of inputs needed configure appearance of a home user interface (e.g., inputs needed to coordinate the colors schemes used across the home screen user interface and other user interfaces and/or elements).

In some embodiments, displaying the first plurality of user interface objects with the first flexible set of colors includes (14042) displaying the first plurality of user interface objects with a first set of backgrounds; displaying the first plurality of user interface objects with the second flexible set of colors includes displaying the first plurality of user interface objects with a second set of backgrounds that are darker than the first set of backgrounds (e.g., the first state corresponds to a light mode, and the second state corresponds to a dark mode, and the icons have a darker background in the dark mode than in the light mode); displaying the first plurality of user interface objects with the first constrained set of colors includes displaying the first plurality of user interface objects with a third set of backgrounds; and displaying the first plurality of user interface objects with the second constrained set of colors includes displaying the first plurality of user interface objects with a fourth set of backgrounds that are darker than the third set of backgrounds (e.g., the first state corresponds to a light mode, and the second state corresponds to a dark mode, and the icons have a darker background in the dark mode than in the light mode). For example, in the dark mode, appearances 900b-938b of application user interface objects 900-938 in FIG. 9B have a dark background (e.g., relative to appearances 900a-938a of application user interface objects 900-938 in the light mode in FIG. 9A). Automatically changing the background of user interface objects in accordance with current state of the computer system (e.g., dark background of user interface objects when dark mode is active and light background of user interface objects when light mode is active), reduces the number and/or complexity of inputs needed configure appearance of a home user interface.

In some embodiments, displaying the first plurality of user interface objects with the first flexible set of colors includes (14026) displaying a first user interface object with a first set of characteristic colors selected from the first flexible set of colors, and displaying a second user interface object with a second set of characteristic colors selected from the first flexible set of colors; displaying the first plurality of user interface objects with the second flexible set of colors includes displaying the first user interface object with a third set of characteristic colors selected from the second flexible set of colors, and displaying the second user interface object with a fourth set of characteristic colors selected from the second flexible set of colors; the first set of characteristic colors selected from the first flexible set of colors is substantially similar to the third set of characteristic colors selected from the second flexible set of colors (e.g., the first state corresponds to a light mode, and the second state corresponds to a dark mode, and the icon for an application has similar sets of characteristic colors in the light mode and the dark mode); and the second set of characteristic colors selected from the first flexible set of colors is substantially similar to the fourth set of characteristic colors selected from the second flexible set of colors (e.g., the first state corresponds to a light mode, and the second state corresponds to a dark mode, and the icon for an application has similar sets of characteristic colors in the light mode and the dark mode). For example, when the “colorful” icon configuration is selected, the color palette for the foreground element(s) of application user interface objects 900-938 is maintained even though the device switches from light mode in FIG. 9A to dark mode in FIG. 9B. Although the first user interface object and the second user interface object are given as examples, it is understood that the same case applies to other user interface objects in the first plurality of user interface objects included in the home screen user interface, so that all of the icons are still easily recognizable based on their appearances as the same icons corresponding to their respective applications. In some embodiments, the set of colors that are used for the “light” mode version of an icon, are the same set of colors used for the “dark” mode version of the same icon, with one or more of the colors switched between foreground element(s) and background element(s) of the icon. In some embodiments, one set of characteristic colors is substantially similar to another set of characteristic colors when a difference between corresponding colors in the two sets of colors is less than a threshold difference (e.g., a threshold number of different colors, and/or a threshold difference in value between colors that have the same hue). In some embodiments, one set of characteristic colors is substantially similar to another set of characteristic colors when the two sets of characteristic colors have the same set of hues, but have different shades or tints of the same set of hues in the two sets of characteristic colors. In some embodiments, one set of characteristic colors is substantially similar to another set of characteristic colors when the two sets of characteristic colors are from the same family of colors (e.g., warm colors, or cool colors, colors that are within the same quadrant on the color wheel). In some embodiments, one set of characteristic colors is substantially similar to another set of characteristic colors when the two sets of characteristic colors have the same visual characteristics (e.g., pastel colors, vibrant colors, muted colors). Maintaining selected colorful or tint appearance configuration for foreground elements of the user interface objects while changing the background of the home screen user interface, in accordance with an automatic change of the state of the device from light mode to dark mode or vice versa, preserves selected appearance for the user interface objects (e.g., by users or app developers) while also provides visual feedback for a current state or change of state of the computer system, thereby reducing the number and/or complexity of inputs needed configure appearance of a home user interface and provides visual feedback that the system is in a specific operation state.

In some embodiments, the first set of characteristic colors of the first user interface object includes (14028) a first subset of characteristic colors and a second subset of characteristic colors different from the first subset of characteristic colors, wherein the first subset of characteristic colors is used for one or more foreground elements of the first user interface object, and the second subset of characteristic colors is used for one or more background elements of the first user interface object, when the computer system is operating in the first state (e.g., the “light” mode, or the “dark” mode). In some embodiments, the third set of characteristic colors of the first user interface object includes the first subset of characteristic colors and the second subset of characteristic colors, wherein the second subset of characteristic colors is used for the one or more foreground elements of the first user interface object, and the first subset of characteristic colors is used for the one or more background elements of the first user interface object, when the computer system is operating in the second state (e.g., the “dark” mode, or the “light” mode). In some embodiments, when the computer system switches between the light mode and the dark mode, the icons for at least some of the applications changes their appearances by switching the colors used for their background elements with the colors used for their foreground elements. For example, application icon 900 corresponding to messages, application icon 918 corresponding to a settings application, an application icon 908 for a music application in FIGS. 9A-9B are examples of such icons in which the background color in the light mode becomes the foreground color for the foreground elements in the dark mode, in accordance with some embodiments. In some embodiments, the background elements include the background image underlying a symbol or graphic representing the identity of the application, and the foreground elements include the symbol or graphic which may include multiple colors. In some embodiments, the first subset of characteristic colors and the second subset of characteristic colors do not include all of the colors used for the foreground elements and/or the background elements of an icon, and only includes the color or colors that are switched between foreground and background elements when the computer system switches between the first state and the second state. In some embodiments, the second set of characteristic colors of the second user interface object includes a third subset of characteristic colors and a fourth subset of characteristic colors different from the third subset of characteristic colors, wherein the third subset of characteristic colors is used for one or more foreground elements of the second user interface object, and the fourth subset of characteristic colors is used for one or more background elements of the second user interface object, when the computer system is operating in the first state (e.g., the “light” mode, or the “dark” mode); and the fourth set of characteristic colors of the second user interface object includes the third subset of characteristic colors and the fourth subset of characteristic colors, wherein the third subset of characteristic colors is used for the one or more foreground elements of the second user interface object, and the fourth subset of characteristic colors is used for the one or more background elements of the second user interface object, when the computer system is operating in the second state (e.g., the “dark” mode, or the “light” mode). Although the first user interface object and/or the second user interface object are given as examples, it is understood that the same case may apply to one or more other user interface objects in the first plurality of user interface objects included in the home screen user interface. In some embodiments, the set of colors that are used for the “light” mode version of an icon, are the same set of colors used for the “dark” mode version of the same icon, with one or more of the colors switched between foreground element(s) and background element(s) of the icon. In some embodiments, when a change of the background of the user interface objects on the home screen in accordance with a change from light mode to dark mode would cause foreground elements of a respective user interface objects to become less distinguishable, color for the background of the respective user interface object in light mode becomes color for the foreground elements of the user interface object in dark mode, preserves the selected appearance for the user interface objects while changing the appearance in accordance with a change of state of the computer system. Swapping the colors of different parts of the user interface objects in accordance with a change from light mode to dark, maintains visibility of the main graphic or foreground elements of a user interface objects while also changing the appearance in accordance with a change of state of the computer system, thereby reducing the time needed to locate a user interface objects and the number and/or complexity of inputs needed configure appearance of a home user interface.

In some embodiments, the home screen user interface includes (14030) one or more user interface objects (e.g., one or more application icons and/or widgets) other than the first plurality of user interface objects, wherein the one or more user interface objects correspond to applications other than the first plurality of applications, a respective user interface object of the one or more user interface objects, when selected by a selection input of the first input type (e.g., a tap input, an air pinch gesture detected in conjunction with a gaze input, a click input detected in conjunction with a location of a focus selector, or another type of selection input), causes the computer system to display a respective application corresponding to the respective user interface object. In some embodiments, displaying the home screen user interface includes, in accordance with a determination that the first appearance property is selected for the first plurality of user interface objects (e.g., the configuration of “colorful” icons is selected), maintaining respective appearances of the one or more user interface objects while the computer system is operating in the first state and while the computer system is operating in the second state (e.g., the one or more icons (e.g., colorful icons) do not change appearances when the computer system switches between the first state and the second state, while the first plurality of user interface objects switch between their “light” and “dark” appearances). In some embodiments, displaying the home screen user interface includes, in accordance with a determination that the second appearance property is selected for the first plurality of user interface objects (e.g., the configuration of “tinted” icons is selected), the computer system maintains respective appearances of the one or more user interface objects while the computer system is operating in the first state and while the computer system is operating in the second state (e.g., the one or more icons (e.g., tinted icons) do not change appearances when the computer system switches between the first state and the second state), while the first plurality of user interface objects switches between their “light” and “dark” appearances. In some embodiments, if the configuration of “colorful” icons is selected, some application user interface objects already have a dark color palette used for the background and a distinctive colorful palette for the foreground elements (e.g., without the system applying any dark filters as in the dark mode). In such scenarios, the color palette used for the background and the foreground elements remain the same even though the device switches from the light mode to dark mode. For example, color palette and appearances of application icon 916 corresponding to the phone application and application icon 928 corresponding to the fitness application remain unchanged even though the device switches from the light mode in FIG. 9A to the dark mode in FIG. 9B (e.g., appearances 916a and 916b of application icon 916 are the same in FIGS. 9A-9B, and appearances 928a and 928b of application icon 928 also remain the same in FIG. 9A-9B). Changing the appearance of some user interface objects in accordance with a change of state of the device while maintaining the respective appearances of other user interface objects even when the computer system changes a state of operation (e.g., light mode to dark mode or vice versa), reduces the time and/or number of inputs needed to locate the user interface objects (e.g., for which the respective appearance is maintained) and provides visual feedback for the current state of the device.

In some embodiments, displaying the first plurality of user interface objects in the home screen user interface with the first constrained (e.g., system-specified) set of colors includes (14032) displaying the first plurality of user interface objects with a first set of one or more tints of a first hue (e.g., one or more variations of a baseline color, that is lighter or darker than the baseline color). In some embodiments, when changing from the “colorful” icon configuration to the “tinted” icon configuration, the computer system tints the first plurality of user interface objects with the same hue, differentiating the internal structures of the user interface objects by varying the tints and shades of the same hue applied to different parts of the user interface objects, achieving an overall tinted “monochromatic” look of the home screen user interface. For example, in FIGS. 9K-9L, the same tint color is applied to application user interface objects 900-938, resulting in an overall tinted “monochromatic” look of application user interface objects 900-938 on the home screen user interface. In some embodiments, displaying the first plurality of user interface objects in the home screen user interface with the second constrained (e.g., system-specified) set of colors includes displaying the first plurality of user interface objects with a second set of one or more tints of the first hue (e.g., a set of darker tints of the first hue than the first set of one or more tints, or a set of one or more shades of the first hue). In some embodiments, displaying the first plurality of user interface objects in the home screen user interface with the second constrained (e.g., system-specified) set of colors includes displaying the first plurality of user interface objects with a set of one or more tints of a second hue different from the first hue (e.g., a set of tints of a darker hue than the first hue, or a set of shades of the second hue). Applying a uniform tint configuration for multiple user interface objects on the home screen in response to selecting “tinted” icon configuration, reduces the number of input and/or time needed to configure the appearance of a home user interface (e.g., applying the same tint color concurrently across multiple objects on the home screen user interface without the need to change color of individual user interface objects).

In some embodiments, the first plurality of user interface objects includes (14034) a plurality of application icons that correspond to different applications. In some embodiments, displaying the first plurality of user interface objects with the first set of one or more tints of the first hue (e.g., one or more variations of a baseline color, that is lighter or darker than the baseline color) includes displaying a plurality of components (e.g., graphical components, and/or textual components) of a respective application icon of the plurality of application icons, in respective layers of a plurality of layers (e.g., translucent layers, where unoccupied regions of the respective layers are translucent, and optionally, the component(s) contained a respective layer are also translucent, optionally, to a degree that is less than the unoccupied portion of the respective layer). For example, the plurality of translucent layers of a respective application icon include different components of the application icon that have different tints of the same hue. Using multiple translucent layers for user interface objects enables the device to change appearance of different elements of user interface objects in accordance with different color configurations, thereby improving the richness of the available color configurations.

In some embodiments, the first plurality of user interface objects include (14036) a plurality of widgets that correspond to different applications. In some embodiments, displaying the first plurality of user interface objects in the home screen user interface with the first constrained (e.g., system-specified) set of colors includes displaying the plurality of widgets with a second set of one or more tints of the first hue (e.g., one or more variations of a baseline color, that is lighter or darker than the baseline color. The same tint color is applied to application icons 900-936 and application widget 938, resulting in an overall tinted “monochromatic” look of application user interface objects 900-938 on the home screen user interface, as illustrated in FIG. 9P. In some embodiments, when changing from the “colorful” icon configuration to the “tinted” icon configuration, the computer system tints the plurality of widgets with the same hue, differentiating the internal structures of the widgets by varying the tints and shades of the same hue applied to different parts of the widgets. In some embodiments, displaying the first plurality of user interface objects in the home screen user interface with the second constrained (e.g., system-specified) set of colors includes displaying the plurality of widgets with another set of one or more tints of the first hue (e.g., a set of darker tints of the first hue than the first set of one or more tints, or a set of one or more shades of the first hue). In some embodiments, displaying the first plurality of user interface objects in the home screen user interface with the second constrained (e.g., system-specified) set of colors includes displaying the plurality of widgets with a set of one or more tints of a second hue different from the first hue (e.g., a set of tints of a darker hue than the first hue, or a set of shades of the second hue). Applying a uniform tint configuration for both application icons and widgets on the home screen in response to selecting a “tinted” icon configuration, reduces the number of input and/or time needed to configure the appearance of a home user interface (e.g., no need to reconfigure widgets separately from application icons).

In some embodiments, displaying the plurality of widgets with the second set of one or more tints of the first hue includes (14038) displaying a respective widget of one or more widgets that includes: displaying one or more foreground elements of the respective widget with a third color different from the first color and the second color. FIG. 9Q illustrates home screen user interface 9000 that displays application user interface objects 900-936 with a first tinted color applied uniformly to application user interface objects 900-936, in accordance with a selected tint configuration. Application widget 938 is also applied the same first tinted color, however, the foreground element corresponding to the date (e.g., “Sunday 8”) is displayed with an additional color, different from the first color. In some embodiments, the third color is a tint or shade of the first hue. In some embodiments, the third color is a neutral color that is not a tint or shade of the first hue (e.g., white, black, or grey). For example, in some embodiments, some elements or display layers of the respective user widget in the foreground have the same color as the background of the respective widget, and some elements and/or display layers in the foreground have the same foreground color, but some elements and/or display layers of the respective widget has a different foreground color from the other foreground elements and are displayed in a neutral color (e.g., white, gray, or black) or an accent color (e.g., colors that have a different hue from the other elements). Displaying one or more foreground elements of the respective widget with a third additional color different from the first and second colors that are used in both the widgets and application icons (e.g., in accordance with the selected tint configuration), preserves the visibility of elements in the widgets that may have more complex shapes, elements, and/or content relative to application icons, thereby reducing the time needed to locate content displayed in widgets and/or reduces the number of inputs and/or time needed to configure the appearance of a home user interface.

In some embodiments, the first plurality of user interface objects include (14040) a plurality of application icons that correspond to different applications. Displaying the first plurality of user interface objects in the home screen user interface with the first constrained (e.g., system-specified) set of colors includes displaying a respective application icon of one or more application icons that includes: displaying a background of the respective application icon with the first color that is a tint of the first hue; and displaying one or more foreground elements of the respective application icon with the second color that is a tint of the first hue (e.g., without displaying foreground elements of the respective application icon with the third color). For example, while application icons 900-926 in home user interface 9000 in FIG. 9R have the same tinted color for the foreground elements, some foreground elements may have a different brightness, hue, or translucency relative to other foreground elements. For example, icons 906, 908, 916, 920, and 922 have foreground elements with the same tinted color as other icons on the home screen 9000, but in addition, some foreground elements are brighter. For example, the sun in icon 906, the triangle in icon 908, the phone in icon 916, the star in icon 920, and the drop in icon 922. For example, in some embodiments, in contrast to widgets, when the home screen user interface is displayed with the first constrained set of colors, a respective application icon of the plurality of application icons has all foreground elements and/or display layers in the same hue (optionally, in different shades, tints, brightness, and/or translucencies of the same hue), and has a background (e.g., one or more background elements and display layers; or a single background layer) in the same hue as the foreground (and optionally, in different shades, tints, brightness, and/or translucency of the same hue), resulting in a monochromatic look of the respective application icon, and of the application icons in the home menu user interface as a whole. Displaying one or more foreground elements of the respective widget with a third additional color different from the first and second colors that are used in both the widgets and application icons (e.g., in accordance with the selected tint configuration), preserves the visibility of elements in the widgets that may have more complex shapes, elements, and/or content relative to application icons, thereby reducing the time needed to locate content displayed in widgets and/or reduces the number of inputs and/or time needed to configure the appearance of a home user interface.

In some embodiments, a respective user interface object (e.g., each user interface object) of the first plurality of user interface objects includes (14042) one or more primary elements of the respective user interface object and one or more secondary elements of the respective user interface object. Displaying the first plurality of user interface objects with a first set of one or more tints of the first hue includes displaying the one or more primary elements of the respective user interface object with a first subset of the first set of one or more tints of the first hue, and displaying the one or more secondary elements of the respective user interface object with a second subset of the first set of one or more tints of the first hue, where the first subset of the first set of one or more tints of the first hue are lighter than the second subset of the first set of one or more tints of the first hue (e.g., the primary elements of the respective user interface object are lighter than the secondary elements of the respective user interface objects, even though they are both of the same first hue). For example, as illustrated in FIG. 9AA, the foreground element of icon 906 corresponding to the sun is lighter or brighter than the rest of the foreground elements regardless of whether a “colorful” icon configuration and a “tint” icon configuration is selected, and regardless of whether the device 100 is operating in the light mode vs dark mode. In some embodiments, the primary elements of the respective user interface objects are elements in the top layer and/or higher layers of the respective user interface object, and the secondary elements of the respective user interface objects are elements in the bottom layer and/or lower layers of the respective user interface object. In some embodiments, the primary elements of the respective user interface objects are elements in the central region of the respective user interface object, and the secondary elements of the respective user interface objects are elements in the peripheral region of the respective user interface object. In some embodiments, the primary elements of the respective user interface objects are elements that are larger than a threshold proportion of the respective user interface, and the secondary elements of the respective user interface objects are elements that are smaller than the threshold portion of the respective user interface object. In some embodiments, other ways of separating primary elements and secondary elements of user interface objects are possible. Displaying primary elements and secondary elements of user interface objects with the same color but different hue, brightness, or saturation, improves visibility of selected elements of a user interface objects while also displaying the user interface objects in accordance with the selected visual appearance configuration (e.g., tint configuration), thereby reducing the time needed to locate user interface objects on the home screen user interface and/or reduces the number of inputs and/or time needed to configure the appearance of a home user interface.

In some embodiments, displaying the home screen user interface includes (14044): in accordance with a determination that a first event that corresponds to an application associated with a first user interface object of the first plurality of user interface object has occurred, displaying a first animated movement of the first user interface object in the home screen user interface (e.g., the home screen in a normal mode, or the home screen in a reconfiguration mode). In some embodiments, computer system displays the first animated movement for the first user interface object without displaying the same first animated movement for one or more other user interface objects of the first plurality of user interface objects (e.g., a second user interface object, or other user interface objects different from the first user interface object). In some embodiments, displaying the home screen user interface further includes: in accordance with a determination that a second event that corresponds to an application associated with a second user interface object, different from the first user interface object, of the first plurality of user interface object, has occurred, displaying a second animated movement of the second user interface object in the home screen user interface (e.g., the home screen in a normal mode, or the home screen in a reconfiguration mode). For example, in FIG. 5AT, in accordance with a determination that the messages application (e.g., corresponding to application icon 5002), the photos application (e.g., corresponding to application icon 5004), the fitness application (e.g., corresponding to application icon 5020a), and the settings application (e.g., corresponding to the application icon 5022a) have respective ongoing activities occurring, the computer system 101 displays animation of respective foreground graphical portions of application icons 5002, 5004, 5020a, and 5022a are animated (e.g., illustrated by arrows 5084, arrow 5086, arrow 5088) while other application icons in home screen user interface 5011 are displayed without animation. In some embodiments, the computer system displays the second animated movement of the second user interface object without displaying the same second animated movement for one or more other user interface objects of the first plurality of user interface objects (e.g., the first user interface object, or other user interface objects different from the second user interface object). For example, in some embodiments, an event that corresponds to an application associated with a respective user interface object includes an event that corresponds to an application associated with an application icon, or a widget displayed in the home screen user interface (e.g., irrespective of whether the computer system is in the first state or the second state, and/or irrespective of whether the first appearance property or the second appearance property is selected for the first plurality of user interface objects). In some embodiments, the event that corresponds to an application of a respective user interface object includes changes that has occurred in the application, such as when the application is closed, terminated, and/or dismissed (e.g., by navigating to the home screen, or closing the application in the multitasking user interface). In accordance with a determination that an application is closed prior to the display of the home screen, the computer system displays the application icon and/or widget of the application with an animated movement (e.g., shrinking the application user interface toward its icon and showing the icon settling into place on the home screen user interface) to indicate that the application corresponding to the application icon and/or widget has recently been closed. In some embodiments, the event that corresponds to an application of a respective user interface object includes changes that has occurred in the application, such as when the application is first downloaded or an update to the application is being downloaded. In accordance with a determination that an application is being downloaded or updated with additional downloads, the computer system displays the application icon and/or widget of the application with an animated indicator (e.g., an indicator that indicates the progress of the download and/or the status of the download (e.g., ongoing, suspended, waiting, paused, or recently completed). In some embodiments, the event that corresponds to an application of a respective user interface object includes changes that has occurred on the application icon or widget, such as when the application icon is within a target region of a gaze input, a hovering contact, a focus selector, and/or a pointing device, but is not yet activated or selected by a user input (e.g., a tap input, an air pinch gesture, an air tap gesture, a click input, or activation of an affordance or controller). In accordance with a determination that the application icon or widget is within the target region of a gaze input, a hovering contact, a focus selector, and/or a pointing device, but is not yet activated or selected by a user input, the computer system displays the application icon and/or widget of the application with an animated movement (e.g., shifting away from its placement location in the home screen, enlarging or shrinking in size, and/or pulsating) to indicate that the application icon or widget is within the target region of an input element and is ready to be selected or activated by a user input. In some embodiments, the event that corresponds to an application of a respective user interface object includes changes that has occurred on the application icon or widget, such as when the application icon is being dragged by a user input (e.g., a tap-hold and drag input performed by a contact on the application icon or widget, an air pinch and drag gesture that is detected when a gaze is on the application icon or widget, an air tap gesture performed at the location of the application icon or widget, or a click-hold and drag input detected when a focus selector on the application icon or widget). In accordance with a determination that the application icon or widget is being dragged by a user input (e.g., in a reconfiguration mode), the computer system displays an animated movement of the application icon or widget moving across the home screen user interface, relative to other icons in the home screen user interface, in accordance with the drag input. Displaying an animated movement in a respective user object in the home screen user interface in accordance with a determination that an event with respect to the application corresponding to the respective user interface object is occurring (e.g., the application is being updated, the application is closed, the application is being downloaded, information is being received or sent by the application, when a hover input over the respective user interface object is detected, when the respective user object is moved (e.g., in home rearrangement mode), when the application is being actively used in a current session on the device), provides visual feedback to a user that an event is occurring with respect to the respective application.

In some embodiments, while displaying the home screen user interface (e.g., while the computer system is in the first state or the second state, and while the first appearance property or the second appearance property is selected for the first plurality of user interface objects), the computer system detects (14046) a first user input that corresponds to a request to configure the home screen user interface. In response to detecting the first user input that corresponds to a request to configure the home screen user interface, the computer system displays the home screen user interface in a reconfiguration mode in which one or more configurations of a respective user interface object in the home screen user interface are adjustable in accordance with user inputs, wherein displaying the home screen user interface in the reconfiguration mode includes displaying one or more object appearance controls (e.g., a toggle control that has a first state corresponding to “colorful” icons, and a second state corresponding to “tinted” icons; and/or other types of controls (e.g., color picker, color swatches, or other controls) for specifying a hue for the first plurality of user interface objects) for selecting the first appearance property or the second appearance property for the first plurality of user interface objects in the home screen user interface. For example, in FIG. 9E, the device 100 displays control 9006 for activating a color editing user interface in the home screen user interface 9000 displayed in the reconfiguration mode, and FIGS. 9F-9N displays interactions with different controls in the color editing user interface 9008 (e.g., displayed in response to the selection of control 9006 in FIG. 9E). In some embodiments, in the reconfiguration mode of the home screen user interface (e.g., in a first reconfiguration mode of the home screen user interface, such as the interface reconfiguration mode of the home screen user interface), the configuration of the home screen as a whole, and/or shared configurations of multiple application icons and/or widgets on the home screen user interface, are adjustable collectively or as a whole, in accordance with user inputs (e.g., changing a background of the home screen user interface, changing a grid size of the home screen user interface, changing whether textual labels for icons are displayed, changing whether colorful icons or tinted icons are selected for the home screen, changing which wake screen is paired with the home screen, and changing display properties such as blur radius and/or translucency of the background of the wake screen). In some embodiments, in the reconfiguration mode of the home screen user interface (e.g., in a second reconfiguration mode of the home screen user interface, such as the icon reconfiguration mode of the home screen user interface), configurations of individual application icons and/or widgets can be adjustable on an individual icon basis in accordance with user inputs (e.g., an icon can be moved from one placement location to another placement location in the home screen user interface, removed from the home screen user interface and/or from the computer system, associated with a different application category, displayed with a different size, converted from an application icon to a widget, converted from a widget to an application icon, displayed with different application content, and/or added to a stack and share the same placement location with other widgets, in the reconfiguration mode in accordance with user inputs). In some embodiments, detecting a first user input that corresponds to a request to configure the home screen user interface includes detecting a user input that corresponds to a request to configure one or more aspects of the home screen user interface as a whole. In some embodiments, the user input that corresponds to a request to configure one or more aspects of the home screen user interface as a whole includes an input that initiates a reconfiguration process from a wake screen user interface of the computer system (e.g., a touch and hold input detected on the wake screen user interface, or another input that causes the computer system to enter the reconfiguration user interface of the wake screen user interface) followed by an input that selects an option to customize the home screen user interface that is currently paired with the wake screen user interface. In some embodiments, the user input that corresponds to a request to configure one or more aspects of the home screen user interface as a whole includes an input that initiates a reconfiguration process for the home screen user interface from a system settings user interface (e.g., a touch input selecting an option for customizing the wallpaper and other aspects of the home screen user interface, or another input that causes the computer system to enter the reconfiguration user interface of the home screen user interface).

In some embodiments, detecting the first user input that corresponds to a request to configure the home screen user interface includes detecting a touch-hold input directed to an icon or an unoccupied region of the home screen user interface, or a touch-hold and drag input directed to an icon in the home screen user interface. In some embodiments, detecting the first user input that corresponds to a request to configure the home screen user interface includes detecting a touch-hold input directed to an icon on the home screen user interface to show a selectable option for configuring the home screen user interface (e.g., an “edit home screen” option in a menu associated with the icon), followed by a selection of the selectable option. It is to be noted that, although a touch input on a touch-screen is used as an example for the first user input that corresponds to a request to configure the home screen user interface, it is to be understood, that the touch input can be replaced by another type of user input in another operating environment that provides a home screen user interface in a different form factor, format, and/or configuration, and examples of the types of user input that can trigger the reconfiguration of the home screen user interface include, and are not limited to, a touch-and hold gesture on a touch-sensitive surface at a location that corresponds to a location of the home screen user interface on the display, an air tap and hold gesture at a location of an icon or home screen user interface, an air tap and hold gesture detected while a gaze is directed to an icon or home screen user interface, an air pinch and hold gesture detected while a gaze is directed to an icon or home screen user interface, a click and hold input when a focus selector is on an icon in the home screen user interface, a right or left click input when a focus selector is on an icon in the home screen to show a menu option for configuring the home screen user interface followed by selection of the menu option, press and hole on a crown or hardware control of the computer system to trigger a home screen configuration mode. Displaying, in the home screen user interface that is in the reconfiguration mode, a dedicated control (e.g., a control for activating a color picker user interface) for configuring one or more appearance properties for user interface objects on the home screen user interface (e.g., optionally, in a configuration user interface for changing visual properties), reduces the number and/or complexity of inputs needed to reconfigure the appearance of a home user interface.

In some embodiments, while displaying the home screen user interface in the reconfiguration mode, including concurrently displaying the one or more object appearance controls with a first subset of one or more user interface objects (e.g., application icon(s) and/or widget(s), optionally, in an animated state to indicate that they are in an icon reconfiguration mode) of the first plurality of user interface objects in the home screen user interface (e.g., the subset of one or more of the first plurality of user interface objects corresponds to a currently displayed portion or page of the home screen user interface), the computer system detects (14048) a first movement input that is directed to a respective user interface object of the first subset of one or more user interface objects of the first plurality of user interface objects. In response to detecting the first movement input that is directed to the respective user interface object (e.g., directed to a central region of the respective user interface object, or directed to a move affordance of the respective user interface object) of the first subset of one or more user interface objects of the first plurality of user interface objects, the computer system moves the respective user interface object relative to the home screen user interface (e.g., from a first placement location to a second placement location for the respective user interface object in the home screen user interface) in accordance with the first movement input. For example, in FIG. 9F, while the color editing user interface 9008 is concurrently displayed with home user interface 9000 in the reconfiguration mode, a drag input 9102 detected while application icon 9030 is selected would cause the device 100 to relocate icon 9030 from the top row to a placement location indicated by an end of the arrow in FIG. 9E. In some embodiments, moving the respective user interface object in the home screen user interface includes ceasing to display the respective user interface object at a first placement location in the home screen user interface and displaying the respective user interface object at a second placement location, different from the first placement location, in the home screen user interface. In some embodiments, detecting the first movement input directed to the respective user interface object includes detecting a touch and drag input performed by a contact at a location of the respective user interface object on a touch-screen display. In some embodiments, in response to detecting the first movement input that is directed to the respective user interface object (e.g., directed to a corner, an edge, or a resize affordance of the respective user interface object), the computer system changes the size of the respective user interface object, e.g., from a first size to a second size, and optionally changes the application content that is included in the respective user interface object, in accordance with the magnitude and direction of the first movement input. It is to be noted that, although a touch input on a touch-screen is used as an example for the first movement input that is directed to the respective user interface object, it is to be understood, that the touch input can be replaced by another type of user input in another operating environment that provides a home screen user interface in a different form factor, format, and/or configuration, and examples of the types of user input that can move the respective user interface object in the home screen user interface include, and are not limited to, a touch and drag gesture on a touch-sensitive surface that starts a location that corresponds to a location of the respective user interface object on the display, an air tap and drag gesture that starts at a location of the respective user interface object, an air tap and drag gesture detected while a gaze is directed to the respective user interface object, an air pinch and drag gesture detected while a gaze is directed to the respective user interface object, or a click-hold and drag input when a focus selector is on the respective user interface object. In some embodiments, the home user interface and user interface objects displayed on the home user interface are at least partially visible while a color configuration user interface (e.g., for configuring appearance properties of user interface objects) is displayed (e.g., displayed in response to detecting a selection of a control for activating a color picker user interface). In some embodiments, the appearance of the user interface objects can be changed in the configuration user interface, and, in conjunction, the changes can be previewed on the home user interface. Further, optionally, the home user interface can be rearranged while the configuration user interface is displayed. Rearranging the home user interface (e.g., relocating user interface objects on the home user interface), while displaying a color configuration user interface or while displaying a control for displaying the color configuration user interface, reduces the number and/or complexity of inputs needed to rearrange the user interface and/or change the appearance of the home user interface (e.g., no need to dismiss and activate the color configuration user interface to rearrange the home user interface; and/or no need to activate or deactivate the reconfiguration mode, etc.).

In some embodiments, while displaying the home screen user interface in the reconfiguration mode, including concurrently displaying the one or more object appearance controls with a first subset of one or more user interface objects (e.g., application icon(s) and/or widget(s), optionally, in an animated state to indicate that they are in an icon reconfiguration mode) of the first plurality of user interface objects in the home screen user interface (e.g., the subset of one or more of the first plurality of user interface objects corresponds to a currently displayed portion or page of the home screen user interface), the computer system detects (14050) a first selection input that is directed to a first object appearance control of the one or more object appearance controls. In response to detecting the first selection input that is directed to the first object appearance control, the computer system displays a plurality of selectable options corresponding to a plurality of colors for changing colors of the first plurality of user interface objects in the home screen user interface (e.g., icons and/or widgets on the home screen). For example, in FIG. 9J-9K, in response to the detection of input 9112 selecting control 9012 for picking a tint color, the device 100 optionally displays color editing user interface 9008a with color pots 9300, 9302, 9304, and 9306 representing different tint colors that can be selected. In some embodiments, the plurality of selectable options include and/or correspond to different hues, different tints and/or shades of a hue, colors on a color wheel, a color pallet, or another collection of selectable colors). In some embodiments, by selecting a respective selectable option that corresponds to a respective color, the computer system updates the first constrained set of colors and the second constrained set of colors to includes shades and tints of the respective color, replacing previously included colors in the first and second constrained set of colors; and displays the first plurality of user interface objects using the updated first constrained set of colors or the updated second constrained set of colors (e.g., depending on whether the currently displayed state is the “light” state or the “dark” state), as a preview of how the home menu user interface would look once the computer system exits the reconfiguration mode of the home menu user interface with the currently selected color. In some embodiments, detecting the first selection input directed to the first object appearance control includes detecting a tap input performed by a contact at a location of the first object appearance control on a touch-screen display. It is to be noted that, although a touch input on a touch-screen is used as an example for the first selection input that is directed to the first object appearance control, it is to be understood, that the touch input can be replaced by another type of user input in another operating environment that provides an object appearance control. Examples of the types of user input that can select the first object appearance control include, and are not limited to, a tap input on a touch-sensitive surface at a location that corresponds to a location of the object appearance control on the display, an air tap gesture at a location of the object appearance control, an air tap gesture detected while a gaze is directed to the object appearance control, an air pinch gesture detected while a gaze is directed to the object appearance control, a click input detected when a focus selector is on the object appearance control, and an activation of a controller when the object appearance control has input focus. Displaying a color palette (e.g., in a color configuration user interface) while displaying the home user interface and at least a portion of the user interface objects on the home user interface, allows a user to change a color or other visual properties of the user interface objects multiple times and preview those changes in respective user interface objects displayed on the home screen user interface, thereby reducing the number and/or complexity of inputs needed to change the appearance of the home user interface.

In some embodiments, displaying the one or more object appearance controls includes (14052) concurrently displaying a first set of one or more controls that corresponds to the first appearance property (e.g., the “colored” icons configuration), and a second set of one or more controls that corresponds to the second appearance property (e.g., the “tinted” icons configuration). For example, in FIG. 9F, color editing user interface 9008 includes a control 9020a for activating a system-selected appearance, a control 9020b for activating a light mode appearance, a control 9020c for activating a dark mode appearance, and control 9020d for selecting a tint appearance. In some embodiments, the first set of one or more controls that corresponds to the first appearance property (e.g., the “colored” icons configuration) includes a multicolored control (e.g., a rainbow colored circle, a color wheel, or another control that includes an indication that it is a “colorful” icon option), and the second set of one or more controls that corresponds to the second appearance property includes a plurality of monochromatic controls corresponding to a plurality of hues. Concurrently displaying, optionally in a color configuration user interface, various options for changing the color configuration of user interface objects on the home screen, allows a user to change a color configuration of the user interface objects multiple times and in various ways, and optionally preview those changes on the home screen user interface before committing to the changes (e.g., before exiting the reconfiguration mode), thereby reducing the number and/or complexity of inputs needed to change the appearance of the home user interface.

In some embodiments, while concurrently displaying the first set of one or more controls that corresponds to the first appearance property and the second set of one or more controls that corresponds to the second appearance property, the computer system detects (14054) a second selection input that is directed to a respective control in the second set of one or more controls, wherein the respective control corresponds to a respective color (e.g., a single hue). In response to detecting the second selection input that is directed to the respective control that corresponds to the respective color, the computer system changes an appearance of one or more user interface objects in the home screen user interface (e.g., icons and/or widgets on the home screen) based on the respective color (e.g., choosing the “tinted” icon configuration and updating the first constrained set of colors and the second constrained set of colors to be different shades and tints of the respective color (e.g., the hue of the respective color that has been chosen)). In some embodiments, the second set of one or more controls includes multiple controls that respectively correspond to different colors corresponding to different hues, and a selection input directed to any of the multiple controls causes the computer system to select the second appearance property for the first plurality of user interface objects (e.g., choosing the “tinted” icon configuration), and to configure the first constrained set of colors and the second constrained set of colors in accordance with the color (e.g., the single hue) corresponding to the selected control In response to detecting the second selection input, in accordance with a determination that the respective control is a first control that corresponds to a first color, the computer system changes the one or more user interface objects in the home screen user interface to have colors based on tints of the first color; and in accordance with a determination that the respective control is a second control that corresponds to a second color, different from the first color, the computer system changes the one or more user interface objects in the home screen user interface to have colors based on tints of the second color, and optionally shows a preview of the home screen with the updated mode and color. In some embodiments, the color configuration user interface includes an option to select a custom color (e.g., a custom tint color) that, when selected, is applied uniformly to user interface objects on the home screen, resulting in monochromatic appearance of objects on the home screen user interface. For example, in FIG. 9F, the color editing user interface 9008 includes control 9020d for selecting a tint appearance that, when selected, causes the device 100 to uniformly apply the selected tinted color to application user interface objects 900-938, resulting in a monochromatic tinted appearance of user interface objects 900-938 (e.g., tinted appearances 900d-938d), as illustrated in FIG. 9L. Providing a control option for selecting a monochromatic color scheme for user interface objects on the home screen user interface, allows a user to customize the appearance of the home user interface and reduces the number inputs and/or time needed to configure the appearance of the home user interface.

In some embodiments, while concurrently displaying the first set of one or more controls that corresponds to the first appearance property and the second set of one or more controls that corresponds to the second appearance property, the computer system detects (14056) a selection input that is directed to a control in the second set of one or more controls that corresponds to a currently selected system font color (e.g., an option to adapt the tints of the icons in the home screen to the color of the system font, such as a font used in the home screen user interface or the wake screen user interface). In response to detecting the selection input that is directed to the control that corresponds to the currently selected system font color, the computer system selects the second appearance property for the first plurality of user interface objects (e.g., choosing the “tinted” icon configuration), and configures the first constrained set of colors and the second constrained set of colors in accordance with the currently selected system font color (e.g., the first constrained set of colors and the second constrained set of colors are different shades and tints of the currently selected system font color, or complementary to the currently selected system font color). In some embodiments, the control that corresponds to the currently selected font color shows the currently selected system font color, and changes its color when the currently selected system font color is changed by a user in another configuration process (e.g., during configuration of the wake screen user interface). In some embodiments, the currently selected system font changes from one font color to another font color in response to a change in the currently selected font type. In some embodiments, in response to detecting that the currently selected system font color and/or font type is changed by a user (e.g., by changing the currently selected focus mode, and/or the currently selected wake screen) or by the computer system based on one or more conditions (e.g., conditions for automatically changing a current focus mode, changing a currently selected wake screen, or other system changes) being met, the computer system, optionally, after automatically selecting the second appearance property for the first plurality of user interface objects (e.g., choosing the “tinted” icon configuration, if not already selected), configures the first and second constrained sets of colors in accordance with the updated font color and/or font type, if the second appearance property is currently selected. In some embodiments, in response to detecting that the currently selected system font color and/or font type is changed by a user (e.g., by changing the currently selected focus mode, and/or the currently selected wake screen) or by the computer system based on one or more conditions (e.g., conditions for automatically changing a current focus mode, changing a currently selected wake screen, or other system changes) being met, the computer system, optionally, does not automatically select the second appearance property for the first plurality of user interface objects if not already selected, and does not configure the first and second constrained sets of colors in accordance with the updated font color and/or font type, if the second appearance property is not currently selected. In some embodiments, the color configuration user interface includes an option for color (e.g., dynamic color option) that, when selected, causes the device to apply, uniformly to user interface objects on the home screen, a system-selected color scheme that is based on, and changes dynamically, according to a color scheme selected for a system font. Providing a control option for selecting a system-selected color scheme (e.g., that changes dynamically according to a color scheme selected for a system font) for user interface objects on the home screen user interface, reduces the number inputs and/or time needed to configure the appearance of the home user interface (e.g., inputs needed to improve the uniformity or harmony of colors used different user interface on the device).

In some embodiments, while concurrently displaying the first set of one or more controls that corresponds to the first appearance property and the second set of one or more controls that corresponds to the second appearance property, the computer system detects (14058) a fourth selection input that is directed to a respective control in the second set of one or more controls that corresponds to a currently selected background for the home screen user interface (e.g., an option to adapt the tints of the icons in the home screen to the colors of the background of the home screen user interface). In response to detecting the fourth selection input that is directed to the respective control that corresponds to the currently selected background for the home screen user interface, the computer system selects the second appearance property for the first plurality of user interface objects (e.g., choosing the “tinted” icon configuration), and configures the first constrained set of colors and the second constrained set of colors in accordance with the currently selected background for the home screen user interface (e.g., the first constrained set of colors and the second constrained set of colors are different shades and tints of a hue that contrasts well (e.g., ensuring good visual contrast to the background, and/or without visually clashing with the background) with the currently selected background of the home screen user interface. In some embodiments, the respective control that corresponds to the currently selected background for the home screen user interface shows a recommended hue that adapts to the colors of the background of the home screen user interface, and changes its color and/or hue (e.g., due to a change in recommended hue) when the currently selected background is changed. In some embodiments, the currently selected background of the home screen user interface changes when the currently selected home screen is switched from a first version of the home screen to a second version of the home screen due to a change in notification delivery mode (e.g., activation or termination of a DND mode or another focus mode, based on user request or automatically based on changing contextual conditions), due to editing of the wake screen user interface that affects the background of a corresponding home screen, due to editing of the home screen user interface, due to automatic rotation through different background images used for the background of the home screen user interface (e.g., automatic rotation through different photographs in the photo library or album as the background of the home screen user interface), and/or other scenarios that causes the background of the home screen to change in appearance. In some embodiments, the colors in the first and second constrained sets of colors are automatically updated when the background of the home screen user interface changes in accordance with a user request (e.g., a user request to change the active focus mode or the currently selected wake screen) and/or automatically changes in accordance with one or more conditions (e.g., conditions for automatically switching focus modes and/or wake screens) and the change in background results in a change in color and/or appearance of the background of the home screen user interface; and the computer system automatically updates the appearances of the first plurality of user interface objects based on the updated constrained sets of colors when the home screen user interface is displayed. In some embodiments, the background of the home screen user interface is not a single color, and may include an image, a gradient, a pattern, graphics, and/or photographs, and as a result may include a multitude of colors based on multiple hues, and the first and second constrained set of colors are chosen based on the characteristics of the colors in the background of the home screen user interface, such as the relative spatial distribution and/or visual contrast of the colors in the background. In some embodiments, the background is processed to include different shades and/or tints of the same hue, and the colors of the first plurality of user interface objects are chosen to complement or contrast with the background (e.g., chosen from the same side of the color wheel or opposite side of the color wheel relative to the colors of the background).

In some embodiments, the color configuration user interface includes an option for system-selected dynamic color that, when selected, causes the device to apply, uniformly to user interface objects on the home screen, a system-selected color scheme that is based on, and changes dynamically, according to a color scheme of a system background or wallpaper of the home screen user interface. For example, in FIG. 9F, control 9020a for activating a system-selected appearance (e.g., displayed in color editing user interface 900), optionally, when selected, causes the device 100 to apply, uniformly to user interface objects on the home screen, a system-selected color scheme that is based on, and changes dynamically, according to a color scheme of a system background or wallpaper of the homes screen user interface. For example, in FIG. 9U-9V, in accordance with a determination that control 9020a for activating a system-selected appearance is selected and in accordance with a determination that the background 9002 changes to background 9003, the device 100 automatically changes the tinted appearance of application user interface objects 900-938 in accordance with a color scheme in background 9003. Providing a control option for selecting a system-selected dynamic color (e.g., that changes dynamically according to a color scheme of system background or wallpaper of the homes screen user interface) for user interface objects on the home screen user interface, reduces the number inputs and/or time needed to configure the appearance of the home user interface (e.g., inputs needed to improve the uniformity or harmony of colors used on a home screen user interface).

In some embodiments, displaying the second set of one or more controls that corresponds to the second appearance property includes (14060): in accordance with a determination that a background of the home screen user interface has a first appearance (e.g., a first set of colors, hues, and/or distributions of colors and/or hues), displaying a first set of controls that corresponds to a first set of colors that are used to configure the first constrained set of colors and the second constrained set of colors when the second appearance property is selected for the first plurality of user interface objects; and, in accordance with a determination that the background of the home screen user interface has a second appearance (e.g., a second set of colors, hues, and/or distributions of colors and/or hues), different from the first appearance, displaying a second set of controls that corresponds to a second set of colors that are used to configure the first constrained set of colors and the second constrained set of colors when the second appearance property is selected for the first plurality of user interface objects; and the first set of colors are based on the first appearance of the background (e.g., contrasting the colors in the background, and/or are harmonious with the colors in the background), wherein the second set of colors are based on the second appearance of the background (e.g., contrasting the colors in the background, and/or are harmonious with the colors in the background). In some embodiments, the device automatically derives one or more colors from a system background or wallpaper color schemes, and provides respective option for the derived colors (e.g., in the color configuration user interface) that, when selected, causes the device to apply, uniformly to user interface objects on the home screen, a the system-derived color that is based on, (and optionally changes dynamically), a color used in a system background or wallpaper of the homes screen user interface. For example, in FIG. 9K, color pots 9300, 9302, 9304, and 9306 correspond to colors selected from the background 9002 of the home screen user interface. Automatically deriving a color selected from a background or wallpaper, and proving an option corresponding to the system-derived color, in a color configuration user interface, that, when selected, causes the device to apply, uniformly to user interface objects on the home screen, the system-derived color, reduces the number of inputs and/or time needed to change the appearance of a home screen user interface (e.g., inputs needed to improve the uniformity or harmony of colors used on a home screen user interface).

In some embodiments, while displaying the second set of one or more controls that corresponds to the second appearance property, the computer system detects (14062) a user input that selects a respective color for the first constrained set of colors and the second constrained set of colors (e.g., the user input selects the recommended colors by using the second set of one or more controls, or picks a color from a color pallet or color wheel, or uses a color sampling tool to pick out a color from an image). In response to detecting the user input that selects the respective color for the first constrained set of colors and the second constrained set of colors: the computer system selects the second appearance property for the first plurality of user interface objects (e.g., choosing the “tinted” icon configuration); the computer system configures the first constrained set of colors and the second constrained set of colors in accordance with the respective color (e.g., the first constrained set of colors and the second constrained set of colors are different shades and tints of the respective color that is selected by the user input); and in accordance with a determination that the respective color does not meet first criteria (e.g., criteria that require a threshold level of contrast, and visual harmony between the respective baseline color and the colors of the background) with respect to a currently selected background for the home screen user interface, the computer system changes an appearance of the currently selected background for the home screen user interface (e.g., changing the color(s) and/or tint(s) of the background to contrast better with the respective color and/or to be more harmonious with the respective color). For example, in some embodiments, in FIG. 9K, color pots 9300, 9302, 9304, and 9306 represent various preconfigured tint colors that, when selected, would cause the device to change the appearance of the background with a color configuration selected based on or in accordance with the selected color configuration from color pots 9300, 9302, 9304, and 9306. In some embodiments, in response to detecting the user input that selects the respective color, in accordance with a determination that the respective color meets the first criteria (e.g., criteria that require a threshold level of contrast, and visual harmony between the respective color and the colors of the background) with respect to the currently selected background for the home screen user interface, the computer system forgoes changing the appearance of the currently selected background for the home screen user interface. In some embodiments, visual harmony between the chosen base color for the second appearance property and the currently selected background for the home screen user interface is reflected in the first criteria as a white list of acceptable pairings of colors, a backlist of unacceptable pairings of colors, and/or as a threshold value for a quantity that measures the similarity and/or distances between colors based on various properties of the colors (e.g., luminance, location in a color wheel, or other properties, optionally weighted by their spatial distributions and/or dominance in the background). Automatically changing a color scheme used in a background or wallpaper according to a user-selected color configuration, reduces the number of inputs and/or time needed to change the appearance of a home screen user interface (e.g., inputs needed to improve the uniformity or harmony of colors used on a home screen user interface).

In some embodiments, the computer system displays (14064) a first system user interface (e.g., wake screen user interface, notification user interface, widget user interface, control user interface, application library user interface, and/or other system user interfaces in which application icons and/or widgets may be displayed) different from the home screen user interface, wherein the first system user interface includes a second plurality of user interface objects (e.g., as automatically recommended application icons or widgets, as wake screen quick actions, as wake screen complications, as application launcher controls, and/or other forms of application icons and/or widgets; or as representations of sources for notifications), and the second plurality of user interface objects have corresponding user interface objects in the first plurality of user interface objects (e.g., the second plurality of user interface objects are application icons and widgets found in the home screen user interface, and/or variations of the application icons and/or widgets found in the home screen user interface (e.g., icons with slight changes in shape and size, but overall are recognizable as application icons and/or widgets corresponding to the same applications as those icons in the home screen user interface)). In some embodiments, displaying the first system user interface, including the second plurality of user interface objects, includes: in accordance with a determination that the computer system is operating in the first state and the first appearance property is selected for the first plurality of user interface objects (e.g., a configuration for “colorful” icons is selected), displaying the second plurality of user interface objects in the first system user interface with the first flexible set of colors (e.g., a varied set of colors that includes colors selected by individual applications) in the first system user interface (e.g., the colors used in the second plurality of user interface objects correspond to those of their counterparts in the home screen user interface); in accordance with a determination that the computer system is operating in the first state and the second appearance property is selected for the first plurality of user interface objects (e.g., a configuration of “tinted” icons is selected), displaying the second plurality of user interface objects in the first system user interface with the first constrained (e.g., system-specified) set of colors (e.g., a set of related colors that optionally includes different tints of the same color) in the first system user interface (e.g., the tints used in the second plurality of user interface objects correspond to those of their counterparts in the home screen user interface); in accordance with a determination that the computer system is operating in the second state and the first appearance property is selected for the first plurality of user interface objects (e.g., the configuration of “colorful” icons is selected), displaying the second plurality of user interface objects with the second flexible set of colors (e.g., a varied set of colors that includes colors selected by individual applications) in the first system user interface (e.g., the colors used in the second plurality of user interface objects correspond to those of their counterparts in the home screen user interface); and in accordance with a determination that the computer system is operating in the second state and the second appearance property is selected for the first plurality of user interface objects (e.g., the configuration of “tinted” icons is selected), displaying the second plurality of user interface objects with the second constrained (e.g., system-specified) set of colors (e.g., a set of related colors that optionally includes different tints of the same color) in the first system user interface (e.g., the colors used in the second plurality of user interface objects correspond to those of their counterparts in the home screen user interface). In some embodiments, a color configuration selected for user interface objects on the homes screen can also be applied to user interface objects displayed on user interfaces different from the home screen (e.g., settings user interfaces, notifications, configuration user interfaces, user interfaces for sharing the user interface objects, and/or other system or application specific user interfaces). For example, FIG. 9C illustrates that the light mode appearance 900a of icon 900 (corresponding to the messages application) that is displayed in home screen user interface 9002 in the light mode also appears in a notification banner 9004, in accordance with a determination that the device is in the light mode of operation when the notification is displayed. Further, FIG. 9D illustrates that the dark mode appearance 900b of the same icon 900 that is displayed in home screen user interface 9002 in the dark mode also appears in a notification banner 9004, in accordance with a determination that the device is in the dark mode of operation when the notification is displayed. Automatically applying a color configuration selected for user interface objects on a home screen across other user interfaces (e.g., across the device) without the need for additional user inputs, reduces the number of inputs and/or time to configure the appearance of user interface objects across multiple user interfaces on the device (e.g., reducing the number of inputs and/or time needed to improve the uniformity or harmony of colors used for user interface objects across the device as a whole).

In some embodiments, the computer system displays (14066) a first system user interface (e.g., wake screen user interface, notification user interface, widget user interface, control user interface, application library user interface, a sharing sheet, a settings user interface, and/or other system user interfaces in which application icons and/or widgets may be displayed) different from the home screen user interface, wherein the first system user interface includes a second plurality of user interface objects (e.g., as automatically recommended application icons or widgets, as wake screen quick actions, as wake screen complications, as application launcher controls, and/or other forms of application icons and/or widgets; or as representations of sources for notifications), and the second plurality of user interface objects includes one or more corresponding user interface objects in the first plurality of user interface objects (e.g., the second plurality of user interface objects are application icons and widgets found in the home screen user interface, and/or variations of the application icons and/or widgets found in the home screen user interface (e.g., icons with slight changes in shape and size, but overall are recognizable as application icons and/or widgets corresponding to the same applications as those icons in the home screen user interface)). In some embodiments, a respective user interface object of the second plurality of user interface objects and its corresponding user interface objects in the first plurality of user interface objects are two versions of the same widget or two versions of the same application icon, wherein the two versions of the same widget include the same application content that is updated from time to time as the content in their corresponding application changes and/or include the same set of affordances that when selected cause the computer system to perform the same operations (e.g., media controls for playing back media content; state or stop a recording; changing a state of an item, or changing a state of a peripheral device or external device), and the two versions of the same application icon causes the same operation to be performed when selected (e.g., launching the corresponding application; displaying the same contextual menu). In some embodiments, displaying the first system user interface, including the second plurality of user interface objects, includes: in accordance with a determination that the computer system is operating in the first state and the first appearance property is selected for the first plurality of user interface objects (e.g., a configuration for “colorful” icons is selected), displaying the second plurality of user interface objects in the first system user interface with the first flexible set of colors (e.g., a varied set of colors that includes colors selected by individual applications) in the first system user interface (e.g., the colors used in the second plurality of user interface objects correspond to those of their counterparts in the home screen user interface); in accordance with a determination that the computer system is operating in the second state and the first appearance property is selected for the first plurality of user interface objects (e.g., the configuration of “colorful” icons is selected), displaying the second plurality of user interface objects with the second flexible set of colors (e.g., a varied set of colors that includes colors selected by individual applications) in the first system user interface (e.g., the colors used in the second plurality of user interface objects correspond to those of their counterparts in the home screen user interface); in accordance with a determination that the computer system is operating in the first state and the second appearance property is selected for the first plurality of user interface objects (e.g., a configuration of “tinted” icons is selected), displaying the second plurality of user interface objects in the first system user interface with the first flexible set of colors in the first system user interface (e.g., the second plurality of user interface objects remain colorful icons, even though their counterparts in the home screen user interface are tinted icons); and in accordance with a determination that the computer system is operating in the second state and the second appearance property is selected for the first plurality of user interface objects (e.g., the configuration of “tinted” icons is selected), displaying the second plurality of user interface objects with the second flexible set of colors in the first system user interface (e.g., the second plurality of user interface objects remain colorful icons, even though their counterparts in the home screen user interface are tinted icons). In some embodiments, while some color configuration selected for user interface objects on the homes screen can also be applied to user interface objects displayed on user interfaces different from the home screen, some color configurations are reserved for the home screen and cannot be applied to other user interfaces. For example, FIG. 9C illustrates that the light mode appearance 900a of icon 900 (corresponding to the messages application) that is displayed in home screen user interface 9002 in the light mode also appears in a notification banner 9004, in accordance with a determination that the device is in the light mode of operation when the notification is displayed. Further, FIG. 9D illustrates that the dark mode appearance 900b of the same icon 900 that is displayed in home screen user interface 9002 in the dark mode appears in a notification banner 9004, in accordance with a determination that the device is in the dark mode of operation when the notification is displayed. However, a tinted appearance of icon 900, such as one displayed on home user interface 9000 with respect to FIGS. 9Q-9R, would not appear in the notification banner 9004 in accordance with a determination that the tinted icon configuration is selected. Automatically applying some color configuration selected for user interface objects on the home screen across other user interfaces (e.g., across the device) without the need for additional user inputs while forgoing applying other color configurations to user interfaces different from the home screen, reduces visual clutter and reduces the number of inputs and/or time needed to configure the appearance of user interface objects across multiple user interfaces on the device (e.g., reducing the number of inputs and/or time needed to improve the uniformity or harmony of colors used for user interface objects across the device as a whole).

It should be understood that the particular order in which the operations in FIGS. 14A-14H have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 10000, 11000, 12000, and 13000) are also applicable in an analogous manner to method 14000 described above with respect to FIGS. 14A-14H. For example, the controls, user interfaces, and user inputs described above with reference to method 14000 optionally have one or more of the characteristics of the controls, user interfaces, and user inputs described herein with reference to other methods described herein (e.g., methods 10000, 11000, 12000, and 13000). For brevity, these details are not repeated here.

The operations described above with reference to FIGS. 5A-5AT, 6A-6AX, 7A-7V, 8A-8Q, and 9A-9AB are, optionally, implemented by components depicted in FIGS. 1A-1B. For example, displaying operation 602, detecting operation 714, modifying operation 828, and/or generating operation 923, are optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

The operations described above with reference to FIGS. 5A-5AT, 6A-6AX, 7A-7V, 8A-8Q, and 9A-9AB are, optionally, implemented by components depicted in FIGS. 1A-1B. For example, displaying operation 602, detecting operation 714, modifying operation 828, and/or generating operation 923, are optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or, optionally, whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a computer system that is in communication with one or more display devices and one or more input devices:
displaying, via the one or more display devices, a home screen user interface, wherein the home screen user interface includes a plurality of user interface objects corresponding to a plurality of different applications;
detecting, via the one or more input devices, a first input directed to a first user interface object of the plurality of user interface objects;
in response to detecting the first input directed to the first user interface object of the plurality of user interface objects:
in accordance with a determination that the first input meets first criteria, wherein the first criteria require that the first input meets a first input threshold with less than a threshold amount of movement in order for the first input to meet the first criteria, displaying, concurrently with the first user interface object, two or more configuration options corresponding to the first user interface object, including a first configuration option that, when selected, causes a first change in configuration of the first user interface object in the home screen user interface, and a second selectable option that, when selected, causes a second change in configuration of the first user interface object in the home screen user interface, wherein the second change in configuration is different from the first change in configuration; and
in accordance with a determination that the first input meets second criteria, wherein the second criteria require that the first input does not meet with the first input threshold with less than the threshold amount of movement, in order for the first input to meet the second criteria, performing a first operation associated with the first user interface object.

2. The method of claim 1, wherein the first change in configuration includes a change in object type of the first user interface object, and the method includes:
while displaying, concurrently with the first user interface object, the first configuration option and the second configuration option, detecting, via the one or more input devices, selection of the first configuration option; and
in response to detecting the selection of the first configuration option, changing a respective object type of the first user interface object from a first object type to a second object type or from the second object type to the first object type.

3. The method of claim 2, wherein changing the respective object type of the first user interface object includes:
in accordance with the first user interface object being a respective application icon of a first application, replacing display of the respective application icon of the first application with a respective widget of the first application in the home screen user interface.

4. The method of claim 3, wherein changing the respective object type of the first user interface object includes:
in accordance with the first user interface object being the respective widget of the first application, replacing display of the respective widget of the first application with the respective application icon of the first application in the home screen user interface.

5. The method of claim 1, wherein the second change in configuration includes a change in object dimension of the first user interface object, and the method includes:
while displaying, concurrently with the first user interface object, the first configuration option and the second configuration option, detecting, via the one or more input devices, selection of the second configuration option; and
in response to detecting the selection of the second configuration option, changing a respective set of dimensions of the first user interface object from a first set of dimensions to a second set of dimensions different from the first set of dimensions.

6. The method of claim 1, wherein the two or more configuration options corresponding to the first user interface object includes a third configuration option that, when selected, causes a third change in configuration of the first user interface object, wherein the third change in configuration of the first user interface object includes a change in a respective set of parameters by which a respective type of widgets corresponding to the first user interface object are configured.

7. The method of claim 6, including:
while displaying, concurrently with the first user interface object, the first configuration option, the second configuration option, and the third configuration option, detecting, via the one or more input devices, selection of the third configuration option; and
in response to detecting the selection of the third configuration option, changing one or more parameters of the first user interface object other than the dimensions of the first user interface object.

8. The method of claim 6, wherein the change in the respective set of parameters by which a respective type of widgets corresponding to the first user interface object are configured includes a change in a type of information that is displayed in the first user interface object.

9. The method of claim 1, wherein the home screen user interface includes a respective user interface object that displays a first set of application icons that meet first selection criteria and wherein the method includes:
detecting, via the one or more input devices, a sequence of one or more inputs including a respective input directed to the respective user interface object; and
in response to detecting the sequence of one or more inputs including the respective input directed to the respective user interface object:
in accordance with a determination that the sequence of one or more inputs includes selection of second selection criteria for the respective user interface object, displaying a second set of application icons that are different from the first set of application icons, in the respective user interface object, wherein:
the second selection criteria are different from the first selection criteria; and
the second set of application icons are application icons that meet the second selection criteria;
in accordance with a determination that the sequence of one or more inputs includes selection of third selection criteria for the respective user interface object, displaying a third set of application icons that are different from the first set of application icons and are different from the second set of application icons, in the respective user interface object, wherein:
the third set of application icons are application icons that meet the third selection criteria;
the third selection criteria are different from the first selection criteria; and
the third selection criteria are different from the second selection criteria.

10. The method of claim 9, including:
in response to detecting the respective input directed to the respective user interface object:
in accordance with a determination that the respective input meets the first criteria, wherein the first criteria require that the respective input meets the first input threshold with less than the threshold amount of movement in order for the respective input to meet the first criteria, displaying respective configuration options corresponding to two or more sets of selection criteria, including the second selection criteria and the third selection criteria concurrently with the respective user interface object.

11. The method of claim 1, including:
in response to detecting the first input directed to the first user interface object of the plurality of user interface objects:
in accordance with a determination that the first input meets third criteria, wherein the third criteria require that the first input meets a second input threshold greater than the first input threshold with less than the threshold amount of movement, in order for the third criteria to be met, displaying the home screen user interface in a reconfiguration mode; and
while the home screen user interface is displayed in the reconfiguration mode, detecting a first resize input directed to the first user interface object; and
in response to detecting the first resize input directed to the first user interface object:
changing one or more of a set of parameters by which the first user interface object is configured in accordance with the first resize input.

12. The method of claim 1, including:
detecting, via the one or more input devices, a second input directed to a second user interface object of the plurality of user interface objects, the second user interface object being different from the first user interface object; and
in response to detecting the second input directed to the second user interface object of the plurality of user interface objects:
in accordance with a determination that the second input meets the first criteria, wherein the first criteria require that the second input meets the first input threshold with less than the threshold amount of movement in order for the second input to meet the first criteria, displaying, concurrently with the second user interface object, two or more configuration options corresponding to the second user interface object, including a fourth configuration option that, when selected, causes a fourth change in configuration of the second user interface object, and a fifth selectable option that, when selected, causes a fifth change in configuration of the second user interface object; and
in accordance with a determination that the second input meets the second criteria, wherein the second criteria require that the second input does not meet the first input threshold with less than the threshold amount of movement in order for the second input to meet the second criteria, performing a second operation associated with the second user interface object.

13. The method of claim 1, wherein performing the first operation associated with the first user interface object includes displaying, via the one or more display devices, a respective application corresponding to the first user interface object.

14. The method of claim 1, wherein performing the first operation associated with the first user interface object includes performing a respective operation using a first application that is associated with the first user interface object.

15. The method of claim 1, including:
while displaying the plurality of user interface objects, including the first user interface object, in the home screen user interface, detecting one or more user inputs that correspond to a request for a respective change in configuration of the first user interface object; and
in response to detecting the one or more user inputs that correspond to a request for a respective change in configuration of the first user interface object, displaying, via the one or more display devices, the respective change in configuration of the first user interface object, while maintaining display of at least a first subset of the plurality of user interface objects, in addition to the first user interface object, in the home screen user interface.

16. The method of claim 15, wherein:
displaying, via the one or more display devices, the respective change in configuration of the first user interface object includes changing a respective set of dimensions of the first user interface object from a first set of dimensions to a second set of dimensions different from the first set of dimensions; and
the method includes, moving one or more user interface objects of the plurality of user interface objects in the home screen user interface in addition to changing the respective set of dimensions of the first user interface object.

17. The method of claim 16, including:
in response to detecting the one or more user inputs that correspond to a request for a respective change in configuration of the first user interface object, removing at least one of the one or more user interface objects of the plurality of user interface objects from a current page of the home screen user interface in which the first user interface object is displayed, in addition to changing the respective set of dimensions of the first user interface object.

18. The method of claim 15, wherein:
displaying, via the one or more display devices, the respective change in configuration of the first user interface object includes changing a respective object type of the first user interface object from a third object type to a fourth object type that is different from the third object type; and
the method includes, moving one or more user interface objects of the plurality of user interface objects in the home screen user interface in addition to changing the respective object type of the first user interface object.

19. The method of claim 1, including:
in response to detecting the first input directed to the first user interface object of the plurality of user interface objects:
in accordance with a determination that the first input meets the first criteria and that the first user interface object is a respective widget of a first application, displaying, concurrently with the first user interface object and the two or more configuration options corresponding to the first user interface object, a respective selectable option that, when selected, causes the computer system to display additional configuration options corresponding to the respective widget; and
in accordance with a determination that the first input meets the first criteria and that the first user interface object is a respective application icon of the first application, forgoing displaying, concurrently with the first user interface object and the two or more configuration options corresponding to the first user interface object, the respective selectable option that, when selected, causes the computer system to display additional configuration options corresponding to the respective widget.

20. The method of claim 1, including:
displaying, via the one or more display devices, a first application suggestion widget in the home screen user interface, concurrently with the plurality of user interface objects corresponding to the plurality of different applications, wherein the first application suggestion widget includes respective application icons of a first collection of applications that are automatically selected for inclusion in the first application suggestion widget;
while displaying the first application suggestion widget in the home screen user interface, detecting, via the one or more input devices, a third input directed to the first application suggestion widget; and
in response to detecting the third input directed to the first application suggestion widget:
in accordance with a determination that the third input meets the first criteria, wherein the first criteria require that the third input meets the first input threshold with less than the threshold amount of movement in order for the first criteria to be met, displaying, concurrently with the first application suggestion widget two or more configuration options corresponding to the first application suggestion widget, including a size configuration option for specifying a respective size for the first application suggestion widget, and a category configuration option for specifying a respective category of the first application suggestion widget wherein the computer system selects the respective application icons of the first collection of applications for inclusion in the first application suggestion widget in accordance with the respective category associated with the first application suggestion widget.

21. The method of claim 1, wherein:
displaying the home screen user interface includes concurrently displaying a plurality of application suggestion widgets, including at least a first application suggestion widget and a second application suggestion widget different from the first application suggestion widget,
the first application suggestion widget is associated with a first category,
the second application suggestion widget is associated with a second category different from the first category,
the first application suggestion widget includes respective application icons for a first plurality of applications that are associated with the first category and that are automatically selected for inclusion in the first application suggestion widget for being associated with the first category, and
the second application suggestion widget includes respective application icons for a second plurality of applications that are associated with the second category and that are automatically selected for inclusion in the second application suggestion widget for being associated with the second category.

22. The method of claim 1, including:
displaying the home screen user interface, including at least a first widget, in a reconfiguration mode;
while the home screen user interface is displayed in the reconfiguration mode, detecting a first movement input directed to the first widget; and
in response to detecting the first movement input directed to the first widget, changing a size of the first widget in accordance with the first movement input.

23. The method of claim 22, wherein changing the size of the first widget in accordance with the first movement input includes changing the size of the first widget from a first size of a set of preconfigured sizes to a second size of the set of preconfigured sizes for the first widget.

24. The method of claim 22, wherein changing the size of the first widget in accordance with the first movement input includes changing the size of the first widget in accordance with one or more movement characteristics of the first movement input.

25. The method of claim 22, including:
while displaying the home screen user interface in the reconfiguration mode displaying, via the one or more display devices, concurrently with the first widget, a first set of one or more resize affordances for the first widget, in the home screen user interface.

26. The method of claim 25, wherein the home screen user interface includes a plurality of widgets, including at least the first widget and a second widget different from the first widget, and the method includes:
while displaying the home screen user interface in the reconfiguration mode, displaying, via the one or more display devices, respective sets of one or more resize affordances for the plurality of widgets, including concurrently displaying:
the first set of one or more resize affordances for the first widget, and
a second set of one or more resize affordances for the second widget.

27. The method of claim 25, wherein the home screen user interface includes a collection of multiple widgets associated with a first placement location in the home screen user interface, wherein a respective widget from the collection of multiple widgets is selectively displayed in the first placement location at a given time, and the method includes:
while displaying the home screen user interface in the reconfiguration mode, displaying, via the one or more display devices, a respective set of one or more resize affordances for the respective widget from the collection of multiple widgets that is currently displayed in the first placement location.

28. The method of claim 27, including:
while displaying the respective set of one or more resize affordances for the respective widget from the collection of multiple widgets that is currently displayed in the first placement location of the home screen user interface, detecting, via the one or more input devices, a second movement input directed to the respective set of one or more resize affordances for the respective widget from the collection of multiple widgets and
in response to detecting the second movement input:
in accordance with a determination that resizing the collection of multiple widgets is permitted, resizing the collection of multiple widgets in accordance with the second movement input; and
in accordance with a determination that at least one of the collection of multiple widgets cannot be resized, forgoing resizing the collection of multiple widgets.

29. The method of claim 25, wherein:
displaying, via the one or more display devices, concurrently with the first widget, the first set of one or more resize affordances for the first widget, in the home screen user interface, includes displaying a first resize affordance at a location corresponding to a first portion of the first widget without displaying a resize affordance at a location corresponding to a second portion of the first widget; and
detecting the first movement input directed to the first widget includes detecting the first movement input directed to the second portion of the first widget that is displayed without a resize affordance.

30. The method of claim 22, wherein changing the size of the first widget in accordance with the first movement input includes:
reducing the size of the first widget in accordance with the first movement input, and displaying, via the one or more display devices, a respective application icon that corresponds to a respective application associated with the first widget in place of the first widget.

31. The method of claim 22, wherein:
detecting the first movement input includes detecting a first portion of the first movement input and detecting a second portion of the first movement input following the first portion of the first movement input, wherein the first portion of the first movement input and the second portion of the first movement input are in a first direction relative to the first widget; and
changing the size of the first widget in accordance with the first movement input includes:
changing the size of the first widget to a first threshold size in accordance with the first portion of the first movement input,
displaying, via the one or more display devices, a further change in the size of the first widget in a first direction beyond the first threshold size in accordance with the second portion of the first movement input, and
changing the size of the widget in a second direction that is different than the first direction after the second portion of the first movement input ceases to be detected.

32. The method of claim 22, including:
displaying a plurality of intermediate states between a first size of the first widget and a second size of the first widget, during the first movement input.

33. The method of claim 32, wherein changing the respective size of the first widget in accordance with the first movement input includes switching from displaying the first widget with a first size to displaying the first widget with a second size different from the first size, during the first movement input.

34. The method of claim 32, wherein changing the respective size of the first widget in accordance with the first movement input includes switching from displaying the first widget with a first size to displaying the first widget with a second size different from the first size, after detecting a termination of the first movement input.

35. The method of claim 1, wherein the plurality of user interface objects includes a first application icon that includes respective animated content that indicates a respective ongoing activity associated with a respective application of the first application icon.

36. The method of claim 35, including:
in accordance with a determination that the respective ongoing activity associated with the respective application of the first application icon includes a first ongoing activity, displaying, via the one or more display devices, first animated content in the first application icon; and
in accordance with a determination that the respective ongoing activity associated with the respective application of the first application icon includes a second ongoing activity different from the first ongoing activity, displaying, via the one or more display devices, second animated content, different from the first animated content, in the first application icon.

37. The method of any of claim 35, including:
while displaying, via the one or more display devices, the respective animated content in the first application icon, detecting that the respective ongoing activity associated with the respective application of the first application icon has terminated; and
in response to detecting that the respective ongoing activity associated with the respective application of the first application icon has terminated, ceasing to display the respective animated content in the first application icon, and displaying, via the one or more display devices, the first application icon with a first static appearance.

38. A computer system that is in communication with one or more display devices and one or more input devices, the computer system comprising:
one or more processors; and
memory storing one or more programs, wherein the one or more programs are configured to be executed by the one or more processors, the one or more programs including instructions for:
displaying, via the one or more display devices, a home screen user interface, wherein the home screen user interface includes a plurality of user interface objects corresponding to a plurality of different applications;
detecting, via the one or more input devices, a first input directed to a first user interface object of the plurality of user interface objects;
in response to detecting the first input directed to the first user interface object of the plurality of user interface objects:
in accordance with a determination that the first input meets first criteria, wherein the first criteria require that the first input meets a first input threshold with less than a threshold amount of movement in order for the first input to meet the first criteria, displaying, concurrently with the first user interface object, two or more configuration options corresponding to the first user interface object, including a first configuration option that, when selected, causes a first change in configuration of the first user interface object in the home screen user interface, and a second selectable option that, when selected, causes a second change in configuration of the first user interface object in the home screen user interface, wherein the second change in configuration is different from the first change in configuration; and
in accordance with a determination that the first input meets second criteria, wherein the second criteria require that the first input does not meet with the first input threshold with less than the threshold amount of movement, in order for the first input to meet the second criteria, performing a first operation associated with the first user interface object.

39. A computer readable storage medium storing one or more programs, the one or more programs comprising instructions that, when executed by a computer system that is in communication with one or more display devices and one or more input devices, cause the computer system to:
display, via the one or more display devices, a home screen user interface, wherein the home screen user interface includes a plurality of user interface objects corresponding to a plurality of different applications;
detect, via the one or more input devices, a first input directed to a first user interface object of the plurality of user interface objects;
in response to detecting the first input directed to the first user interface object of the plurality of user interface objects:
in accordance with a determination that the first input meets first criteria, wherein the first criteria require that the first input meets a first input threshold with less than a threshold amount of movement in order for the first input to meet the first criteria, display, concurrently with the first user interface object, two or more configuration options corresponding to the first user interface object, including a first configuration option that, when selected, causes a first change in configuration of the first user interface object in the home screen user interface, and a second selectable option that, when selected, causes a second change in configuration of the first user interface object in the home screen user interface, wherein the second change in configuration is different from the first change in configuration; and
in accordance with a determination that the first input meets second criteria, wherein the second criteria require that the first input does not meet with the first input threshold with less than the threshold amount of movement, in order for the first input to meet the second criteria, perform a first operation associated with the first user interface object.
